(19) United States
(12) Patent Application Publication
(10) Pub. No.: US 2020/0320159 A1
(43) Pub. Date: Oct. 8, 2020

(54) Magnetic-enthalpy symbol H gasiform species dilute, or solution a heater fluid dynamic mechanic class system transfer the integral sub-plasma thermal cycle state of matter dilute, or solution containing the greater amount of solute synthesis extraction the solution pipeline standard a heater fluid.

(71) Applicant: Robert R. Matthews, Washington, DC (US)

(72) Inventor: Robert R. Matthews, Washington, DC (US)

(21) Appl. No.: 16/361,565

(22) Filed: Mar. 22, 2019

(51) Int. Cl. G06F 17/16; C09K 5/10; G05B 15/02

(52) U.S. Cl. CPC G06F 17/16; G05B 15/02; C09K 5/10

(57) ABSTRACT

Heat a heater fluid a superconductor of magnetic-enthalpy in symbol H integral sub-plasma isotopic class [A] thermal cycle matter random dilution of random matrices H_{N}=U_{N} F_{N} U^{†}_{N}, where U_{N} are uniformly distributed over the group of N×N unitary matrices and F_{N} are non-random Hermitian matrices, and The Real and Complex Hermitian Solutions to a System of Quaternion Matrix Equations with Applications by Shao-Wen Yu 1. Combination of the associative and commutative axioms arithmetic progression number of n point coordinate ordered set in series of a real or complex valued axiom of commutativity α∈A sub-plasma set (real or complex valued) singletons have points and the entire space Rⁿ is our solution set of an arbitrary possibly, of linear inequalities with n unknowns x closed priori measures that the moments solution, or the weighted set of an arbitrary possibly n=2.

Magnetic-enthalpy symbol H gasiform species dilute, or solution a heater fluid dynamic mechanic class system transfer the integral sub-plasma thermal cycle state of matter dilute, or solution containing the greater amount of solute synthesis extraction the solution pipeline standard a heater fluid.

### BACKGROUND OF THE INVENTION

Global warming and growing concerns of Greenhouse gas emissions from our dependency on fossil fuels are creating real demand and awareness for an powerplant and powerelectric alternative to fossil fuel engines and expensive replacement parts. Furthermore, Silica Sand and Coal Polymers can be efficiently made into advanced specification of concrete, and roadway pavement possessing intrinsic amounts of elastomericity and tensile strength.

### BRIEF SUMMARY OF THE INVENTION

Scientific utilization of preform technology the variable hydraulic, hydraulic-force, fluid dynamic, or fluid propulsion powerplant actuated force F, or heat a heater fluid magnetic-enthalpy symbol H is derived from No fission product half-life range from 91 y to 210 ky magnetic-enthalpy symbol H ΔE= [symbol] v (with [symbol] gyromagnetic ratio is the critical exponent [symbol] ) degenerate Abelian functions are distinguished by having infinitely small periods, such as for any number ϵ>0 it is possible to find a period wᵥ, if p=1, The vectors wᵥ of all periods, or the system of periods of the Abelian function f(z) form an Abelian group Γ under addition, the period group, or the period module, a basis of this group is a system of periods of the Abelian function, or also as a system of basic periods, an Abelian function f(z) is degenerate if there exists a linear transformation of the variables ^{z}1, . . . , ^{z}p which converts f(z) into a function of fewer variables. Gasiform species are derived from organic fresh and salt water algae dilute, or solution containing the greater amount of solute synthesis extraction the solution set of A finite system Ax≤b of m inequalities with n variables A is m×n matrix is convex, A set of this latter type is three dimensions with flat faces, straight edges and sharp corners, or vertices higher aggregation atoms and hybridization molecules of natural gas, organic waste or biomass to synthesis gas pipeline standard a heater fluid dynamic mechanic class system transfer the integral sub-plasma thermal cycle state of matter fluid or the quantumstate₁ particulate matter conducting operational flow velocity μ of a fluid is a vector field μ=μx, [symbol] which gives the velocity of an element of a fluid flow at position x and ratio [symbol] , the flow speed modulate q is the length of the flow velocity vector₁ q=∥μ∥ and is also a second scalar field at program temperature fluid variable hydraulic, hydraulic-force, fluid dynamic, fluid propulsion powerplant actuated, or heat a heater fluid periodic of the system fourier space shift distance modulation q.

### BRIEF DESCRIPTION OF THE INVENTION

Heat a heater fluid a superconductor of magnetic-enthalpy in symbol H integral sub-plasma isotopic class [A] thermal cycle matter random dilution of random matrices H_{N}=U_{N} F_{N} U^{†}_{N}, where U_{N} are uniformly distributed over the group of N×N unitary matrices and F_{N} are non-random Hermitian matrices, and The Real and Complex Hermitian Solutions to a System of Quaternion Matrix Equations with Applications by Shao-Wen Yu 1. Combination of the associative and commutative axioms arithmetic progression number of n point coordinate ordered set in series of a real or complex valued axiom of commutativity α∈A sub-plasma set (real or complex valued) singletons have points and the entire space Rⁿ is our solution set of an arbitrary possibly, of linear inequalities with n unknowns x closed priori measures that the moments solution, or the weighted set of an arbitrary possibly n=2.

### DETAILED DESCRIPTION AND SPECIFICATION OF THE INVENTION

The variable hydraulic-electric; hydraulic-electric actuated; hydraulic-electric fluid dynamic; hydraulic-electric fluid propulsion; work-energy connection there is a relationship between work and total mechanical energy; the relationship is best expressed by the equation TMEᵢ+W_{nc}=TME_{f} the initial amount of total mechanical energy (TMEᵢ) of a system is altered by the work which is done to it by non-conservative forces (W_{nc}); the final amount of total mechanical energy (TME_{f}) possessed by the system is equivalent to the initial amount of energy (TMEᵢ) plus the work done by these non-conservative forces (W_{nc}); the mechanical energy possessed by a system is the sum of the kinetic energy and the potential energy; thus the above equation can be re-arranged to the form of KEᵢ+PEᵢ+W_{nc}=KE_{f}+PE_{f} 0.5·m·vᵢ²+m·g·hᵢ+F·d·cos(Θ)=0.5·m·v_{f}²+m·g·h_{f}; industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure processing powerplant; or [heat a heater fluid]. Heat a heater fluid a superconductor of magnetic-enthalpy in symbol H. Sub-plasma work power (M∘M)(X_{0,1}) the change in energy of a dynamical class system the dynamics of variable change complexification*, or two times the momentum isotopic class [A] conservation ΔE_{sys}:=the Planck constant [symbol] V in Newton Ring's [symbol] :=s²/2r:=N:=λ/2 the gravitational force:=Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1), α, β, and ϕ small, is written with equations in terms of load factor as (n-cos Θ), g-units stationary, and independent increments dynamics of variable change method of two simple planes a and b having a sequence which accounts for the role of these numbers in measuring the densities of the planes, of finite-dimensions as densities in the neighborhood of 0, and continued of the continuous dimensions as the densities of the planes complexification*, or two times the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜}=λ* is the complex conjugate of λ {impellers; turbo-shaft; turbo-fan; turbo-fluid; turbo-jet; or fluid-propulsion} negative z-axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. The Koszul complex associated to the operad Trias is the differential functor Tridend∘Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f. By definition the Koszul complex associated to the operad Trias is the differential functor Tridend∘Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C*^{Trias}(Trias(V)) is proved. 1. We show that it is sufficient to treat the case V=K. 2. The chain complex C*^{Trias}(Trias(K)) splits into the direct sum of chain complexes C*(u), one for each element u in P_{m,m}≥1. 3. The chain complex C*(u) is shown to be the cell complex of a simplicial set X(u). 4. The space X(u) is shown to be the join of spaces X(v) for certain particular elements v in Pₘ. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B*B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>ν>0 with ν not a scalar multiple of μ. Then μ=(μ−ν)+ν which is a convex linear combination of states (once the terms have been normalized) using the fact that ∥μ−ν∥=lim(μ−ν)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K:ϕ(v₁)=ϕ(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓_{Q}^{f}⇄ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p}) fitted for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q= [symbol] (X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. We consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). Steady-state system theory, our system and process of a steady-state solution which are null-spaces of a positive number n of length n when the state variables which define the behavior of the system and process are unchanging in time. In continuous time, this means that for those properties p of the system, the partial derivative with respect to time is zero and remains so. In mathematics and in our dynamical system, a linear difference equation equates to 0 to a polynomial that is linear in the various iterates of a variable that is, in the values of the elements of a sequence. The polynomial's linearity means that each of its terms has degree 0 or 1 with discrete moment denoted as τ, one period denoted as τ−1, one period later as τ+1, an nth order linear difference equation is one that is written in terms of parameters aⁱ and b, discrete-variable moment (momentum) motion position, harmonic simple moment (momentum) circular motion, and harmonic motion equilibrium position, harmonic series moment (momentum) circular motion, and harmonic motion equilibrium position, continuous-variable moment (momentum) circular motion, and harmonic motion equilibrium position, continuous-equivalently moment (momentum) circular motion, and harmonic motion equilibrium position, or variable geometry moment (momentum) bias efficient in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 motion, and harmonic motion equilibrium position isochronous the period and frequency are independent of the amplitude and constant are the first convex set eigenfunction form a complete set subspace eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1 the motion is uniform circular motion continued in the Taylor series of n-sums of the first n+1 terms of a n-series at 0, when n:=a=0, known as the base point by the action of G₁ depends upon the choice of a base point x₀∈M to every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. (We refer to). “The isomorphism α of (]0,1]×R^{N}) with the quotient BG₁ of G₁⁽⁰⁾×R^{N}=(]0, 1]×M)×R^{N} by the action of G₁ depends upon the choice of a base point x₀∈M, and to simplify the formulae we take j(x₀)=0∈R^{N}. One then has α(ε,X)=((x₀,ε),X)∀_{ε}>0, X∈R^{N}. with this notation the locally compact topology of BG is obtained by gluing]0,1]×R^{N} to ν(M) by the following rule: (εₙ,Xₙ)→(x,Y) for εₙ→0, x∈M, Y∈νx(M) iff Xₙ→j(x)∈R^{N} and Xₙ−j(x)/εₙ→Y in νₓ(M). Using the Euclidean structure of R^{N} we can view νₓ(M) as the subspace orthogonal to j_{*}Tₓ(M)⊂R^{N} and use the following local chart around (x,Y)∈ν(M): ϕ(x,Y,ε)=(ε,j(x)+εY)∈]0,1]×R^{N} for ε>0” the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of ∪; or the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of U for a shaft; or turboshaft sub-plasma work power (M∘M)(X_{0,1}) the change in energy of a dynamical class system the dynamics of variable change complexification*, or two times the momentum isotopic class [A] conservation ΔE_{sys}:=the Planck constant [symbol] V in Newton Ring's [symbol] :=s²/2r:=N:=λ/2 the gravitational force:=Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p₁)²=0, we can write pₐₐ_{^{⋅}}=λₐ, λ^{˜}ₐ_{^{⋅}}, with λ and λ^{˜} two independent real spinors R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1), α, β, and ϕ small, is written with equations in terms of load factor as (n-cos Θ), g-units stationary, and independent increments dynamics of variable change method of two simple planes a and b having a sequence which accounts for the role of these numbers in measuring the densities of the planes, of finite-dimensions as densities in the neighborhood of 0, and continued of the continuous dimensions as the densities of the planes complexification*, or two times the momentum is characterized by 4 real numbers p^{μ}, the matrix pₐₐ_{^{⋅}}=p_{μ}(σ^{μ})ₐₐ_{^{⋅}} is Hermitian, which implies that λ^{˜}=λ* is the complex conjugate of λ {impellers; turbo-shaft; turbo-fan; turbo-fluid; turbo-jet; or fluid-propulsion} negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. The Koszul complex associated to the operad Trias is the differential functor Tridend∘Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f nearby level surface point structure, or solid domain occupies surface point structure “there is an exponential map Mₙ(R)≅glₙ(R) [symbol] X→exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(τX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by D_{X}(b). The collection of all b such that all iterated derivatives always exist is a linear subspace B^{∞} of B, and on this subspace we have (D_{X}D_{Y}−D_{Y}D_{X})(b)=D_{[X,Y]}(b). (We refer to). “The same map Indₐ arises naturally from a geometric construction, that of the tangent groupoid of the manifold M. This groupoid encodes the deformation of T*M to a single point, using the equivalence relation on M×[0,1] which identifies any pairs (x,∈) and (y,∈) provided ∈>0. Implicitly the notion of groupoid. All our algebra structures could be written in the following form: (a*b)( [symbol] )=Σ [symbol] _{1∘} [symbol] ₂₌ [symbol] a( [symbol] ₁)b( [symbol] ₂) for non-rotation, closed-chain equivariant translation-banded A class of C*-algebras and topological Markov chains or spherical models sides are variations given a space X such a family (Dₓ)_{x∈X} of elliptic operators parametrized by X is given by a longitudinal combinatorial(n) elliptic differential operator D an element of the K-group of the parameter space groupoid of the manifold M through the associated C*-algebra C*ᵣ(G): where the [symbol] 's vary in a groupoid G, i.e. in a small category with inverses, or more explicitly: Definition 1. A groupoid consists of a set G, a distinguished subset G⁽⁰⁾⊂G, two maps r,s:G→G⁽⁰⁾ and a law of composition ∘:G⁽²⁾={( [symbol] ₁, [symbol] ₂)∈G×G; s( [symbol] ₁)=r( [symbol] ₂)}→G such that (1) s( [symbol] ₁∘ [symbol] ₂)=s( [symbol] ₂), r( [symbol] ₁∘ [symbol] ₂)=r( [symbol] ₁)∀( [symbol] ₁, [symbol] ₂)∈G⁽²⁾(2) s(x)=r(x)=x ∀×∈G⁽⁰⁾ (3) [symbol] ∘s( [symbol] )= [symbol] , r( [symbol] )∘ [symbol] = [symbol] ∀ [symbol] ∈G (4) ( [symbol] ₁∘ [symbol] ₂)∘ [symbol] ₃= [symbol] ₁∘( [symbol] ₂∘ [symbol] ₃) (5) Each y has a two-sided inverse [symbol] ⁻¹, with [symbol] [symbol] ⁻¹=r( [symbol] ), [symbol] ⁻¹ [symbol] =s( [symbol] ). The maps r,s are called the range and source maps. Equivalence relations. Given an equivalence relation R⊂X×X on a set X, one gets a groupoid in the following obvious way: G=R, G⁽⁰⁾=diagonal of X×X⊂R, r(x,y)=x, s(x,y)=y for any y=(x,y) ∈R⊂X×X and (x,y)∘(y,z)=(x,z), (x,y)⁻¹=(y,x). Groups. Given a group r one takes G=Γ, G⁽⁰⁾={e}, and the law of composition is the group law. Group actions. Given an action X×Γ→^{α}X of a group Γ on a set X, α(x,g)=xg, so that x(g₁g₂)=(xg₁)g₂ ∀x∈X, gᵢ∈Γ, one takes G=X×Γ, G⁽⁰⁾=X×{e}, and r(x,g)=x, s(x,g)=xg ∀(x,g)∈X×Γ(x,g₁)(y,g₂)=(x,g₁g₂) if xg₁=y (x,g)⁻¹=(xg,g⁻¹) ∀(x,g)∈X×Γ. This groupoid G=XoΓ is called the semi-direct product of X by Γ. In all the examples we have met so far, the groupoid G has a natural locally compact topology and the fibers G^{x}=r⁻¹{x}, x∈G⁽⁰⁾, of the map r, are discrete. This is what allows us to define the convolution algebra very simply by (a*b)( [symbol] )= [symbol] a( [symbol] ₁)b( [symbol] ₂). Our next example of the tangent groupoid of a manifold will be easier to handle than the general case; though no longer discrete, it will be smooth in the following sense: Definition 2. A smooth groupoid G is a groupoid together with a differentiable structure on G and G⁽⁰⁾ such that the maps r and s are subimmersions, and the object inclusion map G⁽⁰⁾→G is smooth, as is the composition map G⁽²⁾→G. The general notion is due to Ehresmann and the specific definition here to Pradines, who proved that in a smooth groupoid G, all the maps s:G^{x}→G⁽⁰⁾ are subimmersions, where G^{x}={ [symbol] ∈G;r( [symbol] )=x}. The notion of a ½-density on a smooth manifold allows one to define in a canonical manner the convolution algebra of a smooth groupoid G. More specifically, given G, we let Ω^{1/2} be the line bundle over G whose fiber Ω [symbol] ^{1/2} at [symbol] ∈G, r( [symbol] )=x, s( [symbol] )=y, is the linear space of maps ρ: ∧^{k} [symbol] (G^{x})⊗∧^{k} [symbol] (G_{y})→C such that ρ(λv)=|λ|^{1/2}ρ(v) ∀λ∈R. Here G_{y}={ [symbol] ∈G;s( [symbol] )=y} and k=dim [symbol] (G^{x})=dim [symbol] (G_{y}) is the dimension of the fibers of the submersions r:G→G⁽⁰⁾ and s:G→G⁽⁰⁾. Then we endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), on the manifold G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z)∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G. As two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G. Coming back to the general case, one has: Proposition Let G be a smooth groupoid, and let C_{c}^{∞}(G, Ω^{1/2}) be the convolution algebra of smooth compactly supported ½-densities, with involution *, f*( [symbol] )=f( [symbol] ⁻¹). Then for each x∈G⁽⁰⁾ the following defines an involutive representation πₓ of C_{c}^{∞} (G, Ω^{1/2}) in the Hilbert space L²(Gₓ):(πₓ(f)ξ)( [symbol] )=∫f( [symbol] ₁) λ( [symbol] ₁⁻¹ [symbol] ) ∀ [symbol] ∈Gₓ, ξ∈L²(Gₓ). The completion of C_{c}^{∞}(G, Ω^{1/2}) for the norm ∥f∥=Sup_{x∈G}(0)∥πₓ(f)∥ is a C*-algebra, denoted C*ᵣ(G). As in the case of discrete groups one defines the C*-algebra C*(G) as the completion of the involutive algebra C_{c}^{∞}(G, Ω^{1/2}) for the norm kfkₘₐₓ=sup{kπ(f)k} π involutive Hilbert space representation of C_{c}^{∞}(G, Ω^{1/2}) We let r:C*(G)→C*ᵣ(G) be the canonical surjection. Let us now pass to an interesting example of smooth groupoid, namely we construct the tangent groupoid of a manifold M. Let us first describe G at the groupoid level; we shall then describe its smooth structure. We let G=(M×M×]0,1])∪(TM), where TM is the total space of the tangent bundle of M. We let G⁽⁰⁾⊂G be M×[0,1] with inclusion given by (x,ε)→(x,x,ε)∈M×M×]0,1] for x∈M, ε>0. (x,0)→x∈M⊂TM as the 0-section, for ε=0. The range and source maps are given respectively by r(x,y,ε)=(x,ε) for x∈M, ε>0 r(x,X)=(x,0) for x ∈M,X∈Tₓ(M) s(x,y,ε)=(y,ε) for y∈M, ε>0 s(x,X)=(x,0) for y∈M,X∈Tₓ(M) The composition is given by (x,y,ε)∘(y,z,ε)=(x,z,ε) for ε>0 and x,y,z∈M (x,X)∘(x,Y)=(x,X+Y) for x∈M and X,Y∈Tₓ(M) Putting this in other words, the groupoid G is the union (a union of groupoids is again a groupoid) of the product G₁ of the groupoid M×M of example α) by]0,1] (a set is a groupoid where all the elements belong to G⁽⁰⁾) and of the groupoid G₂=TM which is a union of groups: the tangent spaces Tₓ(M). This decomposition G=G₁∪G₂ of G as a disjoint union is true set theoretically but not at the manifold level. Indeed, we shall now endow G with the manifold structure that it inherits from its identification with the space obtained by blowing up the diagonal Δ=M⊂M×M in the Cartesian square M×M. More explicitly, the topology of G is such that G₁ is an open subset of G and a sequence (xₙ,yₙ,εₙ) of elements of G₁=M×M×]0,1] with εₙ→0 converges to a tangent vector (x,X); X∈Tₓ(M) iff the following holds: The tangent groupoid of M xₙ→x, yₙ→x, xₙ−yₙ/εₙ→X. The last equality makes sense in any local chart around x independently of any choice. One obtains in this way a manifold with boundary, and a local chart around a boundary point (x,X)∈TM is provided, for instance, by a choice of Riemannian metric on M and the following map of an open set of TM×[0,1] to G: ψ(x,X,ε)=(x,expₓ(−εX),ε)∈M×M×]0,1], for ε>0ψ(X,X,0)=(x,X)∈TM Proposition with the above structure G is a smooth groupoid. We shall call it the tangent groupoid of the manifold M and denote it by G_{M}. The structure of the C*-algebra of this groupoid G_{M} is given by the following immediate translation of the inclusion of G₂=TM as a closed subgroupoid of G_{M}, with complement G₁. Proposition to the decomposition G_{M}=G₁∪G₂ of G_{M} as a union of an open and a closed subgroupoid corresponds the exact sequence of C*-algebras 0→C*(G₁)→C*(G)→^{σ}C*(G₂)→0. 2) The C*-algebra C*(G₁) is isomorphic to C₀(]0,1])⊗K, where K is the elementary C*-algebra (all compact operators on Hilbert space). 3) The C*-algebra C*(G₂) is isomorphic to C₀(T*M), the isomorphism being given by the Fourier transform: C*(TₓM)˜C₀(T*ₓM), for each x∈M. It follows from 2) that the C*-algebra C*(G₁) is contractible: it admits a pointwise norm continuous family Θ_{λ} of endomorphisms, λ∈[0,1], such that Θ₀=id and Θ₁=0. (This is easy to check for C₀(]0,1]).) In particular, from the long exact sequence in K-theory we thus get isomorphisms σ_{*}:Kᵢ(C*(G))˜Kᵢ(C*(G₂))=Kⁱ(T*M). On the right-hand side Kⁱ(T*M) is the K-theory with compact supports of the total space of the cotangent bundle. We now have the following geometric reformulation of the analytic index map Indₐ of Atiyah and Singer. Lemma 6. Let ρ:C*(G)→K=C*(M×M) be the transpose of the inclusion M×M→G:(x,y)→(x,y,1) ∀x,y∈M. Then the Atiyah-Singer analytic index is given by Indₐ=ρ_{*}∘(σ_{*})⁻¹:K⁰(T*M)→Z=K₀(K). The proof is straightforward. The map σ:C*(G)→C*(G₂)˜C₀(T*M) is the symbol map of the pseudodifferential calculus for asymptotic pseudodifferential operators. A proof of the index theorem, closely related to the proof of Atiyah and Singer can be adapted to many other situations. Lemma 6 above shows that the analytic index Indₐ has a simple interpretation in terms of the tangent groupoid G_{M}=G. If the smooth groupoids G, G₁, and G₂ involved in this interpretation were equivalent (in the sense of the equivalence of small categories) to ordinary spaces Xⱼ (viewed as groupoids in a trivial way, i.e. Xⱼ=Xⱼ⁽⁰⁾), then we would already have a geometric interpretation of Indₐ, i.e. an index formula. Now the groupoid G₁=M×M×]0,1] is equivalent to the space]0,1] since M×M is equivalent to a single point. Thus the problem comes from G₂ which involves the groups TₓM and is not equivalent to a space. Given any smooth groupoid G and a (smooth) homomorphism h from G to the additive group R^{N} one can form the following smooth groupoid Gₕ:Gₕ=G×R^{N}, Gₕ⁽⁰⁾=G⁽⁰⁾×R^{N} with r( [symbol] ,X)=(r( [symbol] ),X), s( [symbol] ,X)=(s( [symbol] ),X+h( [symbol] )) ∀ [symbol] ∈G, X∈R^{N}, and ( [symbol] ₁,X₁)∘( [symbol] ₂,X₂)=( [symbol] ₁∘ [symbol] ₂,X₁) for any composable pair. Heuristically, if G corresponds to a space X, then the homomorphism h fixes a principal R^{N}-bundle over X and Gₕ corresponds to the total space of this principal bundle. At the level of the associated C*-algebras one has the following: Proposition Let G be a smooth groupoid, h:G→R^{N} a homomorphism. 1) For each character χ∈R_{N} of the group R^{N} the following formula defines an automorphism α_{χ} of C*(G):(α_{χ}(f))( [symbol] )=χ(h( [symbol] ))f( [symbol] ) ∀f∈C_{c}^{∞}(G,Ω^{1/2}). 2) The crossed product C*(G)o_{α}R_{N} of C*(G) by the above action α of R_{N}=(R^{N})\hat{ } is the C*-algebra C*(Gₕ). Thus, we see in particular that if N is even, the Thom isomorphism for C*-algebras (Appendix C) gives us a natural isomorphism: K₀(C*(G))˜K₀(C*(Gₕ)). In the case where G corresponds to a space X, the above isomorphism is of course the usual Bott periodicity isomorphism. We shall now see that for a suitable choice of homomorphism G→^{h}R^{N}, where G=G_{M} is the tangent groupoid of M, the smooth groupoids Gₕ, G_{1,h}, and G_{2,h} will be equivalent to spaces, thus yielding a geometric computation of Indₐ and the index theorem. Let M→^{j}R^{N} be an immersion of M in a Euclidean space R^{N}. Then to j corresponds the following homomorphism h of the tangent groupoid G of M into the group R^{N}: h(x, y, ε)=j(x)−j(y)/ε ε>0 h(x, X)=j_{*}(X) ∀X∈Tₓ(M). One checks immediately that j( [symbol] ₁∘ [symbol] ₂)=j( [symbol] ₁)+j( [symbol] ₂) whenever ( [symbol] ₁, [symbol] ₂)∈G⁽²⁾. This homomorphism h defines a free and proper action of G, by translations, on the contractible space R^{N}. This follows because j is an immersion, so that j_{*} is injective. The smooth groupoid Gₕ is thus equivalent to the classifying space BG, which is the quotient of G⁽⁰⁾×R^{N} by the equivalence relation (x,X)˜(y,Y) iff ∃ [symbol] ∈G r( [symbol] )=x, s( [symbol] )=y, X=Y+h( [symbol] ). Since the action is free and proper the quotient makes good sense. Similar statements hold for G₁ and G₂. A straightforward computation yields BG=i]0,1]×R ^{N} [symbol] ∉ν(M) where ν(M) is the total space of the normal bundle of M in R^{N}. In this decomposition, BG=BG₁∪BG₂, one identifies BG₂, the quotient of G₂⁰×R^{N}=M×R^{N} by the action of G₂=TM, with the total space of ν, νₓ=R^{N}/Tₓ(M). (We refer to). “The isomorphism α of (]0,1]×R^{N}) with the quotient BG₁ of G₁⁽⁰⁾×R^{N}=(]0, 1]×M)×R^{N} by the action of G₁ depends upon the choice of a base point x₀∈M, and to simplify the formulae we take j(x₀)=0∈R^{N}. One then has α(ε,X)=((x₀,ε),X) ∀ε>0, X ∈R^{N}. with this notation the locally compact topology of BG is obtained by gluing]0,1]×R^{N} to ν(M) by the following rule: (εₙ,Xₙ)→(x,Y) for εₙ→0, x∈M, Y∈νₓ(M) iff Xₙ→j(x)∈R^{N} and Xₙ−j(x)/!ₙ→Y in νₓ(M). Using the Euclidean structure of R^{N} we can view νₓ(M) as the subspace orthogonal to j_{*}Tₓ(M)⊂R^{N} and use the following local chart around (x,Y)∈ν(M): ϕ(x,Y,ε)=(ε,j(x)+εY)∈]0,1]×R^{N} for ε>0. To the decomposition of Gₕ as a union of the open groupoid G_{1,h} and the closed groupoid G_{2,h} corresponds the decomposition BG=BG₁∪BG₂. BG₁ is properly contractible and thus we get a well-defined K-theory map ψ:K⁰(BG₂)˜K⁰(BG)→K⁰(R^{N}) which corresponds to the analytic index Indₐ=ρ_{*}∘(σ_{*})⁻¹ under the Thom isomorphisms K₀(C*(Gᵢ))˜K₀(C*(G_{h,i}))=K⁰(BGᵢ). Now, from the definition of the topology of BG it follows that 4) is the natural excision map K⁰(ν(M))→K⁰(R^{N}) of the normal bundle of M, viewed as an open set in R^{N}. Moreover, the Thom isomorphism K⁰(R^{N})˜^{β}Z is the Bott periodicity, while the Thom isomorphism K⁰(T*M)˜K₀(C*(G₂))˜K₀(C*(G_{2,h}))˜K⁰(BG₂) is the usual Thom isomorphism τ:K⁰(T*M)˜K⁰(ν(M)). Thus we have obtained the following formula: Indₐ=β∘ψ∘τ which is the Atiyah-Singer index theorem ([26]), the right-hand side being the topological index Indₜ. We used this proof to illustrate the general principle of first reformulating, as in Lemma 6, the analytical index problems in terms of smooth groupoids and their K-theory (through the associated C*-algebras), and then of making use of free and proper actions of groupoids on contractible spaces to replace the groupoids involved by spaces, for which the computations become automatically geometric”. [Noncommutative Geometry By Alain Connes Topology and K-Theory chapter II page 106.] Meaning that the angular velocity is constant, and the angular displacement is related to the angular velocity by the equation: τ=ωτ. The connection between uniform circular motion, and simple harmonic motion the close connection between circular motion, and simple harmonic motion. For an object having uniform circular motion, is two-dimensional motion, and the x and y position of the object at any time can be found by applying the equations: x=r cos Θ, and y=r sin Θ. Therefore, d²x/dτ²=−k/mx, solving a differential equation produces a solution that is a sinusoidal function. X(τ)=x₀ cos(ωT)+v₀/ω sin(ωT) this equation is written in the form: x(τ)=A cos(ωτ−ϕ), where ω=√k/m, A=√c₁²+c₂², tan ϕ=√c₂/c₁, in the solution, c₁ and c₂ are two constants determined by the initial conditions, and the origin is set to be the equilibrium position. Each of these constants carries a physical meaning of the motion: A is the amplitude (maximum displacement from the equilibrium position), ω=2πf is the angular frequency, and ϕ is the phase. Using the techniques of calculus, the velocity and acceleration as a function of time can be found: v(τ)=dx/dτ=−Aω sin(ωt−ϕ), speed: w√A²−x². Maximum speed: ωA (at equilibrium point) a(τ)=d²x/dτ²=−Aω² cos(ωτ−ϕ). Maximum acceleration: Aω² (at extreme points). By definition, if a mass m is under simple harmonic motion its acceleration is directly proportional to displacement; a(x)=−ω2x where ω2=k/m since ω=2πf, f=½π √k/m, and, since T=1/f where T is the time period, T=2π √m/k. These equations demonstrate that the simple harmonic motion is isochronous (the period and frequency are independent of the amplitude and the initial phase of the motion). Our system period basis of the Abelian function AI(z) may be represented as AI(z)=AI(z1, . . . , zp)=R[x1(z1, . . . , zp), . . . , xp (z1, . . . , zp)], define the period parallelotope of f(z) numeric value built from calculated the expectation value of position and momentum complex function of this form Y=e^{ipx/h}, where p is some number takes at a point relative centre number vector velocity stream period basis of the Abelian function AI(z) may be represented as AI(z)=AI(z1, . . . , zp)=R[x1(z1, . . . , zp), . . . , xp (z1, . . . , zp)], define the period parallelotope of f(z) numeric value greater than >0 some number+positive (above zero annulation) is written, or number vector velocity stream period basis of the Abelian function AI(z) may be represented as AI(z)=AI(z1, . . . , zp)=R[x1(z1, . . . , zp) xp (z1, . . . , zp)], define the period parallelotope of f(z) numeric, zero-centered calibrated zeroing annulation z-axis Load factor LF is our ratio of two forces: load (force) L, or weight W=L/W. Our global measure of stress on the structure stationary compression along the force of load axis, is three dimensions n−2+d−1+o(1) expected query time with o(n) space, matching the volume of the n-ball form a Dirichlet interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path mathematical probability add up to 1. Symmetrical sharp corners in A configuration joined regular sides ABCD by its circumscribed-sphere unit cell axial circle continued in equilateral-shape two lines of symmetry planes o(n1−2/(d+1)) expected query time with o(n) space, quantum-number matching the volume of the n-dimension n o(n1−2/(d+1)) expected query time with o(n) space, quantum-number matching the volume of the n-dimension n satisfying Vn−1<VnR, and Vn≥Vn+1R 2·f(n/2) if n is even, and n>0 f (n−1)+1 if n is odd are quantum-numbers of a dynamical system. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n-cos Θ) g-units natural base. The Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped longitude, or transverse combination while for the only transverse measure λ for (v,f) (the horocycle flow being strongly ergodic), the composition of the above analytic index with dim λ:K*(C*(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism ℏ:Y→Q such that ℏf=g, the following diagram commutes: ℏ*0→X^{g}κ_{Q}^{f}⇄_{ℏ}Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{p:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue. Trivially, the zero module {0} is injective, applied combination of Dirichlet series number of our weighted sets of objects with respect to a weight which is combined exponentially when taking Cartesian products. Suppose that A is a set with function w:A→N assigning a weight to each of the elements of A with weight n. Then we define the formal Dirichlet generating series for A with respect to w. We call such an arrangement (A,w) a weighted set. Dirichlet linear interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points evenly spaced numbers of steady-state system theory, our system and process of a steady-state solution which are null-spaces of a positive number n of length n when the state variables which define the behavior of the system and process are unchanging in time. In continuous time, this means that for those properties p of the system, the partial derivative with respect to time is zero and remains so. In mathematics and in our dynamical system, a linear difference equation equates to 0 to a polynomial that is linear in the various iterates of a variable that is, in the values of the elements of a sequence. All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. Absolute maximum of the values of the function on each set of the isotopy class [A] of closed sets, and define a lower bound of these maxima over all sets of the sub-plasma work power energy of a system E_{sys} conservation and matter relation subspace isotopic class [A]. The lower bound thus obtained will be called the maximum-minimum of the values of the function f on the class [A] and denoted by Infmax_{[A]}f the principle of least ‘stationary’ action variation function of applied action quantum mechanical environmental control unit ECU sub-plasma work power energy of a system E_{sys} conservation, and matter relation subspace isotopic class [A] system. Simplicial and powerful order of equations of the motion of our system, in relativity are the normalization function of a different action. The normalization function of a different action the motion of our system of equations eigenfunctions the principal of the eigenvalues of arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v ∈K, a∈A⇔(32); [symbol] v,π(a)*w [symbol] =0 ∀v∈K, a∈A⇔(33); [symbol] v,π(a*)w [symbol] =0 ∀v∈K, a∈A⇔(34); λ(a*)w ∈K^{⊥}∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where π is a representation of A on H and U is a unitary representation of G such that π(αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1)ϕ(spec(k)):F (spec(k))→HomS (spec(k), X(F)) is a bijection for every algebraically closed field k, (2) For any S-scheme Y and any natural transformation Ψ:F→HomS (*, Y), there is a unique natural transformation Π:HomS (*, X(F)) HomS (*, Y) such that Ψ=Π∘ϕ. These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A, μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1−a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1) ∥a∥≥|μ(a)|. For arbitrary a, ∥μ(a)|²=| [symbol] 1,a [symbol] |²→ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μ_{b} is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] (a)v¹,π²(b)v¹ [symbol] (30)) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈λ} H_{λ}, which is the subspace of the ordinary product where the inner product [symbol] v,w [symbol] =Σ_{λ∈λ} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K, a∈A⇔(32); [symbol] v,π(a)*w [symbol] =0 ∀v∈K, a∈A⇔(33); [symbol] v,π(a*)w [symbol] =0 ∀v∈K, a∈A⇔(34); π(a*)w∈K^{⊥}∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β⁻, α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|²=r²+s²+2st+t² (37) and subtracting t² from both sides gives a contradiction unless s=0. Now, if f≥0 we have ∥f−∥∥∥f∥, hence |μ(f)−∥f∥|=|Pμ(f−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. ∥μ(a)|²≤∥μ∥μ(a*a). Proof. Write μ(a*)=lim μ(a*e_{λ})=lim [symbol] a,e_{λ} [symbol] _{μ} (39) and since we know we have an inner product, this is equal to lim [symbol] e_{λ}, a [symbol] ⁻=lim μ(e*_{λ}a)⁻=μ(a)⁻ (40) as desired. Next, write |μ(a)|²=lim|μ(e_{λ}a)|²=lim| [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that pμ^{˜}((a+λ1)*(a+λ1))=μ(a*a)+λμ⁻(a)+λμ(a)+|λ|²∥μ∥ (43) which is greater than or equal to μ(a*a)−2|λ∥μ(a)|+|λ|²∥μ∥≥μ(a*a)−2|λ∥|μ|^{1/2}μ(a*a)^{1/2}+|λ|²∥μ∥=(μ(a*a)^{1/2}−|λ∥|μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict π to A, then v remains a cyclic vector for π|_{A}. Proof. Choose a self-adjoint sequence aₙ with ∥aₙ∥≤1 so that μ(aₙ)↑∥μ∥. Then ∥π(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,ν be positive linear functionals. Then μ≥ν if μ−ν≥0; we say that ν is subordinate to μ. Given μ, let (π,H,v) be the corresponding GNS representation.

Consider End_{A}(H). Let T∈End_{A}(H) be a positive operator smaller than the identity and set ν(a)=ν_{T}(a)= [symbol] π(a)Tv,v [symbol] (47). (Then T is the Radon-Nikodym derivative of ν with respect to μ.) We compute that ν(a*a)= [symbol] π(a*a)Tv,v [symbol] = [symbol] T^{1/2}π(a)v,T^{1/2}π(a)v [symbol] ≥0 (48) so ν is positive. Similarly, μ−ν is positive. Moreover, if ν_{T}=ν_{S} then T=S (by nondegeneracy). Conversely, suppose ν is a positive linear functional with μ≥ν≥0, we want to show that ν=ν_{T} for some T∈End_{A}(H). For a,b∈A we have |ν(b*a)|≤ν(a*a)^{1/2}ν(b*b)^{1/2}≤μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→ν(b*a) (50) which is well-defined by the above inequality. This is a linear functional of norm less than or equal to ∥π(b)v∥, so by the Riesz representation theorem there exists T∈End(H) such that ν(b*a)= [symbol] π(a)v,T*π(b)v [symbol] (51). Since ν≥0 we have T≥0. Since ν≤μ, we have T≤I. To show that T∈End_{A}(H), write [symbol] π(c)Tπ(a)v,π(b)v [symbol] = [symbol] Tπ(a)ν,π(C*b)v [symbol] (52)=ν((C*b)*a) (53)=ν(b*ca) (54)= [symbol] π(c)π(a)v,T*π(b)v [symbol] (55) which gives π(c)T=Tπ(c) by density. We can encapsulate our work above in the following. Proposition 2.36. The map T→ν_{T} is a bijection between {T∈End_{A}(H): 0≤T≤I} and {ν: μ≥ν≥0}. Definition A positive linear functional is pure if whenever μ≥ν≥0 then ν=rμ for some r∈[0,1]. Theorem 2.37. Let μ be a positive linear functional. Then μ is pure iff the associated GNS representation (σ,H,v) is irreducible. Proof. If μ is not pure, there is μ≥ν≥0 such that ν is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then νₚ is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>ν>0 with ν not a scalar multiple of μ. Then μ=(μ−ν)+ν which is a convex linear combination of states (once the terms have been normalized) using the fact that ∥μ−ν∥=lim(μ−ν)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V *takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a}, H^{a}) be the direct sum of the GNS representations associated to all of the extreme points of S(A). Theorem 2.39. For any a∈A we have ∥π^{a}(a)∥=∥π^{U}(a)∥=∥a∥ (where π^{U} is the universal representation). Proof. Let a∈A be self-adjoint. Then there exists ρ∈S(A) with ∥ρ(a)|=∥a∥. Let Se(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that ∥μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Sₑ(A) together with 0. 208 C*-algebras Marc Rieffel Notes by Qiaochu Yuan Spring 2013. Degenerate Abelian functions are distinguished by having infinitely small periods, such as for any number ϵ>0 it is possible to find a period wᵥ, if p=1. The vectors wᵥ of all periods, or the system of periods of the Abelian function f (z) form an Abelian group Γ under addition, the period group, or the period module, a basis of this group is a system of periods of the Abelian function, or also as a system of basic periods, an Abelian function f (z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q= [symbol] (X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1” (s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁m). Two cobordisms (W, M₀, f₀, M₁, f₁) and (W′,M₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms f does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12) τ M₀^{f0}→∂₀Wⁱ⁰→W)→Wh(π₁(W)) under the isomorphism (i₀∘f₀)_{*}:Wh(π₁(M₀))≈→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sₙ) for all p∈Z, then M is homeomorphic to Sⁿ. Proof. We only give the proof for dim(M)≥6. Since M is simply connected and H*(M)≈H*(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i=0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1}) (W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sₙ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(n) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to except for where x^{˜}x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}∫(αₑₓₚ(τx)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τX)f)(x)−f(x)/τ αₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Incipient p-wave PF power transmission superconducter the operator PF\hat{ }, that obeys the following rules: PF\hat{ }]ₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Then we have (modeled as x=A*s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (D_{X}(b))ₙ=D_{X}(bₙ) where bₙ is the n^{th} isotypic component. Let e₁, . . . e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate p(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where a∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈A, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈λ, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a ∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. The projection p:V→V/F is naturally K-oriented and the following maps from K*(V) to K(C*(V,F)) coincide: 1) p! (cf. Theorem) which, up to the Thom isomorphism, K*(F) K*+¹(V) is equal by Lemma 7 to Indₐ=Indₜ. 2) The Thom isomorphism (Appendix C): ϕ:K*(V)=K(C(V))→K(C(V)oR)=K(C*(V,F)) where we used an arbitrary flow defining the foliation. In particular, by Appendix C, ϕ k is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38)λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39)λᵥ:H*(A)→H*_{τ}(V) is to exploit the local triviality of the foliation as follows: For each open set U∈V one lets A(U) be the algebra associated by the functor C_{c}^{∞}(⋅, Ω^{1/2}) to the restriction of the foliation to U. If U₁∈U₂ one has an obvious inclusion (3.40) A(U₁)∈A(U₂). Thus, one obtains for each n a presheaf Γⁿ on V by setting (3.41) Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a·b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PEA, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S₁ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W ∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Σ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Σ^{j}(K) commute pairwise, the Σ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse A of the map ϕ_{*}([114]) (3.38)λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39)λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41)Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a-b)( [symbol] )=∫ [symbol] _{1∘} [symbol] ₂₌ [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕₖ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix M^{→}. Two pairs (S₀, g₀) and (S₁, g₁), where S i are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1z, and this property remains true whenever Θ is multiplied by an automorphism eigenvalue of modulus} 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with y we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{□}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xₙ)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈E K*(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r(y), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components Bₙ. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Linear and Local Thermal Transmittances: The linear thermal transmittance, symbol Ψ, units: W/(m·K), the heat transfer in Kelvin temperature by Newton Ring's [symbol] :=s²/2r:=N:=λ/2 is the gravitational force. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)!i!=(b−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) (n+i−1)i!=(−1)i(n+i−1)!i!(n−1)!=(−1)i(n+i−10=(−1)i(n+i−1n−1).

Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2, (1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+1 02x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴I+p^{→}·σ^{→}=(^{p4}ₚ₁^{+p3}₊ₚ₂^{p4}ₚ₁^{-p3}₋ₚ₂) with (p¹, p², p₃, p₄) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}ₐ_{^{⋅}}→(Lᵣ)ₐ·^{β}·λ^{˜}_{β}_{^{⋅}}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈}^{^{i j k}} as A·(B×C)=_{∈i j k} A^{l} B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{p:P is a prime ideal of R} is the prime radical of R smooth 1-densities on G the object functor category, G^{x}, x=r(y), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X^{g}↓_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system.

If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) bean Abelian group, define the map Z×M→M (r, m)→rm:=+m+^{(r)} . . . m if r>0, {(−m)+(−m)+^{(-r)} . . . +(−m) if r<0, {0 if r=0, from the group axioms it can be easily deduced that the previous map defines a Z action on M, in other words, every Abelian group is a Z module, the converse is also true, if (M, +) is a Z module the for any r>0 in Z one has r=1+1+^{(r)} . . . +1, and thus rm=(1+ [symbol] +1)m=1m+^{(r)} . . . +1m=m+^{(r)} . . . +m, and for r<0 one has r=(−1)+thus Z modules are precisely Abelian groups, let R be a ring, define an action of R on (R, +) by r*s:=rs, by the ring laws this action makes R into an R module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M(r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=α(v) extending to xⁿ*v:=αⁿ(v)=α(α(⁽ⁿ⁾ . . . α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n ∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • •, iₙ, 0, • • •). The admissible monomials Sq^{I′}∈a correspond to sequences of integers (i′₁, i′₂, • • •, i′ₙ, 0, • • •) where i′ₖ≥2i′ₖ₊₁ and i′ₙ≥1. It remains only to set up a one-to-one correspondence between sequences of non-negative integers l and admissible sequences I′ such that ε^{I} and Sq^{I′} have the same degree. Let Iₖ be the sequence which is zero everywhere except for a 1 in the k^{th} place. Let, l′ₖ=(2^{k-1}, 2^{k-2}, . . . 2, 1, 0, 0, • • •). We construct a map from the set of sequences l to the set of sequences I′ by insisting that Iₖ be sent to I′ₖ and that the map be additive (with respect to coordinate-wise addition). Then if I=(i₁, • • •, iₙ, 0, • • •)→I′=(i′₁, • • •, i′ₙ, 0, • • •) ε^{I} and Sq^{I′} have the same degree and we have i′ₖ=iₖ+2iₖ₊₁+ • • •+2^{n-k} iₙ. Solving for ik in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=αf₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*ₙ(L;B)→C*ₚ (K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let n be a normal subgroup of p and let y→p. Let g:(π,A,K)→(π,A,K) be the automorphism determined by y. Then the image H*ₚ(K;A)→H*_{π}(K;A) is pointwise invariant under the automorphism g.* Proof. let f: (p,A,K)→(p,A,K) be the inner automorphism determined by y. Then by 1.2, the following diagram is commutative H*ₚ(K;A)^{f*}→H*ₚ(K;A)→H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face of τ is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(αt)=h(α) C(τ) for all α∈p and τ∈K. Let ϕ:K→L be a chain map: we say ϕ is carried by C If ϕ(τ) is a chain in C(τ) for all t∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy IÐK→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group π, we can always construct a π-free acyclic simplicial complex W. Proof. We give π the discrete topology and form the infinite repeated join W=π*π*π . . . . This repeated join is a simplicial complex. Taking the join of a complex with a point gives us a contractible space. Any cycle in W must lie in a finite repeated join W′. Such a cycle is homologous to zero in W′*π. Therefore, W is acyclic. We make π act on W as follows:π acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C^{*}ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)σ⁰(xₜᵢ⁽ⁿ⁾₋₁) [(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • •, a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i √ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 is the phase factor is the complex exponential factor (e^{iΘ}). Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii)|a(t,x)−a(t,y)|+|b(t,x)−b(t,y)|≤K₂|x−y|, (iv)|a(t,x)|+|b(t,x)|≤K₃(1+|x|), (v)|a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞) if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅ᵣ^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and M n(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in M n(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)^{r}; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1).

Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤6.2≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2, (1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+102x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p₂, p₃, p₄) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)ÐSL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}ₐ_{^{⋅}}→(Lᵣ)ₐ^{⋅β⋅}λ^{˜}_{β}_{^{⋅}}.

Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ)_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾_{⊕1}+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of L v can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps ₘFᵢ₋₁ into Then F has a filtration G·F given by (GⁿF)ᵢ=mn−iFᵢ for all n,i (where ₘ^{j}=R if j≤0), for which the map (GnF)i=mn−iFi-→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35,16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½ σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X^{g}↓_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M″ has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{p:P is a prime ideal of R} is the prime radical of R smooth 1-densities on G the object functor category, U is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r>0 in Z one has r=1+1+^{(r)} . . . +1, and thus rm=(1+ [symbol] +1)m=1m+^{(r)} . . . +1m=m+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as RR, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=α(v) extending to xⁿ*v:=αⁿ(v)=α(α(⁽ⁿ⁾ . . . α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n ∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:L→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • •, iₙ, 0, • • •). The admissible monomials Sq^{I′}∈a correspond to sequences of integers (i′₁, i′₂, • • •, i′ₙ, 0, • • •) where i′ₖ≥2i′ₖ₊₁ and i′ₙ≥1. It remains only to set up a one-to-one correspondence between sequences of non-negative integers l and admissible sequences I′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • •). We construct a map from the set of sequences I to the set of sequences I′ by insisting that Iₖ be sent to I′ₖ and that the map be additive (with respect to coordinate-wise addition). Then if I=(i₁, • • •, iₙ, 0, • • •)→I′=(i′₁, • • •, i′ₙ, 0, • • •) ε^{I} and Sq^{I′} have the same degree and we have i′ₖ=iₖ+2iₖ₊₁+ • • •+2^{n-k}iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*″. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ(K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let π be a normal subgroup of p and let y→p. Let g:(π,A,K)→(π,A,K) be the automorphism determined by y. Then the image H*ₚ(K;A)→H*_{π}(K;A) is pointwise invariant under the automorphism g.* Proof. let f: (p,A,K)→(p,A,K) be the inner automorphism determined by y. Then by 1.2, the following diagram is commutative H*ₚ(K;A)^{f*}→H*ₚ(K;A)→H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face of τ is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(αt)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group n, we can always construct a π-free acyclic simplicial complex W.

Proof. We give π the discrete topology and form the infinite repeated join W=π·π·π . . . . This repeated join is a simplicial complex. Taking the join of a complex with a point gives us a contractible space. Any cycle in W must lie in a finite repeated join W′. Such a cycle is homologous to zero in W′·π. Therefore, W is acyclic. We make π act on W as follows:π acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivalent chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C*ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and τ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, Nϕ as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕₖ=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • •, a_{g}, b_{g}; ┌[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d i (n, k)=(−1)^{n-k}=|S₁(n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (Zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings M n(R)) since dim(e)=τ(e), for the projections that belong to i √ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (Zₙ)_{n=0, 1, 2, . . .} of 0's and 1's that satisfies the following coherence rule: zₙ=1 ⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let z=f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii)|a(t,x)−a(t,y)|+|b(t,x)−b(t,y)|≤K₂|x−y|, (iv)|a(t,x)|+|b(t,x)|≤K₃(1+|x|), (v)|a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work.

We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of 6 can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X0−Y₀^{δ}|²)^{1/2}≤K₁ δ_{1/2}, (iii)|a(t,x)−a(t,x)|+|b(t,x)−b(t,x)|≤K₂|x−y|, (iv)|a(t,x)|+|b(t,x)|≤K₃(1+|x|), (v)|a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)+)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of G can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii)|a(t,x)−a(t,y)|+|b(t,x)−b(t,y)|≤K₂|x−y|, (iv)|a(t,x)|+|b(t,x)|≤K₃(1+|x|), (v)|a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on b. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b₀₀ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1” (s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ(W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′,M₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12) τM₀^{f0}→∂₀Wⁱ⁰→W)∈Wh(π₁(W)) under the isomorphism (i₀∘f₀)_{*}:Wh(π₁(M₀))^{≅}→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H_{*}(M)≅H_{*}(Sⁿ), one can conclude from the Hurewicz Theorem and Whitehead Theorem [255, Theorem IV.7.13 on page 181 and Theorem IV.7.17 on page 182] that there is a homotopy equivalence f:M→Sₙ. Let Dⁿᵢ⊆M for i=0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f⁻:Dⁿ₀→Dⁿ₁ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0,1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation ^{˜} on a set S is called quasi-reflexive if every element that is related to some element is also related to itself, formally: ∀x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}αₑₓₚ(τx)∫G f(x)αₓ(b)dx−∫G f(x)αₓ(b)dx/τ=lim_{τ→0}1/τ(∫f(x)αₑₓₚ(τx)×(b)−∫f(x)αₓ(b)dx)=lim_{τ→0}∫(αₑₓₚ(τX)f)(x)−f(x)/τ αₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=δ^{(n,m)} (U₀∩U₁∩ . . . ∩Uₚ),b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Then we have (modeled as x=A*s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (D_{X}(b))ₙ=D_{X}(bₙ) where bₙ is the n^{th} isotypic component. Let e₁, . . . e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a ∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σₖ a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈λ, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a ∈|∩J we have ka−aeλk→0 where aeλ∈IJ, hence a ∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2ε for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x a [0,1]. The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure A for (V,F) (the horocycle flow being strongly ergodic), the composition of the above analytic index with dim_{∧}: preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩ₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse X of the map ϕ_{*}([114]) (3.38) λ:H*(A) H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂)∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PEA, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀#S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r(y) and X₁ G^{x}, x=r(y), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r(y), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X; as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τ₀=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∪[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number z a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z²q(Γ,C). Then by Section 2 [symbol] ) one has (3.36) ϕ(c)=τ_{c}. But the cyclic cocycle To of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ*([114]) (3.38)λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B, δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω¹/²) of smooth compactly supported sections of Ω¹/² with the convolution product (a*b)( [symbol] )= [symbol] a( [symbol] ₁)b( [symbol] ₂)∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r(y) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to A×B C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r(y), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with y we have y=0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate i-plane tangent to S at P and we then define the second fundamental form in the same way. Nearby twisted by ϕ are the molecular semi-direct products 1-1 structure filtration. The set Pn can be filtered by FkPn:=∪i≤Pn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components Bₙ. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Linear and Local Thermal Transmittances: The linear thermal transmittance, symbol ψ, units: W/(m·K), the heat transfer in Kelvin temperature by Newton Ring's ℏ:=s²/₂r:=N:=λ/2 is the gravitational force. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=b·/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)→i!(n−1)!=(−1)i(n+i−1i)=(−1)i(n+i−1n−1).

Thus(x+1)−n=Σi=0∞(−1)i(n+i−1n−1)xi=Σᵢ=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17,

where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k,

where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2, (1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k,

where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+)(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+1 02x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)² (p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴I+p^{→}·σ^{Σ}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²−(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)└SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}ₐ_{^{⋅}}→(Lᵣ)ₐ^{⋅β⋅}λ^{˜}_{β}_{^{⋅}}. We obtain a confining potential that is strongly anisotropic the range signals (sources) of variations in directions and our system of equations orders in the number of terms in magnitudes. Our limit in the ratio of our signals (sources) under gamma's definition [symbol] =lim_{n→∞}(Hₙ−1n n), when rewritten as the asymptotic approximation Hₙ≈1n n+ [symbol] , provides a simple (and accurate) method for approximating the partial sums of the harmonic series y allowing the harmonic series to be replaced by logarithms, this time not as an estimate but the exact limit. For fixed xᵢ (i=1, . . . , p) the function f (xᵢ, cⱼ) is defined on the manifold N a and the points of the set D c are critical for f(xᵢ, cⱼ), so that D_{c} contains a least PrE1N^{q} geometrically distinct points. Changing xᵢ (i=1, . . . , p) and taking into account that merging of geometrically distinct critical points is not possible, we can now assert that D_{c} contains at least PrE1N^{q}, generally speaking, nonintersecting²² sets, homeomorphic to M^{p}. The points of set D_{c} at which the determinant 2f/cᵢcⱼ≠0, classified by certain properties of envelopes and method of Ljustenik and Snirel'man for estimating the number of geometrically distinct critical points can be classified into various types, and depending on these types, one can make some inferences regarding their position relative to nearby level surface point structure, or solid domain occupies surface point structure which makes it possible in turn to investigate certain properties of envelopes. The maximum-minimum principle and its generalization. The generalization of the method of Ljustenik and Snirel'man for estimating the number of geometrically distinct critical points. A collection of sets closed with the respect to isotopic deformation in the space Mⁿ will be called an isotopy class. A collection of sets forming an isotopy class must, along with any set A, contain all isotopic deformations 1(A) of the set A. One can obtain an isotopy class by considering the collection of all the sets of a given space having in common some topological or isotopic property. The following sets form isotopy classes: (a) the collection of sets of some manifold M containing a cycle homologous in M to a given cycle [symbol] ; (b) the collection of sets of a manifold M containing a cycle homotopic to a given cycle [symbol] ; (c) the collection of sets of a manifold M containing a cycle isotopic to a given cycle [symbol] ; (d) the collection of all sets of a manifold of a given length or of given category; (e) the collection of sets whose category or length is not less than a given number p. An isotopy class is said to be closed if it contains the topological limit of any sequence of sets in it. Indeed, let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series at 0; or zero power (except 0) equals 1. A power series (centered at 0) is a series of the form ^{∞}Σₙ₌₀ aₙxⁿ=a₀+a₁x+a₂x²+ . . . +aₙxⁿ+ . . . , where the aₙ are some coefficients. If all but finitely many of the aₙ are zero, then the power series is a polynomial function, but if infinitely many of the aₙ are nonzero, then we need to consider the convergence of the power series. The basic facts are these: Every power series has a radius of convergence 0≤R≤∞, which depends on the coefficients aₙ. The power series converges absolutely in |x|<R and diverges in |x|>R, and the convergence is uniform on every interval |x|<ρ where 0≤ρ<R. If R>0, the sum of the power series is infinitely differentiable in |x|<R, and its derivatives are given by differentiating the original power series term by term. Power series work just as well for complex numbers as real numbers, and are in fact best viewed from that perspective, but we restrict our attention here to real-valued power series. Definition 6.1 Let (aₙ)^{∞}ₙ₌₀ be a sequence of real numbers and c E R. The power series centered at c with coefficients aₙ is the series ^{∞}Σₙ₌₀aₙ(x−c)ⁿ. Power series centered at 0: ^{∞}Σₙ₌ₒxⁿ=1+x+x²+x³+x⁴+ . . . , ^{∞}Σₙ₌₀1/n!xⁿ=1+x+½x²+⅙x³+½\acute{4}x⁴++ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . , The power series in Definition 6.1 is a formal expression, since we have not said anything about its convergence. By changing variables x→(x−c), we can assume without loss of generality that a power series is centered at 0, and we will do so when it's convenient. Radius of convergence first, we prove that every power series has a radius of convergence. Theorem 6.2 let ^{∞}Σₙ₌₀aₙ(x−c)ⁿ be a power series. There is an 0≤R≤∞ such that the series converges absolutely for 0≤x−c|<R and diverges for |x−c|>R. Furthermore, if 0≤ρ<R, then the power series converges uniformly on the interval |x−c|≤ρ, and the sum of the series is continuous in |x−c|<R. Proof. Assume without loss of generality that c=0 (otherwise, replace x by x−c). Suppose the power series ^{∞}Σₙ₌₀ aₙxⁿ₀ converges for some x0∈R with x₀≠0. Then its terms converge to zero, so they are bounded and there exists M≥0 such that |aₙxⁿ₀|≤M for n=0, 1, 2, . . . , If |x|<|x|, then |aₙxⁿ|=|aₙxⁿ₀∥x/x₀|ⁿ≤Mrⁿ, r=|x/x₀|<1. Comparing the power series with the convergent geometric series Σ Mrⁿ, we see that Σ aₙxⁿ is absolutely convergent. Thus, if the power series converges for some x₀∈R, then it converges absolutely for every x∈R with |x|<|x₀|. Let R=sup {|x|≥0: Σ aₙxⁿ converges}. If R=0, then the series converges only for x=0. If R>0, then the series converges absolutely for every x∈R with |x|<R, because it converges for some x₀∈R with |x|<|x₀|<R. Moreover, the definition of R implies that the series diverges for every x∈R with |x|>R. If R=∞, then the series converges for all x∈R. Finally, let 0≤ρ<R and suppose |x|≤ρ. Choose σ>0 such that ρ<σ<R. Then Σ|aₙσⁿ| converges, so |aₙσⁿ|≤M, and therefore |aₙxⁿ|=|aₙσⁿ| |x/σ|ⁿ≤|aₙσⁿ| |ρ/σ|ⁿ≤Mrⁿ, where r=ρ/σ<1. Since Σ Mrⁿ<∞, the M-test (Theorem 5.22) implies that the series converges uniformly on |x|≤ρ, and then it follows from Theorem 5.16 that the sum is continuous on |x|≤ρ. Since this holds for every 0≤ρ<R, the sum is continuous in |x|<R. The following definition therefore makes sense for every power series. If the power series ^{∞}Σₙ₌₀ aⁿ(x−c)n converges for |x−c|<R and diverges for |x−c|>R, then 0≤R≤∞ is called the radius of convergence of the power series. Theorem 6.2 does not say what happens at the endpoints x=c±R, and in general the power series may converge or diverge there. we refer to the set of all points where the power series converges as its interval of convergence, which is one of (c−R, c+R), (c−R, c+R], [c−R, c+R), [c−R, c+R]. We will not discuss any general theorems about the convergence of power series at the endpoints (the Abel theorem). Theorem 6.2 does not give an explicit expression for the radius of convergence of a power series in terms of its coefficients. The ratio test gives a simple, but useful, way to compute the radius of convergence, although it doesn't apply to every power series. Theorem 6.4 suppose that aₙ≠0 for all sufficiently large n and the limit R=lim_{n→∞}|aₙ/aⁿ+1| exists or diverges to infinity. Then the power series ^{∞}Σₙ₌₀ aⁿ(x−c)ⁿ has radius of convergence R. Proof. Let r=lim_{n→∞}|aₙ+1(x−c)ⁿ⁻¹/aₙ(x−c)ⁿ|=|x−c| lim_{n→∞} |an+1/an|. By the ratio test, the power series converges if 0≤r<1, or |x−c|<R, and diverges if 1<r≤∞, or |x−c|>R, which proves the result. The root test gives an expression for the radius of convergence of a general power series. Theorem 6.5 (Hadamard). The radius of convergence R of the power series ^{∞}Σₙ₌₀ aⁿ(x−c)ⁿ is given by R=1/lim sup_{n→∞} |an|^{1/n} where R=0 if the lim sup diverges to ∞, and R=∞ if the lim sup is 0. Proof. Let r=lim sup_{n→∞}|aₙ(x−c)ⁿ|^{1/n}=|x−c| lim sup_{n→∞} |aⁿ|^{1/n}. By the root test, the series converges if 0≤r<1, or |x−c|<R, and diverges if 1<r≤∞, or |x−c|>R, which proves the result. This theorem provides an alternate proof of Theorem 6.2 from the root test; in fact, our proof of Theorem 6.2 is more or less a proof of the root test. Definition of convergence and divergence in series the n^{th} partial sum of the series ^{∞}Σₙ₌₁ aₙ is given by Sₙ=a₁+a₂+a₃+ [symbol] +aₙ. If the sequence of these partial sums {Sₙ} converges to L, then the sum of the series converges to L. If {Sₙ} diverges, then the sum of the series diverges. Operations on convergent series if Σ aₙ=A, and Σ bₙ=B, then the following also converge as indicated: Σcaₙ=cA Σ(aₙ+bₙ)=A+B Σ(aₙ−bₙ)=A−B. Alphabetical listing of convergence tests absolute convergence if the series ^{∞}Σₙ₌₁|aₙ| converges, then the series ^{∞}Σₙ₌₁ aₙ also converges. Alternating series test if for all n, aₙ is positive, non-increasing (i.e. 0<aₙ₊₁<=aₙ), and approaching zero, then the alternating series ^{∞}Σₙ₌₁ (−1)ⁿ aₙ and ^{∞}Σₙ₌₁ (−1)ⁿ⁻¹ aₙ both converge. If the alternating series converges, then the remainder R_{N}=s−S_{N} (where s is the exact sum of the infinite series and S_{N} is the sum of the first N terms of the series) is bounded by |R_{N}|<=a_{N+1}. Deleting the first N terms if N is a positive integer, then the series ^{∞}Σₙ₌₁ aₙ and ^{∞}Σ a_{n n=N+1} both converge or both diverge. Direct comparison test if 0<=aₙ<=bₙ for all n greater than some positive integer, then the following rules apply: If ^{∞}Σₙ₌₀bₙ converges, then ^{∞}Σₙ₌₁ aₙ converges. If ^{∞}Σₙ₌₁ aₙ diverges, then ^{∞}Σₙ₌₁ bₙ diverges. Geometric series convergence the geometric series is given by ^{∞}Σₙ₌₀ a rⁿ=a+a r+a r²+a R³+ . . . If |r|<1 then the following geometric series converges to a/(1−r). If |r|>=1 then the above geometric series diverges. Integral test if for all n>=1, f(n)=aₙ, and f is positive, continuous, and decreasing then ^{∞}Σₙ₌₁ aₙ and ∫^{∞}₁ aₙ either both converge or both diverge. If the above series converges, then the remainder R_{N}=s−S_{N} (where s is the exact sum of the infinite series and S_{N} is the sum of the first N terms of the series) is bounded by 0<=R_{N}<=∫(N . . . ∞) f(x) dx. Limit comparison test if lim (n-->) (aₙ/bₙ)=L, where aₙ, bₙ>0 and L is finite and positive, then the series ^{∞}Σₙ₌₁ aₙ and ^{∞}Σₙ₌₁ bₙ either both converge or both diverge. n^{th}-Term test for divergence if the sequence {aₙ} does not converge to zero, then the series ^{∞}Σₙ₌₁ aₙ diverges. p-Series convergence the p-series is given by ^{∞}Σₙ₌₁1/n-isotypic=1/1^{p}+1/2^{p}+1/3^{p}+ . . . where p>0 by definition. If p>1, then the series converges. If 0<p<=1 then the series diverges. Ratio test if for all n, n≠0, then the following rules apply: Let L=lim (n-->∞)|aₙ₊₁/aₙ|. If L<1, then the series ^{∞}Σₙ₌₁ aₙ converges. If L>1, then the series ^{∞}Σₙ₌₁ aₙ diverges. If L=1, then the test in inconclusive. Root test let L=lim (n-->∞)|aₙ|^{1/n}. If L<1, then the series ^{∞}Σₙ₌₁ aₙ converges. If L>1, then the series ^{∞}Σₙ₌₁ aₙ diverges. If L=1, then the test in inconclusive. Taylor series convergence if f has derivatives of all orders in an interval I centered at c, then the Taylor series converges as indicated: ^{∞}Σₙ₌₀ (1/n!) f(n)(c) (x−c)ⁿ=f(x) if and only if lim (n-->∞) Rₙ=0 for all x in I. The remainder R_{N}=s−S_{N} of the Taylor series (where s is the exact sum of the infinite series and S_{N} is the sum of the first N terms of the series) is equal to (1/(n+1)!) f⁽ⁿ⁺¹⁾(z) (x−c)ⁿ⁺¹, where [symbol] is some constant between x and c. Impellers; turbo-shaft; turbo-fan; turbo-fluid; turbo-jet; or fluid-propulsion heat a heater fluid a superconductor of magnetic-enthalpy in symbol H continue our set of natural numbers is denoted N, we adopt member of the set of positive integers 1, 2, 3, . . . (OEIS A000027) or to the set of nonnegative integers 0, 1, 2, 3, . . . (OEIS A001477; e.g., Bourbaki 1968, Halmos 1974). (We refer to). Ribenboim (1996) states “Let P be a set of natural numbers; whenever convenient, it may be assumed that 0∈P”. We summand a directed left module Q over the ring R so to be injective satisfying 1-1 structure of the Dual Algebra the monomials ε^{I} in a′ correspond in a one-to-one way with sequences of non-negative integers (i₁, i₂, • • •, iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓_{Q}^{f}⇄ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). Optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). In the noncommutative case, we call such things C*-dynamical systems. A covariant representation of a C*-dynamical system (A,G,α) is a triple (H,π,U) where n is a representation of A on H and U is a unitary representation of G such that π (αₓ(a))=Uₓπ(a)Uₓ⁻¹. There is a universal C*-algebra whose representations correspond to covariant representations of a given C*-dynamical system. If f∈C_{c}(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X xₛ E. Let the Hilbert Functor Let X→S be a projective scheme, O(1) a relatively ample line bundle and P a fixed polynomial. Let Hilb_{P} (X/S): {Schemes/S}→{sets} be the contravariant functor that associates to an S scheme Y the subschemes of X xₛ Y which are proper and flat over Y and have the Hilbert polynomial P and Let Moduli of stable curves Let ⁻M_{g}: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F) E F(X(F)) represents the functor finely if for every S scheme Y the map Horns (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→Hom_{S}(*, X(F)) such that (1) [symbol] (spec(k)): F (spec(k))→Hom_{S} (spec(k), X(F)) is a bijection for every algebraically closed field k, (2) For any S-scheme Y and any natural transformation Ψ:F→Hom_{S} (*, Y), there is a unique natural transformation Π: Hom_{S} (*, X(F)) Hom_{S} (*, Y) such that Ψ=Π∘ [symbol] . These functors above pose a moduli problem. The first step in our solution of such a problem is to construct a smooth, projective variety/proper scheme/proper Deligne-Mumford stack that represents the functor finely/coarsely. We operate on the Grassmannian Group Plate Projective Space, by definition, parameterizes one-dimensional subspaces in our affine space. The Grassmann varieties or Grassmannians parameterize higher-dimensional subspaces. Let V be a finite-dimensional vector space. As a set, we define G (k,V)={U⊂V: U is a k-dimensional subspace of V} G (k,n)={U⊂Kⁿ: U is a k-dimensional subspace of Kⁿ} By definition, G((k, n))=G(k+1, n+1) when dealing with our subspaces of Pⁿ. To turn the Grassmannian into a variety, we need a coordinate system for subspaces. For projective space, a homogeneous coordinate-tuple [Z₀, . . . , Zₙ] represents an equivalence class of points in Aⁿ⁺¹, namely all points on the same line through the origin. This equivalence can be seen as coming from a group action. The multiplicative group K* acts on Aⁿ⁺¹ \{0} by scalar multiplication and each point of Pⁿ corresponds to an orbit of this action, in other words, Pⁿ is the quotient space (Aⁿ⁺¹\{0})/K*. We can try the same for the Grassmannian: A k-dimensional subspace of Kⁿ is spanned by k vectors. So we look at the space of all k-tuples of linearly independent vectors, which we think k×n-matrices. The group of GLₖ(k) acts on this space by multiplication from the left, and two k×n-matrices have the same row space iff they are in the same orbit under this group action. So we can identify G(k,n) with the quotient space Mat^{(k)}_{k×n} (K)/GLₖ(K). Where Mat^{(k)} is the set of matrices of rank k. Looking further at a group action we know that if the first k×k-minor of the matrix on the right is non-zero, the orbit contains a unique element of a form. Conversely, we obtain a matrix of rank k for any k×(n−k)-matrix B on the right. In other words, the row spans of matrices of this form are in bijection with an affine space A^{k(n-k)}. But this involved a choice coming from the assumption that the first k×k-minor is non-zero. In general, we have to permute columns first. So we see in this way the Grassmannian G(n,k) is covered by (ⁿₖ) copies of affine spaces A^{k(n-k)}. (Note the analogy with projective space.) In particular, whatever the Grassmannian is a variety, it must be of dimension k(n−k). The Grassmannian G(r,n) is the set of r-dimensional subspaces of the k-vector space kⁿ; it has a natural bijection with the set G(r−1,n−1) of (r−1)-dimensional linear subspaces P^{r-1}⊆Pⁿ. We write G(k,V) for the set of k-dimensional subspaces of an n-dimensional k-vector space V. We'd like to be able to think of G(r,V) as a quasiprojective variety; to do so, we consider the Plücker embedding: r [symbol] : G(r,V)→P(∧V) Span(v₁, . . . , vᵣ) [symbol] [v₁∧ . . . ∧vᵣ]. If (wᵢ=Σj aᵢⱼvⱼ)1≤i≤r is another ordered basis for ∧=Span(v₁, . . . , vᵣ), where A=(aᵢⱼ) is an invertible matrix, then w₁∧ . . . ∧wᵣ=(detA)(v₁∧ . . . ∧vᵣ). Thus the Plücker embedding is a well-defined function from G(k,V) to P(∧^{r}V). We would like to show, in analogy with what we were able to show for the Segre embedding a: P(V)×P(W)→P(V⊗W), that the Plücker embedding y is injective, the image [symbol] (G(r,V)) is closed, and the Grassmannian G(r,V) “locally” can be given a structure as an affine variety, and y restricts to an isomorphism between these “local” pieces of G(r,V) and Zariski open subsets of the image. Given x∈∧A^{r} V, we say that x is totally decomposable if x=v₁∧ . . . ∧vᵣ for some v₁, . . . , vᵣ∈V, or equivalently, if [x] is in the image of the Plücker embedding. Grassmannian Group Plate Projective Space, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=C₁ (α₁∧β)+c₂ (α₂∧β) α∧(c₁ β₁+c₂ β₂)=c₁(α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁ ∧ . . . ∧e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂) ∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k−(x−h). Fluid dynamics mathematic optimum series, and parallel integral to the current, optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). There is a universal C*-algebra whose representations correspond to covariant representations of a given C*-dynamical system equilibrium [symbol] -component of M^{→}, Magnetization of a Field Element when all fields are 0; atmospheric, temperature and pressure correction system of integration state of the input variables presence of constraint mathematical field of complex analysis F(−x₁, −x₂, . . . , −x₄)=F(x₁, x₂, . . . , xₙ) solving the for the system of equations the series of a real, or complex valued function continue a collective dynamic function of the complex space C^{p}, p≥1 eigenfunctions form a complete subspace S to sets linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 principal of eigenvalues in arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] n(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A, μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where π is a representation of A on H and U is a unitary representation of G such that π(αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors ϕ:F→HomS (*, X(F)) such that (1) ϕ (spec(k)):F (spec(k))→HomS (spec(k), X(F)) is a bijection for every algebraically closed field k, (2) For any S-scheme Y and any natural transformation ψ:F→HomS (*, Y), there is a unique natural transformation Π:HomS (*, X(F)) HomS (*, Y) such that ψ=Π∘ϕ. These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψψ [symbol] is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A, μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1−a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1)≥|μ(a)≡. For arbitrary a, |μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μ_{b} is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1)∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={πt(a)v:a∈A}⁻ (29). Then Kᵥ is invariant under the action of A; in fact it is the minimal closed subspace invariant under A containing v. We call Kᵥ the cyclic subspace generated by v. The representations L²(A, μ) is cyclic with cyclic vector the image of the identity. Proposition 2.20. Let (π¹,H¹,v¹) and (π²,H²,v²)) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if λπ_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K, a∈A⇔(32); [symbol] v,π(a)*w [symbol] =0 ∀v∈K, a∈A⇔(33); [symbol] v,π(a*)w [symbol] =0 ∀v∈K, a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β,⁻ α⁻). Lemma 2.24. Let A be a C*-algebra and μ a continuous linear functional such that ∥μ∥=μ(1).

Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|²=r²+s²+2st t² (37) and subtracting t² from both sides gives a contradiction unless s=0. Now, if f≥0 we have ∥f−∥f∥∥≤∥f|, hence |μ(f)−∥f∥|=|μ(f−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻¹. 2. |μ(a)|²≤∥μ∥μ(a*a). Proof. Write μ(a*)=lim μ(a*e_{λ})=lim [symbol] a,e_{λ} [symbol] _{μ} (39) and since we know we have an inner product, this is equal to lim [symbol] e_{λ}, a [symbol] ⁻=lim μ(e*_{λ}a)⁻=μ(a)⁻ (40) as desired. Next, write |μ(a)|²=lim|μ(e_{λ}a)|²=lim| [symbol] e*_{λ},a [symbol] _{μ}∥² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜l ((a+λ}1)*(a+λ1))=μ(a*a)+λμ⁻(a)+|λ|²∥μ∥ (43) which is greater than or equal to μ(a*a)−2|λ∥μ(a)|+|λ|²∥μ∥≥(a*a)−2|λ∥|μ∥^{1/2}μ(a*a)^{1/2}+|λ|²∥μ∥=(μ(a*a)^{1/2}−|λ∥|μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict n to A, then v remains a cyclic vector for π|_{A}. Proof. Choose a self-adjoint sequence aₙ with ∥aₙ∥≤1 so that μ(aₙ)↑∥μ∥. Then ∥π(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] →( [symbol] ,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,ν be positive linear functionals. Then μ≥ν if μ−ν≥0; we say that ν is subordinate to μ. Given μ, let (π,H,v) be the corresponding GNS representation. Consider End_{A}(H). Let T∈End_{A}(H) be a positive operator smaller than the identity and set ν(a)=ν_{T}(a)= [symbol] π(a)Tv,v [symbol] (47). (Then T is the Radon-Nikodym derivative of ν with respect to μ.) We compute that ν(a*a)= [symbol] π(a*a)Tv,v [symbol] = [symbol] T^{1/2}π(a)v,T^{1/2}π(a)v [symbol] ≥0 (48) so ν is positive. Similarly, μ−ν is positive. Moreover, if ν_{T}=ν_{S} then T=S (by nondegeneracy). Conversely, suppose ν is a positive linear functional with μ≥ν≥0, we want to show that ν=ν_{T} for some T∈End_{A}(H). For a,b∈A we have |ν(b*a)|≤ν(a*a)^{1/2}ν(b*b)^{1/2}≤μ(a*a)^{1/2}≤μ(b*b)^{1/2}=∥π(a)v∥∥π(b)v∥ (49). In particular, if the RHS is zero, so is the LHS. For fixed b, we can attempt to write down a map π(a)v→ν(b*a) (50) which is well-defined by the above inequality. This is a linear functional of norm less than or equal to ∥π(b)v∥, so by the Riesz representation theorem there exists T∈End(H) such that ν(b*a)= [symbol] π(a)v,T*π(b)v [symbol] (51). Since ν≥0 we have T≥0. Since ν≤μ, we have T≤I. To show that T∈End_{A}(H), write [symbol] π(c)Tπ(a)v, π(b)v [symbol] = [symbol] Tπ(a)v,π(C*b)v [symbol] (52)=ν((C*b)*a) (53)=ν(b*ca) (54)= [symbol] π(c)π(a)v,T*π(b)v [symbol] (55) which gives π(c)T=Tπ(c) by density. We can encapsulate our work above in the following. Proposition 2.36. The map T→ν_{T} is a bijection between {T∈End_{A}(H): 0≤T≤I} and {ν: μ≥ν≥0}. Definition A positive linear functional is pure if whenever μ≥ν≥0 then ν=rμ for some r∈[0,1]. Theorem 2.37. Let u be a positive linear functional. Then μ is pure iff the associated GNS representation (π,H,v) is irreducible. Proof. If μ is not pure, there is μ≥ν≥0 such that ν is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then ν_{P} is not a multiple of μ. Proposition 2.38. (We may recall that the space of states S(A) is convex.) Let μ∈S(A). Then μ is pure if and only if μ is an extreme point of S(A). Proof. If μ is not extreme, pμ=τμ₁+(1−τ) μ₂ where μᵢ∈S(A), τ∈(0,1), and μ₁≠μ≠μ₂. Then μ≥τμ₁, so μ is not pure. Conversely, suppose μ is not pure, so there is μ>ν>0 with ν not a scalar multiple of μ. Then μ=(μ−ν)+ν which is a convex linear combination of states (once the terms have been normalized) using the fact that ∥μ−ν∥=lim(μ−ν)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V *takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥==∥π^{U}∥=∥a∥ (where π^{U} is the universal representation). Proof. Let a∈A be self-adjoint. Then there exists ρ∈S(A) with |ρ(a)|=∥a∥. Let Sₑ(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that |μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Se(A) together with 0. 208 C*-algebras Marc Rieffel Notes by Qiaochu Yuan Spring 2013. Mathematic calculus number theorem optimal control theory 3-7. Groß in 8, and Liu et al. in 9 gave the solvability conditions for Hermitian solution a formalism constraint and its expressions a composite number 2ⁿ−1 of fluid dynamics mathematic control enhance optimum series and parallel integral to the current a dynamical system normalized function of atmospheric, temperature and pressure correction system of integration state of the input variables presence of constraint mathematical field of complex analysis expressions. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. (N):=c prime force the sum of prime numbers n in c. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+P_{n+1/2}. The Acyclicity of the Koszul complex Rohlin's Theorem (strong form). Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, [symbol] ₁, [symbol] ₂ are the longitude, or transverse combination while for the only transverse measure X for (v,f) (the horocycle flow being strongly ergodic), the composition of the above analytic index with dimλ:K*(C*(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓_{Q}^{f}⇄ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction″ the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue. Trivially, the zero module {0} is injective relaxation rates respectively, connectedness definition a subset S⊆C is said to be path connected if for all z₁, z₂∈S there exists a path y in S from z₁ to z₂. Definition. A subset S⊆C is said to be step connected if for all z₁, z₂∈S there exists a step path y in S from z₁ to z₂ equilibrium [symbol] -component of M^{→}, Magnetization of a Field Element when all fields are 0; a *-algebra A, a *-representation of A on a vector space H with pre-inner product is a map π: A→(B(H)) such that [symbol] π(a)v,w [symbol] = [symbol] v,π(a*)w [symbol] . The representation is nondegenerate if the span {π(a)v:a∈A,v∈H} is dense in H. We can represent C*-algebras on Hilbert spaces for those of the form C(X) we can choose a nice positive measure on X and look at the multiplication action on L²(X). We calculate the structure of our positive linear functionals (these are positive linear functionals on C(X) by Riesz-Markov). Such a measure gives us a pre-inner product [symbol] f,g [symbol] =∫f⁻g dμ⁻=μ(f⁻g) which we can get a Hilbert space out of and here we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1” (s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ(W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W└R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′, M₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12)τM₀^{f0}→∂₀Wⁱ⁰→W)∈Wh(π₁(W)) under the isomorphism (i₀∘f₀)*: Wh(π₁(M₀))≅→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group.

Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H*(M)≅H*(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i=0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0,1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications″. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀x, y∈S:x^{˜}y (x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of and the identity relation on S, formally: (≃)=(^{˜})∪(=). For example, the reflexive closure of x<y is x≤y. The reflexive reduction, or irreflexive kernel, of a binary relation on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Theorem 7.6. (Gârding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim _{τ→0} αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(_{τ}X)f)(x)−f(x)/τ αₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gârding domain). The construction b→α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1}. strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Then we have (modeled as x=A*s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (D_{X}(b))ₙ=D_{X}(bₙ) where bₙ is the n^{th} isotypic component. Let e₁, . . . , e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let A be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈λ, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2 Å for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where r is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim n: preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V).

When one varies V without varying V/F one gets the desired information. The idea of the construction of (3.39)λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U^{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PEA, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₁, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and x₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r(y), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω¹/²) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n x for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∪[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1 x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, ⋅B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (F^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G└R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H^{*}_{τ}(V) is to exploit the local triviality of the foliation as follows: For each open set U⊂V one lets A(U) be the algebra associated by the functor C_{c}^{∞}(⋅, Ω¹/²) to the restriction of the foliation to U. If U₁∈U₂ one has an obvious inclusion (3.40) A(U₁)⊂A(U₂). Thus, one obtains for each n a presheaf on Γⁿ by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖG\hat{ }ϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S i are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r(y), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components B. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Linear and Local Thermal Transmittances: The linear thermal transmittance, symbol Ψ, units: W/(m·K), the heat transfer in Kelvin temperature by Newton Ring's [symbol] :=s²/2r:=N:=λ/2 is the gravitational force. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] *, [symbol] f|Af [symbol] is real. Newtonian binomial theorem: (ⁿₖ)=n!/k!(n−k)!=n(n−1)(n−2) (n−k+1)/k!. The expression on the right makes sense even if n is not a non-negative integer, so long as k is a non-negative integer, and we therefore define (^{r}ₖ)=r(r−1)(r−2) (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1).

Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , √·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2, (1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+1 02x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1. nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. (N):=c prime force the sum of prime numbers n in c. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. The Acyclicity of the Koszul complex Rohlin's Theorem (strong form). A semiprime is any integer normalized function of temperature; and pressure correction value of number n is continued as phase factor for any complex number written in polar form (such as re^{iΘ}), the phase factor is the complex exponential factor (e^{iΘ}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. (N):=c prime force the sum of prime numbers n in c. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)ßm₊: H^{ϕ}₁⁻(F_{g-},★)⊗H^{ϕ}₁⁺(F_{g+},★)→H^{ϕ}₁(M,★) induced by the inclusions m_{±}:F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (1.2) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The existence of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. This property is exploited to produce a set of points, called Padua points, at which a function may be sampled in order to compute either a bivariate interpolation or quadrature of the function over the domain [−1,1]×[−1,1]. The relation of some Lissajous curves to Chebyshev polynomials is clearer to understand if the Lissajous curve which generates each of them is expressed using cosine functions rather than sine functions. Here x=cos(t), y=cos(Nt). Heteroclinic connections, a numerical projection is utilized of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N, and then one around L₁, the other around L₂. This heteroclinic connection augments the previously known homoclinic orbits associated with the L₁ and L₂ periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. Linking these heteroclinic connections and homoclinic orbits leads to dynamical chains which form the backbone for temporary capture and rapid resonance transition. we solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum maxima and minima defined for sets, if an ordered set of s has a greatest element m,m is a maximal element of a Sum of Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties the U(a,b) uniform distribution χ^{˜}U(a,b); probability density function PDF {1/b−a, a≤χ≤b, 0, otherwise. Mean distribution is a+b/2; and variance is (continuous) distribution 1/12(b−a)² linear, local, circular moment, or equivalently on the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path is the maximum entropy distribution among all continuous distributions which are supported in the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁l<τ₂<∧<τₙ=b of let y:uniform on [A, b]→C be a path distribution the class s of all real-valued random variables which are supported on s (whose density function is zero outside of s) for each term in the infinite sum, or equivalently, the circular mean and circular variance the base of the plane continue natural logarithm, resulting entropy by mathematical formalism constraint, the connective constant multiplication fluid dynamics. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ΔiB+½ σ(xₜᵢ⁽ⁿ⁾−₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system of X is far from being trivial our longitudinal integral of the trivial bundle does vanish, i.e. the K-theory group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii)E(|X₀−Y₀^{δ}|²)^{1/2}≤K₁ δ^{1/2}, (iii)|a(t,x)−a(t,y)|+|b(t,x)−b(t,y)|≤K₂|x−y|, (iv)|a(t,x)|+|b(t,x)|≤K₃(1+|x|), (v)|a(S,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii)|a(t,x)−a(t,y)|+|b(t,x)−b(t,y)|≤K₂|x−y|, (Iv)|a(t,x)|+|b(t,x)|≤K₃(1+|x|), (v)|a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,□] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C s-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δn} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +em(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},∈)⊗H^{ϕ}₁⁺(F_{g+},★)→H^{ϕ}₁(M,★) induced by the inclusions m_{±}: F_{g+}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution n. The transformation T defined by (Tx)ₙ=xₙ₊₁, n∈Z, is clearly an invertible μ-measure-preserving transformation. The existence of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1 π/N 2 are Chebyshev polynomials of the first kind of degree N. This property is exploited to produce a set of points, called Padua points, at which a function may be sampled in order to compute either a bivariate interpolation or quadrature of the function over the domain [−1,1]×[−1,1]. The relation of some Lissajous curves to Chebyshev polynomials is clearer to understand if the Lissajous curve which generates each of them is expressed using cosine functions rather than sine functions. Here x=cos(t), y=cos(Nt). Heteroclinic connections, a numerical projection is utilized of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1 π/N 2 are Chebyshev polynomials of the first kind of degree N, and then one around Lᵢ, the other around L₂. This heteroclinic connection augments the previously known homoclinic orbits associated with the L₁ and L₂ periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. Linking these heteroclinic connections and homoclinic orbits leads to dynamical chains which form the backbone for temporary capture and rapid resonance transition. we solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number z a complex number w such that e_{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum maxima and minima defined for sets, if an ordered set of s has a greatest element m,m is a maximal element, semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros. Furthermore, if S is a subset of an ordered set T and m is the greatest element of S with respect to order induced by T, m is a least upper bound of S in T. The similar result holds for least element, minimal element and greatest lower bound. It is also possible that the expected value restrictions for the class C force the probability distribution to be zero in certain subsets of S. The Sum of Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of r consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties the U(a,b) uniform distribution χ^{˜}U(a,b); probability density function PDF {1/b−a, a≤χ≤b, 0, otherwise. Mean distribution is a+b/2; and variance is (continuous) distribution 1/12(b−a)² linear, local, circular moment, or equivalently on the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path is the maximum entropy distribution among all continuous distributions which are supported in the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path distribution the class s of all real-valued random variables which are supported on s (whose density function is zero outside of s) for each term in the infinite sum, or equivalently, the circular mean and circular variance the base of the plane continue natural logarithm, resulting entropy by mathematical formalism constraint, the connective constant multiplication fluid dynamics atmospheric gases can be contrasted by superheated steam. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction″. Atmospheric gases can be contrasted by superheated steam is produced by passing saturated steam through an additional heat exchanger, two factors are the ordinates calculate the entropy and the absolute temperature, the total heat is given by the area enclosed by absolute zero base water line and horizontal and vertical line from the respective points, the adiabatic expansion calculate a vertical line, an adiabatic process the expansion at constant entropy with no transfer of heat, the change of entropy is input calculated value as: dS=logₑ(T1/T) where T=absolute temperature (K), the entropy of water above freezing point is input calculated value as: dS=logₑ(T1/273), entropy of evaporation, change of entropy during evaporation dS=dL/T where L=latent heat (J), the entropy of wet steam is input calculated value as: dS=logₑ(T1/273)+ζ(L1/T1) where ζ=dryness fraction, entropy of superheated steam change of entropy during super-heating input calculated value as: dS=cp logₑ(T/T1) where cp=specific heat capacity at constant pressure for steam (kJ/kgK), entropy of superheated steam input calculated value as: dS=logₑ(T1/273)+L1/T1+cp logₑ(Ts/T1) where Ts=absolute temperature of superheated steam T1=absolute temperature of evaporation, water and steam entropy are in imperial units temperature (° F.), absolute pressure (psia), and entropy (Btu/lb ° F.), the entropy of superheated steam at different pressures and temperatures are in (kJ/kgK), absolute pressure, saturation temperature, and steam temperature (° C.) are input calculated value rotation linear, local, circular moment, or equivalently the circular mean, and circular variance the equilateral joined symmetrical corners formal Dirichlet generating series the connective constant a weighted mechanical advantage set coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ. in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped re-measurement allows us to construct the second fundamental form in the same way this shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A^{Θ}, and 2) the formal “metric” dUdU*+dVdV*∈Ω²₊(A^{Θ}). We shall now give a thorough description of all the finitely generated projective modules over A^{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Therefore, a weighted mechanical coefficient base the connective constant a weighted mechanical advantage set coefficient A step path in S is a path y: [A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ specific in Newton's law of universal gravitation, Newton SI basic unit of force 1 N=1 kg×m/s² unit sign N and symbol of force F of weight-gravity G=m×g mass=m and gravity acceleration g=9.80665 m/s² Newton from Kelvin [° N]=([K]−273.15)× 33/100 to Kelvin [K]=[° N]×100/33+273.15 Linear and Local Thermal Transmittances: The linear thermal transmittance, symbol Ψ, units: W/(m·K), gives the extra heat transfer per Kelvin temperature Newton Ring's [symbol] :=s²/₂r:=N:=λ/2 expressed in differential form in the term of gravitational potential f(t, x) and the mass density ϕ(t, x) is the gravitational potential, f. Degenerate Abelian functions are distinguished by having infinitely small periods, such as for any number ϵ>0 it is possible to find a period wᵥ, if p=1. The vectors wᵥ of all periods, or the system of periods of the Abelian function f (z) form an Abelian group Γ under addition, the period group, or the period module, a basis of this group is a system of periods of the Abelian function, or also as a system of basic periods, an Abelian function f (z) is degenerate if there exists a linear transformation of the variables ^{z}1, . . . , ^{Z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period w, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. The matrix W whose columns form a period basis of the Abelian function f(z) has dimension p×2p and is known as the period matrix of the Abelian function f(z). A necessary and sufficient condition for a given matrix W of dimension p×2p to be the period matrix of some non-degenerate Abelian function f(z) exist an anti-symmetric non-degenerate square matrix M with integer elements, of order 2p, and Hermitian inner product has 1 real part symmetric positive definite, and its imaginary part symplectic by properties on a complex vector space V is a complex-valued bilinear form on V which is antilinear in the second slot, and is positive definite, following properties, where z* means the complex conjugate of z. Conditions are expressed as equations and inequalities respectively, a system of p(p−1)/2R Riemann equations and p(p−1)/2R Riemann inequalities is obtained. The number p is called the genus of the matrix W and of the corresponding Abelian function f(z). The columns wᵥ=Re wᵥ+i Im wᵥ of W, regarded as vectors in the real Euclidean space R^{2p}, define the period parallelotope of f(z). All Abelian functions corresponding to the same period matrix W form an Abelian function field ^{K}W. If the field ^{K}W contains a non-degenerate Abelian function, its degree of transcendence over the field C is p. The torus Cp/Γ is then an Abelian variety, and ^{K}W turns out to be its field of rational functions. If, on the other hand, all Abelian functions of ^{K}W are degenerate, then ^{K}W is isomorphic to the field of rational functions on an Abelian variety of dimension lower than p. The Abelian function AI(z) may be represented as AI(z)=AI(^{z}1, . . . , ^{zp})=R[^{x}1(^{z}1, . . . ^{z}p), . . . , ^{x}p (^{z}1, . . . , ^{z}p)]. A generalization of the concept of an elliptic function of the real part of one complex variable s=σ+i τ in analytic number theory to the case of several complex variables, a function f(z) in the variables ^{z}1, . . . , ^{z}p, z=(^{z}1, . . . , ^{z}p), mathematical field of complex analysis meromorphic does function on an open subset D of the complex plane is a function that is holomorphic on all of D except for a set of isolated points, in the complex space C^{p}, p≥1, p coordinates of the upper limits ^{x}1, . . . , ^{x}p, and system of sums lower integration limits ^{c}1, . . . , ^{c}p which are poles of the function in the complex space C^{p}, f(z)f(z), in the complex space, function f(z) in the variables ^{z}1, . . . , ^{z}p, ^{z=z}1, . . . , ^{z}p, is called an Abelian function if there exist ²p row vectors in C^{p}, wᵥ=(w1ᵥ, . . . , wₚᵥ), v=1, . . . , 2p, which are linearly independent over the field of real numbers and are such that f(z+wᵥ)=f(z) for all zϵC^{p}, v=1, . . . , 2p. The vectors wᵥ of all periods, or the system of periods of the Abelian function f(z) form an Abelian group Γ under addition, the period group, or the period module, a basis of this group is a system of periods of the Abelian function, or also as a system of basic periods, an Abelian function f(z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. Indeed, λ and λ^{˜} transform independently, according to λₐ→(Lₗ)ₐ^{β} λ_{β} and X^{˜}ₐ_{^{⋅}}→(Lᵣ)ₐ^{⋅β⋅}λ^{˜}_{β}_{^{⋅}}. We obtain a confining potential that is strongly anisotropic the range signals (sources) of variations in directions and our system of equations orders in the number of terms in magnitudes. Our limit in the ratio of our signals (sources) under gamma's definition [symbol] =lim_{n→∞}(Hₙ−1n n), when rewritten as the asymptotic approximation Hₙ≈1n n+ [symbol] , provides a simple (and accurate) method for approximating the partial sums of the harmonic series [symbol] allowing the harmonic series to be replaced by logarithms, this time not as an estimate but the exact limit. Spherical models critical points and several critical exponents, including the thermal exponent y [symbol] , magnetic exponent yh, and loop exponent yl. Periodic Bₙ,Bₙ(x) Bernoulli number and polynomial B^{˜}ₙ(x) periodic Bernoulli function Bₙ(x−└x┘)Bₙ and polylogarithm Lis(z) function ϕ(z,S)ϕ we incorporate the periodic set c equal to e the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum maxima and minima defined for sets, if an ordered set of s has a greatest element m,m is a maximal element of a sum. Lis(z) polylogarithm the mathematic polylogarithm function Lis(z) of order s and argument z. Only for special values of s does the polylogarithm reduce to an elementary function such as the natural logarithm or rational functions. Acyclicity of the Koszul complex Bₙ,Bₙ(x) Bernoulli number and polynomial B^{˜}ₙ(x) periodic Bernoulli function Bₙ(x−└x┘)Bₙ and Lemma 2.3 (Conca, Iyengar, Nguyen and Romer, [9, Corollary 6.4]). (We refer to) “Let f≠0 be a quadratic form in the polynomial ring k[x1, . . . , xn] (semiprime ≥1). Let R be a Cohen-Macaulay standard graded k-algebra satisfying regR=1. Then R has minimal multiplicity and glldR=dimR. In particular, if f is a non-zero quadratic form in k[x₁, . . . , xₙ], then glld(k[x]/(f))=n−1. Proof. We may assume k is infinite; see Lemma 2.2. Given Proposition 6.3, it remains to show glldR≤dimR. Note that glldR≤glld(R/Rx)+1 if x∈R₁ is R-regular; this is by Theorem 2.4. We may thus reduce to the case when dimR=0. Note that the regularity of R and its multiplicity remain unchanged.

Let R=P/I where P is a polynomial ring and I⊆m², where m=P>1. Since I has 2-linear resolution and pd_{P} R=n, there is an equality of Hilbert series H_{R}(z)(1−z)ⁿ=1−β₁z²+ [symbol] +(−1)ⁿβₙzⁿ⁺¹, where βᵢ≠0 is the ith Betti number of R over P. Therefore by comparing degrees of the polynomials, Rᵢ=0 for i≥2, so I=m². Then every R-module is Koszul, so glldR=0. The last statement holds as k[x]/(f) is Cohen-Macaulay of dimension n−1. Theorem 6.5. If R is defined by monomial relations, then glldR≥dimR. Proof. Suppose R=P/I where P=k[x₁, . . . , xₙ] is a polynomial ring and I is a monomial ideal; we may assume it is quadratic, for else Id_{R} k is infinite. Reordering the variables if necessary we may assume that in the primary decomposition of I the component of minimal height is (x²₁, . . . , x²_{q}, x_{q+1}, . . . , xₛ), where s=n−dimR. We claim that Id_{R}(R/J)=dimR where J=(x₁, . . . , xₛ, x²ₛ₊₁, . . . , x²ₙ). Indeed, set S=k[xₛ₊₁, . . . , xₙ] and let R→S be the canonical surjection. Note that the composition of the inclusion S→R with the map R→S is the identity on S. Moreover Id_{R} S=0, since R is strongly Koszul. Therefore, noting that the action of R on R/J factors through S, from Proposition 2.3 one gets the first equality below: Id_{R}(R/J)=Id_{S}(R/J)=Id_{S}(S/(x²ₛ₊₁, . . . , x²ₙ))=n−s. The last equality is a direct computation; one can get it from Lemma 6.1. By Proposition 6.3 this is the case for Cohen-Macaulay rings; more generally, it holds when R has a maximal Cohen-Macaulay module, and in particular when dimR≤2″. Absolutely Koszul Algebras and The Backlin-Roos Property by Aldo Conca, Srikanth B. Iyengar, Hop D. Nguyen, and Tim Römer. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Dirichlet linear, local, or ring the connective constant a weighted mechanical advantage set coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ generating series number A spaces two coordinates position. The Real and Complex Hermitian Solutions to a System of Quaternion Matrix Equations with Applications by Shao-Wen Yu. We establish necessary and sufficient conditions for the existence of and the expressions for the general real and complex Hermitian solutions to the classical system of quaternion matrix equations A₁X C₁, XB₁C₂, and A^{3x A*3}=C₃. Moreover, formulas of the maximal and minimal ranks of four real matrices X₁,X₂,X₃, and X₄ in solution X X₁ X₂i X₃j X₄k to the system mentioned above are derived. As applications, we give necessary and sufficient conditions for the quaternion matrix equations A₁X C₁,XB₁ C^{2, A3 X A*3}=C₃, and A^{4, X A*4}=C₄ to have real and complex Hermitian solutions. 1. Introduction Throughout this paper (we refer to), we denote the real number field by R; the complex field by C; the set of all m×n matrices over the quaternion algebra Ha₀a₁i a₂j a₃k|i² j² k² ijk−1,a₀,a₁,a₂,a₃∈R 1.1 by H^{m×n}; the identity matrix with the appropriate size by I; the transpose, the conjugate transpose, the column right space, the row left space of a matrix A over H by A^{T},A*,RA, NA, respectively; the dimension of RA by dim RA. By 1, for a quaternion matrix A, dim RA dim NA. dim RA is called the rank of a quaternion matrix A and denoted by rA. The Moore-Penrose inverse of matrix A over H by A^{†} which satisfies four Penrose equations AA^{†}A A,A^{†}AA^{†} A^{†},AA^{†}*AA^{†}, and A^{†}A* A^{†}A. In this case, A^{†} is unique and A^{†}*A*^{†}. Moreover, R_{A} and L_{A} stand for the two projectors L_{A}|−A^{†}A, and R_{A}|−AA^{†} induced by A. Clearly, R_{A} and L_{A} are idempotent and satisfies R_{A}*R_{A}, L_{A}*L_{A}, R_{A} L_{A}*, and R_{A}*L_{A}. Hermitian solutions to some matrix equations were investigated by many authors. In 1976, Khatri and Mitra 2 gave necessary and sufficient conditions for the existence of the Hermitian solutions to the matrix equations AX B,AXB C and A₁X C₁, XB₂ C₂, 1.2 over the complex field C, and presented explicit expressions for the general Hermitian solutions to them by generalized inverses when the solvability conditions were satisfied. Matrix equation that has symmetric patterns with Hermitian solutions appears in some application areas, such as vibration theory, statistics, and optimal control theory 3-7. Groß in 8, and Liu et al. in 9 gave the solvability conditions for Hermitian solution and its expressions of AXA*B 1.3 over C in terms of generalized inverses, respectively. In 10, Tian and Liu established the solvability conditions for A^{3X A*3} C₃, A^{4, X A*4} C₄ 1.4 to have a common Hermitian solution over C by the ranks of coefficient matrices. In 11, Tian derived the general common Hermitian solution of 1.4. Wang and Wu in 12 gave some necessary and sufficient conditions for the existence of the common Hermitian solution to equations A₁X C₁, XB₂C₂, A^{3X A*3} C₃, 1.5 A₁X C₁, XB₂C₂, A₃XA*₃ C₃, A₄XA*₄C₄, 1.6 for operators between Hilbert C*-modules by generalized inverses and range inclusion of matrices. As is known to us, extremal ranks of some matrix expressions can be used to characterize non singularity, rank invariance, range inclusion of the corresponding matrix expressions, as well as solvability conditions of matrix equations 4, 7, 9-24. Real matrices and its extremal ranks in solutions to some complex matrix equation have been investigated by Tian and Liu 9, 13-15. Tian 13 gave the maximal and minimal ranks of two real matrices X₀ and X₁ in solution X X₀iX₁ to AXB C over C with its applications. Liu et al. 9 derived the maximal and minimal ranks of the two real matrices X₀ and X₁ in a Hermitian solution X X₀ iX₁ of 1.3, B*B representations. In order to investigate the real and complex solutions to quaternion matrix equations, Wang and his partners have been studying the real matrices in solutions to some quaternion matrix equations such as AXB C, A₁XB₁ C₁, A₂XB₂ C₂, 1.7 AXA*BXB*C, recently 24-27. To our knowledge, the necessary and sufficient conditions for 1.5 over H to have the real and complex Hermitian solutions have not been given so far. Motivated by the work mentioned above, we in this paper (we refer to) investigate the real and complex Hermitian solutions to system 1.5 over H and its applications. This paper (we refer to) is organized as follows. In Section 2, we first derive formulas of extremal ranks of four real matrices X₁,X₂,X₃, and X₄ in quaternion solution X X₁X₂i X₃j X₄k to 1.5 over H, then give necessary and sufficient conditions for 1.5 over H to have real and complex solutions as well as the expressions of the real and complex solutions. As applications, we in Section 3 establish necessary and sufficient conditions for 1.6 over H to have real and complex solutions. We give necessary, and sufficient for the conditions on m existence, uniqueness, simplicity and normalization function of a different action eigenfunctions principal of eigenvalues for arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²)) be cyclic *-representations of A with cyclic vectors v¹,v². Let μ¹,μ² be the corresponding states. If μ₁=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ε_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v ∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); n(a*)w ∈K^{⊥} ∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where n is a representation of A on H and U is a unitary representation of G such that π(αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F) E F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1) [symbol] (spec(k)):F (spec(k))→HomS (spec(k), X(F)) is a bijection for every algebraically closed field k, (2) For any S-scheme Y and any natural transformation Ψ:F→HomS (*, Y), there is a unique natural transformation Π:HomS (*, X(F)) HomS (*, Y) such that Ψ=Π∘ [symbol] . These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A,μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1−a)≥0, hence that μ (1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1)∥a∥≥|μ(a)|. For arbitrary a, |μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μb(c)=μ(b*cb). Then μ_{b} is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹, μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b+a)=μ¹(b*a)= [symbol] π¹(a)b¹,π²(b)v ¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ε_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each A we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); π(a*)w∈K^{⊥}∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β,⁻α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|²=r²+s²+2st+t² (37) and subtracting t² from both sides gives a contradiction unless s=0. Now, if f≥0 we have ∥f−∥f∥∥≤∥f∥, hence |μ(f)−∥f∥|=|μf−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ to is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. |μ(a)|²≤∥μ∥μ(a*). Proof. Write μ(a*)=limμ(a*e_{λ})=lim [symbol] a,e_{λ} [symbol] _{μ} (39) and since we know we have an inner product, this is equal to lim [symbol] e_{λ}, a [symbol] ⁻=limμ(e*_{λ}a)⁻=μ(a)⁻ (40) as desired. Next, write |μ(a)|²=lim|μ(e_{λ}a)|²=lim| [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)*(a+λ1))=μ(a*a)+λμ⁻(a)+λμ(a)+|λ|²∥μ∥ (43) which is greater than or equal to μ(a*a)−2|λ∥μ(a)|+|λ|²∥μ∥≥μ(a*a)−2|λ∥|μ∥^{1/2}μ(a*a)^{1/2}+|λ|²∥μ∥=(μ(a*a)^{1/2}−|λ∥|μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict n to A, then v remains a cyclic vector for π|_{A}. Proof. Choose a self-adjoint sequence an with ∥aₙ∥≤1 so that μ(aₙ)↑∥μ∥. Then ∥π(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K′. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,ν be positive linear functionals. Then μ≥ν if μ−ν≥0; we say that v is subordinate to μ. Given μ, let (π,H,v) be the corresponding GNS representation. Consider End_{A}(H). Let T∈End_{A}(H) be a positive operator smaller than the identity and set ν(a)=ν_{T}(a)= [symbol] π(a)Tv,v [symbol] (47). (Then T is the Radon-Nikodym derivative of ν with respect to μ.) We compute that ν(a*a)= [symbol] π(a*a)Tv,v [symbol] = [symbol] T^{1/2}π(a)v,T^{1/2}π(a)v [symbol] ≥0 (48) so ν is positive. Similarly, μ−ν is positive. Moreover, if ν_{T}=ν_{S} then T=S (by nondegeneracy). Conversely, suppose v is a positive linear functional with μ≥ν≥0, we want to show that ν=ν_{T} for some T∈End_{A}(H). For a,b∈A we have |ν(b*a)|≤ν(a*a)^{1/2}ν(b*b)^{1/2}≥μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that ν(b*a)= [symbol] π(a)v,T*π(b)v [symbol] (51). Since ν≥0 we have T≥0. Since ν≤μ, we have T≤I. To show that T∈End_{A}(H), write [symbol] π(c)Tπ(a)v,π(b)v [symbol] = [symbol] Tπ(a)v,π(C*b)v [symbol] (52)=ν((C*b)*a) (53)=ν(b*ca) (54)= [symbol] π(c)π(a)v,T*π(b)v [symbol] (55) which gives π(c)T=Tπ(c) by density. We can encapsulate our work above in the following. Proposition 2.36. The map T→ν_{T} is a bijection between {T∈End_{A}(H): 0≤T≤I} and {ν: μ≥ν≥0}. Definition A positive linear functional is pure if whenever μ≥ν≥0 then ν=rμ for some r∈[0,1]. Theorem 2.37. Let μ be a positive linear functional. Then μ is pure iff the associated GNS representation (π,H,v) is irreducible. Proof. If μ is not pure, there is μ≥ν≥0 such that v is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then ν_{P} is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>ν>0 with v not a scalar multiple of μ. Then μ=(μ−ν)+ν which is a convex linear combination of states (once the terms have been normalized) using the fact that ∥μ−ν∥=lim(μ−ν)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥=∥π^{U}(a)∥=∥a∥ (where π^{U} is the universal representation). Proof. Let a∈A be self-adjoint. Then there exists ρ∈S(A) with |ρ(a)|=Hall. Let Sₑ(A) be the set of extreme (pure) states of A. Suppose that there exists c such that |μ(a)∥≤c≤∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that |μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Sₑ(A) together with 0. 208 C*-algebras Marc Rieffel Notes by Qiaochu Yuan Spring 2013. (We refer to) “Inertia Groups and Smooth Structures of (n−1)-Connected 2n-Manifolds” Kasilingam Ramesh (received Jul. 2, 2014, revised Dec. 22, 2014) “Definition 2.4. Let M be a closed topological manifold. Let (N, f) be a pair consisting of a smooth manifold N together with a homeomorphism f: N→M. Two such pairs (N₁, f₁) and (N₂, f₂) are concordant provided there exists a diffeomorphism g: N₁→N₂ such that the composition f₂∘g is topologically concordant to f₁, thus, there exists a homeomorphism F: N₁×[0, 1]→M×[0, 1] such that F_{|N1×0}=f₁ and F_{|N1×0}=f₂∘g. The set of all such concordance classes is denoted by C(M). We will denote the class in C(M) of (M^{m} #Σ^{m}, id) by [M^{m} # Σ^{m}]. (Note that [Mⁿ # Sₙ] is the class of (Mⁿ, id).)” Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of T consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties periodic parabolic expression of the Euclidean structure the exponential function e^{z} can be defined as the limit of (z/N+1)^{N}, as N approaches infinity, and thus e^{iπ} is the limit of (z/N+1)^{N}. A computation of (z/N+1)^{N} can be displayed as parabolic coordinates as the combined effect of N multiplications in the complex plane, with the final point being the actual value of (z/N+1)^{N}. It can be viewed that as N gets larger (z/N+1)^{N} approaches a limit of −1 can be displayed as parabolic coordinates coprime positive integers a and m, primes of the form a+km, where g(s, χi) is bounded for s↓1, using the analytic properties of L(s,χi) we can deduce that log L(s,χ1) is unbounded for s↓1, whereas log L(s, 2) is bounded for sκ1, in particular the two sums of two functions are unbounded for s ↓1, and A Dirichlet character modulo a positive integer m is a group homomorphism χ*: (Z/mZ)^{x}→C^{x}, can be extended to a function χ: N→C by the rule (χ*(n mod m), gcd(n,m)=1, χ(n)=0, χ is also referred to as a Dirichlet character, χ for the function of transport properties N→C and add a star to denote the corresponding homomorphism χ*: (Z/mZ)^{x}→C^{x}, given a Dirichlet character χ: N→C attached the Dirichlet carrier-function L(s,χ) character as a series two sums of two functions, and χ(kn)=χ(k) (n) for all k,n∈N). Coprime positive integers a and m eigenvalue problem with weight m of load factor LF formal Dirichlet power generating series the connective constant a weighted mechanical advantage set coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped re-measurement allows us to construct the second fundamental form in the same way this shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²+(A_{Θ}). We shall now give a thorough description of all the finitely generated projective modules over A^{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Therefore, a weighted mechanical coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points a magnitude of a complex number [symbol] may be defined as the square root of the product of itself and its complex conjugate, [symbol] *, where for any complex number [symbol] =a+bi, its complex conjugate is [symbol] *=a bi. Fluid mechanic the flow velocity μ of a fluid random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. The eigenvalue distribution function of dilute random matrices [H_{N}]_{d} converges to the semicircle Wigner distribution in the limit N→∞, p→∞, where p is the dilution parameter. This convergence can be explained by the observation that the dilution eliminates statistical dependence between the entries of [H_{N}]_{d}. The same statement is valid for the entries of [U_{N}]_{d}. It may be seen that the Wigner law is valid for wide classes of random dilution of random matrices H_{N}=U_{N} F_{N} U^{†}_{N}, where U_{N} are uniformly distributed over the group of N×N unitary matrices and F_{N} are non-random Hermitian matrices, and real and complex Hermitian solutions to the classical system of quaternion matrix equations by Shao-Wen Yu. We establish necessary and sufficient conditions for the existence of and the expressions for the general real and complex Hermitian solutions to the classical system of quaternion matrix equations A₁X C₁, XB₁ C₂, and A^{3X A*3}=C₃. Moreover, formulas of the maximal and minimal ranks of four real matrices X1,X2,X3, and X₄ in solution X X₁ X₂i X₃j X₄k to the system mentioned above are derived. As applications, we give necessary and sufficient conditions for the quaternion matrix equations A₁X C₁,XB₁ C^{2, A3 X A*3}=C₃, and A^{4, X A*4}=C₄ to have real and complex Hermitian solutions. Positive pressurization supercooling refrigeration deceleration temperature less than or equal to ≤−109.3° F. degrees Fahrenheit or −78.5° C. degrees Celsius supercooled fluid refrigerant passes nearby and cools solid super alloy conductors, formed and fitted glazed rectangular, or cylindrical walls insulate superconducting equivalence across in mathematics transitive property of equality: if a=b and b=c, then a=c one of the equivalence properties of equality refrigeration. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓_{Q}^{f}⇄ [symbol] Y the lemma follows intrinsic amount fitting the exact limit into the contravariant functor Hom(−,Q). (We refer to). Cohomology Operations Lectures By N. E. Steen rod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable.

So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Fluid refrigerant passes through cryotubes nearby and cools liquid, polymeric gelling, or solid chloride tank conductors, air is transported and cools while passing through cooling fan housings, or cooled water is transported into radiator housings, or cooled water is transported into radiator housings along with thermal radiation generated by the thermal motion particles of matter carbon dioxide diffuse radiant passive cooling. In mathematics, a binary relation R over a set X is transitive if whenever an element a is related to an element b and b is related to an element c then a is also related to c. Transitivity (or transitiveness) is a key property of both partial order relations and equivalence relations. Formal definition. In terms of set theory, the transitive relation can be defined as: ∀ a,b,c∈X:(aRb∧bRc)→aRc. For example, “is greater than”, “is at least as great as,” and “is equal to” (equality) are transitive relations: Whenever A>B and B>C, then also A>C. Whenever A≥B and B≥C, then also A≥C. Whenever A=B and B=C, then also A=C. Transitive relations: “is a subset of” (set inclusion); “divides” (divisibility); and “implies” (implication). Closure properties. The converse of a transitive relation is always transitive: e.g. knowing that “is a subset of” is transitive and “is a superset of” is its converse, we can conclude that the latter is transitive as well. The intersection of two transitive relations is always transitive. The union of two transitive relations is not always transitive. The complement of a transitive relation is not always transitive. For instance, while “equal to” is transitive, “not equal to” is only transitive on sets with at most one element. Other properties. A transitive relation is asymmetric iff it is irreflexive. Properties that require transitivity. Preorder—a reflexive transitive relation. Partial order an antisymmetric preorder. Total preorder—a total preorder. Equivalence relation a symmetric preorder. Strict weak ordering—a strict partial order in which incomparability is an equivalence relation. Total ordering—a total, antisymmetric transitive relation. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation ^{˜} on a set S is called quasi-reflexive if every element that is related to some element is also related to itself, formally: ∀ x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Numeric isolated super alloy cylinders in series and parallel refrigerant-dynamic conductive circuits are connected to the portable or stationary refrigeration unit from super alloy connecting rods supercooling the outside walls of the cylinders. The outer cylinder cools activating an electronic air compressor rated alternating current AC or direct current DC filling the inner variable cylinders with fluid compression providing diffusive flux compensation expanding or contracting the inner cylinders as fluctuating compensator forcing the carbon dioxide CO₂ filled outer cylinders through a continuous circuit of super alloy curved or linear the first linear, local, circular moment, or equivalently the circular mean and circular variance number A spaces. The series of a real, or complex valued function continue a collective dynamic function of the complex space C^{p}, p≥1 arithmetic progression calculus mathematic expression the number theorem. The insertion of a cyclic point coordinate [symbol] dynamic constant exponent the tools of ordinary calculus of variations with an adjustable Lagrange multiplier=μ; [symbol] 1, [symbol] 2 eigenvalue of the ∧, λ longitude, and standard in transverse combination relaxation rates, respectively. The longitudinal integral of the trivial bundle does vanish, i.e. the K-theory index of the longitudinal Dirac operator is equal to 0. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁₊p_{n+1/2} semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Thus, the integral over V of the trivial bundle vanishes, Ab(V)=0. Note that here only F is assumed to be Spin so that Ab(V) is not a priori an integer. Whose spatial periods (wavelengths) are representations correspond to the little group integral submultiples of Lᵥ colimit 2.0 topology. Numbers, symbols and dynamics operators comprising a scientific aperture, control valve, or control valve venturi a vector calculus fundamental theorem limits of functions continuity, mean value theorem, by way of real-valued function f is continuous on a closed interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path, differentiable on the open interval (a, b), and ƒ(a)=ƒ(b), then there exists a c in the open interval (a, b) such that f′(c)=0, continuum a lift a normal k-smoothing isometries mechanics differential, integral, series, vector, multivariable, and discrete entity, divergence is a vector operator that measures the magnitude of a vector field's source or sink at a given point, in terms of a signed scalar, the divergence represents the volume density of the outward flux of a vector field from an infinitesimal volume around a given point, condensed phases condensation “super-fluid” as it is cooled and contracts, molecular diffusion coefficient the relevant vector field is the velocity of motion fluid at a point, the fluid cools and contracts, the divergence has a negative value, as the region is a sink, measured in angulation and a scientific aperture, control valve, or control valve venturi molecular diffusive fluid refrigerant chemistry continuum a lift a normal k-smoothing isometries vacuum theory chamber mechanics, molecular distillation, refrigeration process, and fractional chemistry (hyper-) superset periodic elements Q are exactly solutions of a matrix equation where Q^{T.}is the transpose of Q and I is the identity matrix M^{→} pressure pumps negative or positive pressurization stream is the accelerator. Fluid mechanic the flow velocity μ of a fluid random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. The eigenvalue distribution function of dilute random matrices [H_{N}]_{d} converges to the semicircle Wigner distribution in the limit N→∞, p→∞, where p is the dilution parameter. This convergence can be explained by the observation that the dilution eliminates statistical dependence between the entries of [H_{N}]_{d}. The same statement is valid for the entries of [U_{N}]_{d}. It may be seen that the Wigner law is valid for wide classes of random dilution of random matrices H_{N}=U_{N} F_{N} U^{†}_{N}, where U_{N} are uniformly distributed over the group of N×N unitary matrices and EN are non-random Hermitian matrices, and real and complex Hermitian solutions to the classical system of quaternion matrix equations by Shao-Wen Yu. We establish necessary and sufficient conditions for the existence of and the expressions for the general real and complex Hermitian solutions to the classical system of quaternion matrix equations A₁X C₁,XB₁ C₂, and A^{3X A*3}=C₃. Moreover, formulas of the maximal and minimal ranks of four real matrices X₁,X₂,X₃, and X₄ in solution X X₁ X₂i X₃j X₄k to the system mentioned above are derived. As applications, we give necessary and sufficient conditions for the quaternion matrix equations A₁X C₁,XB₁ C^{2, A3 X A*3}=C₃, and A^{4, X A*4}=C₄ to have real and complex Hermitian solutions. Positive pressurization supercooling refrigeration deceleration temperature less than or equal to ≤−109.3° F. degrees Fahrenheit or −78.5° C. degrees Celsius carbon dioxide CO₂ nondegenerate 2-form structure in potential theory complex analysis proves invaluable mathematical physics expressions an infinite potential 2-form dry ice in the outer superconducting cryopumps a cryocircuit numeric and hyper-numeric cylinders continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} hyper-numeric series and parallel superconducting cryopumps a cryocircuit wave packets of thermodynamic range characteristic luminosity L* evolve as for the wave equation for a wave on a Ω^{String}₂ₙ, (we refer to) “Inertia Groups and Smooth Structures of (n−1)-Connected 2n-Manifolds” Kasilingam Ramesh (received Jul. 2, 2014, revised Dec. 22, 2014)” (ii): Since the image of the standard sphere under the isomorphism Θ⁻₂ₙ≅^{String}₂ₙ represents the trivial element in Ω^{String}₂ₙ, we have [M²ⁿ]≠[M #Σ] in Ω^{String}₂ₙ. This implies that M and M # Σ are not BString-bordant. By obstruction theory, M²ⁿ has a unique string structure. This implies that M and M # F are not diffeomorphic”. Power series expansion which starts with terms at least of order 2n+1; ^{H}2₌a an output of windows frame m₀≥m₁≥m₂ y:[A, b]→S together with a subdivision a=τ₀<τ₁<τ₂<∧<τₙ=b of [A, b] centered; or frame m₀≥m₁≥m₂ of reference centered the value of μₑ is computed where the coefficients are carried as floating point numbers, such D₆ as a function of μ and then to evaluate it at the critical value μₑ with the critical value g(y) in order to establish the stability criteria computation of rational numbers as coefficients. The series of a real, or complex valued function ƒ(x) that is infinitely differentiable at a real, or complex-number a is the power series too (fortuitously) does the purely real a wave function electron energy loss spectroscopy (EELS). Output of windows frame m₀≥m₁≥m₂ y:[A, b]→S together with a subdivision a=τ₀<τ₁<τ₂<∧<τₙ=b of [A, b] centered; or frame m₀≥m₁≥m₂ of reference centered virtual channel output of windows frames (Photon optical banded energy cables) spectroscopy ƒ(x) polytope group subspace the cross polytope ßn is the regular polytope. (We refer to) Trialgebras and families of polytopes May 6, 2002 Jean-Louis Loday and María O. Ronco. “Trialgebras and families of polytopes introduced by Jean-Louis Loday and María Ronco a new type of algebras that we call the cubical trialgebras (resp. associative trialgebras) is a Koszul operad, or, equivalently, that the homology of the free dendriform trialgebra is trivial. We show that the family of standard simplices and the family of Stasheff polytopes are dual to each other in the following sense. The chain modules of the standard simplices, resp. the Stasheff polytopes, assemble to give an operad. We show that these operads are dual of each other in the operadic sense. The main result of this paper (we refer to) is to show that they are both Koszul operads. As a consequence the generating series of the standard simplices and the generating series of the Stasheff polytopes are inverse to each other. The two operads give rise to new types of algebras with 3 generating operations, 11 relations, respectively 7 relations, that we call associative trialgebras and dendriform trialgebras respectively. The free dendriform trialgebra, which is based on planar trees, has an interesting Hopf algebra structure, which will be dealt with in another paper. Similarly the family of cubes gives rise to an operad which happens to be self-dual for Koszul duality. Introduction. We introduce a new type of associative algebras characterized by the fact that the associative product * is the sum of three binary operations: x*y:=x [symbol] y+x [symbol] y+x·y, and that the associativity property of * is a consequence of 7 relations satisfied by [symbol] , [symbol] and ·, cf. 2.1. Such an algebra is called a dendriform trialgebra. An example of a dendriform trialgebra is given by the algebra of quasi-symmetric functions (cf. 2.3). Our first result is to show that the free dendriform trialgebra on one generator can be described as an algebra over the set of planar trees. Equivalently one can think of these linear generators as being the cells of the Stasheff polytopes (associahedra), since there is a bijection between the k-cells of the Stasheff polytope of dimension n and the planar trees with n+2 leaves and n−k internal vertices. The knowledge of the free dendriform trialgebra permits us to construct the algebras over the dual operad (in the sense of Ginzburg and Kapranov [G-K]) and therefore to construct the chain complex of a dendriform trialgebra. This dual type is called the associative trialgebra since there is again three generating operations, and since all the relations are of the associativity type (cf. 1.2). We show that the free associative trialgebra on one generator is linearly generated by the cells of the standard simplices. The main result of this paper (we refer to) is to show that the operads of dendriform trialgebras (resp. associative trialgebras) is a Koszul operad, or, equivalently, that the homology of the free dendriform trialgebra is trivial. As a consequence of the description of the free trialgebras in the dendriform and associative framework, the generating series of the associated operads are the generating series of the family of the Stasheff polytopes and of the standard simplices respectively: fₜ^{K}(x)=Σ_{n≥1} (−1)ⁿp(Kⁿ⁻¹,t)xⁿ, fₜ^{Δ}(x)=Σ_{n≥1}(−1)ⁿp(Δⁿ⁻¹,t)xⁿ. Here p(X,t) denotes the Poincaré polynomial of the polytope X. The acyclicity of the Koszul complex for the dendriform trialgebra operad implies that fₜ^{Δ}(fₜ^{K}(x))=x. Since p(Δⁿ,t)=((1+t)ⁿ⁺¹−1)/t one gets fₜ^{Δ}(x)=−x/(1+x)(1+(1+t)x) and therefore fₜ^{K}(x)=(1+(2+t)x)+√1+2(2+t)x+t²x²/₂(1+t)x. In [L1, L2] we dealt with dialgebras, that is with algebras defined by two generating operations. In the associative framework the dialgebra case is a quotient of the trialgebra case and in the dendriform framework the dialgebra case is a subcase of the trialgebra case. If we split the associative relation for the operation * into 9 relations instead of 7, then we can devise a similar theory in which the family of Stasheff polytopes is replaced by the family of cubes. So we get a new type of algebras that we call the cubical trialgebras. It turns out that the associated operad is self-dual (so the family of standard simplices is to be replaced by the family of cubes). The generating series of this operad is the generating series of the family of cubes: fₜ^{I}(x)=x/1+(t+2)x. It is immediate to check that fₜ^{I}(fₜ^{I}(x))=x, hence one can presume that this is a Koszul operad. Indeed we can prove that the Koszul complex of the cubical trialgebra operad is acyclic. As in the dialgebra case the associative algebra on planar trees can be endowed with a comultiplication which makes it into a Hopf algebra. This comultiplication satisfies some compatibility properties with respect to the three operations [symbol] , [symbol] and ·. This subject will be dealt with in another paper. Here is the content of the paper 1. associative trialgebras and standard simplices. 2. dendriform trialgebras and Stasheff polytopes. 3. Homology and Koszul duality. 4. Acyclicity of the Koszul complex. 5. cubical trialgebras and hypercubes. In the first section we introduce the notion of associative trialgebra and we compute the free algebra. This result gives the relationship with the family of standard simplices. In the second section we introduce the notion of dendriform trialgebra and we compute the free algebra, which is based on planar trees. This result gives the relationship with the family of Stasheff polytopes. In the third section we show that the associated operads are dual to each other for Koszul duality. Then we construct the chain complexes which compute the homology of these algebras. The acyclicity of the Koszul complex of the operad is equivalent to the acyclicity of the chain complex of the free associative trialgebra. This acyclicity property is the main result of this paper (we refer to), it is proved in the fourth section. After a few manipulations involving the join of simplicial sets we reduce this theorem to proving the contractibility of some explicit simplicial complexes. This is done by producing a sequence of retractions by deformation. In the fifth section we treat the case of the family of hypercubes, along the same lines. These results have been announced in [LR2]. Convention. The category of vector spaces over the field K is denoted by Vect, and the tensor product of vector spaces over K is denoted by ⊗. The symmetric group acting on n elements is denoted by Sₙ. associative trialgebras and standard simplices. In [L1, L2] the first author introduced the notion of associative dialgebra as follows. 1.1 Definition. An associative dialgebra is a vector space A equipped with 2 binary operations: ┤ called left and ├ called right, (left) ┤: A ⊗A→A, (right) ├: A⊗A→A, satisfying the relations: {(x┤y)┤z=x┤(y┤z), (x┤y)┤z=x┤(y├z), (x├y)┤z=x├(y┤z), (x┤y)├z=x├(y├z), (x├y)├z=x├(y├z). Observe that the eight possible products with 3 variables x,y,z (appearing in this order) occur in the relations. Identifying each product with a vertex of the cube and moding out the cube according to the relations transforms the cube into the triangle Δ²: cube: ┤(├), ┤(┤), (┤)┤, (├)┤, [symbol] (├), ┤(├), (├)┤, (├)├, →triangle: ├┤, ┤┤, ├├. There are double lines which indicate the vertices which are identified under the relations. Let us now introduce a third operation ⊥: A⊗A→A called middle. We think of left and right as being associated to the 0-cells of the interval and middle to the 1-cell: ┤⊥├ •--------•. Let us associate to any product in three variables a cell of the cube by using the three operations ┤, ├,⊥. The equivalence relation which transforms the cube into the triangle determines new relations (we indicate only the 1-cells): cube: ⊥(├), (⊥)├, ┤(⊥), ├(⊥), (├)⊥, (┤) ⊥,⊥(┤), (⊥)┤, →triangle: ⊥┤, ├⊥, (┤)⊥=⊥(├). This analysis justifies the following: 1.2 Definitions. An associative trialgebra (resp. an associative trioid) is a vector space A (resp. a set X) equipped with 3 binary operations: ┤ called left, ├ called right and ⊥ called middle, satisfying the following 11 relations: {(x┤y)┤z=x┤(y┤z), (x┤y)┤z=x┤(y├z), (x├y)┤z=x├(y┤z), (x┤y)├z=x├(y├z), (x├y)├z=x├(y├z), {(x┤y)┤z=x┤(y⊥z), (x⊥y)┤z=x⊥(y┤z), x┤y)⊥z=x⊥(y├z), x├y)⊥z=x⊥z), (x⊥y)├z=x├(y├z), {(x⊥y)⊥z=x⊥(y⊥z). First, observe that each operation is associative. Second, observe that the following rule holds: “on the bar side, does not matter which product”. Third, each relation has its symmetric counterpart which consists in reversing the order of the parenthesizing, exchanging ├ and ├, leaving ⊥ unchanged. A morphism between two associative trialgebras is a linear map which is compatible with the three operations. We denote by Trias the category of associative trialgebras. dendriform trialgebras and Stasheff polytopes. In [L1, L2] the first author introduced the notion of dendriform dialgebras. Here we add a third operation. 2.1 dendriform trialgebras. By definition a dendriform trialgebra is a vector space D equipped with three binary operations: [symbol] called left, [symbol] called right, · called middle, satisfying the following relations: {(x [symbol] y) [symbol] z=x [symbol] (y*z), (x [symbol] y) [symbol] z=x [symbol] (y [symbol] z), (x*y) [symbol] z=x [symbol] (y [symbol] z) {(x [symbol] y)·z=x [symbol] (y·z), (x [symbol] y)·z=x·(y [symbol] z), (x·y) [symbol] z=x·(y [symbol] z), {(x·y)·z=x·(y·z), where x*y:=x [symbol] y+x [symbol] y+x·y. 2.2 Lemma. The operation * is associative. Proof. It suffices to add up all the relations to observe that on the right side we get (x*y)*z and on the left side x*(y*z). Whence the assertion. In other words, a dendriform trialgebra is an associative algebra for which the associative operation is the sum of three operations and the associative relation splits into 7 relations. We denote by Tridend the category of dendriform trialgebras and by Tridend the associated operad. By the preceding lemma, there is a well-defined functor: Tridend→As, where As is the category of (nonunital) associative algebras. Observe that the operad Tridend does not come from a set operad because the operation * needs a sum to be defined. However there is a property which is close to it. It is discussed and exploited in [L3]. By definition the Koszul complex associated to the operad Trias is the differential functor Tridend ∘ Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C*^{Trias}(Trias(V)) is proved. 1. We show that it is sufficient to treat the case V=K. 2. The chain complex C*^{Trias}(Trias(K)) splits into the direct sum of chain complexes C*(u), one for each element u in P_{m,m}≥1.3. The chain complex C*(u) is shown to be the cell complex of a simplicial set X(u). 4. The space X(u) is shown to be the join of spaces X(v) for certain particular elements v in Pₘ″. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B*B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>ν>0 with v not a scalar multiple of μ. Then μ=(μ−ν)+ν which is a convex linear combination of states (once the terms have been normalized) using the fact that ∥μ−ν∥=lim(μ−ν)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Suspension zero centered value of μₑ is computed where the coefficients are carried as floating point numbers, such D₆ as a function of μ and then to evaluate it at the critical value μₑ with the critical value g(y) in order to establish the stability criteria computation of rational numbers as coefficients terms at least of order 2n+1; ^{H}2₌a; positive constants: H₄=½(AI²₁−2BI₂I₃+c cß)•, A, B, C constants wave packets of light thermodynamic characteristic luminosity L* evolve as heat a heater fluid a superconductor of magnetic-enthalpy in symbol H ƒ(a)+f′(a)/1!(x−a)+f″(a)/2!(x−a)²+f″(a)/3!(x−a)³+ . . . isotopic a computer processor given critical set are the minimum type power series two linearly independent solutions thermodynamic characteristic range S to sets. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and M n(R) are known to be Morita equivalent. In some C*algebraic sense, B₀(H) is Morita equivalent to C. Theorem (Morita) Let F:R-Mod→S-Mod be an equivalence of categories. Isotopic class [A] lower bound of these maxima over all sets an isotopy class is said to be closed if it contains the topological limit of any sequence of sets in it. N=1 in n dimensions corresponding to the convex hull of the points formed by permuting the coordinates (±1, 0, 0, . . . , 0). A cross-polytope (also called an orthoplex) is denoted Rn and has 2 n vertices and Schläfli symbol {3, . . . , 3, 4/n−2}. The cross polytope is named because its 2 n vertices are located equidistant from the origin along the Cartesian axes in Euclidean space, which each such axis perpendicular to all others. A cross polytope is bounded by 2ⁿ(n−1)-simplexes, and is a dipyramid erected (in both directions) into the nth dimension, with an (n−1)-dimensional cross polytope as its base. In one dimension, the cross polytope is the line segment [−1, 1]. In two dimensions, the cross polytope {4} is the filled square with vertices (−1, 0), (0, −1), (1, 0), (0, 1). In three dimensions, the cross polytope {3, 4} is the convex hull of the octahedron with vertices (−1, 0, 0), (0, −1, 0), (0, 0, −1), (1, 0, 0), (0, 1, 0), (0, 0, 1). In four dimensions, the cross polytope {3, 3, 4} is the 16-cell, depicted in the above figure by projecting onto one of the four mutually perpendicular three-spaces within the four-space obtained by dropping one of the four vertex components (R. Towle). The skeleton of ßn is isomorphic with the circulant graph Ci2ₙ (1, 2, . . . , n−1), also known as the n-cocktail party graph polytope group x⊥, y⊥ for all dimensions, the dual of the cross polytope is the hypercube (and vice versa). Consequently, the number of k-simplices contained in an n-cross polytope is (ⁿk+1)2^{k+1}. We continue with nearby level surface point structure, or solid domain occupies surface point structure fluid filled, or unfilled (volute, or solute) space number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k≤d−1, is there a d-polytope that can not be realized with all its k-faces tangent to a sphere? Leaving aside the trivial cases of d≤2, the constructed non-k-scribable examples for all the cases except for d=3 and k=1, i.e. 3-polytopes that are not edge-scribable. Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. An output of windows frame m₀≥m₁≥m₂ y: [A, b]→S together with a subdivision a=τ₀<τ₁<τ₂<∧<τₙ=b of [A, b] centered; or frame m₀≥m₁≥m₂ of reference centered frames an output of windows coefficients terms at least of order 2n+1; ^{H}2₌a; positive constants: H₄=½(AI²₁−2BI₁I₂+c cß)•, A, B, C constants wave packets of light thermodynamic characteristic luminosity L* evolve as heat a heater fluid a superconductor of magnetic-enthalpy in symbol H ƒ(a)+f′(a)/1!(x−a)+f″(a)/2!(x−a)²+f′″(a)/3!(x−a)³+ . . . isotopic a computer processor that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets of light, ƒ(x) that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets of energy, or ƒ(x) that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets we also incorporate in our optical spectroscopy one set of electrodes are arranged superlattice we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) we can illustrate the manifold for Bloch wave with conventional topology that corresponds to a time-independent superlattice. In this case the manifold does not possess a twist. The vector field is transported along a single closed path in k space without a change in phase. The amplitude of the wave function in this case does not depend on the wave number. Through a series of numerical simulations, we now can demonstrate the application of the concept of time-dependent modulation of elastic properties in achieving bulk wave propagation functionalities for non-reciprocity and immunity to scattering. The vectors remain parallel to each other through a full loop (2π/L rotation) in k space reaching point C; and one needs another full turn to go through the twist a second time and rotate the vector by π again. The vectors remain parallel until they close the continuous path and reach the point A. The vector has accumulated a 2 π phase difference along a 4π/L closed Path. We continue banding (Photon optical banded energy cables) spectroscopy ƒ(x) polytope group subspace the cross polytope ßn is the regular polytope a virtual channel of reference centered Abelian nondegenerate 2-form structure in potential theory complex analysis proves invaluable mathematical physics expressions an infinite potential one {1×1 column}. The Fourier series generalizes to the Fourier transform. Whereby α∈A singletons have { points { and the entire space Rⁿ is our solution set of an arbitrary possibly, infinite system ≤b_{α}, α∈A α^{T}_{α}x≤b_{α}, α∈A of linear inequalities with n unknowns x {the set M={x∈Rⁿ|α^{T}_{α}x≤b_{α}, α∈A} is convex, of linear inequalities with n unknowns x closed priori measures that the moments solution, or the weighted set of an arbitrary possibly n=2; after generalizing the notion of integration, the logarithm can be viewed either as the inverse function of the exponential, or as the integral log z=integral sign ∫ 1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals. Returning to geometric ideas, nondegenerate 2-form structure in potential theory complex analysis proves invaluable mathematical physics expressions an infinite potential one {1×1 column}. Finally the geometric ideas of Riemann can be viewed in terms of modern topology to give a global insight into ‘many-valued’ functions (the logarithm can be viewed either as the inverse function of the exponential, or as the integral log z=integral sign ∫ 1/z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓_{Q}^{f} [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis.

Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction″ the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. As the theory of complex analysis unfolds, We may recall the immense importance of this definition. Complex functions f will be restricted to those of the form f: D→C where D is a domain. The fact that D is open will allow us to deal neatly with limits, continuity, and differentiability because z₀∈D implies the existence of a positive E such that N_{ß}(z₀)⊆D and so f (z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S⊆C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some τ∈R} is path connected. Sometimes it is more convenient to use a simpler type of path. Definition. A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S⊆C which is path connected but is not step connected. Theorem. Every open disc N_{ε}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁^{˜}z₂ iff there exists a path y in S from z₁ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in C then all the connected components of S are open in C. One interesting way to generate open sets in C is to consider the complement of a path. Definition. Let y:[A, b]→C be a path. The complement of y is defined to be C\y([A, b]). For d≥2 and n∈N even, let pₙ=pₙ(d) denote the number of length n self-avoiding polygons in Z^{d} up to translation. The polygon cardinality grows exponentially, and the growth rate lim_{n∈2N pn}^{1/n}∈(0,∞) is called the connective constant and denoted by μ. It has been shown that pₙμ⁻ⁿ≤Cn^{-1/2} in dimension d=2. Here we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations. The polygon cardinality grows exponentially, and the growth rate lim_{n∈2N pn}^{1/n}∈(0,∞) is called the connective constant and denoted by μ. It has been shown that pₙμ⁻ⁿ≤Cn^{-1/2} in dimension d=2. Here we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations a computer processor of formal Dirichlet power generating series the connective constant a weighted mechanical advantage set coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped a set of thermodynamic, light and/or power series built in nondegenerate 2-form structure in potential theory complex analysis proves invaluable mathematical physics expressions an infinite potential quantum wavenumber data sequences mathematic computation mechanics position Q 2\hat{ }n−1 cypher-encryption power sets: the power set functor P:Set→Set maps each set to its power set and each function f:X→Y to the map which sends U⊆X to its image f(U)⊆Y. One can also consider the contravariant power set functor which sends f:X→Y to the map which sends V⊆Y to its inverse image f⁻¹(V)⊆X carrier (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧ e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄ ∧e₁∧e₂+0=2 e₁∧e₂∧e₃∧e₄. If α₁, . . . , αₖ have degree one, then they are linearly independent iff α₁∧ . . . ∧αₖ≠0. Every hyperbola has two asymptotes. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤M₁, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology. Zipping function f 1→f2 of structure power sets: the power set functor P:Set→Set maps each set to its power set and each function f:X→Y to the map which sends U⊆X to its image f(U)⊆Y. One can also consider the contravariant power set functor which sends f:X→Y to the map which sends V⊆Y to its inverse image f⁻¹(V) ⊆X photocurrent logarithmic T_{c} equiangular relates to having angles of equal measure, or growth spiral vector of the isospin (ith spin), and Q is the wavevector of the pure spiral curve in polar coordinates (r, Θ) the curve r=ae^{bΘ} or (Θ)=1/b 1n(r/a), with e being the base of natural logarithms, and a and b being arbitrary positive constants. We use Open and Closed Intervals: by Real Analysis; and Calculus. Bounded Open and Closed Intervals Definition: If a,b∈R such that a<b, then the open interval determined by the endpoints a and b is the set (a,b):={x∈R:a<x<b}. The closed interval determine by the endpoint a and b is A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path:={x∈R:a≤x≤b}. Similarly the half open interval determined by the endpoints a and b is (a,b]:={x∈R:a<x≤b} or [a,b):={x∈R:a≤x<b}. It is important to note that in an open interval, the endpoints are not necessarily in the interval. For example, consider the interval (2,3) which is analogous to the inequality 2<x<3. Notice that the values x=2 and x=3 do not satisfy the inequality, that is 2≮2<3 and 2<3≮3, so these values of x are not in this interval. Definition: If defines either an open or closed interval of real numbers, then the length of this interval is b−a. For example, the length of the interval (2,3) is 3−2=1, which should make sense since (2,3) covers a length of 1 on the real number line. Another example is the degenerate interval [3,3] whose length is 3−3=0. Unbounded Open and Closed Intervals. There are five other types of intervals, all of which are unbounded and are defined as followed with a,b∈R, (a,∞)={x∈R:x>a}, [a,∞)={x∈R:x≥a}, (−∞,a)={x∈R:x<a}, (−∞,a]={x∈R:x≤a}, and (−∞,∞)=R. [A. Connes. An analogue of the Thom isomorphism for crossed products of a C*-algebra by an action of R. Adv. in Math. 39 (1981)] Let A be a C*-algebra, α a one-parameter group of automorphisms of A, e=e*=e² a self-adjoint projection, e∈A, of A. There exists an equivalent projection f˜e, f∈A, and an outer equivalent action α⁰ of R on A such that α′ₜ(f)=f ∀t∈R. One first replaces e by an equivalent projection f such that the map t→αₜ(f)∈A is of class C^{∞}, and then one replaces the derivation δ=(d/dtαₜ)ₜ₌₀ which generates α by the new derivation δ⁰=δ+ad(h) where ad(h)x=hx−xh ∀x∈A, and h=fδ(f)−δ(f)f. From Lemma 7 and the canonical isomorphism Ao_{α}R˜Ao_{α}OR for outer equivalent actions one gets the construction of ϕ⁰_{α}: K₀(A)→K₁(A×_{α}R). Replacing A by SA, one gets similarly ϕ¹_{α}: K₁(A)→K₀(A×_{α}R). Theorem [A. Connes. An analogue of the Thom isomorphism for crossed products of a C*-algebra by an action of R. Adv. in Math. 39 (1981)] Let A be a C*-algebra, and let α be a one-parameter group of automorphisms of A. Then ϕ_{α}: Kᵢ(A)→Kᵢ₊(Ao_{α}R) is an isomorphism of Abelian groups for i=0,1. The composition ϕ_{α\check{ }}ϕ_{α} is the canonical isomorphism of Kᵢ(A) with Kᵢ(A└K), where the double crossed product is identified with A⊗K by Theorem. The proof is simple since it is clearly enough to prove the second statement, and to prove it only for i=0. One then uses Lemma 7 to reduce to the case A=C, where it is easy to check ([A. Connes. An analogue of the Thom isomorphism for crossed products of a C*-algebra by an action of R. Adv. in Math. 39 (1981)]). The above theorem immediately extends to arbitrary simply connected solvable Lie groups H in place of R. Ab(F) is the Ab-genus of this Spin bundle. When F=TV, i.e. when the foliation has just one leaf, this is exactly the content of the well-known vanishing theorem of A. Lichnerowicz (A. Lichnerowicz. Deformations d'algebres associees a unevariete symplectique (les _{*ν}-produits). Ann. Inst. Fourier (Grenoble) 32 (1982)). As an immediate application we see that no spin foliation of a compact manifold V, with non-zero Ab-genus, A\hat{ }(V)/=0, admits a metric of strictly positive scalar curvature. Proof. The projection V→V/F is K-oriented by the Spin structure on F and hence defines a geometric cycle x∈K_{*,τ}(BG). The argument of [J. Rosenberg. C*-algebras, positive scalar curvature and the Novikov conjecture. Inst. Hautes Etudes Sci. Publ. Math. No. 58′ (1983)] shows that the analytical index of the Dirac operator along the leaves of (V,F) is equal to 0 in K*(C*ᵣ(V, F)], so that one has μᵣ(x)=0 with μᵣ the analytic assembly map. Let f:V→BG be the map associated to the projection V→V/F. There exists a polynomial P in the Pontryagin classes of τ, with leading coefficient 1, such that ϕ∘Ch(x)=f_{*}(Ab(F)∩[V]) ∩P∈H_{*}(BG). Thus, since μᵣ(x)=0, the result follows from Theorem.

Corollary Let (V,F) and (V⁰,F⁰) be oriented and transversely oriented compact foliated manifolds. Let f:V→V⁰ be a smooth, orientation preserving, leafwise homotopy equivalence. Then for any element P of the ring R⊂H*(V,C) of Corollary one has h(f*L(V⁰)−L(V)), P∩[V]i=0 where L(V) (resp. (V⁰)) is the L-class of V (resp. V⁰). [symbol] Index formula for longitudinal elliptic operators. The main difficulty in the proof of Theorem 8 is to show the topological invariance of the cyclic cohomology map ϕ:K(A)→C, A=C_{c}^{∞}(G,Ω^{1/2}). We refer to [A. Connes. Cyclic cohomology and the transverse fundamental class of a foliation. Geometric methods in operator algebras (Kyoto, 1983), pp. 52-144, Pitman Res. Notes in Math., 123, Longman, Harlow, 1986] for the proof. Here we shall explain how to compute the pairing h [symbol] (c),Ind(D)i∈C of the cyclic cohomology of A with the index Ind(D)∈K₀(A) of an arbitrary longitudinal elliptic operator D, α). The result is stated quite generally in the theorem on p. 888 of [A. Connes. Cyclic cohomology and noncommutative differential geometry. Proceedings of the International Congress of Math. (ICM Berkeley, Calif., 1986) Vol. 2, pp. 879-889, Amer. Math. Soc., Providence, R.I., 1987], but we shall make it more specific, using the natural map [symbol] _{*}: H*_{τ}(BG)→H*(A) constructed in Section 2 δ) Theorem 14 and Remark b). The gas enters the domain at station 1 with some velocity u and some pressure p and exits at station 2 with a different value of velocity and pressure. For simplicity, we will assume that the density r remains constant within the domain and that the area A through which the gas flows also remains constant. The location of stations 1 and 2 are separated by a distance called Δd x. This change with distance is a gradient. The velocity gradient is indicated by Δd u/Δd x; the change in velocity per change in distance. So at station 2, the velocity is given by the velocity at 1 plus the gradient times the distance u2=u1+(Δd u/Δd x)*Δd x. A similar expression gives the pressure at the exit: p2=p1+(Δd p/Δd x)*Δd x. We have a one dimensional, steady form of Euler's identity is the equality e^{iπ}+1=0. It is interesting to note that the pressure drop of a fluid (the term on the left) is proportional to both the value of the velocity and the gradient of the velocity. The constant of proportionality is k=y/x. Given our linear function y=mx+b the direct constant of proportionality is m: the direct constant of proportionality for any given function y, between any x values, is given by r=Δy/Δx is slope. Therefore, our constant of proportionality is m. Proposition. Expanding, and contracting gases composed with atmospheric gases (sub-plasma the thermal system in relativity), open degenerate ρ(E), or closed degenerate ρ(E) subgroupoid composed with atmospheric gases proposition to the decomposition G_{M}=G₁∪G₂ of G_{M} as a union of an open and a closed subgroupoid corresponds the exact sequence of C*-algebras 0→C*(G₁)→C*(G)→σC*(G₂)→0. 2) The C*-algebra C*(G₁) is isomorphic to C₀(]0,1])⊗K, where K is the elementary C*-algebra (all compact operators on Hilbert space). 3) The C*-algebra C*(G₂) is isomorphic to C₀(T*M), the isomorphism being given by the Fourier transform: C*(TxM)^{˜}C₀(T*xM), for each x∈M which we will call “x” an equilibrium point the topology of G is such that G₁ is an open subset of G and a sequence (xn,yn,εn) of elements of G₁=M×M×]0,1] with εn→0 converges to a tangent vector (x,X); X∈Tx(M) iff the following holds: The tangent groupoid of M xn→x, yn→x, xn−yn/εn→X. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. (We refer to). “Compact operators Let H be a Hilbert space and let B_{f}(H) be the set of finite rank operators in B(H). This is a two-sided ideal in B(H). If I is any proper 2-sided ideal, then B_{f}(H)↓I. We define the compact operators B₀(H) to be the closure of B_{f}(H). Then B_{f}(H) is the minimal dense ideal in B₀(H). (The chain of inclusions B_{f}(H)⊂B₀(H)⊂B(H) is analogous to the chain of inclusions C_{c}(S)∈C₀(S)⊂^{′∞}(S) where S is a set.) The identity operator is not compact, so B₀(H) is a natural example of a nonunital C*-algebra. B₀(H) is topologically simple in the sense that it has no proper 2-sided closed ideals. Its representation on H is irreducible. Moreover, every irreducible representation of B₀(H) is unitarily equivalent to H, and every nondegenerate representation is a direct sum of copies of H. Recall that two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Then F is naturally isomorphic to tensoring by _{R}X_{S} for some bimodule X. We return now to B₀(H). For v,w∈H define hv,wi₀∈B₀(H) by hv,wiu=vhw,ui. This is a rank-1 operator. If T∈B(H) then Thv,wi₀=hTv,wi₀, hence hv,Twi₀=hv,wi₀T*. Theorem C₀(G) oα G is naturally isomorphic to B₀(L²(G)). Proof. C₀(G) oα G has a natural covariant representation (π,U) on L²(G) (which we might call the Schrodinger map). Let a be its integrated form, defined on C_{c}(G,C₀(G))⊇C_{c}(G×G) by Z Z (σ_{F} (ξ))(x)=(F(y)U_{y}ξ)(x)=F(y,x)ξ(y⁻¹x)dy. Let f,g∈C_{c}(G)⊂L²(G) and ξ∈C_{c}(G). Let hf,gi₀ be the rank one operator given by hf,gi₀ξ=fhg,ξi_{L}2_{(G)}. Define hf,gi_{E}(y,x)=f(x)⁻g(y⁻¹x)Δ(y⁻¹x)∈C_{c}(G×G) so that σ_{hf,giE}=hf,gi₀. Let E be the linear span of the functions hf,gi_{E} for f,g∈C_{c}(G). Then E is stable under pointwise product and complex conjugation, and moreover it separates the points of G×G. Hence E is dense in C_{c}(G×G) in the colimit topology, so E is dense in L¹ (G,C₀(G)) and so in C₀(G) oα G. If f₁, . . . fₙ∈C_{c}(G) are orthonormal, then the hfⱼ,fₖi_{E} span a copy of Mₙ(C) (hence a C*-algebra with a unique C*-norm) inside C₀(G) oα G. Hence on this span the norm for C₀(G) oα G agrees with the norm on B(L²(G)) via σ. Hence σ is isometric on E. Hence σ is isometric on C₀(G) oα G and maps into B₀(L²(G)), and we saw that it's onto. More generally, we can consider C₀(G/H) oα G, which turns out to be Morita equivalent to C*(H). Since the reduced cross product is a quotient of the cross product C₀(G) oα G, which is B₀(L²(G)), and since B₀(L²(G)) has no proper quotients, we conclude that α is amenable. Given groups Q,N and α: Q→Aut(N) an action, we can form the semidirect product G=N oα Q, which is N×Q with the multiplication given by (n,x)(m,y)=(nαₓ(m),xy). We can do this for topological groups as well. These groups fit together in a split exact sequence 0→N→G→Q→0. Let N,Q be locally compact. If (H,U) is a strongly continuous unitary representation of G, then it restricts to unitary representations U|_{N},U|_{Q} of N and Q with a covariance relationship. U|_{N} has an integrated form σ^{N} giving a representation of C*(N) on H. For any x∈Q, αₓ is an automorphism of N, so this gives an automorphism of L¹(N). Furthermore, via α, Q acts on the set of unitary representations of N, so acts via a group of automorphisms of C*(N). This action is strongly continuous, so we can form the crossed product C*(N) oα Q. We find that (H,σ^{N},U|_{Q}) is a covariant representation of (C*(N),Q,α), hence gives a representation of the crossed product. The converse also holds. Proposition There is a natural isomorphism C*(N oα Q) ^{˜}=C*(N) oα Q. If N is commutative, then C*(N) is commutative, so C*(N)^{˜}=C₀(N\check{ }) where N\check{ } is the Pontrjagin dual group of all continuous homomorphisms N→T. Then Q acts on N\check{ }, and C*(N oα Q)^{˜}=C₀(N\check{ }) oα Q. Wigner. Consider R⁴ equipped with the bilinear form B(v,w)=v₀w₀−v₁w₁−v₂w₂−v₃w₃. The Lorentz group L is the group of linear transformations on R⁴ preserving B. Let α be its action on R⁴. The Poincaré group is the semidirect product P=R⁴oαL, and we want to consider its (physically interesting) unitary representations. Since R^{\check{ }4˜}=R⁴, we are looking at C₀(R⁴) oα L, and we need irreducible representations of L. For v∈R^{\check{ }4}=0, consider the stabilizer Pᵥ. The orbit of v looks like P/Pᵥ, so we want irreducible representations of C₀(P/Pᵥ)oα L. These representations correspond to representations of the little group Lᵥ. For massive particles, Lᵥ=SU(2). Given any group G and subgroup H we know that C₀(G/H)oα G^{˜}=C*(H). Let's be explicit about this. Given a representation (H,U) of H, we get a representation of C₀(G/H) oα G by constructing the induced representation K={ξ: G→H: ξ(xs)=Uₛ(ξ(x))} where s∈H,x∈G. Note that x→kξ(x)k² is H-invariant so can be identified with a function on G/H; we require that this function is integrable”. (The Longitudinal Index Theorem for Foliations A. Connes* and G. Skandalis** 1983). (Sub-plasma gases the thermal system in relativity), condensed phases condensation “super-fluid” as it is cooled and contracts, molecular diffusion coefficient the relevant vector field is the velocity of motion fluid at a point, the fluid cools and contracts dimorphism (n) squeezing the odd number of isotopes with 1 real part symmetric positive definite, and its imaginary unit √−1 part symplectic by properties on a complex vector space V is a complex valued bilinear form on V which is antilinear in the second slot, and the system then is positive definite. Upon which the only data used in setting up the Yang-Mills problem are 1) the *-algebra A^{Θ}, and 2) the formal “metric” dUdU*+dVdV*∈Ω²₊(A_{Θ}). We now state the Transfer Principle, which allows us to carry out computations with hyperreal numbers the same way we do for real numbers. Intuitively, the Transfer Principle says that the natural extension of each real function has the same properties as the original function. The Extension Principle and Transfer Principle of the axioms for the real numbers come in three sets: the Algebraic Axioms, the Order Axioms, and the Completeness Axiom. All the facts about the real numbers can be proved using only these axioms: heat transfer, of the continuous dimensions as densities continued as the component of acceleration normal acceleration is approximately zero in steady-state, incremental normal acceleration, and given the symbol n_{z} when in g-units classification, and the self-inductance is determined by the geometry of individual circuit the symmetric group acting on n elements is denoted by Sₙ. (We refer to) Trialgebras and families of polytopes May 6, 2002 Jean-Louis Loday and María O. Ronco. “Trialgebras and families of polytopes introduced by Jean-Louis Loday and María Ronco a new type of algebras that we call the cubical trialgebras (resp. associative trialgebras) is a Koszul operad, or, equivalently, that the homology of the free dendriform trialgebra is trivial. We show that the family of standard simplices and the family of Stasheff polytopes are dual to each other in the following sense. The chain modules of the standard simplices, resp. the Stasheff polytopes, assemble to give an operad. We show that these operads are dual of each other in the operadic sense. The main result of this paper (we refer to) is to show that they are both Koszul operads. As a consequence the generating series of the standard simplices and the generating series of the Stasheff polytopes are inverse to each other. The two operads give rise to new types of algebras with 3 generating operations, 11 relations, respectively 7 relations, that we call associative trialgebras and dendriform trialgebras respectively. The free dendriform trialgebra, which is based on planar trees, has an interesting Hopf algebra structure, which will be dealt with in another paper. Similarly the family of cubes gives rise to an operad which happens to be self-dual for Koszul duality. Introduction. We introduce a new type of associative algebras characterized by the fact that the associative product * is the sum of three binary operations: x*y:=x [symbol] y+x [symbol] y+x·y, and that the associativity property of * is a consequence of 7 relations satisfied by [symbol] , [symbol] and ·, cf. 2.1. Such an algebra is called a dendriform trialgebra. An example of a dendriform trialgebra is given by the algebra of quasi-symmetric functions (cf. 2.3). Our first result is to show that the free dendriform trialgebra on one generator can be described as an algebra over the set of planar trees. Equivalently one can think of these linear generators as being the cells of the Stasheff polytopes (associahedra), since there is a bijection between the k-cells of the Stasheff polytope of dimension n and the planar trees with n+2 leaves and n−k internal vertices. The knowledge of the free dendriform trialgebra permits us to construct the algebras over the dual operad (in the sense of Ginzburg and Kapranov [G−K]) and therefore to construct the chain complex of a dendriform trialgebra. This dual type is called the associative trialgebra since there is again three generating operations, and since all the relations are of the associativity type (cf. 1.2). We show that the free associative trialgebra on one generator is linearly generated by the cells of the standard simplices. The main result of this paper (we refer to) is to show that the operads of dendriform trialgebras (resp. associative trialgebras) is a Koszul operad, or, equivalently, that the homology of the free dendriform trialgebra is trivial. As a consequence of the description of the free trialgebras in the dendriform and associative framework, the generating series of the associated operads are the generating series of the family of the Stasheff polytopes and of the standard simplices respectively: fₜ^{K}(x)=Σ_{n≥1}(−1)ⁿp(Kⁿ⁻¹,t)xⁿ, fₜ^{Δ}(x)=Σ_{n≥1}(−1)ₙp(Δⁿ⁻¹,t)xⁿ. Here p(X,t) denotes the Poincaré polynomial of the polytope X. The acyclicity of the Koszul complex for the dendriform trialgebra operad implies that fₜ^{Δ}(fₜ^{K}(x))=x. Since p(Δⁿ,t)=((1+t)ⁿ⁺¹−1)/t one gets fₜ^{Δ}(x)=−x/(1+x)(1+(1+t)x) and therefore fₜ^{K}(x)=−(1+(2+t)x)+√1+2(2+t)x+t²x²/₂(1+t)x. In [L1, L2] we dealt with dialgebras, that is with algebras defined by two generating operations. In the associative framework the dialgebra case is a quotient of the trialgebra case and in the dendriform framework the dialgebra case is a subcase of the trialgebra case. If we split the associative relation for the operation * into 9 relations instead of 7, then we can devise a similar theory in which the family of Stasheff polytopes is replaced by the family of cubes. So we get a new type of algebras that we call the cubical trialgebras. It turns out that the associated operad is self-dual (so the family of standard simplices is to be replaced by the family of cubes).

The generating series of this operad is the generating series of the family of cubes: fₜ^{I}(x)=−x/1+(t+2)x. It is immediate to check that fₜ^{I}(fₜ^{I}(x))=x, hence one can presume that this is a Koszul operad. Indeed we can prove that the Koszul complex of the cubical trialgebra operad is acyclic. As in the dialgebra case the associative algebra on planar trees can be endowed with a comultiplication which makes it into a Hopf algebra. This comultiplication satisfies some compatibility properties with respect to the three operations [symbol] , [symbol] and ·. This subject will be dealt with in another paper. Here is the content of the paper 1. associative trialgebras and standard simplices. 2. dendriform trialgebras and Stasheff polytopes. 3. Homology and Koszul duality. 4. Acyclicity of the Koszul complex. 5. cubical trialgebras and hypercubes. In the first section we introduce the notion of associative trialgebra and we compute the free algebra. This result gives the relationship with the family of standard simplices. In the second section we introduce the notion of dendriform trialgebra and we compute the free algebra, which is based on planar trees. This result gives the relationship with the family of Stasheff polytopes. In the third section we show that the associated operads are dual to each other for Koszul duality. Then we construct the chain complexes which compute the homology of these algebras. The acyclicity of the Koszul complex of the operad is equivalent to the acyclicity of the chain complex of the free associative trialgebra. This acyclicity property is the main result of this paper (we refer to), it is proved in the fourth section. After a few manipulations involving the join of simplicial sets we reduce this theorem to proving the contractibility of some explicit simplicial complexes. This is done by producing a sequence of retractions by deformation. In the fifth section we treat the case of the family of hypercubes, along the same lines. These results have been announced in [LR2]. Convention. The category of vector spaces over the field K is denoted by Vect, and the tensor product of vector spaces over K is denoted by ⊗. The symmetric group acting on n elements is denoted by Sₙ. associative trialgebras and standard simplices. In [L1, L2] the first author introduced the notion of associative dialgebra as follows. 1.1 Definition. An associative dialgebra is a vector space A equipped with 2 binary operations: ┤ called left and [symbol] called right, (left) ┤: A⊗A→A, (right) ├: A└A→A, satisfying the relations: {(x [symbol] y) [symbol] z=x [symbol] (y [symbol] z), (x [symbol] y) [symbol] z=x [symbol] (y [symbol] z), (x [symbol] y) [symbol] z=x├(y┤z), (x [symbol] y) [symbol] z=x [symbol] (y [symbol] z), (x [symbol] y) [symbol] z=x [symbol] (y [symbol] z). Observe that the eight possible products with 3 variables x,y,z (appearing in this order) occur in the relations. Identifying each product with a vertex of the cube and moding out the cube according to the relations transforms the cube into the triangle Δ²: cube: ┤(├), ├(├), (├)├, (┤)├, ┤(┤), ├(┤), (├)┤, (┤)┤, →triangle: ├┤, ┤┤, ├├. There are double lines which indicate the vertices which are identified under the relations. Let us now introduce a third operation ⊥: A⊗A→A called middle. We think of left and right as being associated to the 0-cells of the interval and middle to the 1-cell: ┤⊥├ • . . . •. Let us associate to any product in three variables a cell of the cube by using the three operations ┤, ├,⊥. The equivalence relation which transforms the cube into the triangle determines new relations (we indicate only the 1-cells): cube: ⊥(├), (⊥)├, ┤(⊥), ├(⊥), (├)⊥, (┤) ⊥,⊥(├), (⊥)┤, →triangle: ⊥┤, ├⊥, (┤)⊥=⊥(├). This analysis justifies the following: 1.2 Definitions. An associative trialgebra (resp. an associative trioid) is a vector space A (resp. a set X) equipped with 3 binary operations: ┤ called left, ├ called right and ⊥ called middle, satisfying the following 11 relations: {(x┤y)┤z=x┤(y┤z), (x┤y)┤z=x┤(y├z), (x├y)┤z=x├(y┤z), (x┤y)├z=x├(H├z), (x├y)├z=x├(y├z), {(x┤y)┤z=x┤(y⊥z), (x⊥y) ┤z=x⊥(y┤z), x┤y)⊥z=x⊥(y├z), x├y)⊥z=x├(y⊥z), (x⊥y)├z=x├(y├z), {(x⊥y)⊥z=x⊥(y⊥z). First, observe that each operation is associative. Second, observe that the following rule holds: “on the bar side, does not matter which product”. Third, each relation has its symmetric counterpart which consists in reversing the order of the parenthesizing, exchanging ├ and ┤, leaving ⊥ unchanged. A morphism between two associative trialgebras is a linear map which is compatible with the three operations. We denote by Trias the category of associative trialgebras. dendriform trialgebras and Stasheff polytopes. In [L1, L2] the first author introduced the notion of dendriform dialgebras. Here we add a third operation. 2.1 dendriform trialgebras. By definition a dendriform trialgebra is a vector space D equipped with three binary operations: [symbol] called left, [symbol] called right, · called middle, satisfying the following relations: {(x [symbol] y) [symbol] z=x [symbol] (y*z), (x [symbol] y) [symbol] z=x [symbol] (y [symbol] z), (x*y) [symbol] z=x [symbol] (y [symbol] z) {(x [symbol] y)·z=x [symbol] (y·z), (x [symbol] y)·z=x (y [symbol] z), (x·y)<z=x·(y [symbol] z), {(x·y)·z=x·(y·z), where x*y:=x [symbol] y+x [symbol] y+x·y. 2.2 Lemma. The operation * is associative. Proof. It suffices to add up all the relations to observe that on the right side we get (x*y)*z and on the left side x*(y*z). Whence the assertion. In other words, a dendriform trialgebra is an associative algebra for which the associative operation is the sum of three operations and the associative relation splits into 7 relations. We denote by Tridend the category of dendriform trialgebras and by Tridend the associated operad. By the preceding lemma, there is a well-defined functor: Tridend→As, where As is the category of (nonunital) associative algebras. Observe that the operad Tridend does not come from a set operad because the operation * needs a sum to be defined. However there is a property which is close to it. It is discussed and exploited in [L3]. By definition the Koszul complex associated to the operad Trias is the differential functor Tridend ∘ Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C*^{Trias}(Trias(V)) is proved. 1. We show that it is sufficient to treat the case V=K. 2. The chain complex C*^{Trias}(Trias(K)) splits into the direct sum of chain complexes C*(u), one for each element u in P_{m,m}≥1. 3. The chain complex C*(u) is shown to be the cell complex of a simplicial set X(u). 4. The space X(u) is shown to be the join of spaces X(v) for certain particular elements v in Pₘ″. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B*B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A).

Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τ₁, so μ is not pure. Conversely, suppose μ is not pure, so there is μ>ν>0 with ν not a scalar multiple of μ. Then μ=(μ−ν)+ν which is a convex linear combination of states (once the terms have been normalized) using the fact that ∥μ−νν=lim(μ−ν)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K:ϕ(v₁)=ϕk(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] =g, the following diagram commutes: [symbol] *0→X^{g}↓_{Q}^{f} [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′aᵢ″, where aᵢ′, aᵢ″∈A. But aᵢ′ and aᵢ″ are in A′. Therefore g′∈A′, which is a contradiction″ the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. We consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h} Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). The magnitudes signals (sources) from random dilution of random matrices H_{N}=U_{N} F_{N} U^{†}_{N}, where U_{N} are uniformly distributed over the group of N×N unitary matrices and F_{N} are non-random Hermitian matrices, or real and complex Hermitian solutions our system of equations function. Equilateral number in base point k-face element plane the fundamental group we consider the category of pointed topological spaces, i.e. topological spaces with distinguished points finite-dimensional vector space of nondegenerate 2-form structure in potential theory complex analysis proves invaluable mathematical physics expressions an infinite potential n=2 flat dual vector space our bifunctor is a binary functor whose domain is a product category. For example, the Horn functor is of the type C^{op}×C→Set. It can be seen as a functor in two arguments. The Horn functor is a natural example; it is contravariant in one argument, covariant in the other. Our multifunctor is a generalization of the functor concept to n variables. So, for our example, a bifunctor is a multifunctor with n=2. (We refer to). “We shall sketch the proof for the case n=2 with the centralizer of an element in a one-relator group with torsion is always cyclic” An Improved Subgroup Theorem For HNN Groups with Some Applications. In [4], a subgroup theorem for HNN groups was established. (see Newman [11] or [4, p. 956]) B. B. Newman, Some results on one-relator groups, Bull. Amer. Math. Soc. 74 (1968), 568-571. One then gets the convolution algebra C_{c}^{∞}(G, Ω^{1/2}) of smooth 1-densities on G, infinite connected manifolds the Θⱼ(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries. (We refer to) “Tian 13 gave the maximal and minimal ranks of two real matrices X₀ and X1 in solution X X₀ iX₁ to AXB C over C with its applications, and Liu et al. 9 derived the maximal and minimal ranks of the two real matrices X₀ and X1 in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations,” Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. (We refer to) “An Improved Subgroup Theorem For HNN Groups with Some Applications”. Introduction. In [4], a subgroup theorem for HNN groups was established. The theorem was proved by embedding the given HNN group in a free product with amalgamated subgroup and then applying the subgroup theorem of [3]. In this paper (we refer to) we obtain a sharper form of the subgroup theorem of [4] by applying the Reidemeister-Schreier method directly, using an appropriate Schreier system of coset representatives. Specifically, we prove (in Theorem 1) that if H is a subgroup of the HNN group (1) G= [symbol] t, K; tLt⁻¹=M [symbol] , then H is an HNN group whose base is a tree product of vertices cKc⁻¹∩H where c ranges over a double coset representative system for G mod (H, K); the amalgamated and associated subgroups are contained in vertices of this base and are of the form dMd⁻¹∩H where d ranges over a double coset representative system for G mod (H, M). This improved subgroup theorem for HNN groups was obtained independently by D. E. Cohen [1] using Serre's theory of groups acting on trees. Using the present version of the subgroup theorem, several proofs in [4] can be simplified and results strengthened (see, e.g., [1]). Here we give two new applications of the improved subgroup theorem. Our first application deals with subgroups with non-trivial center of one-relator groups. Definition. A treed HNN group is an HNN group whose base is a tree product and whose associated subgroups are contained in vertices of the tree product base. Let H be a f.g. (finitely generated) subgroup with center Z (≠1) of a torsion-free one-relator group G. Then H as a free Abelian group of rank two, or H is a treed HNN group with infinite cyclic vertices and with center contained in the center of the base (see Theorem 2). Two corollaries are the following: If H is a subgroup with center Z (≠1) of a torsion-free one-relator group, then Z is infinite cyclic unless H is free Abelian of rank two or H is locally infinite cyclic. If H is a f.g. subgroup of the centralizer C of an element x in a torsion-free one-relator group and H∩gp (x)=1, then H is a free group. The first corollary was obtained independently by Mahimovski [8]. Theorem 2 generalizes Pietrowski's [12] characterization of one-relator groups having non-trivial centers. The centralizer of an element in a one-relator group with torsion is always cyclic (see Newman [11] or [4, p. 956]) B. B. Newman, Some results on one-relator groups, Bull. Amer. Math. Soc. 74 (1968), 568-571. Our second application connects the structure of a subgroup of finite index of a certain type of treed HNN group to its index. Classical examples of such a connection are given by the Schreier rank formula for free groups, the Euler characteristic for fundamental groups of orientable compact surfaces as compared with that of a j-sheeted covering space, and the Riemann-Hurwitz formula for Fuchsian groups. Each of these cases may be viewed as associating a number x(G) to each group G in the class so that if G: H=j, then x(H)=j·x(G); indeed, we take this property as the defining property of a characteristic defined on a class of groups closed under taking subgroups of f.i. (finite index). Specifically, for the free group G take x(G)=1-rank G, for the fundamental group G= [symbol] a₁, b₁, a_{g}, b_{g}, Π[aᵢ, bᵢ] [symbol] let x(G)=2−2g, and for the Fuchsian group G= [symbol] c₁, • • •, cₜ, a₁, b₁, • • •, a_{g}, b_{g}; c₁^{y1}, • • •, cₜ^{yt}, c₁⁻¹[a₁, b₁] • • • [a_{g}, b_{g}] [symbol] let x(G)=2g−2+Σ(1−yi⁻¹). In all three cases if x(G)≠0, then isomorphic subgroups of f.i. must have the same index; indeed, in the first two cases x(H) determines H (up to isomorphism). In any case, knowing the index of the subgroup H determines x(H), and therefore limits the structure of H. Wall [15] introduced a “rational Euler characteristic” for finite extensions of discrete groups which admit a finite complex as classifying space. For these groups, not only does x(H)=j·x(G) when G:H=j, but also the formula x(A*B)=x (A)+x(B)−1 holds. The class of groups considered by Wall includes finite extensions of f.g. free groups, and for these groups Stallings [14] generalized Wall's formula to x(A*B; U)=x(A)+x(B)−|U|⁻¹, where U is a finite group (of order |U|), and A, B are finite extensions of f.g. free groups. We generalize this further to show that if G is a treed HNN group with finitely many vertices A₁, • • •, Aᵣ each of which is a finite extension of a free group, and there are finite amalgamated subgroups U₁, • • •, Uᵣ₋₁ and finitely many pairs of finite associated subgroups L₁, M₁, • • •, Lₙ, Mₙ, then Wall's characteristic x(G) is given by (2) x(G)=x(A₁)+ • • • +x(Aᵣ)−|U|⁻¹− • • • −|Uᵣ₋₁|⁻¹−|M₁|⁻¹− • • • −|Mn|⁻¹ (see Theorem 3). We then extend the formula (2) using the more general notion of characteristic (indicated above) to other classes of treed HNN groups (see Theorem 4). The generalized formula applies to (Kleinian) function groups (certain discontinuous subgroups of LF (2, C)). 2. The subgroup theorem for HNN groups. Let G be as in (1). We may suppose that a set of generating symbols is chosen for K which includes a subset {m which generates M and a corresponding subset {Iᵢ} where Iᵢ=t⁻¹mᵢt, which generates L. A K-symbol is one of the chosen K-generators or its inverse; an M-symbol is one of the m or its inverse. Let H be a subgroup of G. In the proof of Theorem 1 below we shall show that there exists a Schreier coset representative system for G mod H of the form {Dₖ·Eₘ·Q(mᵢ)} where Q(mᵢ) is a word in M-symbols, Eₘ·Q(mᵢ) is a word in K-symbols, Dₖ does not end in a K-symbol, Dₖ·Eₘ does not end in an M-symbol, and in no representative does t follow a non-empty M-symbol. Moreover, {Dₖ} is a representative system for G mod (H, K), and {Dₖ·Eₘ} is a representative system for G mod (H, M). Theorem 1. Let G be as in (1), let H be a subgroup of G, and let a Schreier representative system for G mod H be chosen as described above. Then H is a treed HNN group whose vertices are of the form DₖKDₖ⁻¹∩H (where Dₖ ranges over the full double coset representative system for G mod (H, K)) and whose amalgamated and associated subgroups are of the form DₖEₘKEₘ⁻¹Dₖ⁻¹∩H (where DₖEₘ ranges over the full double coset representative system for G mod (H, M)). Proof. The proof of the theorem is analogous to that of the proof of the subgroup theorem (Theorem 5) of [3], and so we merely sketch the argument. First we construct a Schreier representative system for G mod H of the type described. For this purpose define the length of an (H, K) double coset as the shortest length of any word in it. For the (H, K) coset of length 0, we choose the empty word 1 as its K-double coset representative. To obtain the Schreier representatives for the H-cosets of H in HK, we supplement the double coset representative 1 with a special Schreier system (defined after Lemma 5, page 240 of [3] for K mod K∩H with respect to M. Assume we have defined Schreier representatives (in this manner) for all cosets of H contained in a double coset of (H, K) of length less than r. Let HWK and W have length r>0. Now W ends in a t-symbol; hence W=Vt^{e}, ₑ=±1. Moreover, the Schreier representative V* of V has already been defined and has the form V*=Dₖ·Eₘ·Q(mᵢ). If ₑ=1, then DₖEₘQ(mᵢ)t=DₖEₘtQ(Iᵢ), and so HDₖEₘtK=HWK, and we choose DₖEₘt as the double coset representative of HWK. If ₑ=−1, then choose DₖEₘQ(mᵢ)t⁻¹ as the double coset representative D of HWK. In either case we supplement our chosen double coset representative D of HWK with a special Schreier representative system for K mod K∩D⁻¹ HD with respect to M. We have now constructed a Schreier coset representative system for G mod H as described above. Using this Schreier system and the corresponding rewriting process, we may apply the Reidemeister-Schreier method (see [7, Section 2.3]) to obtain a presentation for H from our presentation for G. Now H has generators {S_{N·x}} and {S_{N,t}} semiprime is a Schreier representative and x is a K-generator. Moreover, {S_{N,x}}, semiprime has a fixed (H, K) double coset representative Dₖ and x ranges over the K-generators, generates the subgroup D_{K}KD_{K}⁻¹∩H; {S_{N,y}}, semiprime has a fixed (H, M) double coset representative DₖEₘ and y ranges over the M-generators, generates the subgroup D_{K}EₘMEₘ⁻¹D_{K}⁻¹∩H. Moreover, if the relators of K are conjugated by those N with a fixed D_{k·}, and then the rewriting process τ is applied, the resulting relators together with the trivial generators S_{N,x} provide a set of defining relators for DₖKDₖ−1∩H. The defining relators for H that arise from rewriting {t|ᵢt⁻¹ mᵢ} enable us to eliminate the generators S_{N,t} semiprime is not a double coset representative for G mod (H, M); moreover, the remaining relators take the form (3) S_{DkEm,t} ((DₖEₘt)*L(DₖEₘt)*⁻¹∩H) S_{DkEm,t}⁻¹=DₖEₘMEₘ⁻¹Dₖ⁻¹∩H. Now (3) describes an amalgamation which takes place between vertices (DₖEₘt)*K(DₖEₘt)*⁻¹∩H and (DₖEₘ)K(DₖEₘ)⁻¹∩H if S_{DkEm,t} is a trivial generator (i.e., (DₖEₘt)*≈DₖEₘt); otherwise, (3) describes a pair of associated subgroups from these same vertices. Specifically, if DₖEₘQ(mⱼ) is a representative, then S_{DkEm,t Q,t} is freely equal to τ[(DₖEₘ)*Q(mⱼ)(DₖEₘQ(mⱼ))*⁻¹]·S_{DkEm,t}·τ[(DₖEₘt)*Q(Iⱼ)(DₖEₘQ(Iⱼ))*⁻¹], and hence if Q(mⱼ)≠1, we may eliminate the generators S_{DkEm,Qt}; the remaining relators become those in (3) together with the trivial generators in {S_{DkEm,t}} The amalgamations described in (3) lead to a tree product of vertices DₖKDₖ⁻¹∩H for the following reason (see [7, Lemma 1]): Assign as level of the vertex DₖKDₖ⁻¹∩H, the number r of t-symbols in Dₖ; then the unique vertex of level less than r with which DRKDE^{I} A H has a subgroup amalgamated is the subgroup DKD−I A H where D is obtained from Dₖ by deleting the last t-symbol and then deleting any K-syllable immediately preceding that. Corollary 1. The rank of the free part of H as described in Theorem 1 is [G: (H, M)]−[G: (H, K)]+1. Proof. (DₖEₘt)*≈DₖEₘt if and only if either DₖEₘt is a Schreier representative and therefore an (H, K) double coset representative, or Eₘ=1 and Dₖ ends in t⁻¹. Thus there exists a one-one correspondence between (H, K) double coset representatives ending in t or t⁻¹ and the trivial generators in {S_{DkEm,t}} But there are G: (H, K)−1 double coset representatives for G mod (H, K) ending in t or t⁻¹; hence the assertion follows. The following corollary will be used in the proof of Theorem 4: Corollary 2. Let G be a treed HNN group with finitely many vertices, f.g. free part, and finite amalgamated and associated subgroups. Then any subgroup H of f.i. is a treed HNN group with finitely many vertices each of which is a conjugate of the intersection of H with some conjugate of a vertex of G; the amalgamated and associated subgroups are conjugates of the intersections of H with certain conjugates of the amalgamated and associated subgroups of G. Proof. The proof is by induction on the sum s of the rank of the free part of G and the number of vertices in G. If s=2, the result follows from the subgroup theorem of [3] or Theorem 1 above. Otherwise, suppose G is as in (1) where K is now a treed HNN group with smaller s than that of G. Then H is a treed HNN group whose vertices are of the form cKc⁻¹∩H=c(K∩c⁻¹Hc)c⁻¹, which by inductive hypothesis is a treed HNN group of the desired type. Now an amalgamated or associated subgroup of H has the form dMd⁻¹∩H. Thus H is an HNN group whose base is a tree product with treed HNN groups as vertices and finite amalgamated subgroups, and H itself has finite associated subgroups. It follows as in the argument for the proof of Theorem 1 of [2] that H is a treed HNN group of the asserted form. In a similar May, it follows that if G (A*B; U) where B has smaller s than that of G and A is one of the original vertices of G, then H will be a treed HNN group of the desired type. 3. Subgroups with non-trivial center of one-relator groups. Theorem 2. Let G be a group with one defining relator R where R is not a true power, and let H be a f.g. subgroup of G with non-trivial center Z. Then H is free Abelian of rank two, or H is a treed HNN group with infinite cyclic vertices and Z is contained in the center of the base of H. Proof. If R has syllable length one, then G is free, H is infinite cyclic, and the result holds. Assume R has syllable length greater than one; then G can be embedded in an HNN group G₁= [symbol] t, K; rel K, tLt⁻¹=M [symbol] where K is a one-relator group whose relator is shorter than R and L, M are free (see e.g., [4]). Suppose H is not free Abelian of rank two. Now by Theorem 1, a f.g. subgroup H of G₁ is a treed HNN group H= [symbol] t₁, • • •, tₙ, S; rel S, t₁Lₜ₁⁻¹=M₁, • • • [symbol] where S is a tree product of finitely many vertices A₁, • • •, Aᵣ, each Aᵢ being a subgroup of a conjugate of K; the amalgamated and associated subgroups are free. If n≠1, then Z is contained in S; for, H=Π*(gp(t₁, S); S). First suppose Z [symbol] S^{H}. Then n=1. Since some element in Z is not in S^{H} and H is f.g., and S/S^{H} is infinite cyclic, it follows that S^{R} is f.g. (see Murasugi [10]). Therefore S^{H}=L₁ is free and f.g. Consequently, H has the asserted form by [2, Theorem 3]. Therefore we may assume Z<S^{H}. We show, in fact, that Z<S. If n≠1, we are finished. Suppose n=1. Then S^{H} is an infinite stem product (i.e., a tree product in which each vertex has at most two edges incident with it) of vertices t₁ⁱSt₁⁻ⁱ. If M₁≠S≠L₁, then the stem product is proper (i.e., each amalgamated subgroup is a proper subgroup of its containing vertices), and therefore Z is contained in S. If S equals L₁ or M₁, then S is free; S^{H} is an ascending union of free groups and has a non-trivial center, so that S must be infinite cyclic. If S=gp(a)=L₁, and M1=gp(a^{q}), then H= [symbol] t₁, a; t₁at₁⁻¹=a^{q} [symbol] . Since Z∩S≠1, t₁a^{r}t₁⁻¹=a^{q r}=a^{r} for some r≠0. Hence q=1, and H would be free Abelian of rank two. Therefore Z must be contained in S. Suppose next S consists of a single vertex, S=gKg⁻¹∩H. If n=0, then H=S, is a f.g. subgroup with non-trivial center of the group gKg⁻¹; therefore by the inductive hypothesis, H has the desired form. If n>0, and some Lᵢ or Mᵢ equals S, then S is free with non-trivial center, and so must be infinite cyclic. Thus again H has the asserted form with base S. We may therefore assume that S^{H} is a proper tree product of the vertices tᵢ^{j}Stᵢ^{-j}, and so Z<Lᵢ∩Mi. Since Lᵢ, Mᵢ are free, Z, Lᵢ, Mᵢ must each be infinite cyclic. Therefore S is a f.g. subgroup of gKg⁻¹ and the inductive hypothesis applies to S. Since Z is infinite cyclic, it follows that S is a treed HNN group with infinite cyclic vertices each of which contains Z, and each of the associated subgroups contains Z. Therefore S/Z is a treed HNN group with finite cyclic vertices; moreover, Lᵢ/Z goes into Mᵢ/Z under conjugation by tᵢ. Hence H/Z is an HNN group with finite cyclic vertices, and the associated subgroups of H/Z are finite. Therefore H/Z is a treed HNN group with finite cyclic vertices, and so by the proof of [2, Theorem 3] H has the asserted form. Finally, suppose S does not consist of a single vertex. Then S is a proper tree product and Z is contained in the amalgamated subgroups of S; these are free and therefore infinite cyclic. Moreover, since Z<Lᵢ∩Mᵢ, we have that Lᵢ, Mᵢ are infinite cyclic. Hence each of the vertices Aⱼ of S is f.g. and the inductive hypothesis applies to each Aⱼ. Hence Aⱼ/Z is a treed HNN group with finite cyclic vertices, and the amalgamated and associated subgroups when reduced mod Z yield finite cyclic groups. Thus H/Z is an HNN group whose base is a tree product of treed HNN groups with finite cyclic vertices; the amalgamated and associated subgroups are finite cyclic groups. Hence H/Z is a treed HNN group with finite cyclic vertices, and consequently H has the asserted form (again by the proof of [2, Theorem 3). Corollary 1. Let H be a subgroup with non-trivial center Z of a torsion-free one-relator group G, H not free Abelian of rank two and not locally infinite cyclic. Then Z is infinite cyclic. Proof. If H is f.g., then Z is infinite cyclic because Z is in the center of the tree product base of H, which has infinite cyclic vertices. Suppose H is infinitely generated. Then H is the ascending union of countably many f.g. subgroups Hᵢ each containing a f.g. subgroup Zᵢ of Z such that Z is the ascending union of the Zᵢ. Now by Moldavanski [9] or Newman 11], no Abelian subgroup of G can be a proper ascending union of free Abelian groups of rank two. Hence only finitely many Hᵢ can be free Abelian of rank two. Thus Zᵢ must be infinite cyclic, and so Z is infinite cyclic if Z is f.g. Suppose Z is infinitely generated. Then H/Z is periodic. For otherwise, for some element h of H, gp(h, Zᵢ) is free Abelian of rank two, and gp(h, Z)=∪gp(h, Zᵢ) which is impossible. Hence, if Cᵢ is the center of Hᵢ, then Hᵢ/Cᵢ is on the one hand periodic, and on the other hand a treed HNN group with finite cyclic vertices. Therefore, Hᵢ/Cᵢ is finite, and so Hᵢ is infinite cyclic. Consequently, H is locally infinite cyclic. Corollary 2. If H is a f.g. subgroup of the centralizer C of an element x in a torsion-free one-relator group and H∩gp(x)=1, then H is a free group. Proof. Let H₁=gp(H, x), which is the direct product H X gp(x). If H₁ is free Abelian of rank two, then clearly H is infinite cyclic. If H₁ is not free Abelian of rank two, then the center Z of H₁ is infinite cyclic and therefore equals gp(x). Now since H₁ is a treed HNN group with finitely many cyclic vertices each of which contains Z and each of whose associated subgroups contains Z, it follows that H₁/Z is a treed HNN group with finite cyclic vertices, which is isomorphic to H. Since H is torsion-free, H must be free. 4. Characteristics of groups. Lemma 1. Suppose G is as in (1) and R is a subgroup of K such that R has trivial intersection with the conjugates of L and M in K. Let {aᵢ} be a common double coset representative system for K mod (R, M) and K mod (R, L). Then the subgroup H=R*Πⱼ*gp (aⱼtaⱼ⁻¹) is of index [K: (R, M)]·|M|. In Particular, if K:R and |M| are both finite, then a common double coset representative {aᵢ} exists and H is of finite index in G; if R is free (or torsion-free), then so is H. Proof. We show H is a subgroup of the asserted form and index by constructing H using an appropriate Schreier representative system and a corresponding right coset function. For this purpose choose a set of generating symbols for K which is the union of the following three subsets: the symbols {aᵢ}, the symbols {r_{q}} where r_{q} ranges over the elements of R, and the symbols {mⱼ} where mⱼ ranges over the elements of M; the empty symbol 1 is included among the symbols {aᵢ} as well as {mⱼ}. We use the symbols Iⱼ to denote t⁻¹mⱼt. As Schreier representatives take the words {aᵢmⱼ}. A corresponding right coset function is determined by the following assignments:=(aᵢmⱼk)*=aᵤmᵥ where aᵢmⱼk=r_{q}aᵤmᵥ, for k any K-symbol; (aᵢmⱼt)*=aᵤmᵥ where aᵢIⱼ=r_{q}aᵤmᵥ; and (aᵢmⱼt⁻¹)*=aᵤmᵥ where aᵢmⱼ=r_{q}aᵤIᵥ. It is not difficult to show that these assignments define a permutation representation of G acting on the chosen representatives {aᵢmⱼ}, and hence determine a subgroup H of elements of G which leave the representative 1 fixed. Clearly, H∩K=R; for, the first of the three representative assignments holds when k is any element of K, and so if (k)*=aᵤmᵥ=1 then k=r_{q}. This enables us to show that the Schreier system {aᵢmⱼ} has the required properties to apply Theorem 1. In particular, 1 is the HK double coset representative, and {aᵢ} is a set of representatives for G mod (H, M). Therefore H is a treed HNN group with a single vertex K ∩H=R, the amalgamated and associated subgroups are aᵢMaᵢ⁻¹∩H=aᵢMaᵢ⁻¹∩R=1; and its free part is generated by s_{ai,t}=aᵢt(aᵢt)*⁻¹=aᵢtaᵢ⁻¹ Let G contain a free subgroup F of rank r and finite index j. Then Wall's rational Euler characteristic x(G) (mentioned in the introduction) is given by x(G)=(1−r)/j (this is obtained using Wall's formulas quoted and that the Euler characteristic of an infinite cyclic group is 0). In particular, if G is finite, then x(G)=|G|⁻¹. Lemma 2. Let G be as in (1). Suppose that K contains a free subgroup R of finite index, and that M is finite. Then the Wall characteristic of G is given by x(G)=x(K)−x(M)=x(K)−|M|⁻¹. Proof. Applying Lemma 1, we see that H of that Lemma is free and of finite index in G. Moreover, x(G)=(1−rank H)/[K: (R, M)]·|M|, and rank H=rank R+[K: (R, M)]. Therefore x(G)={1−rank R+[K: (R, M)])}/[K: (R, M)]·|M|=(1−rank R)/[K:R]−|M|⁻¹=x(G)−x(M). Theorem 3. If G is a treed HNN group with vertices A₁, • • • , Aᵣ each of which is a finite extension of a free group, finite amalgamated subgroups U₁, • • • , Uᵣ₋₁, and pairs of finite associated subgroups L₁, M₁, • • •, Lₙ, Mₙ, then Wall's characteristic x(G) is given by (4) x(G)=x(A₁)=+ [symbol] +x(Aᵣ)−|U|⁻¹− • • • −|Uᵣ₋₁|⁻¹−|M₁|⁻¹− • • •−|Mₙ|⁻¹. Proof. The proof of (4) is clearly obtained by using Lemma 2, and Stalling's formula quoted in the introduction. We generalize Wall's characteristic as follows: Definition. Let C be a class of groups closed under taking subgroups of f.i. Then a characteristic x defined on C is a real-valued function defined on C such that if G is in C and G:H=j, then x(H)=j·x(G). In addition to the illustrations of characteristics mentioned in the introduction we give the following: 1. Let C₁ be a class of groups with a characteristic x₁ defined on it. Let C be the class of all groups which contain a subgroup of f.i. which lies in C₁. If G is in C, and G:C=p where C is in C₁, define x(G)=x₁(C)/p. Clearly if G:D=q where D is in C₁, and C/C∩D=c, D/C∩D=d, then x₁(C)/p=x₁(C∩D)/cp=x₁(C∩D)/dq=x₁(D)/q, so that x(G) is well-defined. Moreover, if G:H=j, and H:E=r where E is in C₁, then x(H)=x₁(E)/r=j·x₁(E)/jr=j·x(G). 2. Let C be the class of subgroups of f.i. of a fixed group G. Then a necessary and sufficient condition for a non-zero characteristic to be definable on C is that isomorphic subgroups of f.i. in G have the same index in G. Indeed, if H₁≃H₂, G:H₁=j₁, G:H₂=j₂, and x(G)≠0, then x(H₁)=j₁·x(G)=x(H₂)=j₂·x(G), so that j₁=j₂. Conversely, define x(G)=1, x(H)=j when G:H=j; then x(G) is a well-defined characteristic. Our last example of a characteristic makes use of Theorem 1 and the subgroup theorem of [3]. Theorem 4. Suppose C₁ is a class of f.g. groups with a characteristic x₁ defined on and such that each group in C₁ contains a torsion-free non-cyclic indecomposable (with respect to free product) subgroup of finite index. Let C be the class of treed HNN groups with f.g. free part, finitely many vertices each in C₁, and finite amalgamated and associated subgroups. Suppose G is in C, and has a presentation as a treed HNN group with vertices A₁, • • • , Aᵣ in C₁, amalgamated subgroups U₁, • • • Uᵣ₋₁, and pairs of associated subgroups L₁, M₁, • • • , Lₙ, Mₙ. If we set x(G)=x(A₁)+ • • • +x(Aᵣ)−|U|⁻¹− • • • −|Uᵣ₋₁|⁻¹−|M₁|⁻¹− • • • −|Mₙ|⁻¹. Then x defines a characteristic on the class C. Proof. We first observe that the class (C is closed under forming treed HNN groups with vertices from C, using finite amalgamated and associated subgroups (for an argument, see the proof of Theorem 1 of [2]). Next We note (see [3]) that a subgroup H of (AB; U) is a treed HNN group with vertices cAc⁻¹∩H, dBd⁻¹∩H where c, d range over double coset representative systems for G mod (H, A) and G mod (H, B), respectively; moreover, the amalgamated and associated subgroups are of the form e∪e⁻¹∩H where e ranges over a double coset representative system for G mod (H, U). It follows from Corollary 2 of Theorem 1 that C is closed under taking subgroups of f.i. We now show that if G:H=j, then for each presentation of G as a treed HNN group in C, H has a presentation as a treed HNN group in C for which x(H)=j·x(G). Indeed, suppose that this assertion holds for A, B in C, and consider G=(A*B; U), U finite. Now cAc⁻¹: cAc⁻¹∩H=j_{c} is the number of H cosets in HcA. Hence cAc⁻¹∩H has a treed HNN presentation in C such that x(cAc⁻¹∩H)=j_{c}·x(cAc⁻¹)=j_{c}·x (A). Similarly, if j_{d}=dBd⁻¹: dBd⁻¹∩H, and jₑ eUe⁻¹: eUe⁻¹∩H, then x(H)=Σ_{c} j_{c}·x(A)+Σ_{D jd}·x(B)−Σ_{e je}·|U|⁻¹=j[x(A)+x(B)−|U|⁻¹]=j·x(G). Similarly, if the assertion of the preceding paragraph holds for K in C, and G is as in (1) with M finite, and G:H=j, then H is a treed HNN group with vertices fKf⁻¹∩H where f ranges over a representative system for G mod (H, K); moreover the amalgamated and associated subgroups are of the form gMg⁻¹ H where g ranges over a coset representative system for G mod (H, M). If j_{f}=fKf⁻¹: fKf⁻¹∩H, and j_{g}=gMg⁻¹: gMg⁻¹∩H, then x(H)=Σ_{f} j_{f}·x(K)−Σ_{g jg}·|M|⁻¹=j·[x(K)−|M|⁻¹]=j·x(G). Finally, we show that x is well-defined on the class C. Clearly, the only ambiguity in the definition of x(G) is that G may be presentable in several ways as a treed HNN group in C. Now an element G₁ of cannot be written in a non-trivial way as a treed HNN group with finite amalgamated and associated subgroups; for otherwise, G₁ would have two or infinitely many ends (see Stallings [13]), so that any torsion free subgroup of finite index would have two or infinitely many ends and would therefore be infinite cyclic or a proper free product (see Stallings [13]), contrary to hypothesis. Hence x is well-defined on the elements of C₁. Consider any torsion-free group T in C. Now T has a unique representation as a treed HNN group in C, namely, as a free product of a free group and groups from C₁. Using the uniqueness of representation of a f.g. group as a free product of indecomposable groups, it follows that x(T) is well-defined. Lastly, a group G in has a torsion free subgroup T of f.i., say p (by Stallings [14] and Lemma 1 above), and so x(G)=x(T)/p, so that x(G) is well-defined. Corollary. Let G be as described in Theorem 4, and G:H=j. Suppose that H has a Presentation as a treed HNN group with vertices B₁, • • • , Bₛ, amalgamated subgroups V₁, • • •, Vₛ₋₁, and pairs of associated subgroups P₁, Q₁, • • • , Pₘ, Qₘ. Then x₁(B₁)+ • • • +x₁(Bₛ)=j+x₁(A₁)+ • • • +x₁(Aᵣ)), and |V₁|⁻¹+ • • • +|Vₛ₋₁|⁻¹+|Q₁|⁻¹+ • • • +|Q₁|⁻¹=j(|U₁|⁻¹+ • • • +|Uᵣ₋₁|⁻¹+|M₁|⁻¹+ • • • +|Mₙ|⁻¹). Proof. Since x₁ can be replaced by x₂=2x₁ and the assertion of Theorem 4 will still hold, the result follows. As an illustration of Theorem 4, let C₁ be the class of Fuchsian groups described in the introduction, and let be the characteristic mentioned there. Then it is well-known that each group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0″. The resulting class (C includes Kleinian function groups (see [6]). Can. J. Math., Vol. xxvl, No. I, 1974, pp. 214-224. An Improved Subgroup Theorem For HNN Groups ‘with Some Applications’ by A. Karrass, A. Pietrowski, And D. Solitar. The map which assigns to every vector space its dual space and to every linear map its dual or transpose is a contravariant functor from the category of all vector spaces over a fixed field to itself. The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). The results for the transverse and vertical size of the cloud of atoms, as well as for the kinetic and potential energy per particle, are compared with the predictions of approximated models. We also compare the aspect ratio of the velocity distribution using worm algorithms simulate spaces of our system of equations the number of terms Abelian group Γ under addition n order of harmonic n-isotypic ratio of harmonic to fundamental the magnitudes signals (sources) with [symbol] gyromagnetic ratio are several critical exponents, thermodynamic magnetic the spherical model with long range, inverse power law interactions, leads to relations between these exponents since it expresses them in terms of two underlying exponents σ and τ. The exponent σ is directly related to the effective surface free energy of our sub-plasma system and thence to the dimensionality of our subspace critical point exponents including the thermal exponent y [symbol] , magnetic exponent yh, and loop exponent yl. We thus obtain a functor from the category of pointed topological spaces to the category of groups, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jg})=∧ . . . ∧eᵢₚ ∧eⱼ₁∧ . . . ∧e_{jq} when the indices i₁, . . . , iₚ, j₁, . . . , j_{q}, are distinct, and the product is zero otherwise. While the formula α∧α=0 holds when a has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Σ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, T^{m-1} F⁻ is a disjoint sequence, and μ(∪^{m-1}ᵢ₌₀Tⁱ F⁻)≥1−ε/2. Now express each set A∈V^{m-1}₀T⁻ⁱP/F⁻ as A₁ ∪A₁, A₁ ∪A₂=ϕ, μ(A₁)=μ(A₂), and put (m/2)−1 (m/2)−1 FA=[T2iA1 ∪[T2i−1A2 i=0 i=1. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of ∪^{m-1}ᵢ₌₀ Tⁱ F⁻, TⁱF⁻, 0≤i≤m−1. Thus if m is large enough, μ(F ∪ TF) will be at least 1−ε. This establishes that d(P/F)=d(P/F ∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}:Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M, ϕ) between (F_{g-}, ϕ₋) and (F_{g+}, ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}:F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module s; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙC^{k} p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V ) is equal by Lemma 7 to Indₐ=Indₜ. 2) The Thom isomorphism (Appendix C) ϕK*(V )=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V ) onto K(C*(V,F)), while for the only transverse measure ∧ for (V,F) (the horocycle flow being strongly ergodic), the composition of the above analytic index with dim_{∧}: preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓×3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B, δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G└R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0.

Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W ∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] n are the approximations to y to that our system of equations orders in the number of terms Gamma's definition [symbol] =lim_{n→∞}(Hₙ−1n n). The Space X of Quasiperiodic the little group integral submultiples of L v can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G,−1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of T consists of simplexes all of which have X; as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c E R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)″. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W ∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where yn are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of T consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c E R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry 52 consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊗ [symbol] ₚ of M⊗R for suitable p and [symbol] , it is necessary and sufficient that p₀(Θ)=pₐ(⊗). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type II₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tᵢ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=∪^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∀x∈X₀. We consider Tian 13 gave the maximal and minimal ranks of two real matrices X₀ and X1 in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F ₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • •,iₙ, 0, • • •) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 ⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H) g I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |.

A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F ₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution n and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • •,iₙ, 0, • • •) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution IT and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V ) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure A for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*ₜ(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S i are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114])(3.38)λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂)∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2; . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left [symbol] modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q. are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] i)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Si are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W ∪S1 W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{X}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₄ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )|= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π}{1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a O-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively D 4== • . . . =^{D}_{2N-2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(1)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of U; or the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)n=_{0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of U called the n-isotypic component of U we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Z_{P}). If p>2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{p})→(π×π, Z_{P},K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)} wⱼ× wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀ aₙ(x−c)ⁿ. Power series centered at 0: ^{∞}Σₙ₌₀xⁿ=1+x+x²+x³+x⁴+ . . . , ^{∞}Σₙ₌₀1/n!* xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and power series centered at 1:^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=A, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},(b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Affine function; and second fundamental form constants determined by the initial conditions representations we refer to survey of numerical solution of stochastic differential equations of P. E. Kloeden and E. Platen. High-order methods for strong sample path approximations and for weak functional approximations. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system of X is far from being trivial our longitudinal integral of the trivial bundle does vanish, i.e. the K-theory index of the longitudinal Dirac operator is equal to 0. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F: R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, s∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞} (G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the T-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C(V₀,F₀) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ. where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Periodic the properties S is a Koszul algebra, if k=S/ₙ has 0-linear resolution over S. The standard graded polynomial ring k[x₁, . . . , xₙ] (semiprime ≥1) is a Koszul algebra: k is resolved by the Koszul complex. Which is a linear resolution a period are the vectors wᵥ of all periods, the vectors wᵥ of all periods. Complex functions to those defined we operate on open connected sets, and a compact subset of an open set in the complex plane, in the complex space C^{p}, p≥1, p coordinates of the upper limits ^{x}1, . . . , ^{x}p, a system of sums lower integration limits ^{c}1, . . . , ^{c}p which are poles of the function in the complex space C^{p}, f(z)f(z), z=(^{z}1, . . . , ^{z}n)z=(^{z}1, . . . , ^{z}n), in the complex space CnCn, n>1n>1, a function f(z) in the variables ^{z}1, . . . , ^{z}p, ^{z=z}1, . . . , ^{z}p, is called an Abelian function if there exist ²p row vectors in C^{p}, wᵥ=(w1ᵥ, wₚᵥ), v=1, . . . , 2p, which are linearly independent over the field of real numbers and are such that f(z+wᵥ)=f(z) for all [symbol] ∈C^{p}, v=1, . . . , 2p periodic. (We refer to) “Acyclicity of the Koszul complex. By definition the Koszul complex associated to the operad Trias is the differential functor Tridend∘Trias from Vect to Vect. We will show that it is quasiisomorphic to the identity functor, equivalently we have the 4.1 Theorem. The homology of the free associative trialgebra on V is HnTrias(Trias(V))=nV if n=1, 0 otherwise. Homology of associative trialgebras. Ginzburg and Kapranov's theory of algebraic operads shows that there is a well-defined chain complex for any algebra A over the binary quadratic operad P, constructed out of the dual operad P^{!} as follows. The chain complex of the P-algebra A is C^{P}ₙ(A)=P^{!}(n)*⊗_{Sn} A^{⊗n} in dimension n and the differential d agrees, in low dimension, with the P-algebra structure of A [symbol] _{A}(2): P(2)⊗A^{⊗2}→A under the identification P^{!}(2)*≅P(2). In fact d is characterized by this condition plus the fact that on the cofree P^{!}-coalgebra C*^{P}(A)=P^{!}*(A) it is a graded coderivation. 3.4 Proposition. The chain complex of an associative trialgebra A is given by Cₙ^{Trias}(A)=K[Tₙ]⊗A^{⊗n}, d=Σⁱ⁼ⁿ⁻¹ᵢ₌₁(−1)ⁱdᵢ, where dᵢ(t;a₁, . . . , aₙ)=(dᵢ(t);a₁, . . . , aᵢ∘^{t}ᵢ aᵢ₊₁, . . . aₙ), and dᵢ(t) is the tree obtained from t by deleting the ith leaf and where ∘^{t}ᵢ is given by ∘^{t}ᵢ {├ if the ith leaf of t is left oriented, ┤ if the ith leaf of t is right oriented, ⊥ if the ith leaf of t is a middle leaf. Observe that at a given vertex of a tree there is only one left leaf, one right leaf, but there may be none or several middle leaves. Proof. First observe that this is a chain complex since the operators di satisfy the presimplicial relations dᵢdⱼ=dⱼ₋₁dᵢ for i<j. Indeed, this relation is either immediate (when i and j are far apart), or it is a consequence of the axioms of associative trialgebras when j=i+1. It suffices to check the case n=3, and this was done in 1.3. By Theorems 3.1 and 2.6 Ginzburg and Kapranov theory gives, as expected, Cₙ^{Trias}(A)=K[Tₙ]⊗A^{⊗n}. It is clear from 1.3 that d agrees with the Trias-algebra structure of A in low dimension. Since d is completely explicit, the coderivation property is immediate to check. 3.5 Proposition. The chain complex of a dendriform trialgebra A is given by Cₙ^{Tridend}(A)=K[Pn]⊗A⊗n, d=Σⁱ⁼ⁿ⁻¹ᵢ₌₁X(−1)ⁱdᵢ, where dᵢ(X; a₁, . . . , aₙ)=(dᵢ(X); a₁, . . . , aᵢ∘^{x}ᵢ aᵢ₊ᵢ, . . . aₙ), and dᵢ(X) is the image of X under the map dᵢ:[n]→[n−1] given by dᵢ(r_)={r−1 if i≤r, r if i≥r+1. and where ∘^{X}ᵢ is given by ∘^{X}ᵢ={if i−1∈X and i∈X, [symbol] if i−1∉X and i∈X, [symbol] if i−1∈X and i∉X, * if i−1∉X and i∉X. Proof. Again, observe that this is a chain complex since the operators dᵢ satisfy the presimplicial relations dᵢdⱼ=dⱼ₋₁dᵢ for i<j. Indeed, this relation is either immediate (when i and j are far apart), or it is a consequence of the axioms of dendriform trialgebras when j=i+1. It suffices to check the case n=3. We actually do the computation in one particular case, the others are similar: d₁d₂({0,2},a₁,a₂,a₃)=d₁({0,1};a₁,a₂ [symbol] a₃)=({0};a₁·(a₂ [symbol] a₃)=d₁d₁({0,2},a₁,a₂,a₃)=d₁({0,1};a₁ [symbol] a₂,a₃)=({0}; (a₁ [symbol] a₂)·a₃), These two elements are equal by the fifth relation in 2.1. Acyclicity of the Koszul complex. By definition the Koszul complex associated to the operad Trias is the differential functor Tridend∘Trias from Vect to Vect. We will show that it is quasi-isomorphic to the identity functor. Equivalently we have the Theorem. The homology of the free associative trialgebra on V is HnTrias(Trias(V))=nV if n=1, 0 otherwise. 4.1 Corollary. The operads Trias and Tridend are Koszul operads. 4.2 Corollary. The homology of the free dendriform trialgebra on V is: HnTridend(Tridend(V))=nV if n=1, 0 otherwise. 4.3 Corollary. Let f^{K}ₜ(x) be the generating series of the Stasheff polytope (i.e. of the planar trees), as defined in 1.12. Then one has f^{K}ₜ(x)=−(1+(2+t)x)+√1+2(2+t)x+t²x²/2(1+t)x. Proof of the Corollaries. By Ginzburg and Kapranov theory [G-K] the first two Corollaries follow from the vanishing of the homology of the free associative trialgebra. The last Corollary follows from the functional equation relating the two operads and the computation of the generating series for the associative trialgebra operad (cf. 1.12). Proof of Theorem 4.1. The acyclicity of the augmented complex C*^{Trias}(Trias(V)) is proved in several steps as follows. 1. We show that it is sufficient to treat the case V=K. 2. The chain complex C*^{Trias}(Trias(K)) splits into the direct sum of chain complexes C*(u), one for each element u in P_{m,m}≥1. 3. The chain complex C*(u) is shown to be the cell complex of a simplicial set X(u). 4. The space X(u) is shown to be the join of spaces X(v) for certain particular elements v in Pₘ. 5. Therefore one has L First step. We note from 1.8 that Trias(V)=_{n≥1} K[Pₙ]⊗V^{⊗n}. Cⱼ^{Trias}(Trias(V))=K[Tⱼ]⊗(⊗_{n≥1} K[Pₙ]⊗V^{⊗n})^{⊗j}=K[Tⱼ]⊗⊗_{m≥1} (⊗ₙ₁₊ [symbol] ₊ₙⱼ₌ₘK[Pₙ₁× . . . ×Pₙⱼ])⊗V^{⊗m}. Since d is homogeneous in V, the complex C*^{Trias} splits into the direct sum of subcomplexes, one for each m≥1. This subcomplex is in fact of finite length and, up to tensoring by V^{⊗m}, is of the following form: C*(Pₘ): 0→K[Tₘ×P₁× . . . ×P₁]→ . . . →Mj K[Tⱼ×Pₙ₁× . . . ×Pₙⱼ]→ . . . →K[T₁×Pₘ]. n1+ . . . +n=m we may recall that P₁ and T₁ have only one element. The case m=1 gives the subcomplex of length 0 reduced to V. This shows that H₁^{Trias}(Trias(V)) contains V as expected. For m≥2, the differential is simply the differential of C*(Pₘ) tensored by the identity of V^{⊗m}, hence it is sufficient to prove the acyclicity of C*(Pₘ) to prove the theorem. Second step. The chain complex C*(Pₘ) can still be split into the direct sum of smaller complexes indexed by the elements u of Pₘ. Indeed, let α:=(t;u₁, . . . , uⱼ)∈Tⱼ×Pₙ₁× . . . ×Pₙⱼ be a basis element. Under @@ applying j−1 face operators successively to α, we get an element (^{@@};u)∈T₁×Pₘ which does not depend on the choice of the face operators because of the simplicial relations (cf. 3.4). Considering t as an operation on m variables for associative trialgebras, u is nothing but the result of the evaluation of t on (x, . . . , x), cf. 1.3. Fixing u, let C*(u) be the chain @@ subcomplex linearly generated by the elements α whose image is (^{@@};u)∈T₁×Pₘ. It is clear that C*(Pₘ) is the direct sum of the chain complexes C*(u),u∈Pₘ. Observe that C*(u) is of simplicial type, that is, its boundary is of the form d=−Σⁱ⁼ⁿ⁻¹ᵢ₌₁(−1)ⁱdᵢ. Third step. We fix u∈Pₘ. At this point it is helpful to modify slightly our indexing of the faces and have them to run from 0 to n−2 rather than from 1 to n−1. We also shift the indexing of the complex C*(u) by 1, putting K[T₁×Pₘ] in dimension −1. For any generator α of C*(u) the faces dᵢ(α),0≤i≤n−2, are still generators of C*(u). Hence C*(u) is the normalized augmented complex of an augmented simplicial set that we denote by X(u). The nondegenerate simplices of X(u) are the linear generators α of C*(u). The top dimensional ones are of the form (t;x, . . . , x)∈X(u)ₘ₋₂ where t=t₀V . . . V tₖ∈T_{q}. The integer k is the number of decorations (Cech signs) appearing in u. We denote by T_{{u}} this subset of Tₘ. At the other end the augmentation set is X(u)₋₁=T₁×{u} (one element). The geometric realization of X(u) is the amalgamation of simplices Δ^{m-2} (one for each t∈T_{{u}}) under the following rule: if dᵢₖ . . . dᵢ₁(t;x, . . . , x)=dᵢₖ . . . dᵢ₁(t′;x, . . . , x) for some m−2≥iₖ≥ . . . ≥i₁≥0, then we identify the corresponding (oriented) faces of the simplices t and t′. Observe that under this rule a vertex of type i is identified only with a vertex of type i. Fourth step. We may recall the join construction of augmented simplicial sets (cf. for instance [E−P]). An augmented simplicial set is a simplicial set X together with a set X₋₁ and a map d₀: X₀→X₋₁ satisfying d₁d₀=d₀d₀. The join of two augmented simplicial sets X and Y is Z=X*Y defined by Zₙ=Fp_{+q=n-1}Xₚ×Y_{q}. The faces are dᵢ(x,y)=(dᵢx,y) for 0≤i≤p, dᵢ(x,y)=(x,dᵢ₋ₚ₋₁y) for p+1≤i≤p+1+q, and similarly for the degeneracies. The geometric realization of the simplicial join is the topological join X*Y=X×I×Y/{(x, 0, y)˜(x′, 0, y), (x, 1, y)˜(x, 0, y′)}. In particular one has Δ^{p}*Δ^{q}=Δ^{p+q+1}. Let u=x . . . xxx\check{ } . . . xxx\check{ }. . . x∈Pₘ. By direct inspection we see that X(u) is the simplicial join of the simplicial sets X(x . . . x\check{ }), X(x\check{ } . . . x . . . x\check{ }), . . . , X(x\check{ } . . . x . . . x\check{ }), X(x\check{ } . . . x). The point is that there are only one Cech signs at the extreme locations. Hence it is sufficient to show the contractibility of X(u) in the cases u=x\check{ } . . . x . . . x\check{ } and u=x\check{ } . . . x. 5. Fifth step: the case u=x\check{ } . . . x . . . x\check{ } or u=x\check{ }. . . x∈Pₘ. We treat in detail the case u=x\check{ } . . . x, the other one is similar. Since u=x\check{ } . . . x the trees t in T_{{u}} are of the form @@@@@@@@ . . . @@@@@ Hence the 0-cell (d₀)^{m-2}(t;x, . . . , x)=(^{@@@@ @@}; \check{ }xx . . . x,x) is the same for all t∈T_{{u}}. We denote this vertex by P. In other words, in the amalgamation of the (m−2)-simplices (t;x, . . . , x) giving X(u), all the vertices of type m−2 get identified to P. We will show that there exists a sequence of retractions by deformation X(u)=X(u)^{hm-2i}→ . . . →→→X(u)^{hki}→ . . . →→^{ϕ}→^{k}X(u)^{h0i}=P. The simplicial set X(u)^{hki} is a subsimplicial set of X(u) determined by its nondegenerate k simplices. It is defined inductively as follows. We suppose that X(u)^{hki} has been defined (the induction process begins with k=m−2) and we determine X(u)^{hk-1i}. On X(u)^{hki} we introduce the equivalence relation generated by: α˜β if either dₖα=dₖβ or dₖ₋₁α=dₖ₋₁β. Then in each equivalence class we pick an element, say α₀. By definition X(u)^{hk-1i} is made of the elements dₖ₋₁α₀, one for each equivalence class. The map ϕₖ is defined by ϕₖ(α)=sₖ₋₁dₖ₋₁α₀. On the geometric realization the map ϕₖ consists in collapsing each k-simplex α to its last face (the edge relating the vertices k−1 and k collapses to a point), and then embedding this face into X(u) as dₖ₋₁α₀. All the collapsing are coherent, and so assemble to give a collapsing of X(u)^{hki} to X(u)^{hk-1i}, because one can verify that for each vertex of type k−1 in X(u)^{hki} there is only one edge to the edge relating it to the vertex of type k, that is P. Here for m=4, u=xxxx\check{ } and the planar binary trees d0 d1 d2. Hence the simplices a,b,c,d,e of type Δ² are amalgamated under the following rules: d₀(a)=d₀(b)=d₀(c), d₀(d)=d₀(e), d₁(c)=d₁(d), d₂(a)=d₂(b). The first two spaces of the sequence (binary case) X(xxxx\check{ })=X(xxxx\check{ })^{h2i}→→X(xxxx\check{ })^{h1i}→→X(xxxx\check{ })^{h0i}=P. In the planar tree case X(u)^{h2i} is made of eleven 2-simplices, X(u)^{h1i} is made of seven 1-simplices and X(u)^{h0i} is made of one 0-simplex (namely P). Since each map ϕₖ is a retraction by deformation, the space X(u)=X(u)^{hm-2i} has the same homotopy type as X(u)^{h0i}=P hence it is contractible”. Trialgebras and families of polytopes introduced by Jean-Louis Loday and María Ronco May 6, 2002. Acyclicity of the Koszul complex Bₙ,Bₙ(x) Bernoulli number and polynomial B^{˜}ₙ(x) periodic Bernoulli function Bₙ(x−└x┘)Bₙ and Lemma 2.3 (Conca, Iyengar, Nguyen and Romer, [9, Corollary 6.4]). (We refer to) “Let f≠0 be a quadratic form in the polynomial ring k[x1, . . . , xn] (semiprime ≥1). Let R be a Cohen-Macaulay standard graded k-algebra satisfying regR=1. Then R has minimal multiplicity and glldR=dimR. In particular, if f is a non-zero quadratic form in k[x₁, . . . , xₙ], then glld(k[x]/(f))=n−1. Proof. We may assume k is infinite; see Lemma 2.2. Given Proposition 6.3, it remains to show glldR≤dimR. Note that glldR≤glld(R/Rx)+1 if x∈R₁ is R-regular; this is by Theorem 2.4. We may thus reduce to the case when dimR=0. Note that the regularity of R and its multiplicity remain unchanged. Let R=P/I where P is a polynomial ring and I⊆m², where m=P_{>1}. Since I has 2-linear resolution and pd_{P} R=n, there is an equality of Hilbert series H_{R}(Z)(1−z)ⁿ=1−β₁z²+ [symbol] +(−1)ⁿβₙzⁿ⁺¹, where βᵢ≠0 is the ith Betti number of R over P. Therefore by comparing degrees of the polynomials, Rᵢ=0 for i≥2, so I=m². Then every R-module is Koszul, so glldR=0. The last statement holds as k[x]/(f) is Cohen-Macaulay of dimension n−1. Theorem 6.5. If R is defined by monomial relations, then glldR≥dimR. Proof. Suppose R=P/I where P=k[x₁, . . . , xₙ] is a polynomial ring and I is a monomial ideal; we may assume it is quadratic, for else Id_{R} k is infinite. Reordering the variables if necessary we may assume that in the primary decomposition of I the component of minimal height is (x²₁, . . . , x²_{q}, x_{q+1}, . . . , xₛ), where s=n−dimR. We claim that Id_{R}(R/J)=dimR where J=(x₁, . . . , xₛ, x²ₛ₊₁, . . . , x²ₙ). Indeed, set S=k[xₛ₊₁, . . . , xₙ] and let R→S be the canonical surjection. Note that the composition of the inclusion S→R with the map R→S is the identity on S. Moreover Id_{R} S=0, since R is strongly Koszul. Therefore, noting that the action of R on R/J factors through S, from Proposition 2.3 one gets the first equality below: Id_{R}(R/J)=Id_{S}(R/J)=Id_{S}(S/(x²ₛ₊₁, . . . , x²ₙ))=n−s. The last equality is a direct computation; one can get it from Lemma 6.1. By Proposition 6.3 this is the case for Cohen-Macaulay rings; more generally, it holds when R has a maximal Cohen-Macaulay module, and in particular when dimR≤2”. Absolutely Koszul Algebras and The Backlin-Roos Property by Aldo Conca, Srikanth B. Iyengar, Hop D. Nguyen, and Tim Römer. To obtain lower bounds, we construct the affine function ϕ(x₁,x₂)=a₁x₁+a₂x₂+a₃ that coincides with f at the vertices of M₀. Solving the corresponding system of linear equations a₃ yields ϕ(x₁,x₂). Because of the concavity of f(x₁,x₂), ϕ(x₁,x₂) is underestimating f(x₁,x₂), i.e., we have ϕ(x₁,x₂)≤f(x₁,x₂) ∀(x₁,x₂)ϵM₀. A lower bound β₀ can be found by solving the convex optimization problem (with linear objective function) min ϕ(x₁,x₂), s.t. (x₁,x₂)ϵM₀∩D=D. We obtain β₀ attained at x⁰=(0,0). We construct lower bounds β(M_{1,1}), and β(M_{1,2}) by minimizing over M_{1,1}∩D the affine function ϕ_{1,1} that coincides with f at the vertices of M_{1,1} and by minimizing over M_{1,2}∩D the affine function ϕ_{1,2} that coincides with f at the vertices of M_{1,2}, respectively. One obtains ϕ_{1,1} (x₁,X₂)=ϕ_{1,2}=β(M_{1,1})=(attained at (0,10)), and beta(M_{1,2})=(attained at (0,0)), which implies β₁=number n. The sets of feasible points in M_{1,1}, M_{1,2} which are known until now are S_{M1,1}={(0,0)(0,10)(20,20), S_{M1,2}={(0,0),(20,20)}. Hence α(M_{1,1})=α(M_{1,2})=f(0,0)=−500, α₁=−500 and x¹=(0,0). x²=(0,0) is the optimal solution. Calculating the lower bounds would have been simply by minimizing f over the vertex set of the corresponding partition element M. Whenever a lower bound β(M) yields consistency, or strong consistency, then any lower bound β(M) satisfying β(M)≥>β(M) for all partition sets M will, of course, also provide consistency, or strong consistency; and β(M_{q})=β(M_{q}).) The assumption concerning the deletion rule then implies that x⁻∈D, and hence we have strong consistency. Keeping the partitioning unchanged, we then would have obtained β₀, β₁, deletion of M_{1,2}, deletion of M_{2,2}, (since M_{2,2}∩D⊂M_{1,2}∩D), β₂=α₂. [symbol] (x,y)=(I₁(x,y), (x,y)∈M₁ I₂(x,y), (x,y)∈M₂. If ϕ were not the convex envelope of xy over M, there would be a third affine function I₃(x,y) underestimating xy over M such that ϕ(x⁻,y⁻)<I₃(x⁻,y⁻) (x⁻,y⁻)∈M. Suppose that (x⁻,y⁻)∈M₁. Then (x⁻,y⁻) is a unique convex combination of the three extreme points v¹, v², v³ of M₁. Hence, for every affine function I one has I(x⁻,y⁻)=Σ³ᵢ₌₁λᵢI(vⁱ) with uniquely determined λᵢ≥0 (i=1, . . . , 3), Σ³ᵢ₌₁ λᵢ=1. But since ϕ agrees with xy at these extreme points and I3 underestimates xy there, by (97) we must have ϕ(x⁻,y⁻)=Σ³ᵢ₌₁ λᵢI₃(vⁱ), contradicting (98). A similar argument holds when (x⁻,y⁻)∈M₂. Algorithm X.6 Step 0 (Initialization): Set M₀={M}, where M=R, and determine ϕM(x,y)=f(x)+ϕ_{M}(x,y)+g(y) according to Proposition X.19 (i) and Proposition X.20. We solve the convex minimization problem (PM) minimize ϕM(x,y)=s.t. (x,y)∈M∩K to determine β₀=min ϕM(M∩K). Let S_{M} be the finite set of iteration points in M∩K obtained while solving (P_{M}). We set α₀=min F(S_{M}) and (x⁰,y⁰)∈argmin F(S_{M}). If α₀−β₀=0 (≤ε), then stop. (x₀,y₀) is an (ε−)optimal solution. ϕ(x,y)={I₁(x,y), (x,y)∈M₁ I₂(x,y), (x,y)∈M₂. If ϕ were not the convex envelope of xy over M, there would be a third affine function I₃(x,y); or 4(x,y), (x,y) e M1−(97) t;(x,y) e M2 g(x,y): |If p were not the convex envelope of xy over M, there would be a third affine function 4(x,y) underestimating xy over M such that *Gy)<4(ky) for some (ky) e M. (98) We suppose that (x,y) e M1. Global Optimization Deterministic Approaches Authors: Horst, Reiner, Tuy, Hoang May 1992. Underestimating xy over M such that an underestimation is derived by means of an inner approximation of the hypograph of the function f(x). An alternative interpretation is based on the representation of the function f(x) as the pointwise infimum of a collection of affine functions. In mathematics, the hypograph, or subgraph of a function f: Rⁿ→R is the set of points lying on, or below its graph: hypf={(x, μ): x∈Rⁿ, μ∈R, μ≤f(x)⊆Rⁿ⁺¹ and the strict hypograph of the function is: hyp_{S}f={(x, μ): x∈Rⁿ, μ∈R, μ<f(x)}⊆Rⁿ⁺¹. The set is empty if f≡−∞. The domain (rather than the co-domain) of the function is not particularly important for this definition; it can be an arbitrary set^{[1]} instead of Rⁿ. Similarly, the set of points on, or above the function's graph is its epigraph. A function is concave if and only if its hypograph is a convex set. The hypograph of a real affine function g: Rⁿ→R is a halfspace in Rⁿ⁺¹. A function is upper semi-continuous if and only if its hypograph is closed. The above underestimation algorithm was derived by means of an inner approximation of the hypograph of the function f(x). An alternative interpretation is based on the representation of the function f(x) as the pointwise infimum of a collection of affine functions. (We refer to). “Whose period is the smallest possible compatible with these conditions. In particular, all the outer symmetries Θ∈AutR of R, ∧²=1, Θ/G InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We apply Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We calculate Lis( [symbol] ) function ϕ( [symbol] ,S)ϕ, and Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q. is an arbitrary module homomorphism, now we have a module homomorphism [symbol] :Y→Q such that [symbol] f=g, the following diagram commutes: [symbol] *0→X^{g}↓_{Q}^{f} [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4.1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g-g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F⁻)≥1−ε/2. Now express each set A∈V^{m-1}₀T⁻ⁱ P/F⁻ as A₁∪A₂, A₁∩A₂=ϕ, μ(A₁)=μ(A₂), and put (m/2)−1 (m/2)−1 FA=[T2iA1∪[T2i−1A2 i=0 i=1. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of ∪^{m-1}ᵢ₌₀ Tⁱ F⁻, TⁱF⁻, 0≤i≤m−1. Thus if m is large enough, μ(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heterodinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G:Cob_{G}→pLagrR defined by Mag(g,ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹′²′³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0.5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F) E H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q. and I is the identity matrix M^{→} of two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 H is an HNN group whose base is a tree product of vertices cKc⁻¹∩H where c ranges over a double coset representative system for G mod(H, K). Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take: α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0, H is an HNN group whose base is a tree product of vertices cKc⁻¹∩H where c ranges over a double coset representative system for G mod(H, K). Hamiltonian is assumed to be in Birkhoff's normal form up to terms of degree 2n χ for the function of transport properties generating a series interval A step path in S is a path y: [A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=δ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q. are exactly solutions of a matrix equation where Q^{T} is the transpose of Q and I is the identity matrix M^{→} of two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 H is an HNN group whose base is a tree product of vertices cKc⁻¹∩H where c ranges over a double coset representative system for G mod(H, K). Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take: α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0, H is an HNN group whose base is a tree product of vertices cKc⁻¹∩H where c ranges over a double coset representative system for G mod(H, K). Hamiltonian is assumed to be in Birkhoff's normal form up to terms of degree 2n χ for the function of transport properties generating a series interval A step path in S is a path y: [A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q E Q(R) there exist elements i₁, . . . , iₙ∈R and ψ₁, . . . , ψₙ∈F, such that qiₖ, iₖq∈R, and Σk iₖψₕ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q G Q(R) there exist elements i₁, . . . , iₙ∈R and ψ₁, . . . , ψₙ∈F, such that qiₖ, iₖq∈R, and Σk iₖiψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P); and Let 2. The Acyclicity of the Koszul complex Rohlin's Theorem (strong form). Semiprime rings.

Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, e∘r=id. Thus for any finite projective module E over J^{˜} the triple (E,(r∘e)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q G C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{E1} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j_{*}: K_{D}(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{Y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure A on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with λ∈|0,1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Let A_{Θ} be the corresponding universal C*-algebra. For every n∈Z^{d} we have a corresponding indicator function which we will denote by Uₙ which satisfies UₘUₙ=C_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀(∫αₜ(a))=τ₀ τ(a)id_{AΘ}e)=τ(a) and the conclusion follows. For a left R-module M, the so-called “character module” M+=Hom_{Z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a 6-small kernel. A δ-cover is said to be a flat δ-cover in case F is a flat module. We study rings over which every module has a flat δ-cover and call them right generalized 6-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoλ=ψ, and 2) if μ is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=A, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] : mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W×K^{P}; Zₚ)→H* (W×K; Zₚ the map induced by the diagonal d: K→K^{P}. 4. 1 Lemma. Let τ: H*(W⊗K^{P}; Zₚ)→H*_{π}: (W⊗K^{P}; Zₚ) denote the transfer. Then d*τ=o. Proof. We have a commutative diagram [1] H*(W⊗K^{P}; Zₚ) τ→H*_{π}(W⊗K^{P}; Zₚ); [2] H*_{π}(W⊗K; Zₚ)i*→H*(W⊗K; Z_{P}) τ→H*_{π}(W⊗K; Zₚ). [3] H*(W⊗K^{P}; Zₚ) d*→H*(W⊗K; Z_{P}) [4] H*_{π}(W⊗K^{P}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{P}; Zₚ) then d*P is a homomorphism. Proof. Let u and v be q-cocycles on K. Then P(v+u)−Pu−Pv is given by the chain map W⊗K^{P ε⊗1}→K^{P (u+v)p-up-vP}→Z^{p}. According to 4.1, we need only show that this cocycle is in the image of the transfer. It will be sufficient to show that (u+v)^{p}−u^{p}−v^{p} is in the image of a cocycle under τ: C*(K^{p}; Zₚ)→C*_{π}(K^{p}; Zₚ) since ε⊗1 is an equivariant map. Now (u+v)^{P}−u^{p}−v^{p} Is the sum of all monomials which contain k factors u and (p−k) factors v, where 1≤k≤p−1. Now π permutes such factors freely. Let us choose a basis consisting of monomials whose permutations under π give each monomial exactly once. Let z be the sum of the monomials in the basis. Then τz=(u+v)^{P}−u^{p}−v^{p}. Also z is a cocycle in K^{P} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Z_{P}). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀ DⱼU×D_{k-J}v. Construction of Powers Proof. The map of′ geometric triples ∧, used in 2.6, takes the form ∧: (π, Z_{P}, (K×L)^{p})→(π×π, Z_{P},K^{P}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×Dⱼu×Dₗv. Also d* P(U×v)=Σₖ wₖ× Dₖ (U×v). The lemma follows from 2.6 and V 5.2”. The power series centered at c with coefficients aₙ is the series ^{∞}Zₙ₌₀aₙ(x−c)ⁿ. Power series centered at 0: ^{∞}Zₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Zₙ₌₀(−1)ⁿx²ⁿ=x−x²+x⁴−x⁸+ . . . ; and power series centered at 1: ^{∞}Zₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 closed-chain equivariant translation-banded A class of C*-algebras and topological Markov chains power series expansion. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n-m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, Sᵢ=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)) The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞} (G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊗(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊗E₂ with E₂⊗E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, Sᵢ=1−DQ one gets e=[1−S²₁(S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j_{*}: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Linder this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,Γ⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,Γ⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀×∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{Θ}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate [symbol] -plane tangent to S at P and we then define the second fundamental form in the same way. Shape object plane let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧ (β∧μ), and bilinear (c₁α₁+c₂α₂)∧β=c₁(α₁∧β)+c₂ (α₂∧β) α∧(c₁β₁+c₂β₂)=c₁(α∧β₁)+c₂(α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ·0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,^{∞}) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and η(U^{m-1}ᵢ₌₀Tⁱ F⁻)≥1−ε/2. Now express each set A∈V^{m-1}₀ T⁻ⁱ P/F⁻ as A₁ ∪A₂, A₁∩A₂=ϕ, μ(A₁)=μ(A₂), and put (m/2)−1 (m/2)−1 FA=[T2iA1∪[T2i−1A2 i=0 i=1. Clearly, F_{A} and TF₄ are disjoint. We now let F be the union of the sets F_{A}, A∈V^{m-1}₀ T⁻ⁱ P/F⁻. It follows that F∩TF=ϕ, and that F∪TF is all of U^{m-1}ᵢ₌₀ Tⁱ F⁻, TⁱF⁻, 0≤i≤m−1. Thus if m is large enough, μ(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},∈)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}: F_{g±}→∂M∈M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Micas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A·s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R) is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γ^{N} on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₁∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }4ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }k=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕ^{k}'s: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=x₀<τ₁<Σ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(⊗)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, e a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves p. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group T is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ: K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F ₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=x₀x₁x₂ . . . and t(x)=x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group f is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x−₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U).

Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q. are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 19871. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group T is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]ϕₖ=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], T∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group f is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left [symbol] modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q. are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m )}(U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of G^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group f is chosen discrete and cocompact in such a way that V is a homology 3-sphere is our Euclidean centered group for calibration and control R³ subspace, the operator PF\hat{ }, that obeys the following rules: PF\hat{ }ϕₖ=P<K for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]<J)ₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role [symbol] of Z/2 in the notation of homology groups;” two manifolds X₀ G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π}{1} Two columns of equal width; and {2} Two columns of equal width:=four {4×4 columns}. E a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P). We find the generating function F(x):=f(x) for x∈[0,1] and F(x):=0 for x∈[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively D 4== . . . =^{D}_{2N-2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(l)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of U; or the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of U called the n-isotypic component of U we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Z_{P}). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Z_{P},K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖwₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Z_{n=0b 1}/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and power series centered at 1: ^{∞}Σₙ₋₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the ⊗^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ₀(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{ε1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T·f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘e)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀(C_{c}^{∞}(G)) be the index associated to (E₁,E₂,D) by Proposition 9.3 Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the T-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ)∀×∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with A∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Let A_{Θ} be the corresponding universal C*-algebra. For every n∈Z^{d} we have a corresponding indicator function which we will denote by Uₙ which satisfies UₘUₙ=C_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀(∫αₜ(a))=τ₀τ(a)id_{AΘ})=τ(a) and the conclusion follows. For a left R-module M, the so-called “character module” M+=Hom_{Z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a δ-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoλ=ψ, and 2) if μ is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column) Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊ such that τ∘Θ=λτ for every trace ion N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] : mod 0=1⇒p₀=0, [symbol] =1; p₀=0⇒y=1. Whereas the case mod Θ=1 reduces to the case treated above, for every λ=16 it follows from [141] and part a) of the above theorem that all of the automorphisms Θ∈AutR_{0,1} with mod Θ=A are conjugate (not just outer conjugate). This is a remarkable phenomenon; in effect, for λ an integer, one can describe the nature of Θ precisely as a shift on an infinite tensor product of A×A matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²+(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H*(W×K^{P}; Zₚ)→H*(W×K; Zₚ the map induced by the diagonal d: K→K^{P}. 4.1 Lemma. Let τ: H*(W⊗K^{P}; Zₚ)→H*_{π}: (W⊗K^{P}; Zₚ) denote the transfer. Then d*τ=o. Proof. We have a commutative diagram [1] H*(W⊗K^{P}; Zₚ) τ→H*_{π}(W⊗K^{P}; Zₚ); [2] H*_{π}(W⊗K; Zₚ)i*→H*(W⊗K; Z_{P}) τ→H*_{π}(W⊗K; Zₚ). [3] H*(W⊗K^{P}; Zₚ) d*→H*(W⊗K; Zₚ) [4] H*_{π}(W⊗K^{P}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{P}; Zₚ) then d*P is a homomorphism. Proof. Let u and v be q-cocycles on K. Then P(v+u)−Pu−Pv is given by the chain map W⊗K^{P ε⊗1}→K^{P (u+v)p-uP-vP}→Z^{p}. According to 4.1, we need only show that this cocycle is in the image of the transfer. It will be sufficient to show that (u+v)^{P}−u^{p}−v^{p} is in the image of a cocycle under τ: C*(K^{p}; Zₚ)→C*_{π}(K^{p}; Zₚ) since ε⊗1 is an equivariant map. Now (u+v)^{P}−u^{p}−v^{p} is the sum of all monomials which contain k factors u and (p−k) factors v, where 1≤k≤p−1. Now n permutes such factors freely. Let us choose a basis consisting of monomials whose permutations under π give each monomial exactly once. Let z be the sum of the monomials in the basis. Then τz=(u+v)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{s}(L;Z_{P}). If p>2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)} wⱼ×wᵢ×Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, Bo(Ft) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G ) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D₀∈A of the same class, i.e. D⁰∈D+J, which is invertible in A.

The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ∀(a,λ)∈J. ^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a G J, λ∈C. Proposition 2. Given J⊂A as above, the map α_{*}∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂; E₃,h²)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j_{*}: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D) G K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane singletons have { points { and the entire space Rⁿ is our solution set of an arbitrary possibly, infinite system ≤b_{α}, α∈A α^{T}_{α}x≤bₐ, α∈A of linear inequalities with n unknowns×{the set M={x∈Rⁿ|α^{T}_{α}x<b_{α}, α∈A} is convex, and their incidence of Euclidean space are shared with affine geometry, (vector field on the generic leaf of a foliation) Hₖ(V,R), we get a scalar X(F,∧)=he(F),[C]i∈R nondegenerate 2-form structure in potential theory complex analysis proves invaluable mathematical physics expressions an infinite potential finite-dimensional n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂α₂)∧β=c₁(α₁∧β)+c₂(α₂∧β) α∧(c₁β₁+c₂β₂)=c₁(α∧β₂)+c₂(α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , aₖ have degree one, then they are linearly independent iff α₁∧ . . . ∧aₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ/ⁿ∈(0,∞) is called the connective constant and denoted by μ. Madras [J. Statist. Rhys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(U^{m-1}ᵢ₌₀ Tⁱ F⁻)≥1−ε/2. Now express each set A∈V^{m-1}₀T⁻ⁱ P/F⁻ as A₁∪A₂, A₁∩A₂=ϕ, μ(A₁)=μ(A₂), and put (m/2)−1 (m/2)−1 FA=[T2iA1∪[T2i−1A2 i=0 i=1. Clearly, F_{A} and TF_{A} are disjoint. We now let F be the union of the sets F_{A}, A∈V^{m-1}₀ T⁻ⁱ P/F⁻. It follows that F∩TF=ϕ, and that F∪TF is all of U^{m-1}ᵢ₌₀ Tⁱ F⁻, TⁱF⁻, 0≤i<m−1. Thus if m is large enough, p(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ, −m≤i≤n) where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,∈) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G:Cob_{G}→pLagrR defined by Mag(g,ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x G s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0.β The Ruelle-Sullivan cycle and the Euler number of a measured foliation. By a measured foliation we mean a foliation (V,F) equipped with a transverse measure A. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure p determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], T∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 19871. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖcϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since δT is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is go and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}=(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G(8>R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b]such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and E F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/G InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*,} the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves p. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F ₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x−₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by % up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group E is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x−₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], T∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left [symbol] modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate 2-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₁∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i€R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(m,n)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] )b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<T₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], T G R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σk cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of w₈ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾, ={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅕(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=T_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) A: H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gi:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object [symbol] functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0,1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π}{1} Two columns of equal width; and {2} Two columns of equal width:=four {4×4 columns}. E a positive number, and P a partition, then there is a set F such that F, TF, . . . , Tⁿ⁻¹F is a disjoint sequence, p(Uⁿ⁻¹ᵢ₌₀Tⁱ F)≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(\ddot{X}T h) where X̅Th/2 and X̅Th are the Euler approximation at time T for the step size h/2 and h respectively D 4== . . . =^{D}_{2N-2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c e R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(l)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of U; or the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of U called the n-isotypic component of U we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability p₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Z_{P}). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀ DⱼU×D_{k-J}v. Construction of Powers Proof. The map of′ geometric triples ∧, used in 2.6, takes the form ∧: (π, Zₚ, (K×L)^{P})→(π×π, Z_{P},K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖwₖ×Dₖ (U×v). The lemma follows from 2.6 and V 5.2”. The power series centered at c with coefficients aₙ is the series ^{∞}Zₙ=aₙ(x−c)ⁿ. Power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=ϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q. for D modulo the algebra C_{c}^{∞}(G,Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×p the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞} (G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{ε1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j_{*}: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D) G K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ)∀×∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{*}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where f is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism (f) given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that T is a faithful α-invariant trace. In fact it is the unique such trace. Proof. If τ₀ is any other such trace, then τ₀(a)id_{AΘ}=∫αₜ(τ₀(a))dt=τ₀(∫αₜ(a))=τ₀τ(a)id_{AΘ})=τ(a) and the conclusion follows. For a left R-module M, the so-called “character module” M+=Hom_{Z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a δ-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoλ=ψ, and 2) if μ is an endomorphism of C such that ϕ|μ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] : mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for A an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²+(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H*(W×K^{p}; Zₚ)→H* (W×K; Zₚ the map induced by the diagonal d: K→K^{p}. 4.1 Lemma. Let τ: H*(W⊗K^{P}; Zₚ)→H*_{π}: (W⊗K^{P}; Zₚ) denote the transfer. Then d*τ=o. Proof. We have a commutative diagram [1] H*(W⊗K^{P}; Zₚ) τ→H*_{π}(W⊗K^{P}; Zₚ); [2] H*_{π}(W⊗K; Zₚ)i*→H*(W⊗K; Zₚ) τ→H*_{π}(W⊗K; Zₚ). [3] H*(W⊗K^{P}; Z_{P}) d*→H*(W⊗K; Zₚ) [4] H*_{π}(W⊗K^{P}; Zₚ) d*→H*_{π}(W⊗K; Zₚ). § 4. The Transfer. Since W is acyclic and H⁰ₙ(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{P}; Zₚ) then d*P is a homomorphism. Proof. Let u and v be q-cocycles on K. Then P(v+u)−Pu−Pv is given by the chain map W⊗K^{P ε⊗1}→K^{P (u+v)p-uP-vP}→Z^{p}. According to 4.1, we need only show that this cocycle is in the image of the transfer. It will be sufficient to show that (u+v)^{p}−u^{P}−v^{P} is in the image of a cocycle under τ: C*(K^{p}; Zₚ)→C*_{π}(K^{p}; Zₚ) since ε⊗1 is an equivariant map. Now (u+v)^{P}−u^{p}−v^{p} Is the sum of all monomials which contain k factors u and (p−k) factors v, where 1≤k≤p−1. Now n permutes such factors freely.

Let us choose a basis consisting of monomials whose permutations under n give each monomial exactly once. Let z be the sum of the monomials in the basis. Then τz=(u+v)^{P}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Micas, A. (1991) which involves moduli spaces of flat U(l)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Z_{P}). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼ wₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀ 1/n→xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod O=A, there exists a X×A matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map a_{*}∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G,Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G,Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ ∀(a,λ)∈J. ^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T:E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊗E₂ with E₂⊕E₁ such that j(T)=[h 0 0 hΓ⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₂)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.(3 Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j_{*}: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D) 6 K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Linder this isomorphism our analytic index, Indₐ(D) G K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ₀∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the (Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*;τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane complete metric space property, and number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k≤d−1, is there a d-polytope that can not be realized with all its k-faces tangent to a sphere? Leaving aside the trivial cases of d≤2, he constructed non-k-scribable examples for all the cases except for d=3 and k=1, i.e. 3-polytopes that are not edge-scribable. Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. (N+1)-dimensional n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If a and (3 are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁ ∧ . . . ∧eᵢₚ)∧(eⱼ₁ ∧ . . . ∧e_{jq})=eᵢ₁ ∧ . . . ∧eᵢₚ ∧eⱼ₁ ∧ . . . ∧e_{jq} when the indices i₁, . . . , iₚ, j₁, . . . , j_{q}, are distinct, and the product is zero otherwise. While the formula α∧α=0 holds when a has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧aₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Rhys. 78 (1995) no. 3-4, 681-699] has shown that pₙμ⁻ⁿ≤Cn^{1/2} in dimension d=2. Here we establish that pₙμ⁻ⁿ≤n^{-3/2+o(1)} for a set of even n of full density when d=2 we have that if Θ′=a∧+b/c∧+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=B₀^{→} and B^{→}ₑ semigroup, a semidirect product given a Lie group G is, in a trivial way, a groupoid with G⁽⁰⁾=(e) the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(U^{m-1}ᵢ₌₀ Tⁱ F⁻)≥1−ε/2. Now express each set A∈V^{m-1}₀ T⁻ⁱ P/F⁻ as A₁∪A₂, A₁∩A₂=ϕ, μ(A₁)=μ(A₂), and put (m/2)−1 (m/2)−1 FA=[T2iA1∪[T2i−1A2 i=0 i=1. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of U^{m-1}ᵢ₌₀ Tⁱ F⁻, TⁱF⁻, 0≤i≤m−1. Thus if m is large enough, μ(F∪TF) will be at least 1−ε. This establishes that d(P/F)=d(P/F∪TF). Shifts and partitions of a Bernoulli shift we begin with n=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure p defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob₆ to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(l)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→plagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0,1] which identifies any pairs (x,ε) and (y,ε) provided ε>0.5.β The Ruelle-Sullivan cycle and the Euler number of a measured foliation. By a measured foliation we mean a foliation (V,F) equipped with a transverse measure A. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where I is the completion of E with respect to p, will be called the product space with product measure p determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=i_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)} b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left [symbol] modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of [symbol] ₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along S₁ as explained in Proposition 3.1. The result is regular and Z/2-oriented.

The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=f. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ }, that obeys the following rules: PF\hat{ }ϕₖ=P<K for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivia I transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and G F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(Uⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves p. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group T is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x G X, we construct the point (s(x),t(x)) in the unit square (using binary digits) s(x)=.x₀x₁x₂ . . . and t(x)=,x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (ii, i₂, • • • ,iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(τx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the Vibration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope [ [symbol] ]. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x−₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Z onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Up to a shift of parity, the geometric group K*,_{T}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where f is a discrete cocompact subgroup of SL(2,R), by the left action of the subgroup of lower triangular matrices of the form [1 0 t 1], T∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and O(c) the associated cyclic cohomology class in the (b,B) bicomplex of A=C_{c}^{∞}(G⊗R);” “Theorem 12 reduces to Theorem 4.7 in the case of discrete groups G=f. Let c be a group cocycle, c∈Z^{2q}(Γ,C). Then by Section 2 [symbol] ) one has (3.36) [symbol] (c)=τ_{c}. But the cyclic cocycle τ_{C} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) A: H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q. and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod(H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ . . . xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and O(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) A: H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group f is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖ\hat{ }ₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wk concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{C}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V ) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where [is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e x a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B, δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ* ([114]) (3.38) λ:H*(A)→H* _{τ}(BG). In fact, we shall only describe the composition of this map with the pull-back H* _{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41)Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∂ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ¹)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖG\hat{ }ϕₖ=(PF)ₖgₖϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]=0 for any function f. However, the eigenfunctions form a basis, so that any other function in the subvector ample line O(1) space can be written as a linear combination of ϕₖ's: f=τₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪Sᵢ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, =r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate a-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar λ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ* ([114]) (3.38) λ:H*(A)→H* _{τ}(BG). In fact, we shall only describe the composition of this map with the pull-back H*_{τ}(BG)→H*_{τ}(V).

When one varies V without varying V/F one gets the desired information. The idea of the construction of (3.39) λᵥ:H*(A)→H^{*}_{τ}(V) is to exploit the local triviality of the foliation as follows: For each open set U⊂V one lets A(U) be the algebra associated by the functor C_{c}^{∞}(.; Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41)Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=δ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{=}]0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, gᵢ) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪Sᵢ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the θ^{j}(K) commute pairwise (S₀, g₀) and (S₁, gᵢ), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the θ^{j}(K) commute pairwise, the θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [Tⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π}{1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀Tⁱ F)≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ[either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively D 4==⋅ . . . =^{D}_{2N-2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x).

Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D. ; Nicas, A. (1991) which involves moduli spaces of flat U(1)-connections A module is called a uniform module if every two nonzero submodules have nonzero intersection at the initial phase of the motion 1n+1, the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of ∪; or the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n+0,1,2 . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of ∪ we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p(p-1)rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples A, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=(−1)=Σ_{j,l}(−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖwₖ×Dₖ(U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ∞Σₙ₌₀(−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ε>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}, Then the exact sequence 0→J→J^{˜}→^{ε}C→0 has a natural section r: C→J^{˜}, ε∘=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}A, α(a,λ)=a+Δ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}0.1). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ε>0 it is possible to find a period wᵥ, p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{cc}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f* T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles E; into account. α Construction of Ind(D)∈K₀(J). Let J be a non-unital algebra over C, and define K₀(J) as the kernel of the map K₀(J^{˜})→^{ε}*K_{D}(C)=Z where J^{˜} is the algebra obtained by adjoining a unit to J, that is, J^{˜}={(a,λ);a∈J, λ∈C},and ε(a,λ)=λ∀(a,λ)∈J^{˜}. (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j^{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α* ∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD 0]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.13 Significance of the C*-algebra index. By the construction of C*(V,F) as a completion of the algebra C_{c}^{∞}(G), one has a natural homomorphism C_{c}^{∞}(G) F) and we shall denote by Indₐ(D) the image j^{*}Ind(D). In general we do not expect the map j*: K₀(C_{c}^{∞}(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D) E K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{ρ}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D [symbol] ) [symbol] _{∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D [symbol] ) [symbol] _{∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰),F⁰ of a not necessarily compact manifold, and a not necessarily compact submanifold N of V⁰ which is everywhere transverse to F⁰, then Lemma 8.2 provides us with an easy map from K(N)=K(C₀(N)) to K(C*(V)⁰),F⁰. Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥}of i*(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i*(Fₓ))^{⊥}, and check that on a small enough neighborhood N of the 0-section in ν the map ϕ: N→V⁰ is transverse to F⁰. It is enough to check this transversality on the 0-section V∈ν where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let ν=(i*(F))^{⊥} be the normal bundle of i_{*}F in Rⁿ, and let N˜ν be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V ) is equal by Lemma 7 to Indₐ=Indₜ. 2) The Thom isomorphism (Appendix C) ϕ:K*(V )=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V ) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert Huang transform (HHT). We find the familiar geometric series from calculus; alternately, this function has an infinite expansion. The coordinate system mapping the coordinate [symbol] -plane tangent to S at P and we then define the second fundamental form in the same way. Shape object plane let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀(∫αₜ(a))=τ₀τ(a)id_{AΘ})=τ(a) and the conclusion follows. For a left R-module M, the so-called “character module” M+=Hom_{z}(M,Q/Z) is a right R-module that exhibits an interesting duality, not between injective modules and projective modules, but between injective modules and flat modules (Enochs &Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a δ-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoΔ=ψ, and 2) if μ is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1] R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type II_{∞}, one writes mod Θ for the unique λ∈R*₊ such that ξ∘Θ=λτ for every trace τ on N. For N=R_{0,1}, InnR_{0,1}=Kernel of mod={Θ; Mod Θ=1}. Moreover, ΘτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] : mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H*(W×K^{p}; Zₚ)→H* (W×K; Zₚ the map induced by the diagonal d: K→K^{p}. 4. 1 Lemma. Let τ: H*(W⊗K^{p}; Zₚ)→H*_{π}(W⊗K^{p}; Zₚ) denote the transfer. Then d*τ=o. Proof. We have a commutative diagram [1] H*(W⊗K^{p}; Zₚ) τ→H*_{π}(W⊗K^{p}; Zₚ); [2] H*_{π}(W⊗K; Zₚ)i*→H*(W⊗K; Zₚ) τ→H*_{π}(W⊗K; Zₚ). [3] H*(W⊗K^{p}; Zₚ) d*→H*(W⊗K; Zₚ) [4] H*_{π}(W⊗K^{p}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{p}; Zₚ) then d*P is a homomorphism. Proof. Let u and v be q-cocycles on K. Then P(v+u)−Pu−Pv is given by the chain map W⊗K^{p ε⊗1}→K^{p (u+v)p-uP-vP}→Z^{p}. According to 4.1, we need only show that this cocycle is in the image of the transfer. It will be sufficient to show that (u+v)^{p}−u^{p}−v^{p} is in the image of a cocycle under τ: C*(K^{p}; Zₚ)→C*_{π}(K^{p}; Zₚ) since ε⊗1 is an equivariant map. Now (u+v)^{p}−u^{p}−v^{p} Is the sum of all monomials which contain k factors u and (p−k) factors v, where 1≤k≤p−1. Now a permutes such factors freely. Let us choose a basis consisting of monomials whose permutations under π give each monomial exactly once. Let z be the sum of the monomials in the basis. Then τz=(U+V)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D. ; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀DⱼU×D_{k-J}v. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)}wⱼ×wₗ×Dⱼu×Dᵢv. Applying (d₁)* to each side of this equation, and using the commutative diagram, we obtain d*∧*(Pu×Pv)=Σ_{j,l}(−1)^{l(pr-j)}wⱼ wₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, =0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=×, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and M n(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. a Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9. β Significance of the C*-algebra index. By the construction of C*(V,F) as a completion of the algebra C_{c}^{∞}(G), one has a natural homomorphism C_{c}^{∞}(G)→^{j}C*(V,F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D [symbol] ) [symbol] _{∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D [symbol] ) [symbol] _{∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥} of i*(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) {x∈V, ξ∈vₓ=(i*(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i*(F))^{⊥} be the normal bundle of i_{*}F in Rⁿ, and let N˜ν be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),ρ∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure A on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V ) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{A}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert Huang transform (HHT). We find the familiar geometric series from calculus; alternately, this function has an infinite expansion. The coordinate system mapping the coordinate [symbol] -plane tangent to S at P and we then define the second fundamental form in the same way. Shape object hyperplane complete metric space property, and number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k≤d−1, is there a d-polytope that can not be realized with all its k-faces tangent to a sphere? Leaving aside the trivial cases of d≤2, he constructed non-k-scribable examples for all the cases except for d=3 and k=1, i.e. 3-polytopes that are not edge-scribable.

Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2 . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i˜ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ΔiB+½σ(xₜᵢ⁽ⁿ⁾₋₁)σ⁰(xₜᵢ⁽ⁿ⁾₋₁)[(ΔiB)²−Δᵢ], with x₀^{(n )}=x₀ the equidistant Milstein approximation converges strongly with order (1.0) approximations of functionals can be obtained with lower order weak schemes by extrapolation methods representations correspond to the little group integral submultiples of Lᵥ, can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. This can be exploited to describe explicitly the factor in our affine geometric construction. Continuity equation in physics is an equation that describes the transport of our quantity simple and powerful order applied as our conserved quantity, and is continued apply to our extensive quantity any continuity equation can be expressed in an ‘integral form’ (in terms of a flux integral), which applies to any finite region, and in a ‘differential form’ (in terms of the divergence operator) which applies at a having differentials the flow of a gas through a domain in which flow properties only change in one direction, which we will call X an equilibrium point more explicitly, cycles and cocycles let e(F)∈H^{k}(V,R) be the Euler class of the oriented bundle F on V using the pairing which makes H^{k}(V,R) the dual of the number in base point k-face element plane the fundamental group we consider the category of pointed topological spaces, i.e. topological spaces with distinguished points indecomposable injective modules are the injective hulls of the modules R/p for p a prime ideal of the ring R. Moreover, the injective hull M of R/p has an increasing filtration by modules Mₙ given by the annihilators of the ideals pⁿ, and Mₙ₊₁/Mₙ is isomorphic as finite-dimensional vector space over the quotient field k(p) of R/p to Hom_{R/p}(pⁿ/pⁿ⁺¹, k(p)) finite-dimensional vector space of nondegenerate 2-form structure in potential theory complex analysis proves invaluable mathematical physics expressions an infinite potential n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let G be a connected Lie group and let A be a strongly continuous action of G on B contain 1. We show that it is sufficient to treat the case V=K. The Koszul complex associated to the operad Trias is the differential functor Tridend∘Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f nearby level surface point structure, or solid domain occupies surface point structure “there is an exponential map Mₙ(R)≅glₙ(R) [symbol] X→exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(τX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by Dₓ(b). The collection of all b such that all iterated derivatives always exist is a linear subspace B^{∞} of B, and on this subspace we have (D_{X}D_{Y}−D_{Y}D_{X})(b)=D_{[X,Y]}(b) transfer the ‘twist’ integral rotating reciprocating radial compartment nearby level surface point structure, or solid domain occupies surface point structure *-structure. Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀(∫αₜ(a))=τ₀τ(a)id_{AΘ})=τ(a) and the conclusion follows. Proposition 7.2. A_{Θ} has no proper 2-sided α-invariant ideals. Proof. Let J be such an ideal. Then there exists d∈J with d≥0 and d≠0. Furthermore, αₜ(d)∈J for all t, hence E(d)=∫αₜ(d) dt∈J, so id_{AΘ}∈J and J is not proper. Theorem 7.3. The representation π of A_{Θ} on I²(Z^{d}) is faithful, so C*ᵣ(Z^{d}, c_{Θ})=C*(Z^{d},c_{Θ}). Proof. It suffices to show that the kernel of π is α-invariant. Let J be a 2-sided ideal in A_{Θ}. Then for each n∈Z^{d} we have Uₙ(J)U*ₙ=J. Now UₙUₘU*ₙ=c_{Θ-Θt}(n,m)Uₘ; we define ρ_{Θ}(n,m)=c_{Θ-Θt}(n,m). The maps p_{Θ}(n,−) can be identified with a subgroup of T^{d}. Let H_{Θ} be the closure of this group. By the strong continuity of α we have αₜ(J)=J for all t∈H_{Θ}. Theorem 7.4. If H_{Θ}=T^{d}, then A_{Θ} is simple. In the case d=2 consider U,V satisfying VU=e^{2πir}UV where r is real. This corresponds to C*(Z²,c_{Θ}) where Θ=[0 r 0 0]. If r is irrational then this algebra is simple. What can we say about the center of A_{Θ}? We have UₙUₘUₙ⁻¹=α_{pΘ(n,m)}Uₘ hence Uₘ∈Z(A_{Θ}) if αₜ(Uₘ)=Uₘ for all t∈H_{Θ}. In general a lies in the center iff UₘaUₘ⁻¹=a for all m, hence iff αₜ(a)=a for all t∈H_{Θ}. Let D_{Θ}={m∈Z^{d}: Uₘ∈Z(A_{Θ})}, which is just {m∈Z^{d}: [symbol] m,t [symbol] =1∀t∈H_{Θ}}, which we may also write as H_{Θ}^{⊥}. Let C_{Θ} be the closed subalgebra of A_{Θ} generated by the Uₘ,m∈D_{Θ}. Theorem 7.5. C_{Θ}=Z(A_{Θ}). Proof. H_{Θ} is a compact group, so we can equip it with normalized Haar measure. Define Q: A_{Θ} [symbol] ₐ→∫_{HΘ} αₜ(a) dt∈A_{Θ}. Then Q is a conditional expectation onto the center, and Q(Uₘ)=Uₘ for all m∈D_{Θ}. For m∉D_{Θ}, there exists t₀∈H_{Θ} such that [symbol] m,t₀ [symbol] ≠1, so Q(Uₘ)=∫H_{Θ} αₜ(Uₘ) dt=∫H_{Θ} [symbol] m, t [symbol] Uₘ dt=0. For any f∈C_{c}(Z^{d}) we therefore have Q(f)⊆C_{Θ}, hence Q(A_{Θ})⊆C_{Θ}. We have C_{Θ}≅C*(D_{Θ})≅C(D\hat{ }_{Θ})≅C(T^{d}/H_{Θ}), which is fairly explicit. Let b be a Banach space and let α be a strongly continuous action of R on B. Given b∈B we can ask whether the limit lim_{τ→0} α_{τ}(b)−b/τ exists; if it does, we'll call it D(b). More generally we can replace R with a finite dimensional real vector space V. For v∈V we can consider the action α_{τv} of R and ask whether the directional derivative lim_{τ→0} α_{τv}(b)−b/τ exists; if so, we'll call it Dᵥ(b). Fact from Lie theory: every closed connected subgroup of GLₙ(R) is a Lie group. These are the linear Lie groups. Every Lie group is locally isomorphic to a linear Lie group. In fact, for any Lie group G, either there is a discrete central subgroup C such that G/C is linear or there is a linear Lie group G^{˜} and a discrete central subgroup C of G^{˜} such that G/C^{˜}≅G. Example SL₂(R) is linear but not points. Its universal cover SL₂^{˜}(R) is not linear. Example The Heisenberg group {[1 x y 0 1 [symbol] 0 0 1]: x, y, [symbol] ∈R} is linear, but its quotient by the discrete subgroup {[1 0 n 0 1 0 0 0 1]: n∈Z} is not. “There is an exponential map Mₙ(R)≅glₙ(R) [symbol] X→exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(TX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by Dₓ(b). The collection of all b such that all iterated derivatives always exist is a linear subspace B^{∞} of B, and on this subspace we have (D_{X}D_{Y}−D_{Y}D_{X})(b)=D_{[X,Y]}(b) hence we have a representation of g”. A semiprime is any integer normalized function of temperature; and pressure correction value of number n is continued as phase factor for any complex number written in polar form (such as re^{iΘ}), the phase factor is the complex exponential factor (e^{iΘ}). 1-1 Structure of the Dual Algebra the monomials ε^{I} in a′ correspond in a one-to-one way with sequences of non-negative integers (i₁, i₂, • • • ,iₙ, 0, • • •) we now find the diagonal in a* non-rotating radial (distributor), rotating radial (distributor), rotating reciprocating radial (distributor) trivially, non-rotating radial pistons (distributor), rotating radial pistons (distributor), or rotating reciprocating radial pistons (distributor) trivially, Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for |B^{→}ₑ. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾ the equidistant Milstein approximation converges strongly with order (1.0) approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. This can be exploited to describe explicitly the factor in our affine geometric construction. Continuity equation in physics is an equation that describes the transport of our quantity simple and powerful order applied as our conserved quantity, and is continued apply to our extensive quantity any continuity equation can be expressed in an ‘integral form’ (in terms of a flux integral), which applies to any finite region, and in a ‘differential form’ (in terms of the divergence operator) which applies at a having differentials the flow of a gas through a domain in which flow properties only change in one direction, which we will call X an equilibrium point more explicitly, cycles and cocycles let e(F)∈H^{k}(V,R) be the Euler class of the oriented bundle F on V using the pairing which makes H^{k}(V,R) the dual of the number in base point k-face element plane the fundamental group we consider the category of pointed topological spaces, i.e. topological spaces with distinguished points indecomposable injective modules are the injective hulls of the modules R/p for p a prime ideal of the ring R. Moreover, the injective hull M of R/p has an increasing filtration by modules Mₙ given by the annihilators of the ideals pⁿ, and Mₙ₊₁/Mₙ is isomorphic as finite-dimensional vector space over the quotient field k(p) of R/p to Hom_{R/p}(pⁿ/pⁿ⁺¹, k(p)) finite-dimensional vector space of nondegenerate 2-form structure in potential theory complex analysis proves invaluable mathematical physics expressions an infinite potential n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let x, y be two solutions to the system of all transformations, which preserves the origin and the Euclidean metric, are linear maps. Such transformations Q must, for any x and y, satisfy the object functor category, U is well-defined and unitary or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). Shape object plane singletons have {points {and the entire space Rⁿ is our solution set of an arbitrary possibly, infinite system ≤b_{α}, α∈A α^{T}_{α}x≤b_{α}, α∈A of linear inequalities with n unknowns x {the set M={x∈Rⁿ|α^{T}_{α}x≤b_{α}, α∈A} is convex, and their incidence of Euclidean space are shared with affine geometry, (vector field on the generic leaf of a foliation) Hₖ(V,R), we get a scalar χ(F,∧)=he(F),[C]i∈R nondegenerate 2-form structure in potential theory complex analysis proves invaluable mathematical physics expressions an infinite potential finite-dimensional n=2 flat. 1-1 correspond the structure of the Dual Algebra a Euclidean geometry a case of Klein geometry, a theoretical framework including many alternative geometries. The Euclidean group E(n), also referred to as the group of all isometries ISO(n), treats translations, rotations, and reflections in a uniform way, considering them as group actions in the context of group theory, and especially in Lie group theory. These group actions preserve the Euclidean structure. As the group of all isometries, ISO(n), the Euclidean group is important because it makes Euclidean geometry a case of Klein geometry, a theoretical framework including many alternative geometries. The structure of Euclidean spaces—distances, lines, vectors, angles (up to sign), and so on—is invariant under the transformations of their associated Euclidean group. For instance, translations form a commutative subgroup that acts freely and transitively on Eⁿ, while the stabilizer of any point there is the afore mentioned O(n). As the group of all isometries, ISO(n), where the group I is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iXᵢ of 1.3, B*B representations G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, and X₁ G^{x}, x=r( [symbol] ), as two easy examples of this construction one can take. α) The groupoid G=M×M where M is a compact manifold, r and s are the two projections G→M=G M={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries. The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=X, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] : mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊ (A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. 1987]. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W×K^{p}; Zₚ)→H* (W×K; Zₚ the map induced by the diagonal d: K→K^{p}. 4. 1 Lemma. Let τ: H*(W⊗K^{p}; Zₚ)→H*_{π}(W⊗K^{p}; Zₚ) denote the transfer. Then d*τ=o. Proof. We have a commutative diagram [1] H*(W⊗K^{p}; Zₚ) τ→H*_{π}(W⊗K^{p}; Zₚ); [2] H*_{π}(W⊗K; Zₚ)i*→H*(W⊗K; Zₚ) τ→H*_{π}(W⊗K; Zₚ). [3] H*(W⊗K^{p}; Zₚ) d*→H*(W⊗K; Zₚ) [4] H*_{π}(W⊗K^{p}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If n is the group of cyclic permutations and P: H^{q}(K; Zₚ)→H^{pq}_{π}(W⊗K^{p}; Zₚ) then d*P is a homomorphism. Proof. Let u and v be q-cocycles on K. Then P(v+u)−Pu−Pv is given by the chain map W⊗K^{p ε⊗1}→K^{p (u+v)p-uP-vP}→Z^{p}. According to 4.1, we need only show that this cocycle is in the image of the transfer. It will be sufficient to show that (u+v)^{p}−u^{P}−v^{P} is in the image of a cocycle under τ: C*(K^{p}; Zₚ)→C^{*}_{π}(K^{p}; Zₚ) since ε⊗1 is an equivariant map. Now (u+v)^{p}−u^{p}−v^{p} Is the sum of all monomials which contain k factors u and (p-k) factors v, where 1≤k≤p−1. Now π permutes such factors freely. Let us choose a basis consisting of monomials whose permutations under π give each monomial exactly once. Let z be the sum of the monomials in the basis. Then τz=(u+v)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D. ; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀DⱼU×D_{k-J}v. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×90} (W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=τₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D))”. The non-degenerate Abelian functions are elliptic functions (we refer to) [symbol] The Longitudinal Index Theorem for Foliations. Proposition ρ=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)⊂K₀(J), since this allows us to take the bundles Eᵢ into account. a Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.3 Significance of the C*-algebra index. By the construction of C*(V,F) as a completion of the algebra C_{c}^{∞}(G), one has a natural homomorphism C_{c}^{∞}(G)→ⁱC*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. y The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D [symbol] ) [symbol] _{∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D [symbol] ) [symbol] _{∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space RN. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥} of i*(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i*(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let ν=(i*(F))^{⊥} be the normal bundle of i_{*}F in Rⁿ, and let N˜ν be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V ) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V ) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V) o_{ϕ}Z is a simple unital C*-algebra without any non-trivial idempotents. As a very nice example where this corollary applies one can take the diffeomorphism (I) given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert Huang transform (HHT). We find the familiar geometric series from calculus; alternately, this function has an infinite expansion. The coordinate system mapping the coordinate [symbol] -plane tangent to S at P and we then define the second fundamental form in the same way. Shape object plane singletons have {points {and the entire space Rⁿ is our solution set of an arbitrary possibly, infinite system ≤b_{α}, α∈A α^{T}_{α}x≤b_{α}, α∈A of linear inequalities with n unknowns x {the set M={x∈Rⁿ|α^{T}_{α}x≤b_{α}, α∈A} is convex, and their incidence of Euclidean space are shared with affine geometry, (vector field on the generic leaf of a foliation) Hₖ(V,R), we get a scalar χ(F,∧)=he(F),[C]i∈R nondegenerate 2-form structure in potential theory complex analysis proves invaluable mathematical physics expressions an infinite potential finite-dimensional n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions; and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁α₁+c₂α₂)∧β=c₁ (α₁∧β)+c₂ (α₂∧β) α∧(c₁β₁+c₂β₂)=c₁(a∧β₁)+c₂(α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁ ∧ . . . ∧eᵢₚ∧eⱼ₁∧ . . . ∧e_{jq} when the indices i₁, . . . , j₁, . . . , j_{q}, are distinct, and the product is zero otherwise. While the formula α∧α=0 holds when a has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , aₖ have degree one, then they are linearly independent iff a₁∧ . . . ∧αₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ/ⁿ∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. A pre-Abelian category in mathematics, specifically in category theory, our pre-Abelian category is an additive category that has all kernels and cokernels. Spelled out in more detail, this means that our category C is pre-Abelian when: C is preadditive, pre-Abelian category associated to a chain complex, or cochain complex C of vector spaces; the latter takes the form k-permutations of (n) allotropes-of-nanocarbon nanoparticle blended, and unblended (inert mixture formula); or the form k-permutations of (n) element nanoparticle blended, and unblended (inert mixture formula) enriched over the monoidal category of Abelian groups are performed with this group continuum a lift a normal k-smoothing isometries mechanics, or pre-Abelian category associated to a chain complex, or cochain complex C of vector spaces; the latter takes the form k-permutations of (n) element enriched over the monoidal category of Abelian groups are performed with this group continuum a lift a normal k-smoothing isometries mechanics (equivalently, all hom-sets in C are Abelian groups and composition of morphisms is bilinear); C has all finite products (equivalently, all finite coproducts C^{op}); note that because C is also preadditive, finite products are the same as finite coproducts, making them biproducts; given any morphism f: A→B in C, the equaliser off and the zero morphism from A to B exists (this is by definition the kernel of f), as does the coequaliser (this is by definition the cokernel of f). Note that the zero morphism in item 3 can be identified as the identity element of the horn-set Hom(A,B), which is an Abelian group by item 1; or as the unique morphism A→O→B, where O is a zero object, guaranteed to exist by item 2. Our bifunctor is a binary functor whose domain is a product category. For example, the Horn functor is of the type C^{op}×C→Set. It can be seen as a functor in two arguments. The Horn functor is a natural example; it is contravariant in one argument, covariant in the other. Our multifunctor is a generalization of the functor concept to n variables. So, here we use a bifunctor is a multifunctor with n=2. (We refer to). “We shall sketch the proof for the case n=2 with the centralizer of an element in a one-relator group with torsion is always cyclic” An Improved Subgroup Theorem For HNN Groups with Some Applications. In [4], a subgroup theorem for HNN groups was established. (see Newman [11] or [4, p. 956]) B. B. Newman, Some results on one-relator groups, Bull. Amer. Math. Soc. 74 (1968), 568-571. One then gets the convolution algebra C_{c}^{∞}(G, Ω^{1/2}) of smooth 1-densities on G, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries. (We refer to) “Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations,” Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. (We refer to) “An Improved Subgroup Theorem For HNN Groups with Some Applications”. Introduction. In [4], a subgroup theorem for HNN groups was established. The theorem was proved by embedding the given HNN group in a free product with amalgamated subgroup and then applying the subgroup theorem of [3]. In this paper (we refer to) we obtain a sharper form of the subgroup theorem of [4] by applying the Reidemeister-Schreier method directly, using an appropriate Schreier system of coset representatives. Specifically, we prove (in Theorem 1) that if H is a subgroup of the HNN group (1) G= [symbol] t, K; tLt⁻¹=M [symbol] , then H is an HNN group whose base is a tree product of vertices cKc⁻¹∩H where c ranges over a double coset representative system for G mod (H, K); the amalgamated and associated subgroups are contained in vertices of this base and are of the form dMd⁻¹∩H where d ranges over a double coset representative system for G mod (H, M). This improved subgroup theorem for HNN groups was obtained independently by D. E. Cohen [1] using Serre's theory of groups acting on trees. Using the present version of the subgroup theorem, several proofs in [4] can be simplified and results strengthened (see, e.g., [1]). Here we give two new applications of the improved subgroup theorem. Our first application deals with subgroups with non-trivial center of one-relator groups. Definition. A treed HNN group is an HNN group whose base is a tree product and whose associated subgroups are contained in vertices of the tree product base. Let H be a f.g. (finitely generated) subgroup with center Z (≠1) of a torsion-free one-relator group G. Then H as a free Abelian group of rank two, or H is a treed HNN group with infinite cyclic vertices and with center contained in the center of the base (see Theorem 2). Two corollaries are the following: If H is a subgroup with center Z (≠1) of a torsion-free one-relator group, then Z is infinite cyclic unless H is free Abelian of rank two or H is locally infinite cyclic. If H is a f.g. subgroup of the centralizer C of an element x in a torsion-free one-relator group and H∩gp (x)=1, then H is a free group. The first corollary was obtained independently by Mahimovski [8]. Theorem 2 generalizes Pietrowski's [12] characterization of one-relator groups having non-trivial centers. The centralizer of an element in a one-relator group with torsion is always cyclic (see Newman [11] or [4, p. 956]) B. B. Newman, Some results on one-relator groups, Bull. Amer. Math. Soc. 74 (1968), 568-571. Our second application connects the structure of a subgroup of finite index of a certain type of treed HNN group to its index. Classical examples of such a connection are given by the Schreier rank formula for free groups, the Euler characteristic for fundamental groups of orientable compact surfaces as compared with that of a j-sheeted covering space, and the Riemann-Hurwitz formula for Fuchsian groups. Each of these cases may be viewed as associating a number x(G) to each group G in the class so that if G: H=j, then x(H)=j·x(G); indeed, we take this property as the defining property of a characteristic defined on a class of groups closed under taking subgroups of f.i. (finite index). Specifically, for the free group G take x(G)=1-rank G, for the fundamental group G= [symbol] a₁, b₁, a_{g}, b_{g}, Π[aᵢ, bᵢ] [symbol] let x(G)=2−2g, and for the Fuchsian group G= [symbol] c₁, • • • , cₜ, a₁, b₁, • • • , a_{g}, b_{g}; c₁^{y1}, • • • , cₜ⁻¹[a₁, b₁] • • • [a_{g}, b_{g}] [symbol] let x(G)=2g−2+Σ(1−yi⁻¹). In all three cases if x(G)≠0, then isomorphic subgroups of f.i. must have the same index; indeed, in the first two cases x(H) determines H (up to isomorphism). In any case, knowing the index of the subgroup H determines x(H), and therefore limits the structure of H. Wall [15] introduced a “rational Euler characteristic” for finite extensions of discrete groups which admit a finite complex as classifying space. For these groups, not only does x(H)=j·x(G) when G:H=j, but also the formula x(A*B)=x (A)+x(B)−1 holds. The class of groups considered by Wall includes finite extensions of f.g. free groups, and for these groups Stallings [14] generalized Wall's formula to x(A*B; U)=x(A)+x(B)−|U|⁻¹, where U is a finite group (of order |U|), and A, B are finite extensions of f.g. free groups. We generalize this further to show that if G is a treed HNN group with finitely many vertices A₁, • • • , Aᵣ each of which is a finite extension of a free group, and there are finite amalgamated subgroups U₁, • • • , Uᵣ₋₁ and finitely many pairs of finite associated subgroups L₁, M₁, • • • , Lₙ, Mₙ, then Wall's characteristic x(G) is given by (2) x(G)=x(A₁)+ • • • +x(Aᵣ)−|U₁|⁻¹− • • • |Uᵣ₋₁|⁻¹−|M₁|⁻¹− • • • |Mn|⁻¹ (see Theorem 3). We then extend the formula (2) using the more general notion of characteristic (indicated above) to other classes of treed HNN groups (see Theorem 4).

The generalized formula applies to (Kleinian) function groups (certain discontinuous subgroups of LF (2, C)). 2. The subgroup theorem for HNN groups. Let G be as in (1). We may suppose that a set of generating symbols is chosen for K which includes a subset {mᵢ} which generates M and a corresponding subset {Iᵢ} where Iᵢ=t⁻¹mᵢt, which generates L. A K-symbol is one of the chosen K-generators or its inverse; an M-symbol is one of the m or its inverse. Let H be a subgroup of G. In the proof of Theorem 1 below we shall show that there exists a Schreier coset representative system for G mod H of the form {Dₖ•Eₘ•Q(m₁)} where Q(m₁) is a word in M-symbols, Eₘ•Q(mᵢ) is a word in K-symbols, Dₖ does not end in a K-symbol, Dₖ•Eₘ does not end in an M-symbol, and in no representative does t follow a non-empty M-symbol. Moreover, {Dₖ} is a representative system for G mod (H, K), and {Dₖ•Em} is a representative system for G mod (H, M). Theorem 1. Let G be as in (1), let H be a subgroup of G, and let a Schreier representative system for G mod H be chosen as described above. Then H is a treed HNN group whose vertices are of the form DₖKDₖ⁻¹∩H (where Dₖ ranges over the full double coset representative system for G mod (H, K)) and whose amalgamated and associated subgroups are of the form DₖEₘKEₘ⁻¹Dₖ⁻¹∩H (where DₖEₘ ranges over the full double coset representative system for G mod (H, M)). Proof. The proof of the theorem is analogous to that of the proof of the subgroup theorem (Theorem 5) of [3], and so we merely sketch the argument. First we construct a Schreier representative system for G mod H of the type described. For this purpose define the length of an (H, K) double coset as the shortest length of any word in it. For the (H, K) coset of length 0, we choose the empty word 1 as its K-double coset representative. To obtain the Schreier representatives for the H-cosets of H in HK, we supplement the double coset representative 1 with a special Schreier system (defined after Lemma 5, page 240 of [3] for K mod K∩H with respect to M. Assume we have defined Schreier representatives (in this manner) for all cosets of H contained in a double coset of (H, K) of length less than r. Let HWK and W have length r>0. Now W ends in a t-symbol; hence W=Vt^{e}, ₑ=±1. Moreover, the Schreier representative V* of V has already been defined and has the form V*=Dₖ•Eₘ•Q(mᵢ). If ₑ=1, then DₖEₘQ(mᵢ)t=DₖEₘtQ(Iᵢ), and so HDₖEₘtK=HWK, and we choose DₖEₘt as the double coset representative of HWK. If ₑ=−1, then choose DₖEₘQ(mᵢ)t⁻¹ as the double coset representative D of HWK. In either case we supplement our chosen double coset representative D of HWK with a special Schreier representative system for K mod K∩D⁻¹HD with respect to M. We have now constructed a Schreier coset representative system for G mod H as described above. Using this Schreier system and the corresponding rewriting process, we may apply the Reidemeister-Schreier method (see [7, Section 2.3]) to obtain a presentation for H from our presentation for G. Now H has generators {S_{N,x}} and {S_{N,t}} semiprime is a Schreier representative and x is a K-generator. Moreover, {S_{N,x}}, semiprime has a fixed (H, K) double coset representative Dₖ and x ranges over the K-generators, generates the subgroup D_{K}KDₖ⁻¹∩H; {S_{N,y}}, semiprime has a fixed (H, M) double coset representative DₖEₘ and y ranges over the M-generators, generates the subgroup D_{K}EₘMEₘ⁻¹D_{K}⁻¹∩H. Moreover, if the relators of K are conjugated by those N with a fixed Dₖ, and then the rewriting process T is applied, the resulting relators together with the trivial generators S_{N,x} provide a set of defining relators for DₖKDₖ−1∩H. The defining relators for H that arise from rewriting {t|ᵢt⁻¹ mᵢ} enable us to eliminate the generators S_{N,t} semiprime is not a double coset representative for G mod (H, M); moreover, the remaining relators take the form (3) S_{DkEm,t} ((DₖEₘt)*L(DₖEₘt)*⁻¹∩H) S_{DkEm,t}⁻¹=DₖEₘMEₘ⁻¹Dₖ⁻¹∩H. Now (3) describes an amalgamation which takes place between vertices (DₖEₘt)*K(DₖEₘt)*⁻¹∩H and (DₖEₘ)K(DₖEₘ)⁻¹∩H if S_{DkEm,t} is a trivial generator (i.e., (DₖEₘt)*≈DₖEₘt); otherwise, (3) describes a pair of associated subgroups from these same vertices. Specifically, if DₖEₘQ(mⱼ) is a representative, then S_{DkEm,t Q,t} is freely equal to τ[(DₖEₘ)*Q(mⱼ)(DₖEₘQ(mⱼ))*⁻¹]•S_{DkEm,t}•τ[(DₖEₘt)*Q(Iⱼ)(DₖEₘQ(Iⱼ))*⁻¹], and hence if Q(mⱼ)≠1, we may eliminate the generators S_{DkEm,Qt}; the remaining relators become those in (3) together with the trivial generators in {S_{DkEm,t}} The amalgamations described in (3) lead to a tree product of vertices DₖKDₖ⁻¹∩H for the following reason (see [7, Lemma 1]): Assign as level of the vertex DₖKDₖ⁻¹∩H, the number r of t-symbols in Dₖ; then the unique vertex of level less than r with which DRKDE^{I} A H has a subgroup amalgamated is the subgroup DKD−I A H where D is obtained from Dₖ by deleting the last t-symbol and then deleting any K-syllable immediately preceding that. Corollary 1. The rank of the free part of H as described in Theorem 1 is [G: (H, M)]−[G: (H, K)]+1. Proof. (DₖEₘt)*≈DₖEₘt if and only if either DₖEₘt is a Schreier representative and therefore an (H, K) double coset representative, or Eₘ=1 and Dₖ ends in t⁻¹. Thus there exists a one-one correspondence between (H, K) double coset representatives ending in t or t⁻¹ and the trivial generators in {S_{DkEm,t}} But there are G: (H, K)−1 double coset representatives for G mod (H, K) ending in t or t⁻¹; hence the assertion follows. The following corollary will be used in the proof of Theorem 4: Corollary 2. Let G be a treed HNN group with finitely many vertices, f.g. free part, and finite amalgamated and associated subgroups. Then any subgroup H of f.i. is a treed HNN group with finitely many vertices each of which is a conjugate of the intersection of H with some conjugate of a vertex of G; the amalgamated and associated subgroups are conjugates of the intersections of H with certain conjugates of the amalgamated and associated subgroups of G. Proof. The proof is by induction on the sum s of the rank of the free part of G and the number of vertices in G. If s=2, the result follows from the subgroup theorem of [3] or Theorem 1 above. Otherwise, suppose G is as in (1) where K is now a treed HNN group with smaller s than that of G. Then H is a treed HNN group whose vertices are of the form cKc⁻¹∩H=c(K∩c⁻¹Hc)c⁻¹, which by inductive hypothesis is a treed HNN group of the desired type. Now an amalgamated or associated subgroup of H has the form dMd⁻¹∩H. Thus H is an HNN group whose base is a tree product with treed HNN groups as vertices and finite amalgamated subgroups, and H itself has finite associated subgroups. It follows as in the argument for the proof of Theorem 1 of [2] that H is a treed HNN group of the asserted form. In a similar May, it follows that if G (A*B; U) where B has smaller s than that of G and A is one of the original vertices of G, then H will be a treed HNN group of the desired type. 3. Subgroups with non-trivial center of one-relator groups. Theorem 2. Let G be a group with one defining relator R where R is not a true power, and let H be a f.g. subgroup of G with non-trivial center Z. Then H is free Abelian of rank two, or H is a treed HNN group with infinite cyclic vertices and Z is contained in the center of the base of H. Proof. If R has syllable length one, then G is free, H is infinite cyclic, and the result holds. Assume R has syllable length greater than one; then G can be embedded in an HNN group G₁= [symbol] t, K; rel K, tLt⁻¹=M [symbol] where K is a one-relator group whose relator is shorter than R and L, M are free (see e.g., [4]). Suppose H is not free Abelian of rank two. Now by Theorem 1, a f.g. subgroup H of G₁ is a treed HNN group H= [symbol] t₁, • • • , tₙ, S; rel S, t₁Lₜ₁⁻¹=M₁, • • • [symbol] where S is a tree product of finitely many vertices A₁, • • • , Aᵣ, each Aᵢ being a subgroup of a conjugate of K; the amalgamated and associated subgroups are free. If n≠1, then Z is contained in S; for, H=Π*(gp(t₁, S); S). First suppose Z [symbol] S^{H}. Then n=1. Since some element in Z is not in S^{H} and H is f.g., and S/S^{H} is infinite cyclic, it follows that S^{H} is f.g. (see Murasugi [10]). Therefore S^{H}=L₁ is free and f.g. Consequently, H has the asserted form by [2, Theorem 3]. Therefore we may assume Z<S^{H}. We show, in fact, that Z<S. If n≠1, we are finished. Suppose n=1. Then S^{H} is an infinite stem product (i.e., a tree product in which each vertex has at most two edges incident with it) of vertices t₁ⁱSt₁⁻ⁱ. If M₁≠S≠L₁, then the stem product is proper (i.e., each amalgamated subgroup is a proper subgroup of its containing vertices), and therefore Z is contained in S. If S equals L₁ or M₁, then S is free; S^{H} is an ascending union of free groups and has a non-trivial center, so that S must be infinite cyclic. If S=gp(a)=L₁, and M₁=gp(a^{q}), then H= [symbol] t₁, a; t₁at₁⁻¹=a^{q} [symbol] . Since Z∩S≠1, t₁a^{r}t₁⁻¹=a^{q r}=a^{r} for some r≠0. Hence q=1, and H would be free Abelian of rank two. Therefore Z must be contained in S. Suppose next S consists of a single vertex, S=gKg⁻¹∩H. If n=0, then H=S, is a f.g. subgroup with non-trivial center of the group gKg⁻¹; therefore by the inductive hypothesis, H has the desired form. If n>0, and some Lᵢ or Mᵢ equals S, then S is free with non-trivial center, and so must be infinite cyclic. Thus again H has the asserted form with base S. We may therefore assume that S^{H} is a proper tree product of the vertices tᵢ^{j}Stᵢ^{-j}, and so Z<Lᵢ∩Mi. Since Lᵢ, Mᵢ are free, Z, Lᵢ, Mᵢ must each be infinite cyclic. Therefore S is a f.g. subgroup of gKg⁻¹ land the inductive hypothesis applies to S. Since Z is infinite cyclic, it follows that S is a treed HNN group with infinite cyclic vertices each of which contains Z, and each of the associated subgroups contains Z. Therefore S/Z is a treed HNN group with finite cyclic vertices; moreover, Lᵢ/Z goes into Mᵢ/Z under conjugation by tᵢ. Hence H/Z is an HNN group with finite cyclic vertices, and the associated subgroups of H/Z are finite. Therefore H/Z is a treed HNN group with finite cyclic vertices, and so by the proof of [2, Theorem 3] H has the asserted form. Finally, suppose S does not consist of a single vertex. Then S is a proper tree product and Z is contained in the amalgamated subgroups of S; these are free and therefore infinite cyclic. Moreover, since Z<Lᵢ∩Mᵢ, we have that Lᵢ, Mᵢ are infinite cyclic. Hence each of the vertices Aⱼ of S is f.g. and the inductive hypothesis applies to each Aⱼ. Hence Aⱼ/Z is a treed HNN group with finite cyclic vertices, and the amalgamated and associated subgroups when reduced mod Z yield finite cyclic groups. Thus H/Z is an HNN group whose base is a tree product of treed HNN groups with finite cyclic vertices; the amalgamated and associated subgroups are finite cyclic groups. Hence H/Z is a treed HNN group with finite cyclic vertices, and consequently H has the asserted form (again by the proof of [2, Theorem 3). Corollary 1. Let H be a subgroup with non-trivial center Z of a torsion-free one-relator group G, H not free Abelian of rank two and not locally infinite cyclic. Then Z is infinite cyclic. Proof. If H is f.g., then Z is infinite cyclic because Z is in the center of the tree product base of H, which has infinite cyclic vertices. Suppose H is infinitely generated. Then H is the ascending union of countably many f.g. subgroups Hᵢ each containing a f.g. subgroup Z of Z such that Z is the ascending union of the Z. Now by Moldavanski [9] or Newman 11], no Abelian subgroup of G can be a proper ascending union of free Abelian groups of rank two. Hence only finitely many Hᵢ can be free Abelian of rank two. Thus Zᵢ must be infinite cyclic, and so Z is infinite cyclic if Z is f.g. Suppose Z is infinitely generated. Then H/Z is periodic. For otherwise, for some element h of H, gp(h, Zᵢ) is free Abelian of rank two, and gp(h, Z)=∪gp(h, Zᵢ) which is impossible. Hence, if Cᵢ is the center of Hᵢ, then Hᵢ/Cᵢ is on the one hand periodic, and on the other hand a treed HNN group with finite cyclic vertices. Therefore, Hᵢ/Cᵢ is finite, and so Hᵢ is infinite cyclic. Consequently, H is locally infinite cyclic. Corollary 2. If H is a f.g. subgroup of the centralizer C of an element x in a torsion-free one-relator group and H∩gp(x)=1, then H is a free group. Proof. Let H₁=gp(H, x), which is the direct product H X gp(x). If H₁ is free Abelian of rank two, then clearly H is infinite cyclic. If H₁ is not free Abelian of rank two, then the center Z of H₁ is infinite cyclic and therefore equals gp(x). Now since H₁ is a treed HNN group with finitely many cyclic vertices each of which contains Z and each of whose associated subgroups contains Z, it follows that H₁/Z is a treed HNN group with finite cyclic vertices, which is isomorphic to H. Since H is torsion-free, H must be free. 4. Characteristics of groups. Lemma 1. Suppose G is as in (1) and R is a subgroup of K such that R has trivial intersection with the conjugates of L and M in K. Let {aᵢ} be a common double coset representative system for K mod (R, M) and K mod (R, L). Then the subgroup H=R*Πⱼ*gp (aⱼtaⱼ⁻¹) is of index [K: (R, M)]•|M|. In Particular, if K:R and |M| are both finite, then a common double coset representative {aᵢ} exists and H is of finite index in G; if R is free (or torsion-free), then so is H. Proof. We show H is a subgroup of the asserted form and index by constructing H using an appropriate Schreier representative system and a corresponding right coset function. For this purpose choose a set of generating symbols for K which is the union of the following three subsets: the symbols {aᵢ}, the symbols {r_{q}} where r_{q} ranges over the elements of R, and the symbols {mⱼ} where mⱼ ranges over the elements of M; the empty symbol 1 is included among the symbols {aᵢ} as well as {mⱼ}. We use the symbols Iⱼ to denote t⁻¹mⱼt. As Schreier representatives take the words {aᵢmⱼ}. A corresponding right coset function is determined by the following assignments:=(aᵢmⱼk)*=aᵤmᵥ where aᵢmⱼk=r_{q}aᵤmᵥ, for k any K-symbol; (aᵢmⱼt)*=aᵤmᵥ where aᵢIⱼ=r_{q}aᵤmᵥ; and (aᵢmⱼt⁻¹)*=aᵤmᵥ where aᵢmⱼ=r_{q}aᵤIᵥ. It is not difficult to show that these assignments define a permutation representation of G acting on the chosen representatives {aᵢmⱼ}, and hence determine a subgroup H of elements of G which leave the representative 1 fixed. Clearly, H∩K=R; for, the first of the three representative assignments holds when k is any element of K, and so if (k)*=aᵤmᵥ=1 then k=r_{q}. This enables us to show that the Schreier system {aᵢmⱼ} has the required properties to apply Theorem 1. In particular, 1 is the HK double coset representative, and {aᵢ} is a set of representatives for G mod (H, M). Therefore H is a treed HNN group with a single vertex K∩H=R, the amalgamated and associated subgroups are aᵢMaᵢ⁻¹∩H=aᵢMaᵢ⁻¹∩R=1; and its free part is generated by s_{ai,t}=aᵢt(aᵢt)*⁻¹=aᵢtaᵢ⁻¹ Let G contain a free subgroup F of rank r and finite index j. Then Wall's rational Euler characteristic x(G) (mentioned in the introduction) is given by x(G)=(1−r)/j (this is obtained using Wall's formulas quoted and that the Euler characteristic of an infinite cyclic group is 0). In particular, if G is finite, then x(G)=|G|⁻¹. Lemma 2. Let G be as in (1). Suppose that K contains a free subgroup R of finite index, and that M is finite. Then the Wall characteristic of G is given by x(G)=x(K)−x(M)=x(K)−|M|⁻¹. Proof. Applying Lemma 1, we see that H of that Lemma is free and of finite index in G. Moreover, x(G)=(1−rank H)/[K: (R, M)]•|M|, and rank H=rank R+[K: (R, M)]. Therefore x(G)={1−rank R+[K: (R, M)])}/[K: (R, M)]•|M|=(1−rank R)/[K:R]−|M|⁻¹=x(G)−x(M). Theorem 3. If G is a treed HNN group with vertices A₁, • • • , Aᵣ each of which is a finite extension of a free group, finite amalgamated subgroups U₁, • • • , Uᵣ₋₁, and pairs of finite associated subgroups L₁, M₁, • • • , Lₙ, Mₙ, then Wall's characteristic x(G) is given by (4) x(G)=x(A₁)=+ • • • +x(Aᵣ)−|U∥⁻¹−|Uᵣ₋₁|⁻¹−|M₁|⁻¹− • • • |Mₙ|⁻¹. Proof. The proof of (4) is clearly obtained by using Lemma 2, and Stalling's formula quoted in the introduction. We generalize Wall's characteristic as follows: Definition. Let C be a class of groups closed under taking subgroups of f.i. Then a characteristic x defined on C is a real-valued function defined on C such that if G is in C and G:H=j, then x(H)=j•x(G). In addition to the illustrations of characteristics mentioned in the introduction we give the following: 1. Let C₁ be a class of groups with a characteristic x₁ defined on it. Let C be the class of all groups which contain a subgroup of f.i. which lies in C₁. If G is in C, and G:C=p where C is in C₁, define x(G)=x₁(C)/p. Clearly if G:D=q where D is in C₁, and C/C∩D =c, D/C∩D=d, then x₁(C)/p=x₁(C∩D)/cp=x₁ (C∩D)/dq=x₁(D)/q, so that x(G) is well-defined. Moreover, if G:H=j, and H:E=r where E is in C₁, then x(H)=x₁(E)/r=j•x₁(E)/jr=j•x(G). 2. Let C be the class of subgroups of f.i. of a fixed group G. Then a necessary and sufficient condition for a non-zero characteristic to be definable on C is that isomorphic subgroups of f.i. in G have the same index in G. Indeed, if H₁≅H₂, G:H₁=j₁, G:H₂=j₂, and x(G)≠0, then x(H₁)=j₁•x(G)=x(H₂)=j₂•x(G), so that j₁=j₂. Conversely, define x(G)=1, x(H)=j when G:H=j; then x(G) is a well-defined characteristic. Our last example of a characteristic makes use of Theorem 1 and the subgroup theorem of [3]. Theorem 4. Suppose C₁ is a class of f.g. groups with a characteristic x₁ defined on and such that each group in C₁ contains a torsion-free non-cyclic indecomposable (with respect to free product) subgroup of finite index. Let C be the class of treed HNN groups with f.g. free part, finitely many vertices each in C₁, and finite amalgamated and associated subgroups. Suppose G is in C, and has a presentation as a treed HNN group with vertices A₁, • • • , Aᵣ in C₁, amalgamated subgroups U₁, • • • , Uᵣ₋₁, and pairs of associated subgroups L₁, M₁, • • • , Lₙ, Mₙ. If we set x(G)=x(A₁)+ • • • +x(Aᵣ)−|U|⁻¹− • • • −|Uᵣ₋₁|⁻¹−|M₁|⁻¹− • • • −|Mₙ|⁻¹. Then x defines a characteristic on the class C. Proof. We first observe that the class (C is closed under forming treed HNN groups with vertices from C, using finite amalgamated and associated subgroups (for an argument, see the proof of Theorem 1 of [2]). Next We note (see [3]) that a subgroup H of (A*B; U) is a treed HNN group with vertices cAc⁻¹∩H, dBd⁻¹∩H where c, d range over double coset representative systems for G mod (H, A) and G mod (H, B), respectively; moreover, the amalgamated and associated subgroups are of the form eUe⁻¹∩H where e ranges over a double coset representative system for G mod (H, U). It follows from Corollary 2 of Theorem 1 that C is closed under taking subgroups of f.i. We now show that if G:H =j, then for each presentation of G as a treed HNN group in C, H has a presentation as a treed HNN group in C for which x(H)=j•x(G). Indeed, suppose that this assertion holds for A, B in C, and consider G=(A_{*}B; U), U finite. Now cAc⁻¹: cAc⁻¹∩H=j_{c} is the number of H cosets in HcA. Hence cAc⁻¹∩H has a treed HNN presentation in C such that x(cAc⁻¹∩H)=j_{c}•x(cAc⁻¹)=j_{c}•x (A). Similarly, if j_{d}=dBd⁻¹: dBd⁻¹∩H, and jₑ eUe⁻¹: eUe⁻¹∩H, then x(H)=Σ_{c} j_{c}•x(A)+Σ_{D jd}•x(B)−Σ_{e je}•|U|⁻¹=j[x(A)+x(B)−|U|⁻¹]=j•x(G). Similarly, if the assertion of the preceding paragraph holds for K in C, and G is as in (1) with M finite, and G:H=j, then H is a treed HNN group with vertices fKf⁻¹∩H where f ranges over a representative system for G mod (H, K); moreover the amalgamated and associated subgroups are of the form gMg⁻¹ H where g ranges over a coset representative system for G mod (H, M). If j_{f}=fKf⁻¹: fKf⁻¹∩H, and j_{g}=gMg⁻¹: gMg⁻¹∩H, then x(H)=Σ_{f} j_{f}·x(K)−Σ_{g jg}·|M|⁻¹=j·[x(K)−|M|⁻¹]=j·x(G). Finally, we show that x is well-defined on the class C. Clearly, the only ambiguity in the definition of x(G) is that G may be presentable in several ways as a treed HNN group in C. Now an element G₁ of cannot be written in a non-trivial way as a treed HNN group with finite amalgamated and associated subgroups; for otherwise, G₁ would have two or infinitely many ends (see Stallings [13]), so that any torsion free subgroup of finite index would have two or infinitely many ends and would therefore be infinite cyclic or a proper free product (see Stallings [13]), contrary to hypothesis. Hence x is well-defined on the elements of C₁. Consider any torsion-free group T in C. Now T has a unique representation as a treed HNN group in C, namely, as a free product of a free group and groups from C₁. Using the uniqueness of representation of a f.g. group as a free product of indecomposable groups, it follows that x(T) is well-defined. Lastly, a group G in has a torsion free subgroup T of f.i., say p (by Stallings [14] and Lemma 1 above), and so x(G)=x(T)/p, so that x(G) is well-defined. Corollary. Let G be as described in Theorem 4, and G:H=j. Suppose that H has a Presentation as a treed HNN group with vertices B₁, • • • , Bₛ, amalgamated subgroups Vᵢ, • • • , Vₛ₋₁, and pairs of associated subgroups P₁, Q₁, • • • , Pₘ, Qₘ. Then x₁(B₁)+ • • • +x₁(Bₛ)=j+x₁(A₁)+ • • • +x₁(Aᵣ)), and |V₁|⁻¹+ • • • +|Vₛ₋₁|⁻¹+|Q₁|⁻¹+ • • • +|Q₁|⁻¹=j(|U₁|⁻¹+ • • • +|Uᵣ₋₁|⁻¹+|M₁|⁻¹+ • • • +|Mₙ|⁻¹). Proof. Since x₁ can be replaced by x₂=2x₁ and the assertion of Theorem 4 will still hold, the result follows. As an illustration of Theorem 4, let C₁ be the class of Fuchsian groups described in the introduction, and let be the characteristic mentioned there. Then it is well-known that each group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0”. The resulting class (C includes Kleinian function groups (see [6]). Can. J. Math., Vol. xxvl, No. I, 1974, pp. 214-224. An Improved Subgroup Theorem For HNN Groups ‘with Some Applications’ by A. Karrass, A. Pietrowski, And D. Solitar. Our closed monoidal category in mathematics, especially in category theory, a closed monoidal category (also called a monoidal closed category) is a context where it is possible both to form tensor products of objects and to form ‘mapping objects’. A classic example is the category of sets, S to sets, where the tensor product of sets A and B is the usual Cartesian product A×B Cartesian Product (set of ordered pairs from A and B) {1,2}×{3,4}={(1,3), (1,4), (2,3), (2,4)}, and the mapping object B^{A} is the set of functions from A to B. Another example is the category FdVect, consisting of finite-dimensional vector spaces and linear maps. Here the tensor product is the usual tensor product of vector spaces, and the mapping object is the vector space of linear maps from one vector space to another. The ‘mapping object’ referred to above is also called the ‘internal Hom’. The internal language of closed symmetric monoidal categories is linear logic and the type system is the linear type system. Many examples of closed monoidal categories are symmetric. However, this need not always be the case, as non-symmetric monoidal categories can be encountered in category-theoretic formulations of linguistics; roughly speaking, this is because word-order in natural language, or in other theoretical subject matters. A closed monoidal category is a monoidal category C such that for every object B the functor given by right tensoring with B A [symbol] A⊗B has a right adjoint, written A [symbol] (B⇒A). This means that there exists a bijection, called ‘currying’, between the Horn-sets Hom_{C}(A⊗B,C)≅Hom_{C}(A, B⇒C) that is natural in both A and C. In a different, but common notation, one would say that the functor −⊗B: C→C has a right adjoint [B, −]: C→C equivalently, a closed monoidal category C is a category equipped, for every two objects A and B, with an object A⇒B, a morphism eval_{A,B}:(A⇒B)⊗A→B, satisfying the following universal property: for every morphism f:X⊗A→B there exists a unique morphism h: X→A⇒B such that f=eval_{A,B}∘(h⊗id_{A}). It can be shown that this construction defines a functor ⇒: C^{op}⊗C→C. This functor is called the internal Horn functor, and the object A⇒B is called the internal Horn of A and B. Many other notations are in common use for the internal Horn. When the tensor product on C is the Cartesian product, the usual notation is B^{A} and this object is called the exponential object. Biclosed and symmetric categories strictly speaking, we have defined a right closed monoidal category, since we required that right tensoring with any object A has a right adjoint. In a left closed monoidal category, we instead demand that the functor of left tensoring with any object A B [symbol] A⊗B have a right adjoint B [symbol] (B⇐A). A biclosed monoidal category is a monoidal category that is both left and right closed. A symmetric monoidal category is left closed if and only if it is right closed. Thus we may safely speak of a ‘symmetric monoidal closed category’ without specifying whether it is left or right closed. In fact, the same is true more generally for braided monoidal categories: since the braiding makes A⊗B naturally isomorphic to B⊗A, the distinction between tensoring on the left and tensoring on the right becomes immaterial, so every right closed braided monoidal category becomes left closed in a canonical way, and vice versa. We have described closed monoidal categories as monoidal categories with an extra property. One can equivalently define a closed monoidal category to be a closed category with an extra property. Namely, we can demand the existence of a tensor product that is left adjoint to the internal Horn functor. In this approach, closed monoidal categories are also called monoidal closed categories. The monoidal category Set of sets and functions, with Cartesian product as the tensor product, is a closed monoidal category. Here, the internal horn A⇒B is the set of functions from A to B. In computer science, the bijection between tensoring and the internal horn is known as currying, particularly in functional programming languages. Indeed, some languages, such as Haskell and Caml, explicitly use an arrow notation to denote a function. This example is a Cartesian closed category. More generally, every Cartesian closed category is a symmetric monoidal closed category, when the monoidal structure is the Cartesian product structure. Here the internal horn A⇒B is usually written as the exponential object B^{A}. The monoidal category FdVect of finite-dimensional vector spaces and linear maps, with its usual tensor product, is a closed monoidal category. Here A⇒B is the vector space of linear maps from A to B. This example is a compact closed category. More generally, every compact closed category is a symmetric monoidal closed category, in which the internal Horn functor A⇒B is given by B⊗A*. Kelly, G. M. “Basic Concepts of Enriched Category Theory”, London mathematical Society Lecture Note Series No. 64 (C.U.P., 1982). Paul-André Melliès, “Categorical Semantics of Linear Logic”, Panoramas et Synthèses 27, Société Mathématique de France, 2009. In mathematics, specifically in category theory, an additive category is a preadditive category C admitting all finitary biproducts. A category C is preadditive if all its horn-sets are Abelian groups and composition of morphisms is bilinear; C is enriched over the monoidal category of Abelian groups. In a preadditive category, every finitary product (including the empty product, i.e., a final object) is necessarily a coproduct (or initial object in the case of an empty diagram), and hence a biproduct, and conversely every finitary coproduct is necessarily a product (this is a consequence of the definition, not a part of it). Thus an additive category is equivalently described as a preadditive category admitting all finitary products, or a preadditive category admitting all finitary coproducts. Another, yet equivalent, way to define an additive category is a category (not assumed to be preadditive) which has a zero object, finite coproducts and finite products and such that the canonical map from the coproduct to the product XIIY→XIIY is an isomorphism. This isomorphism can be used to equip Hom(X,Y) with a commutative monoid structure. The last requirement is that this is in fact an Abelian group. Unlike the afore-mentioned definitions, this definition does not need the auxiliary additive group structure on the Horn sets as a datum, but rather as a property.^{[1]}Jacob Lurie: Higher Algebra, Definition 1.1.2.1, “Archived copy” (PDF). Archived from the original (PDF) on 2015 Feb. 6. Retrieved 2015 Jan. 30. Note that the empty biproduct is necessarily a zero object in the category, and a category admitting all finitary biproducts is often called semiadditive. As shown below, every semiadditive category has a natural addition, and so we can alternatively define an additive category to be a semiadditive category having the property that every morphism has an additive inverse. We also considers additive R-linear categories for a commutative ring R. These are a categories enriched over the monoidal category of R-modules and admitting all finitary biproducts. The original example of an additive category is the category of Abelian groups Ab. The zero object is the trivial group, the addition of morphisms is given pointwise, and biproducts are given by direct sums. We consider, every module category over a ring R is additive, and so in particular, the category of vector spaces over a field K is additive. The algebra of matrices over a ring, thought of as a category as described below, is also additive. Internal characterisation of the addition law Let C be a semiadditive category, so a category having all finitary biproducts. Then every horn-set has an addition, endowing it with the structure of an Abelian monoid, and such that the composition of morphisms is bilinear. Moreover, if C is additive, then the two additions on horn-sets must agree. In particular, a semiadditive category is additive if and only if every morphism has an additive inverse. This shows that the addition law for an additive category is internal to that category.^{[2]} MacLane, Saunders (1950), “Duality for groups”, Bulletin of the American mathematical Society, 56 (6): 485-516, doi:10.1090/S0002-9904-1950-09427-0, MR 0049192 Sections 18 and 19 deal with the addition law in semiadditive categories. To define the addition law, we will use the convention that for a biproduct, pₖ will denote the projection morphisms, and iₖ will denote the injection morphisms. We first observe that for each object A there is a diagonal morphism Δ: A→A⊕A satisfying pₖ∘Δ=1_{A} for k=1,2, and a codiagonal morphism ∇: A⊕A→A satisfying ∇∘iₖ=1_{A} for k=1,2. Next, given two morphisms αₖ: A→B, there exists a unique morphism α₁⊕α₂: A⊕A→B⊕B such that pᵢ∘(α₁⊕α₂)∘iₖ equals αₖ if k=I, and 0 otherwise. We can therefore define α₁+α₂:=∇∘(a₁⊕a₂)∘Δ. This addition is both commutative and associative. The associativity can be seen by considering the composition A^{Δ}→A⊕A|A^{α1⊕α2⊕α3}→B⊕B⊕B^{∇}→B. We have α+0=α, using that α⊕0=i₁∘α∘p₁. It is also bilinear, using for example that Δ∘β=(β⊕β)∘Δ and that (α₁⊕α₂)∘(β₁⊕β₂)=(α₁∘β₁)⊕(α₂∘β₂). We remark that for a biproduct A⊕B we have i₁∘p₁+i₂∘p₂=1. Using this, we can represent any morphism A⊕B→C⊕D as a matrix. Matrix representation of morphisms. Given objects A₁, . . . , Aₙ and B₁, . . . , Bₘ in an additive category, we can represent morphisms f: A₁⊕ [symbol] ⊕Aₙ→B₁⊕ [symbol] ⊕Bₘ as m-by-n matrices (f₁₁ f₁₂ [symbol] f₁ₙ f₂₁ f₂₂ [symbol] [symbol] . . . [symbol] fₘ₁ fₘ₂ . . . fₘₙ) where fₖₗ:=pₖ∘f∘Aₗ→Bₖ. Using that Σₖ iₖ∘pₖ=1, it follows that addition and composition of matrices obey the usual rules for matrix addition and matrix multiplication. Thus additive categories can be seen as the most general context in which the algebra of matrices makes sense. We may recall that the morphisms from a single object A to itself form the endomorphism ring End(A). If we denote the n-fold product of A with itself by Aⁿ, then morphisms from Aⁿ to A^{m} are m-by-n matrices with entries from the ring End(A). Conversely, given any ring R, we can form a category Mat(R) by taking objects An indexed by the set of natural numbers (including zero) and letting the horn-set of morphisms from Aₙ to Aₘ be the set of m-by-n matrices over R, and where composition is given by matrix multiplication. Then Mat(R) is an additive category, and Aₙ equals the n-fold power (A₁)ⁿ. This construction should be compared with the result that a ring is a preadditive category with just one object, shown here. If we interpret the object An as the left module Rₙ, then this matrix category becomes a subcategory of the category of left modules over R. This may be confusing in the special case where m or n is zero, because we usually don't think of matrices with 0 rows or 0 columns. This concept makes sense, however: such matrices have no entries and so are completely determined by their size. While these matrices are rather degenerate, they do need to be included to get an additive category, since an additive category must have a zero object. Thinking about such matrices can be useful in one way, though: they highlight the fact that given any objects A and B in an additive category, there is exactly one morphism from A to 0 (just as there is exactly one 0-by-1 matrix with entries in End(A)) and exactly one morphism from 0 to B (just as there is exactly one 1-by-0 matrix with entries in End(B)) this is just what it means to say that 0 is a zero object. Furthermore, the zero morphism from A to B is the composition of these morphisms, as can be calculated by multiplying the degenerate matrices. Additive functors A functor F: C→D between preadditive categories is additive if it is an Abelian group homomorphism on each horn-set in C. If the categories are additive, then a functor is additive if and only if it preserves all biproduct diagrams. That is, if B is a biproduct of A₁, . . . , Aₙ in C with projection morphisms ₚₖ and injection morphisms kj, then F(B) should be a biproduct of F(A₁), . . . , F(Aₙ) in D with projection morphisms F(pₖ) and injection morphisms F(iₖ). Almost all functors studied between additive categories are additive. In fact, it is a theorem that all adjoint functors between additive categories must be additive functors (see here), and most interesting functors studied in all of category theory are adjoints. When considering functors between R-linear additive categories, one usually restricts to R-linear functors, so those functors giving an R-module homomorphism on each horn-set. A pre-Abelian category is an additive category in which every morphism has a kernel and a cokernel. An Abelian category is a pre-Abelian category such that every monomorphism and epimorphism is normal. Many commonly studied additive categories are in fact Abelian categories; for example, Ab is an Abelian category. The free Abelian groups provide an example of a category that is additive but not Abelian. ^{[3]}Shastri, Anant R. (2013), Basic Algebraic Topology, CRC Press, p. 466, ISBN 9781466562431. Nicolae Popescu; 1973; Abelian Categories with Applications to Rings and Modules; Academic Press, Inc. (out of print) goes over all of this very slowly.

Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components B n of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order y∈(0, ∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|I Ag [symbol] *, [symbol] f|Af [symbol] is real. Newtonian binomial theorem: (ⁿₖ)=n!/k!(n−k)!=n(n−1)(n−2) [symbol] (n−k+1)/k!. The expression on the right makes sense even if n is not a non-negative integer, so long as k is a non-negative integer, and we therefore define (^{r}ₖ)=r(r−1)(r−2) [symbol] (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) [symbol] (−n−i+1)/i!=₍₋₁₎ⁱ(n)(n+1) [symbol] (n+i−1)i!=(−1)i(n+i−1)!i!(n−1)!=(−1)i(n+i−1i)=(−1)i(n+i−1n−1). (−n)(−n−1)(−n−2) [symbol] (−n−i+1)i!=(−1)i(n)(n+1) [symbol] (n+i−1)i!=(−1)i(n+i−1)!i!(n−1)!=(−1)i(n+i−1i)=(−1)i(n+i−1n−1).

Thus (x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi =0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+67x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+316+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ [symbol] )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. f(x)=(1+x+x2+ [symbol] )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ [symbol] )(1−x)−1=(1+x+x2+ [symbol] ) is the familiar geometric series from calculus; alternately, this function has an infinite expansion: f(x)=x2+4x3+10x4+20x5+35x6+55x7+78x8+102x9+125x10+145x11+160x12+170x13+176x14+179x15+180x16+180x17+180x18+180x19+180x20+ [symbol] f(x)=x2+4x3+10x4+20x5+35x6+55x7+78x8+102x9+125x10+145x11+160x12+170x13+176x14+179x15+180x16+180x17+180x18+180x19+180x 20+ [symbol] .We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ [symbol] )(1+x2+x4+ [symbol] )(1+x+x2+x3+ [symbol] )=x(1+(x2)+(x2)2+(x2)3+ [symbol] )(1+(x2)+(x2)2+(x2)3+ [symbol] )11−x=x(1−x2)2(1−x). (x+x3+x5+ [symbol] )(1+x2+x4+ [symbol] )(1+x+x2+x3+ [symbol] )=x(1+(x2)+(x2)2+(x2)3+ [symbol] )(1+(x2)+(x2)2+(x2)3+ [symbol] )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β}·λ^{˜}_{β′}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈ij k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=lim [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: [symbol] −→Fᵢ^{∂}→Fₗ₋₁^{∂}→ [symbol] −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: [symbol] −→Fᵢ^{∂}→Fᵢ₋₁^{∂}→ [symbol] −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞ 19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm: Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35,16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X^{g}↓_{α}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let ∧ be a transverse measure for (V,F), the category whose objects are pairs (p,A), where p is a group and A is a left p-module. A map f: (p, A)→(π, B) consists of homomorphisms f₁: p'π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ a₁″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} [symbol] +m if r>0, {(−m)+(−m)+^{(-r)} [symbol] +(−m) if r<0, {0 if r=0, from the group axioms it can be easily deduced that the previous map defines a Z action on M, in other words, every Abelian group is a Z module, the converse is also true, if (M, +) is a Z module the for any r >0 in Z one has r=1+1+^{(r)} [symbol] +1, and thus rm=(1+ [symbol] +1)m=1m+^{(r)} [symbol] +1m=m+^{(r)} [symbol] +m, and for r<0 one has r=(−1)+thus Z modules are precisely Abelian groups, let R be a ring, define an action of R on (R, +) by r*s:=rs, by the ring laws this action makes R into an R module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=α(v) extending to xⁿ*v:=αⁿ(v)=α(α(⁽ⁿ⁾ [symbol] α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • ,iₙ, 0, • • • ). The admissible monomials Sq^{I′}∈a correspond to sequences of integers (i′₁, i′₂, • • • , i′n, 0, • • • ) where i′ₖ≥2i′ₖ₊₁ and i′ₙ≥1. It remains only to set up a one-to-one correspondence between sequences of non-negative integers l and admissible sequences l′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences by insisting that Iₖ be sent to and that the map be additive (with respect to coordinate-wise addition). Then if I=(i₁, • • • , iₙ, 0, • • • )→I′=(i′ᵢ, • • • , i′ₙ, 0, • • • ) ε^{I} and Sq^{I′} have the same degree and we have iₖ=iₖ+2iₖ₊₁+ • • • +2^{n-k} iₙ. Solving for iₖ in terms of we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*″. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let π be a normal subgroup of p and let y→p. Let g:(π,A,K)→(η,A,K) be the automorphism determined by y. Then the image H*ₚ(K;A)→H*ₙ(K;A) is pointwise invariant under the automorphism g.* Proof. let f: (p,A,K)→(p,A,K) be the inner automorphism determined by y. Then by 1.2, the following diagram is commutative H*ₚ(K;A)^{f}*→H*ₚ(K;A)→H*_{π}(K;A); and H*ₚ(K;A)→H*_{π}(K;A)^{g}*→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face oft is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group n, we can always construct a π-free acyclic simplicial complex W. Proof. We give π the discrete topology and form the infinite repeated join W=π*π*π . . . . This repeated join is a simplicial complex. Taking the join of a complex with a point gives us a contractible space. Any cycle in W must lie in a finite repeated join W′. Such a cycle is homologous to zero in W′*π. Therefore, W is acyclic. We make i t act on W as follows:π acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivarlant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)“. An element of the K-group of the parameter space groupoid of the manifold M through the associated C*-algebra C*ᵣ(G): random dilution of random matrices H_{N}=U_{N} F_{N} U⁺_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, Nϕ as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁ (n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From Math World—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i √ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ, of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0, ∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,∞]. We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cᵢ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure processing powerplant; or [heat a heater fluid]. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). The product of an element; or in the product of two elements stationary; and independent increments elements of 1-1 structure of 1-1 structure of the Dual Algebra; Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p₁)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β}·λ^{˜}_{β′}; the product of an element; or in the product of two elements stationary; and independent increments elements of 1-1 structure; industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure of the Dual Algebra; processing powerplant; or [heat a heater fluid]. Target of temperature ranges contribution specific heat the logarithm of the pre-exponential factors: high modulus thermoset docking; low modulus thermoset docking; solid phase docking; critical pressure per; triple point pϕ; compressible liquid; liquid phase; vapour Tϕ; supercritical fluid docking matter; triple point; gaseous phase; or critical temperature T_{cr}. We add elements target of temperature ranges contribution specific heat the logarithm of the pre-exponential factors: high modulus thermoset docking; low modulus thermoset docking; solid phase docking; critical pressure p_{cr}; triple point pϕ; compressible liquid; liquid phase; vapour Tϕk; supercritical fluid docking matter; triple point; gaseous phase; or critical temperature T_{cr} with the equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|cmesh(τn) [symbol] , ∀(n)≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Where [symbol] ₙ are the approximations to y to that our system of equations orders in the number of terms 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field the application of the calculus to vectors which gives the velocity of an element of a fluid flow at position x and ratio [symbol] the flow speed modulation q is steady-state properties p of the system, the partial derivative with respect to time is zero the length of the flow velocity vector₁ q=∥μ∥ the scalar field triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0, 1, 0, 1, 4, 1, 4, 1, 3, 0, . . . ]. Let pₙ be the number of positive and qₙ the number of negative terms in the first n terms of a simply rearranged alternating harmonic series, then the result to interest us is that the rearrangement converges if and only if a=lim_{n→∞}pₙ/qₙ exists, in which case the sum is 1n 2+½ 1n a. There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{”})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate p(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈λ, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; rhenium continuum a lift a normal k-smoothing isometries vacuum theory chamber mechanics, molecular distillation, refrigeration process, and fractional chemistry (hyper-) superset periodic elements are exactly solutions of a matrix equation where Q^{T} is the transpose of Q and I is the identity matrix M^{→} tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements are exactly solutions of a matrix equation where Q^{T} is the transpose of Q and I is the identity matrix M^{→} potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; etc. 1-1 structure of the Dual Algebra the monomials E₁ in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; etc. 1-1 structure of the Dual Algebra the monomials E₁ in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field in the product of an element; or in the product of two elements stationary; and independent increments elements of 1-1 structure. The generating function thus F(x). Let F:R→R be the function defined by setting F(x):=f(x) for x∈[0,1] and F(x):=0 for x [0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤Pn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). The product of an element; or in the product of two elements stationary; and independent increments elements of 1-1 structure of the Dual Algebra. Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β}·λ^{˜}_{β′}; the product of an element; or in the product of two elements stationary; and independent increments elements of 1-1 structure n=2 elements, or docking matter. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ, −m≤i≤n} where tᵢ, −m≤i≤n, is some fixed finite sequence in {1, 2, . . . , k}. Let E denote the o-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. The product of an element; or in the product of two elements stationary; and independent increments elements of 1-1 structure n=2 elements, or docking matter e.g. independent, and stationary increments allotropes of carbon nanotubes alloys, and elements semiprecious minerals. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; etc. 1-1 structure of the Dual Algebra the monomials ε^{I} in a′ correspond in a one-to-one way with sequences of non-negative integers (i₁, i₂, • • • , 0, • • • ) we now find the diagonal in a* every three-dimensional vector is written as a linear combination of the three mathematics vector calculus differentiation and integration over the vector field. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} polymeric gelling; etc. 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field in the product of an element; or in the product of two elements stationary; and independent increments elements of 1-1 structure. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate a-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). The product of an element; or in the product of two elements stationary; and independent increments elements of 1-1 structure of the Dual Algebra. Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β}·λ^{˜}_{β′}; the product of an element; or in the product of two elements stationary; and independent increments elements of 1-1 structure n=2 elements, or docking matter. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ, −m≤i≤n} where tᵢ, −m≤i≤n, is some fixed finite sequence in {1, 2, . . . , k}. Let E denote the o-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. The product of an element; or in the product of two elements stationary; and independent increments elements of 1-1 structure n=2 elements, or docking matter e.g. independent, and stationary increments allotropes of carbon nanotubes alloys, and elements semiprecious minerals. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=Co(X) we take actions α:G→Homeo(X). Formal Dirichlet generating series number A spaces two coordinates position normal vector the solution set of A finite system Ax b of m inequalities with n variables A is m×n matrix is convex, A set of this type is three dimensions in steady-state motion with a, p, and c k small, is written with equations in terms of load factor as (n-cos Θ) transport properties generating series is three dimensions spinneret g-units of 1-1. structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion silica sand grains grounded hyper-, ultra-, super-, or fine-particles continuous suspended, and 3-dimensional volume continuously vertically, or horizontally drawn, and driven; or particle matter physics: (hyper-) superset periodic elements Q are exactly solutions of a matrix equation where Q^{T} is the transpose of Q and I is the identity matrix M^{→} continuously projected fracturing silica sand grains hyper-, ultra-, super-, or fine-chards of needles continuous suspended, and 3-dimensional volume continuously vertically, or horizontally drawn, and driven mixtures. The product of an element; or in the product of two elements stationary; and independent increments elements of 1-1 structure n=2 elements dynamics of variable change complexification*, or two times the momentum is characterized by 4 real numbers p^{μ}, the matrix pₐₐ_{^{⋅}}=p_{μ}(σ^{μ})ₐₐ_{^{⋅}} is Hermitian, which implies that λ^{˜}=λ* is the complex conjugate of λ connected impellers; turbo-shaft; turbo-fan; turbo-fluid; turbo-jet; or fluid-propulsion negative [symbol] -axis y:[A, b]→S together with a subdivision a=τ₀<τ₁<τ₂<∧<τₙ b of [A, b] contain 1. We show that it is sufficient to treat the case V=K. 2. The chain complex C*^{Trias}(Trias(K)) splits into the direct sum of chain complexes C*(u), one for each element u in P_{m,m}≥1.3. The chain complex C*(u) is shown to be the cell complex of a simplicial set X(u). 4. The space X(u) is shown to be the join of spaces X(v) for certain particular elements v in Pₘ. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B*B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v >0 with v not a scalar multiple of μ. Then μ=(μ−v)+v which is a convex linear combination of states (once the terms have been normalized) using the fact that ∥μ−v∥=lim(μ−v)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−T)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials E₁ in a′ correspond in a one-to-one way with sequences of non-negative integers (i₁, i₂, • • • , iₙ, 0, • • • ) we now find the diagonal in a* the equivalence condition. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n−cos Θ) transport properties generating series is three dimensions spinneret g-units of 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion optical class element silicon dioxide SiO₂; cobalt Co; feldspar AT₄O₈; zirconium ZrSiO₄; and selenium Se “glass” beads; optically filtered; elemental colors; transparent; translucent (natural); (hyper-) superset periodic elements Q are exactly solutions of a matrix equation where Q^{T} is the transpose of Q and I is the identity matrix M^{→} elements; colored dyes; and lakes. The product of an element; or in the product of two elements stationary; and independent increments elements of 1-1 structure n=2 elements dynamics of variable change complexification*, or two times the momentum is characterized by 4 real numbers p^{μ}, the matrix pₐₐ_{^{⋅}}=p_{μ}(σ^{μ})ₐₐ_{^{⋅}} is Hermitian, which implies that λ^{˜}=λ* is the complex conjugate of λ connected impellers; turbo-shaft; turbo-fan; turbo-fluid; turbo-jet; or fluid-propulsion negative [symbol] -axis y:[A, b]→S together with a subdivision a=τ₀<τ₁<τ₂<∧<τₙ=b of [A, b] contain 1. We show that it is sufficient to treat the case V=K. 2. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n-cos Θ) transport properties generating series is three dimensions spinneret g-units 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size grains silica sand polymeric gelling above, and below zero transition successively broken orthogonal ligands having the intrinsic property in quantities of Young's modulus of elastomericity, and tensile strength polymeric gelling cement. The product of an element; or in the product of two elements stationary; and independent increments elements of 1-1 structure n=2 elements, or docking matter natural base in silica route number of bonds geometric on surface area of hyper-, ultra-, super-, fine-, course fine-, and course-size discretion optical class element silicon dioxide SiO₂; cobalt Co; feldspar AT₄O₈; zirconium ZrSiO₄; and selenium Se “glass” beads; optically filtered; elemental colors; transparent; translucent (natural); (hyper-) superset periodic elements Q are exactly solutions of a matrix equation where Q^{T} is the transpose of Q and I is the identity matrix M^{→} elements; colored dyes; and lakes. A semiprime is any integer normalized function of atmospheric, temperature and pressure correction value of number n is continued as phase factor for any complex number written in polar form (such as re^{iΘ}), the phase factor is the complex exponential factor (e^{iΘ}) the motion is uniform circular motion we incorporate the periodic set c equal to e so they are too fortuitously the base of the natural logarithm plane. The normalization function of a different action the motion of our system of equations eigenfunctions the principal of eigenvalues of arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional μ ion a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹, μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] (v_{λ},w_{λ} [symbol] (31) converges (equivalently the completion of the ordinary direct sum). If for each A we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A‥(33); [symbol] v, π(a*)w [symbol] =0 ∀v∈K,a∈A⇔(34); π(a*)w∈K^{⊥} ∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where π is a representation of A on H and U is a unitary representation of G such that π(αx(a))=U×π(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))U×v where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors ϕ:F→HomS (*, X(F)) such that (1) ϕ(spec(k)):F (spec(k))→HomS (spec(k), X(F)) is a bijection for every algebraically closed field k, (2) For any S-scheme Y and any natural transformation ψ:F→HomS (*, Y), there is a unique natural transformation Π:HomS (*, X(F)) HomS (*, Y) such that ψ=Π∘ϕ. These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A, μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A,μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰ (0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. S₀ we need more hypotheses. Theorem 2.15. Let A be a *-Banach algebra with identity and let μ be a positive linear functional on A. Then μ is continuous and ∥μ|=μ(1). Corollary 2.16. Let A be a *-normed algebra with identity and let μ be a continuous positive linear functional on A. Then ∥μ|=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1−a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have pμ(1) ∥a∥≥|μ(a)|. For arbitrary a, |μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μ_{b} is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. S₀ let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence U is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in N. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A, μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β, ⁻α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤|f+it∥²=∥f∥²+t² (36) but the LHS is equal to |r+i(s+t)|²=r²+s²+2st +t² (37) and subtracting t² from both sides gives a contradiction unless s=0. Now, if f≥0 we have ∥f−∥f∥∥≤∥f∥, hence |μ(f)−∥f∥=|μ(f−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥σ(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. |μ(a)|²≤∥μ∥μ(a*a). Proof. Write μ(a*)=limμ(a*e_{λ})=lim [symbol] a,e_{λ} [symbol] _{μ} (39) and since we know we have an inner product, this is equal to lim [symbol] e_{λ}, a [symbol] ⁻=limμ(e*_{λ}a)⁻=μ(a)⁻ (40) as desired. Next, write |μ(a)|²=lim |μ(e_{λ}a)|²=lim| [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)*(a+λ1))=μ(a*a)+λμ^{˜}(a)+λμ(a)+|λ|²∥μ∥ (43) which is greater than or equal to μ(a*a)−2|λ∥μ(a)|+|λ|²∥μ∥≥μ(a*a)−2|λ∥|μ∥^{1/2}μ(a*a)^{1/2}+|λ|²∥μ∥=(μ(a*a)^{1/2}−|λ∥|μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict π to A, then v remains a cyclic vector for π|_{A}. Proof. Choose a self-adjoint sequence aₙ with ∥aₙ∥≤1 so that μ(aₙ)↑∥μ∥. Then ∥π(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e^{x})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,v be positive linear functionals. Then μ≥v if μ−v≤0; we say that v is subordinate to μ. Given μ, let (π,H,v) be the corresponding GNS representation. Consider End_{A}(H). Let T∈End_{A}(H) be a positive operator smaller than the identity and set v(a)=v_{T}(a)= [symbol] π(a)Tv,v [symbol] (47). (Then T is the Radon-Nikodym derivative of v with respect to μ.) We compute that v(a*a)= [symbol] π(a*a)Tv,v [symbol] = [symbol] (T^{1/2}π(a)v,T^{1/2}π(a)v [symbol] ≥0 (48) so v is positive. Similarly, μ−v is positive. Moreover, if v_{T}=v_{S} then T=S (by nondegeneracy). Conversely, suppose visa positive linear functional with μ≥v≥0, we want to show that v=v_{T} for some T∈End_{A}(H). For a,b∈A we have |v(b*a)|≤v(a*a)^{1/2}v(b*b)^{1/2}≤μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that v(b*a)= [symbol] π(a)v,T*π(b)v [symbol] (51). Since v≥0 we have T≥0. Since v≤μ, we have T≤I. To show that T∈End_{A}(H), write [symbol] π(c)Tπ(a)v,π(b)v [symbol] = [symbol] Tπ(a)v,π(C*b)v [symbol] (52)=v((C*b)*a) (53)=v(b*ca) (54)= [symbol] π(c)π(a)v,T*π(b)v [symbol] (55) which gives π(c)T=Tπ(c) by density. We can encapsulate our work above in the following. Proposition 2.36. The map T→v_{T} is a bijection between {T∈End_{A}(H): 0≤T≤I} and {v: μ≥v≥0}. Definition A positive linear functional is pure if whenever μ≥v≥0 then v =rμ for some r∈[0,1]. Theorem 2.37. Let μ be a positive linear functional. Then μ is pure iff the associated GNS representation (π,H,v) is irreducible. Proof. If μ is not pure, there is μ≥v≥0 such that v is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then vₚ is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v >0 with v not a scalar multiple of μ. Then μ=(μ−v)+v which is a convex linear combination of states (once the terms have been normalized) using the fact that ∥μ−v∥=lim(μ−v)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥=∥π^{U}(a)∥=∥a∥ (where π^{U} is the universal representation). Proof. Let a∈A be self-adjoint. Then there exists ρ∈S(A) with |ρ(a)|=∥a∥. Let Sₑ(A) be the set of extreme (pure) states of A. Suppose that there exists c such that ∥μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that ∥μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Sₑ(A) together with 0. 208 C*-algebras Marc Rieffel Notes by Qiaochu Yuan Spring 2013. ‘Differential form’ continued by the refrigeration component of U expanded, and cooled asymmetry condensations, moisture, and dew-point program temperature steady-state integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is an irrational number for which any finite pattern of numbers occurs with the expected limiting frequency in the expansion in a given integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 (cf. D. Ruelle and D. Sullivan. Currents, flows and diffeomorphisms. Topology 14) of sub-plasma (base), or expansion in a given integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 (cf. D. Ruelle and D. Sullivan. Currents, flows and diffeomorphisms. Topology 14) of atmospheric gases there is an element g′∈A′ such that g−g′ is decomposable (all bases), Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). Cooling, and energy transmittance τ condensation gases in the direction of our affine factors (cf. D. Ruelle and D. Sullivan. Currents, flows and diffeomorphisms. Topology 14) the thermal system in relativity our affine S to sets integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 condensation “super-fluid” refrigeration particles plate, and rod connectivity conductance, and transfer gives us cooling, and energy transmittance t condensation gases in the direction of our affine factors (cf. D. Ruelle and D. Sullivan. Currents, flows and diffeomorphisms. Topology 14). Cylindrical hydraulic integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 outflows; G-invariant system elliptical moisture collector; and G-invariant system circular moisture collector two straight series, and parallel conductors of infinite length continuous Unit circle in complex dynamics Julia set of discrete nonlinear dynamical system with evolution function f0(x)=x2 is a unit circle dynamical systems angle measure circle group Pythagorean trigonometric identity unit disk, unit sphere, unit hyperbola, unit square and [symbol] transform. In mathematics, a unit circle is a circle with a radius of one. Frequently, especially in trigonometry, the unit circle is the circle of radius one centered at the origin 0, 0 in the Cartesian coordinate system in the Euclidean plane. The unit circle is often denoted S¹, the generalization to higher dimensions is the unit sphere. If x, y is a point on the unit circle, then |x| and |y| are the lengths of the legs of a right triangle whose hypotenuse has length 1. Thus, by the Pythagorean theorem, x and y satisfy the equation x²+y²=1. Since x²=−x² for all x, and since the reflection of any point on the unit circle disk nearby the x- or y-axis is also on the unit circle, the above equation holds for all points x, y on the unit circle, not only those in the first quadrant. The interior of the unit circle is called the open unit disk, while the interior of the unit circle combined with the unit circle itself is called the closed unit disk. One may also use other notions of distance to define other unit circles, on mathematical norms. The complex plane 2 trigonometric functions on the unit circle 3 circle group 4 complex dynamics in the complex plane the unit circle unit of complex numbers, the set of complex numbers z of the form z=e^{it}=cos(t)+i sin(t) for all t, expand upon Euler's formula the complex plane 2 trigonometric functions on the unit circle 3 circle group 4 complex dynamics in the complex plane the unit circle unit of complex numbers, the set of complex numbers z of the form z=e^{it}=cos(t)+i sin(t) for all t, the relation of Euler's formula, as phase factor in quantum mechanics; and cylindrical hydraulic integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 outflows; condensations gives us an extra action mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, quadrupoles correspond terminus equivalence A×B Cartesian Product (set of ordered pairs from A and B) {1,2}×{3,4}={(1,3), (1,4), (2,3), (2,4)} to covariant representations of a given C*-dynamical system cylindrical hydraulic actuation mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, (cf. D. Ruelle and D. Sullivan. Currents, flows and diffeomorphisms. Topology 14). Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [τₙ,τₙ₊₁] for an ideal H of R the following are equivalent: (a) H is semiprime; (b) I²⊆H implies I⊆H for all left (right/two-sided) ideals I; (c) aRa⊆H implies that a∈H. Correspond to covariant representations of a given C*-dynamical system cylindrical hydraulic actuation mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, (cf. D. Ruelle and D. Sullivan. Currents, flows and diffeomorphisms. Topology 14). Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). Semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Bin(n,p) binomial distribution f(k)=ₙCₖ p^{k}(1−p)^{n-k} pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of atmospheric, temperature and pressure correction the value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁(n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A )⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written {x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿk)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎^{I}(n)(n+1) . . . (n+i−1)i!=(−1)i(n+i−1)!i!(n−1)!=(−1)i(n+i−1i)=(−1)i(n+i −1n−1). (−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1). Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi =0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+179x15+180x16+180x17+180x18+180x19+180x20+.f(x)=x2+4x3+10x4+20x5+35x6+55x7+78x8+102x9+125x10+145x11+160x12+170x13+176x14+179x15+180x16+180x17+180x18+180x19+180x20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x =x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β}·λ^{˜}_{β′}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and c(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol Eli k as A (B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35,16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X ^{g}↓_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let ∧ be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z action on M, in other words, every Abelian group is a Z module, the converse is also true, if (M, +) is a Z module the for any r >0 in Z one has r=1+1+^{(r)} . . . +1, and thus rm=(1+ [symbol] +1)m=1m+^{(r)} . . . +1m=m+^{(r)} . . . +m, and for r<0 one has r=(−1)+thus Z modules are precisely Abelian groups, let R be a ring, define an action of R on (R, +) by r*s:=rs, by the ring laws this action makes R into an R module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=α(v) extending to xⁿ*v:=αⁿ(v)=α(α(⁽ⁿ⁾ . . . α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • ,iₙ, 0, • • • ). The admissible monomials Sq^{I′}∈a correspond to sequences of integers (i′₁, i′₂, • • • , i′n, 0, • • • ) where i′ₖ≥2i′ₖ₊₁ and i′ₙ≥1. It remains only to set up a one-to-one correspondence between sequences of non-negative integers l and admissible sequences l′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences by insisting that Iₖ be sent to and that the map be additive (with respect to coordinate-wise addition). Then if I=(i₁, • • • , iₙ, 0, • • • )→I′=(i′ᵢ, • • • , i′ₙ, 0, • • • ) ε^{I} and Sq^{I′} have the same degree and we have iₖ=iₖ+2iₖ₊₁+ • • • +2^{n-k} iₙ. Solving for iₖ in terms of we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*″. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let π be a normal subgroup of p and let y→p. Let g:(π,A,K)→(η,A,K) be the automorphism determined by y. Then the image H*ₚ(K;A)→H*ₙ(K;A) is pointwise invariant under the automorphism g.* Proof. let f: (p,A,K)→(p,A,K) be the inner automorphism determined by y. Then by 1.2, the following diagram is commutative H*ₚ(K;A)^{f}*→H*ₚ(K;A)→H*_{π}(K;A); and H*ₚ(K;A)→H*_{π}(K;A)^{g}*→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face oft is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group n, we can always construct a π-free acyclic simplicial complex W. Proof. We give π the discrete topology and form the infinite repeated join W=π*π*π . . . . This repeated join is a simplicial complex. Taking the join of a complex with a point gives us a contractible space. Any cycle in W must lie in a finite repeated join W′. Such a cycle is homologous to zero in W′·π. Therefore, W is acyclic. We make π act on W as follows:π acts by left multiplication on each factor n of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(n, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivarlant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)“. An element of the K-group of the parameter space groupoid of the manifold M through the associated C*-algebra C*ᵣ(G): random dilution of random matrices H_{N}=U_{N} F_{N} U^{t}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , {n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁(n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram !Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] z+1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k≤d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cᵢ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0, ∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] z=f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δn+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] z=f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(|+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0, ∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of 1, can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, d₁W). Two cobordisms (W, M₀, f₀, M₁, f₁) and (W′,M₀, f′₀, M′₁, f′₁) over M₀ are diffeomorphic relative M₀ if there is an orientation preserving diffeomorphism F:W→W′ with F∘f₀=f₀′. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12) τM₀^{f0}→∂₀Wⁱ⁰→W)∈Wh(π₁(W)) under the isomorphism (i₀∘f₀)*: Wh(π₁(M₀))≅→Wh(πᵢ(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H·(M)≅H·(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i =0, 1 be two embedded disjoint disks. Put W=M (int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ¹. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0} Uᵢₒ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h_{|Dn0×(0)}=id, h_{|∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of r given by coning f yields only a homeomorphism f⁻ and not a diffeomorphism even if we start with a diffeomorphism f. The map r is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. S₀ the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself.

An example is the “greater than” relation (x >y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation ˜ on a set S is called quasi-reflexive if every element that is related to some element is also related to itself, formally: ∀x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure of a binary relation ^{˜} on a set S is the smallest reflexive relation on S that is a superset of equivalently, it is the union of ^{˜} and the identity relation on S, formally: (≅)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ˜, formally: (\tilde{≠})=(^{˜})\(=). That is, it is equivalent to except for where x˜x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}αₑₓₚ(_{τ}x)∫G f(x)αₓ(b)dx−∫G f(x)αₓ(b)dx/τ=lim_{τ→0}1/τ(∫f(x)αₑₓₚ(τx)x(b)−∫f(x)αₓ(b)dx)=lim_{τ→0}∫(αₑₓₚ(τX)f)(x)−f(x)/τaₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Then we have (modeled as x=A*s where the ‘mixing matrix’ is invertible and the n×1 vector s=[s₁, . . . sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (Dₓ(b))ₙ=Dₓ(bₙ) where bₙ is the n^{th} isotypic component. Let e₁, . . . e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{ρ}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0} Σₙ e^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R) K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈A, then ka−aeλk2=ka(1−eλ)k2=k(1−eλ)a*a(1−eλ)k but since a∈A we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax b of m inequalities with n variables A is m×n matrix is convex, A set of this type is three dimensions in steady-state motion with α, β, and ϕ small, is written with equations in terms of load factor as (n-cos θ) transport properties generating series is three dimensions spinneret g-units of 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion silica sand grains grounded hyper-, ultra-, super-, or fine-particles continuous suspended, and 3-dimensional volume continuously vertically, or horizontally drawn, and driven; or silica sand particles hyper-, ultra-, super-, or fine-fractured chards of needles continuous suspended, and 3-dimensional volume continuously vertically, or horizontally drawn, and driven. The anthracite high carbon count coal dust slimes (less than, or greater than 0-0.2 mm); or calcium carbonate CaCO₃ continuous particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion polymeric “black” beads; or “slake glass white” beads. The product of an element; or in the product of two elements stationary; and independent increments elements of 1-1 structure n=2 elements, or docking matter. Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex T of K′ is contained in a set of the form f⁻¹(Uⁱ). Then the minimal carrier of r consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties generating series is three dimensions spinneret g-units of 1-1 structure of the Dual Algebra the monomials ε^{I} in a′ correspond in a one-to-one way with sequences of non-negative integers (i₁, i₂, • • • ,iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion coal, and silica sand “black” beads independent, and stationary increments Anthracite coal bitumen; petrochemical raw crude oil pavement pellet product “high carbon count coal dust slimes cemented tar mixtures”.

The product of an element; or in the product of two elements stationary; and independent increments elements of 1-1 structure n=2 elements, or docking matter dynamics of variable change complexification*, or two times twice the momentum is characterized by 4 real numbers p^{μ}, the matrix pₐₐ_{^{⋅}}=p_{μ}(σ^{μ})ₐₐ_{^{⋅}} is Hermitian, which implies that λ^{˜}=λ* is the complex connected impellers negative z-axis impellers y:[A, b]→S together with a subdivision a=τ₀<τ₁<τ₂<∧<τₙ=b of [A, b] Dirichlet generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points in number theory the sum of their Dirichlet series arrangement (A,w). Compression member rotary-screw; centrifugal; or turbo-jet impeller basic; volute; or o-ring seal closed casing; or open fluid dynamics advanced casing (without seal) s structural elements that are subjected to axial compressive forces only are called columns. Columns are subjected to axial loads thru the centroid stress: the stress in the column cross-section can be calculated as f=P/A where f, is assumed to be uniform over the entire cross-section. The stress-state will be non-uniform due to: accidental eccentricity of loading with respect to centroid; member rotary-screw; centrifugal; or turbo-jet impeller basic; volute; or o-ring seal closed casing; or open fluid dynamics advanced casing (without seal) out-of-straightness (crookedness); or residual stresses in the member rotary-screw; centrifugal; or turbo-jet impeller basic; volute; or o-ring seal closed casing; or open fluid dynamics advanced casing (without seal) cross-section due to fabrication processes. Accidental eccentricity and member rotary-screw; centrifugal; or turbo-jet impeller basic; volute; or o-ring seal closed casing; or open fluid dynamics advanced casing (without seal) out-of-straightness can cause bending moments in the member rotary-screw; centrifugal; or turbo-jet impeller basic; volute; or o-ring seal closed casing; or open fluid dynamics advanced casing (without seal). However, these are secondary and are usually ignored. Bending moments cannot be neglected if they are acting on the member rotary-screw; centrifugal; or turbo-jet impeller basic; volute; or o-ring seal closed casing; or open fluid dynamics advanced casing (without seal). Members with axial compression and bending moment are called beam-columns. Column buckling consider a long slender compression member rotary-screw; centrifugal; or turbo-jet impeller basic; volute; or o-ring seal closed casing; or open fluid dynamics advanced casing (without seal). If an axial load P is applied and increased slowly, it will ultimately reach a value P_{cr} that will cause buckling of the column. P_{cr} is called the critical buckling load of the column. We correct metallurgy defects by employing advanced die-cast mold and foundry procedure with state-of-the-art machining techniques. We further reduce metallurgy defect with two state-of-the-art test generators 1. Advanced foundry precision tool and die-cast mold refinement technique; and 2. Synthesized organigenic gases the numerical solution X⁽ⁿ⁾ converges strongly to X with order [symbol] >0 if there exists a constant c>0 such that E|X_{T}−X⁽ⁿ⁾ _{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of higher aggregation sinterization (oxygen, gases, and elements). Sintering is the process of compacting and forming a solid mass of matter by specific heat, and pressure without melting it to the point of liquefaction. Smelterization is the smelting process of applying specific heat, and pressure to ore in order to melt out a base metal extractive metallurgy to extract metal from their ore, base metal; or raw iron ore. Higher aggregation sinterization (oxygen, gases, and elements) atoms and intramolecular hybridization molecules yield wrought iron; or high purity metal. Particle matter physics: (hyper-) superset periodic elements Q are exactly solutions of a matrix equation where Q^{T} is the transpose of Q and I is the identity matrix M^{→} molecular n-layered strengthened tool-metal; and high-carbon percentage mixture allotropes of carbon nanotubes CNT's structure of alloy lower defect properties. An element of the K-group of the parameter space groupoid of the manifold M through the associated C*-algebra C*ᵣ(G): random dilution of random matrices H_{N}=U_{N} F_{N} U^{t}N, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, Leibniz's rule for differentiation under the integral sign ∫, for an integral of the form ₐ₍ₓ₎∫^{b(x)}f(x,t) dt, where −∞<a(x), b(x)<∞ the derivative of this integral is expressible as d/dx(ₐ₍ₓ₎∫_{b(x)} f(x,t) d/dx(dt)=f(x, b(x))·d/dx b(x)−f(x, a(x))·d/dx a(x)+a(x)∫b(x) ∂/∂x f(x, t) dt, where the partial derivative indicates that inside the integral, only the variation of f(x, t) with x is considered in taking the derivative. Notice that if a(x) and b(x) are constants rather than functions of x, we have a special case of Leibniz's rule: d/dx (a∫b f(x, t) dt)=ₐ∫^{b} ∂/∂x f(x, t) dt. Thus under certain conditions, one may interchange the integral and partial differential operators. This important result is particularly useful in the differentiation of integral transforms. A moment generating function in probability theory, a variation of the Laplace transform, which can be differentiated to generate the moments of a random variable. Whether Leibniz's integral rule applies is essentially a question about the interchange of limits. Theorem. Let f(x, t) be a function such that both f(x, t) and its partial derivative fₓ(x, t) are continuous in t and x in some region of the (x, t)-plane, including a(x)≤t≤b(x), x₀≤x≤x₁. Also suppose that the functions a(x) and b(x) are both continuous and both have continuous derivatives for x₀≤x≤x₁. Then, for x₀≤x≤x₁, d/dx(a(x)∫b(x) f(x,t) dt)=f(x, b(x))·d/dx b(x)−f(x, a(x))·d/dx a(x)+a(x)∫b(x) ∂/∂x f(x, t) dt. This formula is the general form of the Leibniz integral rule and can be derived using the fundamental theorem of calculus. The (first) fundamental theorem of calculus is just the particular case of the above formula where a(x)=a, a constant, b(x)=x, and f(x, t)=f(t). If both upper, and lower limits are taken as constants, then the formula takes the shape of an operator equation: It∂x=∂xIt where ∂x is the partial derivative with respect to x and It is the integral operator with respect to t over a fixed interval. That is, it is related to the symmetry of second derivatives, but involving integrals as well as derivatives. This case is also known as the Leibniz integral rule. The following three basic theorems on the interchange of limits are essentially equivalent: the interchange of a derivative and an integral (differentiation under the integral sign ∫; i.e., Leibniz integral rule); the change of order of partial derivatives; the change of order of integration (integration under the integral sign ∫; i.e., Fubini's theorem). Continuity of equation orientated equivalence ±poles of the function, are continued as a continuous equivalence ±poles of the function in a Hilbert space is a vector space H with an inner product [symbol] f, g [symbol] such that the norm defined by |f|=√ [symbol] f, f [symbol] turns H into a complete metric space. If the metric defined by the norm is not complete, then H is instead known as an inner product space. Sampled functions leads to a sampling theorem for finite sequences of the sample paths in Hilbert spaces include 1. The real numbers Rⁿ with [symbol] v, u [symbol] the vector dot product of v and u. 2. The complex numbers Cⁿ with [symbol] v, u [symbol] the vector dot product of v and the complex conjugate of u. Sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}f(x) g (x) d x, and nondegenerate 2-form structure in potential theory complex analysis proves invaluable mathematical physics expressions an infinite potential one {1×1 column} quadrupole, or equivalence their incidence of the Euclidean space are shared with an affine geometry, the complete metric space property, and the number in base point k-face element plane the fundamental group we consider the category of pointed topological spaces, i.e. topological spaces with distinguished points. Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [τₙ,τₙ₊₁] for an ideal H of R the following are equivalent: (a) H is semiprime; (b) I²⊆H implies I⊆H for all left (right/two-sided) ideals I; (c) aRa⊆H implies that a∈H. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}f(x) g (x) d x, nondegenerate 2-form structure in potential theory complex analysis proves invaluable mathematical physics expressions an infinite potential one {1×1 column} quadrupole, or equivalence capillary feeder and collector of exhaled carbon dioxide CO₂, equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, Nϕ as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Higher aggregation atoms sinterization (oxygen, gases, and elements) atoms and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of capillary feeder and collector of higher aggregation sinterization (oxygen, gases, and elements) the flow speed modulation q is steady-state properties p of the system, the partial derivative with respect to time is zero the length of the flow velocity vector₁ q=∥μ∥ a second scalar field at program temperature fluid triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0, 1, 0, 1, 4, 1, 4, 1, 3, 0, . . . ], let pₙ be the number of positive and qₙ the number of negative terms in the first n terms of a simply rearranged alternating harmonic series, then the result to interest us is that the rearrangement converges if and only if a=lim_{n→∞}pₙ/qₙ exists, in which case the sum is 1n 2+½ 1n. Larmor the zero module {0} is injective. M^{→}| is maximized when the rotational frequency ω is equal to the Larmor free precession frequency ω₀= [symbol] |B₀^{→}ₙ₌₀| (Our detuning ω−ω₀≈0). Free Larmor precession, which occurs for B^{→}=B₀^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. r=B^{→}=B₀^{→}ₙ₌₀: and B^{→}ₑ semigroup, a semidirect product given a group G with identity element e, |B^{→}ₑ D 4==• . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i, j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e1(T)h+e2(T)h2+ [symbol] +em(T)hm+O(hm+1)): to |ZTh−Ef(XT)|≤O(hm+1) A is the inductive limit of finite-dimensional algebras; it is said to be approximately finite (or AF). 2) (K0(A), K0(A)+)=(Z2, {(a, b); 1+√5/2 a+b≥0}). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4== . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{1,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m >0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m >0, or spherical d can be resolved into a sum of two vectors, one parallel and one perpendicular to the axis L, that is, d=d_{L}+d_{⊥}, d_{L}=(d·S)S, d_{⊥}=d−d_{L}. In this case, the rigid motion takes the form D(x)=(A(x)+d_{⊥})+d_{L}. Now, the orientation preserving rigid motion D′*=A(x)+d_{⊥} transforms all the points of R³ so that they remain in planes perpendicular to L. For a rigid motion of this type there is a unique point c in the plane P perpendicular to L through 0, such that D*(C)=A(C)+d_{⊥}=C. The point C can be calculated as C =[I−A]⁻¹d_{⊥}, because d_{⊥} does not have a component in the direction of the axis of A. A rigid motion D′* with a fixed point must be a rotation of around the axis L_{c} through the point c. Therefore, the rigid motion D(x)=D*(x)+d_{L}, consists of a rotation about the line L_{c} followed by a translation by the vector d_{L} in the direction of the line L_{c}. Conclusion: every rigid motion of R³ is the result of a rotation of R³ about a line L_{c} followed by a translation in the direction of the line.

The combination of a rotation about a line and translation along the line is called a helical motion. Computing a point on the helical axis A point C on the helical axis satisfies the equation: D*(C)=A(C)+d_{⊥}=C. Solve this equation for C using Cayley's formula for a rotation matrix C [A]=[I−B]⁻¹ [I+B], where [B] is the skew-symmetric matrix constructed from Rodrigues' vector b=tan ϕ/2S, such that [B]y=b×y. Use this form of the rotation A to obtain C=[I−B]⁻1 [I+B]C+d_{⊥}, [I−B]C=[I+B]C+[I−B]d_{⊥}, which becomes −2[B]C=[I−B]d_{⊥}. This equation can be solved for C on the helical axis P(x) to obtain, C=b×d−b×(b×d)/2b×b. The helical axis P(x)=C+xS of this spatial displacement has the Plücker coordinates S=(S, C·S) ‘Helical’ geometric, Plücker coordinates, assign six homogeneous coordinates to each line in projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m >0, or spherical d. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C′-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras; it is said to be approximately finite (or AF). 2) (K₀(A), K₀(A)⁺)=(Z², {(a, b); 1+√V5/2 a+b≥0}). We note that the C′-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system are exposed to the common action of a static Magnetic Field of a Current Element Magnetic Resonance side B^{→}=Bₒ^{→}ₙ₌₀ and B^{→}ₑ (n-Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series). B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D2}_{N-2=0}: Let (aₙ)^{∞}ₙ₌₀ be a sequence of real numbers and c∈R real-valued power series. The power series centered at c with coefficients aₙ is the ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′[B^{→}ₑ D 4== . . . =^{D2}_{N-2=0}: Let (aₙ)^{∞}ₙ₌₀ be a sequence of real numbers and c∈R real-valued power series. The power series centered at c with coefficients aₙ is the ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′|=Ω_{R}/ [symbol] ] that rotates with a frequency ω around Bₒ^{→}ₙ₌₀. The motion of M^{→} is governed by the Bloch equations. The effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aⁿ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ on M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′=0, so that magnetization precesses around B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ at the Larmor frequency. The magnetization is Bin(n,p) binomial distribution f(k)=ₙCₖ p^{k}(1−p)^{n-k} pulsed rotations above the two dimensional x-y plane for [symbol] \hat{ }direction for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotates at the Larmor frequency (detuning=0) and for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ the magnetization is for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotates at the Larmor frequency (detuning=0) and for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′|Magnetic Field of a Current Element Magnetic Resonance with relaxation, for which the magnetization reaches a steady state. Our value of the frequency detuning ω−ω₀. If ω<<ω₀ or ω>>ω₀, the effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ is small and the steady state is close to the equilibrium magnetization along [symbol] . However, when ω≈ω₀, the effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ is important and the steady state is reached far from the [symbol] axis. Adiabatic following occurs for ω<<ω₀, in which case the magnetization precesses rapidly around the Magnetic Field of a Current Element Magnetic Resonance and therefore follows the direction of r adiabatically. The time evolution of the magnetization M^{→}=(u, v, w) of an ensemble of magnetic moments in a Magnetic Field of a Current Element Magnetic Resonance B^{→}=(Bₓ, B_{y}, B_{z}) is described by the Bloch equations, d/d t (u v w)= [symbol] (Bₓ, B_{y}, B_{z})×(u, v, w)−( [symbol] ₂ u [symbol] ₂ v [symbol] ₁(w−w_{eq})), where w_{eq} is the equilibrium [symbol] -component of M^{→}, when all fields are 0; [symbol] ₁ and [symbol] ₂ are called the longitudinal and transverse relaxation rates, respectively. The total Magnetic Field of a Current Element Magnetic Resonance is the vector sum of a Static Field Bₒ^{→}ₙ₌₀ along [symbol] and a field B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotating above the x-y plane, B^{→}=Bₒ^{→}ₙ₌₀: and re semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′=(Bₙ cos(ωt) Bₙ sin(ωt) B₀). Inserting B^{→} into the Bloch equations yields d/d t (u v w)=(Ω_{R} cos(ωt) Ω_{R} cos(ωt) ω₀)×(u, v, w)−( [symbol] ₂ u [symbol] ₂ v [symbol] ₁(ω−ω_{eq})), where ω₀₌ [symbol] |Bₒ^{→}ₙ₌₀| is the free Larmor precession frequency around Bₙ^{→}ₙ₌₀: and Ω_{R}= [symbol] |B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′| is our Rabi frequency, which characterizes the magnitude of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′, the strength of the interaction of the rotating field with the magnetization. Our set ω₀=(n=2); after generalizing the notion of integration, the logarithm can be viewed either as the inverse function of the exponential, or as the integral log z=integral sign ∫1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. More generally, Laurent series (using positive and negative powers) take care of isolated points where functions become infinite and lead to the powerful ‘theory of residues’ for the calculation of complex integrals. Returning to geometric ideas, complex analysis proves invaluable in two-dimensional potential theory. Finally the geometric ideas of Riemann can be viewed in terms of modern topology to give a global insight into ‘many-valued’ functions (the logarithm can be viewed either as the inverse function of the exponential, or as the integral log z=integral sign ∫1/z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. As the theory of complex analysis unfolds, the reader will see the immense importance of this definition. Complex functions f will be restricted to those of the form f: D→C where D is a domain. The fact that D is open will allow us to deal neatly with limits, continuity, and differentiability because z₀∈D implies the existence of a positive ε such that N_{ε}(z₀)⊆D and so f (z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S⊆C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some t∈R} is path connected. Sometimes it is more convenient to use a simpler type of path. Definition. A step path in S is a path y:[a, b]→S together with a subdivision a=t₀<t₁<t₂<∧<tₙ=b of [a, b] such that in each subinterval [tⱼ₋₁, tⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S⊆C which is path connected but is not step connected. Theorem. Every open disc N_{ε}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁^{˜}z₂ iff there exists a path y in S from z₁ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in C then all the connected components of S are open in C. One interesting way to generate open sets in C is to consider the complement of a path. Definition. Let y:[a, b]→C be a path. The complement of y is defined to be C\y([a, b]).; so all frequencies and relaxation rates are expressed in units of ω₀. The time unit is therefore 2π/ω₀ and the total time is equivalent to the number of Larmor cycles. Let x, y be two solutions to the system, does prove that any point [symbol] z=λx+λx+(1−λy) with λ∈|0, 1| also is A solution to the system, or having exponents the exponential function e^{x}, and the sum of the first n+1 terms of its Taylor series nondegenerate 2-form structure finite-dimensional n=2 flat, hyperbola, the distance between the foci is 2c. C²=a²+b². Every hyperbola has two asymptotes. A hyperbola with a horizontal transverse axis and center at (h, k) has one asymptote with equation y=k+(x−h) and the other with equation y=k−(x−h). The set of Din the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if θ′=aθ+b/cθ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). A module is called a uniform module if every two nonzero submodules have nonzero intersection circle group are also injective Z-modules A module isomorphic to an injective module solid domain surfaces U|_{N} has an integrated form σ^{N} giving a representation of C*(n) on H along the line of an unique trace τ, nearby level surfaces (x+1)⁻ⁿ, “ideal radial”, “slant”, “V”, “straight”, “inline”, “horizontally opposed”, “linear actuated”¹, or “stationary object”¹ (are our special cases of the one-manifold¹) base of the natural plane constant are the first convex set eigenfunctions form a complete set subspace which is a linear resolution we incorporate the periodic set c equal to e the base of the natural plane logarithm two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{J}(K) commute pairwise (S₀, g₀) and (S₁, gᵢ), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iXᵢ to AXB C over C with its applications, and Liu et al. 9 derived the maximal and minimal ranks of the two real matrices X₀ and X₁ in a Hermitian solution X X₀ iX₁ of 1.3, B*B representations G^{x}, x=r( [symbol] ) constants determined by the initial conditions, K. Sugahara, On the poles of Riemannian manifolds of nonnegative curvature, Progress in Differential Geometry, Adv. Stud. Pure Math. 22,(1993), 321-332. Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for |B^{→}ₑ. The Space X of Quasiperiodic the little group integral submultiples of I, can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀DⱼU×D_{k-J}v. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×90} (W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . . We apply Markov Chain basic probability, and conditional probability the conditional probability of event A given event B is defined as P(A/B)≡P(AB)/P(B) where AB≡A∩B (intersection). Events A and B are independent if P(AB)=P(A)P(B) or, equivalently, if P(A|B)=P(A). For events Bᵢ, 1≤i≤k, such that BᵢBⱼ=Ø0 for all i≠j, and an event A, we can apply Bayes formula to calculate P(Bᵢ|A) if we are given P(Bᵢ) and P(A|Bᵢ), 1≤i≤k: P(Bᵢ\A)≡P(ABᵢ)/P(A)=P(Bᵢ)P(A\Bᵢ)/P(Bⱼ)P(A\Bⱼ). Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4== . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁(neighborhood of 0). Our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e1(T)h+e2(T)h2+ [symbol] +em(T)hm+O(hm+1)): to |ZTh−Ef(XT)|≤O(hm+1) A is the inductive limit of finite-dimensional algebras; it is said to be approximately finite (or AF). 2) (K0(A), K0(A)+)=(Z2, {(a, b); 1+√5/2 a+b≥0}). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d can be resolved into a sum of two vectors, one parallel and one perpendicular to the axis L, that is, d=d_{L}+d_{⊥}, d_{L}=(d·S)S, d_{⊥}=d−d_{L}. In this case, the rigid motion takes the form D(x)=(A(x)+d_{⊥})+d_{L}. Now, the orientation preserving rigid motion D′*=A(x)+d_{⊥} transforms all the points of R³ so that they remain in planes perpendicular to L. For a rigid motion of this type there is a unique point c in the plane P perpendicular to L through 0, such that D*(C)=A(C)+d_{⊥}=C. The point C can be calculated as C=[I−A]⁻¹d_{⊥}, because d_{⊥} does not have a component in the direction of the axis of A. A rigid motion D′* with a fixed point must be a rotation of around the axis L_{c} through the point c. Therefore, the rigid motion D(x)=D*(x)+d_{L}, consists of a rotation about the line L_{c} followed by a translation by the vector d_{L} in the direction of the line L_{c}. Conclusion: every rigid motion of R³ is the result of a rotation of R³ about a line L_{c} followed by a translation in the direction of the line. The combination of a rotation about a line and translation along the line is called a helical motion. Computing a point on the helical axis A point C on the helical axis satisfies the equation: D*(C)=A(C)+d_{⊥}=C. Solve this equation for C using Cayley's formula for a rotation matrix C [A]=[I−B]⁻¹ [I+B], where [B] is the skew-symmetric matrix constructed from Rodrigues' vector b=tan ϕ/2S, such that [B]y=b×y. Use this form of the rotation A to obtain C=[I−B]⁻1 [I+B]C+d_{⊥}, [I−B]C=[I+B]C+[I−B]d_{⊥}, which becomes −2[B]C=[I−B]d_{⊥}. This equation can be solved for C on the helical axis P(x) to obtain, C=b×d−b×(b×d)/2b×b. The helical axis P(x)=C+xS of this spatial displacement has the Plücker coordinates S=(S, C·S) ‘Helical’ geometric, Plücker coordinates, assign six homogeneous coordinates to each line in projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m>0, or spherical d. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras; it is said to be approximately finite (or AF). 2) (K₀(A), K₀(A)⁺)=(Z², {(a, b); 1+√V5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system are exposed to the common action of a static Magnetic Field of a Current Element Magnetic Resonance side B^{→}=Bₒ^{→}ₙ₌₀ and B^{→}ₑ (n-Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series). B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′[B^{→}ₑ D 4== . . . =^{D2}_{N-2=0}: Let (aₙ)^{∞}ₙ₌₀ be a sequence of real numbers and c∈R real-valued power series. The power series centered at c with coefficients aₙ is the ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′|=Ω_{R}/ [symbol] ] that rotates with a frequency ω around Bₒ^{→}ₙ₌₀. The motion of M^{→} is governed by the Bloch equations. The effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aⁿ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ on M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′=0, so that magnetization precesses around B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ at the Larmor frequency. The magnetization is Bin(n,p) binomial distribution f(k)=ₙCₖ p^{k}(1−p)^{n-k} pulsed rotations above the two dimensional x-y plane for [symbol] \hat{ }direction for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotates at the Larmor frequency (detuning=0) and for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ the magnetization is for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotates at the Larmor frequency (detuning=0) and for which B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′|Magnetic Field of a Current Element Magnetic Resonance with relaxation, for which the magnetization reaches a steady state. Our value of the frequency detuning ω−ω₀. If ω<<ω₀ or ω>>ω₀, the effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ is small and the steady state is close to the equilibrium magnetization along [symbol] . However, when ω≈ω₀, the effect of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ is important and the steady state is reached far from the [symbol] axis. Adiabatic following occurs for ω<<ω₀, in which case the magnetization precesses rapidly around the Magnetic Field of a Current Element Magnetic Resonance and therefore follows the direction of r adiabatically. The time evolution of the magnetization M^{→}=(u, v, w) of an ensemble of magnetic moments in a Magnetic Field of a Current Element Magnetic Resonance B^{→}=(Bₓ, B_{y}, B_{z}) is described by the Bloch equations, d/d t (u v w)= [symbol] (Bₓ, B_{y}, B_{z})×(u, v, w)−( [symbol] ₂ u [symbol] ₂ v [symbol] ₁(w−w_{eq})), where w_{eq} is the equilibrium [symbol] -component of M^{→}, when all fields are 0; [symbol] ₁ and [symbol] ₂ are called the longitudinal and transverse relaxation rates, respectively. The total Magnetic Field of a Current Element Magnetic Resonance is the vector sum of a Static Field Bₒ^{→}ₙ₌₀ along [symbol] and a field B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′ rotating above the x-y plane, B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aⁿ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′=(Bₙ cos(ωt) Bₙ sin(ωt) B₀). Inserting B^{→} into the Bloch equations yields d/d t (u v w)=(Ω_{R} cos(ωt) Ω_{R} cos(ωt) ω₀)×(u, v, w)−( [symbol] ₂ u [symbol] ₂ v [symbol] ₁(ω−ω_{eq})), where ω₀₌ [symbol] |Bₒ^{→}ₙ₌₀| is the free Larmor precession frequency around Bₙ^{→}ₙ₌₀: and Ω_{R}= [symbol] |B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′| is our Rabi frequency, which characterizes the magnitude of B^{→}=Bₒ^{→}ₙ₌₀ and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀ and B^{→}ₑ semigroup, a semidirect product given a group G with identity element e, |B^{→}ₑ D 4== . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1-12k=H2F2k_2 equivalent translation periodic D′, the strength of the interaction of the rotating field with the magnetization. Our set ω₀=(n=2); after generalizing the notion of integration, the logarithm can be viewed either as the inverse function of the exponential, or as the integral log z=integral sign ∫1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. More generally, Laurent series (using positive and negative powers) take care of isolated points where functions become infinite and lead to the powerful ‘theory of residues’ for the calculation of complex integrals. Returning to geometric ideas, complex analysis proves invaluable in two-dimensional potential theory. Finally the geometric ideas of Riemann can be viewed in terms of modern topology to give a global insight into ‘many-valued’ functions (the logarithm can be viewed either as the inverse function of the exponential, or as the integral log z=integral sign ∫1./z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. As the theory of complex analysis unfolds, the reader will see the immense importance of this definition. Complex functions f will be restricted to those of the form f: D→C where D is a domain. The fact that D is open will allow us to deal neatly with limits, continuity, and differentiability because z₀∈D implies the existence of a positive ε such that N_{ε}(z₀)⊆D and so f (z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S g C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some t∈R} is path connected. Sometimes it is more convenient to use a simpler type of path. Definition. A step path in S is a path y:[a, b]→S together with a subdivision a=t₀<t₁<t₂<∧<tₙ=b of [a, IA such that in each subinterval [tⱼ₋₁, tⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S g C which is path connected but is not step connected. Theorem. Every open disc N_{∈}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁˜z₂ iff there exists a path y in S from z₁ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in C then all the connected components of S are open in C. One interesting way to generate open sets in C is to consider the complement of a path. Definition. Let y:[a, b]→C be a path. The complement of y is defined to be C\y([a, b]).; so all frequencies and relaxation rates are expressed in units of ω₀. The time unit is therefore 2π/ω₀ and the total time is equivalent to the number of Larmor cycles. Let x, y be two solutions to the system, does prove that any point [symbol] z=λx+λx+(1−λy) with λ∈|0, 1| also is A solution to the system, or having exponents the exponential function e^{x}, and the sum of the first n+1 terms of its Taylor series nondegenerate 2-form structure finite-dimensional n=2 flat, hyperbola, the distance between the foci is 2c. C²=a²+b². Every hyperbola has two asymptotes. A hyperbola with a horizontal transverse axis and center at (h, k) has one asymptote with equation y=k+(x−h) and the other with equation y=k−(x−h). The set of Din the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if θ′=aθ+b/cθ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). A module is called a uniform module if every two nonzero submodules have nonzero intersection circle group are also injective Z-modules A module isomorphic to an injective module solid domain surfaces U|_{N} has an integrated form σ^{N} giving a representation of C*(n) on H along the line of an unique trace T, nearby level surfaces (x+1)⁻ⁿ, “ideal radial”, “slant”, “V”, “straight”, “inline”, “horizontally opposed”, “linear actuated”¹, or “stationary object”¹ (are our special cases of the one-manifold s) base of the natural plane constant are the first convex set eigenfunctions form a complete set subspace which is a linear resolution we incorporate the periodic set c equal to e the base of the natural plane logarithm two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; C), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where S₁ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations G^{x}, x=r( [symbol] ) constants determined by the initial conditions, K. Sugahara, On the poles of Riemannian manifolds of nonnegative curvature, Progress in Differential Geometry, Adv. Stud. Pure Math. 22, (1993), 321-332. Larmor the zero module {0} is injective. M^{→} is maximized when the rotational frequency ω is equal to the Larmor free precession frequency ω₀= [symbol] |Bₒ^{→}ₙ₌₀| (Our detuning ω−ω₀≈0). Free Larmor precession, which occurs for |B^{→}ₑ. The Space X of Quasiperiodic the little group integral submultiples of I, can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=t(e), for the projections that belong to i √ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{1,j}^{(m)}≡P(Xₙ₊ₘ=j|Xₙ=i)=(P^{m})_{i,j}=P_{i,k}^{m-1}P_{k,j} (matrix multiplication). Communication and canonical form state j is accessible from state i if P^{(m)}_{i,j}>0 for some m >0, or spherical d begin a subgroup H of elements from the other. The communication relation partitions the set of states into (communication) classes. Every state is in one and only one class. If there is only one class, the chain is irreducible; otherwise it is reducible. A communication class is closed if the DTMC cannot leave it; otherwise it is open. All states j in open classes are transient; then P_{i,j}ⁿ→0 as n→∞. A DTMC can be put into canonical form by rearranging the states, putting the closed classes first. Sampled functions leads to a sampling theorem for finite sequences of the sample paths and gives us a simple derivation in block matrix form with 2 closed classes and 1 open class: P=(P₁ 0 R₁ 0 P₂ R₂ 0 0 Q) (The entries are themselves matrices.) Positive recurrent DTMC's an irreducible DTMC (or a closed communication class) is recurrent if the probability of returning to each state is 1. A recurrent DTMC is positive recurrent if the expected time to return is finite. A finite-state irreducible DTMC is always positive recurrent. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J}v. If p=2, Dₖ(U×v)=Σ^{k}ⱼ₌₀DⱼU×D_{k-J}v. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×90} (W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)}wⱼ×wₗ×Dⱼu×Dᵢv. Applying (d₁)* to each side of this equation, and using the commutative diagram, we obtain d*∧*(Pu×Pv)=Σ_{j,l}(−1)^{l(pr-j)}wⱼ wₗ×Dⱼu×Dₗv. Also d*P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . closed-chain equivariant translation-banded A class of C*-algebras and topological Markov chains. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ }commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f [n-mosfet generated by symbols {A₁, . . . , Aₛ}] power series expansion (n) sides metal-oxide-semiconductor field-effect transistor (mosfet) PF transmission. Proposition. We use Rohlin's Theorem to select to select F⁻ such that F⁻, T F⁻, T² F⁻, . . . , T^{m-1} F⁻ is a disjoint sequence, and μ(∪^{M-1}ᵢ₌₀ TⁱF⁻)≥1−ε/2. Now express each set A∈V^{m-1}₀ T⁻¹P/F⁻ as A₁∪A₂, A₁∩A₂=ϕ, μ(A₁)=μ(A₂), and put (m/2)−1 (m/2)−1 FA=[T2iA1 ∪[T2i−1A2 i=0 i=1. Clearly, F_{A} and TF_{A} are disjoint. We now let F be the union of the sets F_{A}, A∈V^{m-1}₀T⁻ⁱP/F⁻. It follows that F∩TF=ϕ, and that F∪TF is all of ∪^{m-1}ᵢ₌₀ Tⁱ F⁻, TⁱF⁻, 0≤i<m−1. Thus if m is large enough, μ(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M, ϕ) between (F_{g-}, ϕ₋) and (F_{g+},ϕ₊) the (closure of) the kernel of the R-linear map (−m₋) ⊗m₊: H^{ϕ}₁⁻(F_{g-},★)⊗H^{ϕ}₁⁺(F_{g+},★)→H^{ϕ}₁(M,★) induced by the inclusions m_{±}:F_{g±}→∂M⊂c M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module s; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5. β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where 1 is the completion of E with respect to μ, will be called the product space with product measure μ. determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution n and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{Σ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V ) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [10 t 1], τ∈R, one sees that the analytic index gives a (degree −1) isomorphism of K*(V ) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n ! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ* ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H^{*}_{τ}(V) is to exploit the local triviality of the foliation as follows: For each open set U⊂V one lets A(U) be the algebra associated by the functor C_{c}^{∞}(.; Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41)Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=δ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{=}]0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪Sᵢ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, =r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate a-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar λ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) ϕ(c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ* ([114]) (3.38) λ:H*(A)→H* _{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H^{*}_{τ}(V) is to exploit the local triviality of the foliation as follows: For each open set U⊂V one lets A(U) be the algebra associated by the functor C_{c}^{∞}(.; Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41)Γⁿ(U)=C^{m}(A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=δ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{=}]0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪Sᵢ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role [symbol] of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, =r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate a-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V ) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i- [symbol] χ(M)=Inn M∩Ct M/Inn M, which made it possible ([87]) to show the existence of a factor of type II₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod →S-Mod be an equivalence of categories. If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, c a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈X₁. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)n=_{0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T r, for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=x₋₁x₋₂x₋₃ . . . . The mapping x→(s(x),t(x)) is easily seen to be 1-1 structure of the Dual Algebra the monomials E₁ in a′ correspond in a one-to-one way with sequences of non-negative integers (i₁, i₂, • • • ,iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Ind.: K s(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. Completeness of Fourier modes the purpose of this note is to show completeness of the Fourier modes . . . , e^{-3ix}/√2π, e^{-2ix}/√2π, e^{-ix}/√2π, 1/√2π, e^{ix}/√2π, e^{2ix}/√2π, e^{3ix}/√2π . . . , for describing functions that are periodic of period 2π. It is to be shown that all these functions is written as combinations of the Fourier modes above. Assume that f(x) is any reasonable smooth function that repeats itself after a distance 2π, so that f(x+2π)=f(x). Then you can always write it in the form f(x)= . . . +c₋₂e^{-2ix}/√2π, +c₋₁e^{-2ix}/√2π, +c₋₁e^{-ix}/√2π, +c₀1/√2π, +c₁e^{ix}/√2π, +c₂e^{2ix}/√2π, +c₃e^{3ix}/√2π . . . +. or f(x)=^{∞}Σ_{k=-∞}cₖe^{kix}/2π for short. Such a representation of a periodic function is called a “Fourier series”. The coefficients cₖ are called “Fourier coefficients”. The factors 1/√2π can be absorbed in the definition of the Fourier coefficients, if you want. Because of the Euler formula, the set of exponential Fourier modes above is completely equivalent to the set of real Fourier modes 1/√2π, cos(x)/√π, sin(x)/√π, cos(2x)/√π, sin(2x)/√π, cos(3x)/√π, sin(3x)/√π, so that 2π-periodic functions are written as f(x)=a₀1/√2π+^{∞}Σₖ₌₁ak cos(kx)/√π+^{∞}Σₖ₌₁bk sin(kx)/√π. The extension to functions that are periodic of some other period than 2π is a trivial matter of rescaling x. For a period 2I, with I any half period, the exponential Fourier modes take the more general form, . . . , e^{-k2ix}/√2I, +e^{-k1ix}/√2I, +1/√2I, +e^{k1ix}/√2I, e^{k2ix}/√2I, . . . k₁=1π/I, k₂=2/I, k₃=3π/I, . . . and similarly the real version of them becomes 1/√2I, cos(k₁x)/√I, sin(k₁x)/√I, cos(k₂x)/√I, sin(k₂x)/√I, cos(k₃x)/√l, sin(k₃x)/√I, . . . , Often, the functions of interest are not periodic, but are required to be zero at the ends of the interval on which they are defined. Those functions can be handled too, by extending them to a periodic function. For example, if the functions f(x) relevant to a problem are defined only for 0 [symbol] x [symbol] I and must satisfy f(0) f(x) f(I) 0, then extend them to the range −I [symbol] x [symbol] 0 by setting f(x)=−f(−x) and take the range −I [symbol] x [symbol] I to be the period of a 2I-periodic function. It may be noted that for such a function, the cosines disappear in the real Fourier series representation, leaving only the sines. Similar extensions can be used for functions that satisfy symmetry or zero-derivative boundary conditions at the ends of the interval on which they are defined. If the half period I becomes infinite, the spacing between the discrete k values becomes zero and the sum over discrete k values turns into an integral over continuous k values. This is exactly what happens in quantum mechanics for the eigenfunctions of linear momentum. The representation is now no longer called a Fourier series, but a “Fourier integral”. And the Fourier coefficients cₖ are now called the “Fourier transform” F(k). The completeness of the eigenfunctions is now called Fourier's integral theorem or inversion theorem. The basic completeness proof is a long mathematical derivation. The Fourier modes are orthogonal and normalized. Any arbitrary periodic function f of period 2π that has continuous first and second order derivatives is written as f(x)=^{k=∞}Σ_{k=-∞}cₖe^{kix}/√2π in other words, as a combination of the set of Fourier modes. First an expression for the values of the Fourier coefficients cₖ is needed. It can be obtained from taking the inner product [symbol] e^{lix}/√2π|f(x) [symbol] between a generic eigenfunction e^{lix}/√2π and the representation for function f(x) above. Noting that all the inner products with the exponentials representing f(x) will be zero except the one for which k=I, if the Fourier representation is indeed correct, the coefficients need to have the values cI∫^{2π}ₓ₌₀e^{-lix}/√2πf(x)dx, a requirement that was already noted by Fourier. Note that I and x are just names for the eigenfunction number and the integration variable that you can change at will. Therefore, to avoid name conflicts, the expression will be renotated as cₖ∫^{2π}ₓ₌₀e^{-kix}^{^{−}}/√2πf(x⁻)dx⁻. Now the question is: suppose you compute the Fourier coefficients cₖ from this expression, and use them to sum many terms of the infinite sum for f(x), say from some very large negative value −K for k to the corresponding large positive value K; in that case, is the result you get, call it fK(x)≡√1+2(2+t)_{-K}cₖe^{kix}/√2π, a valid approximation to the true function f(x)? More specifically, if you sum more and more terms (make K bigger and bigger), does f_{K}(x) reproduce the true value of f(x) to any arbitrary accuracy that you may want? If it does, then the eigenfunctions are capable of reproducing f(x). If the eigenfunctions are not complete, a definite difference between f_{K}(x) and f(x) will persist however large you make K. In mathematical terms, the question is whether lim_{K→∞}f_{K}(x)=f(x). To find out, the trick is to substitute the integral for the coefficients cₖ into the sum and then reverse the order of integration and summation to get: f_{K}(x)=½π∫^{2π}ₓ_{^{−}}₌₀f(x⁻)[√1+2(2+t)_{-K}e^{ki(x-x}^{^{−}}⁾] dx⁻. The sum in the square brackets can be evaluated, because it is a geometric series with starting value e^{-Ki(x-x}^{^{−}}⁾ and ratio of terms e^{i(x-x}^{^{−}}⁾. Using a formula, multiplying top and bottom with e^{-i(x-x}^{^{−}}^{)/2}, and cleaning up with, the Euler formula, the sum is found to equal sin ((K+½)(x−x⁻))/sin(½(x−x⁻)). This expression is called the Dirichlet kernel. You now have f_{K}(x)=∫^{2π}ₓ_{^{−}}₌₀f(x⁻)sin((K+½)(x−x⁻))/2π sin (½(x−x⁻)) dx⁻. The second trick is to split the function f(x⁻) being integrated into the two parts f(x) and f(x⁻)−f(x). The sum of the parts is obviously still f(x⁻), but the first part has the advantage that it is constant during the integration over (x⁻) and can be taken out, and the second part has the advantage that it becomes zero at (x⁻)=x. You get f_{K}(x)=f(x)∫^{2π}ₓ_{^{−}}₌₀ sin((K+½)(x−x⁻))/2π sin(½(x−x⁻)) dx⁻+∫^{2π}ₓ_{^{−}}₌₀(f(x⁻)−f(x))sin((K+½)(x−x⁻))/2π sin(½(x−x⁻)) dx⁻. Now if you backtrack what happens in the trivial case that f(x) is just a constant, you find that f_{K}(x) is exactly equal to f(x) in that case, while the second integral above is zero. That makes the first integral above equal to one. Returning to the case of general f(x), since the first integral above is still one, it makes the first term in the right hand side equal to the desired f(x), and the second integral is then the error in f_{K}(x). To manipulate this error and show that it is indeed small for large K, it is convenient to rename the K-independent part of the integrand to g(x⁻)=f(x⁻)−f(x))/2π sin(½(x−x⁻)). Using l'Hôpital's rule twice, it is seen that since by assumption f has a continuous second derivative, g has a continuous first derivative. So you can use one integration by parts to get f_{K}(x)=f(x)+1/K+½ ∫^{2π}ₓ_{^{−}}₌₀g′(x⁻) cos ((K+½)(x−x⁻))dx⁻. And since the integrand of the final integral is continuous, it is bounded. That makes the error inversely proportional to K+½, implying that it does indeed become arbitrarily small for large K. Completeness has been proved. It may be noted that under the stated conditions, the convergence is uniform; there is a guaranteed minimum rate of convergence regardless of the value of x. This can be verified from Taylor series with remainder. Also, the more continuous derivatives the 2π-periodic function f(x) has, the faster the rate of convergence, and the smaller the number 2K+1 of terms that you need to sum to get good accuracy is likely to be. For example, if f(x) has three continuous derivatives, you can do another integration by parts to show that the convergence is proportional to 1/(K+½)² rather than just 1/(K+½). But watch the end points: if a derivative has different values at the start and end of the period, then that derivative is not continuous, it has a jump at the ends. (Such jumps can be incorporated in the analysis, however, and have less effect than it may seem. You get a better practical estimate of the convergence rate by directly looking at the integral for the Fourier coefficients). By the rule (χ*(n mod m), gcd(n,m)=1, χ(n)=0, χ is also referred to as a Dirichlet character, χ for the function of transport properties of Euclidean space transformations that preserve the Euclidean metric isometries are the sum of the dimensions of its factors two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×Sᵢ) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; C), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where S₁ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations M₀ and N₁, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 A differentiable map f:M₀→N₁ is called A diffeomorphism if it is A bijection and its inverse f−1: N₁→M₀ is differentiable as well, if these functions are r times continuously differentiable, f is called A Cr-diffeomorphism. M₀ and N₁ formally, are diffeomorphic symbol usually being ≃ if there is A diffeomorphism f from M₀ to N₁, they are Cr diffeomorphic if there is an r times continuously differentiable bijective map between them whose inverse is also r times continuously differentiable. Diffeomorphism if it is A bijection and its inverse f−1: N₁→M₀ having exponents b^{m+n}=b^{m}×bⁿ; (b^{m})ⁿ=b^{m×n}; and (b×c)ⁿ=bⁿx cⁿ mean value constraint as applications, we establish necessary and sufficient conditions over H to have The Real and Complex Hermitian Solutions to a System of Quaternion Matrix Equations with Applications by Shao-Wen Yu (we refer to). Diffeomorphism A mapping that is isomorphic, 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto, differentiable, with an inverse map having the same characteristics as the original smooth map f:S1→S2f:S1→S2, which are bijective and whose inverse map f−1:S2→S1f−1:S2→S1, which are bijective and whose inverse map f−1:S2→S1f−1:S2→S1 is smooth onto, vector additive the dot product of one of the vectors (with respect to coordinate-wise addition) with the cross product of the other two, 1-1 structure of the Dual Algebra the monomials ε^{I} in a′ correspond in a one-to-one way with sequences of non-negative integers (i₁, i₂, • • • , iₙ, 0, • • • ) we now find the diagonal in a* we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, phase factor for any complex number written in polar form (such as re^{iΘ}), the phase factor is the complex exponential factor (e^{iΘ}) the motion is uniform circular motion we incorporate the periodic set c equal to e so they are too fortuitously the base of the natural logarithm plane. The normalization function of a different action the motion of our system of equations eigenfunctions the principal of eigenvalues of arithmetic progression. Homomorphism of groups, the homomorphism of the ring structure I^{˜}. Commutes with all cohomology operations negative [symbol] z-axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). It may be noted that under the stated conditions, the convergence is uniform; there is a guaranteed minimum rate of convergence regardless of the value of x. This can be verified from Taylor series with remainder. Also, the more continuous derivatives the 2π-periodic function f(x) has, the faster the rate of convergence, and the smaller the number 2K+1 of terms that you need to sum to get good accuracy is likely to be. For example, if f(x) has three continuous derivatives, you can do another integration by parts to show that the convergence is proportional to 1/(K+½)² rather than just 1/(K+½). But watch the end points: if a derivative has different values at the start and end of the period, then that derivative is not continuous, it has a jump at the ends. (Such jumps can be incorporated in the analysis, however, and have less effect than it may seem. You get a better practical estimate of the convergence rate by directly looking at the integral for the Fourier coefficients). Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, Leibniz's rule for differentiation under the integral sign ∫, for an integral of the form ₐ₍ₓ₎∫^{b(x)} f(x,t) dt, where −∞<a(x), b(x)<∞ the derivative of this integral is expressible as d/dx(ₐ₍ₓ₎∫_{b(x)} f(x,t) dt)=f(x, b(x))·d/dx b(x)−f(x, a(x))·d/dx a(x)+a(x)∫b(x) ∂/∂x f(x, t) dt, where the partial derivative indicates that inside the integral, only the variation of f(x, t) with x is considered in taking the derivative. Notice that if a(x) and b(x) are constants rather than functions of x, we have a special case of Leibniz's rule: d/dx (a∫b f(x, t) dt)=ₐ∫^{b} ∂/∂x f(x, t) dt. Thus under certain conditions, one may interchange the integral and partial differential operators. This important result is particularly useful in the differentiation of integral transforms. A moment generating function in probability theory, a variation of the Laplace transform, which can be differentiated to generate the moments of a random variable. Whether Leibniz's integral rule applies is essentially a question about the interchange of limits. Theorem. Let f(x, t) be a function such that both f(x, t) and its partial derivative fₓ(x, t) are continuous in t and x in some region of the (x, t)-plane, including a(x)≤t≤b(x), x₀≤x≤xᵢ. Also suppose that the functions a(x) and b(x) are both continuous and both have continuous derivatives for x₀≤x≤x₁. Then, for x₀≤x≤x₁, d/dx(a(x)∫b(x) f(x,t) dt)=f(x, b(x))·d/dx b(x)−f(x, a(x))·d/dx a(x)+a(x)∫b(x) ∂/∂x f(x, t) dt. This formula is the general form of the Leibniz integral rule and can be derived using the fundamental theorem of calculus. The (first) fundamental theorem of calculus is just the particular case of the above formula where a(x)=a, a constant, b(x)=x, and f(x, t)=f(t). If both upper, and lower limits are taken as constants, then the formula takes the shape of an operator equation: It∂x=∂xIt where dx is the partial derivative with respect to x and It is the integral operator with respect to t over a fixed interval. That is, it is related to the symmetry of second derivatives, but involving integrals as well as derivatives. This case is also known as the Leibniz integral rule. The following three basic theorems on the interchange of limits are essentially equivalent: the interchange of a derivative and an integral (differentiation under the integral sign ∫; i.e., Leibniz integral rule); the change of order of partial derivatives; the change of order of integration (integration under the integral sign ∫; i.e., Fubini's theorem). Continuity of equation orientated equivalence ±poles of the function, are continued as a continuous equivalence ±poles of the function in a Hilbert space is a vector space H with an inner product [symbol] f, g [symbol] such that the norm defined by |f|=√ [symbol] f, f [symbol] turns H into a complete metric space. If the metric defined by the norm is not complete, then H is instead known as an inner product space. Sampled functions leads to a sampling theorem for finite sequences of the sample paths in Hilbert spaces include 1. The real numbers Rⁿ with [symbol] v, u [symbol] the vector dot product of v and u. 2. The complex numbers Cⁿ with [symbol] v, u [symbol] the vector dot product of v and the complex conjugate of u. Sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}f(x) g (x) d x, and nondegenerate 2-form structure in potential theory complex analysis proves invaluable mathematical physics expressions an infinite potential one {1×1 column} quadrupole, or equivalence their incidence of the Euclidean space are shared with an affine geometry, the complete metric space property, and the number in base point k-face element plane the fundamental group we consider the category of pointed topological spaces, i.e. topological spaces with distinguished points. Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [τₙ,τₙ₊₁] for an ideal H of R the following are equivalent: (a) H is semiprime; (b) I²⊆H implies I⊆H for all left (right/two-sided) ideals I; (c) aRa⊆H implies that a∈H. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}(x) g (x) d x, nondegenerate 2-form structure in potential theory complex analysis proves invaluable mathematical physics expressions an infinite potential one {1×1 column} quadrupole, or equivalence capillary feeder and collector of exhaled carbon dioxide CO₂, equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|≤mesh(τn) [symbol] , {n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, Nϕ as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Higher aggregation atoms sinterization (oxygen, gases, and elements) (1.0) atoms and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices q=∥μ∥ a second scalar field at program temperature fluid triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0, 1, 0, 1, 4, 1, 4, 1, 3, 0, . . . ]. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology. Transcendental Functions analytic function ƒ(z) of one real or complex variable z independent variable extended to functions of several variables mathematics through quadrature of the rectangular hyperbola xy=1, functions are transcendental: f₁(x)=x^{π}, f₂(x)=c^{x}, f₃(x)=x^{x}, f₄(x)=x^{1/x}, f₅₍ₓ₎=log_{c}(x), f₆(x)=sin x in particular, for ƒ₂ if we set c equal to e the base of the natural logarithm, then we get that e^{x} is a transcendental function similarly, if we set c equal to e in ƒ₅, then we get that f₅₍ₓ₎=logₑ x=1n x that is, the natural logarithm is a transcendental function and Differentiation of Transcendental Functions trigonometric derivatives (rate of change, engineering, equation of normal) of sin, cos, and tan functions, derivatives of csc, sec, and cot functions, and derivatives of inverse trigonometric functions differentiating logarithmic, and exponential functions derivative of the logarithmic function, and derivatives of transcendental functions formulas for taking derivatives of exponential, logarithm, trigonometric, and inverse trigonometric functions then any function made by composing these with polynomials, or with each other can be differentiated by using the chain rule, product rule, or mathematic the first two are the essentials for exponential, and logarithms: the next three are essential for trig functions: and the next three are essential for inverse trig functions curves as the cycloid of mathematics a periodic curve. The matrix W whose columns form a period basis of the Abelian function f(z) has dimension p×2p and is known as the period matrix of the Abelian function f(z). A necessary and sufficient condition for a given matrix W of dimension p×2p to be the period matrix of some non-degenerate Abelian function f(z) exist an anti-symmetric non-degenerate square matrix M with integer elements, of order 2p, and Hermitian inner product has 1 real part symmetric positive definite, and its imaginary part symplectic by properties on a complex vector space V is a complex-valued bilinear form on V which is antilinear in the second slot, and is positive definite, following properties, where z* means the complex conjugate of z. Conditions are expressed as equations and inequalities respectively, a system of p(p−1)/2R Riemann equations and p(p−1)/2R Riemann inequalities is obtained. The number p is called the genus of the matrix W and of the corresponding Abelian function f(z). The columns wᵥ=Re wᵥ+i Im wᵥ of W, regarded as vectors in the real Euclidean space R^{2p}, define the period parallelotope of f(z). All Abelian functions corresponding to the same period matrix W form an Abelian function field ^{K}W. If the field ^{K}W contains a non-degenerate Abelian function, its degree of transcendence over the field C is p. The torus Cp/Γ is then an Abelian variety, and ^{K}W turns out to be its field of rational functions. If, on the other hand, all Abelian functions of ^{K}W are degenerate, then ^{K}W is isomorphic to the field of rational functions on an Abelian variety of dimension lower than p. The Abelian function AI(z) may be represented as AI(z)=AI(^{z}1, . . . , ^{zp})=R[^{x}1(^{z}1, . . . , ^{z}p), . . . , ^{x}p (^{z}1, . . . , ^{z}p)]. A generalization of the concept of an elliptic function of the real part of one complex variable s=σ+iτ in analytic number theory to the case of several complex variables, a function f(z) in the variables ^{z}1, . . . , ^{z}p, z=(^{z}1, . . . , ^{z}p), mathematical field of complex analysis meromorphic does function on an open subset D of the complex plane is a function that is holomorphic on all of D except for a set of isolated points, in the complex space C^{p}, p≤1, p coordinates of the upper limits ^{x}1, . . . , ^{x}p, and system of sums lower integration limits ^{c}1, . . . , ^{c}p which are poles of the function in the complex space C^{p}, f(z)f(z), in the complex space, function f(z) in the variables ^{z}1, . . . , ^{z}p, ^{z=z}1, . . . , ^{z}p, is called an Abelian function if there exist ²p row vectors in C^{p}, wᵥ=(w1ᵥ, . . . , wₚᵥ), v=1, . . . , 2p, which are linearly independent over the field of real numbers and are such that f(z+wᵥ)=f(z) for all zϵC^{p}, v=1, . . . , 2p. The vectors wᵥ of all periods, or the system of periods of the Abelian function f(z) form an Abelian group r under addition, the period group, or the period module, a basis of this group is a system of periods of the Abelian function, or also as a system of basic periods, an Abelian function f(z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, d₁W). Two cobordisms (W, M₀, f₀, M₁, f₁) and (W′,M₀, f′₀, M′₁, f′₁) over M₀ are diffeomorphic relative M₀ if there is an orientation preserving diffeomorphism F:W→W′ with F∘f₀=f₀′. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12) τM₀^{f0}→∂₀Wⁱ⁰→W)∈Wh(π₁(W)) under the isomorphism (i₀∘f₀)*: Wh(π₁(M₀))≅→Wh(πᵢ(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H*(M)≅H*(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i =0, 1 be two embedded disjoint disks. Put W=M (int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ¹. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0} Uᵢₒ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h_{|Dn0×(0)}=id, h_{|∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of r given by coning f yields only a homeomorphism f⁻ and not a diffeomorphism even if we start with a diffeomorphism f. The map r is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. S₀ the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x >y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation ^{˜} on a set S is called quasi-reflexive if every element that is related to some element is also related to itself, formally: ∀x, y∈S:x˜y (x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (∫)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to except for where x^{˜}x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τX)f)(x)−f(x)/τ αₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped longitude, or transverse combination while for the only transverse measure X for (v,f) (the horocycle flow being strongly ergodic), the composition of the above analytic index with dimλ:K*(C*(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f (x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] power series two linearly independent solutions a minimum type thermodynamic characteristic range set lower bound of these maxima over all sets an isotopy class is said to be closed if it contains the topological limit of any sequence of sets in it. Given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X^{g}↓_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all a∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→(r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M″ has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′aᵢ″, where aᵢ′, aᵢ″∈A. But aᵢ′ and a₁″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r>0 in Z one has r=1+1+^{(r)} . . . +1, and thus rm=(1+ [symbol] +1)m=1m+^{(r)} . . . +1m=M+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, ₛM an S-module. Consider the map R×M (r, m) r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and a: V→V a linear map. Define the map F[x]×V→V(x, v)→x*v:=α(v) extending to xⁿ*v:=αⁿ(v)=α(α(⁽ⁿ⁾ . . . α(v))) and (Σαᵢxⁱ)*v:=Σαᵢxᵢ(v). It is an easy exercise to check that under this action V becomes an F[x]-module.

Conversely, if V is a module over the polynomial ring F[x], since F F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map a: V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries I⊗K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-3. Structure of the Dual Algebra the monomials ε^{I} in a′ thus correspond in a one-to-one way with sequences of non-negative integers (i₁, i₂, • • •, iₙ, 0, • • •). The admissible monomials Sq^{I′}∈a correspond to sequences of integers (i′₁, i′₂, • • •, i′n, 0, • ••) where i′ₖ≥2i′ₖ₊₁ and i′ₙ≥1. It remains only to set up a one-to-one correspondence between sequences of non-negative integers I and admissible sequences such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • •). We construct a map from the set of sequences I to the set of sequences I′ by insisting that Iₖ be sent to I′ₖ and that the map be additive (with respect to coordinate-wise addition). Then if I=(i₁, • • •, iₙ, 0, • • •)→I′=(i′₁, • • •, i′ₙ, 0, • • •) ε^{I} and Sq^{I′} have the same degree and we have i′ₖ=iₖ+2iₖ₊₁+ • • • +2^{n-k} iₙ. Solving for iₖ in terms of i′ₖ, we obtain iₖ=i′ₖ+2iₖ₊₁. Therefore, every admissible sequence is the image of a unique sequence I of non-negative integers. Thus the correspondence is one-to-one. This completes the proof of the theorem. We now find the diagonal in a*”. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let π be a normal subgroup of p and let y→p. Let g:(π,A,K)→(π,A,K) be the automorphism determined by y. Then the image H*ₚ(K;A)→H*ₙ(K;A) is pointwise invariant under the automorphism g.* Proof. let f: (p,A,K)→(p,A,K) be the inner automorphism determined by y. Then by 1.2, the following diagram is commutative H*ₚ(K;A)^{f*}→H*ₚ(K;A)→H*ₙ(K;A); and H*ₚ(K;A)→H*ₙ(K;A)^{g*}→H*ₙ(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topology—that is, a set is open if and only if its intersection with every finite subcomplex is open, (i.e. K is a CW complex). Let K and L be cell complexes. A carrier from K to L is a function C which assigns to each cell t∈K a subcomplex C(r) of L such that a face oft is sent to a subcomplex of C(τ). An acyclic carrier is one such that C(τ) is acyclic for each t∈K. Let p and n be groups which act on K and L respectively (consistently with their cell structures), and let h: p n be a homomorphism. An equivariant carrier is one such that C(ατ)=h(α) C(τ) for all a∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If c ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group n, we can always construct a π-free acyclic simplicial complex W. Proof. We give π the discrete topology and form the infinite repeated join W=π•π•π . . . This repeated join is a simplicial complex. Taking the join of a complex with a point gives us a contractible space. Any cycle in W must lie in a finite repeated join W′. Such a cycle is homologous to zero in W′•π. Therefore, W is acyclic. We make π act on W as follows: n acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*ₙ(W;A). In the class of π-free acyclic complexes, any two complexes are equivariantly homotopy equivalent, and any two equivariant chain maps going from one such complex to another are equivariantly homotopic. Therefore the groups H*ₙ(W;A), as W varies over the class, are all isomorphic to each other and the isomorphisms are unique and transitive. We can therefore identify all these cohomology groups and write H*(π;A), instead of H*ₙ(W;A). 2.4. Lemma. H*(π;A), is a contravariant functor from the category of pairs (see 1.1)”. An element of the K-group of the parameter space groupoid of the manifold M through the associated C*-algebra C^{*}ᵣ(G): random dilution of random matrices H_{N}=U_{N} F_{N} U^{∀}N, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and G(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜ₁⁽ⁿ⁾=Xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾⁼₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2 . . .} of 0's and 1's that satisfies the following coherence rule: zₙ=1⇒zₙ₊₁=0 is the phase factor derivative, dI/dU, on the electric current, I. Incipient p-wave PF power transmission superconducter the operator PF A, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ } G\hat{ } ϕₖ=gₖPF\hat{ } ϕk=gₖ(PF)ₖϕₖ (where (PF)ₖ=P for k=1, 2, 3 and =F for k=4. We also have G\hat{ } PF\hat{ } ϕₖ=G\hat{ } (PF)ₖϕₖ=(PF)ₖG\hat{ } ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ },G\hat{ }]f=0 for any function f. However, the eigenfunctions form a basis, so that any other function in the subvector ample line O(1) space can be written as a linear combination of ϕₖ′s: Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∪U₁∪ . . . ∪ Uₚ), b, B, δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π =a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • •, a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≥4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}. The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles [p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−)^{n-k}=|S₁(n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . →A050212 6; 24; 120; 720; 5040, 1260; 40320, 18144; . . . 5 A050213 24; 120; 720; 5040; 40320; 362880, 72576; . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram !Alpha: Permutation Cycle we refer to: Weisstein, Eric W. “Permutation Cycle”. From Math World—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0.

1. The variable hydraulic-electric; hydraulic-electric actuated; hydraulic-electric fluid dynamic; hydraulic-electric fluid propulsion; work-energy connection there is a relationship between work and total mechanical energy; the relationship is best expressed by the equation TMEᵢ+W_{nc}=TME_{f} the initial amount of total mechanical energy (TMEᵢ) of a system is altered by the work which is done to it by non-conservative forces (W_{nc}); the final amount of total mechanical energy (TME_{f}) possessed by the system is equivalent to the initial amount of energy (TMEᵢ) plus the work done by these non-conservative forces (W_{nc}); the mechanical energy possessed by a system is the sum of the kinetic energy and the potential energy; thus the above equation can be re-arranged to the form of KEᵢ+PEᵢ+W_{nc}=KE_{f}+PE_{f}0.5·m·vᵢ²+m·g·hᵢ+F•d·cos(Θ)=0.5·m·v_{f}²+m·g·h_{f}; industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure processing powerplant; or [heat a heater fluid]. Heat a heater fluid a superconductor of magnetic-enthalpy in symbol H. Sub-plasma work power (M∘M)(X_{0,1}) the change in energy of a dynamical class system the dynamics of variable change complexification*, or two times the momentum isotopic class [A] conservation ΔE_{sys}:=the Planck constant [symbol] V in Newton Ring's [symbol] :=s²/2r:=N:=λ/2 the gravitational force:=Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors R smooth 1-densities on G the object functor category, u is well-defined and unitary, or in category of sheaves of Ox-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1), α, β, and ϕ small, is written with equations in terms of load factor as (n−cos Θ), g-units stationary, and independent increments dynamics of variable change method of two simple planes a and b having a sequence which accounts for the role of these numbers in measuring the densities of the planes, of finite-dimensions as densities in the neighborhood of 0, and continued of the continuous dimensions as the densities of the planes complexification*, or two times the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜}=λ^{*} is the complex conjugate of λ {impellers; turbo-shaft; turbo-fan; turbo-fluid; turbo-jet; or fluid-propulsion} negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. The Koszul complex associated to the operad Trias is the differential functor Tridend∘Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f. By definition the Koszul complex associated to the operad Trias is the differential functor Tridend∘Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C^{*Trias}(Trias(V)) is proved. 1. We show that it is sufficient to treat the case V=K. 2. The chain complex C^{*Trias}(Trias(K)) splits into the direct sum of chain complexes C^{*}(u), one for each element u in P_{m,m}≥1. 3. The chain complex C^{*}(u) is shown to be the cell complex of a simplicial set X(u). 4. The space X(u) is shown to be the join of spaces X(v) for certain particular elements v in Pₘ. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B^{*}B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, t). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−v∥=lim(μ−v)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •, iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] : Y Q such that [symbol] f=g, the following diagram commutes: [symbol] *0→X^{g}↓_{Q}^{f} [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wk concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. We consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). Steady-state system theory, our system and process of a steady-state solution which are null-spaces of a positive number n of length n when the state variables which define the behavior of the system and process are unchanging in time. In continuous time, this means that for those properties p of the system, the partial derivative with respect to time is zero and remains so. In mathematics and in our dynamical system, a linear difference equation equates to 0 to a polynomial that is linear in the various iterates of a variable that is, in the values of the elements of a sequence. The polynomial's linearity means that each of its terms has degree 0 or 1 with discrete moment denoted as T, one period denoted as τ−1, one period later as τ+1, an nth order linear difference equation is one that is written in terms of parameters aⁱ and b, discrete-variable moment (momentum) motion position, harmonic simple moment (momentum) circular motion, and harmonic motion equilibrium position, harmonic series moment (momentum) circular motion, and harmonic motion equilibrium position, continuous-variable moment (momentum) circular motion, and harmonic motion equilibrium position, continuous-equivalently moment (momentum) circular motion, and harmonic motion equilibrium position, or variable geometry moment (momentum) bias efficient in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 motion, and harmonic motion equilibrium position isochronous the period and frequency are independent of the amplitude and constant are the first convex set eigenfunction form a complete set subspace eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1 the motion is uniform circular motion continued in the Taylor series of n-sums of the first n+1 terms of a n-series at 0, when n:=a=0, known as the base point by the action of G₁ depends upon the choice of a base point x₀∈M to every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. (We refer to). “The isomorphism a of (]0,1]×R^{N}) with the quotient BG₁ of G₁⁽⁰⁾×R^{N}=(]0, 1]×M)×R^{N} by the action of G₁ depends upon the choice of a base point x₀∈M, and to simplify the formulae we take j(x₀)=0∈R^{N}. One then has α(ε,X)=((x₀,ε),X) ∀ε>0, XεR^{N}. with this notation the locally compact topology of BG is obtained by gluing]0,1]×R^{N} to v(M) by the following rule: (εₙ,Xₙ)(x,Y) for εₙ→0, x∈M, Y∈vₓ(M) iff Xₙ→j(x)∈R^{N} and Xₙ−j(x)/εₙ→Y in vₓ(M). Using the Euclidean structure of RN we can view vₓ(M) as the subspace orthogonal to j_{*}Tₓ(M)⊂R^{N} and use the following local chart around (x,Y)∈v(M): ϕ(x,Y,ε)=(ε,j(x)+εY)∈]0,1]×R^{N} for ε>0″ the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of U called the n-isotypic component of ∪; or the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of U for a shaft; or turboshaft sub-plasma work power (M∘M)(X_{0,1}) the change in energy of a dynamical class system the dynamics of variable change complexification*, or two times the momentum isotopic class [A] conservation ΔE_{sys}:=the Planck constant [symbol] V in Newton Ring's [symbol] :=s²/2r:=N:=λ/2 the gravitational force:=Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1), α, β, and ϕ small, is written with equations in terms of load factor as (n−cos Θ), g-units stationary, and independent increments dynamics of variable change method of two simple planes a and b having a sequence which accounts for the role of these numbers in measuring the densities of the planes, of finite-dimensions as densities in the neighborhood of 0, and continued of the continuous dimensions as the densities of the planes complexification*, or two times the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜}=λ^{*} is the complex conjugate of λ {impellers; turbo-shaft; turbo-fan; turbo-fluid; turbo-jet; or fluid-propulsion} negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. The Koszul complex associated to the operad Trias is the differential functor Tridend∘Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f nearby level surface point structure, or solid domain occupies surface point structure “there is an exponential map Mₙ(R)≅glₙ(R)∈X exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(τX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by D_{X}(b). The collection of all b such that all iterated derivatives always exist is a linear subspace B^{∞} of B, and on this subspace we have (DₓD_{y}−D_{y}Dₓ)(b)=D_{[X,Y]}(b). (We refer to). “The same map Indₐ arises naturally from a geometric construction, that of the tangent groupoid of the manifold M. This groupoid encodes the deformation of T^{*}M to a single point, using the equivalence relation on M×[0,1] which identifies any pairs (x,ε) and (y,ε) provided ε>0. Implicitly the notion of groupoid. All our algebra structures could be written in the following form: (a*b)( [symbol] )= [symbol] a( [symbol] ₁)b( [symbol] ₂) for non-rotation, closed-chain equivariant translation-banded A class of C*-algebras and topological Markov chains or spherical models sides are variations given a space X such a family (Dₓ)_{x∈X} of elliptic operators parametrized by X is given by a longitudinal combinatorial(n) elliptic differential operator Dan element of the K-group of the parameter space groupoid of the manifold M through the associated C*-algebra C^{*}ᵣ(G): where the [symbol] 's vary in a groupoid G, i.e. in a small category with inverses, or more explicitly: Definition 1. A groupoid consists of a set G, a distinguished subset G⁽⁰⁾⊂G, two maps r,s:G→G⁽⁰⁾ and a law of composition ∘:G⁽²⁾={( [symbol] ₁, [symbol] ₂)∈G×G; s( [symbol] ₁)=r( [symbol] ₂)}→G such that (1) s( [symbol] ₁∘ [symbol] ₂)=s( [symbol] ₂), r( [symbol] ₁∘ [symbol] ₂)=r( [symbol] ₁) ∀( [symbol] ₁, [symbol] ₂)∈G⁽²⁾ (2) s(x)=r(x)=x ∀x∈G⁽⁰⁾ (3) [symbol] ∘s( [symbol] )= [symbol] , r( [symbol] )∘ [symbol] = [symbol] ∀ [symbol] ∈G (4) ( [symbol] ₁∘ [symbol] ₂)∘ [symbol] ₃= [symbol] ₁∘( [symbol] ₂∘ [symbol] ₃) (5) Each [symbol] has a two-sided inverse [symbol] ⁻¹, with [symbol] [symbol] ⁻¹=r( [symbol] ), [symbol] ⁻¹ [symbol] =s( [symbol] ). The maps r,s are called the range and source maps. Equivalence relations. Given an equivalence relation R⊂X=X on a set X, one gets a groupoid in the following obvious way: G=R, G⁽⁰⁾=diagonal of X×X⊂R, r(x,y)=x, s(x,y)=y for any [symbol] =(x,y)∈R⊂X×X and (x,y)∘(y,z)=(x,z), (x,y)⁻¹=(y,x). Groups. Given a group Γ one takes G=Γ, G⁽⁰⁾={e}, and the law of composition is the group law. Group actions. Given an action X×Γ→^{α}X of a group Γ on a set X, α(x,g)=xg, so that x(g₁g₂)=(xg₁)g₂ ∀x∈X, gᵢ∈Γ, one takes G=X×Γ, G⁽⁰⁾=X×{e}, and r(x,g)=x, s(x,g)=xg ∀(x,g)∈X×Γ (x,g₁)(y,g₂)=(x,g₁g₂) if xg₁=y (x,g)⁻¹=(xg,g⁻¹) ∀(x,g)∈X×Γ. This groupoid G=XoΓ is called the semi-direct product of X by Γ. In all the examples we have met so far, the groupoid G has a natural locally compact topology and the fibers G^{x}=r⁻¹{x}, x∈G⁽⁰⁾, of the map r, are discrete. This is what allows us to define the convolution algebra very simply by (a*b)( [symbol] )=Σ [symbol] _{1∘} [symbol] ₂₌ [symbol] a( [symbol] ₁)b( [symbol] ₂). Our next example of the tangent groupoid of a manifold will be easier to handle than the general case; though no longer discrete, it will be smooth in the following sense: Definition 2. A smooth groupoid G is a groupoid together with a differentiable structure on G and G⁽⁰⁾ such that the maps r and s are subimmersions, and the object inclusion map G⁽⁰⁾→G is smooth, as is the composition map G⁽²⁾→G. The general notion is due to Ehresmann and the specific definition here to Pradines, who proved that in a smooth groupoid G, all the maps s:G^{x}→G⁽⁰⁾ are subimmersions, where G^{x}={ [symbol] ∈G;r( [symbol] )=x}. The notion of a ½-density on a smooth manifold allows one to define in a canonical manner the convolution algebra of a smooth groupoid G. More specifically, given G, we let Ω^{1/2} be the line bundle over G whose fiber Ω [symbol] ^{1/2} at [symbol] ∈G, r( [symbol] )=x, s( [symbol] )=y, is the linear space of maps ρ: ∧^{k}T [symbol] (G^{x})⊗∧^{k}T [symbol] (G_{y})→C such that ρ(λv)=|λ|^{1/2}ρ(v) ∀λ∈R. Here G [symbol] ={ [symbol] ∈G;s( [symbol] )=y} and k=dimT [symbol] (G^{x})=dimT [symbol] (G_{y}) is the dimension of the fibers of the submersions r:G→G⁽⁰⁾ and s:G→G⁽⁰⁾. Then we endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] ( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), on the manifold G^{x}, x=r( [symbol] ), as two easy examples of this construction one can take. a) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. [3) A Lie group G is, in a trivial way, a groupoid with G M={e}. One then gets the convolution algebra C_{c}^{∞}(G,Ω^{1/2}) of smooth 1-densities on G. As two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G M={e}. One then gets the convolution algebra C_{c}^{∞}(G,Ω^{1/2}) of smooth 1-densities on G. Coming back to the general case, one has: Proposition Let G be a smooth groupoid, and let C_{c}^{∞}(G,Ω^{1/2}) be the convolution algebra of smooth compactly supported ½-densities, with involution *, f^{*}( [symbol] )=f( [symbol] ⁻¹). Then for each x∈G⁽⁰⁾ the following defines an involutive representation πₓ of C_{c}^{∞}(G,Ω^{1/2}) in the Hilbert space L²(Gₓ): (πₓ(f)ξ( [symbol] )=∫f( [symbol] ₁) ξ( [symbol] ₁⁻¹ [symbol] ) ∀y∈Gₓ, ξ∈L²(Gₓ). The completion of C_{c}^{∞}(G Ω^{1/2}) for the norm ∥f∥=Sup_{x∈G}(0)∥πₓ(f)∥ is a C*-algebra, denoted C^{*}ᵣ(G). As in the case of discrete groups one defines the C*-algebra C^{*}(G) as the completion of the involutive algebra C_{c}^{∞}(G,Ω^{1/2}) for the norm kfkₘₐₓ=sup{kπ(f)k}π involutive Hilbert space representation of C_{c}^{∞}(G,Ω^{1/2}) We let r: C*(G)C*ᵣ(G) be the canonical surjection. Let us now pass to an interesting example of smooth groupoid, namely we construct the tangent groupoid of a manifold M. Let us first describe G at the groupoid level; we shall then describe its smooth structure. We let G=(M×M×]0,1])∪(TM), where TM is the total space of the tangent bundle of M. We let G⁽⁰⁾⊂G be M×[0,1] with inclusion given by (x,ε)→(x,x,ε)∈M×M×]0,1] for x∈M,ε>0. (x,0)→x→M⊂TM as the 0-section, for ε=0. The range and source maps are given respectively by r(x,y,ε)=(x,ε) for x∈M,ε>0 r(x,X)=(x,0) for x∈M,X∈Tₓ(M) s(x,y,ε)=(y,ε) for y∈M,ε>0 s(x,X)=(x,0) for y∈M,X∈Tₓ(M) The composition is given by (x,y,ε)∘(y,z,ε)=(x,z,ε) for ε>0 and x,y,z∈M (x,X)∘(x,Y)=(x,X+Y) for x∈M and X,Y∈Tₓ(M) Putting this in other words, the groupoid G is the union (a union of groupoids is again a groupoid) of the product G₁ of the groupoid M×M of example α) by]0,1] (a set is a groupoid where all the elements belong to G⁽⁰⁾ and of the groupoid G₂=TM which is a union of groups: the tangent spaces Tₓ(M). This decomposition G=G₁∪G₂ of G as a disjoint union is true set theoretically but not at the manifold level. Indeed, we shall now endow G with the manifold structure that it inherits from its identification with the space obtained by blowing up the diagonal Δ=M⊂M×M in the Cartesian square M×M. More explicitly, the topology of G is such that G₁ is an open subset of G and a sequence (xₙ,yₙ,εₙ) of elements of G₁=M×M×]0,1] with εₙ→0 converges to a tangent vector (x,X); X∈Tₓ(M) iff the following holds: The tangent groupoid of M xₙ→x, yₙ→x, xₙ−yₙ/εₙ→X. The last equality makes sense in any local chart around x independently of any choice. One obtains in this way a manifold with boundary, and a local chart around a boundary point (x,X)∈TM is provided, for instance, by a choice of Riemannian metric on M and the following map of an open set of TM×[0,1] to G: ψ(x,X,ε)=(x,expₓ(−εX),ε)∈M×M×]0,1], for ε>0 ψ(X,X,0)=(x,X)∈TM Proposition with the above structure G is a smooth groupoid. We shall call it the tangent groupoid of the manifold M and denote it by G_{M}. The structure of the C_{*}-algebra of this groupoid G_{M} is given by the following immediate translation of the inclusion of G₂=TM as a closed subgroupoid of G_{M}, with complement G1. Proposition to the decomposition G_{M}=G₁∪G₂ of G_{M} as a union of an open and a closed subgroupoid corresponds the exact sequence of C*-algebras 0→C*(G₁)→C^{*}(G)→^{σ}C^{*}(G₂)→0. 2) The C*-algebra C^{*}(G₁) is isomorphic to C₀(]0,1])⊗K, where K is the elementary C*-algebra (all compact operators on Hilbert space). 3) The C*-algebra C^{*}(G₂) is isomorphic to C₀(T^{*}M), the isomorphism being given by the Fourier transform: C^{*}(TₓM)˜C₀(T*ₓM), for each x∈M. It follows from 2) that the C*-algebra C^{*}(G₁) is contractible: it admits a pointwise norm continuous family Θ_{λ} of endomorphisms, λ∈[0,1], such that Θ₀=id and Θ₁=0. (This is easy to check for C₀(]0,1]).) In particular, from the long exact sequence in K-theory we thus get isomorphisms σ_{*}: Kᵢ(C^{*}(G))˜Kᵢ(C^{*}(G₂))=Kⁱ(T^{*}M). On the right-hand side Kⁱ(T^{*}M) is the K-theory with compact supports of the total space of the cotangent bundle. We now have the following geometric reformulation of the analytic index map Indₐ of Atiyah and Singer. Lemma 6. Let p: C^{*}(G)→K=C^{*}(M×M) be the transpose of the inclusion M×M→G: (x,y)→(x,y,1) ═x,y∈M. Then the Atiyah-Singer analytic index is given by Indₐ=ρ_{*}∘(σ_{*})⁻¹: K⁰(T^{*}M)→Z=K₀(K). The proof is straightforward. The map σ: C^{*}(G)→C^{*}(G₂)˜C₀(T^{*}M) is the symbol map of the pseudodifferential calculus for asymptotic pseudodifferential operators. A proof of the index theorem, closely related to the proof of Atiyah and Singer can be adapted to many other situations. Lemma 6 above shows that the analytic index Indₐ has a simple interpretation in terms of the tangent groupoid G_{M}=G. If the smooth groupoids G, G₁, and G₂ involved in this interpretation were equivalent (in the sense of the equivalence of small categories) to ordinary spaces Xⱼ (viewed as groupoids in a trivial way, i.e. Xⱼ=Xⱼ⁽⁰⁾, then we would already have a geometric interpretation of Indₐ, i.e. an index formula. Now the groupoid G₁=M×M×]0,1] is equivalent to the space]0,1] since M×M is equivalent to a single point. Thus the problem comes from G₂ which involves the groups TₓM and is not equivalent to a space. Given any smooth groupoid G and a (smooth) homomorphism h from G to the additive group R^{N} one can form the following smooth groupoid Gₕ:Gₕ=G×R^{N}, Gₕ⁽⁰⁾=G⁽⁰⁾×R^{N} with r( [symbol] ,X)=(r( [symbol] ),X), s( [symbol] ,X)=(s( [symbol] ),X+h( [symbol] )) ∀ [symbol] ∈G, X∈R^{N}, and ( [symbol] ₁,X₁)∘( [symbol] ₂,X₂)=( [symbol] ₁∘ [symbol] ₂,X₁) for any composable pair. Heuristically, if G corresponds to a space X, then the homomorphism h fixes a principal R^{N}-bundle over X and Gₕ corresponds to the total space of this principal bundle. At the level of the associated C*-algebras one has the following: Proposition Let G be a smooth groupoid, h:G→R^{N} a homomorphism. 1) For each character x∈R_{N} of the group R^{N} the following formula defines an automorphism α_{χ} of C^{*}(G):(α_{χ}(f))( [symbol] )=χ(h( [symbol] ))f( [symbol] ) ∀f∈C_{c}^{∞}(G,Ω^{1/2}). 2) The crossed product C^{*}(G)o_{α}R_{N} of C^{*}(G) by the above action α of R_{N}=(R^{N})\hat{ } is the C*-algebra C^{*}(Gₕ). Thus, we see in particular that if N is even, the Thom isomorphism for C*-algebras (Appendix C) gives us a natural isomorphism: K₀(C^{*}(G))˜K₀(C^{*}(Gₕ)). In the case where G corresponds to a space X, the above isomorphism is of course the usual Bott periodicity isomorphism. We shall now see that for a suitable choice of homomorphism G→^{h}R^{N}, where G=G_{M} is the tangent groupoid of M, the smooth groupoids Gₕ, G_{1,h}, and G_{2,h} will be equivalent to spaces, thus yielding a geometric computation of Indₐ and the index theorem. Let M→^{j}R^{N} be an immersion of M in a Euclidean space R^{N}. Then to j corresponds the following homomorphism h of the tangent groupoid G of M into the group R^{N}: h(x, y, ε)=j(x)−j(y)/ε ε>0 h(x, X)=j_{*}(X) ∀X∈Tₓ(M). One checks immediately that j( [symbol] ₁∘ [symbol] ₂)=j( [symbol] ₁)+j( [symbol] ₂) whenever ( [symbol] ₁, [symbol] ₂)∈G⁽²⁾. This homomorphism h defines a free and proper action of G, by translations, on the contractible space R^{N}. This follows because j is an immersion, so that j_{*} is injective. The smooth groupoid Gₕ is thus equivalent to the classifying space BG, which is the quotient of G⁽⁰⁾×R^{N} by the equivalence relation (x,X)˜(y,Y) iff ∃∈G r( [symbol] )=x, s( [symbol] )=y, X=Y+h( [symbol] ). Since the action is free and proper the quotient makes good sense. Similar statements hold for G₁ and G₂. A straightforward computation yields BG=i]0,1]×R ^{N} [symbol] ∪v(M) where v(M) is the total space of the normal bundle of M in R^{N}. In this decomposition, BG=BG₁∪BG₂, one identifies BG₂, the quotient of G₂⁽⁰⁾×R^{N}=M×R^{N} by the action of G₂=TM, with the total space of v, vₓ=R^{N}/Tₓ(M). (We refer to). “The isomorphism α of (]0,1]×R^{N}) with the quotient BG₁ of G₁⁽⁰⁾×R^{N}=(]0, 1]×M)×R^{N} by the action of G₁ depends upon the choice of a base point x₀∈M, and to simplify the formulae we take j(x₀)=0∈R^{N}. One then has α(ε,X)=((x₀,ε),X) ∀ε>0, X∈R^{N}. with this notation the locally compact topology of BG is obtained by gluing]0,1]×R^{N} to v(M) by the following rule: (εₙ,Xₙ)→(x,Y) for εₙ→0, x∈M,Y∈vₓ(M) iff Xₙ→j(x)∈R^{N} and Xₙ−j(x)/εₙ→Y in vₓ(M). Using the Euclidean structure of R^{N} we can view vₓ(M) as the subspace orthogonal to j_{*}Tₓ(M)⊂R^{N} and use the following local chart around (x,Y)∈v(M): ϕ(x,Y,ε)=(ε,j(x)+εY)∈]0,1]×R^{N} for ε>0. To the decomposition of Gₕ as a union of the open groupoid G_{1,h} and the closed groupoid G_{2,h} corresponds the decomposition BG=BG₁∪BG₂. BG₁ is properly contractible and thus we get a well-defined K-theory map ψ:K⁰(BG₂)˜K⁰(BG)→K⁰(R^{N}) which corresponds to the analytic index Indₐ=ρ_{*}∘(σ_{*})⁻¹ under the Thom isomorphisms K₀(C*(Gᵢ))˜K₀(C^{*}(G_{h,i}))=K⁰(BGᵢ). Now, from the definition of the topology of BG it follows that ψ is the natural excision map K⁰(v(M))→K⁰(R^{N}) of the normal bundle of M, viewed as an open set in R^{N}. Moreover, the Thom isomorphism K⁰(R^{N})˜^{β}Z is the Bott periodicity, while the Thom isomorphism K⁰(T^{*}M)˜K₀(C^{*}(G₂))˜K₀(C^{*}(G_{2,h}))−K⁰(BG₂) is the usual Thom isomorphism τ:K⁰(T^{*}M)˜K⁰(v(M)). Thus we have obtained the following formula: Indₐ=β∘ψ∘τ which is the Atiyah-Singer index theorem ([26]), the right-hand side being the topological index Indₜ. We used this proof to illustrate the general principle of first reformulating, as in Lemma 6, the analytical index problems in terms of smooth groupoids and their K-theory (through the associated C*-algebras), and then of making use of free and proper actions of groupoids on cotractible spaces to replace the groupoids involved by spaces, for which the computations become automatically geometric”. [Noncommutative Geometry By Alain Connes Topology and K-Theory chapter II page 106.] Meaning that the angular velocity is constant, and the angular displacement is related to the angular velocity by the equation: Θ=ωτ. The connection between uniform circular motion, and simple harmonic motion the close connection between circular motion, and simple harmonic motion. For an object having uniform circular motion, is two-dimensional motion, and the x and y position of the object at any time can be found by applying the equations: x=r cos Θ, and y=r sin Θ. Therefore, d²x/dτ²=−k/mx, solving a differential equation produces a solution that is a sinusoidal function. X(τ)=x₀ cos(ωτ)+v₀/ω sin(ωτ) this equation is written in the form: x(τ)=A cos(ωτ−ϕ), where ω=√k/m, A=√c₁²+c₂², tan ϕ=√c₂/c₁, in the solution, c₁ and c₂ are two constants determined by the initial conditions, and the origin is set to be the equilibrium position. Each of these constants carries a physical meaning of the motion: A is the amplitude (maximum displacement from the equilibrium position), ω=2πf is the angular frequency, and ϕ is the phase. Using the techniques of calculus, the velocity and acceleration as a function of time can be found: v(τ)=dx/dτ=−Aω sin(ωτ−ϕ), speed: ω√A²−x². Maximum speed: ωA (at equilibrium point) a(τ)=d²x/dτ²=−Aω² cos(ωτ−ϕ). Maximum acceleration: Aω² (at extreme points). By definition, if a mass m is under simple harmonic motion its acceleration is directly proportional to displacement; a(x)=−ω2x where ω2=k/m since ω=2πf, f=½π √k/m, and, since T=1/f where T is the time period, T=2π √m/k. These equations demonstrate that the simple harmonic motion is isochronous (the period and frequency are independent of the amplitude and the initial phase of the motion). Our system period basis of the Abelian function AI(z) may be represented as AI(z)=AI(z1, . . , zp)=R[x1(z1, . . . , zp), . . . , xp(z1, . . . , zp)], define the period parallelotope of f(z) numeric value built from calculated the expectation value of position and momentum complex function of this form Y=e^{ipx/h}, where p is some number takes at a point relative centre number vector velocity stream period basis of the Abelian function AI(z) may be represented as AI(z)=AI(z1, . . . , zp)=R[x1(z1, . . . , zp), . . . , xp(z1, . . . , zp)], define the period parallelotope of f(z) numeric value greater than >0 some number+positive (above zero annulation) is written, or number vector velocity stream period basis of the Abelian function AI(z) may be represented as AI(z)=AI(z1, . . . , zp)=R[x1(z1, . . . , zp), . . . , xp(z1, . . . , zp)], define the period parallelotope of f(z) numeric, zero-centered calibrated zeroing annulation a-axis Load factor LF is our ratio of two forces: load (force) L, or weight W=L/W. Our global measure of stress on the structure stationary compression along the force of load axis, is three dimensions n−2+d−1+o(1) expected query time with o(n) space, matching the volume of the n-ball form a Dirichlet interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path mathematical probability add up to 1. Symmetrical sharp corners in A configuration joined regular sides ABCD by its circumscribed-sphere unit cell axial circle continued in equilateral-shape two lines of symmetry planes o(n1−2/(d+1)) expected query time with o(n) space, quantum-number matching the volume of the n-dimension n o(n1−2/(d+1)) expected query time with o(n) space, quantum-number matching the volume of the n-dimension n satisfying Vn−1<VnR, and Vn≥Vn+1R 2·f (n/2) if n is even, and n>0 f (n−1)+1 if n is odd are quantum-numbers of a dynamical system. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax b of m inequalities with n variables A is m×n matrix is convex, A set of this type is three dimensions in steady-state motion with α, β, and ϕ small, is written with equations in terms of load factor as (n−cos Θ) g-units natural base. The Dirichlet carrier-function L(s,χ) character, χ for the solid domain linear approximation by ridgelets converges rapidly to nice ridge functions let be the open star of the i^{th} vertex X; of L′. Then (Uᵢ) is an open covering of L. We can choose a barycentric subdivision K′ of K such that each simplex τ of K′ is contained in a set of the form f⁻¹(U¹). Then the minimal carrier of τ consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties generating a series interval A step path in S is a path y:[A, b]→S together with a subdivision a=τ₀<τ₁<τ₂<∧<tₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped longitude, or transverse combination while for the only transverse measure X for (v,f) (the horocycle flow being strongly ergodic), the composition of the above analytic index with dim X: K^{*}(C^{*}(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. We summand a directed left module Q over the ring R so to be injective satisfying 1-1 structure of the Dual Algebra the monomials ε^{I} in a′ correspond in a one-to-one way with sequences of non-negative integers (i₁, i₂, • • •, iₙ, 0, • • •) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] →0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈c(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue. Trivially, the zero module {0} is injective, applied combination of Dirichlet series number of our weighted sets of objects with respect to a weight which is combined exponentially when taking Cartesian products. Suppose that A is a set with function w:A→N assigning a weight to each of the elements of A with weight n. Then we define the formal Dirichlet generating series for A with respect to w. We call such an arrangement (A,w) a weighted set. Dirichlet linear interval A step path in S is a path y:[A, b]→S together with a subdivision a=τ₀<τ₁<τ₂<∧<Tₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points evenly spaced numbers of steady-state system theory, our system and process of a steady-state solution which are null-spaces of a positive number n of length n when the state variables which define the behavior of the system and process are unchanging in time. In continuous time, this means that for those properties p of the system, the partial derivative with respect to time is zero and remains so. In mathematics and in our dynamical system, a linear difference equation equates to 0 to a polynomial that is linear in the various iterates of a variable that is, in the values of the elements of a sequence. All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. Absolute maximum of the values of the function on each set of the isotopy class [A] of closed sets, and define a lower bound of these maxima over all sets of the sub-plasma work power energy of a system E_{sys} conservation and matter relation subspace isotopic class [A]. The lower bound thus obtained will be called the maximum-minimum of the values of the function f on the class [A] and denoted by Infmax_{[A]}f the principle of least ‘stationary’ action variation function of applied action quantum mechanical environmental control unit ECU sub-plasma work power energy of a system E_{sys} conservation, and matter relation subspace isotopic class [A] system. Simplicial and powerful order of equations of the motion of our system, in relativity are the normalization function of a different action. The normalization function of a different action the motion of our system of equations eigenfunctions the principal of the eigenvalues of arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹, μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹), U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧}(v_{λ},w_{λ}) (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)^{*}w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where n is a representation of A on H and U is a unitary representation of G such that π (αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define of v=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1) [symbol] (spec(k)):F (spec(k))→HomS (spec(k), X(F)) is a bijection for every algebraically closed field k, (2) For any S-scheme Y and any natural transformation ψ:F→HomS (*, Y), there is a unique natural transformation Π:HomS (*, X(F)) HomS (*, Y) such that ψ=Π∘ [symbol] . These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A,μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻(22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}₋₃₂₈ p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1+a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1) ∥a∥≥|μ(a)|. For arbitrary a, |μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μ_{b} is also a continuous positive linear functional. Now: [symbol] πₐ(b), πₐ(b) [symbol] = [symbol] ab,ab [symbol] =μ(b*a*ab)=μb(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β,⁻α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻(in C(X)) then μ(f)∈R. Suppose μ(f)=r+is. Then for τ∈R we have |μ(f+it)|²≤∥f+it∥²=∥f∥²+t² (36)) but the LHS is equal to |r+i(s+t)|²=r²+s²+2st+t²(37) and subtracting t² from both sides gives a contradiction unless s=0. Now, if f≥0 we have ∥f−∥f∥∥, hence |μ(f)−∥f∥ |=|μ(f−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. |μ(a)|²≤∥μ∥μ(a*a). Proof. Write μ(a*)=limμ(a*e_{λ})=lim [symbol] a,e_{λ} [symbol] _{μ} (39) and since we know we have an inner product, this is equal to lim [symbol] e_{λ}, a [symbol] ⁻=lim μ(e*_{λ}a)⁻=μ(a)⁻ (40) as desired. Next, write |μ(a)|²=lim |μ(e_{λ}a)|²=lim | [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)^{*}(a+λ1))=μ(a*a)+λμ⁻¹(a)+λμ(a)+|λ|²∥μ∥ (43) which is greater than or equal to μ(a*a)−2|λ∥μ(a)|+|λ|²∥μ∥≥μ(a*a)−2|λ| ∥μ∥^{1/2}μ(a*a)^{1/2}+|λ|²∥μ∥=(μ(a*a)^{1/2}−|λ| ∥μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict π to A, then v remains a cyclic vector for π|_{A}. Proof. Choose a self-adjoint sequence aₙ with ∥aₙ∥≤1 so that μ(aₙ)↑∥μ∥. Then ∥π(aₙ)v−v∥²=μ(a*ₙaₙ)−μ(aₙ)−μ(a*ₙ)+∥μ∥−μ(aₙ)→0 (45) as desired. If A is a non-unital *-normed algebra, (π,H) a nondegenerate *-representation, and ex is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity ex. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,v be positive linear functionals. Then μ≥v if μ−v≥0; we say that v is subordinate to μ. Given μ, let (π,H,v) be the corresponding GNS representation. Consider End_{A}(H). Let T∈End_{A}(H) be a positive operator smaller than the identity and set v(a)=v_{T}(a)= [symbol] π(a)Tv,v [symbol] (47). (Then T is the Radon-Nikodym derivative of v with respect to μ.) We compute that v(a*a)= [symbol] π(a*a)Tv,v [symbol] = [symbol] T^{1/2}π(a)v,T^{1/2}π(a)v [symbol] ≥0 (48) so v is positive. Similarly, μ−v is positive. Moreover, if v_{T}=v_{S} then T=S (by nondegeneracy). Conversely, suppose visa positive linear functional with μ≥v≥0, we want to show that v=v_{T} for some T∈End_{A}(H). For a,b∈A we have |v(b*a)|<v(a*a)^{1/2}v(b*b)^{1/2}≤≤μ(a*a)^{1/2}μ(b*b)^{1/2}∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that v(b*a)= [symbol] π(a)v,T^{*}π(b)v [symbol] (51). Since v≥0 we have T≥0. Since v μ, we have T≤I. To show that T∈End_{A}(H), write [symbol] π(c)Tπ(a)v,π(b)v [symbol] = [symbol] Tπ(a)v,π(C*b)v [symbol] (52)=v((C*b)^{*}a) (53)=v(b*ca) (54)= [symbol] π(c)π(a)v,T *π(b)v [symbol] (55) which gives π(c)T=Tπ(c) by density. We can encapsulate our work above in the following. Proposition 2.36. The map T→v_{T} is a bijection between {T∈End_{A}(H): 0≤T≤I} and {v: μ≥v≥0}. Definition A positive linear functional is pure if whenever μ≥v≥0 then v=rμ for some r∈[0,1]. Theorem 2.37. Let μ be a positive linear functional. Then μ is pure iff the associated GNS representation (π,H,v) is irreducible. Proof. If μ is not pure, there is μ≥v≥0 such that v is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then v_{P} is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−v∥=lim(μ−v)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V^{*} takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)μ=∥π^{U}(a)∥=∥a∥ (where π^{U} is the universal representation). Proof. Let a∈A be self-adjoint. Then there exists ρ∈S(A) with |ρ(a)|=∥a∥. Let Sₑ(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that ∥μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A^{*} in the weak-* topology and its extreme points are the extreme states Sₑ(A) together with 0. 208 C*-algebras Marc Rieffel Notes by Qiaochu Yuan Spring 2013. Degenerate Abelian functions are distinguished by having infinitely small periods, such as for any number ϵ>0 it is possible to find a period wᵥ, if p=1. The vectors wᵥ of all periods, or the system of periods of the Abelian function f (z) form an Abelian group Γ under addition, the period group, or the period module, a basis of this group is a system of periods of the Abelian function, or also as a system of basic periods, an Abelian function f (z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2 (2^{x-1}+4^{y}(1^{x+y}) is the real Euclidean space R^{2p} fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ(W, M₀)∈Wh(π) vanishes. (2) For any x∈Wh(π) there is an h-cobordism (W; M₀, f₀, M₁, f₁) over M₀ with τ(W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′, M₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ(W, M₀)∈Wh(π₁(M₀)), (7.2) is defined to be the preimage of the Whitehead torsion (see Definition 6.12) τM₀^{f0}→∂₀Wⁱ⁰→W)∈Wh(πᵢ(W)) under the isomorphism (i₀∘f₀)_{*}:Wh(π₁(M₀)) Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H^{*}(M)≅H^{*}(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i=0, 1 be two embedded disjoint disks. Put W=M (int(Dⁿ₀) [symbol] int(Dⁿ₁)). Then W turns out to be a simply connected h-cobordism. Hence we can find a diffeomorphism F:(∂Dⁿ₀[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:∂Dⁿ₀→Dⁿ₁. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0}Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0.1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀ x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ˜ on a set S is the smallest reflexive relation on S that is a superset of ˜. equivalently, it is the union of ˜ and the identity relation on S, formally: (≃)=(˜)∪(=). For example, the reflexive closure of x<y is x≤y. The reflexive reduction, or irreflexive kernel, of a binary relation ˜ on a set S is the smallest relation \tilde{≠} such that \tilde{≠} shares the same reflexive closure as ˜. It can be seen in a way as the opposite of the reflexive closure. It is equivalent to the complement of the identity relation on S with regard to ˜, formally: (\tilde{≠})=(˜)\(=). That is, it is equivalent to ˜ except for where x˜x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0} αₑₓₚ(_{τ}x)(α_{f}(b)−(α_{f}(b)/τ=lim_{τ→0} αₑₓₚ(_{τ}x)∫G f(x)αₓ(b)dx−∫G f(x)αₓ(b)dx/τ=lim_{τ→0}1/τ(∫f(x)αₑₓₚ(τx)x(b)−∫f(x)αₓ(b)dx)=lim_{τ→0}∫(αₑₓₚ(τx)f)(x)−f(x)/τ αₓ(b)dx=f(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Incipient p-wave PF power transmission superconducter the operator PF A, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }=0, we need to prove that [PF\hat{ }, G\hat{ }=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Then we have (modeled as x=A_{*}s where the ‘mixing matrix’ is invertible and the n×1 vector s=isotypic components Bₙ, where bₙ∈Bₙ if αᵥ(bₙ)=e^{2π} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (Dₓ(b))ₙ=Dₓ(bₙ) where bₙ is the n^{th} isotypic component. Let be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ² [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(1)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈∧, let bλ=Xa*a. a∈A Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈X, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bπ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k<ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from n(X, x₀) to n(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of L can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. The projection p:V→V/F is naturally K-oriented and the following maps from K^{*}(V) to K(C^{*}(V,F)) coincide: 1) p! (cf. Theorem) which, up to the Thom isomorphism, K^{*}(F)˜K^{*+1}(V) is equal by Lemma 7 to Indₐ=Indₜ. 2) The Thom isomorphism (Appendix C) ϕ:K^{*}(V)=K(C(V))→K(C(V)oR)=K(C^{*}(V,F)) where we used an arbitrary flow defining the foliation. In particular, by Appendix C, ϕ is an isomorphism and so are the map p! and the index Indₐ:K^{*}(F)→K(C^{*}(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K^{*}(V) onto K(C^{*}(V,F)), while for the only transverse measure ∧ for (V,F) (the horocycle flow being strongly ergodic), the composition of the above analytic index with dim_{∧}:preserving K^{*}(C^{*}(V,F))→R is equal to 0, so in particular dim∧ is identically 0, submitting K(C^{*}(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar X(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and ϕ(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse A of the map [symbol] _{*}([114 1) (3.38) λ:H^{*}(A)→H^{*}_{τ}(BG). In fact, we shall only describe the composition of this map with the pull-back H^{*}_{τ}(BG)→H^{*}_{τ}(V). When one varies V without varying V/F one gets the desired information. The idea of the construction of (3.39) λᵥ:H^{*}(A) H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map from the periodic cyclic cohomology H^{*}(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )=∫ [symbol] _{1∘} [symbol] _{2=y} a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ⁻¹ [symbol] ), we define on the base of the natural plane constant are the first convex set eigenfunctions form a complete set subspace which is a linear resolution eigenvalue of modulus 1. normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=P i t ik, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Si are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant: A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and g i: X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B^{*}B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of T consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H^{*}(A) H^{*}_{τ}(BG). In fact, we shall only describe the composition of this map with the pull-back H^{*}_{τ}(BG) H^{*}_{τ}(V). When one varies V without varying V/F one gets the desired information. The idea of the construction of (3.39) λᵥ:H^{*}(A) H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ zone has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12)“. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group [is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Si as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R₀, i, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. a) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [tⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C^{*}(V,F))) is equal to {hCh(E),[C]i;[E]∈K^{*}(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F: R-Mod→S-Mod be an equivalence of categories. Lemma 1. Let R be a strongly semiprime ring. Then for every q∈Q(R) there exist elements i₁, . . . , iₙ∈R and ψ₁, . . . , ωₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components Bₙ. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod S-Mod be an equivalence of categories. Linear and Local Thermal Transmittances: The linear thermal transmittance, symbol ψ, units: W/(m•K), the heat transfer in Kelvin temperature by Newton Ring's [symbol] :=s²/2r:=N:=λ/2 is the gravitational force. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}₁)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1).
Thus (x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞⋅1, ∞⋅2, . . . , ∞⋅n}{∞⋅1, ∞⋅2, . . . , ∞˜n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18 +4x17 +10x16 +19x15+31x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1<∞, 0≤x2≤50≤x2≤5, 0≤x3≤50≤x3≤5, 2≤x4≤62x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8 +1 02x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²+(p¹)²=0, we can write pₐₐ_{^{⋅}}=λₐ,λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴I+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²+(p³)²+(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write Pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}ₐ_{^{⋅}}→(Lᵣ)ₐ^{.β.}λ^{˜}_{β}_{^{⋅}}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ Bⱼ C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F; is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06 1. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that of [symbol] f=g, the following diagram commutes: [symbol] *0→X^{g}↓ [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let ∧ be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M >M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r>0 in Z one has r=1+1+^{(r)} . . . +1, and thus rm=(1+ [symbol] +1)m=1m+ [symbol] +1m=m+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=α(v) extending to xⁿ*v:=αⁿ(v)=α(α(⁽ⁿ⁾ . . . α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map a: V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α: V6→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • , iₙ, 0, • • • ). The admissible monomials Sq^{I′}∈a correspond to sequences of integers (i′₁, i′₂, • • • , i′ₙ, 0, • • • ) where i′ₖ≥2i′ₖ₊₁ and i′ₙ≥1. It remains only to set up a one-to-one correspondence between sequences of non-negative integers I and admissible sequences such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences I′ by insisting that Iₖ be sent to I′ₖ and that the map be additive (with respect to coordinate-wise addition). Then if I=(I₁, • • • , iₙ, 0, • • • )→I′=(I′₁, • • • , i′ₙ, 0, • • • ) ε^{I} and Sq^{I′} have the same degree and we have i′ₖ=iₖ+2iₖ₊₁+ • • • +2^{n-k} iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”. (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all a∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B ^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the Cochain level. 1.5. Lemma. Let (p,A,K) be an algebraic triple. Let π be a normal subgroup of p and let y→p. Let g: (α,A,K)→(π,A,K) be the automorphism determined by y. Then the image H*ₚ(K;A)→H*_{π}(K;A) is pointwise invariant under the automorphism g.* Proof. let f: (p,A,K)→(p,A,K) be the inner automorphism determined by y. Then by 1.2, the following diagram is commutative H*ₚ(K;A)^{f*}→H*ₚ(K;A)→H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topology—that is, a set is open if and only if its intersection with every finite subcomplex is open, (i.e. K is a CW complex). Let K and L be cell complexes. A carrier from K to L is a function C which assigns to each cell t∈K a subcomplex C(τ) of L such that a face oft is sent to a subcomplex of C(τ). An acyclic carrier is one such that C(τ) is acyclic for each t∈K. Let p and n be groups which act on K and L respectively (consistently with their cell structures), and let h: p r i be a homomorphism. An equivariant carrier is one such that C(ατ)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group π, we can always construct a π-free acyclic simplicial complex W. Proof. We give π the discrete topology and form the infinite repeated join W=π•π•π . . . This repeated join is a simplicial complex. Taking the join of a complex with a point gives us a contractible space. Any cycle in W must lie in a finite repeated join W′. Such a cycle is homologous to zero in W′•π. Therefore, W is acyclic. We make π act on W as follows:π acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C^{*}ᵣ(G): random dilution of random matrices H_{N}=U_{N} F_{N} U^{†}N, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)≥0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1→zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)_{K}ϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ})). Group G in is a finite extension of a torsion free non-cyclic indecomposable subgroup G₁ of the form G₁= [symbol] a₁, b₁, • • • , a_{g}, b_{g}; Π[aᵢ, bᵢ [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁(n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . The functions dᵣ (n, k) are given by the recurrence relation dᵣ (n, k)=(n−1) dᵣ (n−1, k)+(n−1)ᵣ₋₁dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1 +5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cᵢ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ})^{1/2}<K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components B n of squelch of squelch (noise) is additive, or when, the process of pointwise isotypic components Bₙ of squelch of squelch (noise) disable is subtractive, that is when the diffusion coefficient has the form b(t,x)∈b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,∞). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2 Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|<O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of L, , can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)!i. (n−1)!=(−1)i(n+i−1i)=(−1)i(n+i−1n−1).
Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞⋅1, ∞⋅2, . . . , ∞⋅n}{∞⋅1, ∞⋅2, . . . , ∞⋅n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50x3≤5, 2≤x4≤62x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x3≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x35, 2≤x4≤62<x4≤6. We find that x1×1 is not bounded above. The generating function thus F(x)=(1+x+x2+)(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+)(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+)(1−x)−1=(1+x+x2+) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+102x9+125x10+145x11+160x12+170x13+176x14+179x15+180x16+180x17+180x18+180x19+180x 20+. We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+)(1+x2+x4+)(1+x+x2+x3+)=x(1+(x2)+(x2)2+(x2)3+)(1+(x2)+(x2)2+(x2)3+)11−x=x(1 x2)2(1−x).(x+x3+x5+)(1+x2+x4+)(1+x+x2+x3+)=x(1+(x2)+(x2)2+(x2)3+)(1+(x2)+(x2)2+(x2)3+)11−x=x(1 x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix 6² of its i and define (for our purposes here) σ²=(⁰₁⁻¹₀) Any real 2-by-2 matrix p (this matrix is of course to be distinguished from the matrix p in (1)) can be decomposed as p=p⁴I+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²+(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R) SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²⁼⁰, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β}λ_{β} and λ^{˜}_{a′}→(Lᵣ)_{a′}^{β′}λ^{˜}_{β′}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into Then ₘFᵢ₋₁ has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential a. The associated graded complex induced by the filtration G·F, denoted by lin^{R} F, is called the linear part of F. We define the linearity defect of M as the number Id_{R} M=sup{i:H,(lin^{R} F)=06 1. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X^{g}↓ [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r>0 in Z one has r=1+1+^{(r)} . . . +1, and thus rm=(1+ [symbol] +1)m=1m+^{(r)} . . . +1M=M+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V(x, v)→x*v:=α(v) extending to xⁿ*v:=αⁿ(v)=α(α(⁽ⁿ⁾ . . . α(v))) and (Σαᵢxᵢ)*v:=Σaᵢxᵢ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let RM be an R-module, a subset p⊆M is said to be a submodule of M if: P is a subgroup of (M, +), i.e. P≠Ø, for all a, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “5 2. 1-1 Structure of the Dual Algebra the monomials ε^{I} in a′ thus correspond in a one-to-one way with sequences of non-negative integers (i₁, i₂, • • • , iₙ, 0, • • • ). The admissible monomials Sq^{I′}∈a correspond to sequences of integers (i′₁, i′₂, • • • , iₙ, 0, • • • ) where i′ₖ≥2i′ₖ₊₁ and i′ₙ≥1. It remains only to set up a one-to-one correspondence between sequences of non-negative integers I and admissible sequences I′ such that ε^{I} and Sq^{I′ have the same degree. Let I}ₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences I′ by insisting that Ik be sent to I′ₖ and that the map be additive (with respect to coordinate-wise addition). Then if I=(i₁, • • • , iₙ, 0, • • • )→I′=(i′₁, • • • , i′ₙ, 0, • • • ) ε^{I} and Sq^{I′} have the same degree and we have i′ₖ=iₖ+2iₖ₊₁+ • • • +2^{n-k}iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”. (we refer to). Cohomology Operations Lectures By N. E. Steenrod Written And Revised By D. B. A. Epstein. “5 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ(K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*ₚ(K;A) be the homology of the complex C*ₚ(K;A) and H*ₚ(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If n is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*ₚ(K;A) by 1.2. 1.4. Lemma. An inner automorphism of the algebraic triple (p,A,K) induces the identity map on H*ₚ(K;A). Proof. The induced map is the identity on the cochain level. 1.5. Lemma. Let (p,A,K) be an algebraic triple. Let n be a normal subgroup of p and let y→p. Let g:(π,A,K) (π,A,K) be the automorphism determined by y. Then the image H*ₚ(K;A) H*_{π}(K;A) is pointwise invariant under the automorphism g.* Proof. let f: (p,A,K)→(p,A,K) be the inner automorphism determined by y. Then by 1.2, the following diagram is commutative H*ₚ(K;A)→H*ₚ(K;A)→H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face oft is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(a) C(τ) for all α∈p and τ∈K. Let ϕ:K→L be a chain map: we say ϕ is carried by C If τ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(T) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group π, we can always construct a π-free acyclic simplicial complex W. Proof. We give π the discrete topology and form the infinite repeated join W=π•π•π . . . . This repeated join is a simplicial complex. Taking the join of a complex with a point gives us a contractible space. Any cycle in W must lie in a finite repeated join W′. Such a cycle is homologous to zero in W′•π. Therefore, W is acyclic. We make π act on W as follows:π acts by left multiplication on each factor n of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(T)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W) (p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π},(W;A). 2.4. Lemma. H*(π;A), is a contravariant functor from the category of pairs (see 1.1)”. An element of the K-group of the parameter space groupoid of the manifold M through the associated C*-algebra C^{*}ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, b₁] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S=₁ (n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates x i (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant Ks does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order y∈(0,∞] if there exists a finite constant K and a positive constant S₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅ᵣ^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(hₘ₊₁) A is the inductive limit of finite-dimensional algebras. It is said to be approximately finite (or AF). 2) (K₀(A), K₀(A)⁺)={(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ,cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R+x R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δn} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +em(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +em(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>Pₙ₋₁+p_{n+1/2}. semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant Ks does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components B n of squelch of squelch (noise) is additive, or when, the process of pointwise isotypic components B n of squelch of squelch (noise) disable is subtractive, that is when the diffusion coefficient has the form b(t,x) b(t) for all (t,x)∈R+x Rd, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order δ∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b m satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant ∂₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁ ∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′, M′₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, t (W, M₀)∈Wh(π₁(M₀)), (7.2) is defined to be the preimage of the Whitehead torsion (see Definition 6.12) τ M₀^{f0} ∂₀Wⁱ⁾→W)∈Wh(π₁(W)) under the isomorphism (i₀∘f₀)_{*}:Wh(π₁(M₀))^{≅}→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman. [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7. 3. implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H•(M)≅H•(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i=0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f: Dⁿ→Dⁿ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0,1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀ x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜})∪(=). For example, the reflexive closure of x<y is x≤y. The reflexive reduction, or irreflexive kernel, of a binary relation on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τx)f)(x)−f(x)/τ αₓ(b)dx=f(Dₓf)(x)αₓ(b)dx where we use the fact that (a_{y}f)(x)=f(y⁻¹x). Is it true that every b∈B^{∞} has the form α_{f}(c) for some f∈C_{c}^{∞}(G) and c∈B^{∞} Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PE)ₖϕₖ=(PF)ₖG\hat{ }ϕₖ=(PF)ₖgₖϕₖ. Thus we proved that for the 4 eigenfunctions: [PF\hat{ }, G\hat{ }] ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A1, . . . , Aₛ}] power series expansion. Then we have (modeled as x=A_{*}s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (D_{X}(b))ₙ=D_{X}(bₙ) where bₙ is the n^{th} isotypic component. Let e₁, . . . , e_{d} be a basis of R^{d}. Then (D^{2p}ₑ₁ D^{2p}ₑ₂ . . . D^{2p}_{ed})(bₙ)=(2πi)^{2pd} [symbol] n, e₁ [symbol] . . . [symbol] n, e_{d} [symbol] ^{2p}bₙ from which it follows that |bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n >0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H) g I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L(0)=p and L(1)=p X is a topological space and p∈X, a loop is a continuous map L:[0, 1]→X such that L(0)=p and L(1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈λ, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk=1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of 1, , can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. The projection p:V→V/F is naturally K-oriented and the following maps from K^{*}(V) to K(C^{*}(V,F)) coincide: 1) p! (cf. Theorem) which, up to the Thom isomorphism, K^{*}(F)˜K^{*+1}(V) is equal by Lemma 7 to Indₐ=Indₜ. 2) The Thom isomorphism (Appendix C) ϕ:K^{*}(V)=K(C(V))→K(C(V)oR)=K(C^{*}(V,F)) where we used an arbitrary flow defining the foliation. In particular, by Appendix C, ϕ is an isomorphism and so are the map p! and the index Indₐ:K^{*}(F)K(C^{*}(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K^{*}(V) onto K(C^{*}(V,F)), while for the only transverse measure ∧ for (V,F) (the horocycle flow being strongly ergodic), the composition of the above analytic index with dim_{∧}: preserving K^{*}(C^{*}(V,F))→R is equal to 0, so in particular dim∧ is identically 0, submitting K(C^{*}(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H^{*}(A) H^{*}_{τ}(BG). In fact, we shall only describe the composition of this map with the pull-back H^{*}_{τ}(BG)→H^{*}_{τ}(V). When one varies V without varying V/F one gets the desired information. The idea of the construction of (3.39) λᵥ:H^{*}(A)→H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (Zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (5, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′ X, whose restriction to S₀ is go and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r(z,1229 ) and X₁G^{x}, x=r(z,1229 ), infinite connected manifolds the Θⱼ(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r(z,1229 ) and X₁ G^{x}, x=r(z,1229 ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ₋₁n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [tⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H^{*}(A) H^{*}_{τ}(BG). In fact, we shall only describe the composition of this map with the pull-back H^{*}_{τ}(BG) H_{*}^{τ}(V). When one varies V without varying V/F one gets the desired information. The idea of the construction of (3.39) λᵥ:H^{*}(A)→H^{*}_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix (W. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S i as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [5, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r(z,1259 ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3++ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert Huang transform (HHT). We now decompose our load, or signal into so-called intrinsic mode function (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C^{*}(V,F))) is equal to {hCh(E),[C]i;[E]∈K^{*}(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of 1, , can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F: R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components Bₙ. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Linear and Local Thermal Transmittances: The linear thermal transmittance, symbol ψ, units: W/(m•K), the heat transfer in Kelvin temperature by Newton Ring's [symbol] :=s²/2r:=N:=λ/2 is the gravitational force. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)!i!(n−1)!=(−1)i(n+i−1 0=(−1)i(n+i−1n−1).
Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞⋅1, ∞⋅2, . . . , ∞⋅n}{∞⋅1, ∞⋅2, . . . , ∞⋅n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1<20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+102x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜ two independent real spinors. We consider the group SO(}2,2). The groups SO(m,n) as a Minkowski (space) already noted in his famous paper (we refer to), it is a simple matter of removing (or adding) an i here and there. Let us strip the Pauli matrix 6² of its i and define (for our purposes here) σ²≡(⁰₁⁻¹₀). Any real 2-by-2 matrix p (this matrix is of course to be distinguished from the matrix p in (1)) can be decomposed as p=p⁴|+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²+(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗(8) SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β} λ_{β} and λ^{˜}ₐ_{^{⋅}}→(Lᵣ)ₐ^{.β.}λ^{˜}_{β}_{^{⋅}}. We obtain a confining potential that is strongly anisotropic the range signals (sources) of variations in directions and our system of equations orders in the number of terms in magnitudes. Our limit in the ratio of our signals (sources) under gamma's definition [symbol] =lim_{n→∞}(Hₙ−1n n), when rewritten as the asymptotic approximation Hₙ≈1n n+ [symbol] , provides a simple (and accurate) method for approximating the partial sums of the harmonic series y allowing the harmonic series to be replaced by logarithms, this time not as an estimate but the exact limit. For fixed xᵢ (i=1, . . . , p) the function f (xᵢ, cⱼ) is defined on the manifold N Q and the points of the set D_{c} are critical for f(xᵢ, cⱼ), so that D_{c} contains a least PrE1N^{q} geometrically distinct points. Changing xᵢ (i=1, . . . , p) and taking into account that merging of geometrically distinct critical points is not possible, we can now assert that D_{c} contains at least PrE1N^{q}, generally speaking, nonintersecting²² sets, homeomorphic to M^{p}. The points of set D, at which the determinant 2f/cᵢcⱼ≠0, classified by certain properties of envelopes and method of Ljustenik and Snirel'man for estimating the number of geometrically distinct critical points can be classified into various types, and depending on these types, one can make some inferences regarding their position relative to nearby level surface point structure, or solid domain occupies surface point structure which makes it possible in turn to investigate certain properties of envelopes. The maximum-minimum principle and its generalization. The generalization of the method of Ljustenik and Snirel'man for estimating the number of geometrically distinct critical points. A collection of sets closed with the respect to isotopic deformation in the space Mⁿ will be called an isotopy class. A collection of sets forming an isotopy class must, along with any set A, contain all isotopic deformations 1(A) of the set A. One can obtain an isotopy class by considering the collection of all the sets of a given space having in common some topological or isotopic property. The following sets form isotopy classes: (a) the collection of sets of some manifold M containing a cycle homologous in M to a given cycle z; (b) the collection of sets of a manifold M containing a cycle homotopic to a given cycle z; (c) the collection of sets of a manifold M containing a cycle isotopic to a given cycle z; (d) the collection of all sets of a manifold of a given length or of given category; (e) the collection of sets whose category or length is not less than a given number p. An isotopy class is said to be closed if it contains the topological limit of any sequence of sets in it. Indeed, let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series at 0; or zero power (except 0) equals 1. A power series (centered at 0) is a series of the form ^{∞}Σₙ₌₀ aₙxⁿ=a₀+a₁x+a₂x²+ . . . +aₙxⁿ+ . . . , where the aₙ are some coefficients. If all but finitely many of the aₙ are zero, then the power series is a polynomial function, but if infinitely many of the aₙ are nonzero, then we need to consider the convergence of the power series. The basic facts are these: Every power series has a radius of convergence 0≤R≤∞, which depends on the coefficients aₙ. The power series converges absolutely in |x|<R and diverges in |x|>R, and the convergence is uniform on every interval |x|<ρ where 0≤ρ<R. If R>0, the sum of the power series is infinitely differentiable in |x|<R, and its derivatives are given by differentiating the original power series term by term. Power series work just as well for complex numbers as real numbers, and are in fact best viewed from that perspective, but we restrict our attention here to real-valued power series. Definition 6.1 Let (aₙ)^{∞}ₙ₌₀ be a sequence of real numbers and c∈R. The power series centered at c with coefficients aₙ is the series ^{˜}Σₙ₌₀aₙ(x−c)ⁿ. Power series centered at 0: ^{∞}Σₙ₌₀xⁿ=1+x+x²+x³+x⁴+ . . . , ^{∞Σ}ₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿX²ⁿ=x−x²+x⁴−x⁸+ . . . ; and power series centered at 1: ^{∞}Σₙ₌₁(−1)ⁿ⁺¹/n(x−1)ⁿ=(x−1)−½(x−1)²+⅓(x−1)³−¼(x−1)⁴+ . . . , The power series in Definition 6.1 is a formal expression, since we have not said anything about its convergence. By changing variables x→(x−c), we can assume without loss of generality that a power series is centered at 0, and we will do so when it's convenient. Radius of convergence first, we prove that every power series has a radius of convergence. Theorem 6.2 let ^{∞}Σₙ₌₀aₙ(x−c)ⁿ be a power series. There is an 0≤R≤∞ such that the series converges absolutely for 0≤|x−c|<R and diverges for |x−c|>R. Furthermore, if 0≤ρ<R, then the power series converges uniformly on the interval |x−c|<ρ, and the sum of the series is continuous in |x−c|<R. Proof. Assume without loss of generality that c=0 (otherwise, replace x by x−c). Suppose the power series ^{∞}Σₙ₌₀ aₙXⁿ₀ converges for some x0∈R with x₀≠0. Then its terms converge to zero, so they are bounded and there exists M≥0 such that |aₙxⁿ₀|≤M for n=0, 1, 2, . . . , If |x|<|x₀|, then |aₙxⁿ|=|aₙxⁿ₀∥x/x₀|ⁿ≤Mrⁿ, r=|x/x₀<1. Comparing the power series with the convergent geometric series Σ Mrⁿ, we see that Σ aₙxⁿ is absolutely convergent. Thus, if the power series converges for some x₀∈R, then it converges absolutely for every x∈R with |x|<|x₀|. Let R=sup {|x|≥0: Σ aₙxⁿ converges}. If R=0, then the series converges only for x=0. If R >0, then the series converges absolutely for every x∈R with |x|<R, because it converges for some x₀∈R with |x|<|x₀|<R. Moreover, the definition of R implies that the series diverges for every x∈R with |x|>R. If R=∞, then the series converges for all x∈R. Finally, let 0≤ρ<R and suppose |x|≤ρ. Choose σ>0 such that ρ<σ<R. Then Σ|aₙσⁿ| converges, so |aₙσⁿ|≤M, and therefore |aₙxⁿ|=|aₙσⁿ∥x/σ|ⁿ≤|aₙσⁿ∥ρ/σ|ⁿ≤Mrⁿ, where r=ρ/σ<1. Since Σ Mrⁿ<∞, the M-test (Theorem 5.22) implies that the series converges uniformly on |x|≤ρ, and then it follows from Theorem 5.16 that the sum is continuous on |x|≤ρ. Since this holds for every 0≤ρ<R, the sum is continuous in |x|<R. The following definition therefore makes sense for every power series. If the power series ^{∞}Σₙ₌₀aⁿ(x−c)n converges for |x−c|<R and diverges for |x−c|>R, then 0≤R≤∞ is called the radius of convergence of the power series. Theorem 6.2 does not say what happens at the endpoints x=c±R, and in general the power series may converge or diverge there. we refer to the set of all points where the power series converges as its interval of convergence, which is one of (c−R, c+R), (c−R, c+R], [c−R, c+R), [c−R, c+R]. We will not discuss any general theorems about the convergence of power series at the endpoints (the Abel theorem). Theorem 6.2 does not give an explicit expression for the radius of convergence of a power series in terms of its coefficients. The ratio test gives a simple, but useful, way to compute the radius of convergence, although it doesn't apply to every power series. Theorem 6.4 suppose that aₙ≠0 for all sufficiently large n and the limit R=lim_{n→∞}|aₙ/aⁿ+1| exists or diverges to infinity. Then the power series ^{∞}Σₙ₌₀ aⁿ(x−c)ⁿ has radius of convergence R. Proof. Let r=lim_{n→∞}|aₙ+1|(x−c)ⁿ⁺¹/aₙ(x−c)ⁿ|=|x−c| lim_{n→∞}|an+1/an|. By the ratio test, the power series converges if 0≤r<1, or |x−c|<R, and diverges if 1<r≤∞, or |x−c|>R, which proves the result. The root test gives an expression for the radius of convergence of a general power series. Theorem 6.5 (Hadamard). The radius of convergence R of the power series ^{∞}Σₙ₌₀ aₙ(x−c)ⁿ is given by R=1/lim sup_{n=∞} |an|^{1/n} where R=0 if the lim sup diverges to ∞, and R=∞ if the lira sup is 0. Proof. Let r=lim sup_{n→∞} |aₙ(x−c)ⁿ|^{1/n}=|x−c| lim sup_{n→∞} |aⁿ|^{1/n}. By the root test, the series converges if 0≤r<1, or |x−c|<R, and diverges if 1<r≤∞, or |x−c|>R, which proves the result. This theorem provides an alternate proof of Theorem 6.2 from the root test; in fact, our proof of Theorem 6.2 is more or less a proof of the root test. Definition of convergence and divergence in series the n^{th} partial sum of the series ^{∞}Σₙ₌₁ aₙ is given by Sₙ=a₁+a₂+a₃+ [symbol] +aₙ. If the sequence of these partial sums {Sₙ} converges to L, then the sum of the series converges to L. If {Sₙ} diverges, then the sum of the series diverges. Operations on convergent series if Σ aₙ=A, and Σ bₙ=B, then the following also converge as indicated: Σcaₙ=cA Σ(aₙ+bₙ)=A+B Σ(aₙ−bₙ)=A−B. Alphabetical listing of convergence tests absolute convergence if the series ^{∞}Σₙ₌₁|aₙ| converges, then the series ^{∞}Σₙ₌₁ aₙ also converges. Alternating series test if for all n, aₙ is positive, non-increasing (i.e. 0<aₙ₊₁<=aₙ), and approaching zero, then the alternating series ^{∞}Σₙ₌₁(−1)ⁿ aₙ and ^{∞}Σₙ₌₁(−1)ⁿ⁻¹ aₙ both converge. If the alternating series converges, then the remainder R_{N}=s−S_{N} (where s is the exact sum of the infinite series and S_{N} is the sum of the first N terms of the series) is bounded by |R_{N}|<=a_{N+1}. Deleting the first N terms if N is a positive integer, then the series ^{∞}Σₙ₌₁ aₙ and ^{∞}Σ a_{n n=N+1} both converge or both diverge. Direct comparison test if 0<=aₙ<=bₙ for all n greater than some positive integer, then the following rules apply: If ^{∞}Σₙ₌₀ bₙ converges, then ^{∞}Σₙ₌₁ aₙ converges. If ^{∞}Σₙ₌₁ aₙ diverges, then ^{∞}Σₙ₌₁ bₙ diverges. Geometric series convergence the geometric series is given by ^{∞}Σₙ₌₀ a rⁿ=a+a r+a r²+a R³+ . . . If |r|<1 then the following geometric series converges to a/(1−r). If |r|>=1 then the above geometric series diverges. Integral test if for all n>=1, f(n)=aₙ, and f is positive, continuous, and decreasing then ^{∞}Σₙ₌₁ aₙ and ∫^{∞}₁ aₙ either both converge or both diverge. If the above series converges, then the remainder R_{N}=s−S_{N} (where s is the exact sum of the infinite series and S_{N} is the sum of the first N terms of the series) is bounded by 0<=R_{N}<=f (N . . . ∞) f(x) dx. Limit comparison test if lim (n-->) (aₙ/bₙ)=L, where aₙ, bₙ>0 and L is finite and positive, then the series ^{∞}Σₙ₌₁ aₙ and ^{∞}Σₙ₌₁ bₙ either both converge or both diverge. nth-Term test for divergence if the sequence {aₙ} does not converge to zero, then the series ^{∞}Σₙ₌₁ aₙ diverges. p-Series convergence the p-series is given by ^{∞}Σₙ₌₁ 1/n-isotypic=1/1^{p}+½^{p}+⅓^{p}+ . . . where p>0 by definition. If p>1, then the series converges. If 0<p<=1 then the series diverges. Ratio test if for all n, n≠0, then the following rules apply: Let L=lim (n-->∞)|aₙ₊₁/aₙ|. If L<1, then the series ^{∞}Σₙ₌₁ aₙ converges. If L>1, then the series ^{∞}Σₙ₌₁ aₙ diverges. If L=1, then the test in inconclusive. Root test let L=lim (n-->∞)|aₙ|^{1/n}. If L<1, then the series ^{∞}Σₙ₌₁ aₙ converges. If L>1, then the series ^{∞}Σₙ₌₁ aₙ diverges. If L=1, then the test in inconclusive. Taylor series convergence if f has derivatives of all orders in an interval I centered at c, then the Taylor series converges as indicated: ^{∞}Σₙ₌₀(1/n!) f(n)(c) (x−c)ⁿ=f(x) if and only if lim (n-->∞) Rₙ=0 for all x in I. The remainder R_{N}=s−S_{N} of the Taylor series (where s is the exact sum of the infinite series and S_{N} is the sum of the first N terms of the series) is equal to (1/(n+1)!) f⁽ⁿ⁺¹⁾(z) (x−c)ⁿ⁺¹, where [symbol] is some constant between x and c. Impellers; turbo-shaft; turbo-fan; turbo-fluid; turbo-jet; or fluid-propulsion heat a heater fluid a superconductor of magnetic-enthalpy in symbol H continue our set of natural numbers is denoted N, we adopt member of the set of positive integers 1, 2, 3, . . . (OEIS A000027) or to the set of nonnegative integers 0, 1, 2, 3, . . . (OEIS A001477; e.g., Bourbaki 1968, Halmos 1974). (We refer to). Ribenboim (1996) states “Let P be a set of natural numbers; whenever convenient, it may be assumed that 0∈P”. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). Optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). In the noncommutative case, we call such things C*-dynamical systems. A covariant representation of a C*-dynamical system (A,G,α) is a triple (H,π,U) where n is a representation of A on H and U is a unitary representation of G such that π(αₓ(a))=Uₓπ(a)Uₓ⁻¹. There is a universal C*-algebra whose representations correspond to covariant representations of a given C*-dynamical system. If f∈C_{c}(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×ₛ E. Let the Hilbert Functor Let X→S be a projective scheme, O(1) a relatively ample line bundle and P a fixed polynomial. Let Hilbₚ(X/S): {Schemes/S}→{sets} be the contravariant functor that associates to an S scheme Y the subschemes of X×ₛY which are proper and flat over Y and have the Hilbert polynomial P and Let Moduli of stable curves Let ⁻M_{g}: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S. and an element U(F)∈F(X(F)) represents the functor finely if for every S scheme Y the map Hom_{S} (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→Horns (⋅, X(F)) such that (1) [symbol] (spec(k)): F (spec(k))→Hom_{S} (spec(k), X(F)) is a bijection for every algebraically closed field k, (2) For any S-scheme Y and any natural transformation ψ:F→Hom_{S} (⋅, Y), there is a unique natural transformation Π: Hom_{S}(⋅, X(F)) Hom_{S} (⋅, Y) such that ψ=Π∘ [symbol] . These functors above pose a moduli problem. The first step in our solution of such a problem is to construct a smooth, projective variety/proper scheme/proper Deligne-Mumford stack that represents the functor finely/coarsely. We operate on the Grassmannian Group Plate Projective Space, by definition, parametrizes one-dimensional subspaces in our affine space. The Grassmann varieties or Grassmannians parametrize higher-dimensional subspaces. Let V be a finite-dimensional vector space. As a set, we define G (k,V)={U⊂V: U is a k-dimensional subspace of V} G (k,n)={U⊂Kⁿ: U is a k-dimensional subspace of Kⁿ} By definition, G((k, n))=G(k+1, n+1) when dealing with our subspaces of Pⁿ. To turn the Grassmannian into a variety, we need a coordinate system for subspaces. For projective space, a homogeneous coordinate-tuple [Z₀, . . . , Zₙ] represents an equivalence class of points in Aⁿ⁺¹, namely all points on the same line through the origin. This equivalence can be seen as coming from a group action. The multiplicative group K^{*} acts on Aⁿ⁺¹ {0} by scalar multiplication and each point of Pⁿ corresponds to an orbit of this action, in other words, Pⁿ is the quotient space (Aⁿ⁺¹\{0})/K^{*}. We can try the same for the Grassmannian: A k-dimensional subspace of Kⁿ is spanned by k vectors. So we look at the space of all k-tuples of linearly independent vectors, which we think k x n-matrices. The group of GLₖ(k) acts on this space by multiplication from the left, and two k x n-matrices have the same row space iff they are in the same orbit under this group action. So we can identify G(k,n) with the quotient space Mat^{(k)}_{k×n} (K)/GLₖ(K). Where Mat^{(k)} is the set of matrices of rank k. Looking further at a group action we know that if the first k×k-minor of the matrix on the right is non-zero, the orbit contains a unique element of a form. Conversely, we obtain a matrix of rank k for any k×(n−k)-matrix B on the right. In other words, the row spans of matrices of this form are in bijection with an affine space A^{k(n-k)}. But this involved a choice coming from the assumption that the first k×k-minor is non-zero. In general, we have to permute columns first. So we see in this way the Grassmannian G(n,k) is covered by (ⁿk) copies of affine spaces A^{k(n-k)}. (Note the analogy with projective space.) In particular, whatever the Grassmannian is a variety, it must be of dimension k(n−k). The Grassmannian G(r,n) is the set of r-dimensional subspaces of the k-vector space kⁿ; it has a natural bijection with the set G(r−1,n−1) of (r−1)-dimensional linear subspaces P^{r-1}⊆Pⁿ. We write G(k,V) for the set of k-dimensional subspaces of an n-dimensional k-vector space V. We'd like to be able to think of G(r,V) as a quasiprojective variety; to do so, we consider the Plücker embedding: r [symbol] : G(r,V)→P(∧V) Span(v₁, . . . , vᵣ) [symbol] [v₁∧ . . . ∧vᵣ]. If (wᵢ=Σj aᵢⱼvⱼ)1_{≤}i_{≤}r is another ordered basis for ∧=Span(v₁, . . . , vᵣ), where A=(aᵢⱼ) is an invertible matrix, then w=₁∧ . . . ∧wᵣ=(detA)(v₁∧ . . . ∧vᵣ). Thus the Plücker embedding is a well-defined function from G(k,V) to P(∧^{r} V). We would like to show, in analogy with what we were able to show for the Segre embedding P(V)×P(W)→P(V⊗W), that the Plücker embedding y is injective, the image [symbol] (G(r,V)) is closed, and the Grassmannian G(r,V) “locally” can be given a structure as an affine variety, and y restricts to an isomorphism between these “local” pieces of G(r,V) and Zariski open subsets of the image. Given x∈∧^{r}V, we say that x is totally decomposable if x=v₁∧ . . . ∧vᵣ for some v₁, . . . , vᵣ∈V, or equivalently, if [x] is in the image of the Plücker embedding. Grassmannian Group Plate Projective Space, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁(α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when a has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k−(x−h). Fluid dynamics mathematic optimum series, and parallel integral to the current, optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). There is a universal C*-algebra whose representations correspond to M^{→}, covariant representations of a given C*-dynamical system equilibrium [symbol] -component of Magnetization of a Field Element when all fields are 0; atmospheric, temperature and pressure correction system of integration state of the input variables presence of constraint mathematical field of complex analysis F(−x₁, −x₂, . . . , −x₄)=F(x₁, x2, . . . , xₙ) solving the for the system of equations the series of a real, or complex valued function continue a collective dynamic function of the complex space CP, p≥1 eigenfunctions form a complete subspace S to sets linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 principal of eigenvalues in arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)^{c} I. Let the exact sequence KO(1)→K₀(R) K₀(R/I) where K₀(I) is defined as follows: adjoined unit by ring structure I^{˜}, which has some K-theory K₀n. There is a map K₀(I^{˜})→K₀(k)≅Z. Let the exact sequence K₀(I)→K₀(R)→K₀(R/I) where K₀(1) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ₁=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)^{*}w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where n is a representation of A on H and U is a unitary representation of G such that π(αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F)) F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1) [symbol] (spec(k)):F (spec(k))→HomS (spec(k), X(F)) is a bijection for every algebraically closed field k, (2) For any S-scheme Y and any natural transformation ψ:F→HomS (*, Y), there is a unique natural transformation Π:HomS (*, X(F)) HomS (*, Y) such that ψ=Π∘ [symbol] . These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A,μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1+a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have p(1) ∥a∥≥|μ(a)|. For arbitrary a, |μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥²(26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μb is also a continuous positive linear functional. Now: [symbol] πₐ(b),πₐ(b) [symbol] = [symbol] ab,ab [symbol] =μ(b*a*ab)=μb(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w)=0 ∀v∈K,a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (a,β)^{*}=(β⁻, α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|², r²+s²+2st+t² (37) and subtracting t² from both sides gives a contradiction unless s=0. Now, if f≥0 we have ∥f−∥f∥∥≤∥f∥, hence |μ(f)−∥f∥|=|μ(f−∥f∥)|≤∥f∥ (38) which gives μ(f)≥0 as desired. Theorem 2.25. Let A be a unital C*-algebra and B a C*-algebra of A. Let p be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π₈₀ (a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. |μ(a)|²≤∥μ∥μ(a*a). Proof. Write ∥(a*)=limμ(a*e_{λ})=lim(a*e_{λ})_{μ} (39) and since we know we have an inner product, this is equal to lim [symbol] e_{λ}, a [symbol] ⁻=lim μ [symbol] e*_{λ}a [symbol] ⁻=μ(a)⁻ (40) as desired. Next, write |μ(a)|²=lim|μ(e_{λ}a)|²=lim| [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)^{*}(a+λ1))=μ(a*a)+λμ⁻(a)+λμ(a)+|λ|²∥μ∥ (43) which is greater than or equal to μ(a*a)−2|λ∥μ(a)|+|λ|²∥μ∥≥μ(a*a)−2|λ|∥μ∥^{1/2}μ(a*a)^{1/2}+|λ|²∥μ∥=(μ(a*a)^{1/2}−|λ|∥μ∥^{1/2})²≥0 (44) and the conclusion follows. Corollary 2.31. Let A be a *-normed algebra with a norm-1 approximate identity. Let μ be a continuous positive linear functional on A. Extend it to A⁻ by μ^{˜}(1)=∥μ∥. Then μ^{˜} is a positive linear functional on A^{˜}. with the above hypotheses, we can apply the GNS construction to obtain a cyclic representation (π,H,v) of A. Proposition 2.32. If we restrict π to A, then v remains a cyclic vector for π|_{A}. Proof. Choose a self-adjoint sequence aₙ with ∥aₙ∥≤1 so that μ(aₙ)↑∥μ∥. Then ∥π(aₙ)v−v∥^{2=μ(a*}ₙaₙ)−μ(aₙ)−μ(a*ₙ)+∥μ∥−∥(aₙ)→0 (45) as desired. If A is a non-unital *-normed algebra, (π,H) a nondegenerate *-representation, and e_{λ} is an approximate identity of norm 1, then n(e_{λ})π(a)v=π(e_{λ}a)v→π(a)v (46) hence in particular n(ex)v→v for all v in a dense subspace of H. Since ex has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(_{λ}x)v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,v be positive linear functionals. Then μ≥v if μ−v≥0; we say that v is subordinate to μ. Given μ, let (π,H,v) be the corresponding GNS representation. Consider End_{A}(H). Let T∈End_{A}(H) be a positive operator smaller than the identity and set v(a)=v_{T}(a)= [symbol] π(a)Tv,v [symbol] (47). (Then T is the Radon-Nikodym derivative of v with respect to μ.) We compute that v(a*a)= [symbol] π(a*a)Tv,v [symbol] = [symbol] T^{1/2}π(a)v,T^{1/2}π(a)v [symbol] ≥0 (48) so v is positive. Similarly, μ−v is positive. Moreover, if v_{T}=vₛ then T=S (by nondegeneracy). Conversely, suppose visa positive linear functional with μ≥v≥0, we want to show that v=v_{T} for some T∈End_{A}(H). For a,b∈A we have |v(b*a)|≤v(a*a)^{1/2}v(b*b)^{1/2}≤μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that v(b*a)= [symbol] π(a)v,T ^{*}π(b)v [symbol] (51). Since v≥0 we have T≥0. Since v≤μ, we have T≤I. To show that T∈End_{A}(H), write [symbol] π(c)Tπ(a)v,π(b)v [symbol] = [symbol] Tπ(a)v,π(C*b)v [symbol] (52)=v((C*b)^{*}a) (53)=v(b*ca) (54)= [symbol] π(c)π(a)v,T ^{*}π(b)v [symbol] (55) which gives π(c)T=Tπ(c) by density. We can encapsulate our work above in the following. Proposition 2.36. The map T→v_{T} is a bijection between {T∈End_{A}(H): 0≤T≤I} and {v: μ≥v≥0}. Definition A positive linear functional is pure if whenever μ≥v≥0 then v=rμ for some r∈[0,1]. Theorem 2.37. Let μ be a positive linear functional. Then μ is pure iff the associated GNS representation (π,H,v) is irreducible. Proof. If p is not pure, there is μ≥ν≥0 such that v is not a multiple of p. Then there exists T∈End_{A}(H) not a scalar multiple of the identity, so by Schur's lemma, H is not irreducible. Conversely, if H has a proper invariant subspace, let P∈End_{A}(H) be the corresponding projection. Then v_{P} is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−r)μ₂ where μ₁∈S(A), τ∈(0,1), and μ₁≠μ≠μ₂. Then μ≥τμ₁, so μ is not pure. Conversely, suppose p is not pure, so there is μ>v>0 with v not a scalar multiple of μ. Then μ=(μ−v)+v which is a convex linear combination of states (once the terms have been normalized) using the fact that ∥μ−v∥=lim(μ−v)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V^{*} takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥=∥π^{U}(a)∥=∥a∥ (where π^{U} is the universal representation). Proof. Let a∈A be self-adjoint. Then there exists ρ∈S(A) with |ρ(a)|=∥a∥. Let Se(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Se(A) such that |μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Sₑ(A) together with 0. 208 C*-algebras Marc Rieffel Notes by Qiaochu Yuan Spring 2013. Mathematic calculus number theorem optimal control theory 3-7. Groß in 8, and Liu et al. in 9 gave the solvability conditions for Hermitian solution a formalism constraint and its expressions a composite number 2ⁿ−1 of fluid dynamics mathematic control enhance optimum series and parallel integral to the current a dynamical system normalized function of atmospheric, temperature and pressure correction system of integration state of the input variables presence of constraint mathematical field of complex analysis expressions. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. (N):=c prime force the sum of prime numbers n in c. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. The Acyclicity of the Koszul complex Rohlin's Theorem (strong form). Equilateral pole equivalent translation symmetrical bisection measure of change two poles, or equivalently is written period module the sum of the first n+1 terms of a series at 0; Euler's identity is the equality e^{iπ}+1 =0 the Euler scheme is our simplest strong Taylor approximation, [symbol] ₁, [symbol] ₂ are the longitude, or transverse combination while for the only transverse measure λ for (v,f) (the horocycle flow being strongly ergodic), the composition of the above analytic index with dimλ:K^{*}(C^{*}(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈cb(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue. Trivially, the zero module {0} is injective relaxation rates respectively, connectedness definition a subset S⊆C is said to be path connected if for all z₁, z₂∈S there exists a path y in S from z₁ to z₂. Definition. A subset S⊆C is said to be step connected if for all z₁, z₂∈S there exists a step path y in S from z₁ to z₂ equilibrium [symbol] -component of M^{→}, Magnetization of a Field Element when all fields are 0; a *-algebra A, a *-representation of A on a vector space H with pre-inner product is a map π: A→(B(H)) such that [symbol] π(a)v,w [symbol] = [symbol] v,π(a*)w [symbol] . The representation is nondegenerate if the span {π(a)v:a∈A,v∈H} is dense in H. We can represent C*-algebras on Hilbert spaces for those of the form C(X) we can choose a nice positive measure on X and look at the multiplication action on L²(X). We calculate the structure of our positive linear functionals (these are positive linear functionals on C(X) by Riesz-Markov). Such a measure gives us a pre-inner product [symbol] f,g [symbol] =∫ f⁻g dμ⁻=μ(f⁻g) which we can get a Hilbert space out of and here we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M1, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′,M₀, f′₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms f, does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ (W, M₀)∈Wh(π₁(M₀)), (7.2) is defined to be the preimage of the Whitehead torsion (see Definition 6.12) τ M₀^{f0}→∂₀Wⁱ⁰→W)∈Wh(π₁(W)) under the isomorphism (i₀∘f₀)_{*}:Wh(π₁(M₀))^{≅}→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay More information about the s-cobordism theorem can be found for instance in [128], [153, Chapter 1], [167] [211, pages 87-90]. The s-cobordism theorem is known to be false (smoothly) for n=dim(M₀)=→in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H^{*}(M)≅H^{*}(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i=0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:←Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f: Dⁿ→Dⁿ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:←Dⁿ₀×{k}→∂Dⁿ₀×[0, 1] for k=0, 1 by h|_{Dn0×{0}}=Id, h|_{∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] == [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation ^{˜} on a set S is called quasi-reflexive if every element that is related to some element is also related to itself, formally: ∀ x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜}) U (=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0} αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τX)f)(x)−f(x)/τ αₓ(b)dx=∫(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Then we have (modeled as x=A_{*}s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ⊆B^{∞}. If b∈B^{∞} then (Dₓ(b))ₙ=Dₓ(bₙ) where bₙ is the n^{th} isotypic component. Let e₁, . . . e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞} then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{P}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σₙ2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n>0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(1)→K₀(R)→K₀(R/I) where K₀(1) is defined as follows: adjoined unit by ring structure I^{˜}, which has some K-theory K₀(I^{˜}). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let A be the collection of all finite subsets of S ordered by inclusion. Given λ∈∧, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If a∈A, then ka−aeλk2=ka(1−eλ)k2=k(1−eλ)a*a(1−eλ)k but since a∈λ we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all a∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). The least upper bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary. The same argument works in the other direction. Hence there is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from π(X, x₀) to π(Y, y₀). Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r(y), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. The projection p:V→V/F is naturally K-oriented and the following maps from K^{*}(V) to K(C^{*}(V,F)) coincide: 1) p! (cf. Theorem) which, up to the Thom isomorphism, K^{*}(F)˜K^{*+1}(V) is equal by Lemma 7 to Indₐ=Indₜ. 2) The Thom isomorphism (Appendix C) ϕ:K^{*}(V)=K(C(V))→K(C(V)oR)=K(C^{*}(V,F)) where we used an arbitrary flow defining the foliation. In particular, by Appendix C, ϕ is an isomorphism and so are the map p! and the index Indₐ:K^{*}(F)→K(C^{*}(V,F)). Taking for instance the horocycle foliation of V=SL(2,R)/r, where Γ is a discrete cocompact subgroup of SL(2,R), by the left action of the subgroup of lower triangular matrices of the form [1 0 t 1], τ∈R, one sees that the analytic index gives a (degree −1) isomorphism of K^{*}(V) onto K(C^{*}(V,F)), while for the only transverse measure ∧ for (V,F) (the horocycle flow being strongly ergodic), the composition of the above analytic index with dim_{∧}: preserving K^{*}(C*(V,F))→R is equal to 0, so in particular dim∧ is identically 0, submitting K(C*(V,F))R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle T c of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H^{*}(A)→H^{*}_{τ}(BG). In fact, we shall only describe the composition of this map with the pull-back H^{*}_{τ}(BG)→H^{*}_{τ}(V). When one varies V without varying V/F one gets the desired information. The idea of the construction of (3.39) λᵥ:H^{*}(A)→H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map from the periodic cyclic cohomology H^{*}(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Si as explained in Proposition 3.1. The result is regular and Z/2-oriented. The boundary of W∪S₁ W′ is S₀ [symbol] S₂. Since g and g′ agree on Si, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and xᵢ G x, x=r( [symbol] ), infinite connected manifolds the Θ^{j}(K) commute pairwise (S₀, g₀) and (S₁, g₁), where Si are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G_{M}=G⁽⁰⁾={(x,x);x∈M} and the composition is (x,y)∘(y,z)=(x,z) ∀x,y,z∈M. The convolution algebra is then the algebra of smoothing kernels on the manifold M. [3) A Lie group G is, in a trivial way, a groupoid with G⁽⁰⁾={e}. One then gets the convolution algebra C_{c}^{∞}(G,Ω^{1/2}) of smooth 1-densities on G, −1n n), with y we have y=0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of T consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, Tⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₁∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse X of the map [symbol] _{*}([114]) (3.38) λ:H^{*}(A)→H^{*}_{τ}(BG). In fact, we shall only describe the composition of this map with the pull-back H^{*}_{τ}(BG) H^{*}_{τ}(V). When one varies V without varying V/F one gets the desired information. The idea of the construction of (3.39) λᵥ:H^{*}(A) H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12)“. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where QT is the transpose of Q and I is the identity matrix M^{→}. Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ: S,→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on Si, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n x for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C^{*}(V,F))) is equal to {hCh(E),[C]i;[E]∈K^{*}(V)} (The Longitudinal Index Theorem for Foliations A. Connes* and G. Skandalis** 1983). Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩l{P: P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∈[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Properties that require transitivity, preorder a reflexive transitive relation, partial order an antisymmetric preorder, total preorder a total preorder, equivalence relation a symmetric preorder, strict weak ordering a strict partial order in which incomparability is an equivalence relation, total ordering a total, antisymmetric transitive relation, closure properties the converse of a transitive relation is always transitive: e.g. knowing that “is a subset of” is transitive, and “is a superset of” is its converse. We can conclude that the latter is transitive as well or partial differential problem we solve with Fourier transform, or finite Fourier transform in isotypic components Bₙ. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Linear and Local Thermal Transmittances: The linear thermal transmittance, symbol ψ, units: W/(m•K), the heat transfer in Kelvin temperature by Newton Ring's [symbol] :=s²/2r:=N:=λ/2 is the gravitational force. Semiprime rings. Two rings R,S are Morita equivalent if their categories of left modules are equivalent. R and M, ,(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<x<1. Proof: the series is the Maclaurin series for (x+1)^{r}, and that the series converges when −1<x<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1). (−n)(−n−1)(−n−2) . . . (−n−i+1)i!=(−1)i(n)(n+1) . . . (n+i−1)i!=(−1)i(n+i−1)! H(n−1)!=(−1)i(n+i−1i)=(−1)i(n+i−1n−1).
Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞⋅1, ∞⋅2, . . . , ∞⋅n}{∞⋅1, ∞⋅2, . . . , ∞⋅n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+x+x2)(1+x+x2+x3+x4+x5)(1+x+x2+x3+x4+x5)(x2+x3+x4+x5+x6). (1+x+x2)(1+x+x2+x3+x4+x5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+31x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞≤0≤x1≤∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+102x9+125x10+145x11+160x12+170x13+176x14+179x15+180x16+180x17+180x18+180x19+180x 20+ . . . . We find a generating function for the number of submultiple sets of {∞·a,∞·b,∞·c}{∞·a,∞·b,∞·c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+)(1+(x2)+(x2)2+(x2)3+ . . . )11−x=x(1−x2)2(1−x). (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1 x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²+(p¹)²=0, we can write pₐₐ_{^{⋅}}=λₐ, λ^{˜}ₐ_{^{⋅}}, with λ and λ^{˜} two independent real spinors. (N):=c prime force the sum of prime numbers n in c. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. The Acyclicity of the Koszul complex Rohlin's Theorem (strong form). A semiprime is any integer normalized function of temperature; and pressure correction value of number n is continued as phase factor for any complex number written in polar form (such as re^{iΘ}), the phase factor is the complex exponential factor (e^{iΘ}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. (N):=c prime force the sum of prime numbers n in c. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₘ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the o-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}:F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat 5-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, (I)):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat 6-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g,ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat 6-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A_{*}s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T^{*}M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where F is the completion of E with respect to μ, will be called the product space with product measure μ determined by the distribution π. The transformation T defined by (Tx)ₙ=xₙ₊₁, n∈Z, is clearly an invertible μ-measure-preserving transformation. The existence of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²+(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. This property is exploited to produce a set of points, called Padua points, at which a function may be sampled in order to compute either a bivariate interpolation or quadrature of the function over the domain [−1,1]×[−1,1]. The relation of some Lissajous curves to Chebyshev polynomials is clearer to understand if the Lissajous curve which generates each of them is expressed using cosine functions rather than sine functions. Here x=cos(t), y=cos(Nt). Heteroclinic connections, a numerical projection is utilized of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N, and then one around L₁, the other around L₂. This heteroclinic connection augments the previously known homoclinic orbits associated with the L₁ and L₂ periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. Linking these heteroclinic connections and homoclinic orbits leads to dynamical chains which form the backbone for temporary capture and rapid resonance transition. we solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum maxima and minima defined for sets, if an ordered set of s has a greatest element m,m is a maximal element of a Sum of Dirichlet carrier-function L(s,χ) character, χ for the solid domain linear approximation by ridgelets converges rapidly to nice ridge functions let U; be the open star of the i^{th} vertex Xᵢ of L′. Then (U;) is an open covering of L. We can choose a barycentric subdivision K′ of K such that each simplex τ of K′ is contained in a set of the form f⁻¹(Uⁱ). Then the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties the U(a,b) uniform distribution χ^{˜}U(a,b); probability density function PDF {1/b−a, a≤χ≤b, 0, otherwise. Mean distribution is a+b/2; and variance is (continuous) distribution 1/12(b−a)² linear, local, circular moment, or equivalently on the interval A step path in S is a path y:[A, b]→S together with a subdivision a=τ₀<Δ₁<τ₂<∧<τₙ=b of [A, b] such that in each subinterval [τⱼ₋ᵢ, τⱼ] either re(y) or im(y) is constant τ₀<τ₁<τ₂<∧<τₙ=b of let y:uniform on [A, b]→C be a path is the maximum entropy distribution among all continuous distributions which are supported in the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path distribution the class s of all real-valued random variables which are supported on s (whose density function is zero outside of s) for each term in the infinite sum, or equivalently, the circular mean and circular variance the base of the plane continue natural logarithm, resulting entropy by mathematical formalism constraint, the connective constant multiplication fluid dynamics. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system of X is far from being trivial our longitudinal integral of the trivial bundle does vanish, i.e. the K-theory group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let z=f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{1/2})−Ef(X̅_{T}^{h}) where X̅_{T}^{1/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates x i (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2} (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁,K₂,K₃,K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components B n of squelch of squelch (noise) is additive, or when, the process of pointwise isotypic components Bₙ of squelch of squelch (noise) disable is subtractive, that is when the diffusion coefficient has the form b(t,x)∈b(t) for all (t,x)∈R+x Rd, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δn+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2},)−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X̅_{T})≤O(h^{m+1}). The Euler approximation for SDEs Yₙ₊₁=Yₙ+a(Yₙ)Δn+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔn+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},∈), [symbol] ⋅,⋅ [symbol] ₛ) where ★∈∂F_{g} and: [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (m,ϕ) between (F_{g-},ϕ₋) and (F_{g+},ϕ₊) the (closure of) the kernel of the R-linear map (−m₋)⊗m₊: H^{ϕ}₁(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat 6-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, 4)):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat 6-cover in case F is a flat module s; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module s; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A_{*}s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T^{*}M to a single point, using the equivalence relation on M×[0, 1] which identifies any pairs (x,ε) and (y,ε) provided ε>0.5.β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution n. The transformation T defined by (Tx)ₙ=Xₙ₊₁, n∈Z, is clearly an invertible μ-measure-preserving transformation. The existence of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N. This property is exploited to produce a set of points, called Padua points, at which a function may be sampled in order to compute either a bivariate interpolation or quadrature of the function over the domain [−1,1]×[−1,1]. The relation of some Lissajous curves to Chebyshev polynomials is clearer to understand if the Lissajous curve which generates each of them is expressed using cosine functions rather than sine functions. Here x=cos(t), y=cos(Nt). Heteroclinic connections, a numerical projection is utilized of a heteroclinic connection between pairs of equal energy periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1π/N 2 are Chebyshev polynomials of the first kind of degree N, and then one around L₁, the other around L₂. This heteroclinic connection augments the previously known homoclinic orbits associated with the L₁ and L₂ periodic P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²+(p³)²−(p¹)²=0, we can write pₐₐ_{^{⋅}}=λₐ, λ^{˜}ₐ_{^{⋅}}, with λ and λ^{˜} two independent real spinors extends to arbitrary simply connected solvable Lie groups H in place of R. Ab(F) is the Ab-genus of this Spin bundle around two points where a=1, b=N (N is a natural number) and δ=N−1 π/N 2 are Chebyshev polynomials of the first kind of degree N. Linking these heteroclinic connections and homoclinic orbits leads to dynamical chains which form the backbone for temporary capture and rapid resonance transition. we solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum maxima and minima defined for sets, if an ordered set of s has a greatest element m,m is a maximal element, semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros. Furthermore, if S is a subset of an ordered set T and m is the greatest element of S with respect to order induced by T, m is a least upper bound of S in T. The similar result holds for least element, minimal element and greatest lower bound. It is also possible that the expected value restrictions for the class C force the probability distribution to be zero in certain subsets of S. The Sum of Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, x for the function of transport properties the U(a,b) uniform distribution χ˜U(a,b); probability density function PDF {1/b−a, a≤x≤b, 0, otherwise. Mean distribution is a+b/2; and variance is (continuous) distribution 1/12(b−a)² linear, local, circular moment, or equivalently on the interval A step path in S is a path y:[A, b]->S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path is the maximum entropy distribution among all continuous distributions which are supported in the interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path distribution the class s of all real-valued random variables which are supported on s (whose density function is zero outside of s) for each term in the infinite sum, or equivalently, the circular mean and circular variance the base of the plane continue natural logarithm, resulting entropy by mathematical formalism constraint, the connective constant multiplication fluid dynamics atmospheric gases can be contrasted by superheated steam. (We refer to). Cohomology Operations Lectures By N. E. Steen rod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction”. Atmospheric gases can be contrasted by superheated steam is produced by passing saturated steam through an additional heat exchanger, two factors are the ordinates calculate the entropy and the absolute temperature, the total heat is given by the area enclosed by absolute zero base water line and horizontal and vertical line from the respective points, the adiabatic expansion calculate a vertical line, an adiabatic process the expansion at constant entropy with no transfer of heat, the change of entropy is input calculated value as: dS=logₑ(T1/T) where T=absolute temperature (K), the entropy of water above freezing point is input calculated value as: dS=logₑ(T1/273), entropy of evaporation, change of entropy during evaporation dS=dL/T where L=latent heat (J), the entropy of wet steam is input calculated value as: dS=logₑ(T1/273)+ζ(L1/T1) where ζ=dryness fraction, entropy of superheated steam change of entropy during super-heating input calculated value as: dS=cp logₑ(T/T1) where cp=specific heat capacity at constant pressure for steam (kJ/kgK), entropy of superheated steam input calculated value as: dS=logₑ(T1/273)+L1/T1+cp logₑ(Ts/1) where Ts=absolute temperature of superheated steam T1=absolute temperature of evaporation, water and steam entropy are in imperial units temperature (° F.), absolute pressure (psia), and entropy (Btu/lb ° F.), the entropy of superheated steam at different pressures and temperatures are in (kJ/kgK), absolute pressure, saturation temperature, and steam temperature (° C.) are input calculated value rotation linear, local, circular moment, or equivalently the circular mean, and circular variance the equilateral joined symmetrical corners formal Dirichlet generating series the connective constant a weighted mechanical advantage set coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<T n=b of let y:uniform on [A, b]→C be a path we find the natural base of the plane points denoted by μ in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s) Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped re-measurement allows us to construct the second fundamental form in the same way this shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Therefore, a weighted mechanical coefficient base the connective constant a weighted mechanical advantage set coefficient A step path in S is a path y: [A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<tₙ=b of let y:uniform on [A, b]→C be a path we find the natural base of the plane points denoted by μ specific in Newton's law of universal gravitation, Newton SI basic unit of force 1 N=1 kg×m/s² unit sign N and symbol of force F of weight-gravity G=m×g mass=m and gravity acceleration g=9.80665 m/s² Newton from Kelvin [° N]=([K]−273.15)× 33/100 to Kelvin [K]=[° N]×100/33+273.15 Linear and Local Thermal Transmittances: The linear thermal transmittance, symbol W, units: W/(m•K), gives the extra heat transfer per Kelvin temperature Newton Ring's [symbol] :=s²/2r:=N:=λ/2 expressed in differential form in the term of gravitational potential f(t, x) and the mass density ϕ(t, x) is the gravitational potential, f. Degenerate Abelian functions are distinguished by having infinitely small periods, such as for any number ϵ>0 it is possible to find a period w, if p=1. The vectors wᵥ of all periods, or the system of periods of the Abelian function f (z) form an Abelian group Γ under addition, the period group, or the period module, a basis of this group is a system of periods of the Abelian function, or also as a system of basic periods, an Abelian function f (z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ε>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4Y(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4y(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. The matrix W whose columns form a period basis of the Abelian function f(z) has dimension p×2p and is known as the period matrix of the Abelian function f(z). A necessary and sufficient condition for a given matrix W of dimension p×2p to be the period matrix of some non-degenerate Abelian function f(z) exist an anti-symmetric non-degenerate square matrix M with integer elements, of order 2p, and Hermitian inner product has 1 real part symmetric positive definite, and its imaginary part symplectic by properties on a complex vector space V is a complex-valued bilinear form on V which is antilinear in the second slot, and is positive definite, following properties, where z^{*} means the complex conjugate of z. Conditions are expressed as equations and inequalities respectively, a system of p(p−1)/2R Riemann equations and p(p−1)/2R Riemann inequalities is obtained. The number p is called the genus of the matrix W and of the corresponding Abelian function f(z). The columns wᵥ=Re wᵥ+i Im wᵥ of W, regarded as vectors in the real Euclidean space R^{2p}, define the period parallelotope of f(z). All Abelian functions corresponding to the same period matrix W form an Abelian function field ^{K}W. If the field ^{K}W contains a non-degenerate Abelian function, its degree of transcendence over the field C is p. The torus Cp/Γ is then an Abelian variety, and ^{K}W turns out to be its field of rational functions. If, on the other hand, all Abelian functions of ^{K}W are degenerate, then ^{K}W is isomorphic to the field of rational functions on an Abelian variety of dimension lower than p. The Abelian function AI(z) may be represented as AI(z)=AI(¹1, . . . , ^{zp})=R[^{x}1(^{z}1, . . . ²p), . . . , ^{x}p (²1, . . . , _{z}p)] A generalization of the concept of an elliptic function of the real part of one complex variable s=σ+i τ in analytic number theory to the case of several complex variables, a function f(z) in the variables ^{z}1, . . . , ^{z}p, z=(^{z}1, . . . , ^{z}p), mathematical field of complex analysis meromorphic does function on an open subset D of the complex plane is a function that is holomorphic on all of D except for a set of isolated points, in the complex space C^{p}, p≥1, p coordinates of the upper limits ^{x}1, . . . , ^{x}p, and system of sums lower integration limits ^{c}1, . . . , ^{c}p which are poles of the function in the complex space C^{p}, f(z)f(z), in the complex space, function f(z) in the variables ^{z}1, . . . , ^{z}p, ^{z=z}1, . . . , ^{z}p, is called an Abelian function if there exist ²p row vectors in C^{p}, wᵥ=(w1ᵥ, . . . , wₚᵥ), v=1, . . . , 2p, which are linearly independent over the field of real numbers and are such that f(z+w )=f(z) for all z∈C^{p}, v=1, . . . , 2p. The vectors wᵥ of all periods, or the system of periods of the Abelian function f(z) form an Abelian group Γ under addition, the period group, or the period module, a basis of this group is a system of periods of the Abelian function, or also as a system of basic periods, an Abelian function f(z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ϵ>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x+1}+4Y(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. Indeed, λ and λ^{˜} transform independently, according to λₐ>(Lₗ)ₐ^{β} λ_{β} and λ^{˜}_{a′}→(Lᵣ)_{a′}^{β′}λ^{˜}_{β′}. We obtain a confining potential that is strongly anisotropic the range signals (sources) of variations in directions and our system of equations orders in the number of terms in magnitudes. Our limit in the ratio of our signals (sources) under gamma's definition y=lim_{n→∞}(Hₙ−1n n), when rewritten as the asymptotic approximation Hₙ≈1n n+ [symbol] , provides a simple (and accurate) method for approximating the partial sums of the harmonic series [symbol] allowing the harmonic series to be replaced by logarithms, this time not as an estimate but the exact limit. Spherical models critical points and several critical exponents, including the thermal exponent y [symbol] , magnetic exponent yh, and loop exponent yl. Periodic Bₙ,Bₙ(x) Bernoulli number and polynomial B^{˜}ₙ(x) periodic Bernoulli function Bₙ(x−└x┘)Bₙ and polylogarithm Lis(z) function ϕ(z,S)ϕ we incorporate the periodic set c equal to e the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , and an exponential function e^{x}, and continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum maxima and minima defined for sets, if an ordered set of s has a greatest element m,m is a maximal element of a sum. Lis(z) polylogarithm the mathematic polylogarithm function Lis(z) of order s and argument z. Only for special values of s does the polylogarithm reduce to an elementary function such as the natural logarithm or rational functions. Acyclicity of the Koszul complex Bₙ,Bₙ(x) Bernoulli number and polynomial Bₙ(x) periodic Bernoulli function Bₙ(x−└x┘)Bₙ and Lemma 2.3 (Conca, Iyengar, Nguyen and Romer, [9, Corollary 6.4]). (We refer to) “Let f≠0 be a quadratic form in the polynomial ring k[x1, . . . , xn] (semiprime >1). Let R be a Cohen-Macaulay standard graded k-algebra satisfying regR=1. Then R has minimal multiplicity and glldR=dimR. In particular, if f is a non-zero quadratic form in k[x₁, . . . , xₙ], then glld(k[x]/(f))=n−1. Proof. We may assume k is infinite; see Lemma 2.2. Given Proposition 6.3, it remains to show glldR≤dimR. Note that glldR≤glld(R/Rx)+1 if x∈R₁ is R-regular; this is by Theorem 2.4. We may thus reduce to the case when dimR=0. Note that the regularity of R and its multiplicity remain unchanged. Let R=P/I where P is a polynomial ring and I⊆m², where m=P_{>1}. Since I has 2-linear resolution and pd_{P} R=n, there is an equality of Hilbert series H_{R}(z)(1−z)ⁿ=1−β₁z²+ [symbol] +(−1)ⁿβₙzⁿ⁺¹, where βᵢ≠0 is the ith Betti number of R over P. Therefore by comparing degrees of the polynomials, Rᵢ=0 for i≥2, so I=m². Then every R-module is Koszul, so glldR=0. The last statement holds as k[x]/(f) is Cohen-Macaulay of dimension n−1. Theorem 6.5. If R is defined by monomial relations, then glldR≥dimR. Proof. Suppose R=P/I where P=k[x₁, . . . , xₙ] is a polynomial ring and I is a monomial ideal; we may assume it is quadratic, for else Id_{R} k is infinite. Reordering the variables if necessary we may assume that in the primary decomposition of I the component of minimal height is (x²₁, . . . , x²_{q}, x_{q+1}, . . . , xₛ), where s=n−dimR. We claim that Id_{R}(R/J)=dimR where J=(x₁, . . . , xₛ, x²ₛ₊₁, . . . , x²ₙ). Indeed, set S=k[xₛ₊₁, . . . , xₙ] and let R→S be the canonical surjection. Note that the composition of the inclusion S R with the map R S is the identity on S. Moreover Id_{R} S=0, since R is strongly Koszul. Therefore, noting that the action of R on R/J factors through S, from Proposition 2.3 one gets the first equality below: Id_{R}(R/J)=Id_{S}(R/J)=Id_{S}(S/(x²ₛ₊₁, . . . , x²ₙ))=n−s. The last equality is a direct computation; one can get it from Lemma 6.1. By Proposition 6.3 this is the case for Cohen-Macaulay rings; more generally, it holds when R has a maximal Cohen-Macaulay module, and in particular when dimR≤2”. Absolutely Koszul Algebras and The Backlin-Roos Property by Aldo Conca, Srikanth B. Iyengar, Hop D. Nguyen, and Tim R mer. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Dirichlet linear, local, or ring the connective constant a weighted mechanical advantage set coefficient A step path in S is a path y:[A, b]→S together with a subdivision a=τ₀<T i<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ generating series number A spaces two coordinates position. The Real and Complex Hermitian Solutions to a System of Quaternion Matrix Equations with Applications by Shao-Wen Yu. We establish necessary and sufficient conditions for the existence of and the expressions for the general real and complex Hermitian solutions to the classical system of quaternion matrix equations A₁X C₁,XB₁ C₂, and A^{3X A*3}=C₃. Moreover, formulas of the maximal and minimal ranks of four real matrices X1,X2,X3, and X₄ in solution X X₁ X₂i X₃j X₄k to the system mentioned above are derived. As applications, we give necessary and sufficient conditions for the quaternion matrix equations A₁X C₁,XB₁ C^{2, A3 X A*3}=C₃, and A^{4, X A*4}=C₄ to have real and complex Hermitian solutions. 1. Introduction Throughout this paper (we refer to), we denote the real number field by R; the complex field by C; the set of all m×n matrices over the quaternion algebra Ha₀a₁i a₂j a₃k|i²j₂k²ijk−1,a₀,a₁,a₂,a₃∈R 1.1 by H^{m×n}; the identity matrix with the appropriate size by I; the transpose, the conjugate transpose, the column right space, the row left space of a matrix A over H by A^{T},A^{*},RA, NA, respectively; the dimension of RA by dim RA. By 1, for a quaternion matrix A, dim RA dim NA. dim RA is called the rank of a quaternion matrix A and denoted by rA. The Moore-Penrose inverse of matrix A over H by A^{†} which satisfies four Penrose equations AA^{†}A A,A^{†}AA^{†} A^{†},AA^{†*}AA^{†}, and A^{†}A^{*} A^{†}A. In this case, A^{†} is unique and A^{†*}A^{*†}. Moreover, R_{A} and L_{A} stand for the two projectors L_{A}I−A^{†}A, and R_{A}I−AA^{†} induced by A. Clearly, RA and LA are idempotent and satisfies R_{A}^{*}R_{A}, L_{A}^{*} L_{A}, R_{A} L_{A}^{*}, and R_{A}^{*} L_{A}. Hermitian solutions to some matrix equations were investigated by many authors. In 1976, Khatri and Mitra 2 gave necessary and sufficient conditions for the existence of the Hermitian solutions to the matrix equations AX B,AXB C and A₁X C₁, XB₂ C₂, 1.2 over the complex field C, and presented explicit expressions for the general Hermitian solutions to them by generalized inverses when the solvability conditions were satisfied. Matrix equation that has symmetric patterns with Hermitian solutions appears in some application areas, such as vibration theory, statistics, and optimal control theory 3-7. Groß in 8, and Liu et al. in 9 gave the solvability conditions for Hermitian solution and its expressions of AXA* B 1.3 over C in terms of generalized inverses, respectively. In 10, Tian and Liu established the solvability conditions for A^{3X A*3} C₃, A^{4, X A*4} C₄ 1.4 to have a common Hermitian solution over C by the ranks of coefficient matrices. In 11, Tian derived the general common Hermitian solution of 1.4. Wang and Wu in 12 gave some necessary and sufficient conditions for the existence of the common Hermitian solution to equations A₁X C₁, XB₂ C₂, A^{3X A*3} C₃, 1.5 A₁X C₁, XB₂ C₂, A₃XA*₃ C₃, A₄XA*₄ Ca, 1.6 for operators between Hilbert C*-modules by generalized inverses and range inclusion of matrices. As is known to us, extremal ranks of some matrix expressions can be used to characterize non singularity, rank invariance, range inclusion of the corresponding matrix expressions, as well as solvability conditions of matrix equations 4, 7, 9-24. Real matrices and its extremal ranks in solutions to some complex matrix equation have been investigated by Tian and Liu 9, 13-15. Tian 13 gave the maximal and minimal ranks of two real matrices X₀ and X₁ in solution X X₀ iX₁ to AXB C over C with its applications. Liu et al. 9 derived the maximal and minimal ranks of the two real matrices X₀ and Xi in a Hermitian solution X X₀ iX₁ of 1.3, B^{*} B representations. In order to investigate the real and complex solutions to quaternion matrix equations, Wang and his partners have been studying the real matrices in solutions to some quaternion matrix equations such as AXB C, A₁XB₁ C₁, A₂XB₂C₂, 1.7 AXA*BXB*C, recently 24-27. To our knowledge, the necessary and sufficient conditions for 1.5 over H to have the real and complex Hermitian solutions have not been given so far. Motivated by the work mentioned above, we in this paper (we refer to) investigate the real and complex Hermitian solutions to system 1.5 over H and its applications. This paper (we refer to) is organized as follows. In Section 2, we first derive formulas of extremal ranks of four real matrices X₁,X₂,X₃, and X₄ in quaternion solution X X₁ X₂i X₃j X₄k to 1.5 over H, then give necessary and sufficient conditions for 1.5 over H to have real and complex solutions as well as the expressions of the real and complex solutions. As applications, we in Section 3 establish necessary and sufficient conditions for 1.6 over H to have real and complex solutions. We give necessary, and sufficient for the conditions on m existence, uniqueness, simplicity and normalization function of a different action eigenfunctions principal of eigenvalues for arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H) g I. Let the exact sequence K₀(I) K₀(R) K₀(R/I) where K₀(I) is defined as follows: adjoined unit by ring structure I^{˜}, which has some K-theory K₀(I^{˜}). There is a map K₀(I^{˜}) K₀(k)=Z. Let the exact sequence K₀(I) K₀(R)→K₀(R/I) where K₀(I) is defined as follows: adjoined unit by ring structure I^{˜}, which has some K-theory K₀(I^{˜}). Let A be a *-normed algebra with identity and μ be a continuous positive linear functional on A. Then L²(A,μ) is a nondegenerate *-representation of A Corollary 2.19. For every continuous positive linear functional on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b sa)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each A we have a representation λ_{λ} of A on H_{λ}, we can try to define a representation on the direct sum. This is possible if and only if ∥π_{λ}(a)∥ is uniformly bounded in λ. In practice we will have ∥π_{λ}(a)∥<∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)^{*}w [symbol] =0 ∀v∈K,a∈A⇔(33); [symbol] v,π(e)w [symbol] =0 ∀v∈K,a∈A⇔(34); π(a*)w∈K^{⊥}∀a∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where n is a representation of A on H and U is a unitary representation of G such that π (αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1) [symbol] (spec(k)):F (spec(k))→HomS (spec(k), X(F)) is a bijection for every algebraically closed field k, (2) For any S-scheme Y and any natural transformation ψ:F→HomS (*, Y), there is a unique natural transformation Π:HomS (*, X(F)) HomS (*, Y) such that W=Π∘ [symbol] . These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→ [symbol] aψ,ψ [symbol] is a state iff ψ is a unit vector in H. (21) This is a pure state in quantum mechanics. If A,μ are as above, [symbol] a,b [symbol] =p(a*b) defines a pre-inner product on A. The vectors of length 0 form a subspace N by the Cauchy-Schwarz inequality. A/N therefore inherits an inner product which we can complete to obtain a Hilbert space L²(A, p). This is the Gelfand-Naimark-Segal construction. A has a left regular representation πₐ(b)=ab on itself which descends to A/N because N is a left ideal. Moreover, this action is compatible with adjoints. However, nₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N,a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1+a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1) ∥a∥≥|μ(a)|. For arbitrary a, ∥μ(a)|²=| [symbol] 1,a [symbol] |²≤ [symbol] 1,1 [symbol] [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then μ_{b} is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and p. be a continuous positive linear functional on A. Then L²(A,μ) is a nondegenerate *-representation of A Corollary 2.19. For every continuous positive linear functional on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v² [symbol] (30) hence ∪ is well-defined and unitary. The same argument works in the other direction. Hence there is a bijective correspondence between continuous positive linear functional on A and unitary equivalence classes of (pointed) cyclic *-representations of A. Let 1-1), be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧}(v_{λ},w_{λ}) (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)^{*}w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as p runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)^{*}=(β⁻,α⁻). Lemma 2.24. Let A be a C*-algebra and μ a continuous linear functional such that ∥μ∥=μ (1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|²=r²+s²+2st+t² (37) and subtracting t² from both sides gives a contradiction unless s=0. Now, if f≥0 we have ∥f−∥f∥∥≤∥f∥, hence ∥μ(f)−∥f∥|=|μ(f−∥f∥)| (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =A. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀ Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻¹. 2. |μ(a)|²≤∥μ∥μ(a*a). Proof. Write μ(a*)=limμ [symbol] a*e_{λ} [symbol] =lim(a,e_{λ})_{μ} (39) and since we know we have an inner product, this is equal to lim [symbol] e_{λ}, a [symbol] ⁻=lim μ(e*_{λ}a)⁻=μ(a)⁻ (40) as desired. Next, write |μ(a)|²=lim|μ(e_{λ}a)|²=lim| [symbol] e*_{λ},a [symbol] _{μ}|² (41) which by Cauchy-Schwarz is bounded by lira [symbol] a,a [symbol] _{μ} [symbol] e*_{λ},e*_{λ})≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)^{*}(a+λ1))=μ(a*a)+λμ⁻(a)+λμ(a)+|λ|²∥μ∥ (43) which is greater than or equal to μ(a*a)−2|λμ(a)|+|λ|²∥μ∥≥μ(a*a)−2|λ|∥μ∥^{1/2}μ(a*a)^{1/2}+|λ|²∥μ∥=(μ(a*a)^{1/2}−|λ|∥μ∥^{1/2})²≥0 (44) and the conclusion follows. Corollary 2.31. Let A be a *-normed algebra with a norm-1 approximate identity. Let μ be a continuous positive linear functional on A. Extend it to A⁻ by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict π to A, then v remains a cyclic vector for π|_{A}. Proof. Choose a self-adjoint sequence aₙ with ∥aₙ∥≤1 so that μ(aₙ)↑∥82 ∥. Then ∥π(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since e_{λ} has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A^{*} in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K¹. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,v be positive linear functionals. Then μ≥v if μ−v≥0; we say that v is subordinate to μ. Given μ, let (π,H,v) be the corresponding GNS representation. Consider End_{A}(H). Let T∈End_{A}(H) be a positive operator smaller than the identity and set v(a)=v_{T}(a)= [symbol] π(a)Tv,v [symbol] (47). (Then T is the Radon-Nikodym derivative of v with respect to μ.) We compute that v(a*a)= [symbol] π(a*a)Tv,v [symbol] =(T^{1/2}π(a)v,T^{1/2}π(a)v [symbol] ≥0 (48) so v is positive. Similarly, μ−v is positive. Moreover, if v_{T}=vₛ then T=S (by nondegeneracy). Conversely, suppose v is a positive linear functional with μ≥v≥0, we want to show that v=v_{T} for some T∈End_{A}(H). For a,b∈A we have |v(b*a)|≤v(a*a)^{1/2}v(b*b)^{1/2}≤μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that v(b*a)= [symbol] π(a)v,T ^{*}π(b)v [symbol] (51). Since v≥0 we have T≥0. Since v≤μ, we have T≤I. To show that T∈End_{A}(H), write [symbol] π(c)Tπ(a)v,π(b)v [symbol] = [symbol] Tπ(a)v,π(C*b)v [symbol] (52)=v((C*b)^{*}a) (53)=v(b*ca) (54)= [symbol] π(c)π(a)v,T ^{*}π(b)v [symbol] (55) which gives π(c)T=Tπ(c) by density. We can encapsulate our work above in the following. Proposition 2.36. The map T→v_{T} is a bijection between if {T∈End_{A}(H): 0≤T≤I} and {v: μ≥v≥0}. Definition A positive linear functional is pure if whenever μ≥v≥0 then v=rμ for some r∈[0,1]. Theorem 2.37. Let μ be a positive linear functional. Then μ is pure iff the associated GNS representation (π,H,v) is irreducible. Proof. If μ is not pure, there is μ≥v≥0 such that v is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then v_{P} is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−c∥=lim(μ−v)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V^{*} takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥=∥π^{U}(a)∥=∥a∥ (where π^{U} is the universal representation). Proof. Let a∈A be self-adjoint. Then there exists ρ∈S(A) with |p(a)|=∥a∥. Let Se(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that ∥μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A^{*} in the weak-* topology and its extreme points are the extreme states Sₑ(A) together with 0. 208 C*-algebras Marc Rieffel Notes by Qiaochu Yuan Spring 2013. (We refer to) “Inertia Groups and Smooth Structures of (n−1)-Connected 2n-Manifolds” Kasilingam Ramesh (received Jul. 2, 2014, revised Dec. 22, 2014) “Definition 2.4. Let M be a closed topological manifold. Let (N, f) be a pair consisting of a smooth manifold N together with a homeomorphism f: N→M. Two such pairs (N₁, f₁) and (N₂, f₂) are concordant provided there exists a diffeomorphism g: N₁→N₂ such that the composition f₂∘g is topologically concordant to f₁, thus, there exists a homeomorphism F: N₁×[0, 1]→M×[0, 1] such that F_{|N1×0}=f₁ and F_{|N×0}=f₂∘g. The set of all such concordance classes is denoted by C(M). We will denote the class in C(M) of (M^{m} # Σ^{m}, id) by [M^{m} # Σ^{m}]. (Note that [Mⁿ # Sⁿ] is the class of (Mⁿ, id).)” Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of τ consists of simplexes all of which have X i as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties periodic parabolic expression of the Euclidean structure the exponential function e^{z} can be defined as the limit of (z/N+1)^{N}, as N approaches infinity, and thus e^{iπ} is the limit of (z/N+1)^{N}. A computation of (z/N+1)^{N} can be displayed as parabolic coordinates as the combined effect of N multiplications in the complex plane, with the final point being the actual value of (z/N+1)^{N}. It can be viewed that as N gets larger (z/N+1)^{N} approaches a limit of −1 can be displayed as parabolic coordinates coprime positive integers a and m, primes of the form a+km, where g(s,χ1) is bounded for s←1, using the analytic properties of L(s,χi) we can deduce that log L(s,χ1) is unbounded for s←1, whereas log L(s,χ2) is bounded for s←1, in particular the two sums of two functions are unbounded for s←1, and A Dirichlet character modulo a positive integer m is a group homomorphism χ^{*}: (Z/mZ)^{x}→C^{x}, can be extended to a function χ: N→C by the rule (χ^{*}(n mod m), gcd(n,m)=1, χ(n)=0, χ is also referred to as a Dirichlet character, χ for the function of transport properties N→C and add a star to denote the corresponding homomorphism χ^{*}: (Z/mZ)^{x}→C×, given a Dirichlet character χ: N→C attached the Dirichlet carrier-function L(s,χ) character as a series two sums of two functions, and χ(kn)=χ(k)χ(n) for all k,n∈N). Coprime positive integers a and m eigenvalue problem with weight m of load factor LF formal Dirichlet power generating series the connective constant a weighted mechanical advantage set coefficient A step path in S is a path y:[A, b]→S together with a subdivision a=to <τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points denoted by μ in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped re-measurement allows us to construct the second fundamental form in the same way this shows that even though we started with the irrational rotation algebra, a fairly irrational or singular datum, the Yang Mills problem takes us back to a fairly regular situation. We should again stress that the only data used in setting up the Yang Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Therefore, a weighted mechanical coefficient A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points a magnitude of a complex number [symbol] may be defined as the square root of the product of itself and its complex conjugate, [symbol] *, where for any complex number [symbol] =a+bi, its complex conjugate is [symbol] *=a−bi. Fluid mechanic the flow velocity μ of a fluid random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. The eigenvalue distribution function of dilute random matrices [H_{N}]_{d} converges to the semicircle Wigner distribution in the limit N→∞, p→∞, where p is the dilution parameter. This convergence can be explained by the observation that the dilution eliminates statistical dependence between the entries of [H_{N}]_{d}. The same statement is valid for the entries of [U_{N}]_{d}. It may be seen that the Wigner law is valid for wide classes of random dilution of random matrices H_{N}=U_{N} F_{N} U^{†}_{N}, where U_{N} are uniformly distributed over the group of N×N unitary matrices and F_{N} are non-random Hermitian matrices, and real and complex Hermitian solutions to the classical system of quaternion matrix equations by Shao-Wen Yu. We establish necessary and sufficient conditions for the existence of and the expressions for the general real and complex Hermitian solutions to the classical system of quaternion matrix equations A₁X C₁,XB₁ C₂, and A^{3X A*3}=C₃. Moreover, formulas of the maximal and minimal ranks of four real matrices X₁,X₂,X₃, and X₄ in solution X X₁ X₂i X₃j X₄k to the system mentioned above are derived. As applications, we give necessary and sufficient conditions for the quaternion matrix equations A₁X C₁,XB₁ C^{2, A3 X A*3}=C₃, and A^{4, X A*4}=C₄ to have real and complex Hermitian solutions. Positive pressurization supercooling refrigeration deceleration temperature less than or equal to ≤−109.3° F. degrees Fahrenheit or −78.5° C. degrees Celsius supercooled fluid refrigerant passes nearby and cools solid super alloy conductors, formed and fitted glazed rectangular, or cylindrical walls insulate superconducting equivalence across in mathematics transitive property of equality: if a=b and b=c, then a=c one of the equivalence properties of equality refrigeration. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ i, aᵢ″∈A. But a′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R₂ₚ for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Fluid refrigerant passes through cryotubes nearby and cools liquid, polymeric gelling, or solid chloride tank conductors, air is transported and cools while passing through cooling fan housings, or cooled water is transported into radiator housings, or cooled water is transported into radiator housings along with thermal radiation generated by the thermal motion particles of matter carbon dioxide diffuse radiant passive cooling. In mathematics, a binary relation R over a set X is transitive if whenever an element a is related to an element b and b is related to an element c then a is also related to c. Transitivity (or transitiveness) is a key property of both partial order relations and equivalence relations. Formal definition. In terms of set theory, the transitive relation can be defined as: ∀ a,b,c∈X:(aRb∧bRc)→aRc. For example, “is greater than”, “is at least as great as,” and “is equal to” (equality) are transitive relations: Whenever A>B and B>C, then also A>C. Whenever A≥B and B≥C, then also A≥C. Whenever A=B and B=C, then also A=C. Transitive relations: “is a subset of” (set inclusion); “divides” (divisibility); and “implies” (implication). Closure properties. The converse of a transitive relation is always transitive: e.g. knowing that “is a subset of” is transitive and “is a superset of” is its converse, we can conclude that the latter is transitive as well. The intersection of two transitive relations is always transitive. The union of two transitive relations is not always transitive. The complement of a transitive relation is not always transitive. For instance, while “equal to” is transitive, “not equal to” is only transitive on sets with at most one element. Other properties. A transitive relation is asymmetric iff it is irreflexive. Properties that require transitivity. Preorder—a reflexive transitive relation. Partial order—an antisymmetric preorder. Total preorder—a total preorder. Equivalence relation—a symmetric preorder. Strict weak ordering—a strict partial order in which incomparability is an equivalence relation. Total ordering—a total, antisymmetric transitive relation. In mathematics, a binary relation R over a set X is reflexive if every element of X is related to itself. Formally, this may be written ∀x∈X:x R x we consider Tian 13 gave the maximal and minimal ranks of two real matrices X₀ and Xi in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀ x, y∈S:x^{˜}y⇒(x^{˜}x∧y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ^{˜} on a set S is the smallest reflexive relation on S that is a superset of ^{˜}. equivalently, it is the union of ^{˜} and the identity relation on S, formally: (≃)=(^{˜})∪(=). For example, the reflexive closure of x<y is x≤y. The reflexive reduction, or irreflexive kernel, of a binary relation ^{˜} on a set S is the smallest relation \tilde{≠} such that \tilde{≠} shares the same reflexive closure as ^{˜}. It can be seen in a way as the opposite of the reflexive closure. It is equivalent to the complement of the identity relation on S with regard to ^{˜}, formally: (\tilde{≠})=(^{˜})\(=). That is, it is equivalent to ^{˜} except for where x^{˜}x is true. For example, the reflexive reduction of x≤y is x<y. Numeric isolated super alloy cylinders in series and parallel refrigerant-dynamic conductive circuits are connected to the portable or stationary refrigeration unit from super alloy connecting rods supercooling the outside walls of the cylinders. The outer cylinder cools activating an electronic air compressor rated alternating current AC or direct current DC filling the inner variable cylinders with fluid compression providing diffusive flux compensation expanding or contracting the inner cylinders as fluctuating compensator forcing the carbon dioxide CO₂ filled outer cylinders through a continuous circuit of super alloy curved or linear the first linear, local, circular moment, or equivalently the circular mean and circular variance number A spaces. The series of a real, or complex valued function continue a collective dynamic function of the complex space C^{p}, p≥1. arithmetic progression calculus mathematic expression the number theorem. The insertion of a cyclic point coordinate [symbol] dynamic constant exponent the tools of ordinary calculus of variations with an adjustable Lagrange multiplier=μ; [symbol] 1, [symbol] 2 eigenvalue of the ∧, λ longitude, and standard in transverse combination relaxation rates, respectively. The longitudinal integral of the trivial bundle does vanish, i.e. the K-theory index of the longitudinal Dirac operator is equal to 0. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Thus, the integral over V of the trivial bundle vanishes, Ab(V)=0. Note that here only F is assumed to be Spin so that Ab(V) is not a priori an integer. Whose spatial periods (wavelengths) are representations correspond to the little group integral submultiples of Lᵥ colimit 2.0 topology. Numbers, symbols and dynamics operators comprising a scientific aperture, control valve, or control valve venturi a vector calculus fundamental theorem limits of functions continuity, mean value theorem, by way of real-valued function f is continuous on a closed interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path, differentiable on the open interval (a, b), and f(a)=f(b), then there exists a c in the open interval (a, b) such that f′(c)=0, continuum a lift a normal k-smoothing isometries mechanics differential, integral, series, vector, multivariable, and discrete entity, divergence is a vector operator that measures the magnitude of a vector field's source or sink at a given point, in terms of a signed scalar, the divergence represents the volume density of the outward flux of a vector field from an infinitesimal volume around a given point, condensed phases condensation “super-fluid” as it is cooled and contracts, molecular diffusion coefficient the relevant vector field is the velocity of motion fluid at a point, the fluid cools and contracts, the divergence has a negative value, as the region is a sink, measured in angulation and a scientific aperture, control valve, or control valve venturi molecular diffusive fluid refrigerant chemistry continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} pressure pumps negative or positive pressurization stream is the accelerator. Fluid mechanic the flow velocity μ of a fluid random dilution of random matrices H_{N}=U_{N} F_{N} U^{†}_{N} where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. The eigenvalue distribution function of dilute random matrices [H_{N}]_{d} converges to the semicircle Wigner distribution in the limit N→∞, p→∞, where p is the dilution parameter. This convergence can be explained by the observation that the dilution eliminates statistical dependence between the entries of [H_{N}]_{d}. The same statement is valid for the entries of [U_{N}]_{d}. It may be seen that the Wigner law is valid for wide classes of random dilution of random matrices H_{N}=U_{N} F_{N} U^{†}_{N}, where U_{N} are uniformly distributed over the group of N×N unitary matrices and F_{N} are non-random Hermitian matrices, and real and complex Hermitian solutions to the classical system of quaternion matrix equations by Shao-Wen Yu. We establish necessary and sufficient conditions for the existence of and the expressions for the general real and complex Hermitian solutions to the classical system of quaternion matrix equations A₁X C₁,XB₁ C₂, and A^{3X A*3}=C₃. Moreover, formulas of the maximal and minimal ranks of four real matrices X₁,X₂,X₃, and X₄ in solution X X₁ X₂i X₃j X₄k to the system mentioned above are derived. As applications, we give necessary and sufficient conditions for the quaternion matrix equations A₁X C₁,XB₁ C^{2, A3 X A83}=C₃, and A^{4, X A*4}=C₄ to have real and complex Hermitian solutions. Positive pressurization supercooling refrigeration deceleration temperature less than or equal to ≤−109.3° F. degrees Fahrenheit or −78.5° C. degrees Celsius carbon dioxide CO₂ nondegenerate 2-form structure in potential theory complex analysis proves invaluable mathematical physics expressions an infinite potential 2-form dry ice in the outer superconducting cryopumps a cryocircuit numeric and hyper-numeric cylinders continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} hyper-numeric series and parallel superconducting cryopumps a cryocircuit wave packets of thermodynamic range characteristic luminosity L* evolve as for the wave equation for a wave on a Ω^{String}₂ₙ, (we refer to) “Inertia Groups and Smooth Structures of (n−1)-Connected 2n-Manifolds” Kasilingam Ramesh (received Jul. 2, 2014, revised Dec. 22, 2014) “(ii): Since the image of the standard sphere under the isomorphism Θ⁻₂ₙ=Ω^{String}₂ₙ represents the trivial element in Ω^{String}₂ₙ, we have [M²ⁿ]≠[M # Σ] in Ω^{String}₂ₙ. This implies that M and M # Σ are not BString-bordant. By obstruction theory, M²ⁿ has a unique string structure. This implies that M and M # Σ are not diffeomorphic”. Power series expansion which starts with terms at least of order 2n+1; ^{H}2₌ₐ an output of windows frame m₀ m₂ y:[A, b]→S together with a subdivision a=τ₀<τ₁<τ₂<∧<τₙ=b of [A, b] centered; or frame m₀≥m₁≥m₂ of reference centered the value of μₑ is computed where the coefficients are carried as floating point numbers, such D₆ as a function of μ and then to evaluate it at the critical value μₑ with the critical value g(y) in order to establish the stability criteria computation of rational numbers as coefficients. The series of a real, or complex valued function f(x) that is infinitely differentiable at a real, or complex-number a is the power series too (fortuitously) does the purely real a wave function electron energy loss spectroscopy (EELS). Output of windows frame m₀≥m₁≥m₂ y:[A, b]→S together with a subdivision a=τ₀<τ₁<τ₂<∧<τₙ=b of [A, b] centered; or frame m₀≥m₁≥m₂ of reference centered virtual channel output of windows frames (Photon optical banded energy cables) spectroscopy f(x) polytope group subspace the cross polytope ßn is the regular polytope. (We refer to) Trialgebras and families of polytopes May 6, 2002 Jean-Louis Loday and María O. Ronco. “Trialgebras and families of polytopes introduced by Jean-Louis Loday and María Ronco a new type of algebras that we call the cubical trialgebras (resp. associative trialgebras) is a Koszul operad, or, equivalently, that the homology of the free dendriform trialgebra is trivial. We show that the family of standard simplices and the family of Stasheff polytopes are dual to each other in the following sense. The chain modules of the standard simplices, resp. the Stasheff polytopes, assemble to give an operad. We show that these operads are dual of each other in the operadic sense. The main result of this paper (we refer to) is to show that they are both Koszul operads. As a consequence the generating series of the standard simplices and the generating series of the Stasheff polytopes are inverse to each other. The two operads give rise to new types of algebras with 3 generating operations, 11 relations, respectively 7 relations, that we call associative trialgebras and dendriform trialgebras respectively. The free dendriform trialgebra, which is based on planar trees, has an interesting Hopf algebra structure, which will be dealt with in another paper. Similarly the family of cubes gives rise to an operad which happens to be self-dual for Koszul duality. Introduction. We introduce a new type of associative algebras characterized by the fact that the associative product * is the sum of three binary operations: x*y:=x [symbol] y+x [symbol] y+x·y, and that the associativity property of * is a consequence of 7 relations satisfied by [symbol] , [symbol] and ·, cf. 2.1. Such an algebra is called a dendriform trialgebra. An example of a dendriform trialgebra is given by the algebra of quasi-symmetric functions (cf. 2.3). Our first result is to show that the free dendriform trialgebra on one generator can be described as an algebra over the set of planar trees. Equivalently one can think of these linear generators as being the cells of the Stasheff polytopes (associahedra), since there is a bijection between the k-cells of the Stasheff polytope of dimension n and the planar trees with n+2 leaves and n−k internal vertices. The knowledge of the free dendriform trialgebra permits us to construct the algebras over the dual operad (in the sense of Ginzburg and Kapranov [G-K]) and therefore to construct the chain complex of a dendriform trialgebra. This dual type is called the associative trialgebra since there is again three generating operations, and since all the relations are of the associativity type (cf. 1.2). We show that the free associative trialgebra on one generator is linearly generated by the cells of the standard simplices. The main result of this paper (we refer to) is to show that the operads of dendriform trialgebras (resp. associative trialgebras) is a Koszul operad, or, equivalently, that the homology of the free dendriform trialgebra is trivial. As a consequence of the description of the free trialgebras in the dendriform and associative framework, the generating series of the associated operads are the generating series of the family of the Stasheff polytopes and of the standard simplices respectively: fₜ^{K}(x)=Σ_{n≥1}(−1)ⁿp(Kⁿ⁻¹,t)xⁿ, fₜ^{Δ}(X)=Σ_{n≥1}(−1)ⁿp(Δⁿ⁻¹,t )xⁿ Here p(X,t) denotes the Poincaré polynomial of the polytope X. The acyclicity of the Koszul complex for the dendriform trialgebra operad implies that fₜ^{Δ}(fₜ^{K}(x))=x. Since p(Δⁿ,t)=((1+t)ⁿ⁺¹−1)/t one gets fₜ^{Δ}(x)=−x/(1+x)(1+(1+t)x) and therefore fₜ^{K}(x)=−(1+(2+t)x)+√1 +2(2+t)x+t²x²/2(1+t)x. In [L1, L2] we dealt with dialgebras, that is with algebras defined by two generating operations. In the associative framework the dialgebra case is a quotient of the trialgebra case and in the dendriform framework the dialgebra case is a subcase of the trialgebra case. If we split the associative relation for the operation * into 9 relations instead of 7, then we can devise a similar theory in which the family of Stasheff polytopes is replaced by the family of cubes. So we get a new type of algebras that we call the cubical trialgebras. It turns out that the associated operad is self-dual (so the family of standard simplices is to be replaced by the family of cubes). The generating series of this operad is the generating series of the family of cubes: fₜ^{I}(x)=−x/1+(t+2)x. It is immediate to check that fₜ^{I}(fₜ^{I}(x))=x, hence one can presume that this is a Koszul operad. Indeed we can prove that the Koszul complex of the cubical trialgebra operad is acyclic. As in the dialgebra case the associative algebra on planar trees can be endowed with a comultiplication which makes it into a Hopf algebra. This comultiplication satisfies some compatibility properties with respect to the three operations [symbol] , [symbol] and ·. This subject will be dealt with in another paper. Here is the content of the paper 1. associative trialgebras and standard simplices. 2. dendriform trialgebras and Stasheff polytopes. 3. Homology and Koszul duality. 4. Acyclicity of the Koszul complex. 5. cubical trialgebras and hypercubes. In the first section we introduce the notion of associative trialgebra and we compute the free algebra. This result gives the relationship with the family of standard simplices. In the second section we introduce the notion of dendriform trialgebra and we compute the free algebra, which is based on planar trees. This result gives the relationship with the family of Stasheff polytopes. In the third section we show that the associated operads are dual to each other for Koszul duality. Then we construct the chain complexes which compute the homology of these algebras. The acyclicity of the Koszul complex of the operad is equivalent to the acyclicity of the chain complex of the free associative trialgebra. This acyclicity property is the main result of this paper (we refer to), it is proved in the fourth section. After a few manipulations involving the join of simplicial sets we reduce this theorem to proving the contractibility of some explicit simplicial complexes. This is done by producing a sequence of retractions by deformation. In the fifth section we treat the case of the family of hypercubes, along the same lines. These results have been announced in [LR2]. Convention. The category of vector spaces over the field K is denoted by Vect, and the tensor product of vector spaces over K is denoted by ⊗. The symmetric group acting on n elements is denoted by Sₙ. associative trialgebras and standard simplices. In [L1, L2] the first author introduced the notion of associative dialgebra as follows. 1.1 Definition. An associative dialgebra is a vector space A equipped with 2 binary operations: ┤ called left and ├ called right, (left) ┤: A⊗A→A, (right) ├: A⊗A→A, satisfying the relations: {(x┤y)┤z=x┤(y┤z), (x┤y)┤z=x┤(y├z), (x├y)┤z=x├(y┤z), (x┤y)├z=x├(y├z), (x├y)├z=x├(y├z). Observe that the eight possible products with 3 variables x,y,z (appearing in this order) occur in the relations. Identifying each product with a vertex of the cube and moding out the cube according to the relations transforms the cube into the triangle Δ²: cube: ┤(├), ├(├), (├)├, (┤)├, ┤(┤), ├(┤), (┤)├, (├)├, →triangle: ├ ┤, ┤ ┤, ├ ├. There are double lines which indicate the vertices which are identified under the relations. Let us now introduce a third operation ⊥: A⊗A→A called middle. We think of left and right as being associated to the 0-cells of the interval and middle to the 1-cell: ┤ ⊥ ├ [symbol] . Let us associate to any product in three variables a cell of the cube by using the three operations ┤, ├, ⊥. The equivalence relation which transforms the cube into the triangle determines new relations (we indicate only the 1-cells): cube: ⊥(├), (⊥)├, ┤(⊥), ├(⊥), (├)⊥, (┤) ⊥, ⊥(┤), (⊥)┤, →triangle: ⊥ ┤, ├ ⊥, (┤) ⊥=⊥(├). This analysis justifies the following: 1.2 Definitions. An associative trialgebra (resp. an associative trioid) is a vector space A (resp. a set X) equipped with 3 binary operations: ┤ called left, ├ called right and ⊥ called middle, satisfying the following 11 relations: {(x┤y)┤z=x┤(y┤z), (x┤y)┤z=x┤(y├z), (x├y)┤z=x├(y┤z), (x┤y)├z=x├(y├z), (x├y)├z=x├(y├z), {(x┤y)┤z=x┤(y⊥z), (x⊥y)┤z=x⊥(y┤z), x┤y)⊥z=x⊥(y├z), x├y)⊥z=x├(y⊥z), (x⊥y)├z=x├(y├z), {(x⊥y)⊥z=x⊥(y⊥z). First, observe that each operation is associative. Second, observe that the following rule holds: “on the bar side, does not matter which product”. Third, each relation has its symmetric counterpart which consists in reversing the order of the parenthesizing, exchanging ├ and ┤, leaving ⊥ unchanged. A morphism between two associative trialgebras is a linear map which is compatible with the three operations. We denote by Trias the category of associative trialgebras. dendriform trialgebras and Stasheff polytopes. In [L1, L2] the first author introduced the notion of dendriform dialgebras. Here we add a third operation. 2.1 dendriform trialgebras. By definition a dendriform trialgebra is a vector space D equipped with three binary operations: [symbol] called left, [symbol] called right, · called middle, satisfying the following relations: {(x [symbol] y) [symbol] z=x [symbol] (y*z), (x [symbol] y) [symbol] z=x [symbol] (y [symbol] z), (x*y) [symbol] z=x [symbol] (y [symbol] z) {(x [symbol] y)·z=x [symbol] (y·z), (x [symbol] y)·z=x·(y [symbol] z), (x·y) [symbol] z=x·(y [symbol] z), {(x·y)·z=x·(y·z), where x*y:=x [symbol] y+x [symbol] y+x·y. 2.2 Lemma. The operation * is associative. Proof. It suffices to add up all the relations to observe that on the right side we get (x*y)*z and on the left side x*(y*z). Whence the assertion. In other words, a dendriform trialgebra is an associative algebra for which the associative operation is the sum of three operations and the associative relation splits into 7 relations. We denote by Tridend the category of dendriform trialgebras and by Tridend the associated operad. By the preceding lemma, there is a well-defined functor: Tridend→As, where As is the category of (nonunital) associative algebras. Observe that the operad Tridend does not come from a set operad because the operation * needs a sum to be defined. However there is a property which is close to it. It is discussed and exploited in [L3]. By definition the Koszul complex associated to the operad Trias is the differential functor Tridend ∘ Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C^{*Trias}(Trias(V)) is proved. 1. We show that it is sufficient to treat the case V=K. 2. The chain complex C^{*Trias}(Trias(K)) splits into the direct sum of chain complexes C^{*}(u), one for each element u in P_{m,m}≥1. 3. The chain complex C^{*}(u) is shown to be the cell complex of a simplicial set X(u). 4. The space X(u) is shown to be the join of spaces X(v) for certain particular elements v in Pₘ″. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B^{*}B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A). Then μ is pure if and only if p t is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−v∥=lim(μ−v)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−t)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Suspension zero centered value of μₑ is computed where the coefficients are carried as floating point numbers, such D₆ as a function of μ and then to evaluate it at the critical value μₑ with the critical value g(y) in order to establish the stability criteria computation of rational numbers as coefficients terms at least of order 2n+1; ^{H}2₌ₐ; positive constants: H₄=½(AI²₁−2BI₁I₂+c cß), A, B, C constants wave packets of light thermodynamic characteristic luminosity L* evolve as heat a heater fluid a superconductor of magnetic-enthalpy in symbol H f(a)+f′(a)/1!(x−a)+f″(a)/2!(x−a)²+f′″(a)/3!(x−a)³+ . . . isotopic a computer processor given critical set are the minimum type power series two linearly independent solutions thermodynamic characteristic range S to sets. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of L, can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩l{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0, 1, 2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1}. Semiprime rings. Two rings R,S are Morita equivalent if their categories of left modules are equivalent. R and M n(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and M n(R) are known to be Morita equivalent. In some C*algebraic sense, B₀(H) is Morita equivalent to C. Theorem (Morita) Let F:R-Mod→S-Mod be an equivalence of categories. Isotopic class [A] lower bound of these maxima over all sets an isotopy class is said to be closed if it contains the topological limit of any sequence of sets in it. N=1 in n dimensions corresponding to the convex hull of the points formed by permuting the coordinates (±1, 0, 0, . . . , 0). A cross-polytope (also called an orthoplex) is denoted Rn and has 2 n vertices and Schläfli symbol {3, . . . , 3, 4/n−2}. The cross polytope is named because its 2 n vertices are located equidistant from the origin along the Cartesian axes in Euclidean space, which each such axis perpendicular to all others. A cross polytope is bounded by 2ⁿ(n−1)-simplexes, and is a dipyramid erected (in both directions) into the nth dimension, with an (n−1)-dimensional cross polytope as its base. In one dimension, the cross polytope is the line segment [−1, 1]. In two dimensions, the cross polytope {4} is the filled square with vertices (−1, 0), (0, −1), (1, 0), (0, 1). In three dimensions, the cross polytope {3, 4} is the convex hull of the octahedron with vertices (−1, 0, 0), (0, −1, 0), (0, 0, −1), (1, 0, 0), (0, 1, 0), (0, 0, 1). In four dimensions, the cross polytope {3, 3, 4} is the 16-cell, depicted in the above figure by projecting onto one of the four mutually perpendicular three-spaces within the four-space obtained by dropping one of the four vertex components (R. Towle). The skeleton of Rn is isomorphic with the circulant graph Ci2ₙ (1, 2, . . . , n−1), also known as the n-cocktail party graph polytope group x⊥, y⊥ for all dimensions, the dual of the cross polytope is the hypercube (and vice versa). Consequently, the number of k-simplices contained in an n-cross polytope is (ⁿk+1)2^{k+1}. We continue with nearby level surface point structure, or solid domain occupies surface point structure fluid filled, or unfilled (volute, or solute) space number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k≤d−1, is there a d-polytope that can not be realized with all its k-faces tangent to a sphere? Leaving aside the trivial cases of d≤2, he constructed non-k-scribable examples for all the cases except for d=3 and k=1, i.e. 3-polytopes that are not edge-scribable. Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. An output of windows frame m₀≥m₁≥m₂ y: [A, b]→S together with a subdivision a=τ₀<τ₁<τ₂<∧<τₙ=b of [A, b] centered; or frame m₀≥m₁≥m₂ of reference centered frames an output of windows coefficients terms at least of order 2n+1; ^{H}2₌ₐ; positive constants: H₄=½(AI²₁−2BI₁I₂+c cß)⊚, A, B, C constants wave packets of light thermodynamic characteristic luminosity L* evolve as heat a heater fluid a superconductor of magnetic-enthalpy in symbol H ƒ(a)+f′(a)/1!(x−a)+f″(a)/2!(x−a)²+f′″(a)/3!(x−a)³+ . . . isotopic a computer processor that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets of light, f(x) that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets of energy, or f(x) that is infinitely differentiable we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) at a real, or complex-number a is the power series build wave packets we also incorporate in our optical spectroscopy one set of electrodes are arranged superlattice we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) we can illustrate the manifold for Bloch wave with conventional topology that corresponds to a time-independent superlattice. In this case the manifold does not possess a twist. The vector field is transported along a single closed path in k space without a change in phase. The amplitude of the wave function in this case does not depend on the wave number. Through a series of numerical simulations, we now can demonstrate the application of the concept of time-dependent modulation of elastic properties in achieving bulk wave propagation functionalities for non-reciprocity and immunity to scattering. The vectors remain parallel to each other through a full loop (2π/L rotation) in k space reaching point C; and one needs another full turn to go through the twist a second time and rotate the vector by π again. The vectors remain parallel until they close the continuous path and reach the point A. The vector has accumulated a 2 π phase difference along a 4π/L closed Path. We continue banding (Photon optical banded energy cables) spectroscopy f(x) polytope group subspace the cross polytope Rn is the regular polytope a virtual channel of reference centered Abelian nondegenerate 2-form structure in potential theory complex analysis proves invaluable mathematical physics expressions an infinite potential one {1×1 column}. The Fourier series generalizes to the Fourier transform. Whereby a∈A singletons have {points {and the entire space R n is our solution set of an arbitrary possibly, infinite system ≤b_{α}, α∈A α^{T}_{α}x≤b_{α}, α∈A of linear inequalities with n unknowns x{the set M={x∈Rⁿ|α^{T}_{α}x≤b_{α}, α∈A} is convex, of linear inequalities with n unknowns x closed priori measures that the moments solution, or the weighted set of an arbitrary possibly n=2; after generalizing the notion of integration, the logarithm can be viewed either as the inverse function of the exponential, or as the integral log z=integral sign ∫ 1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals. Returning to geometric ideas, nondegenerate 2-form structure in potential theory complex analysis proves invaluable mathematical physics expressions an infinite potential one {1×1 column}. Finally the geometric ideas of Riemann can be viewed in terms of modern topology to give a global insight into ‘many-valued’ functions (the logarithm can be viewed either as the inverse function of the exponential, or as the integral log z=integral sign ∫ 1/z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g: X Q is an arbitrary module homomorphism, now we have a module homomorphism [symbol] :Y→Q such that [symbol] f=g, the following diagram commutes: [symbol] *0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “54. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and a″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩l{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space Re p for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, t). Therefore, (2.39) holds as an equality of formal power series. As the theory of complex analysis unfolds, We may recall the immense importance of this definition. Complex functions f will be restricted to those of the form f: D→C where D is a domain. The fact that D is open will allow us to deal neatly with limits, continuity, and differentiability because z₀∈D implies the existence of a positive ε such that N_{ε}(z₀)⊆D and so f(z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S⊆C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some τ∈R} is path connected. Sometimes it is more convenient to use a simpler type of path. Definition. A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S⊆C which is path connected but is not step connected. Theorem. Every open disc N_{ε}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁˜z₂ iff there exists a path y in S from zᵢ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in C then all the connected components of S are open in C. One interesting way to generate open sets in C is to consider the complement of a path. Definition. Let y:[A, b]→C be a path. The complement of y is defined to be C\y([A, b]). For d≥2 and n∈N even, let pₙ=pₙ(d) denote the number of length n self-avoiding polygons in Z^{d} up to translation. The polygon cardinality grows exponentially, and the growth rate lim_{n∈2N pn}^{1/n}∈(0,∞) is called the connective constant and denoted by μ. It has been shown that pₙμ⁻ⁿ≤Cn^{-1/2} in dimension d=2. Here we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations. The polygon cardinality grows exponentially, and the growth rate lim_{n∈2N pn}^{1/n}∈(0,∞) is called the connective constant and denoted by μ. It has been shown that pₙμ⁻ⁿ≤Cn^{-1/2} in dimension d=2. Here we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations a computer processor of formal Dirichlet power generating series the connective constant a weighted mechanical advantage set coefficient A step path in S is a path y:[A, b]→S together with a subdivision a=τ₀<τ₁<τ₂<∧<Δₙ=b of [A, b] such that in each subinterval [τⱼ₋₁, τⱼ] either re(y) or im(y) is constant Δ₀<Δ₁<τ₂<∧<τₙ=b of let y:uniform on [A, b]→C be a path we find the natural base of the plane points denoted by μ in number theory the sum of their Dirichlet series arrangement (A,w). Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients do are too fortuitously real including the dot product or scalar product of algebraic operation takes two equal-length sequences of numbers coordinated with a return of a single number Vparallelpiped a set of thermodynamic, light and/or power series built in nondegenerate 2-form structure in potential theory complex analysis proves invaluable mathematical physics expressions an infinite potential quantum wavenumber data sequences mathematic computation mechanics position Q 2\hat{ }n−1 cypher-encryption power sets: the power set functor P:Set→Set maps each set to its power set and each function f:X→Y to the map which sends U⊆X to its image f(U)⊆Y. One can also consider the contravariant power set functor which sends f:X→Y to the map which sends V⊆Y to its inverse image f⁻¹(V)⊆X carrier (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then a∧β=(−1)^{pq} β∧a. And is associative, (a∧β)∧μ=α∧(β∧μ), and bilinear (c₁ α₁+c₂ α₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧ . . . ∧e_{jg} when the indices iₚ, j₁, . . . , j_{q}, are distinct, and the product is zero otherwise. While the formula α∧α=0 holds when α has degree one, it does not hold in general. We consider a=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ≠0. Every hyperbola has two asymptotes. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ=n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology. Zipping function f 1→f2 of structure power sets: the power set functor P:Set→Set maps each set to its power set and each function f:X→Y to the map which sends U⊆X to its image f(U)⊆Y. One can also consider the contravariant power set functor which sends f:X→Y to the map which sends V⊆Y to its inverse image f⁻¹(V)⊆X photocurrent logarithmic T_{c} equiangular relates to having angles of equal measure, or growth spiral vector of the isospin (ith spin), and Q is the wavevector of the pure spiral curve in polar coordinates (r, Θ) the curve r=ae^{bΘ} or (Θ)=1/b 1n(r/a), with e being the base of natural logarithms, and a and b being arbitrary positive constants. We use Open and Closed Intervals: by Real Analysis; and Calculus. Bounded Open and Closed Intervals Definition: If a,b∈R such that a<b, then the open interval determined by the endpoints a and b is the set (a,b):={x∈R:a<x<b}. The closed interval determine by the endpoint a and b is A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path:={x∈R:a≤x≤b}. Similarly the half open interval determined by the endpoints a and b is (a,b]:={x∈R:a<x≤b} or [a,b):={x∈R:α≤x<b}. It is important to note that in an open interval, the endpoints are not necessarily in the interval. For example, consider the interval (2,3) which is analogous to the inequality 2<x<3. Notice that the values x=2 and x=3 do not satisfy the inequality, that is 2 [symbol] 2<3 and 2<3 [symbol] 3, so these values of x are not in this interval. Definition: If a≤b defines either an open or closed interval of real numbers, then the length of this interval is b−a. For example, the length of the interval (2,3) is 3−2 =1, which should make sense since (2,3) covers a length of 1 on the real number line. Another example is the degenerate interval [3,3] whose length is 3−3 =0. Unbounded Open and Closed Intervals. There are five other types of intervals, all of which are unbounded and are defined as followed with a,b∈R, (a,∞)={x∈R:x>a}, [a,∞)={x∈R:x≥a}, (−∞,a)={x∈R:x<a}, (−∞,a]={x∈R:x≤a}, and (−∞,∞)=R. [A. Connes. An analogue of the Thom isomorphism for crossed products of a C*-algebra by an action of R. Adv. in Math. 39 (1981)] Let A be a C*-algebra, α a one-parameter group of automorphisms of A, e=e*=e² a self-adjoint projection, e∈A, of A. There exists an equivalent projection f˜e, f∈A, and an outer equivalent action α⁰ of R on A such that α′ₜ(f)=f ∀t∈R. One first replaces e by an equivalent projection f such that the map t→αₜ(f)∈A is of class C^{∞}, and then one replaces the derivation δ=(d/dtαₜ)ₜ₌₀ which generates α by the new derivation δ⁰=δ+ad(h) where ad(h)x=hx−xh ∀x∈A, and h=fδ(f)−δ(f)f. From Lemma 7 and the canonical isomorphism Ao_{α}R˜Ao_{α}0R for outer equivalent actions one gets the construction of ϕ⁰_{α}: K₀(A)→K₁(A×_{α} R). Replacing A by SA, one gets similarly ϕ¹_{α}: K₁(A)→K₀(A×_{α} R). Theorem [A. Connes. An analogue of the Thom isomorphism for crossed products of a C*-algebra by an action of R. Adv. in Math. 39 (1981)] Let A be a C*-algebra, and let α be a one-parameter group of automorphisms of A. Then ϕ_{α}: Kᵢ(A)→Kᵢ₊₁(Ao_{α}R) is an isomorphism of Abelian groups for i=0,1. The composition ϕ_{α\hat{ }}∘ϕ_{α} is the canonical isomorphism of Kᵢ(A) with Kᵢ(A⊗K), where the double crossed product is identified with A⊗K by Theorem. The proof is simple since it is clearly enough to prove the second statement, and to prove it only for i=0. One then uses Lemma 7 to reduce to the case A=C, where it is easy to check ([A. Connes. An analogue of the Thom isomorphism for crossed products of a C*-algebra by an action of R. Adv. in Math. 39 (1981)]). The above theorem immediately extends to arbitrary simply connected solvable Lie groups H in place of R. Ab(F) is the Ab-genus of this Spin bundle. When F=TV, i.e. when the foliation has just one leaf, this is exactly the content of the well-known vanishing theorem of A. Lichnerowicz (A. Lichnerowicz. Deformations d'algebres associees a unevariete symplectique (les *ᵥ-produits). Ann. Inst. Fourier (Grenoble) 32 (1982)). As an immediate application we see that no spin foliation of a compact manifold V, with non-zero Ab-genus, A\hat{ }(V)/=0, admits a metric of strictly positive scalar curvature. Proof. The projection V→V/F is K-oriented by the Spin structure on F and hence defines a geometric cycle x∈K_{*,τ}(BG). The argument of [J. Rosenberg. C*-algebras, positive scalar curvature and the Novikov conjecture. Inst. Hautes Etudes Sci. Publ. Math. No. 58′ (1983)] shows that the analytical index of the Dirac operator along the leaves of (V,F) is equal to 0 in K•(C*ᵣ(V, F)], so that one has μᵣ(x)=0 with μᵣ the analytic assembly map. Let f:V→BG be the map associated to the projection V→V/F. There exists a polynomial P in the Pontryagin classes of τ, with leading coefficient 1, such that ϕ∘Ch(x)=f_{*}(Ab(F)∩[V])∩P∈H_{*}(BG). Thus, since μᵣ(x)=0, the result follows from Theorem.
Corollary Let (V,F) and (V⁰,F⁰) be oriented and transversely oriented compact foliated manifolds. Let f:V→V⁰ be a smooth, orientation preserving, leafwise homotopy equivalence. Then for any element P of the ring R⊂H*(V,C) of Corollary one has h(f*L(V⁰)−L(V)), P∩[V]i=0 where L(V) (resp. (V⁰)) is the L-class of V (resp. V⁰). [symbol] Index formula for longitudinal elliptic operators. The main difficulty in the proof of Theorem 8 is to show the topological invariance of the cyclic cohomology map ϕ:K(A)→C, A=C_{c}^{∞}(G,Ω^{1/2}). We refer to [A. Connes. Cyclic cohomology and the transverse fundamental class of a foliation. Geometric methods in operator algebras (Kyoto, 1983), pp. 52-144, Pitman Res. Notes in Math., 123, Longman, Harlow, 1986] for the proof. Here we shall explain how to compute the pairing h [symbol] (c),Ind(D)i∈C of the cyclic cohomology of A with the index Ind(D)∈K₀(A) of an arbitrary longitudinal elliptic operator D, α). The result is stated quite generally in the theorem on p. 888 of [A. Connes. Cyclic cohomology and noncommutative differential geometry. Proceedings of the International Congress of Math. (ICM Berkeley, Calif., 1986) Vol. 2, pp. 879-889, Amer. Math. Soc., Providence, R.I., 1987], but we shall make it more specific, using the natural map [symbol] : H*_{τ}(BG)→H*(A) constructed in Section 2 δ) Theorem 14 and Remark b). The gas enters the domain at station 1 with some velocity u and some pressure p and exits at station 2 with a different value of velocity and pressure. For simplicity, we will assume that the density r remains constant within the domain and that the area A through which the gas flows also remains constant. The location of stations 1 and 2 are separated by a distance called Δd x. This change with distance is a gradient. The velocity gradient is indicated by Δd u/Δd x; the change in velocity per change in distance. So at station 2, the velocity is given by the velocity at 1 plus the gradient times the distance u2=u1+(Δd u/Δd x)*Δd x. A similar expression gives the pressure at the exit: p2=p1+(Δd p/Δd x)*Δd x. We have a one dimensional, steady form of Euler's identity is the equality e^{iπ}+1=0. It is interesting to note that the pressure drop of a fluid (the term on the left) is proportional to both the value of the velocity and the gradient of the velocity. The constant of proportionality is k=y/x. Given our linear function y=mx+b the direct constant of proportionality is m: the direct constant of proportionality for any given function y, between any x values, is given by r=Δy/Δx is slope. Therefore, our constant of proportionality is m. Proposition. Expanding, and contracting gases composed with atmospheric gases (sub-plasma the thermal system in relativity), open degenerate ρ(E), or closed degenerate ρ(E) subgroupoid composed with atmospheric gases proposition to the decomposition G_{M}=G₁∪G₂ of G_{M} as a union of an open and a closed subgroupoid corresponds the exact sequence of C*-algebras 0→C*(G₁)C*(G)→σC*(G₂)→0. 2) The C*-algebra C*(G₁) is isomorphic to C₀(]0,1])⊗K, where K is the elementary C*-algebra (all compact operators on Hilbert space). 3) The C*-algebra C*(G₂) is isomorphic to C₀(T*M), the isomorphism being given by the Fourier transform: C*(TxM)^{˜}C₀(T*xM), for each x∈M which we will call “x” an equilibrium point the topology of G is such that G₁ is an open subset of G and a sequence (xn,yn,εn) of elements of G₁=M×M×]0,1] with εn→0 converges to a tangent vector (x,X); X∈Tx(M) iff the following holds: The tangent groupoid of M xn→x, yn→x, xn−yn/εn→X. Compact operators. Let H be a Hilbert space and let Bf(H) be the set of finite rank operators in B(H). This is a two-sided ideal in B(H). If I is any proper 2-sided ideal, then Bf(H)⊂I. Let the exact sequence K₀(1)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. (We refer to). “Compact operators Let H be a Hilbert space and let B_{f}(H) be the set of finite rank operators in B(H). This is a two-sided ideal in B(H). If I is any proper 2-sided ideal, then B_{f}(H)⊂I. We define the compact operators B₀(H) to be the closure of B_{f}(H). Then B_{f}(H) is the minimal dense ideal in B₀(H). (The chain of inclusions B_{f}(H)⊂B₀(H)⊂B(H) is analogous to the chain of inclusions C_{c}(S)⊂C₀(S)⊂′^{∞}(S) where S is a set.) The identity operator is not compact, so B₀(H) is a natural example of a nonunital C*-algebra. B₀(H) is topologically simple in the sense that it has no proper 2-sided closed ideals. Its representation on H is irreducible. Moreover, every irreducible representation of B₀(H) is unitarily equivalent to H, and every nondegenerate representation is a direct sum of copies of H. Recall that two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Then F is naturally isomorphic to tensoring by _{R}X_{S} for some bimodule X. We return now to B₀(H). For v,w∈H define hv,wi₀∈B₀(H) by hv,wiu=vhw,ui. This is a rank-1 operator. If T∈B(H) then Thv,wi₀=hTv,wi₀, hence hv,Twi₀=hv,wi₀T^{*}. Theorem C₀(G) oα G is naturally isomorphic to B₀(L²(G)). Proof. C₀(G) oα G has a natural covariant representation (π,U) on L²(G) (which we might call the Schrödinger map). Let σ be its integrated form, defined on C_{c}(G,C₀(G))⊇C_{c}(G×G) by Z Z (σ_{F}(ξ))(x)=(F(y)U_{y}ξ)(x)=F(y,x)ξ(y⁻¹x)dy. Let f,g∈C_{c}(G)⊂L²(G) and ξ∈C_{c}(G). Let hf,gi₀ be the rank one operator given by hf,gi₀ξ=fhg,ξi_{L}2_{(G)}. Define hf,gi_{ε}(y,x)=f(x)⁻¹g(y⁻¹x)Δ(y⁻¹x)∈C_{c}(G×G) so that σ_{hf,giE}=hf,gi₀. Let E be the linear span of the functions hf,gi_{E} for f,g∈C_{c}(G). Then E is stable under pointwise product and complex conjugation, and moreover it separates the points of G×G. Hence E is dense in C_{c}(G×G) in the colimit topology, so E is dense in L¹(G,C₀(G)) and so in C₀(G) oα G. If f₁, . . . fₙ∈C_{c}(G) are orthonormal, then the hfⱼ,fₖi_{E} span a copy of Mₙ(C) (hence a C*-algebra with a unique C*-norm) inside C₀(G) oα G. Hence on this span the norm for C₀(G) oα G agrees with the norm on B(L²(G)) via σ. Hence a is isometric on E. Hence σ is isometric on C₀(G) oα G and maps into B₀(L²(G)), and we saw that it's onto. More generally, we can consider C₀(G/H) oα G, which turns out to be Morita equivalent to C^{*}(H). Since the reduced cross product is a quotient of the cross product C₀(G) oα G, which is B₀(L²(G)), and since B₀(L²(G)) has no proper quotients, we conclude that a is amenable. Given groups Q,N and α: Q→Aut(N) an action, we can form the semidirect product G=N oα Q, which is N×Q with the multiplication given by (n,x)(m,y)=(nαₓ(m),xy). We can do this for topological groups as well. These groups fit together in a split exact sequence 0→N→G→Q→0. Let N,Q be locally compact. If (H,U) is a strongly continuous unitary representation of G, then it restricts to unitary representations U|_{N},U|_{Q} of N and Q with a covariance relationship. U|_{N} has an integrated form σ^{N} giving a representation of C^{*}(N) on H. For any x∈Q, αₓ is an automorphism of N, so this gives an automorphism of L¹(N). Furthermore, via α, Q acts on the set of unitary representations of N, so acts via a group of automorphisms of C^{*}(N). This action is strongly continuous, so we can form the crossed product C^{*}(N) oα Q. We find that (H,σ^{N},U|_{Q}) is a covariant representation of (C^{*}(N),Q,α), hence gives a representation of the crossed product. The converse also holds. Proposition There is a natural isomorphism C^{*}(N oα Q)^{˜}=C^{*}(N) oα Q. If N is commutative, then C^{*}(N) is commutative, so C^{*}(N)^{˜}=C₀(N\hat{ }) where N\hat{ } is the Pontrjagin dual group of all continuous homomorphisms N→T. Then Q acts on and C^{*}(N oα Q)^{˜}=C₀(N\hat{ }) oα Q. Wigner. Consider R⁴ equipped with the bilinear form B(v,w)=v₀w₀−v₁w₁−v₂w₂−v₃w₃. The Lorentz group L is the group of linear transformations on R⁴ preserving B. Let α be its action on R⁴. The Poincaré group is the semidirect product P=R⁴oαL, and we want to consider its (physically interesting) unitary representations. Since R^{\hat{ }4˜}=R⁴, we are looking at C₀(R⁴) oα L, and we need irreducible representations of L. For v∈R^{\hat{ }4}=0, consider the stabilizer Pᵥ. The orbit of v looks like P/Pᵥ, so we want irreducible representations of C₀(P/Pᵥ)oα L. These representations correspond to representations of the little group L. For massive particles, Lᵥ=SU(2). Given any group G and subgroup H we know that C₀(G/H)oα G=C^{*}(H). Let's be explicit about this. Given a representation (H,U) of H, we get a representation of C₀(G/H) oα G by constructing the induced representation K={ξ: G→H: ξ(xs)=Uₛ(ξ(x))} where s∈H,x∈G. Note that x→kξ(x)k² is H-invariant so can be identified with a function on G/H; we require that this function is integrable”. (The Longitudinal Index Theorem for Foliations A. Connes* and G. Skandalis** 1983). (Sub-plasma gases the thermal system in relativity), condensed phases condensation “super-fluid” as it is cooled and contracts, molecular diffusion coefficient the relevant vector field is the velocity of motion fluid at a point, the fluid cools and contracts dimorphism (n) squeezing the odd number of isotopes with 1 real part symmetric positive definite, and its imaginary unit √−1 part symplectic by properties on a complex vector space V is a complex valued bilinear form on V which is antilinear in the second slot, and the system then is positive definite. Upon which the only data used in setting up the Yang Mills problem are 1) the *-algebra A_{Θ}, and 2) the formal “metric” dUdU*+dVdV*∈Ω²₊(A_{Θ}). We now state the Transfer Principle, which allows us to carry out computations with hyperreal numbers the same way we do for real numbers. Intuitively, the Transfer Principle says that the natural extension of each real function has the same properties as the original function. The Extension Principle and Transfer Principle of the axioms for the real numbers come in three sets: the Algebraic Axioms, the Order Axioms, and the Completeness Axiom. All the facts about the real numbers can be proved using only these axioms: heat transfer, of the continuous dimensions as densities continued as the component of acceleration normal acceleration is approximately zero in steady-state, incremental normal acceleration, and given the symbol n, when in g-units classification, and the self-inductance is determined by the geometry of individual circuit the symmetric group acting on n elements is denoted by Sₙ. (We refer to) Trialgebras and families of polytopes May 6, 2002 Jean-Louis Loday and María O. Ronco. “Trialgebras and families of polytopes introduced by Jean-Louis Loday and María Ronco a new type of algebras that we call the cubical trialgebras (resp. associative trialgebras) is a Koszul operad, or, equivalently, that the homology of the free dendriform trialgebra is trivial. We show that the family of standard simplices and the family of Stasheff polytopes are dual to each other in the following sense. The chain modules of the standard simplices, resp. the Stasheff polytopes, assemble to give an operad. We show that these operads are dual of each other in the operadic sense. The main result of this paper (we refer to) is to show that they are both Koszul operads. As a consequence the generating series of the standard simplices and the generating series of the Stasheff polytopes are inverse to each other. The two operads give rise to new types of algebras with 3 generating operations, 11 relations, respectively 7 relations, that we call associative trialgebras and dendriform trialgebras respectively. The free dendriform trialgebra, which is based on planar trees, has an interesting Hopf algebra structure, which will be dealt with in another paper. Similarly the family of cubes gives rise to an operad which happens to be self-dual for Koszul duality. Introduction. We introduce a new type of associative algebras characterized by the fact that the associative product * is the sum of three binary operations: x*y:=x [symbol] y+x [symbol] y+x·y, and that the associativity property of * is a consequence of 7 relations satisfied by [symbol] , [symbol] and cf. 2.1. Such an algebra is called a dendriform trialgebra. An example of a dendriform trialgebra is given by the algebra of quasi-symmetric functions (cf. 2.3). Our first result is to show that the free dendriform trialgebra on one generator can be described as an algebra over the set of planar trees. Equivalently one can think of these linear generators as being the cells of the Stasheff polytopes (associahedra), since there is a bijection between the k-cells of the Stasheff polytope of dimension n and the planar trees with n+2 leaves and n−k internal vertices. The knowledge of the free dendriform trialgebra permits us to construct the algebras over the dual operad (in the sense of Ginzburg and Kapranov [G-K]) and therefore to construct the chain complex of a dendriform trialgebra. This dual type is called the associative trialgebra since there is again three generating operations, and since all the relations are of the associativity type (cf. 1.2). We show that the free associative trialgebra on one generator is linearly generated by the cells of the standard simplices. The main result of this paper (we refer to) is to show that the operads of dendriform trialgebras (resp. associative trialgebras) is a Koszul operad, or, equivalently, that the homology of the free dendriform trialgebra is trivial. As a consequence of the description of the free trialgebras in the dendriform and associative framework, the generating series of the associated operads are the generating series of the family of the Stasheff polytopes and of the standard simplices respectively: fₜ^{K}(x)=Σ_{n≥1} (−1)ⁿp(Kⁿ⁻¹,t)xⁿ, fₜ^{Δ}(x)=Σ_{n≥1}(−1)ⁿp(Δⁿ⁻¹,t)xⁿ. Here p(X,t) denotes the Poincaré polynomial of the polytope X. The acyclicity of the Koszul complex for the dendriform trialgebra operad implies that fₜ^{Δ}(fₜ^{K}(x))=x. Since p(Δⁿ,t)=((1+t)ⁿ⁺¹−1)/t one gets fₜ^{Δ}(x)=−x/(1+x)(1+(1+t)x) and therefore fₜ^{K}(x)=−(1+(2+t)x)+√1 +2(2+t)x+t²x²/2(1+t)x. In [L1, [2] we dealt with dialgebras, that is with algebras defined by two generating operations. In the associative framework the dialgebra case is a quotient of the trialgebra case and in the dendriform framework the dialgebra case is a subcase of the trialgebra case. If we split the associative relation for the operation * into 9 relations instead of 7, then we can devise a similar theory in which the family of Stasheff polytopes is replaced by the family of cubes. So we get a new type of algebras that we call the cubical trialgebras. It turns out that the associated operad is self-dual (so the family of standard simplices is to be replaced by the family of cubes). The generating series of this operad is the generating series of the family of cubes: fₜ^{I}(x)=−x/1+(t+2)x. It is immediate to check that fₜ^{I}(fₜ^{I}(x))=x, hence one can presume that this is a Koszul operad. Indeed we can prove that the Koszul complex of the cubical trialgebra operad is acyclic. As in the dialgebra case the associative algebra on planar trees can be endowed with a comultiplication which makes it into a Hopf algebra. This comultiplication satisfies some compatibility properties with respect to the three operations [symbol] , [symbol] and ·. This subject will be dealt with in another paper. Here is the content of the paper 1. associative trialgebras and standard simplices. 2. dendriform trialgebras and Stasheff polytopes. 3. Homology and Koszul duality. 4. Acyclicity of the Koszul complex. 5. cubical trialgebras and hypercubes. In the first section we introduce the notion of associative trialgebra and we compute the free algebra. This result gives the relationship with the family of standard simplices. In the second section we introduce the notion of dendriform trialgebra and we compute the free algebra, which is based on planar trees. This result gives the relationship with the family of Stasheff polytopes. In the third section we show that the associated operads are dual to each other for Koszul duality. Then we construct the chain complexes which compute the homology of these algebras. The acyclicity of the Koszul complex of the operad is equivalent to the acyclicity of the chain complex of the free associative trialgebra. This acyclicity property is the main result of this paper (we refer to), it is proved in the fourth section. After a few manipulations involving the join of simplicial sets we reduce this theorem to proving the contractibility of some explicit simplicial complexes. This is done by producing a sequence of retractions by deformation. In the fifth section we treat the case of the family of hypercubes, along the same lines. These results have been announced in [LR2]. Convention. The category of vector spaces over the field K is denoted by Vect, and the tensor product of vector spaces over K is denoted by ⊗. The symmetric group acting on n elements is denoted by Sₙ. associative trialgebras and standard simplices. In [L1, L2] the first author introduced the notion of associative dialgebra as follows. 1.1 Definition. An associative dialgebra is a vector space A equipped with 2 binary operations: ├ called left and ┤ called right, (left) ┤: A⊗A→A, (right) ├: A⊗A→A, satisfying the relations: {(x┤y)┤z=x┤(y┤z), (x┤y)┤z=x┤(y├z), (x├y)┤z=x├(y┤z), (x┤y)├z==x├(y├z), (x├y)├z=x├(y├z). Observe that the eight possible products with 3 variables x,y,z (appearing in this order) occur in the relations. Identifying each product with a vertex of the cube and moding out the cube according to the relations transforms the cube into the triangle Δ²: cube: ┤(├), ├(├), (├)├, (┤)├, ┤(┤), ├(┤), (├)┤, (┤)┤, →triangle: ├ ┤, ┤ ┤, ├ ├. There are double lines which indicate the vertices which are identified under the relations. Let us now introduce a third operation ⊥: A⊗A→A called middle. We think of left and right as being associated to the 0-cells of the interval and middle to the 1-cell: ┤ ⊥ ├ [symbol] . Let us associate to any product in three variables a cell of the cube by using the three operations ┤,├,⊥. The equivalence relation which transforms the cube into the triangle determines new relations (we indicate only the 1-cells): cube: ⊥(├), (⊥)├, ┤(⊥), ├(⊥), (├)⊥, (┤) ⊥, ⊥(┤), (⊥)┤, triangle: ⊥ ┤, ├ ⊥, (┤)⊥=⊥(├). This analysis justifies the following: 1.2 Definitions. An associative trialgebra (resp. an associative trioid) is a vector space A (resp. a set X) equipped with 3 binary operations: ┤ called left, ├ called right and ⊥ called middle, satisfying the following 11 relations: {(x┤y)┤z=x┤(y┤z), (x┤y)┤z=x┤(y├z), (x├y)┤z=x├(y┤z), (x┤y)├z=x├(y├z), (x├y)├z=x├(y┤z), {(x┤y)┤z=x┤(y⊥z), (x⊥y)┤z=x⊥(y┤z), x┤y)⊥z=x⊥(y├z), x├y)⊥z=x├(y⊥z), (x⊥y)├z=x├(y├z), {(x⊥y)⊥z=x⊥(y⊥z). First, observe that each operation is associative. Second, observe that the following rule holds: “on the bar side, does not matter which product”. Third, each relation has its symmetric counterpart which consists in reversing the order of the parenthesizing, exchanging ├ and ┤, leaving ⊥ unchanged. A morphism between two associative trialgebras is a linear map which is compatible with the three operations. We denote by Trias the category of associative trialgebras. dendriform trialgebras and Stasheff polytopes. In [L1, L2] the first author introduced the notion of dendriform dialgebras. Here we add a third operation. 2.1 dendriform trialgebras. By definition a dendriform trialgebra is a vector space D equipped with three binary operations: [symbol] called left, [symbol] called right, · called middle, satisfying the following relations: {(x [symbol] y) [symbol] z=x<(y*z), (x [symbol] y) [symbol] z=x [symbol] (y [symbol] z), (x*y) [symbol] z=x [symbol] (y [symbol] z) {(x [symbol] y)·z=x [symbol] (y·z), (x [symbol] y)·z=x·(y [symbol] z), (x·y) [symbol] z=x·(y [symbol] z), {(x·y)·z=x·(y·z), where x*y:=x [symbol] y+x [symbol] y+x·y. 2.2 Lemma. The operation * is associative. Proof. It suffices to add up all the relations to observe that on the right side we get (x*y)*z and on the left side x*(y*z). Whence the assertion. In other words, a dendriform trialgebra is an associative algebra for which the associative operation is the sum of three operations and the associative relation splits into 7 relations. We denote by Tridend the category of dendriform trialgebras and by Tridend the associated operad. By the preceding lemma, there is a well-defined functor: Tridend→As, where As is the category of (nonunital) associative algebras. Observe that the operad Tridend does not come from a set operad because the operation * needs a sum to be defined. However there is a property which is close to it. It is discussed and exploited in [L3]. By definition the Koszul complex associated to the operad Trias is the differential functor Tridend∘Trias from Vect to Vect. It is shown that it is quasiisomorphic to the identity functor. Equivalently we have the Theorem. The homology of the free associative trialgebra on V is HnTrias(Trias(V))=nV if n=1, 0 otherwise. Proof of Theorem. The acyclicity of the augmented complex C^{*Trias}(Trias(V)) is proved. 1. We show that it is sufficient to treat the case V=K. 2. The chain complex C^{*Trias}(Trias(K)) splits into the direct sum of chain complexes C^{*}(u), one for each element u in P_{m,m}≥1. 3. The chain complex C^{*}(u) is shown to be the cell complex of a simplicial set X(u). 4. The space X(u) is shown to be the join of spaces X(v) for certain particular elements v in Pₘ″. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B^{*}B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, c). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−v∥=lim(μ−v)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g:X→Q is an arbitrary module homomorphism, now we have a module homomorphism [symbol] :Y→Q such that [symbol] f=g, the following diagram commutes: [symbol] *0→X^{g}↓ [symbol] Y the lemma follows intrinsic amount fitting the exact limit into the contravariant functor Hom(−,Q). (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σ aᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩l{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space Re p for all positive integer values of x and y formula for all composite numbers every even number paired by this formula subtracted by a given magnitude Q/2 would be a prime counting function denoting Q as a given magnitude Q/2+(2^{x-}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=′X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. We consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h r n+l)): to |Z_{T}^{h}−Ef(X_{T})≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). The magnitudes signals (sources) from random dilution of random matrices H_{N}=U_{N} F_{N} U^{†}_{N}, where U_{N} are uniformly distributed over the group of N×N unitary matrices and F_{N} are non-random Hermitian matrices, or real and complex Hermitian solutions our system of equations function. Equilateral number in base point k-face element plane the fundamental group we consider the category of pointed topological spaces, i.e. topological spaces with distinguished points finite-dimensional vector space of nondegenerate 2-form structure in potential theory complex analysis proves invaluable mathematical physics expressions an infinite potential n=2 flat dual vector space our bifunctor is a binary functor whose domain is a product category. For example, the Horn functor is of the type C^{op}×C→Set. It can be seen as a functor in two arguments. The Horn functor is a natural example; it is contravariant in one argument, covariant in the other. Our multifunctor is a generalization of the functor concept to n variables. So, for our example, a bifunctor is a multifunctor with n=2. (We refer to). “We shall sketch the proof for the case n=2 with the centralizer of an element in a one-relator group with torsion is always cyclic” An Improved Subgroup Theorem For HNN Groups with Some Applications. In [4], a subgroup theorem for HNN groups was established. (see Newman [11] or [4, p. 956]) B. B. Newman, Some results on one-relator groups, Bull. Amer. Math. Soc. 74 (1968), 568-571. One then gets the convolution algebra C_{c}^{∞}(G,Ω^{1/2}) of smooth 1-densities on G, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries. (We refer to) “Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations,” Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod S-Mod be an equivalence of categories. (We refer to) “An Improved Subgroup Theorem For HNN Groups with Some Applications”. Introduction. In [4], a subgroup theorem for HNN groups was established. The theorem was proved by embedding the given HNN group in a free product with amalgamated subgroup and then applying the subgroup theorem of [3]. In this paper (we refer to) we obtain a sharper form of the subgroup theorem of [4] by applying the Reidemeister-Schreier method directly, using an appropriate Schreier system of coset representatives. Specifically, we prove (in Theorem 1) that if H is a subgroup of the HNN group (1) G= [symbol] t, K; tLt⁻¹=M [symbol] , then H is an HNN group whose base is a tree product of vertices cKc⁻¹∩H where c ranges over a double coset representative system for G mod (H, K); the amalgamated and associated subgroups are contained in vertices of this base and are of the form dMd⁻¹∩H where d ranges over a double coset representative system for G mod (H, M). This improved subgroup theorem for HNN groups was obtained independently by D. E. Cohen [1] using Serre's theory of groups acting on trees. Using the present version of the subgroup theorem, several proofs in [4] can be simplified and results strengthened (see, e.g., [1]). Here we give two new applications of the improved subgroup theorem. Our first application deals with subgroups with non-trivial center of one-relator groups. Definition. A treed HNN group is an HNN group whose base is a tree product and whose associated subgroups are contained in vertices of the tree product base. Let H be a f.g. (finitely generated) subgroup with center Z (≠1) of a torsion-free one-relator group G. Then H as a free Abelian group of rank two, or H is a treed HNN group with infinite cyclic vertices and with center contained in the center of the base (see Theorem 2). Two corollaries are the following: If H is a subgroup with center Z (≠1) of a torsion-free one-relator group, then Z is infinite cyclic unless H is free Abelian of rank two or H is locally infinite cyclic. If H is a f.g. subgroup of the centralizer C of an element x in a torsion-free one-relator group and H∩gp (x)=1, then H is a free group. The first corollary was obtained independently by Mahimovski [8]. Theorem 2 generalizes Pietrowski's [12] characterization of one-relator groups having non-trivial centers. The centralizer of an element in a one-relator group with torsion is always cyclic (see Newman [11] or [4, p. 956]) B. B. Newman, Some results on one-relator groups, Bull. Amer. Math. Soc. 74 (1968), 568-571. Our second application connects the structure of a subgroup of finite index of a certain type of treed HNN group to its index. Classical examples of such a connection are given by the Schreier rank formula for free groups, the Euler characteristic for fundamental groups of orientable compact surfaces as compared with that of a j-sheeted covering space, and the Riemann-Hurwitz formula for Fuchsian groups. Each of these cases may be viewed as associating a number x(G) to each group G in the class so that if G: H=j, then x(H)=j•x(G); indeed, we take this property as the defining property of a characteristic defined on a class of groups closed under taking subgroups of f.i. (finite index). Specifically, for the free group G take x(G)=1-rank G, for the fundamental group G= [symbol] a₁, b1, a_{g}, b_{g}, Π[aᵢ, bᵢ] [symbol] let x(G)=2−2g, and for the Fuchsian group G= [symbol] c₁, • • • , cₜ, a₁, b₁, • • • , a_{g}, b_{g}; c₁^{y1}, • • • , cₜ^{yt}, c₁⁻¹[a₁, b₁] • • • [a_{g}, b_{g}] [symbol] let x(G)=2g−2+Σ(1−yi⁻¹). In all three cases if x(G)≠0, then isomorphic subgroups of f.i. must have the same index; indeed, in the first two cases x(H) determines H (up to isomorphism). In any case, knowing the index of the subgroup H determines x(H), and therefore limits the structure of H. Wall [15] introduced a “rational Euler characteristic” for finite extensions of discrete groups which admit a finite complex as classifying space. For these groups, not only does x(H)=j•x(G) when G:H=j, but also the formula x(A_{*}B)=x(A)+x(B)−1 holds. The class of groups considered by Wall includes finite extensions of f.g. free groups, and for these groups Stallings [14] generalized Wall's formula to x(A_{*}B; U)=x(A)+x(B)−|U|⁻¹ where U is a finite group (of order |U|), and A, B are finite extensions of f.g. free groups. We generalize this further to show that if G is a treed HNN group with finitely many vertices A₁, • • • , A=ᵣ each of which is a finite extension of a free group, and there are finite amalgamated subgroups U₁, • • • , Uᵣ₋₁ and finitely many pairs of finite associated subgroups L₁, M₁, • • • , Lₙ, Mₙ, then Wall's characteristic x(G) is given by (2) x(G)=x(A₁)+ • • • +x(Aᵣ)−|U₁|⁻¹− • • • −|Uᵣ₋₁|⁻¹−|M₁|⁻¹− • • • −|Mn|⁻¹ (see Theorem 3). We then extend the formula (2) using the more general notion of characteristic (indicated above) to other classes of treed HNN groups (see Theorem 4). The generalized formula applies to (Kleinian) function groups (certain discontinuous subgroups of LF (2, C)). 2. The subgroup theorem for HNN groups. Let G be as in (1). We may suppose that a set of generating symbols is chosen for K which includes a subset {mᵢ} which generates M and a corresponding subset {Iᵢ} where Iᵢ=t⁻¹m ᵢt, which generates L. A K-symbol is one of the chosen K-generators or its inverse; an M-symbol is one of the m or its inverse. Let H be a subgroup of G. In the proof of Theorem 1 below we shall show that there exists a Schreier coset representative system for G mod H of the form {Dₖ•Eₘ•Q(mᵢ)} where Q(mᵢ) is a word in M-symbols, Eₘ•Q(mᵢ) is a word in K-symbols, Dₖ does not end in a K-symbol, Dₖ•Eₘ does not end in an M-symbol, and in no representative does t follow a non-empty M-symbol. Moreover, {Dₖ} is a representative system for G mod (H, K), and {Dₖ•Em} is a representative system for G mod (H, M). Theorem 1. Let G be as in (1), let H be a subgroup of G, and let a Schreier representative system for G mod H be chosen as described above. Then H is a treed HNN group whose vertices are of the form DₖKDₖ⁻¹∩H (where Dₖ ranges over the full double coset representative system for G mod (H, K)) and whose amalgamated and associated subgroups are of the form DₖEₘKEₘ⁻¹Dₖ⁻¹∩H (where DₖEₘ ranges over the full double coset representative system for G mod (H, M)). Proof. The proof of the theorem is analogous to that of the proof of the subgroup theorem (Theorem 5) of [3], and so we merely sketch the argument. First we construct a Schreier representative system for G mod H of the type described. For this purpose define the length of an (H, K) double coset as the shortest length of any word in it. For the (H, K) coset of length 0, we choose the empty word 1 as its K-double coset representative. To obtain the Schreier representatives for the H-cosets of H in HK, we supplement the double coset representative 1 with a special Schreier system (defined after Lemma 5, page 240 of [3] for K mod K∩H with respect to M. Assume we have defined Schreier representatives (in this manner) for all cosets of H contained in a double coset of (H, K) of length less than r. Let HWK and W have length r>0. Now W ends in a t-symbol; hence W=Vt^{e}, ₑ=±1. Moreover, the Schreier representative V* of V has already been defined and has the form V*=Dₖ•Eₘ•Q(mᵢ). If ₑ=1, then DₖEₘQ(mᵢ)t=DₖEₘtQ(Iᵢ), and so HDₖEₘtK=HWK, and we choose DₖEₘt as the double coset representative of HWK. If ₑ=−1, then choose DₖEₘQ(mᵢ)t⁻¹ as the double coset representative D of HWK. In either case we supplement our chosen double coset representative D of HWK with a special Schreier representative system for K mod K∩D⁻¹HD with respect to M. We have now constructed a Schreier coset representative system for G mod H as described above. Using this Schreier system and the corresponding rewriting process, we may apply the Reidemeister-Schreier method (see [7, Section 2.3]) to obtain a presentation for H from our presentation for G. Now H has generators {S_{N·x}} and {S_{N,t}} semiprime is a Schreier representative and x is a K-generator. Moreover, {S_{N,x}}, semiprime has a fixed (H, K) double coset representative Dₖ and x ranges over the K-generators, generates the subgroup D_{K}KDₖ⁻¹∩H; {S_{N,y}}, semiprime has a fixed (H, M) double coset representative DₖEₘ and y ranges over the M-generators, generates the subgroup D_{K}EₘMEₘ⁻¹D_{K}⁻¹∩H. Moreover, if the relators of K are conjugated by those N with a fixed Dₖ, and then the rewriting process τ is applied, the resulting relators together with the trivial generators S_{N,x} provide a set of defining relators for DₖKDₖ−1∩H. The defining relators for H that arise from rewriting {t|ᵢt⁻¹ mᵢ} enable us to eliminate the generators S_{N,t} semiprime is not a double coset representative for G mod (H, M); moreover, the remaining relators take the form (3) S_{DkEm,t} ((DₖEₘt)*L(DₖEₘt)*⁻¹∩H) S_{DkEm,t}⁻¹=DₖEₘMEₘ⁻¹Dₖ⁻¹∩H. Now (3) describes an amalgamation which takes place between vertices (DₖEₘt)*K(DₖEₘt)*⁻¹∩H and (DₖEₘ)K(DₖEₘ)⁻¹∩H if S_{DkEm,t} is a trivial generator (i.e., (DₖEₘt)*≈DₖEₘt); otherwise, (3) describes a pair of associated subgroups from these same vertices. Specifically, if DₖEₘQ(mⱼ) is a representative, then S_{DkEm,t Q,t} is freely equal to τ[(DₖEₘ)*Q(mⱼ)(DₖEₘQ(mⱼ))*⁻¹]•S_{DkEm,t}•τ[(DₖEₘt)*Q(Iⱼ)(DₖEₘQ(Iⱼ)*⁻¹], and hence if Q(mⱼ)≠1, we may eliminate the generators S_{DkEm,Qt}; the remaining relators become those in (3) together with the trivial generators in {S_{DkEm,t}} The amalgamations described in (3) lead to a tree product of vertices DₖKDₖ⁻¹∩H for the following reason (see [7, Lemma 1]): Assign as level of the vertex DₖKDₖ⁻¹∩H, the number r of t-symbols in Dₖ; then the unique vertex of level less than r with which DRKDE^{I}A H has a subgroup amalgamated is the subgroup DKD−I A H where D is obtained from Dₖ by deleting the last t-symbol and then deleting any K-syllable immediately preceding that. Corollary 1. The rank of the free part of H as described in Theorem 1 is [G: (H, M)]−[G: (H, K)]+1. Proof. (DₖEₘt)*≈DₖEₘt if and only if either DₖEₘt is a Schreier representative and therefore an (H, K) double coset representative, or Eₘ=1 and Dₖ ends in t⁻¹. Thus there exists a one-one correspondence between (H, K) double coset representatives ending in t or t⁻¹ and the trivial generators in {S_{DkEm,t}} But there are G: (H, K)−1 double coset representatives for G mod (H, K) ending in t or t⁻¹; hence the assertion follows. The following corollary will be used in the proof of Theorem 4: Corollary 2. Let G be a treed HNN group with finitely many vertices, f.g. free part, and finite amalgamated and associated subgroups. Then any subgroup H of f.i. is a treed HNN group with finitely many vertices each of which is a conjugate of the intersection of H with some conjugate of a vertex of G; the amalgamated and associated subgroups are conjugates of the intersections of H with certain conjugates of the amalgamated and associated subgroups of G. Proof. The proof is by induction on the sum s of the rank of the free part of G and the number of vertices in G. If s=2, the result follows from the subgroup theorem of [3] or Theorem 1 above. Otherwise, suppose G is as in (1) where K is now a treed HNN group with smaller s than that of G. Then H is a treed HNN group whose vertices are of the form cKc⁻¹∩H=c(K∩c⁻¹Hc)c⁻¹, which by inductive hypothesis is a treed HNN group of the desired type. Now an amalgamated or associated subgroup of H has the form dMd⁻¹∩H. Thus H is an HNN group whose base is a tree product with treed HNN groups as vertices and finite amalgamated subgroups, and H itself has finite associated subgroups. It follows as in the argument for the proof of Theorem 1 of [2] that H is a treed HNN group of the asserted form. In a similar May, it follows that if G (A_{*}B; U) where B has smaller s than that of G and A is one of the original vertices of G, then H will be a treed HNN group of the desired type. 3. Subgroups with non-trivial center of one-relator groups. Theorem 2. Let G be a group with one defining relator R where R is not a true power, and let H be a f.g. subgroup of G with non-trivial center Z. Then H is free Abelian of rank two, or H is a treed HNN group with infinite cyclic vertices and Z is contained in the center of the base of H. Proof. If R has syllable length one, then G is free, H is infinite cyclic, and the result holds. Assume R has syllable length greater than one; then G can be embedded in an HNN group G₁= [symbol] t, K; rel K, tLt⁻¹=M [symbol] where K is a one-relator group whose relator is shorter than R and L, M are free (see e.g., [4]). Suppose H is not free Abelian of rank two. Now by Theorem 1, a f.g. subgroup H of Gi is a treed HNN group H= [symbol] t₁, • • • , tₙ, S; rel S, t₁Lₜ₁⁻¹=M1, • • • [symbol] where S is a tree product of finitely many vertices A₁, • • • , Aᵣ, each Aᵢ being a subgroup of a conjugate of K; the amalgamated and associated subgroups are free. If n×1, then Z is contained in S; for, H=Π*(gp(t₁, S); S). First suppose Z [symbol] S^{H}. Then n=1. Since some element in Z is not in S^{H} and H is f.g., and S/S^{H} is infinite cyclic, it follows that S^{H} is f.g. (see Murasugi [10]). Therefore S^{H}=L₁ is free and f.g. Consequently, H has the asserted form by [2, Theorem 3]. Therefore we may assume Z<S^{H}. We show, in fact, that Z<S. If n≠1, we are finished. Suppose n=1. Then S^{H} is an infinite stem product (i.e., a tree product in which each vertex has at most two edges incident with it) of vertices t₁ⁱSt₁⁻¹. If M₁≠S≠L₁, then the stem product is proper (i.e., each amalgamated subgroup is a proper subgroup of its containing vertices), and therefore Z is contained in S. If S equals L₁ or M₁, then S is free; S^{H} is an ascending union of free groups and has a non-trivial center, so that S must be infinite cyclic. If S=gp(a)=L₁, and M₁=gp(a^{q}), then H= [symbol] t₁, a; t₁at₁⁻¹=a^{q} [symbol] . Since Z∩S≠1, t₁a^{r}t₁⁻¹=a^{q r}=a^{r} for some r≠0. Hence q=1, and H would be free Abelian of rank two. Therefore Z must be contained in S. Suppose next S consists of a single vertex, S=gKg⁻¹∩H. If n=0, then H=S, is a f.g. subgroup with non-trivial center of the group gKg⁻¹; therefore by the inductive hypothesis, H has the desired form. If n>0, and some Lᵢ or Mᵢ equals S, then S is free with non-trivial center, and so must be infinite cyclic. Thus again H has the asserted form with base S. We may therefore assume that S^{H} is a proper tree product of the vertices tᵢ^{j}Stᵢ^{-j}, and so Z<Lᵢ∩Mi. Since Lᵢ, Mᵢ are free, Z, Lᵢ, Mᵢ must each be infinite cyclic. Therefore S is a f.g. subgroup of gKg⁻¹ and the inductive hypothesis applies to S. Since Z is infinite cyclic, it follows that S is a treed HNN group with infinite cyclic vertices each of which contains Z, and each of the associated subgroups contains Z. Therefore S/Z is a treed HNN group with finite cyclic vertices; moreover, Lᵢ/Z goes into Mᵢ/Z under conjugation by tᵢ. Hence H/Z is an HNN group with finite cyclic vertices, and the associated subgroups of H/Z are finite. Therefore H/Z is a treed HNN group with finite cyclic vertices, and so by the proof of [2, Theorem 3] H has the asserted form. Finally, suppose S does not consist of a single vertex. Then S is a proper tree product and Z is contained in the amalgamated subgroups of S; these are free and therefore infinite cyclic. Moreover, since Z<Lᵢ∩Mᵢ, we have that Lᵢ, Mᵢ are infinite cyclic. Hence each of the vertices Aⱼ of S is f.g. and the inductive hypothesis applies to each Aⱼ. Hence Aⱼ/Z is a treed HNN group with finite cyclic vertices, and the amalgamated and associated subgroups when reduced mod Z yield finite cyclic groups. Thus H/Z is an HNN group whose base is a tree product of treed HNN groups with finite cyclic vertices; the amalgamated and associated subgroups are finite cyclic groups. Hence H/Z is a treed HNN group with finite cyclic vertices, and consequently H has the asserted form (again by the proof of [2, Theorem 3). Corollary 1. Let H be a subgroup with non-trivial center Z of a torsion-free one-relator group G, H not free Abelian of rank two and not locally infinite cyclic. Then Z is infinite cyclic. Proof. If H is f.g., then Z is infinite cyclic because Z is in the center of the tree product base of H, which has infinite cyclic vertices. Suppose H is infinitely generated. Then H is the ascending union of countably many f.g. subgroups H i each containing a f.g. subgroup Zᵢ of Z such that Z is the ascending union of the Zᵢ. Now by Moldavanski [9] or Newman 11], no Abelian subgroup of G can be a proper ascending union of free Abelian groups of rank two. Hence only finitely many Hᵢ can be free Abelian of rank two. Thus Zᵢ must be infinite cyclic, and so Z is infinite cyclic if Z is f.g. Suppose Z is infinitely generated. Then H/Z is periodic. For otherwise, for some element h of H, gp(h, Zᵢ) is free Abelian of rank two, and gp(h, Z)=∪gp(h, Zᵢ) which is impossible. Hence, if Cᵢ is the center of Hᵢ, then Hᵢ/Cᵢ is on the one hand periodic, and on the other hand a treed HNN group with finite cyclic vertices. Therefore, Hᵢ/Cᵢ is finite, and so Hᵢ is infinite cyclic. Consequently, H is locally infinite cyclic. Corollary 2. If H is a f.g. subgroup of the centralizer C of an element x in a torsion-free one-relator group and H∩gp(x)=1, then H is a free group. Proof. Let H₁=gp(H, x), which is the direct product H X gp(x). If H₁ is free Abelian of rank two, then clearly H is infinite cyclic. If H₁ is not free Abelian of rank two, then the center Z of H₁ is infinite cyclic and therefore equals gp(x). Now since H₁ is a treed HNN group with finitely many cyclic vertices each of which contains Z and each of whose associated subgroups contains Z, it follows that H₁/Z is a treed HNN group with finite cyclic vertices, which is isomorphic to H. Since H is torsion-free, H must be free. 4. Characteristics of groups. Lemma 1. Suppose G is as in (1) and R is a subgroup of K such that R has trivial intersection with the conjugates of L and M in K. Let {aᵢ} be a common double coset representative system for K mod (R, M) and K mod (R, L). Then the subgroup H=R*Πⱼ*gp (aⱼtaⱼ⁻¹) is of index [K: (R, M)]•|M|. In Particular, if K:R and |M| are both finite, then a common double coset representative {aᵢ} exists and H is of finite index in G; if R is free (or torsion-free), then so is H. Proof. We show H is a subgroup of the asserted form and index by constructing H using an appropriate Schreier representative system and a corresponding right coset function. For this purpose choose a set of generating symbols for K which is the union of the following three subsets: the symbols {aᵢ}, the symbols {r_{q}} where r_{q} ranges over the elements of R, and the symbols {mⱼ} where m; ranges over the elements of M; the empty symbol 1 is included among the symbols {aᵢ} as well as {mⱼ}. We use the symbols Iⱼ to denote t⁻¹mⱼt. As Schreier representatives take the words {aᵢmⱼ}. A corresponding right coset function is determined by the following assignments:=(aᵢmⱼk)*=aᵤmᵥ where aᵢmⱼk=r_{q}aᵤmᵥ, for k any K-symbol; (aᵢmⱼt)*=aᵤmᵥ where aᵢIⱼ; =r_{q}aᵤmᵥ; and (aᵢmⱼt⁻¹)*=aᵤmᵥ where aᵢmⱼ=r_{q}aᵤlᵥ. It is not difficult to show that these assignments define a permutation representation of G acting on the chosen representatives {aᵢmⱼ}, and hence determine a subgroup H of elements of G which leave the representative 1 fixed. Clearly, H∩K=R; for, the first of the three representative assignments holds when k is any element of K, and so if (k)*=aᵤmᵥ=1 then k=r_{q}. This enables us to show that the Schreier system {aᵢmⱼ} has the required properties to apply Theorem 1. In particular, 1 is the HK double coset representative, and {aᵢ} is a set of representatives for G mod (H, M). Therefore H is a treed HNN group with a single vertex K∩H=R, the amalgamated and associated subgroups are aᵢMaᵢ⁻¹∩H=aᵢMaᵢ⁻¹∩R=1; and its free part is generated by s_{ai,t}=aᵢt(aᵢt)*⁻¹=aᵢtaᵢ⁻¹ Let G contain a free subgroup F of rank r and finite index j. Then Wall's rational Euler characteristic x(G) (mentioned in the introduction) is given by x(G)=(1−r)/j (this is obtained using Wall's formulas quoted and that the Euler characteristic of an infinite cyclic group is 0). In particular, if G is finite, then x(G)=|G|⁻¹. Lemma 2. Let G be as in (1). Suppose that K contains a free subgroup R of finite index, and that M is finite. Then the Wall characteristic of G is given by x(G)=x(K)−x(M)=x(K)−|M|⁻¹. Proof. Applying Lemma 1, we see that H of that Lemma is free and of finite index in G. Moreover, x(G)=(1−rank H)/[K: (R, M)]•|M|, and rank H=rank R+[K: (R, M)]. Therefore x(G)={1−rank R+[K: (R, M)])}/[K: (R, M)]•|M|=(1−rank R)/[K:R]−|M|⁻¹=x(G)−x(M). Theorem 3. If G is a treed HNN group with vertices A₁, • • • , Aᵣ each of which is a finite extension of a free group, finite amalgamated subgroups U₁, • • • , Uᵣ₋₁, and pairs of finite associated subgroups L₁, M₁, • • • , Lₙ, Mₙ, then Wall's characteristic x(G) is given by (4) x(G)=x(A₁)=+ • • • +x(Aᵣ)−|U∥⁻¹− • • • |Uᵣ₋₁|⁻¹−|M₁|⁻¹− • • • −|Mₙ|⁻¹. Proof. The proof of (4) is clearly obtained by using Lemma 2, and Stalling's formula quoted in the introduction. We generalize Wall's characteristic as follows: Definition. Let C be a class of groups closed under taking subgroups of f.i. Then a characteristic x defined on C is a real-valued function defined on C such that if G is in C and G:H=j, then x(H)=j•x(G). In addition to the illustrations of characteristics mentioned in the introduction we give the following: 1. Let C₁ be a class of groups with a characteristic x₁ defined on it. Let C be the class of all groups which contain a subgroup of f.i. which lies in C₁. If G is in C, and G:C=p where C is in C₁, define x(G)=x₁(C)/p. Clearly if G:D=q where D is in C₁, and C/C∩D=c, D/C∩D=d, then x₁(C)/p=x₁(C∩D)/cp=x₁ (C∩D)/dq=x₁(D)/q, so that x(G) is well-defined. Moreover, if G:H=j, and H:E=r where E is in C₁, then x(H)=x₁(E)/r=j•xᵢ(E)/jr=j•x(G). 2. Let C be the class of subgroups of f.i. of a fixed group G. Then a necessary and sufficient condition for a non-zero characteristic to be definable on C is that isomorphic subgroups of f.i. in G have the same index in G. Indeed, if H₁≃H₂, G:H₁=j₁, G:H₂=j₂, and x(G)≠0, then x(H₁)=j₁•x(G)=x(H₂)=j₂•x(G), so that j₁=j₂. Conversely, define x(G)=1, x(H)=j when G:H=j; then x(G) is a well-defined characteristic. Our last example of a characteristic makes use of Theorem 1 and the subgroup theorem of [3]. Theorem 4. Suppose C₁ is a class of f.g. groups with a characteristic x₁ defined on and such that each group in C₁ contains a torsion-free non-cyclic indecomposable (with respect to free product) subgroup of finite index. Let C be the class of treed HNN groups with f.g. free part, finitely many vertices each in C₁, and finite amalgamated and associated subgroups. Suppose G is in C, and has a presentation as a treed HNN group with vertices A₁, • • • , Aᵣ in C₁, amalgamated subgroups U₁, • • • , Uᵣ₋₁, and pairs of associated subgroups L₁, M₁, • • • , Lₙ, Mₙ. If we set x(G)=x(A₁)+ • • • +x(Aᵣ)−|U|⁻− • • • −|Uᵣ₋₁|⁻¹−|M₁|⁻¹− • • • −|Mₙ|⁻¹. Then x defines a characteristic on the class C. Proof. We first observe that the class (C is closed under forming treed HNN groups with vertices from C, using finite amalgamated and associated subgroups (for an argument, see the proof of Theorem 1 of [2]). Next We note (see [3]) that a subgroup H of (A B; U) is a treed HNN group with vertices cAc⁻¹∩H, dBd⁻¹∩H where c, d range over double coset representative systems for G mod (H, A) and G mod (H, B), respectively; moreover, the amalgamated and associated subgroups are of the form eUe⁻¹∩H where e ranges over a double coset representative system for G mod (H, U). It follows from Corollary 2 of Theorem 1 that C is closed under taking subgroups of f.i. We now show that if G:H=j, then for each presentation of G as a treed HNN group in C, H has a presentation as a treed HNN group in C for which x(H)=j•x(G). Indeed, suppose that this assertion holds for A, B in C, and consider G=(A_{*}B; U), U finite. Now cAc⁻¹: cAc⁻¹∩H=j_{c} is the number of H cosets in HcA. Hence cAc⁻¹∩H has a treed HNN presentation in C such that x(cAc⁻¹∩H)=j_{c}•x(cAc⁻¹)=j_{c}•x (A). Similarly, if j_{d}=dBd⁻¹: dBd⁻¹∩H, and jₑ eUe⁻¹∩H, then x(H)=Σ_{c} j_{c}•x(A)+Σ_{D jd}•x(B)−Σ_{e je}•|U|⁻¹=j[x(A)+x(B)−|U|⁻¹]=j•x(G). Similarly, if the assertion of the preceding paragraph holds for K in C, and G is as in (1) with M finite, and G:H=j, then H is a treed HNN group with vertices fKf⁻¹∩H where f ranges over a representative system for G mod (H, K); moreover the amalgamated and associated subgroups are of the form gMg⁻¹ H where g ranges over a coset representative system for G mod (H, M). If j_{f}=fKf⁻¹: fKf⁻¹∩H, and j_{g}=gMg⁻¹: gMg⁻¹∩H, then x(H)=Σ_{f} j_{f}•x(K)−Σ_{g jg}•|M|⁻¹=j•[x(K)−|M|⁻¹]=j•x(G). Finally, we show that x is well-defined on the class C. Clearly, the only ambiguity in the definition of x(G) is that G may be presentable in several ways as a treed HNN group in C. Now an element G, of cannot be written in a non-trivial way as a treed HNN group with finite amalgamated and associated subgroups; for otherwise, G₁ would have two or infinitely many ends (see Stallings [13]), so that any torsion free subgroup of finite index would have two or infinitely many ends and would therefore be infinite cyclic or a proper free product (see Stallings [13]), contrary to hypothesis. Hence x is well-defined on the elements of C₁. Consider any torsion-free group T in C. Now T has a unique representation as a treed HNN group in C, namely, as a free product of a free group and groups from C₁. Using the uniqueness of representation of a f.g. group as a free product of indecomposable groups, it follows that x(T) is well-defined. Lastly, a group G in has a torsion free subgroup T of f.i., say p (by Stallings [14] and Lemma 1 above), and so x(G)=x(T)/p, so that x(G) is well-defined. Corollary. Let G be as described in Theorem 4, and G:H=j. Suppose that H has a Presentation as a treed HNN group with vertices B₁, • • • , Bₛ, amalgamated subgroups V₁, • • • , Vₛ₋₁, and pairs of associated subgroups P₁, Q₁, • • • , Pₘ, Qₘ. Then X₁(B₁)+ • • • +x₁(Bₛ)=j+x₁(A₁)+ • • • +x₁(Aᵣ)), and |V₁|⁻¹+ • • • +|Vₛ₋₁|⁻¹+|Q₁|⁻¹+ • • • +|Q₁|⁻¹=j(|U₁|⁻¹+ • • • +|Uᵣ₋₁|⁻¹+|M₁|⁻¹+ • • • +|Mₙ|⁻¹). Proof. Since x₁ can be replaced by x₂=2x₁ and the assertion of Theorem 4 will still hold, the result follows. As an illustration of Theorem 4, let C₁ be the class of Fuchsian groups described in the introduction, and let be the characteristic mentioned there. Then it is well-known that each group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0”. The resulting class (C includes Kleinian function groups (see [6]). Can. J. Math., Vol. xxvl, No. I, 1974, pp. 214-224. An Improved Subgroup Theorem For HNN Groups ‘with Some Applications’ by A. Karrass, A. Pietrowski, And D. Solitar. The map which assigns to every vector space its dual space and to every linear map its dual or transpose is a contravariant functor from the category of all vector spaces over a fixed field to itself. The fundamental group we consider the category of pointed topological spaces, i.e. topological spaces with distinguished points. The objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted πᵢ(X, x₀). This is the group of homotopy classes of loops based at x₀. If f:X→Y is a morphism of pointed spaces, then every loop in X with base point x₀ can be composed with f to yield a loop in Y with base point y₀. This operation is compatible with the homotopy equivalence relation and the composition of loops, and we get a group homomorphism from n(X, x₀) to π(Y, y₀). The results for the transverse and vertical size of the cloud of atoms, as well as for the kinetic and potential energy per particle, are compared with the predictions of approximated models. We also compare the aspect ratio of the velocity distribution using worm algorithms simulate spaces of our system of equations the number of terms Abelian group Γ under addition n order of harmonic n-isotypic ratio of harmonic to fundamental the magnitudes signals (sources) with y gyromagnetic ratio are several critical exponents, thermodynamic magnetic the spherical model with long range, inverse power law interactions, leads to relations between these exponents since it expresses them in terms of two underlying exponents a and T. The exponent a is directly related to the effective surface free energy of our sub-plasma system and thence to the dimensionality of our subspace critical point exponents including the thermal exponent y [symbol] , magnetic exponent yh, and loop exponent yl. We thus obtain a functor from the category of pointed topological spaces to the category of groups, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁ (α₁∧β) c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧eⱼ₁∧ . . . ∧e_{jq}, when the indices i₁, . . . , iₚ, j₁, . . . , j_{q}, are distinct, and the product is zero otherwise. While the formula α∧α=0 holds when a has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+A e₂∧e₃∧e₄+e₃∧e₄∧e₁∧e₂+0 =2 e₁∧e₂∧e₃∧e₄. If α₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=B₀^{→} and B^{→}ₑ semigroup, a semidirect product given a Lie group G is, in a trivial way, a groupoid with G m={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F⁻)≥1−ε/2. Now express each set A∈V^{m-1}₀ T⁻ⁱ P/F⁻ as A₁∪A₂, A₁∩A₂=ϕ, μ(A₁)=μ(A₂), and put (m/2)−1 (m/2)−1 FA=[T2iA1∪[T2i−1A2 i=0 i=1. Clearly, F_{A} and TF_{A} are disjoint. We now let F be the union of the sets F_{A}, A∈V^{m-1}₀ T⁻ⁱ P/F⁻. It follows that F∩TF=ϕ, and that F∪TF is all of ∪^{m-1}ᵢ₌₀ Tⁱ F⁻, TⁱF⁻, 0≤i≤m−1. Thus if m is large enough, μ(F∪TF) will be at least 1−ε. This establishes that d(P/F)=d(P/F∪TF). Shifts and partitions of a Bernoulli shift we begin with n=(p₁, p2, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g},ϕ:π₁(F_{g},★)→G) the skew-Hermitian R-module (H^{ϕ}₁(F_{g},★), [symbol] ⋅,⋅ [symbol] ₛ) where ★∈∂F_{g} and: [symbol] ⋅,⋅ [symbol] ₛ: H^{ϕ}₁(F_{g},★)×H^{ϕ}₁(F_{g},∈)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}:F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor“, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g,ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A·s where the ‘mixing matrix’ for all x∈s where the constants C and λj have to be determined so that the integral of p(x) over s is 1 and the above conditions for the expected. values are satisfied. The same map Indₐ arises naturally from a geometric construction, that of the tangent groupoid of the manifold M. This groupoid encodes the deformation of T^{*}M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure A. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K^{*}_{,τ}(BG) is the K-theory group K^{*+1}(V). The projection p:V→V/F is naturally K-oriented and the following maps from K^{*}(V) to K(C^{*}(V,F)) coincide: 1) p! (cf. Theorem) which, up to the Thom isomorphism, K^{*}(F)˜K^{*+1}(V) is equal by Lemma 7 to Indₐ=Indₜ. 2) The Thom isomorphism (Appendix C) ϕ:K^{*}(V)=K(C(V))→K(C(V)oR)=K(C^{*}(V,F)) where we used an arbitrary flow defining the foliation. In particular, by Appendix C, ϕ is an isomorphism and so are the map p! and the index Indₐ:K ^{*}(F)→K(C^{*}(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K^{*}(V) onto K(C^{*}(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H^{*}(A) H^{*}_{τ}(BG). In fact, we shall only describe the composition of this map with the pull-back H^{*}_{τ}(BG)→H^{*}_{τ}(V). When one varies V without varying V/F one gets the desired information. The idea of the construction of (3.39) λᵥ:H^{*}(A)→H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12)“. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group F is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, go)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′ X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G x, x=r( [symbol] ), infinite connected manifolds the Θ^{j}(K) commute pairwise (S₀, g₀) and (S₁, g₁), where S, are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r(z,1456 ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G,−1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n x for the function of transport properties generating a series interval A step path in S is a path y:[A, b]→S together with a subdivision a=τ₀<τ₁<τ₂<∧<τₙ=b of [A, b] such that in each subinterval [τ^{j-1}, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∈[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪ᵢ≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H^{*}(A)→H^{*}_{τ}(BG). In fact, we shall only describe the composition of this map with the pull-back H^{*}_{τ}(BG)→H^{*}_{τ}(V). When one varies V without varying V/F one gets the desired information. The idea of the construction of (3.39) λᵥ:H^{*}(A)→H^{*}_{τ}(V) is to exploit the local triviality of the foliation as follows: For each open set U⊂V one lets A(U) be the algebra associated by the functor C_{c}^{∞}(⋅,Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ⊂U where δ is the Cech coboundary.\check{ } Moreover, there is an obvious forgetful map ϕ from the periodic cyclic cohomology H^{*}(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G,Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group f” is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕk=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{\hat{ }}f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁) The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S=₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on Si, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r(z,1464 ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations X₀ G^{x}, x=r( [symbol] ) and X₁G^{x}, x=r(z,1464 ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r(y), as two easy examples of this construction one can take. α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G,Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<T i<τ₂<∧<τₙ=b of let y:uniform on [A, b]→C be a path we find the natural base of the plane points an optimal value of (P) and (D) calculated in the shape object plane with Hilbert Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by (I ) are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C^{*}(V,F))) is equal to {hCh(E),[C]i;[E]∈K^{*}(V)}. Here Ch is the usual Chern character, mapping K^{*}(V) to H^{*}(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type II₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and >Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and >Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, £ a positive number, and P a partition, then there is a set F such that F, TF, . . . , Tⁿ⁻¹F is a disjoint sequence, p(∪ⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let _{L}i be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group r is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K ^{*}(F)→K(C^{*}(V,F)) we shall construct higher-dimensional generalizations of the above maps dim∧: K(C^{*}(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2} . . . of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution n and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x (s(x),t(x)) is easily seen to be 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto (after removing a set from X of μ-measure zero). We consider Tian 13 gave the maximal and minimal ranks of two real matrices X₀ and X1 in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B^{*}B representations. We continue with The Real and Complex Hermitian Solutions to a System of Quaternion Matrix Equations with Applications by Shao-Wen Yu (we refer to) B^{*}B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution n and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K^{*}(F)→K(C^{*}(V,F)) we shall construct higher-dimensional generalizations of the above maps dim∧: K(C^{*}(V,F))R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H) g I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shoo-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε^{|} in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C* algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts); and {2} Two columns of equal width {the Bernoulli shifts the Acyclicity of the Koszul complex two Bernoulli shifts):=four {4×4 columns) the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by Tₙ up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C* algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Up to a shift of parity, the geometric group K*_{,τ}(BG) is the K-theory group K*⁺¹(V). The projection p:V→V/F is naturally K-oriented and the following maps from K*(V) to K(C*(V,F)) coincide: 1) p!(cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ·([114]) (3.38) λ:H*(A)→H_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a·b)( [symbol] )=∫ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1=⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] |Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }Gϕₖ=gₖPF\hat{ }ϕk=gₖ(PF)ₖϕk (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θⁱ(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z)∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* .(itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ*([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ; H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (τ^{(n,m)}>,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group E is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=τₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ: S,→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, X=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z)∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4,1, 4, 1, 3, 0, . . . ] the minimal carrier of τ consists of simplexes all of which have X, as a vertex of load, or signal by the rule (χ*(ⁿ mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 11]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 11], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim∧ : preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=f. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse A of the map ϕ*([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)kϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂x{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where S, are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)=(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate 2-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ*([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀ IT U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group f is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z)∀x,y,z∈M. The convolution algebra is then the algebra of smoothing kernels on the manifold M. 3) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3 [symbol] +1/10(0+) . . . )))))))) or in the shorthand notation [0; 0, 1, 0, 1, 4, 1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re( [symbol] ) or im( [symbol] ) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim∧ (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π} {1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re( [symbol] ) or im( [symbol] ) is constant τ₀<τ₁<τ₂<∧<T_{π} =b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2 =2Ef(X̅T h/2)−Ef(X̅T h) where X̅Th/2 and X̅Th are the Euler approximation at time T for the step size h/2 and h respectively D 4==• . . . =^{D}_{2N-2 =0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(1)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of ∪ called the n-isotypic component of ∪; or the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of ∪ we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10 ⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steen rod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p >2 then D₂ₖ(U×v)=(−1)^{p}(^{p-1})^{rs/2} Σ^{k}ⱼ₌₀ D₂ⱼ U x D₂ₖ₋₂ⱼ v. If p=2, Dₖ(U×v)=Σ^{k}ⱼ₌₀ DⱼU×Dₖ₋ⱼv. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, di by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)} Wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼwᵢ x Dⱼu×Dₗv. Also d* P(Uxv)=Σₖwₖx Dₖ (Uxv). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀ 1/n!xⁿ=1+x+1/2x²+1/6x³+1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−1/2(x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ } , that obeys the following rules: PF\hat{ } ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{,n,m} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Affine function; and second fundamental form constants determined by the initial conditions representations we refer to survey of numerical solution of stochastic differential equations of P. E. Kloeden and E. Platen. High-order methods for strong sample path approximations and for weak functional approximations. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system of X is far from being trivial our longitudinal integral of the trivial bundle does vanish, i.e. the K-theory index of the longitudinal Dirac operator is equal to 0. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/E InnR, are pairwise conjugate. The simplest realization of the symmetry s¹₂ consists in taking the automorphism of R⊗R that transforms x⊗y into y⊗x for all x, y∈R. For μ₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote p(E). Now, let A be arbitrary, and let α be the homomorphism a: J^{˜}→A, α(a,λ)=a+λ1 ∀a ∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ-1 1−QD Q]. Thus, with S₀=1−QD, S₁=1−DQ one gets e=[1-S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pt. One can then use the local construction of a parametrix for families of elliptic operators and patch the resulting operators by using a partition of unity in V subordinate to a covering (Uⱼ) by domains of foliation charts. What one obtains is an inverse Q. for D modulo the algebra C_{c}^{∞} (G, Ω^{1/2})=J of the foliation. To be more precise let us fix for convenience a smooth nonvanishing 1-density along the leaves and drop the Ω's from the notation. Then to D corresponds a distribution section D∈C_{c} ^{∞} (G, s*(E*₁)⊗r*(E₂)) with support on G⁽⁰⁾. To the quasi-inverse Q of D corresponds a section Q∈C_{c}^{∞} (G, s*(E*₂)⊗r*(E₁)). The quasi-inverse property is then the following QD−1_{E1}∈C_{c}^{∞}(G, s*(E*₁)⊗r*(E₁)) DQ−1E₂∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T·f∈C_{c}^{∞}(G) and f·T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ ∀(a,λ)∈J. ^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j·E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h Θ⊗h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)·E,id) is a quasi-isomorphism, which we denote p(E). Now, let A be arbitrary, and let α be the homomorphism α: J^{˜}→A, α(a,λ)=a+λ1 ∀a∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1-DQ one gets e=[1−S²₁ (S₁+S²₁)∈S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules E, over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S¹ be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C(V)⊂A of multiplication operators on V, as longitudinal differential operators of order 0 allows us to induce the vector bundles Eᵢ to finite projective modules E, over A. As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let {V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥}of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V ×Rⁿ given by ϕ(x,ξ)=(x,i(x)+ξ)∀×∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{εl}K(C*(V⁰,F⁰))˜K(C*(V,F)) Through the Bott periodicity isomorphism since C*(V⁰,F⁰)=SⁿC*(V,F)=C*(V,F)(g)C₀(Rⁿ) The proof easily follows from Theorem 8.3 and the following analogue of Lemma 5.6: Lemma 7. With the notation of Theorem 6, let x=(F,σ(D),p∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧} : K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K*,_{T}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where F is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧} : K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧}(K(C*(V,F))) is equal to {hCh(E),[C]i;[E]∈K*(V)}. FI ere Ch is the usual Chern character, mapping K*(V) to H*(V,Q), and [C] is the Ruelle-Sullivan cycle of Chapter I. Corollary 9. Let V be a compact smooth manifold, and let be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧} : K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Periodic the properties S is a Koszul algebra, if k=S/ₙ has 0-linear resolution over S. The standard graded polynomial ring k[x₁, . . . , xₙ] (semiprime ≥1) is a Koszul algebra: k is resolved by the Koszul complex. Which is a linear resolution a period are the vectors wᵥ of all periods, the vectors wᵥ of all periods. Complex functions to those defined we operate on open connected sets, and a compact subset of an open set in the complex plane, in the complex space C^{p}, p ≥1, p coordinates of the upper limits ^{x}1, . . . , ^{x}p, a system of sums lower integration limits ^{c}1, . . . , ^{c}p which are poles of the function in the complex space C^{p}, f(z)f(z), z=(^{z}1, . . . , ^{z}n)z=(^{z}1, . . . , ^{z}n), in the complex space CnCn, n>1n>1, a function f (z) in the variables ^{z}1, . . . , ^{z}p, ^{z=z}1, . . . , ^{z}p, is called an Abelian function if there exist ²p row vectors in C^{p}, wᵥ=(w1ᵥ, . . . , wₚᵥ), v=1, . . . , 2p, which are linearly independent over the field of real numbers and are such that f(z+wᵥ)=f(z) for all [symbol] ϵC^{p}, v=1, . . . , 2p periodic. (We refer to) “Acyclicity of the Koszul complex. By definition the Koszul complex associated to the operad Trias is the differential functor Tridend∘Trias from Vect to Vect. We will show that it is quasiisomorphic to the identity functor, equivalently we have the 4.1 Theorem. The homology of the free associative trialgebra on V is HnTrias(Trias(V))=nV if n=1, 0 otherwise. Homology of associative trialgebras. Ginzburg and Kapranov's theory of algebraic operads shows that there is a well-defined chain complex for any algebra A over the binary quadratic operad P, constructed out of the dual operad P^{!} as follows. The chain complex of the P-algebra A is C^{p}ₙ(A)=P^{!}(n)⊗_{Sn} A^{⊗n} in dimension n and the differential d agrees, in low dimension, with the P-algebra structure of A [symbol] _{A}(2): P(2)⊗A^{⊗2}→A under the identification P^{!}(2)*≅P(2). In fact d is characterized by this condition plus the fact that on the cofree P^{!}−coalgebra C*^{p}(A)=P^{!}*(A) it is a graded coderivation. 3.4 Proposition. The chain complex of an associative trialgebra A is given by Cₙ^{Trias} (A)=K[Tₙ]⊗A^{⊗n}, d=Σ¹⁼ⁿ⁻¹ᵢ₌₁(−1)ⁱdᵢ, where dᵢ(t;a₁, . . . , aₙ)=(dᵢ(t);a₁, . . . , aᵢ ∘^{t}ᵢ aᵢ₊₁, . . . aₙ), and dᵢ(t) is the tree obtained from t by deleting the ith leaf and where ∘^{t}ᵢ is given by ∘^{t}ᵢ {├ if the ith leaf of t is left oriented, ┤ if the ith leaf of t is right oriented, ⊥ if the ith leaf of t is a middle leaf. Observe that at a given vertex of a tree there is only one left leaf, one right leaf, but there may be none or several middle leaves. Proof. First observe that this is a chain complex since the operators di satisfy the presimplicial relations dᵢdⱼ=dⱼ₋₁dᵢ for i<j. Indeed, this relation is either immediate (when i and j are far apart), or it is a consequence of the axioms of associative trialgebras when j=i+1. It suffices to check the case n=3, and this was done in 1.3. By Theorems 3.1 and 2.6 Ginzburg and Kapranov theory gives, as expected, Cₙ^{Trias} (A)=K[Tₙ]⊗A^{⊗n}. It is clear from 1.3 that d agrees with the Trias-algebra structure of A in low dimension. Since d is completely explicit, the coderivation property is immediate to check. 3.5 Proposition. The chain complex of a dendriform trialgebra A is given by Cₙ^{Tridend}(A)=K[Pn]⊗A⊗n, d=Σⁱ⁼ⁿ⁻¹ᵢ₌₁ X (−1)ⁱdᵢ, where dᵢ(X; a₁, . . . , aₙ)=(dᵢ(X); a₁, . . . , aᵢ ∘^{x}ᵢ aᵢ₊₁, . . . aₙ), and dᵢ(X) is the image of X under the map dᵢ:[n]→[n−1] given by dᵢ (r_)={r−1 if i≤r, r if i≥r+1. and where ∘^{x}ᵢ is given by ∘^{x}ᵢ={if i −1∈X and i∈X, [symbol] if i −1 ∉X and i∈X, [symbol] if i −1∈X and i∉X, * if i −1 ∉X and i∈X. Proof. Again, observe that this is a chain complex since the operators dᵢ satisfy the presimplicial relations dᵢdⱼ=dⱼ₋₁dᵢ for i<j. Indeed, this relation is either immediate (when i and j are far apart), or it is a consequence of the axioms of dendriform trialgebras when j=i+1. It suffices to check the case n =3. We actually do the computation in one particular case, the others are similar: d₁d₂({0,2},a₁,a₂,a₃)=d₁({0,1};a₁,a₂ [symbol] a₃)=({0};a₁˜(a₂ [symbol] a₃)), d₁d₁({0,2},a₁,a₂,a₃)=dᵢ({0,1};a₁>a₂,a₃)=({0};(a₁ [symbol] a₂)·a₃), These two elements are equal by the fifth relation in 2.1. Acyclicity of the Koszul complex. By definition the Koszul complex associated to the operad Trias is the differential functor Tridend ∘ Trias from Vect to Vect. We will show that it is quasi-isomorphic to the identity functor. Equivalently we have the Theorem. The homology of the free associative trialgebra on V is HnTrias(Trias(V))=nV if n=1, 0 otherwise. 4.1 Corollary. The operads Trias and Tridend are Koszul operads. 4.2 Corollary. The homology of the free dendriform trialgebra on V is: HnTridend(Tridend(V))=nV if n=1, 0 otherwise. 4.3 Corollary. Let f^{K}ₜ(x) be the generating series of the Stasheff polytope (i.e. of the planar trees), as defined in 1.12. Then one has f^{K}ₜ(x)=−(1+(2+t)x)+√1+2(2+t)x+t²x²/2(1+t)x. Proof of the Corollaries. By Ginzburg and Kapranov theory [G-K] the first two Corollaries follow from the vanishing of the homology of the free associative trialgebra. The last Corollary follows from the functional equation relating the two operads and the computation of the generating series for the associative trialgebra operad (cf. 1.12). Proof of Theorem 4.1. The acyclicity of the augmented complex C*^{Trias}(Trias(V)) is proved in several steps as follows. 1. We show that it is sufficient to treat the case V=K. 2. The chain complex C*^{Trias}(Trias(K)) splits into the direct sum of chain complexes C*(u), one for each element u in P_{m,m}≥1. 3. The chain complex C*(u) is shown to be the cell complex of a simplicial set X(u). 4. The space X(u) is shown to be the join of spaces X(v) for certain particular elements v in Pₘ. 5. Therefore one has L First step. We note from 1.8 that Trias(V)=_{n≥1}K[Pₙ]⊗V^{⊗n}. Cⱼ^{Trias}(Trias(V))=K[Tⱼ]⊗(⊗_{n≥1} K[Pₙ]⊗V^{⊗n})^{⊗j}=K[Tⱼ] ⊗⊗_{m≥1} (⊗ₙ₁₊ [symbol] ₊ₙⱼ₌ₘK[Pₙ₁ x . . . x Pₙⱼ])⊗V^{⊗m}. Since d is homogeneous in V, the complex C*^{Trias} splits into the direct sum of subcomplexes, one for each m≥1. This subcomplex is in fact of finite length and, up to tensoring by V^{⊗m}, is of the following form: C*(Pₘ): 0→K[Tₘx P₁x . . . x p₁]→ . . . →Mj K[Tⱼ×Pₙ₁x . . . x Pₙⱼ]→ . . . →K[T₁×Pₘ], n1+ [symbol] +n =m we may recall that P₁ and T₁ have only one element. The case m=1 gives the subcomplex of length 0 reduced to V. This shows that H₁^{Trias}(Trias(V)) contains V as expected. For m≥2, the differential is simply the differential of C*(Pₘ) tensored by the identity of V^{⊗m}, hence it is sufficient to prove the acyclicity of C*(Pₘ) to prove the theorem. Second step. The chain complex C*(Pₘ) can still be split into the direct sum of smaller complexes indexed by the elements u of Pₘ. Indeed, let α:=(t;u₁, . . . , uⱼ)∈Tⱼ x pₙ₁ x . . . x pₙⱼ be a basis element. Under @@ applying j−1 face operators successively to α, we get an element (^{@@};u)∈T₁×Pₘ which does not depend on the choice of the face operators because of the simplicial relations (cf. 3.4). Considering t as an operation on m variables for associative trialgebras, u is nothing but the result of the evaluation of t on (x, . . . , x), cf. 1.3. Fixing u, let C*(u) be the chain @@ subcomplex linearly generated by the elements a whose image is (^{@@};u) ∈T₁×Pₘ. It is clear that C*(Pₘ) is the direct sum of the chain complexes C*(u),u∈Pₘ. Observe that C*(u) is of simplicial type, that is, its boundary is of the form d=−Σⁱ⁼ⁿ⁻¹ᵢ₌₁(−1)ⁱdᵢ. Third step. We fix u ∈Pₘ. At this point it is helpful to modify slightly our indexing of the faces and have them to run from 0 to n−2 rather than from 1 to n−1. We also shift the indexing of the complex C*(u) by 1, putting K[T₁ x Pₘ] in dimension −1. For any generator α of C*(u) the faces dᵢ(α),0≤i≤n−2, are still generators of C*(u). Hence C*(u) is the normalized augmented complex of an augmented simplicial set that we denote by X(u). The nondegenerate simplices of X(u) are the linear generators α of C*(u). The top dimensional ones are of the form (t;x, . . . , x) ∈X(u)ₘ₋₂ where t=t₀ V . . . V tₖ∈T_{q}. The integer k is the number of decorations (Cech signs) appearing in u. We denote by T_{{u}} this subset of Tₘ. At the other end the augmentation set is X(u)₋₁=T₁×{u} (one element). The geometric realization of X(u) is the amalgamation of simplices Δ^{m-2} (one for each t∈T_{{u}}) under the following rule: if dᵢₖ . . . dᵢ₁(t;x, . . . , x)=dᵢₖ . . . dᵢ₁(t′;x, . . . , x) for some m−2≥iₖ≥ . . . ≥i₁≥0, then we identify the corresponding (oriented) faces of the simplices t and t′. Observe that under this rule a vertex of type i is identified only with a vertex of type i. Fourth step. We may recall the join construction of augmented simplicial sets (cf. for instance [E−P]). An augmented simplicial set is a simplicial set X. together with a set X₋₁ and a map d₀: X₀→x₋₁ satisfying d₁d₀=d₀d₀. The join of two augmented simplicial sets X. and Y. is Z. =X.*Y. defined by Zₙ=Fp_{+q=n-1} Xₚ x Y_{q}. The faces are dᵢ(x,y)=(dᵢx,y) for 0≤i≤p, dᵢ(x,y)=(x,dᵢ₋ₚ₋₁y) for p+1≤i≤p+1+q, and similarly for the degeneracies. The geometric realization of the simplicial join is the topological join X*Y=X x|x Y/{(x, 0, y) (x′; 0, y), (x, 1, y) (x, 0, y′)}. In particular one has Δ^{p}*Δ^{q}=Δ^{p+q+1}. Let u=x . . . xxx\check{ } . . . xxx\check{ } . . . x∈Pₘ. By direct inspection we see that X(u) is the simplicial join of the simplicial sets X(x . . . x\check{ }), X(x\check{ } . . . x . . . x\check{ }), . . . , X(x\check{ } . . . x . . . x\check{ }), X(x\check{ } . . . x). The point is that there are only one Cech signs at the extreme locations. Hence it is sufficient to show the contractibility of X(u) in the cases u=x\check{ }. . . x . . . x\check{ } and u=x\check{ } . . . x. 5. Fifth step: the case u=x\check{ } . . . X . . . x\check{ } or u=x\check{ } . . . x∈Pₘ. We treat in detail the case u=x\check{ } . . . x, the other one is similar. Since u=x\check{ } . . . x the trees t in T_{{u}} are of the form @@@@@@@@ . . . @@@@ @ Hence the 0-cell (d₀)^{m-2}(t;x, . . . , x)=(^{@@@@ @@}; \check{ }xx . . . x,x) is the same for all t∈T_{{u}}. We denote this vertex by P. In other words, in the amalgamation of the (m−2)-simplices (t;x, . . . , x) giving X(u), all the vertices of type m−2 get identified to P. We will show that there exists a sequence of retractions by deformation X(u)=X(u)^{hm-2i}→ . . . →→→X(u)^{hki}→ . . . →→^{ϕ}→^{k}X(u)^{h0i}=P. The simplicial set X(u)^{hki} is a subsimplicial set of X(u) determined by its nondegenerate k simplices. It is defined inductively as follows. We suppose that X(u)^{hki} has been defined (the induction process begins with k=m−2) and we determine X(u)^{hk-1i}. On X(u)^{hki} we introduce the equivalence relation generated by: α˜β if either dₖα=dₖβ or dₖ₋₁α=dₖ₋₁β. Then in each equivalence class we pick an element, say α₀. By definition X(u)^{hk-1i} is made of the elements dₖ₁α₀, one for each equivalence class. The map ϕₖ is defined by ϕₖ(α)=Sₖ₋₁dₖ₋₁α₀. On the geometric realization the map ϕₖ consists in collapsing each k−simplex a to its last face (the edge relating the vertices k−1 and k collapses to a point), and then embedding this face into X(u) as dₖ₋₁α₀. All the collapsing are coherent, and so assemble to give a collapsing of X(u)^{hki} to X(u)^{hk-1i}, because one can verify that for each vertex of type k −1 in X(u)^{hki} there is only one edge to the edge relating it to the vertex of type k, that is P. Here for m=4, u=xxxx\check{ } and the planar binary trees d0 d1 d2. Hence the simplices a,b,c,d,e of type Δ² are amalgamated under the following rules: d₀(A)=d₀(b)=d₀(c), d₀(d)=d₀(e), dᵢ(c)=dᵢ(d), d₂(α)=d₂(b). The first two spaces of the sequence (binary case) X(xxxx\check{ })=X(xxxx\check{ })^{h2i}→→X(xxxx\check{ })^{h11}→→X(xxxx\check{ })^{h0i}=P. In the planar tree case X(u)^{h2i} is made of eleven 2-simplices, X(u)^{h1i} is made of seven 1-simplices and X(u)^{h0i} is made of one 0-simplex (namely P). Since each map ϕₖ is a retraction by deformation, the space X(u)=X(u)^{hm-2i} has the same homotopy type as X(u)^{h0i}=P hence it is contractible”. Trialgebras and families of polytopes introduced by Jean-Louis Loday and María Ronco May 6, 2002. Acyclicity of the Koszul complex Bₙ,Bₙ(x) Bernoulli number and polynomial B^{˜}ₙ(x) periodic Bernoulli function Bₙ(x−└x┘)Bₙ and Lemma 2.3 (Conca, Iyengar, Nguyen and Romer, [9, Corollary 6.4]). (We refer to) “Let f≠0 be a quadratic form in the polynomial ring k[x1, . . . , xn] (semiprime ≥1). Let R be a Cohen-Macaulay standard graded k-algebra satisfying regR =1. Then R has minimal multiplicity and glldR=dimR. In particular, if f is a non-zero quadratic form in k[x₁, . . . , xₙ], then glld(k[x]/(f))=n−1. Proof. We may assume k is infinite; see Lemma 2.2. Given Proposition 6.3, it remains to show glldR≤dimR. Note that glldR <glld(R/Rx)+1 if x∈R₁ is R-regular; this is by Theorem 2.4. We may thus reduce to the case when dimR=0. Note that the regularity of R and its multiplicity remain unchanged. Let R=P/I where P is a polynomial ring and I⊆m², where m=P_{>1}. Since I has 2-linear resolution and pdₚ R=n, there is an equality of Hilbert series H_{R}(z)(1−z)ⁿ=1−β₁z²+ [symbol] +(−1)ⁿβₙzⁿ⁺¹, where βᵢ≠0 is the ith Betti number of R over P. Therefore by comparing degrees of the polynomials, Rᵢ=0 for i≥2, so I=m². Then every R-module is Koszul, so glldR=0. The last statement holds as k[x]/(f) is Cohen-Macaulay of dimension n−1. Theorem 6.5. If R is defined by monomial relations, then glldR≥dimR. Proof. Suppose R=P/I where P=k[x₁, . . . , xₙ] is a polynomial ring and I is a monomial ideal; we may assume it is quadratic, for else Id_{R} k is infinite. Reordering the variables if necessary we may assume that in the primary decomposition of I the component of minimal height is (x²₁, . . . , x²_{q}, x_{q+1}, . . . , xₛ), where s=n−dimR. We claim that Id_{R}(R/J)=dimR where J=(x₁, . . . , xₛ, x²ₛ₊₁, . . . , x²ₙ). Indeed, set S=k[xₛ₊₁, . . . , xₙ] and let R→S be the canonical surjection. Note that the composition of the inclusion S→R with the map R→S is the identity on S. Moreover Id_{R} S=0, since R is strongly Koszul. Therefore, noting that the action of R on R/J factors through S, from Proposition 2.3 one gets the first equality below: Id_{R}(R/J)=Id_{S}(R/J)=Id_{S}(S/(x²ₛ₊₁, . . . , x²ₙ))=n−s. The last equality is a direct computation; one can get it from Lemma 6.1. By Proposition 6.3 this is the case for Cohen-Macaulay rings; more generally, it holds when R has a maximal Cohen-Macaulay module, and in particular when dimR≤2”. Absolutely Koszul Algebras and The Backlin-Roos Property by Aldo Conca, Srikanth B. Iyengar, Hop D. Nguyen, and Tim Romer. To obtain lower bounds, we construct the affine function ϕ(x₁,x₂)=a₁x₁+a₂x₂+a₃ that coincides with f at the vertices of M₀. Solving the corresponding system of linear equations a₃ yields ϕ(x₁,x₂). Because of the concavity of f(x₁,x₂), ϕ(x₁,x₂) is underestimating f(x₁,x₂), i.e., we have ϕ(x₁,x₂)<f(x₁,x₂) V(x₁,x₂)ϵM₀. A lower bound β₀ can be found by solving the convex optimization problem (with linear objective function) min ϕ(x₁,x₂), s.t. (x₁,x₂)ϵM₀∩D=D. We obtain β₀ attained at x⁰=(0,0). We construct lower bounds β(M_{1,1}), and β(M_{1,2}) by minimizing over M_{1,1}∩D the affine function ϕ_{1,1} that coincides with f at the vertices of M_{1,1} and by minimizing over M_{1,2}∩D the affine function ϕ_{1,2} that coincides with f at the vertices of M_{1,2}, respectively. One obtains ϕ_{1,1} (x₁,x₂)=ϕ_{1,2}=β(M_{1,1})=(attained at (0,10)), and beta(M_{1,2})=(attained at (0,0)), which implies β₁=number n. The sets of feasible points in M_{1,1}, M_{1,2} which are known until now are S_{M1,1}={(0,0)(0,10)(20,20), S_{M1,2}={(0,0),(20,20)}. Hence α(M_{1,1})=α (M_{1,2})=f(0,0)=−500, α₁=−500 and x¹=(0,0). x²=(0,0) is the optimal solution. Calculating the lower bounds would have been simply by minimizing f over the vertex set of the corresponding partition element M. Whenever a lower bound β(M) yields consistency, or strong consistency, then any lower bound β(M) satisfying β(M) ≥β(M) for all partition sets M will, of course, also provide consistency, or strong consistency; and β(M_{q})=β(M_{q}).) The assumption concerning the deletion rule then implies that x⁻ϵD, and hence we have strong consistency. Keeping the partitioning unchanged, we then would have obtained β₀, β₁, deletion of M_{1,2}, deletion of M_{2,2}, (since M_{2,2}∩D⊂M_{1,2}∩D), β₂=α₂. ϕ(x,y)={I₁(x,y), (x,y)ϵM₁ I₂(x,y), (x,y)ϵM₂. If ϕ were not the convex envelope of xy over M, there would be a third affine function I₃(x,y) underestimating xy over M such that ϕ(x⁻,y⁻)<I₃ (x⁻,y⁻) (x⁻,y⁻)ϵM. Suppose that (x⁻,y⁻)ϵM₁. Then (x⁻,y⁻) is a unique convex combination of the three extreme points v¹, v², v³ of Mi. Hence, for every affine function I one has I(x⁻,y⁻)=Σ³ᵢ₌₁ λᵢI(vⁱ) with uniquely determined λ₁>0 (i=1, . . . , 3), Σ³ᵢ₌₁ λᵢ=1. But since ϕ agrees with xy at these extreme points and 13 underestimates xy there, by (97) we must have ϕ(x⁻,y⁻)=Σ³ᵢ₌₁ λᵢI₃(vⁱ), contradicting (98). A similar argument holds when (x⁻,y⁻)ϵM₂. Algorithm X.6 Step 0 (Initialization): Set M₀={M}, where M=R, and determine ϕM(x,y)=f(x)+ϕM(x,y)+g(y) according to Proposition X.19 (i) and Proposition X.20. We solve the convex minimization problem (PM) minimize ϕ M(x,y)=s.t. (x,y)ϵM∩K to determine β₀=min ϕM(M∩K). Let S_{M} be the finite set of iteration points in M A K obtained while solving (P_{M}). We set α₀=min F(S_{M}) and (x⁰,y⁰)ϵargmin F(S_{M}). If α₀−β₀=0 (≤ε), then stop. (x⁰,y⁰) is an (ε−)optimal solution. ϕ(x,y)={I₁(x,y), (x,y)ϵM₁ I₂(x,y), (x,y)ϵM₂. If ϕ were not the convex envelope of xy over M, there would be a third affine function I₃(x,y); or 4(x,y), (x,y)ϵM1−(97) t;(x,y) e M2 g(x,y): If p were not the convex envelope of xy over M, there would be a third affine function 4(x,y) underestimating xy over M such that *Gy)<4(ky) for some (ky) e M. (98) We suppose that (x,y) e M1. Global Optimization Deterministic Approaches Authors: Horst, Reiner, Tuy, Hoang May 1992. Underestimating xy over M such that an underestimation is derived by means of an inner approximation of the hypograph of the function f(x). An alternative interpretation is based on the representation of the function f(x) as the pointwise infimum of a collection of affine functions. In mathematics, the hypograph, or subgraph of a function f: Rⁿ→R is the set of points lying on, or below its graph: hypf={(x, μ): xϵRⁿ, μϵR, μ≤f(x)⊆Rⁿ⁺¹ and the strict hypograph of the function is: hypₛf={(x, μ): xϵRⁿ, μϵR, μ<f(x)}⊆Rⁿ⁺¹. The set is empty if f≡−∞. The domain (rather than the co-domain) of the function is not particularly important for this definition; it can be an arbitrary set^{[1]} instead of Rⁿ. Similarly, the set of points on, or above the function's graph is its epigraph. A function is concave if and only if its hypograph is a convex set. The hypograph of a real affine function g: Rⁿ→R is a halfspace in Rⁿ⁺¹. A function is upper semi-continuous if and only if its hypograph is closed. The above underestimation algorithm was derived by means of an inner approximation of the hypograph of the function f(x). An alternative interpretation is based on the representation of the function f(x) as the pointwise infimum of a collection of affine functions. (We refer to). “Whose period is the smallest possible compatible with these conditions. In particular, all the outer symmetries Θ∈AutR of R, Θ²=1, Θ/∈ InnR, are pairwise conjugate. The simplest realization of the symmetry s¹₂ consists in taking the automorphism of R⊗R that transforms x ⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type II₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We apply Lemma 1. Let R be a strongly semiprime ring. Then for every q E Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We calculate Lis₍ [symbol] ₎ function ϕ( [symbol] ,S)ϕ, and Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • •,iₙ, 0, • • • ) we now find the diagonal in a* the equivalence condition. If Q is a submodule of one another a left R-module M, then in particular submodule K of M such M is the internal direct sum of Q and K, whereby Q+K=M and Q∩K={0}. A short exact sequence provide 0→Q→M→K→0 of left R-modules splits. If X and Y are left R-modules and f:X→Y is an injective module homomorphism and g: X →Q is an arbitrary module homomorphism, now we have a module homomorphism [symbol] :Y→Q such that [symbol] f=g, the following diagram commutes: [symbol] *0→X^{g}↓α^{f} [symbol] Y the lemma follows intrinsic amount fitting the exact limit into the contravariant functor Hom(−,Q). (We refer to). Cohomology Operations Lectures By N. E. Steen rod Written And Revised By D. B. A. Epstein. “§ 4. Indecomposable Elements. 4.1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g −g′∈ϕ(A⊗A) and g −g′=Σaᵢ′ aᵢ″, where aᵢ′, aᵢ″∈A. But aᵢ′ and aᵢ″ are in A′. Therefore g′ G A′, which is a contradiction” the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of Ox-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1) from the category of left R-modules to the category of Abelian groups is exact. Injective right R-modules are defined in complete analogy such we continue for the formula: 2^{x-1}+4^{y}(1^{x+y}) is the real Euclidean space R^{2p} for all positive integer values of x and y formula for all composite numbers every even number paired by this formula subtracted by a given magnitude Q/2 would be a prime counting function denoting Q as a given magnitude Q/2+(2^{x-1}+4^{y}(1^{x+y}) is the real Euclidean space R^{2p}) fitted for the magnitude Q=Π(X_{0,1}). The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌0 Tⁱ F⁻)≥1−εe/2. Now express each set A∈V^{m-1}₀T⁻ⁱ P/F⁻ as A₁ ∪A₂, A₁∩A₂=ϕ, μ(A₁)=μ(A₂), and put (m/2)−1 (m/2)−1 FA=[T2iA1 ∪[T2i−1A2 ᵢ₌₀ i=1. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of ∪^{m-1}ᵢ₌₀ Tⁱ F⁻, Tⁱ F⁻, 0≤i≤m−1. Thus if m is large enough, μ(F∪TF) will be at least 1−ε. This establishes that d(P/F)=d(P/F∪TF). Shifts and partitions of a Bernoulli shift we begin with n=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure p defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g}−,ϕ−) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Σ[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat 6-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that X and A are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when n=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Uₚ to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ>: K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 11], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧} : preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{n,m},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩ Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ*([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{n,m},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩ Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ } 4)₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }Gϕₖ=gₖPF\hat{ }ϕₖ=gₖ(PF)iϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ′s: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→} of two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take: a) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0, H is an HNN group whose base is a tree product of vertices cKc⁻¹∩H where c ranges over a double coset representative system for G mod (H, K). Hamiltonian is assumed to be in Birkhoff's normal form up to terms of degree 2nχ for the function of transport properties generating a series interval A step path in S is a path y: [A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x e [0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+1Pₙ+m. The family of standard simplices. Let Δn={(x0, . . . , xn) ∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) Xᵥ:H*(A)→H*_{τ}(V) is to exploit the local triviality of the foliation as follows: For each open set U⊂V one lets A(U) be the algebra associated by the functor C_{c}^{∞}(, G^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{n,m} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞} (G,Ω^{1/2}) where the integral on the right-hand side makes sense since it is the integral of a 1-density, namely a( [symbol] ₁)b( [symbol] Γ^{x} [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒Zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }Gϕₖ=gₖPF\hat{ }ϕₖ=gₖ(PF)iϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ }, G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. of two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁x [0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X0G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two examples of this construction one can take: α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4, 1, 4, 1, 3, 0, . . . ] the minimal carrier of τ consists of simplexes all of which have X, as a vertex of load, or signal by the rule (χ*(n mod m), gcd(n,m)=1, χ(n)=0, H is an HNN group whose base is a tree product of vertices cKc⁻¹∩H where c ranges over a double coset representative system for G mod (H, K). Hamiltonian is assumed to be in Birkhoff's normal form up to terms of degree 2n χ for the function of transport properties generating a series interval A step path in S is a path y: [A, b]→S together with a subdivision a=τ₀<n<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1], We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧}(K(C*(V,F))) is equal to {hCh(E),[C]i;[E] E K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y G R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊗S^{y}ₚ of M⊗R for suitable p and [symbol] , it is necessary and sufficient that p₀(Θ)=Pₐ(Θ). Moreover, for Θ∈AutM to be outer conjugate to Θ⊗s^{x}_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type 11i not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q ∈Q(R) there exist elements i₁, . . . , iₙ∈R and ψ₁, . . . , ψₙ∈F, such that qiₖ, iₖq ∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, E a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each X₁ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote p(E). Now, let A be arbitrary, and let α be the homomorphism α: J^{˜}→A, α(a,λ)=a+X1 ∀a ∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the T-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any q∈F*ₓ, q /=0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q. for D modulo the algebra C_{c}^{∞} (G, Ω^{1/2})=J of the foliation. To be more precise let us fix for convenience a smooth nonvanishing 1-density along the leaves and drop the Ω's from the notation. Then to D corresponds a distribution section D E C_{c}^{∞} (G, s*(E*₁)⊗r*(E₂)) with support on G⁽⁰⁾. To the quasi-inverse Q of D corresponds a section Q∈C_{c}^{∞} (G, s*(E*₂)⊗r*(E₁)). The quasi-inverse property is then the following QD−1_{E1}∈C_{c}^{∞}(G, s*(E*₁)⊗r*(E₁)) DQ−1E₂ E C_{c}^{∞}(G, s*(E*₂)⊗r*(E₂)) where 1_{Ei} corresponds to the identity operator C^{∞}(V,E₁)→C^{∞}(V,E₁). Now the algebra J=C_{c}^{∞}(G) is a two-sided ideal in the larger A, the algebra under convolution of distributions T E C_{c}^{∞}(G) which are multipliers of C_{c}^{∞}(G), i.e. satisfy T*f∈C_{c}^{∞}(G) and f·T∈C_{c}^{∞}(G), for any f e C_{c}^{∞}(G). Thus, neglecting the bundles E₁ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ ∀(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=A be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote p(E). Now, let A be arbitrary, and let α be the homomorphism α: J^{˜}→A, α(a,λ)=a+λ1 ∀a∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), {E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S* be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class OD ∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules E, over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map from the total space ν to V⁰=V ×Rⁿ given by ϕ(x,ξ)=(x,i(x)+ξ) ∀x∈V, ξ∈vₓ=(i_{*}(Fₓ))^{⊥}, and check that on a small enough neighborhood N of the 0-section in v the map ϕ : N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p∘n) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧} , on C*(V,F) and hence an additive map trace_{∧}: K(C*(V,F))→R. The reason why trace_{∧}∘ Indₜ is much easier to compute than trace_{∧}∘ Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ : K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the ho recycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧}is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧} : K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let A_{Θ}be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)=(0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫ αₜ(τ₀(a))dt=τ₀ (∫ αₜ(a))=τ₀ τ(a)id_{AΘ})=τ(a) and the conclusion follows. For a left R-module M, the so-called “character module” M+=Hom_{Z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a 6-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoλ=ψ, and 2) if p is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconducter the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕk=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type II_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] :mod Θ=1⇒p₀=0, [symbol] =1; p₀=0⇒ [symbol] ]=1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for A an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧ . Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ} , and 2) the formal “metric” dUdU* +dVdV*∈Ω²+(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W x K^{p}; Zₚ)→H* (W x K; Zₚ the map induced by the diagonal d: K→K^{p}. 4. 1 Lemma. Let x: H*(W⊗K^{p}; Zₚ)→H*_{π}: (W⊗K^{p}; Zₚ) denote the transfer. Then d*τ=o. Proof. We have a commutative diagram [1] H*(W⊗K^{p}; Zₚ) τ→H*_{π}(W⊗K^{p}; Zₚ); [2] H*_{π}(W⊗K; Zₚ)i*→H*(W⊗K; Zₚ)τ→H*_{π}(W⊗K; Zₚ). [3] H*(W⊗K^{p}; Zₚ) d*→H*(W⊗K; Zₚ) [4] H*_{π}(W⊗K^{p}; Zₚ) d*→H*_{π}(W⊗K; Zₚ). § 4. The Transfer. Since W is acyclic and H⁰ ₙ(W; Zₚ)→H⁰ (W; Zₚ) is onto, i*:Hⁿₙ(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{p}; Zₚ) then d*P is a homomorphism. Proof. Let u and v be q-cocycles on K. Then P(v+u)−Pu−Pv is given by the chain map W⊗K^{p ε⊗1}→K^{P (u+v)p-uP-vP}→Z^{p}. According to 4.1, we need only show that this cocycle is in the image of the transfer. It will be sufficient to show that (u+v)^{p}−u^{p}−v^{p} is in the image of a cocycle under x: C*(K^{p}; Zₚ)→C*_{π}(K^{p}; Zₚ) since ε⊗1 is an equivariant map. Now (u+v)^{p}−u^{p}−v^{p} Is the sum of all monomials which contain k factors u and (p−k) factors v, where 1≤k≤p−1. Now n permutes such factors freely. Let us choose a basis consisting of monomials whose permutations under π give each monomial exactly once. Let z be the sum of the monomials in the basis. Then τz=(u+v)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of Wₖ”. “4.7. Lemma. Let u∈H^{r}(K;Zₚ) and v∈H^{S}(L;Zₚ). If p >2 then D₂ₖ(U×v)=(−1)^{p}(^{p-1})^{rs/2} Σ^{k}ⱼ₌₀ D₂ⱼ U×D₂ₖ₋₂ⱼ v. If p=2, Dₖ(U×v)=Σ^{k}ⱼ₌₀ DⱼU×Dₖ₋ⱼv. Construction of Powers Proof. The map of geometric triples ∧, used in 2.6, takes the form ∧: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W×W x K×L;Zp)≈H*(W/π×W/π×K×L;Zp). It is easy to see that under this isomorphism we have by 3.2 (d′)*(Pu×Pv)=Σ_{j,l} (−1)^{l(pr-j)}wⱼ×wₗ×DⱼU×Dₗv. Applying (d₁)* to each side of this equation, and using the commutative diagram, we obtain d*∧*(Pu×Pv)=Σ_{j,l} (−1)^{l(pr-j)} wⱼ wₗ×DⱼU×Dₗv. Also d* P(Uxv)=Σk Wₖ×Dₖ (Uxv). The lemma follows from 2.6 and V 5.2”. The power series centered at c with coefficients aₙ is the series Tₙ₌₀ aₙ(x−c)ⁿ. Power series centered at 0: ^{∞}ΣΣₙ₌₀ xⁿ=1+x+x²+x³+x⁴+ . . . , ^{∞}Σₙ₌₀ 1/n!xⁿ=1+x+1/2x²+1/6x³+1/24x⁴+ . . . , ^{∞}Σₙ₌₀ xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−1/2(x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ, It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{n,m},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∈[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞} (G, Ω^{1/2})=J of the foliation. To be more precise let us fix for convenience a smooth nonvanishing 1-density along the leaves and drop the Ω's from the notation. Then to D corresponds a distribution section D G C_{c}^{∞} (G, s*(E*₁)⊗r*(E₂)) with support on G⁽⁰⁾. To the quasi-inverse Q of D corresponds a section Q∈C_{c}^{∞}(G, s*(E*₂)⊗r*(E₁)). The quasi-inverse property is then the following QD−1_{E1}∈C_{c}^{∞}(G, s*(E*₁)⊗r*(E₁)) DQ− 1E₂∈C_{c}^{∞}(G, s*(E*₂)⊗r*(E₂)) where 1_{Ei} corresponds to the identity operator C^{∞}(V,E₁)→C^{∞}(V,E₁). Now the algebra J=C_{c}^{∞}(G) is a two-sided ideal in the larger A, the algebra under convolution of distributions T∈C_{c}^{∞}(G) which are multipliers of C_{c}^{∞}(G), i.e. satisfy T·f∈C_{c}^{∞}(G) and f·T∈C_{c}^{∞}(G), for any f∈C_{c}^{∞} (G).Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D) 6 K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜}is the algebra obtained by adjoining a unit to J, that is, J^{˜}={(a,λ);a∈J,λ∈C},and ε(a,λ)=λ ∀(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜}the triple (E,(r∘ε)_{*}E,id) is a quasi-isomorphism, which we denote p(E). Now, let A be arbitrary, and let α be the homomorphism α: J^{˜}→A, α(a,λ)=a+X1 ∀a∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(“J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞} (G)⊂A. We shall let Ind(D)∈K₀ (C_{c}^{∞}(G)) be the index associated to (E₁,E₂,D) by Proposition 9.(3 Significance of the C*-algebra index. By the construction of C*(V,F) as a completion of the algebra C_{c}^{∞}(G), one has a natural homomorphism C_{c}^{∞}(G)→ⁱC*(V, F) and we shall denote by Indₐ(D) the image j·Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥}of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V ×Rⁿ given by ϕ(x,ξ)=(x,i(x)+ξ)∀x∈V, ξ∈vₓ=(i_{*}(Fₓ))^{⊥}, and check that on a small enough neighborhood N of the 0-section in v the map ϕ : N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i_{*}(F))^{x} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of a(D)∈K(F*)˜K(N) (through the Thom isomorphism) by the map K(N)→^{εl}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧} , on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ : K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t ∈R, one sees that the analytic index gives a (degree-1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with λ∈|0, 1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂a₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁ ∧ . . . ∧eᵢₚ)∧(eⱼ₁ ∧ . . . ∧e_{jq})=eᵢ₁ ∧ . . . ∧eᵢₚ ∧eⱼ₁ ∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁ ∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃ ∧e₄+e₃∧e₄ ∧e₁∧e₂+0=2 e₁∧e₂∧e₃∧e₄. If α₁, . . . , aₖ have degree one, then they are linearly independent if α₁∧ . . . ∧aₖ≠0. A hyperbola with a horizontal transverse axis and center at (h, k) has one asymptote with equation y=k+(x−h) and the other with equation y=k −(x−h). The set of D in the intersection of n half-spaces of the hyperplane Σⁿᵢ₌₁ Xᵢ=a with the hyperrectangle R defined by 0≤x₁≤Mᵢ, i=1, . . . , n, or we denote by N the set of non-negative integers for d ≥2 and n∈N even, let pₙ=pₙ(d) denote the number of length n self-avoiding polygons in Z^{d} up to translation. The polygon cardinality grows exponentially, and the growth rate lim_{nϵ2N} p¹ₙ^{/n}∈(0,∞) is called the connective constant and denoted by p. Madras [J. Statist. Rhys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ} ,A_{Θ}0 are Morita equivalent (cf. D. Ruelle and D. Sullivan. Currents, flows and diffeomorphisms. Topology 14). We also consider a certain variant of self-avoiding walk and argue that, when d ≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F⁻) ≥1−ε/2. Now express each set A∈V^{m-1}₀T⁻¹ P/F⁻ as A₁∩A₂, A₁∩A₂=ϕ , μ(A₁)=μ(A₂), and put (m/2)−1 (m/2)−1 F_{A}=[T2iA1∩[T2i−1A2 ᵢ₌₀ i=1. Clearly, F_{A} and TF_{A} are disjoint. We now let F be the union of the sets F_{A}, A∈V^{m-1}₀T⁻¹ P/F⁻. It follows that F∩TF=ϕ , and that F∪TF is all of U^{m-1}ᵢ₌₀ Tⁱ F⁻, Tⁱ F⁻, 0≤i≤m−1. Thus if m is large enough, μ(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n] where tᵢ, −m≤i≤n, is some fixed finite sequence in {1, 2, . . . , k}. Let E denote the o-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g}, ★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between (F_{g}−,ϕ−) and (F_{g+},ϕ₊) the (closure of) the kernel of the R-linear map (−m₋)⊗m₊: H^{ϕ}₁(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all xϵs where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε≥0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=F. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U<=V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ } ϕₖ=Pϕₖ, for k=1, 2, 3 PF\hat{ }ϕ₄=F<)₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q. are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)o(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b] S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate E-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U1 ∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=F. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) Xᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If Uᵢ<=U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (r<^{n,m}>,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=P(t>k, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] (f|Af [symbol] is real. Semiprime rings. Two rings R,S are Morita equivalent if their categories of left modules are equivalent. R and Mₙ(R) are known to be Morita equivalent. In some C*algebraic sense, B₀(FI) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ } c(>k=G\hat{ }(PF)iϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S ×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; 1/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4,1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₄<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖϕₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈InnR, are pairwise conjugate. The simplest realization of the symmetry s¹₂ consists in taking the automorphism of R⊗R that transforms x⊗y into y⊗x for all x,y G R. For μ₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*,} the following equivalence: InnM/InnM is nonAbelian⇔M is isomorphic to M⊗R. In this case, let Θ∈InnM. In order that Θ be outer conjugate to the automorphism 1 0 S^{v}ₚ of M⊗R for suitable p and y, it is necessary and sufficient that p₀(Θ)=Pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type ∥₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ X₆ where each X, is invariant under T, and where: 1) For every i>0, the restriction of T to X₁ is periodic of period i and card{T^{j}x}=i ∀x∈X₆ 2) For i=0, the restriction of T to X₀ is aperiodic, i.e. card{T^{j}x}=^{∞}∀x∈X₀. We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)ₙ=0, of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to π/4 and as F the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧ : K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊂I. Let the exact sequence K₀(I)→K₀(R)→K₀(R/I) where K₀(I) is defined as follows: adjoined unit by ring structure l, which has some K-theory K₀(I). There is a map K₀(I)→K₀(k)=Σ. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x G X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and p into Lebesgue measure on the unit square. Also, s(Tx)=,x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>Pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group E is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊂I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F ₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x G X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε¹ in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R; S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>Pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Uₚ to a shift of parity, the geometric group K*,_{τ}(BG) is the K-theory group K*⁺¹(V). The projection p:V →V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ-2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 11], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧} : preserving K*(C*(V,F))→R is equal to 0, so in particular dim_{∧} is identically 0, submitting K(C*(V,F))→R is equal to 0, so in particular dim_{∧} is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞} (G⊗R);” “Theorem 12 reduces to Theorem 4.7 in the case of discrete groups G=F. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse A of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{n,m},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a·b)( [symbol] )= [symbol] a( [symbol] ₁)b( [symbol] ₂)∀a, b∈C_{c}^{∞}(G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1], We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn) ∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=F. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ } , that obeys the following rules: PF\hat{ }ϕₖ=P<K for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)kϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all S, are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gₛ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ In n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4, 1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant x₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1], We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn) ∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 11]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n I in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)}, ,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=F. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse A of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If Uᵢ<=U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U) the algebra obtained by adjoining a unit to A(U). Because the construction of the (b,B) bicomplex is functorial it yields a presheaf of bicomplexes: (Γ^{(n,m)}, ,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ } c)i≤=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)kϕₖ=(PF)ₖG\hat{ }ϕₖ=(PF)ₖgₖϕₖ. Thus we proved that for the 4 eigenfunctions: [PF\hat{ } , G\hat{ }]ϕ k=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; 1/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M) and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant T0<T1<T2<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+1Pₙ+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{n,m}* (U₀∩U₁∩ . . . ∩Uₚ), b,B,δ) Uᵢ∈U where δ is the Cech coboundary.\check{ } Moreover, there is an obvious forgetful map from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 19871. We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G,Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ } ϕ₄=F4)₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ } ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M⁺. Two pairs (S₀, g₀) and (S₁, g₁), where S, are compact, m-dimensional Z/2-oriented, regular stratifolds and gᵢ: S,→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where S, are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M) and the composition is (x,y)=(y,z)=(x,z) ∀x,y,z∈M. The convolution algebra is then the algebra of smoothing kernels on the manifold M. β) A Lie group G is, in a trivial way, a “groupoid with G⁽⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4,1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (an)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x ∈[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π} {1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant x₀<τ₂<τ₂<∧<T_{π} =b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(XT h) where X̅Th/2 and X̅Th are the Euler approximation at time T for the step size h/2 and h respectively D 4== . . . =^{D}_{2N-2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(1)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of ∪ called the n-isotypic component of U; or the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of ∪ we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steen rod Written And Revised By D. B. A. Epstein”. “The lemma follows by comparing coefficients of Wₖ”. “4.7. Lemma. Let u∈H^{r}(K;Zₚ) and v∈H^{S}(L;Zₚ). If p ≥2 then D₂ₖ(U×v)=(−1)P(^{p,1})^{rs/2} Z^{k}ⱼ₌₀ D₂ⱼ U×D_{2k-2J}v. If p=2, Dₖ(U×v)=Σ^{k}ⱼ₌₀ DⱼU×D_{k-J}v. Construction of Powers Proof. The map of geometric triples ∧, used in 2.6, takes the form A: (π, Zₚ, (K×L)^{p})→(π×π, Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W ×W×K×L;Zp)≈H*(W/π× W/π× K×L;Zp). It is easy to see that under this isomorphism we have by 3.2 (d′)*(Pu×Pv)=Σ_{j,l} (−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼwₗ×Dⱼu×Dₗv. Also d* P(Uxv)=Σₖwₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀ xⁿ=1+x+x²+x³+x⁴+ . . . , ^{∞}Σₙ₌₀ 1/n!xⁿ=1+x+1/2x²+1/6x³+1/24x⁴+, Σₙ₌₀ (n!)xⁿ=1+x+2x²+6x³+24x⁴+ . . . , Σₙ₌₀ (−1)ⁿx²ⁿ=x−x²+x⁴−x⁸+ . . . ; and power series centered at 1: Σₙ₌₁ (−1)ⁿ⁺¹/n(x−1)ⁿ=(x−1)−1/2(x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ } ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀ 0 U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε).E,id) is a quasi-isomorphism, which we denote p(E). Now, let A be arbitrary, and let α be the homomorphism α: J^{˜}→A, α(a,λ)=a+X1 ∀a ∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀] e M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol a₀(x,η)∈Hom(E_{1,X},E_{2,X}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞} (G, s*(E*₁)⊗r*(E₂)) with support on G⁽⁰⁾. To the quasi-inverse Q of D corresponds a section Q∈C_{c}^{∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,E₁)→C^{∞}(V,E₁). Now the algebra J=C_{c}^{∞} (G) is a two-sided ideal in the larger A, the algebra under convolution of distributions T∈C_{c}^{∞}(G) which are multipliers of C_{c}^{∞}(G), i.e. satisfy T*f∈C_{c}^{∞}(G) and f·T G C_{c}^{∞} (G), for any f∈C_{c}^{∞} (G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J)→^{ε}*K₀(C)=Z where J is the algebra obtained by adjoining a unit to J, that is, J^{˜}={(a,λ);a∈J,λ∈C},and ε(a,λ)=λ ∀(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E_{2/}h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊗(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘p is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules E, over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.3 Significance of the C*-algebra index. By the construction of C*(V,F) as a completion of the algebra C_{c}^{∞}(G), one has a natural homomorphism C_{c}^{∞} (G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*(}Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D) 6 K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class o₀∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V∘one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=u(F)¹ of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V ×Rⁿ given by ϕ(x,ξ)=(x,i(x)+ξ) ∀x ∈V, ξ∈vₓ=(i_{*(}Fₓ))^{⊥}, and check that on a small enough neighborhood N of the 0-section in v the map ϕ : N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{εl}K(C*(V⁰; F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K*,_{X}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where f is a discrete cocompact subgroup of SL(2,R), by the left action of the subgroup of lower triangular matrices of the form [1 0 t 1], t∈R, one sees that the analytic index gives a (degree-1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism <given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧} : K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with λ∈[0,1] also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ}satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀ (∫αₜ(a))=τ₀ τ(a)id_{AΘ})=τ(a) and the conclusion follows. For a left R-module M, the so-called “character module” M+=Hom_{z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a 6-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ : C→M, where C G F, is called an F-cover of M if the following properties are satisfied: 1) For any morphism ψ: C′→M, where C′ G F, there is a morphism A: C′ C such that <)oλ=ψ, and 2) if p is an endomorphism of C such that ϕoμ=ϕ , then p is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconductor the operator PF\hat{ } , that obeys the following rules: PF\hat{ }ϕₖ=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type II_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] :mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever 0 is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧ . Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU* +dVdV* 6 Ω²+(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof p₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×lΩ⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W x K^{p}; Zₚ)→H* (W×K; Zₚ the map induced by the diagonal d: K→K^{p}. 4. 1 Lemma. Let T: H*(W⊗K^{p}; Zₚ)→H*_{π}: (W⊗K^{p}; Zₚ) denote the transfer. Then d*τ=0. Proof. We have a commutative diagram [1] H*(W⊗K^{p}; Zₚ) T→H*_{π}(W⊗K^{p}; Zₚ); [2] H*_{π}(W⊗K; Zₚ)i*→H*(W⊗K; Zₚ) τ→H*_{π}(W⊗K; Zₚ). [3] H*(W⊗K^{p}; Zₚ) d*→H*(W⊗K; Zₚ) [4] H*_{π}(W⊗K^{p}; Zₚ) d*→H*_{π}(W⊗K; Zₚ). § 4. The Transfer. Since W is acyclic and H⁰ _{π}(W; Zₚ)→H⁰ (W; Zₚ) is onto, i*:Hⁿₙ(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{p}; Zₚ) then d*P is a homomorphism. Proof. Let u and v be q-cocycles on K. Then P(v+u)−Pu−Pv is given by the chain map W⊗K^{P ϵ⊗1}→K^{p(u+v)p-uP-vP}→Z^{p}. According to 4.1, we need only show that this cocycle is in the image of the transfer. It will be sufficient to show that (u+v)^{p}-u^{p}-v^{p} is in the image of a cocycle under x: C*(K^{p}; Zₚ)→C*_{π}(K^{p}; Zₚ) since ε⊕1 is an equivariant map. Now (u+v)^{p}−u^{p}−v^{p} Is the sum of all monomials which contain k factors u and (p−k) factors v, where 1≤k≤p−1. Now n permutes such factors freely. Let us choose a basis consisting of monomials whose permutations under π give each monomial exactly once. Let z be the sum of the monomials in the basis. Then τz=(u+v)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Micas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of Wₖ”. “4.7. Lemma. Let u∈H^{r}(K;Zₚ) and v∈H^{S}(L;Zₚ). If p >2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples A, used in 2.6, takes the form ∧: (π, Zₚ, (K×L)^{p})→(π×π , Zₚ,K^{p}×L^{p}). We have the commutative diagram of maps of geometric triples where d is induced by the diagonal on K×L, dᵢ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W×W x K×L;Zp)≈H*(W/π×W/πx K×L;Zp). It is easy to see that under this isomorphism we have by 3.2 (d′)*(Pu×Pv)=Σ_{j,l} (−1)^{l(pr-j)} wⱼX wᵢ x Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×Dⱼu×Dₗv. Also d* P(U×v)=Σₖ Wₖx Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀1/n!xⁿ=1+x+1/2x²+1/6x³+1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−1/2(x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ } , that obeys the following rules: PF\hat{ }ϕₖ=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }; G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the ⊕j(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁, a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C∘⁰(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a para metrix for families of elliptic operators and patch the resulting operators by using a partition of unity in V subordinate to a covering (Uⱼ) by domains of foliation charts. What one obtains is an inverse Q for D modulo the algebra C_{c}^{∞} (G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞} (G, s*(E*₁)⊗r*(E₂)) with support on G⁽⁰⁾. To the quasi-inverse Q of D corresponds a section Q∈C_{c}^{-∞} (G, s*(E*₂)⊗r*(E₁)). The quasi-inverse property is then the following QD−1_{E1}∈C_{c}^{∞}(G; s*(E*₁)⊗r*(E₁)) DQ− 1_{E2} 6 C_{c}^{∞}(G, s*(E*₂)⊗r*(E₂)) where I_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{∞}(G) which are multipliers of C_{c}^{∞}(G), i.e. satisfy T*f∈C_{c}^{∞}(G) and f·T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D) ∈K₀(J), since this allows us to take the bundles Eᵢ into account, α Construction of Ind(D)∈K₀(J). Let J be a non-unital algebra over C, and define K₀(J) as the kernel of the map K₀(J)→^{ε}*K₀(C)=Z where J is the algebra obtained by adjoining a unit to J, that is, J^{˜}={(a,λ);a∈J,λ∈C},and e(a,λ)=λ ∀(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ− 1 1−QD Q] defines an isomorphism of E₁⊕E₂ with E₂⊗E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J; ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₂)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.(3 Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C′-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class o₀∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V “which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V “one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥}of i_{*}(F) in Rⁿ as a manifold N, transversal to the foliation of V “=V×Rⁿ by the integrable bundle F⁰=F×{0}⊂TV “. First note that the bundle ν over V has a total space of dimension d=dimV+n−dimF, which is the same as the codimension of F⁰ in V⁰. Next consider the map ϕ from the total space ν to V∘=V ×Rⁿ given by ϕ(x,ξ)=(x,i(x)+ξ)∀x∈V, ξ∈vₓ=(i_{*}(Fₓ))^{⊥}, and check that on a small enough neighborhood N of the 0-section in v the map ϕ : N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(u(F))^{⊥} be the normal bundle of i_{*}F in Rⁿ, and let N˜v be the corresponding transversal to the foliation of V×Rⁿ=V “by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of a(D)∈K(F*)˜K(N) (through the Thom isomorphism) by the map K(N)→^{εl}K(C*(V “,F⁻))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D)ⁱ,p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C′(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree-1) isomorphism of K*(V) onto K(C*(V,F)), while for the only transverse measure ∧ for (V,F) (the horocycle flow being strongly ergodic), the composition of the above analytic index with dim_{∧}: K*(C′(V,F))7→R is equal to 0, so in particular dim_{∧}is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane singletons have {points {and the entire space Rⁿ is our solution set of an arbitrary possibly, infinite system ≤b_{α}, α∈A α^{T}_{α}x≤b_{α}, α∈A of linear inequalities with n unknowns x {the set M={xϵRⁿ|α^{T}_{α}x≤b_{α}, α∈A} is convex, and their incidence of Euclidean space are shared with affine geometry, (vector field on the generic leaf of a foliation) Hₖ(V,R), we get a scalar χ(F,∧)=he(F),[C]i∈R nondegenerate 2-form structure in potential theory complex analysis proves invaluable mathematical physics expressions an infinite potential finite-dimensional π=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β)∧μ=α∧(β∧μ), and bilinear (c₁ α₁+c₂ α₂)∧β=c₁ (α₁ ∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁ ∧ . . . ∧eᵢₚ)∧(eⱼ₁ ∧ . . . ∧e_{jq})=eᵢ₁ ∧ . . . ∧eᵢₚ ∧eⱼ₁ ∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄) A (e₃∧e₄)=0+e₁∧e₂∧e₃∧e₄+e₃∧e₄ ∧e₁∧e₂+0=2 e₁∧e₂∧e₃∧e₄. If a₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k −(x−h). The set of D in the intersection of n half-spaces of the hyperplane Σⁿᵢ₌₁xᵢ=a with the hyperrectangle R defined by 0≤xᵢ≤Mᵢ, i=1, . . . , n, or we denote by N the set of non-negative integers for d ≥2 and n E N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,^{∞}) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). We also consider a certain variant of self-avoiding walk and argue that, when d ≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F⁻) ≥1−ε/2. Now express each set A∈V^{m-1}₀ T⁻ⁱ P/F⁻ as A₁ ∪A₂, A₁∩A₂=ϕ, μ(A₁)=μ(A₂), and put (m/2)−1 (m/2)−1 FA=[T2iA1 ∪[T2i−1A2 ᵢ₌₀ i=1. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of U^{m-1}ᵢ₌₀ Tⁱ F⁻, Tⁱ F⁻, 0≤i≤m−1. Thus if m is large enough, μ(F∪TF) will be at least 1−ε . This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the o-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★); [symbol] ⋅,⋅ [symbol] ₛ) where ★∈∂F_{g} and [symbol] ⋅,⋅ [symbol] : H^{ϕ}₁(F_{g},★)×H^{ϕ}₁(F_{g},★)→R is a version of the equivariant intersection form with coefficients in R twisted by ϕ . At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁺(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜}are no longer yoked to each other is modeled as x=A·s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T·M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Uₚ to a shift of parity, the geometric group K*_{,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ } ϕ k=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ: S,→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾=(e). One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4, 1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (an)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n I in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)}, ,b,B). Choosing a covering U=(U_{α}) of V sufficiently fine so that the multiple intersections are domains of foliation charts, we get a triple complex M (3.42) (Γ^{n,m,p}=Γ^{,n,m} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=r. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{,n,m} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ } , that obeys the following rules: PF\hat{ }ϕ k=Pϕₖ, for k=1, 2, 3 PF\hat{ } 4)₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ } ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G⁻¹]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′ X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4,1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant x₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x ∈[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+1Pₙ+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E] E K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries 0 E AutR of R, Θ²=1, Θ/∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type Minot antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ω₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Σ. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x (s(x),t(x)) is easily seen to be 1-1 structure of the Dual Algebra the monomials ε^{I} in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and p into Lebesgue measure on the unit square. Also, s(Tx)=.x₁x₂ . . . and τ(TX)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒Σₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group r is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to TX/4 and as T the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1=* zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x e X, we construct the point (s(x),t(x)) in the unit square (using binary digits) s(x)=,x₀x₁x₂ . . . and t(x)=.x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Uₚ to a shift of parity, the geometric group K*,_{τ}(BG) is the K-theory group K*⁺¹(V). The projection p:V →V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim_{∧} is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n I in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)}, ,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group I” is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gᵢ<PF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S, are compact, m-dimensional Z/2-oriented, regular stratifolds and g, :Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where S, are compact, m-dimensional Z/2-oriented, regular stratifolds and & :Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ) infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=D{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4, 1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant x₀<τ₄<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn) e Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map $ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and G>(c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b ∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕ k=G\hat{ }(PF)ₖϕₖ=(PF)ₖG\hat{ }c{)ₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ: S,→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4, 1, 4, 1, 3, 0, . . . ] the minimal carrier of t consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<tₙ=b of [A, b] such that in each subinterval [τⱼ₋₁, τⱼ] either re(y) or im(y) is constant i₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+1Pₙ+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 11]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F)HR is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map ϕ_{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}, (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G, Ω^{1/2}) of smooth compactly supported sections of Ω^{1/2} with the convolution product (a*b)( [symbol] )=_{∫} [symbol] ₁₌ [symbol] ₂₌ [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group T is chosen discrete and cocompact in such a way that V is a homology 3-sphere is our Euclidean centered group for calibration and control R³ subspace, the operator PF\hat{ } , that obeys the following rules: PF\hat{ }ϕₖ=P(K for k=1, 2, 3 PF\hat{ } ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕ k=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0, 1], h) via the isomorphism considered as a map from ({1}×S₁) to (S₂×{0) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of Wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z E M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4,1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable 2 complex analysis, a complex logarithm function an inverse of the complex function e^{x} a logarithm of a complex numbed [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)}, ,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=C Let c be a group cocycle, c∈Z^{2q}(l”,C). Then by Section 2 [symbol] ) one has (3.36) [symbol] (c)=τ_{c}. But the cyclic cocycle t_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{X}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) fⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞} (G, Ω^{1/2}) of smooth compactly supported sections of Ω^{1/2} with the convolution product (a·b)( [symbol] )= [symbol] a( [symbol] ₁)b( [symbol] ₂) ∀a, b∈C_{c}^{∞} (G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group I” is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ } C])₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S, are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all S, are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the &{K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)=(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0, 1, 0, 1, 4,1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y; uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate z-plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧} (K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π} {1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively D 4== . . . =^{D}_{2N -2=0}: under theorem there exist homogeneous polynomials F2k, k=2, . . . , n−2, of degree k such that 1-12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1], We find the familiar geometric series from calculus, alternately, this function has an infinite expansion. Following a construction of Frohman, C. D.; Nicas, A. (1991) which involves moduli spaces of flat U(1)-connections A module is called a uniform module if every two nonzero submodules have nonzero intersection at the initial phase of the motion 1n+1, the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of ∪ called the n-isotypic component of U; or the set Uₙ of Uₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of ∪ we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10′⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steen rod Written And Revised By D. B. A. Epstein”. “The lemma follows by comparing coefficients of Wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D_{2k-2j v}. If p=2, Dₖ(U×v)=Σ^{k}ⱼ₌₀ DⱼU×D_{k-J}v. Construction of Powers Proof. The map of geometric triples A, used in 2.6, takes the form A:[n, Zₚ, (K×L)^{p})→(π×π , Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π} (W×W×K× L;Zp)=H*(W/πx W/πx K×L;Zp). It is easy to see that under this isomorphism we have by 3.2 (d′)*(Pu×Pv)=Σ_{j,l} (−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼwₗ×Dⱼu×Dₗv. Also d* P(U×v)=Σₖwₖ×Dₖ (U×v). The lemma follows from 2.6 and V 5.2”. The power series centered at c with coefficients aₙ is the series ^{∞}Σₙ₌₀ aₙ(x−c)ⁿ. Power series centered at 0: ^{∞}Σₙ₌₀xⁿ=1+x+x²+x³+x⁴+ . . . , ^{∞}Σₙ₌₀ 1/n!xⁿ=1+x+1/2x²+1/6x³+1/24x⁴+ . . . , ^{∞}Σₙ₌₀ (n!)xⁿ=1+x+2x²+6x³+24x⁴+, ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−1/2 (x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconducter the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕ k=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a X×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε).E,id) is a quasi-isomorphism, which we denote ρ(E). Now, let A be arbitrary, and let α be the homomorphism α: J^{˜}→A, α(a,λ)=a+λ1 ∀a ∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(“J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules E, over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any q∈F*ₓ, η/⁼0, the principal symbol σ_{D}(x; n) 6 Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞} (G, Ω^{1/2})=J of the foliation. To be more precise let us fix for convenience a smooth nonvanishing 1-density along the leaves and drop the Ω's from the notation. Then to D corresponds a distribution section D∈C_{c}^{∞} (G, s*(E*₁)⊗r*(E₂)) with support on G⁽⁰⁾. To the quasi-inverse Q of D corresponds a section Q∈C_{c}^{∞} (G, s*(E*₂)⊗r*(E₁)). The quasi-inverse property is then the following QD−1_{E1}∈C_{c}^{∞}(G, s*(E*₁)⊗r*(E₁)) DQ− 1_{E2}∈C_{c}^{∞}(G, s*(E*₂)⊗r*(E₂)) where 1_{Ei} corresponds to the identity operator C^{∞}(V,E₁)→C^{∞}(V,Eᵢ). Now the algebra J=C_{c}^{∞}(G) is a two-sided ideal in the larger A, the algebra under convolution of distributions T∈C_{c}^{∞}(G) which are multipliers of C_{c}^{∞}(G), i.e. satisfy T*f∈C_{c}^{∞}(G) and f·T∈C_{c}^{∞}(G), for any f∈C_{c}^{∞}(G). Thus, neglecting the bundles E₁ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜}is the algebra obtained by adjoining a unit to J, that is, J^{˜}={(a,λ);a∈J,λ∈C},and s(a,λ)=λ V(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}Eᵢ→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of Eᵢ⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜}the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.(3 Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j.(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S¹ be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V∘one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V∘/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)¹ of i_{*}(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V ×Rⁿ given by ϕ(x,ξ)=(x,i(x)+ξ) ∀x∈V, ξ∈vₓ=(i_{*}(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i_{*} on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{εl}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class a(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, tracer on C*(V,F) and hence an additive map trace_{∧}: K(C*(V,F))→R. The reason why trace_{∧}∘ Indₜ is much easier to compute than trace_{∧}∘ Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧} K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ : K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧} : K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧} : K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane let x, y be two solutions to the system, does prove that any the probability mathematically add up to 1=λx+λx+(1−λy) with ∀∈|0, 1| also is A solution to the system, or having exponents the exponential function e^{x}, and the sum of the first n+1 terms of its Taylor series, and the properties of π=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let A_{Θ}be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=x(a)id_{AΘ}, we have that τ is a faithful α-invariant trace. In fact it is the unique such trace. Proof. If τ₀ is any other such trace, then τ₀(a)id_{AΘ}=∫ αₜ(τ₀(a))dt=τ₀(∫αₜ(a))=τ₀τ(a)id_{AΘ})=τ(a) and the conclusion follows. For a left R-module M, the so-called “character module” M+=Hom_{z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semi perfect rings, Flat modules 2000 Mathematics Subject Classification: 16D40; 16L30. Let M be a module. A δ-cover of M is an epimorphism from a module F onto M with a δ-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ : C→M, where C∈F, is called an F-cover of M if the following properties are satisfied: 1) For any morphism ψ: C′→M, where C′∈F, there is a morphism A: C′→C such that ϕoψ=ψ, and 2) if μ is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where Γ is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconductor the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖ([)ₖ=(PF)ₖG\hat{ }ϕₖ=(PF)ₖgₖϕₖ-Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖ<t)ₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type II_{∞}, one writes mod Θ for the unique λ∈R*₊such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] :mod Θ=1⇒μ₀=0, [symbol] =1; μ₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧ . Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ} , and 2) the formal “metric” dUdU* +dVdV*∈Ω²+(A_{Θ}). We shall now give a thorough description of all the finitely generated projective modules over A_{Θ}and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W x K^{p}; Zₚ)→H* (W x K; Zₚ the map induced by the diagonal d: K→K^{p}. 4. 1 Lemma. Let τ: H*(W⊗K^{p}; Zₚ) H*_{π}: (W⊗K^{p}; Zₚ) denote the transfer. Then d*τ=o. Proof. We have a commutative diagram [1] H*(W⊗K^{p}; Zₚ) τ→H*_{π}(W⊗K^{p}; Zₚ); [2] H*_{π}(W⊗K; Zₚ)i*→H*(W⊗K; Zₚ) τ→H*_{π}(W⊗K; Zₚ). [3] H*(W⊗K^{p}; Zₚ) d*→H*(W⊗K; Zₚ) [4] H*_{π}(W⊗K^{p}; Zₚ) d*→H*_{π}(W⊗K; Zₚ). § 4. The Transfer. Since W is acyclic and H⁰_{π}(W; Zₚ) H⁰ (W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H⁰(W⊗K^{p}; Zₚ) then d*P is a homomorphism. Proof. Let u and v be q-cocycles on K. Then P(v+u)−Pu−Pv is given by the chain map W⊗K^{P ε⊗1}→K^{P (u+v)p-uP-vP}→Z^{p}. According to 4.1, we need only show that this cocycle is in the image of the transfer. It will be sufficient to show that (u+v)^{p}−u^{p}−v^{p} is in the image of a cocycle under x: C*(K^{p}; Zₚ)→C*ₙ(K^{p}; Zₚ) since ε⊗1 is an equivariant map. Now (u+v)^{p}−u^{p}−v^{p} Is the sum of all monomials which contain k factors u and (p−k) factors v, where 1≤k≤p−1. Now n permutes such factors freely. Let us choose a basis consisting of monomials whose permutations under π give each monomial exactly once. Let z be the sum of the monomials in the basis. Then τz=(u+v)^{p}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c ∈R real-valued power series. (We refer to) “Cohomology Operations Lectures By N. E. Steenrod Written And Revised By D. B. A. Epstein”. “The lemma follows by comparing coefficients of Wₖ”. “4.7. Lemma. Let u∈H^{r}(K;Zₚ) and v∈H^{S}(L;Zₚ). If p >2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{p})→(π×π , Zₚ,K^{p}×L^{p}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W×W x K×L;Zp)≈H*(W/π×W/π×K×L;Zp). It is easy to see that under this isomorphism we have by 3.2 (d′)*(Pu×Pv)=Σ_{j,l} (−1)^{l(pr-j)} wⱼX wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×Dⱼu×Dₗv. Also d* P(U×v)=Σₖ Wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀l/n!xⁿ=1+x+1/2x²+1/6x³+1/24x⁴+ . . . , ^{∞}Σₙ₌₀(n!)xⁿ=1+x+2x²+6x³+24x⁴+, ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−1/2(x−1)²+1/3(x−1)³−1/4(x−1)⁴+ . . . 2.0 homogeneous polynomials F2k, k=2, . . . , n−2, of degree k such that 1-12k=H2F2k_2 closed-chain equivariant translation-banded A class of C*-algebras and topological Markov chains power series expansion. Incipient p-wave PF power transmission superconductor the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕₖ=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Ik Cₖϕₖ. It's then easy to prove that the previous relation PF\hat{ }G\hat{ }f=G\hat{ }PF\hat{ }f is valid for any function f Lemma 3.8.16. Let f:[0,1] R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}>(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F: R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules E, over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞} (G, Ω^{1/2})=J of the foliation, a period of some isolated points such as for any number ϵ>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞} (G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, y The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let Eᵢ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞} (G,Ω^{1/2})=J of the foliation. To be more precise let us fix for convenience a smooth nonvanishing 1-density along the leaves and drop the Ω's from the notation. Then to D corresponds a distribution section D G C_{c}^{-∞}(G, s*(E*₁)⊗r*(E₂)) with support on G⁽⁰⁾. To the quasi-inverse Q of D corresponds a section Q∈C_{c}^{∞}(G, s*(E*₂)⊗r*(E₁)). The quasi-inverse property is then the following QD−1_{E1}∈C_{c}^{∞}(G, s*(E*₁)⊗r*(E₁)) DQ −1_{E2}∈C_{c}^{∞}(G, s*(E*₂)⊗r*(E₂)) where I_{Ei} corresponds to the identity operator C^{∞}(V,E₁)→C′(V,E₁). Now the algebra J=C_{c}^{∞}(G) is a two-sided ideal in the larger A, the algebra under convolution of distributions T∈C_{c}^{∞}(G) which are multipliers of C_{c}^{∞}(G), i.e. satisfy T·f∈C_{c}^{∞}(G) and f·T∈C_{c}^{∞}(G), for any f∈C_{c}^{∞}(G). Thus, neglecting the bundles E₁ for a while, the existence of Q means that D yields an invertible element of A/J. It is, however, not always possible to find a representative D⁰∈A of the same class, i.e. D₀∈D+J, which is invertible in A. The obstruction to doing so is an element of the K-theory group K₀(J), as follows from elementary algebraic K-theory. We shall, however, recall in detail the construction of this obstruction Ind(D) ∈K₀(J), since this allows us to take the bundles Eᵢ into account. α Construction of Ind(D)∈K₀(J). Let J be a non-unital algebra over C, and define K₀(J) as the kernel of the map K₀(J)→^{ε}*K₀(C)=Z where J is the algebra obtained by adjoining a unit to J, that is, J^{˜}={(a,λ);a∈J,λ∈C},and ε(a,λ)=λ ∀(a,λ)∈J.^{˜}(For a unital algebra K₀ is the group associated to stable isomorphism classes of finite projective modules viewed as a semigroup under direct sum.) Let A be a unital algebra (over C) containing J as a two-sided ideal, and let j: A→A/J=λ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}Eᵢ→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of Eᵢ⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)_{*}E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.(3 Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j_{*}(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class OD ∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the E-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences. [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V∘/F⁰ is the obvious 'etale map, but we do not need this equality (except as notation) to define e!. The main point in the construction of the topological index Indₜ is that an embedding i: V→Rⁿ allows one to consider the normal bundle ν=i_{*}(F)^{⊥} of i_{*}(F) in Rⁿ as a manifold N, transversal to the foliation of V∘=V×Rⁿ by the integrable bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V ×Rⁿ given by ϕ(x,ξ)=(x,i(x)+ξ) ∀x∈V, ξ∈vₓ=(i_{*}(F×))^{⊥}, and check that on a small enough neighborhood N of the 0-section in v the map ϕ : N→V⁰ is transverse to F⁰. It is enough to check this transversality on the 0-section V⊂v where it is obvious, and only uses the injectivity of i. on F⊂TV. Theorem 6. Let (V,F) be a compact foliated manifold, D a longitudinal elliptic differential operator. Let i: V→Rⁿ be an embedding, let v=(i_{*}(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p_{∘}π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘ Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, c>is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧} : K*(C*(V,F))7→R is equal to 0, so in particular dim_{∧}is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C′(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate z-plane tangent to S at P and we then define the second fundamental form in the same way. Shape object plane complete metric space property, and number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k<d −1, is there a d-polytope that can not be realized with all its k-faces tangent to a sphere? Leaving aside the trivial cases of d<2, he constructed non-k-scribable examples for all the cases except for d=3 and k=1, i.e. 3-polytopes that are not edge-scribable. Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. (N+1)-dimensional n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions, and the affine function of hyperbola we establish the wedge product is the product in an exterior algebra. If α and β are differential k-forms of degrees p and q, respectively, then α∧β=(−1)^{pq} β∧α. And is associative, (α∧β) A p=α∧(β ∧μ), and bilinear (c₁ a₁+c₂a₂)∧β=c₁ (a₁∧β)+c₂ (a₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁ ∧ . . . ∧eᵢₚ)∧(eⱼ₁ ∧ . . . ∧e_{jq})=eᵢ₁ ∧ . . . ∧eᵢₚ ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄) A (e₃∧e₄)=0+e₁∧e₂∧e₃∧e₄+e₃∧e₄ ∧e₁∧e₂+0=2 e₁∧e₂∧e₃∧e₄. If α₁, . . . , αₖ have degree one, then they are linearly independent iff α₁∧ . . . ∧aₖ≠0. A hyperbola with a horizontal transverse axis and center at (h, k) has one asymptote with equation y=k+(x−h) and the other with equation y=k −(x−h). The set of D in the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d ≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by p. Madras [J. Statist. Rhys. 78 (1995) no. 3-4, 681-699] has shown that pₙμ⁻ⁿ≤Cn^{1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ} ,A_{Θ}0 are Morita equivalent (cf. D. Ruelle and D. Sullivan. Currents, flows and diffeomorphisms. Topology 14). We also consider a certain variant of self-avoiding walk and argue that, when d ≥3, an upper bound of n−2+d−1+o(1) holds on a full density set for the counterpart in this variant model of this normalized polygon cardinality element particle physics we consider. higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F) ≥1−ε/2. Now express each set A∈V^{m-1}₀T⁻ⁱ P/F⁻ as A₁ ∪A₂, A₁∩A₂=ϕ, μ(A₁)=μ(A₂), and put (m/2)−1 (m/2)−1 FA=[T2iA1 ∪[T2i−1A2 ᵢ₌₀ i=1. Clearly, F_{A} and TF_{A} are disjoint. We now let F be the union of the sets F_{A}, A∈V^{m-1}₀T⁻¹ P/F⁻. It follows that F∩TF=ϕ , and that F∪TF is all of ∪^{m-1}ᵢ₌₀ Tⁱ F⁻, TⁱF⁻, 0≤i≤m−1. Thus if m is large enough, μ(F∪TF) will be at least 1−ε . This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=t₁, −m≤i≤n} where tᵢ, −m≤i≤n, is some fixed finite sequence in {1, 2, . . . , k}. Let E denote the o-algebra generated by the cylinder sets. There is then a unique measure p defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)→G) the skew-Hermitian R-module (H^{ϕ}₁(F_{g},★), [symbol] ⋅,⋅ [symbol] ₛ) where ★∈∂F_{g} and [symbol] ⋅,⋅ [symbol] ₛ: H^{ϕ}₁(F_{g},★)×H^{ϕ}₁(F_{g},★)→R is a version of the equivariant intersection form with coefficients in R twisted by ϕ. At the level of morphisms, Mag assigns to any cobordism (M,ϕ) between {F_{g-},ϕ₋) and (F_{g+},ϕ₊) the (closure of) the kernel of the R-linear map (−m₋)⊗m₊: H^{ϕ}₁⁻(F_{g-},★)⊗H^{ϕ}₁⁻(F_{g+},★)→H^{ϕ}₁(M,★) induced by the inclusions m_{±}: F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category pLag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Σ[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of μ(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0,1] which identifies any pairs (x,ε) and (y,ε) provided ε≥0.5.β The Ruelle-Sullivan cycle and the Euler number of a measured foliation. By a measured foliation we mean a foliation (V,F) equipped with a transverse measure ∧. We assume that F is oriented and we let C be the current defining A in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where I is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*_{,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim_{∧} is identically 0, submitting K(C*(V,F))→R is equal to 0, so in particular dim_{∧} is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n I in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c ∈Z^{2q}(Γ,C). Then by Section 2 [symbol] ) one has (3.36) [symbol] (c)=t_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*}([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞} (G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group r is chosen discrete and cocompact in such a way that V is a homology 3-sphere is our Euclidean centered group for calibration and control R³ subspace, the operator PF\hat{ } , that obeys the following rules: PF\hat{ } ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕ k=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ: S,→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ Gₓ, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞} (G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4, 1, 4, 1, 3, 0, . . . ] the minimal carrier of τ consists of simplexes all of which have X₁ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x ∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+1Pₙ+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁ D . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2_{q} in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group T is chosen discrete and cocompact in such a way that V is a homology 3-sphere is our Euclidean centered group for calibration and control R³ subspace, the operator PF\hat{ } , that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ } , G\hat{ }]ϕk=0. Now, to state that [PF\hat{ } , G\hat{ }]=0, we need to prove that [PF\hat{ } , G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S². Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁ x [0,1], h) and (S₂ x [0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to y to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)_{∘}(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+1/2(1+1/3(0+1/4(1+1/5(4+1/6(1+1/7(4+1/8(1+1/9(3+1/10(0+) . . . )))))))) or in the shorthand notation [0; 0,1, 0, 1, 4,1, 4, 1, 3, 0, . . . ] the minimal carrier of τ consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c ∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=Ui≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let A be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 11]∈SL(2, R) of the manifold V=SL(2,R)/Γ, where the group I” is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖϕₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Ω²=1, Θ/∈InnR, are pairwise conjugate. The simplest realization of the symmetry s¹₂ consists in taking the automorphism of R⊗R that transforms x⊗y into y⊗x for all x,y G R. For μ₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that Θ be outer conjugate to the automorphism 1 ⊕S^{y}ₚ of M⊗R for suitable p and [symbol] , it is necessary and sufficient that p₀(Θ)=pₐ(Θ). Moreover, for Θ∈AutM to be outer conjugate to Θ⊗s, ∈Aut(M⊗R), it is necessary and sufficient that q divide the asymptotic period pₐ(Θ). In particular, every automorphism Θ of M is outer conjugate to Θ⊗1. These results demonstrate the interest of the invariant i-C x(M)=Inn M∩Ct M/Inn M, which made it possible ([87]) to show the existence of a factor of type 111 not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖ iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, e a positive number, and P a partition, then there is a set F such that F, TF, . . . , Tⁿ⁻¹F is a disjoint sequence, μ(∪ⁿ⁻¹ᵢ₌₀ Tⁱ F) ≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and iₖϕₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, e a positive number, and P a partition, then there is a set F such that F, TF, . . . , Tⁿ⁻¹F is a disjoint sequence, μ(∪ⁿ⁻¹ᵢ₌0 Tⁱ F) ≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈X. 2) For i=0, the restriction of T to X₀ is aperiodic, i.e. card{T^{j}x}=∞∀x∈X₀. We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heterodinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group T is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧ : K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H) ∈I. Let the exact sequence K₀(I)→K₀(R)→K₀(R/I) where K₀(I) is defined as follows: adjoined unit by ring structure I^{˜}, which has some K-theory K₀(I). There is a map K₀(I)→K₀(k)≅Σ. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by T_{π} for convenience we shall use the indexing {0,1}, rather than {1,2}; that is, X will be the set of all 2-form infinite sequences of zeros and ones. Given x G X, we construct the point (s(x),t(x)) in the unit square (using binary digits) s(x)=.x₀x₁x₂ . . . and t(x)=,x₋₁ x₋₂x₋₃ . . . . The mapping x (s(x),t(x)) is easily seen to be 1-1 structure of the Dual Algebra the monomials ε^{I′}in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and p into Lebesgue measure on the unit square. Also, s(Tx)=,x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧ : K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I). There is a map K₀(I)→K₀(k)≅Σ. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steen rod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {2} Let the Bernoulli shift with distribution π and denoted by T_{π} for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=,x₋₁ x₋₂x₋₃ . . . . The mapping x→(s(x),t(x)) is easily seen to be 1-1 structure of the Dual Algebra the monomials ε¹ in a′ correspond in a one-to-one way with sequences of non-negative integers (i₁, i₂, . . . , iₙ, 0, . . . ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀1X₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class Σ onto the class of Lebesgue sets and p into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+P_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. (We refer to) “Uₚ to a shift of parity, the geometric group K*_{,τ}(BG) is the K-theory group K*⁺¹(V). The projection p:V →V/F is naturally K-oriented and the following maps from K*(V) to K(C*(V,F)) coincide: 1) p! (cf. Theorem) which, up to the Thom isomorphism, K*(F)K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map p! and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−1/2x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where S₁ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0,1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫_{y1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂×[0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁ G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wk concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G^{,0)}={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xi as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). We can choose our column configuration as desired taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]).(3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(Ft) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented: The boundary of W∪S₁ W′ is S₀ [symbol] S₂. Since g and g′ agree on Sᵢ, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂×[0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀ G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G; Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0,1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤τ₁≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable [symbol] complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] *([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] Sᵢ, g₀ [symbol] gᵢ) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on Sᵢ, they induce a map g∪g′:W∪S₁ W′→X, whose restriction to S₀ is go and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂×[0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of T consists of simplexes all of which have X, as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle (The Longitudinal Index Theorem for Foliations A. Connes* and G. Skandalis** 1983). We let the formal power series Bernoulli shift with distribution π and denoted by T_{π} {1} Two columns of equal width; and {2} Two columns of equal width:=four {4×4 columns}. E a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). We find the generating function F(x):=f(x) for x∈[0,1] and F(x):=0 for x∉[0,1] nondegenerate 2-form structure in potential theory complex analysis proves invaluable mathematical physics expressions an infinite potential one {1×1 column}. For Arnold's Theorem (f∘g)(X) polynomials for f a real polynomial in x, and for any a in such an algebra define f(a) to be the element of the algebra resulting from the obvious substitution of a into f. Then for any two such polynomials f and g, we have that (fg)(a)=f(a)g(a). Power-associative are the submagma generated by any element is associative semigroup, it is associative herewith with the identity, x·yz≡xy·z. Let D 4 the step path generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path pairwise conjugate of the symmetry s¹₂ the step size of our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively D 4==• . . . =^{D}_{2N-2=0}: under theorem there exist homogeneous polynomials F2k, k=2, . . . , n−2, of degree k such that 1−12k=H2F2k_2 closed-chain equivariant translation-banded A class of C*-algebras and topological Markov chains power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. Following a construction of Frohman, C. D.; Nicas, A. (1991) which involves moduli spaces of flat U(1)-connections A module is called a uniform module if every two nonzero submodules have nonzero intersection at the initial phase of the motion 1n+1, the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of a closed subspace of ∪ called the n-isotypic component of ∪; or the set ∪ₙ of ∪ₙs for a normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point of an open subspace of ∪ called the n-isotypic component of ∪ we set the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steen rod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2}Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l}(−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼwₗ×Dⱼu×Dₗv. Also d*P(U×v)=Σₖwₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1] R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λεC. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q]. Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D))″, The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ₀(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D∈C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1E₂∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C}, and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α_{*}∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]-[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, Sᵢ=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥} of i*(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i*(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i*(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map pi and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate [symbol] -plane tangent to S at P and we then define the second fundamental form in the same way. Shape object plane let x, y be two solutions to the system, does prove that any the probability mathematically add up to 1=λx+λx+(1−λy) with λ∈|0,1| also is A solution to the system, or having exponents the exponential function e^{x}, and the sum of the first n+1 terms of its Taylor series, and the properties of n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=αₜ(τ₀(a))dt=τ₀ (∫αₜ(a))=τ₀ τ(a)id_{AΘ})=τ(a) and the conclusion follows. For a left R-module M, the so-called “character module” M+=Hom_{Z}(M,Q/Z) is a right R-module that exhibits an interesting duality, not between injective modules and projective modules, but between injective modules and flat modules (Enochs & Jenda 2001, pp. 78-80). We use flat module, or rings over which every module has a flat δ-cover; and We investigate here some of the properties of flat δ-covers and flat modules having a projective δ-cover: δ-covers; δ-perfect rings; δ-semiperfect rings, Flat modules 2000 Mathematics Subject Classification: 16D40; 16L30. Let M be a module. A δ-cover of M is an epimorphism from a module F onto M with a δ-small kernel. A δ-cover is said to be a flat δ-cover in case F is a flat module. We study rings over which every module has a flat δ-cover and call them right generalized δ-perfect rings. We also give some characterizations of δ-semiperfect and δ-perfect rings in terms of locally (finitely, quasi-, direct-) projective δ-covers and flat δ-covers. Let R be a ring and F be a class of R-modules. Due to Enochs & Jenda [9], for an R-module M, a morphism ϕ: C→M, where C∈F, is called an F-cover of M if the following properties are satisfied: 1) For any morphism ψ: C′→M, where C′∈F, there is a morphism λ: C′→C such that ϕoλ=ψ, and 2) if μ is an endomorphism of C such that ϕoμ=ϕ, then μ is an automorphism of C. If F is the class of projective modules, then an F-cover is called a projective cover. This definition is in agreement with the usual definition of a projective cover. If F is the class of flat modules, then an F-cover is called a flat cover. On the other hand, we deal with flat covers in the following sense: Let M be an R-module. A flat cover of M is an epimorphism f:F→M with a small kernel, where F is a flat module. Rings over which every module has a flat δ-cover by Pinar Aydo\check{g}du Department of Mathematics, Hacettepe University 06800 Beytepe Ankara, Turkey arXiv:1107.0938v1 [math.RA] 5 Jul. 2011. The lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconducter the operator PF\hat{ }, that obeys the following rules: PF\hat{ }ϕₖ=Pϕₖ, for k=1, 2, 3 PF\hat{ }(f)₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊ such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] :mod Θ=1⇒μ₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steen rod Written And Revised By D. B. A. Epstein”. “§ 4. The Transfer. We have defined the transfer in V § 7. Let d*:H* (W×K^{P}; Zₚ)→H*(W×K; Zₚ the map induced by the diagonal d: K→K^{P}. 4. 1 Lemma. Let τ: H*(W⊗K^{P}; Zₚ)→H*_{π}: (W⊗K^{P}; Zₚ) denote the transfer. Then d*τ=o. Proof. We have a commutative diagram [1] H*(W⊗K^{P}; Zₚ) τ→H*_{π}(W⊗K^{P}; Zₚ); [2] H*_{π}(W⊗K; Zₚ)i*→H*(W⊗K; Zₚ) τ→H*_{π}:(W⊗K; Zₚ). [3] H*(W⊗K^{P}; Zₚ) d*→H*(W⊗K; Zₚ) [4] H*_{π}(W⊗K^{P}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{P}; Zₚ) then d*P is a homomorphism. Proof. Let u and v be q-cocycles on K. Then P(v+u)−Pu−Pv is given by the chain map W⊗K^{P∈⊗1}→K^{P (u+v)p-uP-vP}→Z^{p}. According to 4.1, we need only show that this cocycle is in the image of the transfer. It will be sufficient to show that (u+v)^{p}−u^{P}−v^{P} is in the image of a cocycle under τ: C′(K^{p}; Zₚ)→C*_{π}(K^{p}; Zₚ) since ε⊗1 is an equivariant map. Now (u+v)^{P}−u^{p}−v^{p} Is the sum of all monomials which contain k factors u and (p-k) factors v, where 1≤k≤p−1. Now π permutes such factors freely. Let us choose a basis consisting of monomials whose permutations under π give each monomial exactly once. Let z be the sum of the monomials in the basis. Then τz=(u+v)^{P}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steen rod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼwₗ×Dⱼu×Dₗv. Also d* P(U×v)=Σₖ wₖ×Dₖ (U×v). The lemma follows from 2.6 and V 5.2”. The power series centered at c with coefficients aₙ is the series ^{∞}Σₙ₌₀aₙ(x−c)ⁿ. Power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 closed-chain equivariant translation-banded A class of C*-algebras and topological Markov chains power series expansion. Incipient p-wave PF power transmission superconductor the operator PF\hat{ }, that obeys the following rules: PF\hat{ }ϕₖ=Pϕₖ, for k=1, 2, 3 PF\hat{ }CJ)₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }(j)ₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=r^{(n,m)}>(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules E, over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G, Ω^{1/2})=J of the foliation. To be more precise let us fix for convenience a smooth nonvanishing 1-density along the leaves and drop the Ω's from the notation. Then to D corresponds a distribution section D G C_{c}^{-∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1_{E1}∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,Eᵢ). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{ε}*K₀(C)=Z where J^{˜} is the algebra obtained by adjoining a unit to J, that is, J^{˜}={(a,λ);a∈J,λ∈C},and ε(a,λ)=λ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=∧ be the quotient map. Recall that finite projective modules push forward under morphisms of algebras. Definition 1. Given J⊂A as above, a quasi-isomorphism is given by a triple (E₁,E₂,h), where E₁ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,E₁,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, a(a,λ)=a+λ1 ∀a∈J, λ∈C. Proposition 2. Given J⊂A as above, the map α*∘ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, Sᵢ=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(C_{c}^{∞}(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D)∈K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the f-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥} of i*(F) in Rⁿ as a manifold N, transversal to the foliation of V⁰=V×Rⁿ by the integrase bundle F⁰=F×{0}⊂TV⁰. First note that the bundle ν over V has a total space of dimension d=dimV+n−dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i*(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i*(F))^{⊥} be the normal bundle of I_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C′(V,F)⊗C₀(Rⁿ) The proof easily follows from Theorem 8.3 and the following analogue of Lemma 5.6: Lemma 7. With the notation of Theorem 6, let x=(F,σ(D),p∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘Indₜ is much easier to compute than trace_{∧}∘Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map pi and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧}is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let 4) be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to π/4 and as Γ the group formed by products of an even number of hyperbolic reflections along the sides of T. In order to exploit the results on vanishing or homotopy invariance of the analytic index Indₐwe shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate [symbol] -plane tangent to S at P and we then define the second fundamental form in the same way. Shape object hyperplane complete metric space property, and number in base point k-face element plane the fundamental group we consider the category of pointed topological spaces, i.e. topological spaces with distinguished points straight edges, sharp corners, or vertices is our investigation on k-scribability problems, which we call strong to differentiate from the upcoming weak version, focuses on two important families of polytopes: stacked polytopes and cyclic polytopes. Schulte [Sch87] considered k-scribability problems, higher-dimensional analogues of Steiner's problem: For 0≤k≤d−1, is there a d-polytope that can not be realized with all its k-faces tangent to a sphere? Leaving aside the trivial cases of d≤2, he constructed non-k-scribable examples for all the cases except for d=3 and k=1, i.e. 3-polytopes that are not edge-scribable. Surprisingly, it turns out that, as a consequence of the remarkable Koebe-Andreev-Thurston disk packing theorem, every 3-polytope does have a realization with all the edges tangent to the sphere (see [Zie07, Section 1.3] and references therein). Scribability; Stacked polytopes; Cyclic polytopes; Ball packing. H. Chen is supported by the ERC Advanced Grant number 247029 “SDModels”. A. Padrol's research is supported by the DFG Collaborative Research Center SFB/TR 109 “Discretization in Geometry and Dynamics”. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup FI semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+0(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. This can be exploited to describe explicitly the factor in our affine geometric construction. Continuity equation in physics is an equation that describes the transport of our quantity simple and powerful order applied as our conserved quantity, and is continued apply to our extensive quantity any continuity equation can be expressed in an ‘integral form’ (in terms of a flux integral), which applies to any finite region, and in a ‘differential form’ (in terms of the divergence operator) which applies at a having differentials the flow of a gas through a domain in which flow properties only change in one direction, which we will call X an equilibrium point more explicitly, cycles and cocycles let e(F)∈H^{k}(V,R) be the Euler class of the oriented bundle F on V using the pairing which makes H^{k}(V,R) the dual of the number in base point k-face element plane the fundamental group we consider the category of pointed topological spaces, i.e. topological spaces with distinguished points indecomposable injective modules are the injective hulls of the modules R/p for p a prime ideal of the ring R. Moreover, the injective hull M of R/p has an increasing filtration by modules Mₙ given by the annihilators of the ideals pⁿ, and Mₙ₊₁/Mₙ is isomorphic as finite-dimensional vector space over the quotient field k(p) of R/p to Hom_{R/p}(pⁿ/pⁿ⁺¹, k(p)) finite-dimensional vector space of nondegenerate 2-form structure in potential theory complex analysis proves invaluable mathematical physics expressions an infinite potential n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Let G be a connected Lie group and let A be a strongly continuous action of G on B contain 1. We show that it is sufficient to treat the case V=K. The Koszul complex associated to the operad Trias is the differential functor Tridend ∘ Trias from Vect to Vect it is quasiisomorphic to the identity functor and both equivalently in theorem the homology of the free associative trialgebra on V is HnTrias(Trias(V))=nV if n=1, 0 otherwise. Having conservation and matter relation constraint subspace isotopic class [A] the values of the function f on the isotopy denoted by Infmax_{[A]}f nearby level surface point structure, or solid domain occupies surface point structure “there is an exponential map Mₙ(R)≅glₙ(R) [symbol] X→exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(τX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by D_{X}(b). The collection of all b such that all iterated derivatives always exist is a linear subspace B^{∞} of B, and on this subspace we have (D_{X}D_{Y}−D_{Y}D_{X})(b)=D_{[X,Y]}(b) transfer the ‘twist’ integral rotating reciprocating radial compartment nearby level surface point structure, or solid domain occupies surface point structure *-structure. Let A_{Θ} be the corresponding universal C*-algebra. For every n∈Z^{d} we have a corresponding indicator function which we will denote by Uₙ which satisfies UₘUₙ=c_{Θ}(m,n)Uₘ₊ₙ. There is a dual action αₜ(Uₙ)= [symbol] t,n [symbol] Uₙ where t∈T^{d}. Then there is a conditional expectation E: A_{Θ}→Cid_{AΘ} satisfying E(UₘUₙ)={0 if m≠−n c_{Θ}(m, n)U₀ otherwise Letting E(a)=τ(a)id_{AΘ}, we have that τ is a faithful α-invariant trace. In fact it is the unique such trace. Proof. If τ₀ is any other such trace, then τ₀(a)id_{AΘ}=∫αₜ(τ₀(a))dt=τ₀ (∫αₜ(a))=τ₀ τ(a)id_{AΘ})=τ(a) and the conclusion follows. Proposition 7.2. A_{Θ} has no proper 2-sided α-invariant ideals. Proof. Let J be such an ideal. Then there exists d∈J with d≥0 and d≠0. Furthermore, αₜ(d)∈J for all t, hence E(d)=∫αₜ (d) dt∈J, so id_{AΘ}∈J and J is not proper. Theorem 7.3. The representation π of A_{Θ} on I²(Z^{d}) is faithful, so C*ᵣ(Z^{d}, c_{Θ})=C*(Z^{d},c_{Θ}). Proof. It suffices to show that the kernel of π is α-invariant. Let J be a 2-sided ideal in A_{Θ}. Then for each n∈Z^{d} we have Uₙ(J)U*ₙ=J. Now UₙUₘU*ₙ=c_{Θ-Θt}(n,m)Uₘ; we define ρ_{Θ}(n,m)=c_{Θ-Θt}(n,m). The maps ρ_{Θ}(n,−) can be identified with a subgroup of T^{d}. Let H_{Θ} be the closure of this group. By the strong continuity of a we have αₜ(J)=J for all t∈H_{Θ}. Theorem 7.4. If H_{Θ}=T^{d}, then A_{Θ} is simple. In the case d=2 consider U,V satisfying VU=e^{2πir}UV where r is real. This corresponds to C*(Z²,c_{Θ}) where Θ=[0 r 0 0], If r is irrational then this algebra is simple. What can we say about the center of A_{Θ}? We have UₙUₘUₙ⁻¹=α_{pΘ(n,m)}Uₘ hence Uₘ∈Z(A_{Θ}) if αₜ(Uₘ)=Uₘ for all t∈H_{Θ}. In general a lies in the center iff UₘaUₘ⁻¹=a for all m, hence iff αₜ(a)=a for all t∈H_{Θ}. Let D_{Θ}={m∈Z^{d}: Uₘ∈Z(A_{Θ})}, which is just {m∈Z^{d}: [symbol] m,t [symbol] =1∀t∈H_{Θ}}, which we may also write as H_{Θ}^{⊥}. Let C_{Θ} be the closed subalgebra of A_{Θ} generated by the Uₘ,m∈D₀. Theorem 7.5. C_{Θ}=Z(A_{Θ}). Proof. H_{Θ} is a compact group, so we can equip it with normalized Haar measure. Define Q: A_{Θ} [symbol] a→∫_{HΘ}αₜ(a) dt∈A_{Θ}. Then Q is a conditional expectation onto the center, and Q(Uₘ)=Uₘ for all m∈D_{Θ}. For m∉D_{Θ}, there exists t₀∈H_{Θ} such that [symbol] m,t₀ [symbol] ≠1, so Q(Uₘ)=∫H_{Θ} αₜ(Uₘ) dt=∫H_{Θ} [symbol] m, t [symbol] Uₘdt=0. For any f∈C_{c}(Z^{d}) we therefore have Q(f)⊆C_{Θ}, hence Q(A_{Θ})⊆C_{Θ}. We have C_{Θ}≅C*(D_{Θ})≅C(D_{Θ})≅C(T^{d}/H_{Θ}), which is fairly explicit. Let b be a Banach space and let α be a strongly continuous action of R on B. Given b∈B we can ask whether the limit lim_{τ→0} α_{T}(b)−b/τ exists; if it does, we'll call it D(b). More generally we can replace R with a finite dimensional real vector space V. For v∈V we can consider the action α_{τv} of R and ask whether the directional derivative lim_{τ→} α_{τv}(b)−b/τ exists; if so, we'll call it Dᵥ(b). Fact from Lie theory: every closed connected subgroup of GLₙ(R) is a Lie group. These are the linear Lie groups. Every Lie group is locally isomorphic to a linear Lie group. In fact, for any Lie group G, either there is a discrete central subgroup C such that G/C is linear or there is a linear Lie group G^{˜} and a discrete central subgroup C of G^{˜} such that G/C^{˜}≅G. Example SL₂(R) is linear but not points. Its universal cover SL₂^{˜}(R) is not linear. Example The Heisenberg group {[1 x y 0 1 [symbol] 0 0 1]: x, y, [symbol] ∈R} is linear, but its quotient by the discrete subgroup {[1 0 n 0 1 0 0 0 1]: n∈Z} is not. “There is an exponential map Mₙ(R)≅glₙ(R) [symbol] X→exp(X)∈GLₙ(R) and for any closed connected subgroup G of GLₙ(R) we can set g to be the collection of all X∈glₙ(R) such that exp(τX)∈G for all τ∈R. This is a Lie subalgebra. The exponential map g→G is a diffeomorphism in a neighborhood of 0. The subgroups of G that are locally isomorphic to R are exactly the subgroups τ→exp(τX) for X∈g. Now let G be a connected Lie group and let α be a strongly continuous action of G on B. For each X∈g we can ask whether the limit lim_{τ→0}αₑₓₚ(τX)(b)−b/τ exists, and if so we can denote it by D_{X}(b). The collection of all b such that all iterated derivatives always exist is a linear subspace B^{∞} of B, and on this subspace we have (D_{X}D_{Y}−D_{Y}D_{X})(b)=D_{[X,Y]}(b) hence we have a representation of g”. A semiprime is any integer normalized function of temperature; and pressure correction value of number n is continued as phase factor for any complex number written in polar form (such as re^{iΘ}), the phase factor is the complex exponential factor (e^{iΘ}). 1-1 Structure of the Dual Algebra the monomials ε^{|} in a′ correspond in a one-to-one way with sequences of non-negative integers (i₁, i₂, • • • , iₙ, 0, • • • ) we now find the diagonal in a* non-rotating radial (distributor), rotating radial (distributor), rotating reciprocating radial (distributor) trivially, non-rotating radial pistons (distributor), rotating radial pistons (distributor), or rotating reciprocating radial pistons (distributor) trivially, Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for |B^{→}ₑ. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup z+1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. This can be exploited to describe explicitly the factor in our affine geometric construction. Continuity equation in physics is an equation that describes the transport of our quantity simple and powerful order applied as our conserved quantity, and is continued apply to our extensive quantity any continuity equation can be expressed in an ‘integral form’ (in terms of a flux integral), which applies to any finite region, and in a ‘differential form’ (in terms of the divergence operator) which applies at a having differentials the flow of a gas through a domain in which flow properties only change in one direction, which we will call X an equilibrium point more explicitly, cycles and cocycles let e(F)∈H^{k}(V,R) be the Euler class of the oriented bundle F on V using the pairing which makes H^{k}(V,R) the dual of the number in base point k-face element plane the fundamental group we consider the category of pointed topological spaces, i.e. topological spaces with distinguished points indecomposable injective modules are the injective hulls of the modules R/p for p a prime ideal of the ring R. Moreover, the injective hull M of R/p has an increasing filtration by modules Mₙ given by the annihilators of the ideals pⁿ, and Mₙ₊₁/Mₙ is isomorphic as finite-dimensional vector space over the quotient field k(p) of R/p to Hom_{R/p}(pⁿ/pⁿ⁺¹, k(p)) finite-dimensional vector space of nondegenerate 2-form structure in potential theory complex analysis proves invaluable mathematical physics expressions an infinite potential n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Let x, y be two solutions to the system of all transformations, which preserves the origin and the Euclidean metric, are linear maps. Such transformations Q must, for any x and y, satisfy the object functor category, ∪ is well-defined and unitary or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). Shape object plane singletons have {points {and the entire space Rⁿ is our solution set of an arbitrary possibly, infinite system ≤b_{α}, α∈A α^{T}ₐx≤b_{α}, α∈A of linear inequalities with n unknowns x {the set M={x∈Rⁿ|α^{T}_{α}x≤b_{α}, α∈A} is convex, and their incidence of Euclidean space are shared with affine geometry, (vector field on the generic leaf of a foliation) Hₖ(V,R), we get a scalar χ(F,∧)=he(F),[C]i∈R nondegenerate 2-form structure in potential theory complex analysis proves invaluable mathematical physics expressions an infinite potential finite-dimensional n=2 flat. 1-1 correspond the structure of the Dual Algebra a Euclidean geometry a case of Klein geometry, a theoretical framework including many alternative geometries. The Euclidean group E(n), also referred to as the group of all isometries ISO(n), treats translations, rotations, and reflections in a uniform way, considering them as group actions in the context of group theory, and especially in Lie group theory. These group actions preserve the Euclidean structure. As the group of all isometries, ISO(n), the Euclidean group is important because it makes Euclidean geometry a case of Klein geometry, a theoretical framework including many alternative geometries. The structure of Euclidean spaces—distances, lines, vectors, angles (up to sign), and so on—is invariant under the transformations of their associated Euclidean group. For instance, translations form a commutative subgroup that acts freely and transitively on Eⁿ, while the stabilizer of any point there is the afore mentioned O(n). As the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner product involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ: S,→X are continuous maps, are called bordant if there is a compact (m+1)-dimensional Z/2-oriented regular c-stratifold T, and a continuous map g:T→X such that (∂T, g)=(S₀, g₀)+(Sᵢ, gᵢ). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0,1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0,1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0,1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, and X₁ G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries. The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). The diagram commutes colimits in cohomology D₂ₖ=[0,1] commute one {1×1 column} Incipient p-wave PF power transmission superconductor the operator PF\hat{ }, that obeys the following rules: PF\hat{ }(j)ₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; for every automorphism Θ of a factor N of type ∥_{∞}, one writes mod Θ for the unique λ∈R*₊such that τ∘Θ=λτ for every trace τ on N. For N=R_{0,1}, InnR_{0,1}=Kernel of mod={Θ; Mod Θ=1}. Moreover, CτR_{0,1}=InnR_{0,1}. From this, one deduces: Theorem 16. [91] a) Let Θ₁ and Θ₂ be two automorphisms of R_{0,1}. In order that Θ₁ be outer conjugate to Θ₂, it is necessary and sufficient that mod Θ₁=mod Θ₂, p₀(Θ₁)=p₀(Θ₂), [symbol] (Θ₁)= [symbol] (Θ₂). b) The following are the only relations between mod, p₀ and [symbol] :mod Θ=1⇒p₀=0, [symbol] =1; p₀=0⇒ [symbol] =1. Whereas the case mod Θ=1 reduces to the case treated above, for every λ=16 it follows from [141] and part a) of the above theorem that all of the automorphisms Θ∈AutR_{0,1} with mod Θ=λ are conjugate (not just outer conjugate). This is a remarkable phenomenon; in effect, for λ an integer, one can describe the nature of Θ precisely as a shift on an infinite tensor product of λ×λ matrix algebras. Thus, when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1. Theorem 14. Let E be an arbitrary Hermitian, finitely generated projective module over A_{Θ} and let d be the largest integer such that E=∧^{d} is a multiple of a finitely generated projective module ∧. Then the moduli space of the equivalence classes under U(E) of the compatible connections ∇ on c that minimize the action YM(∇) is homeomorphic to (T²)^{d}/S_{d}, the quotient of the dth power of a 2-torus by the action of the symmetric group S_{d}. This shows that even though we started with the irrational rotation algebra, a fairly irrational or singular datum, the Yang-Mills problem takes us back to a fairly regular situation. We should again stress that the only data used in setting up the Yang-Mills problem are 1) the *-algebra A_{Θ}, and 2) the formal “metric” dUdU*+dVdV*∈Ω²₊(A_{Θ}). We shall now give a thorough description of all the finitely generated projective modules over A_{Θ} and of the actual connections that minimize the action YM. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], 1987], The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof μ₀ magnetic constant of permeability, vacuum theory chamber mechanics control in high-vacuum permeability μ₀=4π×10⁻⁵ H/m, magnetic constant of permeability equivalently construction of powers proof the static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point construction of powers proof in high-vacuum permeability μ₀=4π×10⁻⁷ newtons in amperes² (N/A²), the reciprocal of magnetic permeability is magnetic reluctance in SI units, H/m magnetic constant of permeability of free space relative permeability of vacuum μᵣ=1 with reference to a fixed point p known as the base point of construction is unity. (We refer to) “Cohomology Operations Lectures By N. E. Steenrod Written And Revised By D. B. A. Epstein”. “§ 4. The Transfer. We have defined the transfer in V § 7. Let d*:H* (W×K^{P}; Zₚ)→H* (W×K; Zₚ the map induced by the diagonal d: K→K^{P}. 4. 1 Lemma. Let τ: H*(W⊗K^{P}; Zₚ) H*_{π}: (W⊗K^{P}; Zₚ) denote the transfer. Then d*τ=o. Proof. We have a commutative diagram [1] H*(W⊗K^{P}; Zₚ) τ→H*_{π}(W⊗K^{P}; Zₚ); [2] H*_{π}(W⊗K; Zₚ)i*→H*(W⊗K; Zₚ) τ→H*_{π}(W⊗K; Zₚ). [3] H*(W⊗K^{P}; Zₚ) d*→H*(W⊗K; Zₚ) [4] H*_{π}(W⊗K^{P}; Zₚ) d*→H*_{π}(W⊗K; Zₚ). § 4. The Transfer. Since W is acyclic and H⁰_{π}(W; Zₚ)→H⁰(W; Zₚ) is onto, i*:Hⁿ_{π}(W⊗K; Zₚ)→Hⁿ(W⊗K; Zₚ) is also onto. By V 7.1 τi*=o. The lemma follows. 4.2. Lemma. If π is the group of cyclic permutations and P: H^{q}(K; Zₚ)→H^{pq}_{π}(W⊗K^{P}; Zₚ) then d*P is a homomorphism. Proof. Let u and v be q-cocycles on K. Then P(v+u)−Pu−Pv is given by the chain map W⊗K^{Pε⊗1}→K^{P (u+v)p-uP-vP}→Z^{p}. According to 4.1, we need only show that this cocycle is in the image of the transfer. It will be sufficient to show that (u+v)^{p}−u^{P}−v^{P} is in the image of a cocycle under τ: C*(K^{p}; Zₚ)→C*_{π}(K^{p}; Zₚ) since ε⊗1 is an equivariant map. Now (u+v)^{P}−u^{p}−v^{p} Is the sum of all monomials which contain k factors u and (p-k) factors v, where 1≤k≤p−1. Now π permutes such factors freely. Let us choose a basis consisting of monomials whose permutations under π give each monomial exactly once. Let z be the sum of the monomials in the basis. Then τz=(u+v)^{P}−u^{p}−v^{p}. Also z is a cocycle in K^{p} since each monomial is a cocycle. The lemma follows”. The cohomology groups of spaces which commute with the homomorphism induced by a continuous commute with all cohomology operations to a construction of Frohman, C. D.; Nicas, A. (1991) which involves moduli spaces of flat U(1)-connections A module is called a uniform module if every two nonzero submodules have nonzero intersection at the initial phase of the motion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H*_{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×Dⱼu×Dₗv. Also d*P(U×v)=Σₖ wₖ×Dₖ (U×v). The lemma follows from 2.6 and V 5.2”. The power series centered at c with coefficients aₙ is the series ^{∞}Σₙ₌₀ aₙ(x−c)ⁿ. Power series centered at 0: ^{∞}Σₙ₌₀ xⁿ=1+x+x²+x³+x⁴+ . . . , ^{∞}Σₙ₌₀/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 closed-chain equivariant translation-banded A class of C*-algebras and topological Markov chains power series expansion. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }(j)ₖ=gₖPF\hat{ }ϕₖ=gₖ(PF)ₖ(f)ₖ (where (PF)ₖ=P for k=1, 2, 3 and =F for k=4. We also have G\hat{ }PF\hat{ }ϕₖ=G\hat{ }(PF)ϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Meromorphic D a period of some isolated points P(s) is the prime zeta function, and [S] is an Iverson bracket Riemannian manifold of nonnegative curvature there is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem holmorphic to numbers in the proposition coherence rule central to numbers (N) theory of a matrix system The Real and Complex Hermitian Solutions to a System of Quaternion Matrix Equations with Applications by Shao-Wen Yu B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)). It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*(E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, Sᵢ=1−DQ one gets e=[1−S²₁ (S₁+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. Q for D modulo the algebra C_{c}^{∞}(G, Ω^{1/2})=J of the foliation, a period of some isolated points such as for any number ∈>0 it is possible to find a period wᵥ, if p=1, the non-degenerate Abelian functions are elliptic functions of one complex variable, let S be a dense subset of L (countable if A is separable). We obtain an inverse Q for D modulo the algebra C_{c}^{∞}(G, Ω^{1/2})=J of the foliation, an element D of A which is invertible modulo J determines the quasi-isomorphism (A,A,j(D)) “. The non-degenerate Abelian functions are elliptic functions (we refer to) [symbol] The Longitudinal Index Theorem for Foliations. Proposition p=1, the non-degenerate Abelian functions are elliptic functions of one complex variable (we refer to) “the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group”. (We refer to) “Let (V,F) be a compact foliated manifold. Let E₁ and E₂ be smooth complex vector bundles over V, and let D: C^{∞}(V,E₁)→C^{∞}(V,E₂) be a differential operator on V from sections of E₁ to sections of E₂. Let us make the following hypotheses: 1) D restricts to leaves, i.e. (Dξ)ₓ depends only upon the restriction of ξ to a neighborhood of x in the leaf of x. 2) D is elliptic when restricted to leaves, so that, for any η∈F*ₓ, η/⁼0, the principal symbol σ_{D}(x,η)∈Hom(E_{1,x},E_{2,x}) is invertible. In any domain of a foliation chart U=T×P the operator D appears as a family, indexed by t∈T, of elliptic operators on the plaques Pₜ. One can then use the local construction of a parametrix for families of elliptic operators and patch the resulting operators by using a partition of unity in V subordinate to a covering (Uⱼ) by domains of foliation charts. What one obtains is an inverse Q for D modulo the algebra C_{c}^{∞}(G,Ω^{1/2})=J of the foliation. To be more precise let us fix for convenience a smooth nonvanishing 1-density along the leaves and drop the Ω's from the notation. Then to D corresponds a distribution section D∈C_{c}^{∞}(G, s*(E*₁)⊗r*(E₂)) with support on G⁽⁰⁾. To the quasi-inverse Q of D corresponds a section Q∈C_{c}^{-∞}(G, s*(E*₂)⊗r*(E₁)). The quasi-inverse property is then the following QD−1E₁∈C_{c}^{∞}(G, s*(E*₁)⊗r*(E₁)) DQ−1_{E2}∈C_{c}^{∞}(G, s*(E*₂)⊗r*(E₂)) where 1_{Ei} corresponds to the identity operator C^{∞}(V,Eᵢ)→C^{∞}(V,E₁). Now the algebra J=C_{c}^{∞}(G) is a two-sided ideal in the larger A, the algebra under convolution of distributions T∈C_{c}^{-∞}(G) which are multipliers of C_{c}^{∞}(G), i.e. satisfy T*f∈C_{c}^{∞}(G) and f*T∈C_{c}^{∞}(G), for any f∈C_{c}^{∞}(G). Thus, neglecting the bundles Eᵢ for a while, the existence of Q means that D yields an invertible element of A/J. It is, however, not always possible to find a representative D⁰∈A of the same class, i.e. D⁰∈D+J, which is invertible in A. The obstruction to doing so is an element of the K-theory group K₀(J), as follows from elementary algebraic K-theory. We shall, however, recall in detail the construction of this obstruction Ind(D)∈K₀(J), since this allows us to take the bundles Eᵢ into account. α Construction of Ind(D)∈K₀(J). Let J be a non-unital algebra over C, and define K₀(J) as the kernel of the map K₀(J^{˜})→^{e}*K₀(C)=Z where J^{˜} is the algebra obtained by adjoining a unit to J, that is, J^{˜}={(a,λ);a∈J,λ∈C},and ε(a,λ)=λ ∀(a,λ)∈J.^{˜} (For a unital algebra K₀ is the group associated to stable isomorphism classes of finite projective modules viewed as a semigroup under direct sum.) Let A be a unital algebra (over C) containing J as a two-sided ideal, and let j: A→A/J=λ be the quotient map. Recall that finite projective modules push forward under morphisms of algebras. Definition 1. Given J⊂A as above, a quasi-isomorphism is given by a triple (E₁,E₂,h), where Eᵢ and E₂ are finite projective modules over A and h is an isomorphism h: j_{*}E₁→j_{*}E₂. Any element D of A which is invertible modulo J determines the quasi-isomorphism (A,A,j(D)). A quasi-isomorphism is called degenerate when h comes from an isomorphism T: E₁→E₂. There is an obvious notion of direct sum of quasi-isomorphisms, and a simple but crucial lemma shows that the direct sum (E₁,E₂,h)⊕(E₂,Eᵢ,h⁻¹) is always degenerate. More explicitly, let D∈Hom_{A}(E₁,E₂) and Q∈Hom_{A}(E₂,E₁) be such that j(D)=h and j(Q)=h⁻¹. Then the matrix T=[D+(1−DQ)D DQ−1 1−QD Q] defines an isomorphism of E₁⊕E₂ with E₂⊕E₁ such that j(T)=[h 0 0 h⁻¹]. It follows that quasi-isomorphisms modulo degenerate ones form a group which, as we shall see now, is canonically isomorphic to K₀(J) independently of the choice of A. Let us first consider the special case A=J^{˜}. Then the exact sequence 0→J→J^{˜}→^{ε}C→0 has a natural section r: C→J^{˜}, ε∘r=id. Thus for any finite projective module E over J^{˜} the triple (E,(r∘ε)*E,id) is a quasi-isomorphism, which we denote ρ(E). Now, let A be arbitrary, and let α be the homomorphism α: J^{˜}→A, α(a,λ)=a+λ1 ∀a∈J, λ∈C. Proposition 2. Given J⊂A as above, the map α*∘ ρ is an isomorphism from K₀(J) to the group of classes of quasi-isomorphisms modulo degenerate ones. The proof follows from the computation ([391]) of the K-theory of the fibered product algebra {(a₁,a₂)∈A×A;j(a₁)=j(a₂)}. Given a quasi-isomorphism (E₁,E₂,h) we shall let Ind(h)∈K₀(J) be the associated element of K₀(J) (Proposition). For instance, if D is an element of A which is invertible modulo J then Ind(D) is the element of K₀(J) given by [e]−[e₀], where the idempotents e,e₀∈M₂(^{˜}J) are e₀=[1 0 0 0] and e=Te₀T⁻¹ with, as above, T=[D+(1−DQ)D DQ−1 1−QD Q], Thus, with S₀=1−QD, S₁=1−DQ one gets e=[1−S²₁ (Sᵢ+S²₁)D S₀Q S²₀]∈M₂(^{˜}J). One has Ind(h₂∘h₁)=Ind(h₁)+Ind(h₂) for any pair ((E₁,E₂,h₁), (E₂,E₃,h₂)) of quasiisomorphisms. Let (V,F) be a compact foliated manifold and let D be, as above, a longitudinal elliptic operator from the bundle E₁ to E₂. Then the inclusion C^{∞}(V)⊂A of multiplication operators on V, as longitudinal differential operators of order 0 allows us to induce the vector bundles Eᵢ to finite projective modules Eᵢ over A. The above existence of an inverse for D modulo C_{c}^{∞}(G) is then precisely encoded in Proposition The triple (E₁,E₂,D) defines a quasi-isomorphism over the algebra J=C_{c}^{∞}(G)⊂A. We shall let Ind(D)∈K₀ (C_{c}^{∞}(G)) be the index associated to (E₁,E₂,D) by Proposition 9.β Significance of the C*-algebra index. By the construction of C*(V,F) as a completion of the algebra C_{c}^{∞}(G), one has a natural homomorphism C_{c}^{∞}(G)→^{j}C*(V, F) and we shall denote by Indₐ(D) the image j_{*}Ind(D). In general we do not expect the map j*: K₀(Cc(G))→K₀(C*(V, F)) to be an isomorphism, and thus we lose information in replacing Ind(D) by Indₐ(D)=j*(Ind(D)). It is, however, only for the latter index that one has vanishing or homotopy invariance results of the following type: Proposition Let (V,F) be a compact foliated manifold. Assume that the real vector bundle F is endowed with a Spin structure and a Euclidean structure whose leafwise scalar curvature is strictly positive. Let D be the leafwise Dirac operator. Then D is a longitudinal elliptic operator and Indₐ(D)=0. In other words, with F of even dimension and oriented by its Spin structure, one lets S^{±} be the bundle of spinors and D: C^{∞}(V,S⁺)→C^{∞}(V,S⁻) be the partial differential operator on V which restricts to leaves as the leafwise Dirac operator. The proof of the vanishing of Indₐ(D) is the same as the proof of J. Rosenberg for covering spaces (cf.); using the Lichnerowicz formula for D*D and DD* one shows that these two operators are bounded from below by a strictly positive scalar. This shows the vanishing of Indₐ(D) e K₀(C*(V,F)) because operator inequalities imply spectral properties in C*-algebras. It is, however, not sufficient to prove the vanishing of Ind(D)∈K₀(C_{c}^{∞}(G)). As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. Let V→^{p}B be a fibration, where V and B are smooth compact manifolds, and let F be the vertical foliation, so that the leaves of (V,F) are the fibers of the fibration and the base B is the space V/F of leaves of the foliation. Then a longitudinal elliptic operator is the same thing as a family (D_{y})_{y∈B} of elliptic operators on the fibers in the sense of [27] M. F. Atiyah and I. M. Singer. The index of elliptic operators, IV. Ann. of Math.(2) 93 (1971). Moreover, the C*-algebra of the foliation (V,F) is strongly Morita equivalent to C(B), and one has a canonical isomorphism K(C*(V,F))˜K(C(B))=K(B). Under this isomorphism our analytic index, Indₐ(D)∈K(C*(V,F)) is the same as the Atiyah-Singer index for the family D=(D_{y})_{y∈B}, Indₐ(D)∈K(B) (cf. [27]). In this situation the Atiyah-Singer index theorem for families (loc. cit) gives a topological formula for Indₐ(D) as an equality Indₐ(D)=Indₜ(D) where the topological index Indₜ(D) only involves the K-theory class σ_{D}∈K(F*) of the principal symbol of D, and uses in its construction an auxiliary embedding of V in the Euclidean space R^{N}. (cf. loc. cit). We shall now explain the index theorem for foliations ([136] A. Connes and G. Skandalis. Then the inclusion C^{∞}(V)⊂A of multiplication operators on V, as longitudinal differential operators of order 0 allows us to induce the vector bundles Eᵢ to finite projective modules Eᵢ over A. As another example, let us consider the leafwise homotopy invariance of the longitudinal signature, i.e. of Indₐ(D), where D is the longitudinal signature operator. This question is the exact analogue of the question of the homotopy invariance of the Γ-invariant signature for covering spaces, which was proved by Mishchenko and Kasparov. One gets: Proposition Let (V,F) be a compact foliated manifold with F even-dimensional and oriented. Let D be the leafwise signature operator. Then its analytic index Indₐ(D)∈K₀(C*(V,F)) is preserved under leafwise oriented homotopy equivalences, [symbol] The longitudinal index theorem. The longitudinal index theorem for foliations.) Which extends the above result to the case of arbitrary foliations of compact manifolds and immediately implies the index theorem for measured foliations of Chapter I. As in the Atiyah-Singer theorem we shall use an auxiliary embedding of V in Rⁿ in order to define the topological index, Indₜ(D), and the theorem will be the equality Indₐ=Indₜ. This equality holds in K(C*(V,F)) and thus we need an easy way to land in this group. Now, given a foliation (V⁰,F⁰) of a not necessarily compact manifold, and a not necessarily compact submanifold N of V⁰ which is everywhere transverse to F⁰, then Lemma 8.2 provides us with an easy map from K(N)=K(C₀(N)) to K(C*(V⁰,F⁰)). Indeed, for a suitable open neighborhood V⁰⁰ of N in V⁰ one has C₀(N)˜C*(V⁰⁰,F⁰)⊂C*(V⁰,F⁰) (where the first equivalence is a strong Morita equivalence). Of course, the resulting map K(N)→K(C*(V⁰,F⁰)) coincides with the map e!, where e: N→V⁰/F⁰ is the obvious 'etale map, but we do not need this equality (except as notation) to define e!. The main point in the construction of the topological index Indₜ is that an embedding i: V→Rⁿ allows one to consider the normal bundle ν=i*(F)^{⊥} of i*(F) in Rⁿ as a manifold N, transversal to the foliation of V⁰=V×Rⁿ by the integrable bundle F⁰=F×{0}⊂TV⁰. First note that the bundle ν over V has a total space of dimension d=dimV+n-dimF, which is the same as the codimension of F⁰ in V⁰. Next consider the map ϕ from the total space ν to V⁰=V×Rⁿ given by ϕ(x,ξ)=(x,i(x)+ξ) ∀x∈V, ξ∈vₓ=(i*(Fₓ))^{⊥}, and check that on a small enough neighborhood N of the 0-section in v the map ϕ: N→V⁰ is transverse to F⁰. It is enough to check this transversality on the 0-section V⊂v where it is obvious, and only uses the injectivity of i* on F⊂TV. Theorem 6. Let (V,F) be a compact foliated manifold, D a longitudinal elliptic differential operator. Let i: V→Rⁿ be an embedding, let v=(i*(F))^{⊥} be the normal bundle of i_{*}F in Rⁿ, and let N˜v be the corresponding transversal to the foliation of V×Rⁿ=V⁰ by F⁰=F×{0}. Then the analytic index, Indₐ(D) is equal to Indₜ(σ(D)), where σ(D)∈K(F*) is the K-theory class of the principal symbol of D, while Indₜ(σ(D)) is the image of σ(D)∈K(F*)˜K(N) (through the Thom isomorphism) by the map K(N)→^{e!}K(C*(V⁰,F⁰))˜K(C*(V,F)) Through the Bott periodicity isomorphism since C*(V⁰,F⁰)=SⁿC*(V,F)=C*(V,F)⊗C₀(Rⁿ) The proof easily follows from Theorem 8.3 and the following analogue of Lemma 5.6: Lemma 7. With the notation of Theorem 6, let x=(F,σ(D),p∘π) be the geometric cycle given by the total space of the bundle F, the K-theory class σ(D)∈K*(F) of the symbol of D, and the K-oriented map F→V→V/F. Then Indₐ(D)=μ(x)∈K(C*(V,F)). Note that a direct proof of Theorem 6 is possible using the Thom isomorphism as in Section 5. Of course, the above theorem does not require the existence of a transverse measure for the foliation, and it implies the index theorem for measured foliations of Chapter I. A transverse measure ∧ on (V,F) determines a positive semi-continuous semi-finite trace, trace_{∧}, on C*(V,F) and hence an additive map trace_{∧}: K(C*(V,F))→R. The reason why trace_{∧}∘ Indₜ is much easier to compute than trace_{∧}∘ Indₐ is that the former computation localizes on the restriction of the foliation F⁰ to a neighborhood V⁰⁰ of N in V⁰ on which the space of leaves V⁰⁰/F⁰ is an ordinary space N, so that all difficulties disappear. Let us apply these results in the simplest example of a one-dimensional oriented foliation (with no stable compact leaves) and compute dim_{∧}K(C*(V,F))⊂R. For such foliations the graph G is V×R and the classifying space BG is thus homotopic to V. Thus, up to a shift of parity, the geometric group K_{*,τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map pi and the index Indₐ:K*(F)→K(C*(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], t∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}: K*(C*(V,F))7→R is equal to 0, so in particular dim_{∧} is identically 0. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle of Chapter I. Corollary 9. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere. For instance, one can take in the Poincare disk a regular triangle T with its three angles equal to n/4 and as Γ the group formed by products of an even number of hyperbolic reflections along the sides of T. In order to exploit the results on vanishing or homotopy invariance of the analytic index Indₐ we shall construct in Chapter III higher-dimensional generalizations of the above maps dim_{∧}: K(C*(V,F))→R associated to higher-dimensional “currents” on the space of leaves V/F, whose differential geometry, i.e. the transverse geometry of the foliation, will then be fully used”. (The Longitudinal Index Theorem for Foliations A. Connes* and G. Skandalis** 1983). Meromorphic D a period of some isolated points P(s) is the prime zeta function, and [S] is an Iverson bracket Riemannian manifold of nonnegative curvature Let inf(P) and sup(D) denote the optimal value of (P) and (D), respectively. Then we have the following familiar result (so-called weak duality). For a smooth point p on S, we continue mapping of the complex Hilbert transform z with envelope |z|. Mapping Hilbert-Huang transform (HHT). We find the familiar geometric series from calculus; alternately, this function has an infinite expansion. The coordinate system mapping the coordinate [symbol] -plane tangent to S at P and we then define the second fundamental form in the same way. Shape object plane singletons have {points {and the entire space Rⁿ is our solution set of an arbitrary possibly, infinite system ≤b_{α}, α∈A α^{T}_{α}x≤b_{α}, α∈A of linear inequalities with n unknowns x {the set M={x∈Rⁿ|α^{T}_{α}X≤b_{α}, α∈A} is convex, and their incidence of Euclidean space are shared with affine geometry, (vector field on the generic leaf of a foliation) Hₖ(V,R), we get a scalar χ(F,∧)=he(F),[C]i∈R nondegenerate 2-form structure in potential theory complex analysis proves invaluable mathematical physics expressions an infinite potential finite-dimensional n=2 flat, (we refer to) to the cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Every hyperbola has two asymptotes; we calculate solid domain by linear approximation the diagonal in a* every three-dimensional vector is written as a linear combination of the three mathematics vector calculus differentiation and integration over the vector field by ridgelets converges rapidly to nice ridge functions; and the affine function of hyperbola we establish the wedge product is the product in an exterior algebra. If α and β are differential k-forms of degrees p and q, respectively, then α∧β=(−1)^{pq}β∧α. And is associative, (α∧β)∧μ=α∧(β∧μ), and bilinear (c₁ a₁+c₂ a₂)∧β=c₁ (α₁∧β)+c₂ (α₂∧β) α∧(c₁ β₁+c₂ β₂)=c₁ (α∧β₁)+c₂ (α∧β₂) (Spivak 1999, p. 203), where c₁ and c₂ are constants. The exterior algebra is generated by elements of degree one, and so the wedge product can be defined using a basis e₁ for V:(eᵢ₁∧ . . . ∧eᵢₚ)∧(eⱼ₁∧ . . . ∧e_{jq})=eᵢ₁∧ . . . ∧eᵢₚ∧eⱼ₁∧ . . . ∧e_{jq} when the indices i₁, . . . , iₚ, j₁, . . . , j_{q}, are distinct, and the product is zero otherwise. While the formula α∧α=0 holds when α has degree one, it does not hold in general. We consider α=e₁∧e₂+e₃∧e₄: α∧α=(e₁∧e₂)∧(e₁∧e₂)+(e₁∧e₂)∧(e₃∧e₄)+(e₃∧e₄)∧(e₁∧e₂)+(e₃∧e₄)∧(e₃∧e₄)=0+e₁∧e₂∧e₃∧e₄+e₃∧e₄∧e₁∧e₂+0=2 e₁∧e₂∧e₃∧e₄. If α₁, . . . , αₖ have degree one, then they are linearly independent iff α₁∧ . . . ∧αₖ≠0. A hyperbola with a horizontal transverse axis and center at (h, k) has one asymptote with equation y=k+(x−h) and the other with equation y=k−(x−h). The set of D in the intersection of n half-spaces of the hyperplane Σⁿᵢ₌₁xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Rhys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). We also consider a certain variant of self-avoiding walk and argue that, when d≥3, an upper bound of n−2+d−1+o(1) holds on a full density set for the counterpart in this variant model of this normalized polygon cardinality element particle physics we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology symmetrical Magnetic Field of a Current Element Magnetic Resonance side B^{→}=Bₒ^{→} and B^{→}ₑ semigroup, a semidirect product given a Lie group G is, in a trivial way, a groupoid with G⁽⁰⁾={e} the substitution law holds for real power-associative algebras, and the multiplication of polynomials works. For f a real polynomial in x, and for any a in such an algebra define f(a) to be the element of the algebra resulting from the obvious substitution of a into f. Proposition. A pre-Abelian category in mathematics, specifically in category theory, our pre-Abelian category is an additive category that has all kernels and cokernels. Spelled out in more detail, this means that our category C is pre-Abelian when: C is preadditive, pre-Abelian category associated to a chain complex, or cochain complex C of vector spaces; the latter takes the form k-permutations of (n) allotropes-of-nanocarbon nanoparticle blended, and unblended (inert mixture formula); or the form k-permutations of (n) element nanoparticle blended, and unblended (inert mixture formula) enriched over the monoidal category of Abelian groups are performed with this group continuum a lift a normal k-smoothing isometries mechanics, or pre-Abelian category associated to a chain complex, or cochain complex C of vector spaces; the latter takes the form k-permutations of (n) element enriched over the monoidal category of Abelian groups are performed with this group continuum a lift a normal k-smoothing isometries mechanics (equivalently, all horn-sets in C are Abelian groups and composition of morphisms is bilinear); C has all finite products (equivalently, all finite coproducts C^{op}); note that because C is also preadditive, finite products are the same as finite coproducts, making them biproducts; given any morphism f: A→B in C, the equaliser of f and the zero morphism from A to B exists (this is by definition the kernel off), as does the coequaliser (this is by definition the cokernel off). Note that the zero morphism in item 3 can be identified as the identity element of the horn-set Hom(A,B), which is an Abelian group by item 1; or as the unique morphism A→O→B, where O is a zero object, guaranteed to exist by item 2. Our bifunctor is a binary functor whose domain is a product category. For example, the Horn functor is of the type C^{op}×C→Set. It can be seen as a functor in two arguments. The Horn functor is a natural example; it is contravariant in one argument, covariant in the other. Our multifunctor is a generalization of the functor concept to n variables. So, here we use a bifunctor is a multifunctor with n=2. (We refer to). “We shall sketch the proof for the case n=2 with the centralizer of an element in a one-relator group with torsion is always cyclic” An Improved Subgroup Theorem For HNN Groups with Some Applications. In [4], a subgroup theorem for HNN groups was established, (see Newman [11] or [4, p. 956]) B. B. Newman, Some results on one-relator groups, Bull. Amer. Math. Soc. 74 (1968), 568-571. One then gets the convolution algebra C_{c}^{∞}(G, Ω^{1/2}) of smooth 1-densities on G, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1. Where H is an HNN group whose base is a tree product of vertices cKc⁻¹∩H where c ranges over a double coset representative system for G mod (H, K). Hamiltonian is assumed to be in Birkhoff's normal form up to terms of degree 2n continuum a lift a normal k-smoothing isometries. (We refer to) “Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations,” Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. (We refer to) “An Improved Subgroup Theorem For HNN Groups with Some Applications”. Introduction. In [4], a subgroup theorem for HNN groups was established. The theorem was proved by embedding the given HNN group in a free product with amalgamated subgroup and then applying the subgroup theorem of [3], In this paper (we refer to) we obtain a sharper form of the subgroup theorem of [4] by applying the Reidemeister-Schreier method directly, using an appropriate Schreier system of coset representatives. Specifically, we prove (in Theorem 1) that if H is a subgroup of the HNN group (1) G= [symbol] t, K; tLt⁻¹=M [symbol] , then H is an HNN group whose base is a tree product of vertices cKc⁻¹∩H where c ranges over a double coset representative system for G mod (H, K); the amalgamated and associated subgroups are contained in vertices of this base and are of the form dMd⁻¹∩H where d ranges over a double coset representative system for G mod (H, M). This improved subgroup theorem for HNN groups was obtained independently by D. E. Cohen [1] using Serre's theory of groups acting on trees. Using the present version of the subgroup theorem, several proofs in [4] can be simplified and results strengthened (see, e.g., [1]). Here we give two new applications of the improved subgroup theorem. Our first application deals with subgroups with non-trivial center of one-relator groups. Definition. A treed HNN group is an HNN group whose base is a tree product and whose associated subgroups are contained in vertices of the tree product base. Let H be a f.g. (finitely generated) subgroup with center Z (≠1) of a torsion-free one-relator group G. Then H as a free Abelian group of rank two, or H is a treed HNN group with infinite cyclic vertices and with center contained in the center of the base (see Theorem 2). Two corollaries are the following: If H is a subgroup with center Z (≠1) of a torsion-free one-relator group, then Z is infinite cyclic unless H is free Abelian of rank two or H is locally infinite cyclic. If H is a f.g. subgroup of the centralizer C of an element x in a torsion-free one-relator group and H∩gp (x)=1, then H is a free group. The first corollary was obtained independently by Mahimovski [8], Theorem 2 generalizes Pietrowski's [12] characterization of one-relator groups having non-trivial centers. The centralizer of an element in a one-relator group with torsion is always cyclic (see Newman [11] or [4, p. 956]) B. B. Newman, Some results on one-relator groups, Bull. Amer. Math. Soc. 74 (1968), 568-571. Our second application connects the structure of a subgroup of finite index of a certain type of treed HNN group to its index. Classical examples of such a connection are given by the Schreier rank formula for free groups, the Euler characteristic for fundamental groups of orientable compact surfaces as compared with that of a j-sheeted covering space, and the Riemann-Hurwitz formula for Fuchsian groups. Each of these cases may be viewed as associating a number x(G) to each group G in the class so that if G: H=j, then x(H)=j•x(G); indeed, we take this property as the defining property of a characteristic defined on a class of groups closed under taking subgroups of f.i. (finite index). Specifically, for the free group G take x(G)=1-rank G, for the fundamental group G= [symbol] a₁, b₁, a_{g}, b_{g}, Π[aᵢ, bᵢ] [symbol] let x(G)=2−2g, and for the Fuchsian group G= [symbol] c₁, • • • , cₜ, a₁, b₁, • • • , a_{g}, b_{g}; c₁^{y1}, • • • , cₜ^{yt}, c₁⁻¹[a₁, b₁] • • • [a_{g}, b_{g}] [symbol] let x(G)=2g−2+Σ(1−yi⁻¹). In all three cases if x(G)≠0, then isomorphic subgroups of f.i. must have the same index; indeed, in the first two cases x(H) determines H (up to isomorphism). In any case, knowing the index of the subgroup H determines x(H), and therefore limits the structure of H. Wall [15] introduced a “rational Euler characteristic” for finite extensions of discrete groups which admit a finite complex as classifying space. For these groups, not only does x(H)=j•x(G) when G:H=j, but also the formula x(A*B)=x (A)+x(B)−1 holds. The class of groups considered by Wall includes finite extensions of f.g. free groups, and for these groups Stallings [14] generalized Wall's formula to x(A*B; U)=x(A)+x(B)−|U|⁻¹, where U is a finite group (of order |U|), and A, B are finite extensions of f.g. free groups. We generalize this further to show that if G is a treed HNN group with finitely many vertices A₁, • • • , Aᵣ each of which is a finite extension of a free group, and there are finite amalgamated subgroups U₁, • • • , Uᵣ₋₁ and finitely many pairs of finite associated subgroups L₁, M₁, • • • , Lₙ, Mₙ, then Wall's characteristic x(G) is given by (2) x(G)=x(A₁)+ • • • +x(Aᵣ)−|U₁|⁻¹− • • • −|Uᵣ₋₁|⁻¹−|M₁|⁻¹ [symbol] |Mn|⁻¹ (see Theorem 3). We then extend the formula (2) using the more general notion of characteristic (indicated above) to other classes of treed HNN groups (see Theorem 4). The generalized formula applies to (Kleinian) function groups (certain discontinuous subgroups of LF (2, C)). 2. The subgroup theorem for HNN groups. Let G be as in (1). We may suppose that a set of generating symbols is chosen for K which includes a subset {mᵢ} which generates M and a corresponding subset {Iᵢ} where Iᵢ=t⁻¹mᵢt, which generates L. A K-symbol is one of the chosen K-generators or its inverse; an M-symbol is one of the mᵢ or its inverse. Let H be a subgroup of G. In the proof of Theorem 1 below we shall show that there exists a Schreier coset representative system for G mod H of the form {Dₖ•Eₘ•Q(mᵢ)} where Q(mᵢ) is a word in M-symbols, Eₘ •Q(mᵢ) is a word in K-symbols, Dₖ does not end in a K-symbol, Dₖ •Eₘ does not end in an M-symbol, and in no representative does t follow a non-empty M-symbol. Moreover, {Dₖ} is a representative system for G mod (H, K), and {Dₖ •Em} is a representative system for G mod (H, M). Theorem 1. Let G be as in (1), let H be a subgroup of G, and let a Schreier representative system for G mod H be chosen as described above. Then H is a treed HNN group whose vertices are of the form DₖKDₖ⁻¹∩H (where Dₖ ranges over the full double coset representative system for G mod (H, K)) and whose amalgamated and associated subgroups are of the form DₖEₘKEₘ⁻¹Dₖ⁻¹∩H (where DₖEₘ ranges over the full double coset representative system for G mod (H, M)). Proof. The proof of the theorem is analogous to that of the proof of the subgroup theorem (Theorem 5) of [3], and so we merely sketch the argument. First we construct a Schreier representative system for G mod H of the type described. For this purpose define the length of an (H, K) double coset as the shortest length of any word in it. For the (H, K) coset of length 0, we choose the empty word 1 as its K-double coset representative. To obtain the Schreier representatives for the H-cosets of H in HK, we supplement the double coset representative 1 with a special Schreier system (defined after Lemma 5, page 240 of [3] for K mod K∩H with respect to M. Assume we have defined Schreier representatives (in this manner) for all cosets of H contained in a double coset of (H, K) of length less than r. Let HWK and W have length r>0. Now W ends in a t-symbol; hence W=Vt^{e}, ₑ=±1. Moreover, the Schreier representative V* of V has already been defined and has the form V*=Dₖ •Eₘ •Q(mᵢ). If ₑ=1, then DₖEₘQ(mᵢ)t=DₖEₘtQ(lᵢ), and so HDₖEₘtK=HWK, and we choose DₖEₘt as the double coset representative of HWK. If ₑ=−1, then choose DₖEₘQ(mᵢ)t⁻¹ as the double coset representative D of HWK. In either case we supplement our chosen double coset representative D of HWK with a special Schreier representative system for K mod K∩D⁻¹HD with respect to M. We have now constructed a Schreier coset representative system for G mod H as described above. Using this Schreier system and the corresponding rewriting process, we may apply the Reidemeister-Schreier method (see [7, Section 2.3]) to obtain a presentation for H from our presentation for G. Now H has generators {S_{N·x}} and {S_{N,t}} semiprime is a Schreier representative and x is a K-generator. Moreover, {S_{N,X}}, semiprime has a fixed (H, K) double coset representative Dₖ and x ranges over the K-generators, generates the subgroup D_{K}KDₖ⁻¹ ∩H; {S_{N,y}}, semiprime has a fixed (H, M) double coset representative DₖEₘ and y ranges over the M-generators, generates the subgroup D_{K}EₘMEₘ⁻¹D_{K}⁻¹∩H. Moreover, if the relators of K are conjugated by those N with a fixed Dₖ, and then the rewriting process τ is applied, the resulting relators together with the trivial generators S_{N,x} provide a set of defining relators for DₖKDₖ−1∩H. The defining relators for H that arise from rewriting {t|ᵢt⁻¹ mᵢ} enable us to eliminate the generators S_{N,t} semiprime is not a double coset representative for G mod (H, M); moreover, the remaining relators take the form (3) S_{DkEm,t} ((DₖEₘt)*L(DₖEₘt)*⁻¹∩H) S_{DkEm,t}⁻¹=DₖEₘMEₘ⁻¹Dₖ⁻¹∩H. Now (3) describes an amalgamation which takes place between vertices (DₖEₘt)*K(DₖEₘt)*⁻¹∩H and (DₖEₘ)K(DₖEₘ)⁻¹∩H if S_{DkEm,t} is a trivial generator (i.e., (DₖEₘt)*=DₖEₘt); otherwise, (3) describes a pair of associated subgroups from these same vertices. Specifically, if DₖEₘQ(mⱼ) is a representative, then S_{DkEm,t Q,t} is freely equal to τ[(DₖEₘ)*Q(mⱼ)(DₖEₘQ(mⱼ))*⁻¹]•S_{DkEm,t}•τ[(DₖEₘt)*Q(lⱼ)(DₖEₘQ(lⱼ))*⁻¹], and hence if Q(mⱼ)≠1, we may eliminate the generators S_{DkEm,Qt}; the remaining relators become those in (3) together with the trivial generators in {S_{DkEm,t}} The amalgamations described in (3) lead to a tree product of vertices DₖKDₖ⁻¹∩H for the following reason (see [7, Lemma 1]): Assign as level of the vertex DₖKDₖ⁻¹∩H, the number r of t-symbols in Dₖ; then the unique vertex of level less than r with which DRKDE^{I}A H has a subgroup amalgamated is the subgroup DKD−I A H where D is obtained from Dₖ by deleting the last t-symbol and then deleting any K-syllable immediately preceding that. Corollary 1. The rank of the free part of H as described in Theorem 1 is [G: (H, M)]−[G: (H, K)]+0.1. Proof. (DₖEₘt)*≈DₖEₘt if and only if either DₖEₘt is a Schreier representative and therefore an (H, K) double coset representative, or Eₘ=1 and Dₖ ends in t⁻¹. Thus there exists a one-one correspondence between (H, K) double coset representatives ending in t or t⁻¹ and the trivial generators in {S_{DkEm,t}} But there are G: (H, K)−1 double coset representatives for G mod (H, K) ending in t or t⁻¹; hence the assertion follows. The following corollary will be used in the proof of Theorem 4: Corollary 2. Let G be a treed HNN group with finitely many vertices, f.g. free part, and finite amalgamated and associated subgroups. Then any subgroup H of f.i. is a treed HNN group with finitely many vertices each of which is a conjugate of the intersection of H with some conjugate of a vertex of G; the amalgamated and associated subgroups are conjugates of the intersections of H with certain conjugates of the amalgamated and associated subgroups of G. Proof. The proof is by induction on the sum s of the rank of the free part of G and the number of vertices in G. If s=2, the result follows from the subgroup theorem of [3] or Theorem 1 above. Otherwise, suppose G is as in (1) where K is now a treed HNN group with smaller s than that of G. Then H is a treed HNN group whose vertices are of the form cKc⁻¹∩H=c(K∩c⁻¹Hc)c⁻¹, which by inductive hypothesis is a treed HNN group of the desired type. Now an amalgamated or associated subgroup of H has the form dMd⁻¹∩H. Thus H is an HNN group whose base is a tree product with treed HNN groups as vertices and finite amalgamated subgroups, and H itself has finite associated subgroups. It follows as in the argument for the proof of Theorem 1 of [2] that H is a treed HNN group of the asserted form. In a similar May, it follows that if G (A*B; U) where B has smaller s than that of G and A is one of the original vertices of G, then H will be a treed HNN group of the desired type. 3. Subgroups with non-trivial center of one-relator groups. Theorem 2. Let G be a group with one defining relator R where R is not a true power, and let H be a f.g. subgroup of G with non-trivial center Z. Then H is free Abelian of rank two, or H is a treed HNN group with infinite cyclic vertices and Z is contained in the center of the base of H. Proof. If R has syllable length one, then G is free, H is infinite cyclic, and the result holds. Assume R has syllable length greater than one; then G can be embedded in an HNN group G₁= [symbol] t, K; rel K, tLt⁻¹=M [symbol] where K is a one-relator group whose relator is shorter than R and L, M are free (see e.g., [4]). Suppose H is not free Abelian of rank two. Now by Theorem 1, a f.g. subgroup H of Gi is a treed HNN group H= [symbol] t₁, • • • , tₙ, S; rel S, t₁L₁⁻¹=M₁, • • • [symbol] where S is a tree product of finitely many vertices A₁, • • • , Aᵣ, each Aᵢ being a subgroup of a conjugate of K; the amalgamated and associated subgroups are free. If n≠1, then Z is contained in S; for, H=Π*(gp(t₁, S); S). First suppose Z [symbol] S^{H}. Then n=1. Since some element in Z is not in S^{H} and H is f.g., and S/S^{H} is infinite cyclic, it follows that S^{H} is f.g. (see Murasugi [10]). Therefore S^{H}=L₁ is free and f.g. Consequently, H has the asserted form by [2, Theorem 3], Therefore we may assume Z<S^{H}. We show, in fact, that Z<S. If n≠1, we are finished. Suppose n=1. Then S^{H} is an infinite stem product (i.e., a tree product in which each vertex has at most two edges incident with it) of vertices t₁ ⁱSt₁⁻ⁱ. If M₁≠S≠L₁, then the stem product is proper (i.e., each amalgamated subgroup is a proper subgroup of its containing vertices), and therefore Z is contained in S. If S equals L₁ or M₁, then S is free; S^{H} is an ascending union of free groups and has a non-trivial center, so that S must be infinite cyclic. If S=gp(a)=L₁, and M₁=gp(a^{q}), then H= [symbol] t₁, a; t₁at₁⁻¹=a^{q} [symbol] . Since Z∩S≠1, t₁a^{r}t₁⁻¹=a^{q r}=a^{r} for some r≠0. Hence q=1, and H would be free Abelian of rank two. Therefore Z must be contained in S. Suppose next S consists of a single vertex, S=gKg⁻¹∩H. If n=0, then H=S, is a f.g. subgroup with non-trivial center of the group gKg⁻¹; therefore by the inductive hypothesis, H has the desired form. If n≥0, and some Lᵢ or Mᵢ equals S, then S is free with non-trivial center, and so must be infinite cyclic. Thus again H has the asserted form with base S. We may therefore assume that S^{H} is a proper tree product of the vertices tᵢ^{j}Stᵢ^{-j}, and so Z<Lᵢ∩Mi. Since Lᵢ, Mᵢ are free, Z, Lᵢ, Mᵢ must each be infinite cyclic. Therefore S is a f.g. subgroup of gKg⁻¹ and the inductive hypothesis applies to S. Since Z is infinite cyclic, it follows that S is a treed HNN group with infinite cyclic vertices each of which contains Z, and each of the associated subgroups contains Z. Therefore S/Z is a treed HNN group with finite cyclic vertices; moreover, Lᵢ/Z goes into Mᵢ/Z under conjugation by tᵢ. Hence H/Z is an HNN group with finite cyclic vertices, and the associated subgroups of H/Z are finite. Therefore H/Z is a treed HNN group with finite cyclic vertices, and so by the proof of [2, Theorem 3] H has the asserted form. Finally, suppose S does not consist of a single vertex. Then S is a proper tree product and Z is contained in the amalgamated subgroups of S; these are free and therefore infinite cyclic. Moreover, since Z<Lᵢ∩Mᵢ, we have that Lᵢ, Mᵢ are infinite cyclic. Hence each of the vertices Aⱼ of S is f.g. and the inductive hypothesis applies to each Aⱼ. Hence Aⱼ/Z is a treed HNN group with finite cyclic vertices, and the amalgamated and associated subgroups when reduced mod Z yield finite cyclic groups. Thus H/Z is an HNN group whose base is a tree product of treed HNN groups with finite cyclic vertices; the amalgamated and associated subgroups are finite cyclic groups. Hence H/Z is a treed HNN group with finite cyclic vertices, and consequently H has the asserted form (again by the proof of [2, Theorem 3). Corollary 1. Let H be a subgroup with non-trivial center Z of a torsion-free one-relator group G, H not free Abelian of rank two and not locally infinite cyclic. Then Z is infinite cyclic. Proof. If H is f.g., then Z is infinite cyclic because Z is in the center of the tree product base of H, which has infinite cyclic vertices. Suppose H is infinitely generated. Then H is the ascending union of countably many f.g. subgroups Hᵢ each containing a f.g. subgroup Zᵢ of Z such that Z is the ascending union of the Zᵢ. Now by Moldavanski [9] or Newman 11], no Abelian subgroup of G can be a proper ascending union of free Abelian groups of rank two. Hence only finitely many Hᵢ can be free Abelian of rank two. Thus Zᵢ must be infinite cyclic, and so Z is infinite cyclic if Z is f.g. Suppose Z is infinitely generated. Then H/Z is periodic. For otherwise, for some element h of H, gp(h, Zᵢ) is free Abelian of rank two, and gp(h, Z)=∪ gp(h, Zᵢ) which is impossible. Hence, if Cᵢ is the center of Hᵢ, then Hᵢ/Cᵢ is on the one hand periodic, and on the other hand a treed HNN group with finite cyclic vertices. Therefore, Hᵢ/Cᵢ is finite, and so Hᵢ is infinite cyclic. Consequently, H is locally infinite cyclic. Corollary 2. If H is a f.g. subgroup of the centralizer C of an element x in a torsion-free one-relator group and H∩gp(x)=1, then H is a free group. Proof. Let H₁=gp(H, x), which is the direct product H X gp(x). If H₁ is free Abelian of rank two, then clearly H is infinite cyclic. If H₁ is not free Abelian of rank two, then the center Z of H₁ is infinite cyclic and therefore equals gp(x). Now since H₁ is a treed HNN group with finitely many cyclic vertices each of which contains Z and each of whose associated subgroups contains Z, it follows that H₁/Z is a treed HNN group with finite cyclic vertices, which is isomorphic to H. Since H is torsion-free, H must be free. 4. Characteristics of groups. Lemma 1. Suppose G is as in (1) and R is a subgroup of K such that R has trivial intersection with the conjugates of L and M in K. Let {aᵢ} be a common double coset representative system for K mod (R, M) and K mod (R, L). Then the subgroup H=R*Πⱼ*gp (aⱼtaⱼ⁻¹) is of index [K: (R, M)]•|M|. In Particular, if K:R and |M| are both finite, then a common double coset representative {aᵢ} exists and H is of finite index in G; if R is free (or torsion-free), then so is H. Proof. We show H is a subgroup of the asserted form and index by constructing H using an appropriate Schreier representative system and a corresponding right coset function. For this purpose choose a set of generating symbols for K which is the union of the following three subsets: the symbols {aᵢ}, the symbols {r_{q}} where r_{q} ranges over the elements of R, and the symbols {mⱼ} where mⱼ ranges over the elements of M; the empty symbol 1 is included among the symbols {aᵢ} as well as {mⱼ}. We use the symbols lⱼ to denote t⁻¹mⱼt. As Schreier representatives take the words {aᵢmⱼ}. A corresponding right coset function is determined by the following assignments:=(aᵢmⱼk)*=aᵤmᵥ where aᵢmⱼk=r_{q}aᵤmᵥ, for k any K-symbol; (aᵢmⱼt)*=aᵤmᵥ where aᵢlⱼ=r_{q}aᵤmᵥ; and (aᵢmⱼt⁻¹)*=aᵤmᵥ where aᵢmⱼ=r_{q}aᵤlᵥ. It is not difficult to show that these assignments define a permutation representation of G acting on the chosen representatives {aᵢmⱼ}, and hence determine a subgroup H of elements of G which leave the representative 1 fixed. Clearly, H∩K=R; for, the first of the three representative assignments holds when k is any element of K, and so if (k)*=aᵤmᵥ=1 then k=r_{q}. This enables us to show that the Schreier system {aᵢmⱼ} has the required properties to apply Theorem 1. In particular, 1 is the HK double coset representative, and {aᵢ} is a set of representatives for G mod (H, M). Therefore H is a treed HNN group with a single vertex K ∩H=R, the amalgamated and associated subgroups are aᵢMaᵢ⁻¹∩H=aᵢMaᵢ⁻¹∩R=1; and its free part is generated by s_{ai,t}=aᵢt(aᵢt)*⁻¹=aᵢtaᵢ⁻¹ Let G contain a free subgroup F of rank r and finite index j. Then Wall's rational Euler characteristic x(G) (mentioned in the introduction) is given by x(G)=(1−r)/j (this is obtained using Wall's formulas quoted and that the Euler characteristic of an infinite cyclic group is 0). In particular, if G is finite, then x(G)=|G|⁻¹. Lemma 2. Let G be as in (1). Suppose that K contains a free subgroup R of finite index, and that M is finite. Then the Wall characteristic of G is given by x(G)=x(K)−x(M)=x(K)−|M|⁻¹. Proof. Applying Lemma 1, we see that H of that Lemma is free and of finite index in G. Moreover, x(G)=(1−rank H)/[K: (R, M)]•|M|, and rank H=rank R+[K: (R, M)]. Therefore x(G)={1−rank R+[K: (R, M)])}/[K: (R, M)]•|M|=(1−rank R)/[K:R]−|M|⁻¹=x(G)−x(M). Theorem 3. If G is a treed HNN group with vertices A₁, • • • , Aᵣ each of which is a finite extension of a free group, finite amalgamated subgroups U₁, • • • , Uᵣ₋₁, and pairs of finite associated subgroups L₁, M₁, • • • , Lₙ, Mₙ, then Wall's characteristic x(G) is given by (4) x(G)=x(A₁)=+ • • • +x(Aᵣ)−|U∥⁻¹−• • • −|Uᵣ₋₁|⁻¹−|M_{1|}⁻¹− • • • −|Mₙ|⁻¹. Proof. The proof of (4) is clearly obtained by using Lemma 2, and Stalling's formula quoted in the introduction. We generalize Wall's characteristic as follows: Definition. Let C be a class of groups closed under taking subgroups of f.i. Then a characteristic x defined on C is a real-valued function defined on C such that if G is in C and G:H=j, then x(H)=j•x(G). In addition to the illustrations of characteristics mentioned in the introduction we give the following: 1. Let C₁ be a class of groups with a characteristic x₁ defined on it. Let C be the class of all groups which contain a subgroup of f.i. which lies in C₁. If G is in C, and G:C=p where C is in C₁, define x(G)=x₁(C)/p. Clearly if G:D=q where D is in C₁, and C/C∩D=c, D/C∩D=d, then x₁(C)/p=x₁(C∩D)/cp=x₁(C∩D)/dq=x₁(D)/q, so that x(G) is well-defined. Moreover, if G:H=j, and H:E=r where E is in C₁, then x(H)=x₁(E)/r=j•x₁(E)/jr=j•x(G). 2. Let C be the class of subgroups of f.i. of a fixed group G. Then a necessary and sufficient condition for a non-zero characteristic to be definable on C is that isomorphic subgroups of f.i. in G have the same index in G. Indeed, if H₁≃H₂, G:H₁=j₁, G:H₂=j₂, and x(G)≠0, then x(H₁)=j₁•x(G)=X(H₂)=j₂ •x(G), so that j₁=j₂. Conversely, define x(G)=1, x(H)=j when G:H=j; then x(G) is a well-defined characteristic. Our last example of a characteristic makes use of Theorem 1 and the subgroup theorem of [3]. Theorem 4. Suppose C₁ is a class of f.g. groups with a characteristic x₁ defined on and such that each group in C₁ contains a torsion-free non-cyclic indecomposable (with respect to free product) subgroup of finite index. Let C be the class of treed HNN groups with f.g. free part, finitely many vertices each in C₁, and finite amalgamated and associated subgroups. Suppose G is in C, and has a presentation as a treed HNN group with vertices A₁, • • • , Aᵣ in C₁, amalgamated subgroups U₁, • • • Uᵣ₋₁, and pairs of associated subgroups L₁, M₁, • • • , Lₙ, Mₙ. If we set x(G)=x(A₁)+ • • • +x(Aᵣ)−|U|⁻¹− • • • −|Uᵣ₋₁|⁻¹−|M₁|⁻¹− • • • −1|Mₙ|⁻¹. Then x defines a characteristic on the class C. Proof. We first observe that the class (C is closed under forming treed HNN groups with vertices from C, using finite amalgamated and associated subgroups (for an argument, see the proof of Theorem 1 of [2]). Next We note (see [3]) that a subgroup H of (A*B; U) is a treed HNN group with vertices cAc⁻¹∩H, dBd⁻¹∩H where c, d range over double coset representative systems for G mod (H, A) and G mod (H, B), respectively; moreover, the amalgamated and associated subgroups are of the form eUe⁻¹∩H where e ranges over a double coset representative system for G mod (H, U). It follows from Corollary 2 of Theorem 1 that C is closed under taking subgroups of f.i. We now show that if G:H=j, then for each presentation of G as a treed HNN group in C, H has a presentation as a treed HNN group in C for which x(H)=j•x(G). Indeed, suppose that this assertion holds for A, B in C, and consider G=(A*B; U), U finite. Now cAc⁻¹: cAc⁻¹∩H=j_{c} is the number of H cosets in HcA. Hence cAc⁻¹∩H has a treed HNN presentation in C such that x(cAc⁻¹∩H)=j_{c} •x(cAc⁻¹)=j_{c} •x (A). Similarly, if j_{d}=dBd⁻¹: dBd⁻¹∩H, and jₑ eUe⁻¹: eUe⁻¹∩H, then x(H)=Σ_{c} j_{c}•x(A)+Σ_{D jd}•x(B)−Σ_{e je}•|U|⁻¹=j[x(A)+x(B)−|U|⁻¹]=j•x(G). Similarly, if the assertion of the preceding paragraph holds for K in C, and G is as in (1) with M finite, and G:H=j, then H is a treed HNN group with vertices fKf⁻¹∩H where f ranges over a representative system for G mod (H, K); moreover the amalgamated and associated subgroups are of the form gMg⁻¹ H where g ranges over a coset representative system for G mod (H, M). If j_{f}=fKf⁻¹: fKf⁻¹∩H, and j_{g}=gMg⁻¹: gMg⁻¹∩H, then x(H)=Σ_{f} j_{f} •x(K)−Σ_{g jg}•|M|⁻¹=j•[x(K)−|M|⁻¹]=j•x(G). Finally, we show that x is well-defined on the class C. Clearly, the only ambiguity in the definition of x(G) is that G may be presentable in several ways as a treed HNN group in C. Now an element G₁ of cannot be written in a non-trivial way as a treed HNN group with finite amalgamated and associated subgroups; for otherwise, Gi would have two or infinitely many ends (see Stallings [13]), so that any torsion free subgroup of finite index would have two or infinitely many ends and would therefore be infinite cyclic or a proper free product (see Stallings [13]), contrary to hypothesis. Hence x is well-defined on the elements of C₁. Consider any torsion-free group T in C. Now T has a unique representation as a treed HNN group in C, namely, as a free product of a free group and groups from C₁. Using the uniqueness of representation of a f.g. group as a free product of indecomposable groups, it follows that x(T) is well-defined. Lastly, a group G in has a torsion free subgroup T of f.i., say p (by Stallings [14] and Lemma 1 above), and so x(G)=x(T)/p, so that x(G) is well-defined. Corollary. Let G be as described in Theorem 4, and G:H=j. Suppose that H has a Presentation as a treed HNN group with vertices B₁, • • • , Bₛ, amalgamated subgroups V₁, • • • , Vₛ₋₁, and pairs of associated subgroups P₁, Q₁, • • • , Pₘ, Qₘ. Then x₁(B₁)+ • • • +x₁(Bₛ)=j+x₁(A₁)+ • • • +x₁(Aᵣ)), and |V₁|⁻¹+ • • • +|Vₛ₋₁|⁻¹+|Q₁|⁻¹+ • • • +|Q₁|⁻¹=j(|U₁|⁻¹+ • • • +|Uᵣ₋₁|⁻¹+|M₁|⁻¹+ • • • +|Mₙ|⁻¹). Proof. Since x₁ can be replaced by x₂=2x₁ and the assertion of Theorem 4 will still hold, the result follows. As an illustration of Theorem 4, let C₁ be the class of Fuchsian groups described in the introduction, and let be the characteristic mentioned there. Then it is well-known that each group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0”. The resulting class (C includes Kleinian function groups (see [6]). Can. J. Math., Vol. xxvl, No. I, 1974, pp. 214-224. An Improved Subgroup Theorem For HNN Groups ‘with Some Applications’ by A. Karrass, A. Pietrowski, And D. Solitar. Our closed monoidal category in mathematics, especially in category theory, a closed monoidal category (also called a monoidal closed category) is a context where it is possible both to form tensor products of objects and to form ‘mapping objects’. A classic example is the category of sets, S to sets, where the tensor product of sets A and B is the usual Cartesian product A×B Cartesian Product (set of ordered pairs from A and B) {1,2}×{3,4}={(1,3), (1,4), (2,3), (2,4)}, and the mapping object B^{A} is the set of functions from A to B. Another example is the category FdVect, consisting of finite-dimensional vector spaces and linear maps. Here the tensor product is the usual tensor product of vector spaces, and the mapping object is the vector space of linear maps from one vector space to another. The ‘mapping object’ referred to above is also called the ‘internal Horn’. The internal language of closed symmetric monoidal categories is linear logic and the type system is the linear type system. Many examples of closed monoidal categories are symmetric. However, this need not always be the case, as non-symmetric monoidal categories can be encountered in category-theoretic formulations of linguistics; roughly speaking, this is because word-order in natural language, or in other theoretical subject matters. A closed monoidal category is a monoidal category C such that for every object B the functor given by right tensoring with B A [symbol] A⊗B has a right adjoint, written A [symbol] (B⇒A). This means that there exists a bijection, called ‘currying’, between the Horn-sets Hom_{C}(A⊗B,C)≅Hom_{C}(A, B⇒C) that is natural in both A and C. In a different, but common notation, one would say that the functor −⊗B: C→C has a right adjoint [B, −]: C→C equivalently, a closed monoidal category C is a category equipped, for every two objects A and B, with an object A⇒B, a morphism eval_{A,B}:(A⇒B)⊗A→B, satisfying the following universal property: for every morphism f:X⊗A→B there exists a unique morphism h: X→A⇒B such that f=eval_{A,B}∘(h⊗id_{A}). It can be shown that this construction defines a functor⇒: C^{op} ⊗C→C. This functor is called the internal Horn functor, and the object A⇒B is called the internal Horn of A and B. Many other notations are in common use for the internal Horn. When the tensor product on C is the Cartesian product, the usual notation is B^{A} and this object is called the exponential object. Biclosed and symmetric categories strictly speaking, we have defined a right closed monoidal category, since we required that right tensoring with any object A has a right adjoint. In a left closed monoidal category, we instead demand that the functor of left tensoring with any object A B [symbol] A⊗B have a right adjoint B [symbol] (B⇐A). A biclosed monoidal category is a monoidal category that is both left and right closed. A symmetric monoidal category is left closed if and only if it is right closed. Thus we may safely speak of a ‘symmetric monoidal closed category’ without specifying whether it is left or right closed. In fact, the same is true more generally for braided monoidal categories: since the braiding makes A⊗B naturally isomorphic to B⊗A, the distinction between tensoring on the left and tensoring on the right becomes immaterial, so every right closed braided monoidal category becomes left closed in a canonical way, and vice versa. We have described closed monoidal categories as monoidal categories with an extra property. One can equivalently define a closed monoidal category to be a closed category with an extra property. Namely, we can demand the existence of a tensor product that is left adjoint to the internal Horn functor. In this approach, closed monoidal categories are also called monoidal closed categories. The monoidal category Set of sets and functions, with Cartesian product as the tensor product, is a closed monoidal category. Here, the internal horn A ⇒B is the set of functions from A to B. In computer science, the bijection between tensoring and the internal horn is known as currying, particularly in functional programming languages. Indeed, some languages, such as Haskell and Caml, explicitly use an arrow notation to denote a function. This example is a Cartesian closed category. More generally, every Cartesian closed category is a symmetric monoidal closed category, when the monoidal structure is the Cartesian product structure. Here the internal horn A⇒B is usually written as the exponential object B^{A}. The monoidal category FdVect of finite-dimensional vector spaces and linear maps, with its usual tensor product, is a closed monoidal category. Here A⇒B is the vector space of linear maps from A to B. This example is a compact closed category. More generally, every compact closed category is a symmetric monoidal closed category, in which the internal Horn functor A⇒B is given by B⊗A*. Kelly, G. M. “Basic Concepts of Enriched Category Theory”, London mathematical Society Lecture Note Series No. 64 (C.U.P., 1982). Paul-André Melliès, “Categorical Semantics of Linear Logic”, Panoramas et Synthèses 27, Société Mathématique de France, 2009. In mathematics, specifically in category theory, an additive category is a preadditive category C admitting all finitary biproducts. A category C is preadditive if all its horn-sets are Abelian groups and composition of morphisms is bilinear; C is enriched over the monoidal category of Abelian groups. In a preadditive category, every finitary product (including the empty product, i.e., a final object) is necessarily a coproduct (or initial object in the case of an empty diagram), and hence a biproduct, and conversely every finitary coproduct is necessarily a product (this is a consequence of the definition, not a part of it). Thus an additive category is equivalently described as a preadditive category admitting all finitary products, or a preadditive category admitting all finitary coproducts. Another, yet equivalent, way to define an additive category is a category (not assumed to be preadditive) which has a zero object, finite coproducts and finite products and such that the canonical map from the coproduct to the product XIIY→XIIY is an isomorphism. This isomorphism can be used to equip Hom(X,Y) with a commutative monoid structure. The last requirement is that this is in fact an Abelian group. Unlike the afore-mentioned definitions, this definition does not need the auxiliary additive group structure on the Horn sets as a datum, but rather as a property.^{[1]}Jacob Lurie: Higher Algebra, Definition 1.1.2.1, “Archived copy” (PDF). Archived from the original (PDF) on 2015 Feb. 6. Retrieved 2015 Jan. 30. Note that the empty biproduct is necessarily a zero object in the category, and a category admitting all finitary biproducts is often called semiadditive. As shown below, every semiadditive category has a natural addition, and so we can alternatively define an additive category to be a semiadditive category having the property that every morphism has an additive inverse. We also considers additive R-linear categories for a commutative ring R. These are a categories enriched over the monoidal category of R-modules and admitting all finitary biproducts. The original example of an additive category is the category of Abelian groups Ab. The zero object is the trivial group, the addition of morphisms is given pointwise, and biproducts are given by direct sums. We consider, every module category over a ring R is additive, and so in particular, the category of vector spaces over a field K is additive. The algebra of matrices over a ring, thought of as a category as described below, is also additive. Internal characterisation of the addition law Let C be a semiadditive category, so a category having all finitary biproducts. Then every hom-set has an addition, endowing it with the structure of an Abelian monoid, and such that the composition of morphisms is bilinear. Moreover, if C is additive, then the two additions on horn-sets must agree. In particular, a semiadditive category is additive if and only if every morphism has an additive inverse. This shows that the addition law for an additive category is internal to that category.^{[2]}MacLane, Saunders (1950), “Duality for groups”, Bulletin of the American mathematical Society, 56 (6): 485-516, doi: 10.1090/50002-9904-1950-09427-0, MR 0049192 Sections 18 and 19 deal with the addition law in semiadditive categories. To define the addition law, we will use the convention that for a biproduct, pₖ will denote the projection morphisms, and iₖ will denote the injection morphisms. We first observe that for each object A there is a diagonal morphism Δ: A→A⊕A satisfying pₖ∘Δ=1_{A} for k=1,2, and a codiagonal morphism ∇: A⊕A→A satisfying ∇∘iₖ=1_{A} for k=1,2. Next, given two morphisms αₖ: A→B, there exists a unique morphism α₁⊕α₂: A⊕A→B⊕B such that pₗ∘(α₁⊕α₂)∘iₖ equals αₖ if k=l, and 0 otherwise. We can therefore define α₁+α₂:=∇∘(α₁⊕α₂)∘Δ. This addition is both commutative and associative. The associativity can be seen by considering the composition A^{Δ}→A⊕A⊕A^{α1⊕α2⊕α3}→B⊕B⊕B^{∇}→B. We have α+0=α, using that α⊕0=i₁∘α∘p₁. It is also bilinear, using for example that Δ∘β=(β⊕β)∘Δ and that (α₁⊕α₂)∘(β₁⊕β₂)=(α₁∘β₁)⊕(α₂ ∘β₂). We remark that for a biproduct A⊕B we have i₁∘p₁+i₂∘p₂=1. Using this, we can represent any morphism A⊕B→C⊕D as a matrix. Matrix representation of morphisms. Given objects A₁, . . . , Aₙ and B₁, . . . , Bₘ in an additive category, we can represent morphisms f: A₁⊕ . . . ⊕Aₙ→B₁⊕ . . . ⊕Bₘ as m-by-n matrices (f₁₁ f₁₂ . . . f₁ₙ f₂₁ f₂₂ . . . f₂ₙ [symbol] [symbol] . . . [symbol] fₘ₁ fₘ₂ . . . fₘₙ) where fₖₗ:=pₖ∘f∘iₗ: Aₗ→Bₖ. Using that Σₖ iₖ∘pₖ=1, it follows that addition and composition of matrices obey the usual rules for matrix addition and matrix multiplication. Thus additive categories can be seen as the most general context in which the algebra of matrices makes sense. We may recall that the morphisms from a single object A to itself form the endomorphism ring End(A). If we denote the n-fold product of A with itself by Aⁿ, then morphisms from Aⁿ to A^{m} are m-by-n matrices with entries from the ring End(A). Conversely, given any ring R, we can form a category Mat(R) by taking objects Aₙ indexed by the set of natural numbers (including zero) and letting the horn-set of morphisms from Aₙ to Aₘ be the set of m-by-n matrices over R, and where composition is given by matrix multiplication. Then Mat(R) is an additive category, and Aₙ equals the n-fold power (A₁)ⁿ. This construction should be compared with the result that a ring is a preadditive category with just one object, shown here. If we interpret the object An as the left module Rₙ, then this matrix category becomes a subcategory of the category of left modules over R. This may be confusing in the special case where m or n is zero, because we usually don't think of matrices with 0 rows or 0 columns. This concept makes sense, however: such matrices have no entries and so are completely determined by their size. While these matrices are rather degenerate, they do need to be included to get an additive category, since an additive category must have a zero object. Thinking about such matrices can be useful in one way, though: they highlight the fact that given any objects A and B in an additive category, there is exactly one morphism from A to 0 (just as there is exactly one 0-by-1 matrix with entries in End(A)) and exactly one morphism from 0 to B (just as there is exactly one 1-by-0 matrix with entries in End(B))— this is just what it means to say that 0 is a zero object. Furthermore, the zero morphism from A to B is the composition of these morphisms, as can be calculated by multiplying the degenerate matrices. Additive functors A functor F: C→D between preadditive categories is additive if it is an Abelian group homomorphism on each horn-set in C. If the categories are additive, then a functor is additive if and only if it preserves all biproduct diagrams. That is, if B is a biproduct of A₁, . . . , Aₙ in C with projection morphisms ₚₖ and injection morphisms kj, then F(B) should be a biproduct of F(A₁), . . . , F(Aₙ) in D with projection morphisms F(pₖ) and injection morphisms F(iₖ). Almost all functors studied between additive categories are additive. In fact, it is a theorem that all adjoint functors between additive categories must be additive functors (see here), and most interesting functors studied in all of category theory are adjoints. When considering functors between R-linear additive categories, one usually restricts to R-linear functors, so those functors giving an R-module homomorphism on each horn-set. A pre-Abelian category is an additive category in which every morphism has a kernel and a cokernel. An Abelian category is a pre-Abelian category such that every monomorphism and epimorphism is normal. Many commonly studied additive categories are in fact Abelian categories; for example, Ab is an Abelian category. The free Abelian groups provide an example of a category that is additive but not Abelian. ^{[3]}Shastri, Anant R. (2013), Basic Algebraic Topology, CRC Press, p. 466, ISBN 9781466562431. Nicolae Popescu; 1973; Abelian Categories with Applications to Rings and Modules; Academic Press, Inc. (out of print) goes over all of this very slowly.

1. Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, q), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/!k(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<X<1. Proof: the series is the Maclaurin series for (x+1)^{r}, and that the series converges when −1<X<1. prove: that the series is equal to (x+1)^{r}; Expand the function (1−x)⁻ⁿ when n is a positive integer: we first consider with nearby level surfaces (x+1)ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)!i!(n−1)!=(−1)i(n+i−1i)=(−1)i(n+i−1n−1).(−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1).
Thus(x+1)−n=Σi=0∞(−1)i(n+i−1n−1)xi=Σi=0∞(n+i−1n−1)(−x)i. (x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+X+X2)(1+X+X2+X3+X4+X5)(1+X+X2+X3+X4+X5)(X2+X3+X4+X5+X6).(1+X+X2)(1+X+X2+X3+X4+X5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+x+x2)(1=+x+x2+x3+x4+x5)2(x2+x3+x4+x5+x6)x18+4x17+10x16+19x15+3 1x14+45x13+58x12+6 7x11+70x10+67x9+58x8+45x7+31x6+19x5+10x4+4x3+x2,(1+x+x2)(1+x+x2+x3+x4+x5)2(x2+x3+x4+x5+x6)=x18+4x17+10x16+19x15+31x14+45x13+58x12+67x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1∞, 0≤x2≤50≤x2≤5, 0≤x3≤50≤x3≤5, 2≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+1 02x9+125x10+145x11+160x12+170x13+176x14+179x15+180x16+180x17+180x18+180x19+180x20+ . . . . We find a generating function for the number of submultiple sets of {∞.a, ∞.b, ∞.c}{∞.a,∞.b, ∞.c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x).(x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β} λ_{β} and λ^{˜}ₐ_{^{⋅}}→(Lᵣ)ₐ^{.β.}λ^{˜}_{β}_{^{⋅}}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity p of a fluid is a vector field p the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:H,(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞ [19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R}k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the to flowing diagram commutes: [symbol] *0→X ^{g}↓_{Q}^{f} [symbol] Y the cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=αf₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n 6 M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steen rod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r>0 in Z one has r=1+1+^{(r)} . . . +1, and thus rm=(1+ [symbol] +1)m=1m+^{(r)} . . . +1m=m+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M(r,m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V(x,v)→x*v:=α(v) extending to xⁿ*v:=αⁿ(v)=α(α(⁽ⁿ⁾ . . . α(v))) and (Σaᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x* v, by the module axioms, α is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n G P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • , iₙ, 0, • • • ). The admissible monomials Sq^{I′}∈a correspond to sequences of integers (i′₁, i′₂; • • • , i′n, 0, • • • ) where i′ₖ≥2i′ₖ₊₁ and iₙ≥1. It remains only to set up a one-to-one correspondence between sequences of non-negative integers I and admissible sequences I′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences I′ by insisting that Iₖ be sent to I′ₖ and that the map be additive (with respect to coordinate-wise addition). Then if I=(i₁, • • • , iₙ, 0, • • • )→f=(i′₁, • • • , i′ₙ, 0, • • • ) ε^{I} and Sq^{I′} have the same degree and we have i′ₖ=iₖ+2iₖ₊₁+ • • • +2^{n-k} iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”, (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*_{P}(K;A) be the homology of the complex C*_{P}(K;A) and H*_{P}(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*_{P}(K;A) by 1.2. 1.4. Lemma. An inner automorphism of the algebraic triple (p,A,K) induces the identity map on H*_{P}(K;A). Proof. The induced map is the identity on the cochain level. 1.5. Lemma. Let (p,A,K) be an algebraic triple. Let n be a normal subgroup of p and let y→p. Let g:(π,A,K)→(π,A,K) be the automorphism determined by y. Then the image H*ₚ(K;A)→H*_{π}(K;A) is pointwise invariant under the automorphism g.* Proof, let f: (p,A,K)→(p,A,K) be the inner automorphism determined by y. Then by 1.2, the following diagram is commutative H*_{P}(K;A)H*_{P}(K;A)→H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face of τ is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group π, we can always construct a π-free acyclic simplicial complex W. Proof. We give π the discrete topology and form the infinite repeated join W=π*π*π . . . . This repeated join is a simplicial complex. Taking the join of a complex with a point gives us a contractible space. Any cycle in W must lie in a finite repeated join W′. Such a cycle is homologous to zero in W′*π. Therefore, W is acyclic. We make π act on W as follows:π acts by left multiplication on each factor π of the join and we extend the action linearly. This action is obvious free and the lemma is proved. Suppose we have a homomorphism π→p and W is an acyclic rx-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C*ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands p(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=r^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (6=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2}(132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . 2 A008306 1; 2; 6, 3; 24, 20; 120, 130, 15; 720, 924, 210; . . . 3 A050211 2; 6; 24; 120, 40; 720, 420; 5040, 3948; 40320, . . . 4 A050212 6; 24; 120; 720; 5040, 1260; 40320, 18144; . . . 5 A050213 24; 120; 720; 5040; 40320; 362880, 72576; . . . . The functions dᵣ (n, k) are given by the recurrence relation dᵣ (n, k)=(n−1) dᵣ(n−1, k)+(n−1)ᵣ-idᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i √ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |α(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for anytime discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²++eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for anytime discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, 6/∈ InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number>arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₃δ^{1/2} holds, where the constant Kg does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for anytime discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b>0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′((ΔWₙ)²−Δₙ) we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²++eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for anytime discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ /∈InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ G AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure processing powerplant; or [heat a heater fluid]. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). The product of an element; or in the product of two elements stationary; and independent increments elements of 1-1 structure of 1-1 structure of the Dual Algebra; Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=· [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λa, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β} λ_{β} and λ^{˜}ₐ_{^{⋅}}→(Lᵣ)ₐ^{.β.}λ^{˜}_{β}.; the product of an element; or in the product of two elements stationary; and independent increments elements of 1-1 structure; industrial sand concrete powerplant; industrial coal-sand pavement powerplant; industrial calcium carbonate-sand “slake glass” powerplant; industrial coal bitumen; petrochemical raw crude oil pavement pellet product the four scientific principles of distillation steam; ordinary atmospheric pressure; continuum a lift a normal k-smoothing isometries vacuum theory chamber mechanics; molecular distillation; refrigeration process; and fractional chemistry coal pavement powerplant; industrial the four scientific principles of distillation steam; ordinary atmospheric pressure; continuum a lift a normal k-smoothing isometries vacuum theory chamber mechanics; molecular distillation; refrigeration process; and fractional chemistry powerplant; an element; or in the product of two elements stationary; and independent increments added elements 1-1 structure of the Dual Algebra; processing powerplant; or [heat a heater fluid]. Target of temperature ranges contribution specific heat the logarithm of the pre-exponential factors: high modulus thermoset docking; low modulus thermoset docking; solid phase docking; critical pressure p_{cr}; triple point pϕ; compressible liquid; liquid phase; vapour Tϕ; supercritical fluid docking matter; triple point; gaseous phase; or critical temperature T_{cr}. We add elements target of temperature ranges contribution specific heat the logarithm of the pre-exponential factors: high modulus thermoset docking; low modulus thermoset docking; solid phase docking; critical pressure p_{cr}; triple point pϕ; compressible liquid; liquid phase; vapour Tϕ; supercritical fluid docking matter; triple point; gaseous phase; or critical temperature τ_{cr} with the equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0<t≤T}|Xₜ−X⁽ⁿ⁾ ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . →F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞ [19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Where [symbol] ₙ are the approximations to [symbol] to that our system of equations orders in the number of terms 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field the application of the calculus to vectors which gives the velocity of an element of a fluid flow at position x and ratio [symbol] the flow speed modulation q is steady-state properties p of the system, the partial derivative with respect to time is zero the length of the flow velocity vector₁ q=∥μ∥ the scalar field triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0,1, 0,1, 4, 1, 4, 1, 3, 0, . . . ]. Let pₙ be the number of positive and qₙ the number of negative terms in the first n terms of a simply rearranged alternating harmonic series, then the result to interest us is that the rearrangement converges if and only if a=lim_{n→∞}pₙ/qₙ exists, in which case the sum is 1n 2+½ In a. There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n≥0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Σ. Formally, if X is a topological space and p∈X, a loop is a continuous map L:[0,1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a∈A which add in the obvious way and multiply so that (1,0) is the identity. The obvious norm here is k(α,a)ₖ=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)ₖ=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let A be the collection of all finite subsets of S ordered by inclusion. Given λ∈∧, let bλ=Xa*a. a∈λ Since Lisa left ideal, bλ∈L and is positive. Let eλ=(1/|λ|+bλ)−1 bλ Again we have eλ∈L, and again eλ is-positive. The claim is that eλ is a right approximate identity for L. To see this, let a∈S. Consider ka−aeλk. If α∈A, then ka−aeλk2=ka(1−eλ)k2=k(1−eλ)a*a(1−eλ)k but since α∈A we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if (eλ) is a positive norm-1 identity for I, then k1−eλk≤1, and is in fact equal to 1. Proof. We will need the following lemma. Lemma 2.14. For all α∈A we have kakA/I=limka−ae|lambdak. Proof. Fix >0. Choose d∈I such that ∥a−d∥≤∥a∥A/I+∈. Then ka−aeλk=ka(1−eλ)k≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−e×)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q. are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q. are exactly solutions of a matrix equation where Q^{T} is the transpose of Q and I is the identity matrix M^{→}heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; etc. 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}* tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q. are exactly solutions of a matrix equation where Q^{T} is the transpose of Q and I is the identity matrix M^{→}polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; etc. 1-1 structure of the Dual Algebra the monomials s′ in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field in the product of an element; or in the product of two elements stationary; and independent increments elements of 1-1 structure. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤τ₁≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)} (The Longitudinal Index Theorem for Foliations A. Connes* and G. Skandalis** 1983). The product of an element; or in the product of two elements stationary; and independent increments elements of 1-1 structure of the Dual Algebra. Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product (f, g) such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴I+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T} Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β} λ_{β} and λ^{˜}ₐ_{^{⋅}}→(Lᵣ)ₐ^{.β.}λ^{˜}_{β′}. The product of an element; or in the product of two elements stationary; and independent increments elements of 1-1 structure n=2 elements, or docking matter. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ; −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. The product of an element; or in the product of two elements stationary; and independent increments elements of 1-1 structure n=2 elements, or docking matter e.g. independent, and stationary increments allotropes of carbon nanotubes alloys, and elements semiprecious minerals. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}potassium ash silicon dioxide SiO₂; silicon dioxide SiO2 continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; etc. 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field. The product of an element; or in the product of two elements stationary; and independent increments elements of 1-1 structure n=2 elements, or docking matter e.g. hyper-, ultra-, super-fine-, course fine-, and course size allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-alloys; elements semiprecious minerals; elements semiprecious mineral continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}lutetium nitrogen allotropes of carbon nanotubes CNT's; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental lithium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental cadmium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental magnesium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental copper continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; elemental allotropes of carbon nanotubes continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal/2; beryllium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q. and I is the identity matrix M^{→}battery metal/2 allotropes of carbon nanotubes CNT's; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; tungsten continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal allotropes of carbon nanotubes CNT's; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; steel continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; rhenium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→} tool-metal; rhenium continuum a lift a normal k-smoothing-isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; molybdenum continuum a lift a normal k-smoothing isometries vacuum theory chamber mechanics, molecular distillation, refrigeration process, and fractional chemistry (hyper-) superset periodic elements Clare exactly solutions of a matrix equation where Q^{T} is the transpose of Q and I is the identity matrix M^{→}tool-metal; boron icosahedra continuum a lift a normal k-smoothing isometries vacuum theory chamber mechanics, molecular distillation, refrigeration process, and fractional chemistry (hyper-) superset periodic elements Q. are exactly solutions of a matrix equation where Q^{T} is the transpose of Q and I is the identity matrix M^{→}tool-metal; chromium continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; Nioben C₂₂H₃₆ClNO continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Clare exactly solutions of a matrix equation where Q^{T} is the transpose of Q and I is the identity matrix M^{→}tool-metal; aluminum continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}tool-metal allotropes of carbon nanotubes CNT's; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}potassium ash silicon dioxide SiO₂; silicon dioxide SiO₂ continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soda ash silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}battery metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}precious metal silicon dioxide SiO₂/2; elemental continuum a lift a normal k-smoothing isometries vacuum theory chamber mechanics, molecular distillation, refrigeration process, and fractional chemistry (hyper-) superset periodic elements Q. are exactly solutions of a matrix equation where Q^{T} is the transpose of Q and I is the identity matrix M^{→}heavy metal silicon dioxide SiO₂/2; elemental continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}soft metal silicon dioxide SiO₂/2; continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}silicon dioxide SiO₂; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene, 1,3-butadiene; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymer of isoprene 1,3-butadiene; allotropes of carbon nanotubes CNT's continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; polyamide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M polymeric gelling; polyimide continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; boron icosahedra continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; tetrafluoroethylene continuum a lift a normal k-smoothing isometries vacuum theory chamber mechanics, molecular distillation, refrigeration process, and fractional chemistry (hyper-) superset periodic elements Q are exactly solutions of a matrix equation where Q^{T} is the transpose of Q and I is the identity matrix M^{→}polymeric gelling; etc. 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field in the product of an element; or in the product of two elements stationary; and independent increments elements of 1-1 structure. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, the product of an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K′(V)} (The Longitudinal Index Theorem for Foliations A. Connes* and G. Skandalis** 1983). The product of an element; or in the product of two elements stationary; and independent increments elements of 1-1 structure of the Dual Algebra. Newtonian binomial theorem: when r is a nonnegative integer, the binomial coefficients for k>r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null SO(2,2) vector p, that is, a real 4-vector such that (p⁴)²+(p²)²−(p³)²−(p¹)²=0, we can write pₐₐ_{^{⋅}}=λₐ, λ^{˜}ₐ, with λ and λ^{˜} two independent real spinors. We consider the group SO(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²═(⁰₁⁻¹₀). Any real 2-by-2 matrix p (this matrix is of course to be distinguished from the matrix p in (1)) can be decomposed as p=p⁴l+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T} Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(Lₗ)ₐ^{β} λ_{β} and λ^{˜}ₐ_{^{⋅}}→(Lᵣ)ₐ^{.β.}λ^{˜}_{β}. The product of an element; or in the product of two elements stationary; and independent increments elements of 1-1 structure n=2 elements, or docking matter. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. The product of an element; or in the product of two elements stationary; and independent increments elements of 1-1 structure n=2 elements, or docking matter e.g. independent, and stationary increments allotropes of carbon nanotubes alloys, and elements semiprecious minerals. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q 6 Q(R) there exist elements i₁, . . . , iₙ∈R and ψ₁, . . . , ψₙ∈F, such that qiₖ, iₖd∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n−cos Θ) transport properties generating series is three dimensions spinneret g-units of 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion silica sand grains grounded hyper-, ultra-, super-, or fine-particles continuous suspended, and 3-dimensional volume continuously vertically, or horizontally drawn, and driven; or particle matter physics: (hyper-) superset periodic elements Q are exactly solutions of a matrix equation where Q^{T} is the transpose of Q and I is the identity matrix M^{→} continuously projected fracturing silica sand grains hyper-, ultra-, super-, or fine-chards of needles continuous suspended, and 3-dimensional volume continuously vertically, or horizontally drawn, and driven mixtures. The product of an element; or in the product of two elements stationary; and independent increments elements of 1-1 structure n=2 elements dynamics of variable change complexification*, or two times the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜}=λ* is the complex conjugate of λ connected impellers; turbo-shaft; turbo-fan; turbo-fluid; turbo-jet; or fluid-propulsion negative [symbol] -axis y:[A, b]→S together with a subdivision a=τ₀<τ₁<τ₂<∧<τₙ=b of [A, b] contain 1. We show that it is sufficient to treat the case V=K. 2. The chain complex C*^{Trias}(Trias(K)) splits into the direct sum of chain complexes C*(u), one for each element u in P_{m,m}≥1.3. The chain complex C*(u) is shown to be the cell complex of a simplicial set X(u). 4. The space X(u) is shown to be the join of spaces X(v) for certain particular elements v in Pₘ. The spaces X(v) are shown to be contractible. Proposition 2.38. A guiding principle for constructing a series of retractions by deformation. Since each map ϕₖ is a retraction by deformation, the space X(u)=X(u)^{hm-2i} has the same homotopy type as X(u)^{h0i}=P hence it is contractible. Corollary 2.66 define a subgroup separating system ϕ(B) bias efficient B*B representations in normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 differential geometry, the second fundamental form (shape tensor) is a quadratic form on the tangent plane of a smooth surface consists in recovering a set of unobservable signals (sources) from a set of observed mixtures in the affine S to sets. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof of Equality (2.39). (2.67) Means that the equality (2.39) holds as an equality of complex functions in (Q, τ). Therefore, (2.39) holds as an equality of formal power series. Proposition 2.38. (We note that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose p is not pure, so there is μ>v>0 with v not a scalar multiple of μ. Then μ=(μ−v)+v which is a convex linear combination of states (once the terms have been normalized) using the fact that ∥μ−v∥=lim(μ−v)(eλ). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−x)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. Definition. A domain is a non-empty, path connected, open set in the complex plane. According to Theorem 2.66, a domain is also step connected. This means we can refer to a domain as being “connected,” meaning either path or step connected as appropriate. We summand a directed left module Q over the ring R so to be injective satisfying 1-1 structure of the Dual Algebra the monomials ε^{I} in a′ correspond in a one-to-one way with sequences of non-negative integers (i₁, i₂, • • • , iₙ, 0, • • • ) we now find the diagonal in a* the equivalence condition. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖϕₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n−cos Θ) transport properties generating series is three dimensions spinneret g-units of 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→}hyper-, ultra-, super-, fine-, course fine-, and course-size discretion optical class element silicon dioxide SiO₂; cobalt Co; feldspar AT₄O₈; zirconium ZrSiO₄; and selenium Se “glass” beads; optically filtered; elemental colors; transparent; translucent (natural); (hyper-) superset periodic elements Q are exactly solutions of a matrix equation where Q^{T} is the transpose of Q and I is the identity matrix M^{→}elements; colored dyes; and lakes. The product of an element; or in the product of two elements stationary; and independent increments elements of 1-1 structure n=2 elements dynamics of variable change complexification*, or two times the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜}=λ* is the complex conjugate of λ connected impellers; turbo-shaft; turbo-fan; turbo-fluid; turbo-jet; or fluid-propulsion negative [symbol] -axis y:[A, b]→S together with a subdivision a=τ₀<τ₁<τ₂<∧<τₙ=b of [A, b] contain 1. We show that it is sufficient to treat the case V=K. 2. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n-cos Θ) transport properties generating series is three dimensions spinneret g-units 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size grains silica sand polymeric gelling above, and below zero transition successively broken orthogonal ligands having the intrinsic property in quantities of Young's modulus of elastomericity, and tensile strength polymeric gelling cement. The product of an element; or in the product of two elements stationary; and independent increments elements of 1-1 structure n=2 elements, or docking matter natural base in silica route number of bonds geometric on surface area of hyper-, ultra-, super-, fine-, course fine-, and course-size discretion optical class element silicon dioxide SiO₂; cobalt Co; feldspar AT₄O₈; zirconium ZrSiO₄; and selenium Se “glass” beads; optically filtered; elemental colors; transparent; translucent (natural); (hyper-) superset periodic elements Q are exactly solutions of a matrix equation where Q^{T} is the transpose of Q and I is the identity matrix M” elements; colored dyes; and lakes. A semiprime is any integer normalized function of atmospheric, temperature and pressure correction value of number n is continued as phase factor for any complex number written in polar form (such as re^{iΘ}), the phase factor is the complex exponential factor (e^{iΘ}) the motion is uniform circular motion we incorporate the periodic set c equal to e so they are too fortuitously the base of the natural logarithm plane. The normalization function of a different action the motion of our system of equations eigenfunctions the principal of eigenvalues of arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H) Q I. Let the exact sequence K₀(l)→K₀(R)→K₀(R/I) where K₀(l) is defined as follows: adjoined unit by ring structure I^{˜}, which has some K-theory K₀(l). There is a map K₀(I^{→})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). Let A be a *-normed algebra with identity and p be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] π(a)v,v [symbol] . Let (π,H) be a *-representation of A on a Hilbert space H and let v be a vector in H. Let Kᵥ={π(a)v: α∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v¹, v². Let μ¹, μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence ∪ is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈λ} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,α∈A⇔(32); [symbol] v,π(a)*w [symbol] =0 ∀v∈K,α∈A⇔(33); [symbol] v,π(a*)w [symbol] =0 ∀v∈K, a∈A⇔ (34); π(a*)w∈K^{⊥} ∀α∈A (35) as desired. 208 C*-algebras Marc Rieffel Notes by Qiaochu Yuan Spring 2013. In the noncommutative case, we call such things C*-dynamical systems. A covariant representation of a C*-dynamical system (A,G,α) is a triple (H,π,U) where π is a representation of A on H and U is a unitary representation of G such that π (αx(a))=Uxπ(a)Ux−1. There is a universal C*-algebra whose representations correspond to covariant representations of a given C*-dynamical system. If f∈Cc(G,A) is a function on G with finite support and values in A and (H,π,U) is a covariant representation, we define σfv=Xπ(f(x))Uxv where v∈H. We operate on the Grassmannian Group Plate Projective Space, The Grassmannian Functor Let S be a scheme, E a vector bundle on S and k a positive integer less than the rank of E. Let Gr(k, S, E): {Schemes/S}→{sets} be the contravariant functor that associates to an S-scheme X subvector bundles of rank k of X×S E. Let the Hilbert Functor Let X→S be a projective scheme, O(1) a relatively ample line bundle and P a fixed polynomial. Let HilbP (X/S): {Schemes/S}→{sets} be the contravariant functor that associates to an S scheme Y the subschemes of X×S Y which are proper and flat over Y and have the Hilbert polynomial P and Let Moduli of stable curves Let −Mg: {Schemes}→{sets} be the functor that assigns to a scheme Z the set of families (up to isomorphism) X Z flat over Z whose fibers are stable curves of genus g. Given a contravariant functor F from schemes over S to sets, we say that a scheme X(F) over S and an element U(F)∈F(X(F)) represents the functor finely if for every S scheme Y the map HomS (Y, X(F))→F(Y) given by g→g*U(F) is an isomorphism. Given a contravariant functor F from schemes over S to sets, we say that a scheme X(F) over S coarsely represents the functor F if there is a natural transformation of functors [symbol] :F→HomS (*, X(F)) such that (1) [symbol] spec(k)):F (spec(k))→HomS (spec(k), X(F)) is a bijection for every algebraically closed field k, (2) For any S-scheme Y and any natural transformation Ψ:F→HomS (*, Y), there is a unique natural transformation Π:HomS (*, X(F)) HomS (*, Y) such that Ψ=Π∘ [symbol] . These functors above pose a moduli problem. The first step in our solution of such a problem is to construct a smooth, projective variety/proper scheme/proper Deligne-Mumford stack that represents the functor finely/coarsely. Let A be a unital *-algebra. A linear functional μ on A is positive if μ(a*a)≥0 for all a∈A. It is a state if it is positive and μ(1)=1 (these should be thought of as noncommutative probability measures). Example Let A be a *-algebra of operators on a Hilbert space H. Then if ψ∈H, the linear functional a→(aψ,ψ) is a state iff ψ is a unit vector in H. (21) This is a pure state in quantum mechanics. If A,μ are as above, [symbol] a,b [symbol] =μ(a*b) defines a pre-inner product on A. The vectors of length 0 form a subspace N by the Cauchy-Schwarz inequality. A/N therefore inherits an inner product which we can complete to obtain a Hilbert space L²(A,μ). This is the Gelfand-Naimark-Segal construction. A has a left regular representation πₐ(b)=ab on itself which descends to A/N because N is a left ideal. Moreover, this action is compatible with adjoints. However, πₐ is not necessarily bounded in general, so this action does not necessarily extend to the completion in general. We need to check that [symbol] a,b [symbol] is actually a pre-inner product. In particular, we need to check that [symbol] b,a [symbol] = [symbol] a,b [symbol] ⁻ (22). To see this, note that 0≤ [symbol] a+b,a+b [symbol] = [symbol] a,a [symbol] + [symbol] a,b [symbol] + [symbol] b,a [symbol] + [symbol] b,b [symbol] (23) from which it follows that the imaginary part of [symbol] a,b [symbol] + [symbol] b,a [symbol] is zero. Substituting ib for b we also conclude that the imaginary part of [symbol] a,ib [symbol] + [symbol] ib,a [symbol] is zero, and this gives the result. The above is equivalent to the claim that μ is *-linear if A has an identity but not in general. As a counterexample, let A be the algebra of polynomials vanishing at 0 and let μ(p)=ip⁰(0). Then [symbol] p,q [symbol] =0 identically but μ is not *-linear. Now let N be the subspace of vectors of norm zero. By Cauchy-Schwarz, N is also {a: [symbol] a,b [symbol] =0∀b∈A} and hence is a subspace. Furthermore, if b∈N, a∈A, then [symbol] ab,ab [symbol] = [symbol] b,a*ab [symbol] =0 (24) hence ab∈N and N is a left ideal. It follows that A/N is a left A-module, and the pre-inner product descends to an inner product on A/N which we can complete. We would like to extend the action of A to an action on the completion, but we do not have boundedness in general. For example, if A is the space of polynomial functions on R and μ(p)=∫^{∞}_{-∞}p(t)e^{-t2} dt (25) then we can check that the action of A is not bounded with respect to the corresponding inner product. So we need more hypotheses. Theorem 2.15. Let A be a *-Banach algebra with identity and let μ be a positive linear functional on A. Then μ is continuous and ∥μ∥=μ(1). Corollary 2.16. Let A be a *-normed algebra with identity and let μ be a continuous positive linear functional on A. Then ∥μ∥=μ(1). Proof. We will need the following lemma. Lemma 2.17. Let a∈A be self-adjoint with norm strictly less than 1. Then there exists a self-adjoint element b such that 1−a=b². To show this we can write √1−a as a convergent power series. It follows that μ(1−a)≥0, hence that μ(1)≥μ(a) for a self-adjoint with norm strictly less than 1. Similarly, μ(1+a)≥0, hence μ(1)≥−μ(a), so μ(1)≥|μ(a)|. It follows by a limiting argument that for any self-adjoint a∈A we have μ(1)∥a∥≥|μ(a)|. For arbitrary a, |μ(a)|²=| [symbol] 1,a [symbol] ²≤(1,1) [symbol] a,a [symbol] =μ(1)μ(a*a)≤μ(1)²∥a*a∥≤μ(1)²∥a∥² (26) and the conclusion follows. Proposition 2.18. Let A be a *-normed algebra with identity and let μ be a continuous positive linear functional. Then the left regular representation of A on A/N with inner product [symbol] ⋅,⋅ [symbol] is by bounded operators and extends to the completion; moreover, ∥πₐ∥≤∥a∥. Proof. Let a,b∈A. Define μ_{b}(c)=μ(b*cb). Then p₆ is also a continuous positive linear functional. Now: [symbol] πₐ(b),πₐ(b) [symbol] = [symbol] ab,ab [symbol] =μ(b*a*ab)=μ_{b}(a*a) (27) which is less than or equal to ∥μ_{b}∥∥a*a∥=μ_{b}(1) ∥a*a∥=μ(b*b) ∥a*a∥≤∥a∥² [symbol] b,b [symbol] (28) and the conclusion follows. So let A be a *-normed algebra with identity and μ be a continuous positive linear functional on A. Then L²(A,μ) is a nondegenerate *-representation of A Corollary 2.19. For every continuous positive linear functional μ on a *-normed algebra A, there is a *-representation of A and a vector v∈H such that μ(a)= [symbol] n(a)v,v [symbol] . Let (π,H) be a *-representation of A on a Hilbert space H and let v be a vector in H. Let Kᵥ={n(a)v:a∈A}⁻ (29). Then Kᵥ is invariant under the action of A; in fact it is the minimal closed subspace invariant under A containing v. We call Kᵥ the cyclic subspace generated by v. The representations L²(A,μ) is cyclic with cyclic vector the image of the identity. Proposition 2.20. Let (π¹,H¹,v¹) and (π²,H²,v²) be cyclic *-representations of A with cyclic vectors v²,v². Let μ¹,μ² be the corresponding states. If μ¹=μ² then the representations are unitarily equivalent. Proof. We want to take U(π¹(a)v¹)=π²(a)v². The problem is that this may not be well-defined. But we can compute that [symbol] U(π¹(a)v¹),U(π¹(b),v¹) [symbol] =μ²(b*a)=μ¹(b*a)= [symbol] π¹(a)v¹,π²(b)v¹ [symbol] (30) hence U is well-defined and unitary. The same argument works in the other direction. Hence there is a bijective correspondence between continuous positive linear functional on A and unitary equivalence classes of (pointed) cyclic *-representations of A. Let H_{λ} be a family of Hilbert spaces. We can form their Hilbert space direct sum ⊗_{λ∈∧} H_{λ}, which is the subspace of the ordinary product where the inner product [symbol] v,w [symbol] =Σ_{λ∈∧} [symbol] v_{λ},w_{λ} [symbol] (31) converges (equivalently the completion of the ordinary direct sum). If for each λ we have a representation π_{λ} of A on H_{λ}, we can try to define a representation on the direct sum. This is possible if and only if ∥π_{λ}(a)∥ is uniformly bounded in λ. In practice we will have ∥π_{λ}(a)∥≤∥a∥, in which case the same will be true of the direct sum. Proposition 2.21. If K⊂H is an invariant subspace of a *-representation, then so is its orthogonal complement K^{⊥}. Proof. If w∈K^{⊥}, then [symbol] π(a)v,w [symbol] =0 ∀v∈K,a∈A⇔(32); [symbol] v,π(a)*w [symbol] =0 ∀v∈K,a∈A⇔(33); [symbol] v,π(a*)w [symbol] =0 ∀v∈K,a∈A⇔(34); π(a*)w∈K^{⊥} ∀a∈A (35) as desired. Corollary 2.22. Finite-dimensional *-representations are completely reducible (semisimple). Proposition 2.23. Every *-representation on a Hilbert space H is a Hilbert space direct sum of cyclic representations. Proof. Imitate the proof that a Hilbert space has an orthonormal basis. (We don't get a decomposition into irreducible representations in general. We may need to use direct integrals instead of direct sums, and then direct integral decompositions need not be unique.) Definition The universal *-representation of A is the Hilbert space direct sum of all L²(A,μ) as μ runs over all positive linear functionals of norm 1 (states). The universal *-representation contains every cyclic representation. It follows that every *-representation is a direct summand of some sum of copies of the universal *-representation. A need not have any *-representations or states. For example, let A=C×C with the sup norm and (α,β)*=(β⁻, α⁻). Lemma 2.24. Let A be a C*-algebra and μ a continuous linear functional such that ∥μ∥=μ(1). Then μ is positive. Proof. We want to show that μ(a*a)≥0. equivalently, we want to show that if a∈A⁺ then μ(a)≥0. Suppose otherwise. Let B=C(X) be the *-algebra generated by a and restrict μ to B. First, we want to show that if f=f⁻ (in C(X)) then μ(f)∈R. Suppose μ(f)=r+is. Then for τ∈R we have |μ(f+it)|²≤∥f+it∥²=∥f∥²+t² (36) but the LHS is equal to |r+i(s+t)|²=r²+s²+2st+t² (37) and subtracting t² from both sides gives a contradiction unless s=0. Now, if f≥0 we have ∥f−∥f∥∥<∥f∥, hence |μ(f)−∥f∥|=|μ(f−∥f∥)|≤∥f∥ (38) which gives μ(f)≥0 as desired. Theorem 2.25. Let A be a unital C*-algebra and B a C*-algebra of A. Let μ be a positive linear functional on B. Then μ extends to a positive linear functional on A. Proof. Apply the Hahn-Banach theorem together with the lemma above. Theorem 2.26. Let A be a unital C*-algebra and a∈A self-adjoint. For any λ∈σ(a), there is a cyclic nondegenerate *-representation (π,H,v) with ∥v∥=1 such that [symbol] π(a)v,v [symbol] =λ. Proof. Let B be the C*-subalgebra generated by a, which is C(σ(a)). Let μ₀ be the functional defined on B given by the Dirac measure at λ. Then μ₀ is a state on B. Let μ^{˜}₀ be an extension of μ₀ to a state on A, and let (π,H,v) be the GNS representation associated to ^{˜}μ₀. Corollary 2.27. (Gelfand-Naimark) The universal representation of A is isometric (norm-preserving). Proof. Let a∈A. Then ∥π(a)∥²=∥π(a*a)∥. Let λ=∥a*a∥. The corresponding representation π_{λ} satisfies ∥π_{λ}(a*a)∥=λ=∥a*a∥, and the conclusion follows. Corollary 2.28. All of the above continues to hold if A is a non-unital C*-algebra. Let A be a *-normed algebra with a norm-1 approximate identity. Lemma 2.29. Let μ be a continuous positive linear functional on A. Then 1. μ(a*)=μ(a*)⁻. 2. |μ(a)|²∥μ∥μ(a*a). Proof. Write μ(a*)=limμ(a*e_{λ})=lim [symbol] a,e_{λ} [symbol] _{μ} (39) and since we know we have an inner product, this is equal to lim [symbol] e_{λ}, a [symbol] ⁻=lim μ(e*_{λ}a)⁻=μ(a)⁻ (40) as desired. Next, write |μ(a)|²=lim|μ(e_{λ}a)|²=lim| [symbol] e*_{λ},a [symbol] _{μ}|² (41) which by Cauchy-Schwarz is bounded by lim [symbol] a, a [symbol] _{μ} [symbol] e*_{λ}, e*_{λ} [symbol] ≤μ(a*a)∥μ∥ (42) as desired. Proposition 2.30. Let A be a *-normed algebra and let μ be a continuous positive linear functional on A. If μ satisfies the properties above and if μ extends to the unitization A^{˜} of A so that μ^{˜}(1)=∥μ∥, then μ^{˜} is a positive linear functional. Proof. The nontrivial thing to prove is positivity. We compute that μ^{˜}((a+λ1)*(a+λ1))=μ(a*a)+λμ⁻(a)+λμ(a)+|λ|²∥μ∥ (43) which is greater than or equal to μ(a*a)−2|λ∥μ(a)|+|λ|²∥μ∥≥μ(a*a)−2|λ∥|μ∥^{1/2}μ(a*a)^{1/2}+|λ|²∥μ∥=(μ(a*a)^{1/2}−|λ∥|μ∥^{1/2})²≥0 (44) and the conclusion follows. Corollary 2.31. Let A be a *-normed algebra with a norm-1 approximate identity. Let μ be a continuous positive linear functional on A. Extend it to A^{˜} by μ^{˜}(1)=∥μ∥. Then μ^{˜} is a positive linear functional on A^{˜}. with the above hypotheses, we can apply the GNS construction to obtain a cyclic representation (π,H,v) of A^{˜}. Proposition 2.32. If we restrict π to A, then v remains a cyclic vector for π|_{A}. Proof. Choose a self-adjoint sequence aₙ with ∥aₙ∥≤1 so that μ(aₙ)↑∥μ∥. Then ∥N(aₙ)v−v∥²=μ(a*ₙaₙ)−μ(aₙ)−μ(a*ₙ)+∥μ∥≤∥μ∥−μ(aₙ)→0 (45) as desired. If A is a non-unital *-normed algebra, (π,H) a nondegenerate *-representation, and e_{λ} is an approximate identity of norm 1, then π(e_{λ})π(a)v=π(e_{λ}a)v→π(a)v (46) hence in particular π(e_{λ})v→v for all v in a dense subspace of H. Since ex has norm 1, it follows that π(e_{λ})v→v for all v∈H. We conclude the following: Proposition 2.33. (π,H) is nondegenerate if and only if π(e_{λ})v→v for all v∈H. Corollary 2.34. Let A be a *-normed algebra with approximate identity e_{λ}. Let μ be a positive linear functional and (π,H,v) the corresponding GNS representation. Then μ(e_{λ})→ [symbol] π(e_{λ})v,v [symbol] → [symbol] v,v [symbol] =∥μ∥. Let A be a unital *-normed algebra and S(A) the space of positive linear functionals of norm 1 on A (states). S(A) is a closed subset of the unit ball of the dual A* in the weak-* topology, hence compact by Banach-Alaoglu. S(A) is also convex, which suggests that it would be interesting to examine its extreme points. The above fails if A is not unital. For example, if A=C₀(R) is the space of real-valued functions on R vanishing at infinity, the Dirac deltas δ(n) have limit 0 as n→∞, so the space of states on A is not closed. Schur's lemma in this context is the following. Lemma 2.35. (Schur) (π,H) is irreducible iff End_{A}(H)≅C. Note that End_{A}(H) is a C*-subalgebra of B(H) closed in the strong operator topology (a von Neumann algebra). Proof. If H is not irreducible, it has a proper invariant subspace K with invariant orthogonal complement K^{⊥}. It follows that the projection onto K belongs to End_{A}(H), which therefore cannot be isomorphic to C. If End_{A}(H) is not isomorphic to C, then it is a C*-algebra containing an element T which is not a scalar multiple of the identity. The C*-subalgebra generated by T contains a zero divisor whose kernel is an invariant subspace of H, so H is not irreducible. States Definition Let μ,v be positive linear functionals. Then μ≥v if μ−v≥0; we say that v is subordinate to μ. Given μ, let (π,H,v) be the corresponding GNS representation. Consider End_{A}(H). Let T∈End_{A}(H) be a positive operator smaller than the identity and set v(a)=v_{T}(a)= [symbol] π(a)Tv,v [symbol] (47). (Then T is the Radon-Nikodym derivative of v with respect to μ.) We compute that v(a*a)= [symbol] π(a*a)Tv,v [symbol] = [symbol] T^{1/2}π(a)v,T^{1/2}π(a)v [symbol] ≥0 (48) so v is positive. Similarly, μ−v is positive. Moreover, if v_{T}=v_{S} then T=S (by nondegeneracy). Conversely, suppose v is a positive linear functional with μ≥v≥0, we want to show that v=v_{T} for some T∈End_{A}(H). For a,b∈A we have |v(b*a)|≤v(a*a)^{1/2}v(b*b)^{1/2}≤μ(a*a)^{1/2}μ(b*b)^{1/2}=∥π(a)v∥∥π(b)v∥ (49). In particular, if the RHS is zero, so is the LHS. For fixed b, we can attempt to write down a map π(a)v→v(b*a) (50) which is well-defined by the above inequality. This is a linear functional of norm less than or equal to ∥π(b)v∥, so by the Riesz representation theorem there exists T∈End(H) such that v(b*a)= [symbol] π(a)v,T*π(b)v [symbol] (51). Since v≥0 we have T≥0. Since v≤μ, we have T≤I. To show that T∈End_{A}(H), write [symbol] π(c)Tπ(a)v,π(b)v [symbol] = [symbol] Tπ(a)v,π(C*b)v [symbol] (52)=v((C*b)*a) (53)=v(b*ca) (54)= [symbol] π(c)π(a)v,T*π(b)v [symbol] (55) which gives π(c)T=Tπ(c) by density. We can encapsulate our work above in the following. Proposition 2.36. The map T→v_{T} is a bijection between {T∈End_{A}(H): 0≤T≤1} and {v: μ≥v≥0). Definition A positive linear functional is pure if whenever μ≥v≥0 then v=rμ for some r∈[0,1]. Theorem 2.37. Let μ be a positive linear functional. Then μ is pure iff the associated GNS representation (π,H,v) is irreducible. Proof. If μ is not pure, there is μ≥v≥0 such that v is not a multiple of μ. Then there exists T∈End_{A}(H) not a scalar multiple of the identity, so by Schur's lemma, H is not irreducible. Conversely, if H has a proper invariant subspace, let P∈End_{A}(H) be the corresponding projection. Then v_{P} is not a multiple of μ. Proposition 2.38. (We may recall that the space of states S(A) is convex.) Let μ∈S(A). Then μ is pure if and only if μ is an extreme point of S(A). Proof. If μ is not extreme, μ=τμ₁+(1−τ)μ₂ where μᵢ∈S(A), τ∈(0,1), and μ₁≠μ≠μ₂. Then μ≥τμ₁, so μ is not pure. Conversely, suppose μ is not pure, so there is μ>v>0 with v not a scalar multiple of μ. Then μ=(μ−v)+v which is a convex linear combination of states (once the terms have been normalized) using the fact that ∥μ−v∥=lim(μ−v)(e_{λ}). Extreme points of S(A) are pure states. If A is unital, then S(A) is weak-* compact, so by the Krein-Milman theorem has many extreme points. A sketch of Krein-Milman is as follows. Definition Let K be a convex subset of a vector space. A face of K s a subset F such that if v∈F and v=τv₁+(1−τ)v₂ with 0<τ<1 and v₁,v₂∈K, then v₁,v₂∈F. A face of a face is a face. Let V be a locally convex topological vector space. If K is a convex compact subset of V and if ϕ∈V* takes its maximum on K at some point v₀, then {v∈K: ϕ(v₁)=ϕ(v₀)} is a closed face of K. By Hahn-Banach together with a Zorn's lemma argument we can find descending chains of closed faces which necessarily end at extreme points. Let (π^{a},H^{a}) be the direct sum of the GNS representations associated to all of the extreme points of S(A). Theorem 2.39. For any a∈A we have ∥π^{a}(a)∥=∥π^{∪}(a)∥=∥a∥ (where π^{∪} is the universal representation). Proof. Let a∈A be self-adjoint. Then there exists ρ∈S(A) with |ρ(a)|=∥a∥. Let Sₑ(A) be the set of extreme (pure) states of A. Suppose that there exists c such that |μ(a)|≤c<∥a∥ for all μ∈Sₑ(A). This inequality is preserved by convex combinations, so this inequality holds for any μ in the closure of the convex hull of Sₑ(A), which by Krein-Milman is all of S(A); contradiction. Hence there is a sequence μₙ∈Sₑ(A) such that |μₙ(a)|↑∥a∥. As a corollary, Gelfand and Raikov showed that locally compact groups have many irreducible unitary representations. Let A be a non-unital C*-algebra. We can define a quasi-state space Q(A) to be the space of all positive linear functionals with ∥μ∥≤1. This is also a compact convex subset of A* in the weak-* topology and its extreme points are the extreme states Sₑ(A) together with 0. 208 C*-algebras Marc Rieffel Notes by Qiaochu Yuan Spring 2013. ‘Differential form’ continued by the refrigeration component of U expanded, and cooled asymmetry condensations, moisture, and dew-point program temperature steady-state integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is an irrational number for which any finite pattern of numbers occurs with the expected limiting frequency in the expansion in a given integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 (cf. D. Ruelle and D. Sullivan. Currents, flows and diffeomorphisms. Topology 14) of sub-plasma (base), or expansion in a given integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 (cf. D. Ruelle and D. Sullivan. Currents, flows and diffeomorphisms. Topology 14) of atmospheric gases there is an element g′∈A′ such that g−g′ is decomposable (all bases), Madras [J. Statist. Rhys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). Cooling, and energy transmittance τ condensation gases in the direction of our affine factors (cf. D. Ruelle and D. Sullivan. Currents, flows and diffeomorphisms. Topology 14) the thermal system in relativity our affine S to sets integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 condensation “super-fluid” refrigeration particles plate, and rod connectivity conductance, and transfer gives us cooling, and energy transmittance τ condensation gases in the direction of our affine factors (cf. D. Ruelle and D. Sullivan. Currents, flows and diffeomorphisms. Topology 14). Cylindrical hydraulic integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 outflows; G-invariant system elliptical moisture collector; and G-invariant system circular moisture collector two straight series, and parallel conductors of infinite length continuous Unit circle in complex dynamics Julia set of discrete nonlinear dynamical system with evolution function f0(x)=x2 is a unit circle dynamical systems angle measure circle group Pythagorean trigonometric identity unit disk, unit sphere, unit hyperbola, unit square and z transform. In mathematics, a unit circle is a circle with a radius of one. Frequently, especially in trigonometry, the unit circle is the circle of radius one centered at the origin 0, 0 in the Cartesian coordinate system in the Euclidean plane. The unit circle is often denoted S¹, the generalization to higher dimensions is the unit sphere. If x, y is a point on the unit circle, then |x| and |y| are the lengths of the legs of a right triangle whose hypotenuse has length 1. Thus, by the Pythagorean theorem, x and y satisfy the equation x²+y²=1. Since x²=−x² for all x, and since the reflection of any point on the unit circle disk nearby the x- or y-axis is also on the unit circle, the above equation holds for all points x, y on the unit circle, not only those in the first quadrant. The interior of the unit circle is called the open unit disk, while the interior of the unit circle combined with the unit circle itself is called the closed unit disk. One may also use other notions of distance to define other unit circles, on mathematical norms. The complex plane 2 trigonometric functions on the unit circle 3 circle group 4 complex dynamics in the complex plane the unit circle unit of complex numbers, the set of complex numbers z of the form z=e^{it}=cos(t)+i sin(t) for all t, expand upon Euler's formula the complex plane 2 trigonometric functions on the unit circle 3 circle group 4 complex dynamics in the complex plane the unit circle unit of complex numbers, the set of complex numbers z of the form z=e^{it}=cos(t)+i sin(t) for all t, the relation of Euler's formula, as phase factor in quantum mechanics; and cylindrical hydraulic integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 outflows; condensations gives us an extra action mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, quadrupoles correspond terminus equivalence A×B Cartesian Product (set of ordered pairs from A and B) {1,2}×{3,4}={(1,3), (1,4), (2,3), (2,4)} to covariant representations of a given C*-dynamical system cylindrical hydraulic actuation mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, (cf. D. Ruelle and D. Sullivan. Currents, flows and diffeomorphisms. Topology 14). Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [τₙ,τₙ₊₁] for an ideal H of R the following are equivalent: (a) H is semiprime; (b) I²⊆H implies I⊆H for all left (right/two-sided) ideals I; (c) aRa⊆H implies that a∈H. Correspond to covariant representations of a given C*-dynamical system cylindrical hydraulic actuation mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 expanding on a line, and mechanical wave function integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 contracting on a line, (cf. D. Ruelle and D. Sullivan. Currents, flows and diffeomorphisms. Topology 14). Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if Θ′=aΘ+b/cΘ+d where ax+b/cx+d∈SL₂(Z), then A_{Θ},A_{Θ}0 are Morita equivalent (cf. D. Ruelle and D. Sullivan. Currents, flows and diffeomorphisms. Topology 14). Semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Bin(n,p) binomial distribution f(k)=ₙCₖ p^{k}(1−p)^{n-k} pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of atmospheric, temperature and pressure correction the value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1→4→3→1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁ (n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . . 2 A008306 1; 2; 6, 3; 24, 20; 120, 130, 15; 720, 924, 210; . . . . 3 A050211 2; 6; 24; 120, 40; 720, 420; 5040, 3948; 40320 4 A050212 6; 24; 120; 720; 5040, 1260; 40320, 18144; . . . . 5 A050213 24; 120; 720; 5040; 40320; 362880, 72576; . . . . The functions dᵣ (n, k) are given by the recurrence relation dᵣ (n, k)=(n−1) dᵣ (n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)1 (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)=b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for anytime discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Newtonian binomial theorem: (ⁿₖ)=n!/k!(n−k)!=n(n−1)(n−2) . . . (n−k+1)/k!. The expression on the right makes sense even if n is not a non-negative integer, so long as k is a non-negative integer, and we therefore define (^{r}ₖ)=r(r−1)(r−2) . . . (r−k+1)/k! when r is a real number. Generalized binomial coefficients share some important properties that (^{r}ₖ)=(^{r-1}ₖ₋₁)+(^{r-1}ₖ). Now remarkably: Newton's Binomial Theorem for any real number r that is not a non-negative integer, (x+1)^{r}=^{∞}Σᵢ₌₀(^{r}ᵢ)xⁱ when −1<X<1. Proof: the series is the Maclaurin series for (x+1)^{r}, and that the series converges when −1<X<1. prove: that the series is equal to (x+1)^{r}; Expand the function (1−x)⁻ⁿ when n is a positive integer: we first consider with nearby level surfaces (x+1)⁻ⁿ; we can simplify the binomial coefficients: (−n)(−n−1)(−n−2) . . . (−n−i+1)/i!=₍₋₁₎ⁱ(n)(n+1) . . . (n+i−1)i!=(−1)i(n+i−1)m(n−1)!=(−1)i(n+i−1i)=(−1)i(n+i−1n−1).(−n)(−n−1)(−n−2) . . . (−n−i+1)i!=(−1)i(n)(n+1) . . . (n+i−1)i!=(−1)i(n+i−1)!i!(n−1)!=(−1)i(n+i−1i)=(−1)i(n+i−1n−1). Thus(x+1)−n=Σi=0∞(−1)i(n+i−1n−1)xi=Σi=0∞(n+i−1n−1)(−x)i*(x+1)−n=Σi=0∞(−1)i(n+i−1n−1)xi=Σi=0∞(n+i−1n−1)(−x)i. Now replacing xx by −x−x gives (1−x)−n=Σi=0∞(n+i−1n−1)xi. (1−x)−n=Σi=0∞(n+i−1n−1)xi. So (1−x)−n(1−x)−n is the generating function for (n+i−1n−1)(n+i−1n−1), the number of submultiple sets of {∞·1, ∞·2, . . . , ∞·n}{∞·1, ∞·2, . . . , ∞·n} of size ii. We find it possible to directly construct the generating function whose coefficients solve a counting problem. We find the number of solutions to x1+x2+x3+x4=17x1+x2+x3+x4=17, where 0≤x1≤20≤x1≤2, 0≤x2≤50≤x2≤5, 0≤x3≤50≤x3≤5, 2≤x4≤62≤x4≤6. We can solve this problem using the inclusion-exclusion formula; alternately, we use generating functions. We consider the function (1+X+X2)(1+X+X2+X3+X4+X5)(1+X+X2+X3+X4+X5)(X2+>3+X4+X5+X6).(1+X+X2)(1+X+X2+X3+X4+X5)(1+x+x2+x3+x4+x5)(x2+x3+x4+x5+x6). We can multiply this out by choosing one term from each factor in all possible ways. If we then collect like terms, the coefficient of xkxk will be the number of ways to choose one term from each factor so that the exponents of the terms add up to kk. This is precisely the number of solutions to x1+x2+x3+x4=kx1+x2+x3+x4=k, where 0≤x1≤20≤x1≤2, 0≤x2≤50≤x2≤5, 0≤x3≤50≤x3≤5, 2≤x4≤62≤x4≤6. Thus, the answer to the problem is the coefficient of x17x17. with the help of a computer algebra system we get (1+X+X2)(1=+X+X2+X3+X4+X5)2(X2+X3+X4+X5+X6)X18+4x17+10x16+19x15+3 1x14+45x13+58x12+6 7x11+70x10+67x9+58x8+45x7+31x6+19x5+10x4+4x3+x2)(1+x+x2)(1+x+x2+x3+x4+x5)2(x2+x3+x4+x5+x6)=x18+4x17+10x16+19x15+31x14+45x13+58x12+(S7x11+70x10+67x9+58x8+45x7+31 6+19x5+10x4+4x3+x2, so the answer is 4. We find the generating function for the number of solutions to x1+x2+x3+x4=kx1+x2+x3+x4=k, where 0≤x1≤∞0≤x1≤∞, 0≤x2≤50≤x2≤5, 0≤x3≤50≤x3≤5, 1≤x4≤62≤x4≤6. We find that x1×1 is not bounded above. The generating function thus F(x)=(1+x+x2+ . . . )(1+x+x2+x3+x4+x5)2(x2+x3+x4+x5+x6)=(1−x)−1(1+x+x2+x3+x4+x5)2(x2+x3+x4+x 5+x6)=(1+x+x2+x3+x4+x5)2(x2+x3+x4+x5+x6)1−x. f(x)=(1+x+x2+ . . . )(1+x+x2+x3+x4+x5)2(x2+x3+x4+x5+x6)=(1−x)−1(1+x+x2+x3+x4+x5)2(x2+x3+x4+x5+x6)=(1+x+x2+x3+x4+x5)2(x2+x3+x4+x5+x6)1−x. We find that (1−x)−1=(1+x+x2+ . . . )(1−x)−1=(1+x+x2+ . . . ) is the familiar geometric series from calculus; alternately, this function has an infinite expansion: f(x)=x2+4x3+10x4+20x5+35x6+55x7+78x8+102x9+125x10+145x11+160x12+170x13+176x14+17 9x15+180x16+180x17+180x18+180x19+180x20+ . . . . f(x)=x2+4x3+10x4+20x5+35x6+55x7+78x8+l 02x9+125x10+145x11+160x12+170x13+176x14+179x15+180x16+180x17+180x18+180x19+180x 20+ . . . . We find a generating function for the number of submultiple sets of {∞.a, ∞.b, ∞.c}{∞.a, ∞.b, ∞.c} in which there are an odd number of aas, an even number of bbs, and any number of ccs. This is the same as the number of solutions to x1+x2+x3=nx1+x2+x3=n in which x1×1 is odd, x2x2 is even, and x3x3 is unrestricted. The generating function is therefore (x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x).(x+x3+x5+ . . . )(1+x2+x4+ . . . )(1+x+x2+x3+ . . . )=x(1+(x2)+(x2)2+(x2)3+ . . . )(1+(x2)+(x2)2+(x2)3+ . . . )11−x=x(1−x2)2(1−x). Newtonian binomial theorem: when r is a nonnegative integer, the binomial coefficients for k >r are zero, this equation reduces to the binomial theorem, and there are at most r+1 nonzero terms binomial series then taking the geometric series valid formula on the poles of the function in a Hilbert space is a vector space H with an inner product [symbol] f, g [symbol] such that the norm defined by |f|=√ [symbol] f, f [symbol] turns H into a complete metric space where ζ(s) is the Riemann zeta function, P(s) is the prime zeta function, and [S] is an Iverson bracket Riemannian manifold of nonnegative curvature. In differential geometry, for a null 50(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. We consider the group 50(2,2). The groups SO(m,n) as a Minkowski (space) already noted in his famous paper (we refer to), it is a simple matter of removing (or adding) an i here and there. Let us strip the Pauli matrix σ² of its i and define (for our purposes here) σ²≡(⁰₁⁻¹₀). Any real 2-by-2 matrix p (this matrix is of course to be distinguished from the matrix p in (1)) can be decomposed as p=p⁴|+p^{→}·σ^{→}=(^{p4}ₚ₁^{+p3}₊ₚ₂^{p4}ₚ₁^{-p3}₋ₚ₂) with (p¹, p², p³, p⁴) four real numbers. Now we have det p=(p⁴)²+(p²)²−(p³)²−(p¹)². Instead of SL(2,C), we now consider SL(2,R), consisting of all 2-by-2 real matrices with unit determinant. For any two elements Lₗ and Lᵣ of this group, transform p→p′=Lₗp(Lᵣ)^{T}. Evidently, det p′=(det Lₗ)(det p)(det Lᵣ)=det p. Thus, the transformation preserves the quadratic invariant (p⁴)²+(p²)²−(p³)²−(p¹)². This shows explicitly that the group SO(2,2) is locally isomorphic to SL(2,R)⊗SL(2,R), where the two factors of SL(2,R) reflects the fact that Lₗ and Lᵣ can be chosen independently of each other. For a null SO(2,2) vector p, that is, a real 4-vector such that (p⁴)²+(p²)²−(p³)²−(p¹)²=0, we can write pₐₐ_{^{⋅}}=λₐ, λ^{˜}ₐ_{^{⋅}}, with λ and λ^{˜} two independent real spinors. Indeed, λ and λ^{˜} transform independently, according to λₐ→(U)ₐ^{β} λ_{β} and λ^{˜}ₐ→(Lᵣ)ₐ^{.β.}λ^{˜}_{β}. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB +½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of natural gas, organic waste or biomass to synthesis gas pipeline standard a heater fluid dynamic mechanic class system transfer the integral Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−0):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m∈[0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] thermal cycle state of matter fluid, or the quantumstate₁ particulate matter (nanoparticle) conducting operational flow velocity μ of a fluid is a vector field μ the linearity defect of the residue field: Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. On the linearity defect of the residue field: We work with a noetherian local ring (R,ₘ,k) with the unique maximal ideal ₘ and the residue field k=R/ₘ, but with appropriate changes what we say will also cover the graded situation where (R,ₘ,k) is a standard graded k-algebra with the graded maximal ideal ₘ. Sometimes, we omit k and write simply (R,ₘ). Let M denote a finitely generated R-module. Let the minimal free resolution of M over R be F: . . . −→Fᵢ^{∂}→Fᵢ₋₁^{∂}→ . . . −→F₁^{∂}→F₀−→0. By definition, the differential maps Fᵢ into ₘFᵢ₋₁. Then F has a filtration G·F given by (GⁿF)ᵢ=mn−iFᵢ for all n,i (where ₘ^{j}=R if j≤0), for which the map (GnF)i=mn−iFi−→(GnF)i−1=mn−i+1Fi−1 is induced by the differential ∂. The associated graded complex induced by the filtration G·F, denoted by lin^{R} F, is called the linear part of F. We define the linearity defect of M as the number Id_{R} M=sup{i:Hᵢ(lin^{R} F)=06}. By convention, the trivial module is set to have linearity defect 0. We say that M is a Koszul module if Id_{R} M=0. Furthermore, R is called a Koszul ring if Id_{R} k=0. In the graded case, R is a Koszul algebra (i.e. k has a linear free resolution as an R-module) if and only if R is a Koszul ring, or equivalently, if and only if Id_{R} k<∞[19]. This is reminiscent of the result due to Avramov-Eisenbud and Avramov-Peeva [4], [6] saying that R is a Koszul algebra if and only if k has finite Castelnuovo-Mumford regularity reg_{R} k. It is not clear whether the analogous statement for local rings, that Id_{R} k<∞ implies R is Koszul, holds true; see [2], [30] for the recent progress on this question, and [1], [13], [25], [28], [32], [33] for some other directions of study. [19] Jurgen Herzog and Srikanth B. Iyengar, Koszul modules. J. Pure Appl. Algebra 201 (2005), 154-188. [4] Luchezar L. Avramov and David Eisenbud, Regularity of modules over a Koszul algebra. J. Algebra. 153 (1992), 85-90. [6] Luchezar L. Avramov and Irena Peeva, Finite regularity and Koszul algebras. Amer. J. Math. 123 (2001), 275-281. [2] Rasoul Ahangari Maleki, On the regularity and Koszulness of modules over local rings. Comm. Algebra 42 (2014), 3438-3452. [30] Liana M. Sega, On the linearity defect of the residue field. J. Algebra 384 (2013), 276-290. [1] Rasoul Ahangari Maleki, On the regularity and Koszulness of modules over local rings. Comm. Algebra 42 (2014), 3438-3452. [13] David Eisenbud, Gunnar Fløystad and Frank-Olaf Schreyer, Sheaf cohomology and free resolutions over exterior algebras. Trans. Amer. Math. Soc. 355 (2003), 4397-4426. [25] Ryota Okazaki and Kohji Yanagawa, Linearity defects of face rings. J. Algebra 314 (2007), no. 1, 362-382. [26] Irena Peeva, Graded syzygies. Algebra and Applications. Volume 14, Springer, London (2011). [28] Tim Romer, On minimal graded free resolutions. Ph.D. dissertation, University of Essen (2001). [32] Kohji Yanagawa, Castelnuovo-Mumford regularity for complexes and weakly Koszul modules. J. Pure Appl. Algebra 207 (2006), no. 1, 77-97. [33] Linearity defect and regularity over a Koszul algebra. Math. Scand. 104 (2009), no. 2, 205-220. Institut fur Mathematik, Friedrich-Schiller-Universitat Jena, Ernst-Abbe-Platz 2, 07743 Jena Dipartimento di Matematica, Universita di Genova, Via Dodecaneso 35, 16146 Genoa, Italy. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[{ΔiB)²−Δᵢ], with x₀⁽ⁿ⁾=x₀ the equidistant Milstein approximation converges strongly with order (1.0) atoms, and intramolecular hybridization molecules are derived from organic chemistry recycled Foods waste product; Farm waste products (animal, or agricultural); natural plant kingdom species plant product; fresh water algae product; salt water algae product; or blue-green algae (Cyanobacteria, also known as Cyanophyta) product given a space X such a family (Dₓ)_{x∈x} of elliptic operators parametrized by X is given by a longitudinal elliptic operator D an element of the K-group of the parameter space groupoid longitude, or transverse combination. Continuous of the homomorphism [symbol] :Y→Q such that [symbol] f=g, the following diagram commutes: [symbol] *0→X ^{g}↓_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let A be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(σ)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m+n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁; whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′ aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, U is well-defined and unitary, or in category of sheaves of O_{X}-modules over some ringed space (X,O_{X}) a right Noetherian. (We refer to) Chapters Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r >0 in Z one has r=1+1+^{(r)} . . . +1, and thus rm=(1+ [symbol] +1)m=1m+^{(r)} . . . +1m=m+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=a(v) extending to xⁿ*v:=αⁿ(v)=α(α(⁽ⁿ⁾ . . . α(v))) and (Σαᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→V by α(v):=x*v, by the module axioms, a is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(αᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all a, b∈P one has a+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • , iₙ, 0, • • • ). The admissible monomials Sq^{I′}∈a correspond to sequences of integers (i′₁, i′₂, • • • , i′n, 0, • • • ) where i′ₖ≥2i′ₖ₊₁ and i′ₙ≥1. It remains only to set up a one-to-one correspondence between sequences of non-negative integers I and admissible sequences I′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences f by insisting that Iₖ be sent to I′ₖ and that the map be additive (with respect to coordinate-wise addition). Then if I=(i₁, • • • , iₙ, 0, • • • )→I′=(i′₁, • • • , i′ₙ, 0, • • • ) ε^{I} and Sq^{I′} have the same degree and we have i′ₖ=iₖ+2iₖ₊₁+ • • • +2^{n-k} iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”, (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ(K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*_{P}(K;A) be the homology of the complex C*_{P}(K;A) and H*_{P}(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*_{P}(K;A) by 1.2. 1.4. Lemma. An inner automorphism of the algebraic triple (p,A,K) induces the identity map on H*_{P}(K;A). Proof. The induced map is the identity on the cochain level. 1.5. Lemma. Let (p,A,K) be an algebraic triple. Let n be a normal subgroup of p and let y→p. Let g:(π,A,K)→(π,A,K) be the automorphism determined by y. Then the image H*_{P}(K;A)→H*_{π}(K;A) is pointwise invariant under the automorphism g.* Proof, let f: (p,A,K)→(p,A,K) be the inner automorphism determined by y. Then by 1.2, the following diagram is commutative H*_{P}(K;A)H*_{P}(K;A)→H*ₚ(K;A); and H*_{P}(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face of τ is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(α) C(τ) for all α∈p and τ∈K. Let ϕ:K→L be a chain map: we say ϕ is carried by C If ϕ(x) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K′ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group π, we can always construct a π-free acyclic simplicial complex W. Proof. We give π the discrete topology and form the infinite repeated join W=π*π>π . . . . This repeated join is a simplicial complex. Taking the join of a complex with a point gives us a contractible space. Any cycle in W must lie in a finite repeated join W′. Such a cycle is homologous to zero in W′*π. Therefore, W is acyclic. We make π act on W as follows: n acts by left multiplication on each factor n of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell τ∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*_{P}(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C*ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n-k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ, bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3}, (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1 →4 →3 →1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S3, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2}(132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁(n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . . 2 A008306 1; 2; 6, 3; 24, 20; 120, 130, 15; 720, 924, 210; . . . . 3 A050211 2; 6; 24; 120, 40; 720, 420; 5040, 3948; 40320, . . . . 4 A050212 6; 24; 120; 720; 5040, 1260; 40320, 18144; . . . . 5 A050213 24; 120; 720; 5040; 40320; 362880, 72576; . . . . The functions dᵣ (n, k) are given by the recurrence relation dᵣ (n, k)=(n−1) dᵣ(n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0. Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q ), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. The example that the “topology” of X is far from being trivial, that it gives rise to the C*-algebra A, which is a simple C*-algebra, uniquely characterized as a C*-algebra (up to Morita equivalence) by the properties 1) A is the inductive limit of finite-dimensional algebras. It is said to be approximately finite (or AF). 2) (K₀(A), K₀(A)⁺)=(Z², {(a, b); 1+√5/2 a+b≥0}). Permutation cycle a coherence length: let dᵣ (n, k) be the number of the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor is the complex exponential factor (e^{iΘ}). Proposition. Frequency V contribution specific heat mechanical wave function expanding on a line, and mechanic wave function contracting on a line we consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|_{XT}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for anytime discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. In its simplest form, a n×1 vector x of observations (typically, the output of n sensors semiprecious mineral, semiprecious rhenium, semi-precious hafnium, nitrogen, and carbon Hf—C—N, semi-precious hafnium-oxide (mosfet), or semi-precious yttrium-oxide (mosfet). We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,T] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for anytime discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ /∈ InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations let [symbol] =f(xᵢ, cⱼ), where f is a twice continuously differentiable function of the local coordinates xᵢ (i=1, . . . , p) and of the local values of the parameters cⱼ (j=1, . . . , q). Our theorem here suppose that (i) E(|X₀|²)<∞, (ii) E(|X₀−Y₀^{δ}|²)^{1/2}≤K₁ δ^{1/2}, (iii) |a(t,x)−a(t,y)|+|b(t,x)−b(t,y)|≤K₂|x−y|, (iv) |a(t,x)|+|b(t,x)|≤K₃(1+|x|), (v) |a(s,x)−a(t,x)|+|b(s,x)−b(t,x)|≤K₄(1+|x|)|s−t|^{1/2} for all s,t∈[0,1] and x,y∈R^{d}, where the constants K₁, K₂, K₃, K₄ do not depend on δ. Then, for the Euler approximation Y^{δ}, the estimate E(|X_{T}−Y^{δ}(T)|)≤K₅δ^{1/2} holds, where the constant K₅ does not depend on δ. Proof. We refer to survey of numerical solution of stochastic differential equations of P. E. Kloeden and E. Platen. High-order methods for strong sample path approximations and for weak functional approximations. In our case, the Euler scheme may actually achieve a higher order of strong convergence. For when, the process of pointwise isotypic components Bₙ of squelch of squelch (noise) is additive, or when, the process of pointwise isotypic components Bₙ of squelch of squelch (noise) disable is subtractive, that is when the diffusion coefficient has the form b(t,x)≡b(t) for all (t,x)∈R⁺×R^{d}, it turns out that the Euler scheme has order [symbol] =1.0 of strong convergence under appropriate smoothness assumptions on a and b. We remark that additive noise is sometimes understood to have b(t) as constant. The Euler scheme gives good numerical results when the drift and diffusion coefficients are nearly constant. Again, the condition for f(x) to have a continuous second derivative can be relaxed with continued work. We use higher order schemes in our affine function to have b(t) as constant. The Euler scheme is our simplest strong Taylor approximation, containing only the time and Wiener integrals of multiplicity one from the Itô-Taylor expansion, which we will call X an equilibrium point more explicitly, the factor in our affine geometric construction. The conclusion which can be drawn from this study of numerical solution of stochastic differential equations are these: I. It is important that the trajectories, that is our paths, of the approximation should be close to those of the Itô process in some problem schemes. We need to consider the absolute error at the final time instant T, that is ²(δ)=(E|X_{T}−Y_{N}|^{q})^{1/q} for k≥1. The absolute error is certainly a criterion for the closeness of the sample paths of the Itô process X and the approximation Y at time T. We shall say that an approximation process Y converges in the strong sense with order [symbol] ∈(0,∞] if there exists a finite constant K and a positive constant δ₀ such that E|X_{T}−Y_{N}|≤Kδ^{r} for any time discretization with maximum step size δ∈(0,δ₀). Our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras. It is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of L can be synthesized colimit 2.0 topology. The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²++eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}). The Euler approximation for SDEs Yₙ₊₁=Yₙ+a(Yₙ)Δₙ+b(Yₙ)ΔWₙ has strong order [symbol] =0.5. II. We may be interested only in some function of the value of the Itô process at a given final time T such as one of the first two moments EX_{T} and E(X_{T})² or, more generally, the expectation E(g(X_{T})) for some function g. In simulating such a functional it suffices to have a good approximation of the probability distribution of the random variable X_{T} and sampled functions leads to a sampling theorem for finite sequences of the sample paths and gives us a simple derivation. We shall say that a time discrete approximation Y converges in the weak sense with order β∈(0,∞] if for any polynomial g there exists a finite constant K and a positive constant δ₀ such that E(g(X_{T}))−E(g(Y_{N}))≤Kδ^{β} for any time discretization with maximum step size δ∈(0,δ₀). We see that an Euler approximation of an Itô process converges with weak order β=1.0, which is greater than its strong order of convergence [symbol] =0.5. III. We obtain the Milstein scheme by adding the additional term Yₙ₊₁=Yₙ+aΔₙ+bΔWₙ+½bb′{(ΔWₙ)²−Δₙ} we shall see that the Milstein scheme converges with strong order [symbol] =1.0 under the assumption that E(X₀)²<∞, that a and b are twice continuously differentiable, and that a,a⁰,b,b⁰ and b⁰⁰ satisfy a uniform Lipschitz condition. We represent Err(T,h) as a function of h Err(T,h)=e₁(T)h+e₂(T)h²+ [symbol] +eₘ(T)h^{m}+O(h^{m+1}). If the above result is verified, higher order approximations of functionals can be obtained with lower order weak schemes by extrapolation methods. D. Talay and L. Tubaro proposed an order 2.0 weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}). The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈ InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁→∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on S₁=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′,M₀, f₀, M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ (W, M₀)∈Wh(π₁(M₀)), (7.2) is defined to be the preimage of the Whitehead torsion (see Definition 6.12) τ M₀^{f0}→∂₀Wⁱ⁰→W)∈Wh(π₁(W)) under the isomorphism (i₀∘f₀)*: Wh(π₁(M₀))^{≅}→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II]. More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45]. The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)≥5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H*(M)≅H*(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i =0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×{0}, Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿi to a homeomorphism f₁⁻:Dⁿ₀→Dⁿ₁. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0} Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6]. Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₄ in solution X X₀iX₁ to AXB C over C with its applications, and Liu et al. 9 derived the maximal and minimal ranks of the two real matrices X₀ and X₁ in a Hermitian solution X X₀iX₄ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x>y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀ x, y∈S:x^{˜}y⇒(x^{˜}x ∧ y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ˜ on a set S is the smallest reflexive relation on S that is a superset of ˜. equivalently, it is the union of ˜ and the identity relation on S, formally: (≃)=(˜)∪(=). For example, the reflexive closure of x<y is x≤y. The reflexive reduction, or irreflexive kernel, of a binary relation ˜ on a set S is the smallest relation \tilde{≠} such that \tilde{≠} shares the same reflexive closure as ˜. It can be seen in a way as the opposite of the reflexive closure. It is equivalent to the complement of the identity relation on S with regard to ˜, formally: (\tilde{≠})=(˜)\(=). That is, it is equivalent to ˜ except for where x˜x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0}αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τX)f)(x)−f(x)/τ αₓ(b)dx=J(Dₓf)(x)αₓ(b)dx where we use the fact that (α_{y}f)(x)=f(y⁻¹x). It true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Carding domain). The construction b→α_{f}(b) normal k-smoothing isometries is often called smoothing, or mollifying. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x ∈[0,1] and F(x):=0 for x∉[0,1]. Then F is also continuous [n-mosfet generated by symbols {A₁, . . . , Aₛ}] power series expansion. Then we have (modeled as x=A*s where the ‘mixing matrix’ is invertible and the n×1 vector s=[s₁, . . . , sₙ]^{T}) isotypic components Bₙ, where bₙ∈Bₙ if αᵥ(bₙ)=e^{2πi} [symbol] n,v [symbol] bₙ. For bₙ∈Bₙ we have Dᵥ(bₙ)=2πi [symbol] n,v [symbol] bₙ. From here it follows that Bₙ ⊆B^{∞}. If b∈B^{∞} then (Dₓ(b))ₙ=Dₓ(bₙ) where bₙ is the n^{th} isotypic component. Let e₁, . . . e_{d} be a basis of R^{d}. Then (D^{2p}ₑ₁ D^{2p}ₑ₂ . . . D^{2p}_{ed}) (bₙ)=(2πi)^{2pd} [symbol] n, e₁ [symbol] ^{2p} [symbol] . . . [symbol] n, e_{d} [symbol] ^{2p}bₙ from which it follows that ∥bₙ∥≤1/1+( [symbol] n, e₁ [symbol] . . . [symbol] n, e_{d} [symbol] )^{p}(D^{2p}ₑ₁ . . . D^{2p}_{ed})(b) Hence if b∈B^{∞}then ∥bₙ∥ lies in the Schwartz space on Z^{d}. Proposition 7.7. The converse holds. That is, if bₙ is a function on Z^{d} with bₙ∈Bₙ such that ∥bₙ∥ lies in the Schwartz space, then b=^{p}bₙ∈B^{∞}. Proof. Given X∈R^{d} regarded as the Lie algebra of T^{d} we have Dx(b)=lim_{r→0}αᵣx(b)−b/r=lim_{r→0}Σₙαᵣx(bₙ)−bₙ/r=lim_{r→0}Σₙe^{2πir} [symbol] n, X [symbol] −1/r bₙ=lim_{r→0}Σn2πi [symbol] n, X [symbol] bₙ as expected (where everything converges appropriately because ∥bₙ∥ decays rapidly). There is a bijective correspondence between continuous positive linear functional on A and unitary equivalence classes of (pointed) cyclic *-representations of A or in category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). For any real number n≥0, an algorithm is input calculated for the value of the loop model meaning in mathematics a loop is a closed curve whose initial and final points coincide in a fixed point p known as the base point. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I). There is a map K₀(I^{˜})→K₀(k)≅Z. Formally, if X is a topological space and p∈X, a loop is a continuous map L:[0, 1]→X such that L (0)=p and L (1)=p. Proposition. Loop-degenerate ρ(E), we decompose L (0)=p and L (1)=p X is a topological space and p∈X, a loop is a continuous map L:[0, 1]→X such that L (0)=p and L (1)=p (we refer to) “constructions if I is a closed 2-sided ideal of a C*-algebra A, then the quotient A/I is also a C*-algebra. The forgetful functor from unital Banach algebras to non-unital Banach algebras has a left adjoint which is obtained by adjoining an identity” loop-degenerate ρ(E). “The unitalization construction A→A^{˜} is given by pairs (α,a) where α∈C and a G A which add in the obvious way and multiply so that (1,0) is the identity. The obvious norm here is k(α,a)k=kαk+kak, and this gives a Banach algebra. However, if we start with a non-unital C*-algebra, we do not necessarily get a unital C*-algebra. To fix this, let A be a C*-algebra. Consider An regarded as a right A-module. Define an A-valued inner product by [symbol] (ak), (bk) [symbol] A=Σk a*kbk. The motivating example is that A=C(X), where the inner product behaves like a metric on the trivial bundle X×Cn. From such an A-valued inner product we can induce a norm given by |hv,viA|½. Now suppose A is non-unital and regard A as a right A-module. Given (α,a)∈A^{˜} (the unitalization), we can define a module endomorphism given by T(α,a):b→αb+ab and define k(α,a)k=kT(α,a)k where the second is the operator norm. This is a C*-norm on A^{˜}, which can be proven using basic properties of the A-valued inner product. In some situations we might not want to adjoin an identity. We can sometimes avoid this using approximate identities. Definition Let A be a normed non-unital algebra and {eλ} a net of elements of A. Such a net is a left approximate identity if limeλa=a for all a∈A. An approximate identity is bounded if keλk≤k for all λ, and is of norm 1 if keλk≤1. Similarly we have right and two-sided approximate identities. Proposition. Let A be a unital C*algebra and let L be a left ideal in A, not necessarily closed. Then L has a right approximate identity of norm 1 consisting of elements of A+. If A is separable, then we can arrange for the approximate identity to be a sequence. Proof. Let S be a dense subset of L (countable if A is separable). Let ∧ be the collection of all finite subsets of S ordered by inclusion. Given λ∈λ, let bλ=Xa*a. a∈λ Since L is a left ideal, bλ∈L and is positive. Let eλ=(1/|λ|+bλ)−1 bλ Again we have eλ∈L, and again eλ is positive. The claim is that eλ is a right approximate identity for L. To see this, let a∈S. Consider ka−aeλk. If α∈A, then ka−aeλk2=ka(1−eλ)k2=k(1−eλ)a*a(1−eλ)k but since α∈A we know that a*a≤bλ, so we conclude by two previous inequalities that k(1−eλ)a*a(1−eλ)k≤k(1−eλ)bλ(1−eλ)k=k(1−eλ)2bλk. We now compute that (1−eλ)2bλ=1/n bλ/1/n+bλ whose norm tends to 0 as desired (where n=|λ|). This establishes that eλ is a right approximate identity for elements in S, and the general conclusion follows by boundedness and density. Proposition Let I be a closed 2-sided ideal of a unital C*-algebra A. Then I is closed under taking adjoints, so is a (non-unital) C*-algebra. Proof. Let eλ be a right approximate identity for I satisfying the conditions above. Let a∈I. Then ka*−eλa*k=ka−aeλk→0. Since I is a two-sided ideal, eλa*∈I, hence a*∈I by closure. Proposition. Any C*-algebra A, not necessarily unital, contains a two-sided approximate identity of norm 1 consisting of elements of A+. Proof. Since A is a closed left ideal, it has a right approximate identity eλ. Since A is closed under taking adjoints, the right approximate identity is a two-sided approximate identity. Let I and J be two-sided closed ideals. Then I∩J⊇IJ (the closure of the span of products of elements of I and elements of J). Now take an approximate identity eλ in I. Then if a∈I∩J we have ka−aeλk→0 where aeλ∈IJ, hence a∈IJ, so I∩J=IJ. Also, if I is a two-sided closed ideal of A and J is a two-sided closed ideal of I, then in fact J is an ideal of A. Let A be a non-unital Banach algebra and I a (proper) closed 2-sided ideal of it. Then A/I is a Banach space (since I is closed) and a Banach algebra (since I is a 2-sided ideal). Theorem 2.13. (Segal) If A is a C*-algebra, so is A/I. We will adjoin a unit as necessary. The key fact is that if {eλ} is a positive norm-1 identity for I, then k1−eλk≤1, and is in fact equal to 1. Proof. We will need the following lemma. Lemma 2.14. For all A∈A we have kakA/I=limka−ae|lambdak. Proof. Fix >0. Choose d∈I such that ∥a−d∥≤∥a∥A/I+∈. Then ka-aeλk=ka(1−eλ)ₖ≤k(a−d)(1−eλ)k+kd(1−eλ)k≤ka−d|+kd−deλk which is less than or equal to ∥a∥A/I+2∈ for λ suitably far into the net. We used the key fact above. Now we want to show that the norm on A/I satisfies the C*-identity. We have kak2A/I=limka(1−eλ)k2=limk(1−eλ)a*a(1−eλ)k≤limsupka*a(1−eλ)k≤kka*ak by the key lemma as desired”. (The Longitudinal Index Theorem for Foliations A. Connes* and G. Skandalis** 1983). Solving for the greatest lower bound base the objects are pairs (X, x₀), where X is a topological space and x₀ is a point in X. A morphism from (X, x₀) to (Y, y₀) is given by a continuous map f:X→Y with f(x₀)=y₀. To every topological space X with distinguished point x₀, one can define the fundamental group based at x₀, denoted π₁(X, x₀). This is the group of homotopy classes of loops based at x₀. If f:X→Y is a morphism of pointed spaces, then every loop in X with base point x₀ can be composed with f to yield a loop in Y with base point y₀ commute specific base cohomology properties. There is a universal C*-algebra whose representations correspond to covariant representations of a given C*-dynamical system position optimal control theory 3-7. Groß in 8, and Liu et al. in 9 gave the solvability conditions for Hermitian solution and its expressions composite number 2ⁿ−1 fluid dynamics control enhance mathematic optimum series, and parallel integral to the current dynamical system normalized function of atmospheric, temperature and pressure correction in the presence of constraint state of the input in optimal control. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖiψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). Formal Dirichlet generating series number A spaces two coordinates position normal vector the solution set of A finite system Ax≤b of m inequalities with n variables A is m×n matrix is convex, A set of this type is three dimensions in steady-state motion with α, β, and ϕ small, is written with equations in terms of load factor as (n-cos Θ) transport properties generating series is three dimensions spinneret g-units of 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion silica sand grains grounded hyper-, ultra-, super-, or fine-particles continuous suspended, and 3-dimensional volume continuously vertically, or horizontally drawn, and driven; or silica sand particles hyper-, ultra-, super-, or fine-fractured chards of needles continuous suspended, and 3-dimensional volume continuously vertically, or horizontally drawn, and driven. The anthracite high carbon count coal dust slimes (less than, or greater than 0-0.2 mm); or calcium carbonate CaCO₃ continuous particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion polymeric “black” beads; or “slake glass white” beads. The product of an element; or in the product of two elements stationary; and independent increments elements of 1-1 structure n=2 elements, or docking matter. Dirichlet carrier-function L(s,χ) character, χ for the solid domain linear approximation by ridgelets converges rapidly to nice ridge functions let Uᵢ be the open star of the i^{th} vertex Xᵢ of L′. Then (Uᵢ) is an open covering of L. We can choose a barycentric subdivision K′ of K such that each simplex τ of K′ is contained in a set of the form f⁻¹(Uⁱ). Then the minimal carrier of T consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ is also referred to as a Dirichlet character, χ for the function of transport properties generating series is three dimensions spinneret g-units of 1-1 structure of the Dual Algebra the monomials ε^{I} in a′ correspond in a one-to-one way with sequences of non-negative integers (i₁, i₂, • • • , iₙ, 0, • • • ) we now find the diagonal in a* every three-dimensional vector is written as a linear combination of the three mathematics vector calculus differentiation and integration over the vector field particle matter physics: (hyper-) superset periodic elements Q are exactly solutions of a matrix equation where Q^{T} is the transpose of Q and I is the identity matrix M^{→} hyper-, ultra-, super-, fine-, course fine-, and course-size discretion coal, and silica sand “black” beads independent, and stationary increments Anthracite coal bitumen; petrochemical raw crude oil pavement pellet product “high carbon count coal dust slimes cemented tar mixtures”.

2. The product of an element; or in the product of two elements stationary; and independent increments elements of 1-1 structure n=2 elements, or docking matter dynamics of variable change complexification*, or two times twice the momentum is characterized by 4 real numbers p^{μ}, the matrix pₐₐ_{^{⋅}}=−p_{μ}(σ^{μ})ₐₐ_{^{⋅}} is Hermitian, which implies that λ^{˜} =λ* is the complex connected impellers negative z-axis impellers y:[A, b]→S together with a subdivision a=τ₀<τ₁<τ₂<∧<τₙ=b of [A, b] Dirichlet generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points in number theory the sum of their Dirichlet series arrangement (A,w). Compression member rotary-screw; centrifugal; or turbo-jet impeller basic; volute; or o-ring seal closed casing; or open fluid dynamics advanced casing (without seal) s structural elements that are subjected to axial compressive forces only are called columns. Columns are subjected to axial loads thru the centroid stress: the stress in the column cross-section can be calculated as f=P/A where f, is assumed to be uniform over the entire cross-section. The stress-state will be non-uniform due to: accidental eccentricity of loading with respect to centroid; member rotary-screw; centrifugal; or turbo-jet impeller basic; volute; or o-ring seal closed casing; or open fluid dynamics advanced casing (without seal) out-of-straightness (crookedness); or residual stresses in the member rotary-screw; centrifugal; or turbo-jet impeller basic; volute; or o-ring seal closed casing; or open fluid dynamics advanced casing (without seal) cross-section due to fabrication processes. Accidental eccentricity and member rotary-screw; centrifugal; or turbo-jet impeller basic; volute; or o-ring seal closed casing; or open fluid dynamics advanced casing (without seal) out-of-straightness can cause bending moments in the member rotary-screw; centrifugal; or turbo-jet impeller basic; volute; or o-ring seal closed casing; or open fluid dynamics advanced casing (without seal). However, these are secondary and are usually ignored. Bending moments cannot be neglected if they are acting on the member rotary-screw; centrifugal; or turbo-jet impeller basic; volute; or o-ring seal closed casing; or open fluid dynamics advanced casing (without seal). Members with axial compression and bending moment are called beam-columns. Column buckling consider a long slender compression member rotary-screw; centrifugal; or turbo-jet impeller basic; volute; or o-ring seal closed casing; or open fluid dynamics advanced casing (without seal). If an axial load P is applied and increased slowly, it will ultimately reach a value P_{cr} that will cause buckling of the column. P_{cr} is called the critical buckling load of the column. We correct metallurgy defects by employing advanced die-cast mold and foundry procedure with state-of-the-art machining techniques. We further reduce metallurgy defect with two state-of-the-art test generators 1. Advanced foundry precision tool and die-cast mold refinement technique; and 2. Synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}→0, as mesh(τn)→0. One could use E sup_{θ≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order (1.0) atoms, and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of higher aggregation sinterization (oxygen, gases, and elements). Sintering is the process of compacting and forming a solid mass of matter by specific heat, and pressure without melting it to the point of liquefaction. Smelterization is the smelting process of applying specific heat, and pressure to ore in order to melt out a base metal extractive metallurgy to extract metal from their ore, base metal; or raw iron ore. Higher aggregation sinterization (oxygen, gases, and elements) atoms and intramolecular hybridization molecules yield wrought iron; or high purity metal. Particle matter physics: (hyper-) superset periodic elements Q are exactly solutions of a matrix equation where Q^{T} is the transpose of Q and I is the identity matrix M^{→} molecular n-layered strengthened tool-metal; and high-carbon percentage mixture allotropes of carbon nanotubes CNT's structure of alloy lower defect properties. An element of the K-group of the parameter space groupoid of the manifold M through the associated C*-algebra C*ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, Leibniz's rule for differentiation under the integral sign ∫, for an integral of the form ₐ₍ₓ₎∫^{b(x)} f(x,t) dt, where −∞<a(x), b(x)<∞ the derivative of this integral is expressible as d/dx(ₐ₍ₓ₎∫_{b(x)} f(x,t) dt)=f(x, b(x))·d/dx b(x)−f(x, a(x))·d/dx a(x)+a(x)∫b(x) ∂/∂x f(x, t) dt, where the partial derivative indicates that inside the integral, only the variation of f(x, t) with x is considered in taking the derivative. Notice that if a(x) and b(x) are constants rather than functions of x, we have a special case of Leibniz's rule: d/dx (a∫b f(x, t) dt)=ₐ∫^{b} ∂/∂x f(x, t) dt. Thus under certain conditions, one may interchange the integral and partial differential operators. This important result is particularly useful in the differentiation of integral transforms. A moment generating function in probability theory, a variation of the Laplace transform, which can be differentiated to generate the moments of a random variable. Whether Leibniz's integral rule applies is essentially a question about the interchange of limits. Theorem. Let f(x, t) be a function such that both f(x, t) and its partial derivative fₓ(x, t) are continuous in t and x in some region of the (x, t)-plane, including a(x)≤t≤b(x), x₀≤x≤x₁. Also suppose that the functions a(x) and b(x) are both continuous and both have continuous derivatives for x₀≤x≤x₁. Then, for x₀≤x≤x₁, d/dx(a(x)∫b(x) f(x,t) dt)=f(x, b(x))·d/dx b(x)−f(x, a(x))·d/dx a(x)+a(x)∫b(x) ∂/∂x f(x, t) dt. This formula is the general form of the Leibniz integral rule and can be derived using the fundamental theorem of calculus. The (first) fundamental theorem of calculus is just the particular case of the above formula where a(x)=a, a constant, b(x)=x, and f(x, t)=f(t). If both upper, and lower limits are taken as constants, then the formula takes the shape of an operator equation: It∂x=∂xIt where ∂x is the partial derivative with respect to x and It is the integral operator with respect to t over a fixed interval. That is, it is related to the symmetry of second derivatives, but involving integrals as well as derivatives. This case is also known as the Leibniz integral rule. The following three basic theorems on the interchange of limits are essentially equivalent: the interchange of a derivative and an integral (differentiation under the integral sign ∫; i.e., Leibniz integral rule); the change of order of partial derivatives; the change of order of integration (integration under the integral sign ∫; i.e., Fubini's theorem). Continuity of equation orientated equivalence ±poles of the function, are continued as a continuous equivalence ±poles of the function in a Hilbert space is a vector space H with an inner product [symbol] f, g [symbol] such that the norm defined by |f|=√ [symbol] f, f [symbol] turns H into a complete metric space. If the metric defined by the norm is not complete, then H is instead known as an inner product space. Sampled functions leads to a sampling theorem for finite sequences of the sample paths in Hilbert spaces include 1. The real numbers Rⁿ with [symbol] v, u [symbol] the vector dot product of v and u. 2. The complex numbers Cⁿ with [symbol] v, u [symbol] the vector dot product of v and the complex conjugate of u. Sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫f (x) g (x) d x, and nondegenerate 2-form structure in potential theory complex analysis proves invaluable mathematical physics expressions an infinite potential one {1×1 column} quadrupole, or equivalence their incidence of the Euclidean space are shared with an affine geometry, the complete metric space property, and the number in base point k-face element plane the fundamental group we consider the category of pointed topological spaces, i.e. topological spaces with distinguished points. Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [sτₙ,τₙ₊₁] for an ideal H of R the following are equivalent: (a) H is semiprime; (b) I²⊆H implies I⊆H for all left (right/two-sided) ideals I; (c) aRa⊆H implies that a∈H. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}f (x) g (x) d x, nondegenerate 2-form structure in potential theory complex analysis proves invaluable mathematical physics expressions an infinite potential one {1×1 column} quadrupole, or equivalence capillary feeder and collector of exhaled carbon dioxide CO₂, equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n>1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Higher aggregation atoms sinterization (oxygen, gases, and elements) atoms and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices of capillary feeder and collector of higher aggregation sinterization (oxygen, gases, and elements) the flow speed modulation q is steady-state properties p of the system, the partial derivative with respect to time is zero the length of the flow velocity vector₁ q=∥μ∥ a second scalar field at program temperature fluid triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0, 1, 0, 1, 4, 1, 4, 1, 3, 0, . . . ], let pₙ be the number of positive and qₙ the number of negative terms in the first n terms of a simply rearranged alternating harmonic series, then the result to interest us is that the rearrangement converges if and only if a=lim_{n→∞}pₙ/qₙ exists, in which case the sum is 1n 2+½ 1n. Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P=(P_{i,j}), where P_{i,j}=P(Xₙ₊₁=j|Xₙ=i). And the initial distribution, P(X₀=j), for all states j. The m-step transition probabilities are P_{i,j}^{(m)} ≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P=(P_{i,j}), where P_{i,j}≡P(Xₙ₊₁=j|Xₙ=i). And the initial distribution, P(X₀=j), for all states j. The m-step transition probabilities are P_{i,j}^{(m)} ≡P(Xₙ+m=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively. Generally, if we consider ZTh=λ0Ef(X̅ Th)+λ1Ef(X̅ Th/2)+λ2Ef(X̅ Th/4)+ . . . +λmEf(X̅ Th/2m) for a sequence h>h/2>h/4> . . . >h/2m. Conclusion: we can then arrive from (Err(T,h)=e1(T)h+e2(T)h2+ [symbol] +em(T)hm+O(hm+1)): to |ZTh−Ef(XT)|≤O(hm+1) A is the inductive limit of finite-dimensional algebras; it is said to be approximately finite (or AF). 2) (K0(A), K0(A)+)=(Z2, {(a, b); 1+√5/2 a+b≥0}). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)} ≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d can be resolved into a sum of two vectors, one parallel and one perpendicular to the axis L, that is, d=d_{L}+d_{⊥}, d_{L}=(d·S)S, d_{⊥}=d−d_{L}. In this case, the rigid motion takes the form D(x)=(A(x)+d_{⊥})+d_{L}. Now, the orientation preserving rigid motion D′*=A(x)+d_{⊥} transforms all the points of R³ so that they remain in planes perpendicular to L. For a rigid motion of this type there is a unique point c in the plane P perpendicular to L through 0, such that D*(C)=A(C)+d_{⊥}=C. The point C can be calculated as C =[I−A]⁻¹d_{⊥}, because d_{⊥} does not have a component in the direction of the axis of A. A rigid motion D′* with a fixed point must be a rotation of around the axis L_{c} through the point c. Therefore, the rigid motion D(x)=D*(x)+d_{L}, consists of a rotation about the line L_{c} followed by a translation by the vector d_{L} in the direction of the line L_{c}. Conclusion: every rigid motion of R³ is the result of a rotation of R³ about a line L_{c} followed by a translation in the direction of the line. The combination of a rotation about a line and translation along the line is called a helical motion. Computing a point on the helical axis A point C on the helical axis satisfies the equation: D*(C)=A(C)+d_{⊥}=C. Solve this equation for C using Cayley's formula for a rotation matrix C [A]=[I−B]⁻¹ [I+B], where [B] is the skew-symmetric matrix constructed from Rodrigues' vector b=tan ϕ/2S, such that [B]y=b×y. Use this form of the rotation A to obtain C=[I−B]⁻1 [I+B]C+d_{⊥}, [I−B]C=[I+B]C+[I−B]d_{⊥}, which becomes −2[B]C=[I−B]d_{⊥}. This equation can be solved for C on the helical axis P(x) to obtain, C=b×d−b×(b×d)/2b×b. The helical axis P(x)=C+xS of this spatial displacement has the Plücker coordinates S=(S, C·S) ‘Helical’ geometric, Plücker coordinates, assign six homogeneous coordinates to each line in projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. The Milstein approximation define recursively for 1≤i≤n, xₜᵢ⁽ⁿ⁾=xₜᵢ⁽ⁿ⁾₋₁+μ(xₜᵢ⁽ⁿ⁾−i)Δi+σ(xₜᵢ⁽ⁿ⁾₋₁ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)++λmEf(X̅ Th/2m) for a sequence h>h/2>h/4> . . . >h/2m. Conclusion: we can then arrive from (Err(T,h)=e₁(T)h+e₂(T)h²++eₘ(T)h^{m}+O(h^{m+1})): to |Z_{T}^{h}−Ef(X_{T})|≤O(h^{m+1}) A is the inductive limit of finite-dimensional algebras; it is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system are exposed to the common action of a static Magnetic Field of a Current Element Magnetic Resonance side B^{→}=Bₒ^{→}ₙ₌₀: and B^{→}ₑ (n-Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series). B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ [|B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′|=Ω_{R}/ [symbol] ] that rotates with a frequency ω around Bₒ^{→}ₙ₌₀. The motion of M^{→} is governed by the Bloch equations. The effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ on M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′=0, so that magnetization processes around B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ=i(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ at the Larmor frequency. The magnetization is Bin(n,p) binomial distribution f(k)=ₙCₖ p^{k}(1−p)^{n-k} pulsed rotations above the two dimensional x-y plane for [symbol] \hat{ } direction for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D¹ rotates at the Larmor frequency (detuning=0) and for which B^{→}=Bₒ^{→}ₙ₌₀: and B→ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ the magnetization is for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ rotates at the Larmor frequency (detuning=0) and for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+X+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′| Magnetic Field of a Current Element Magnetic Resonance with relaxation, for which the magnetization reaches a steady state. Our value of the frequency detuning ω−ω₀. If ω<<ω₀ or ω>>ω₀, the effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ Xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ is small and the steady state is close to the equilibrium magnetization along [symbol] . However, when ω≈ω₀, the effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀ aₙ(x−c)ⁿ. Here are some power series centered at 0: Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ {−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ is important and the steady state is reached far from the [symbol] axis. Adiabatic following occurs for ω>>ω₀, in which case the magnetization processes rapidly around the Magnetic Field of a Current Element Magnetic Resonance and therefore follows the direction of B^{→} adiabatically. The time evolution of the magnetization M^{→}=(u, v, w) of an ensemble of magnetic moments in a Magnetic Field of a Current Element Magnetic Resonance B^{→}=(Bₓ, B_{y}, B_{z}) is described by the Bloch equations, d/d t (u v w)= [symbol] (Bₓ, B_{y}, B [symbol] )×(u, v, w)−( [symbol] ₂ u [symbol] ₂ v [symbol] ₁(w−w_{eq})), where w_{eq} is the equilibrium [symbol] -component of M^{→}, when all fields are 0; [symbol] ₁ and [symbol] ₂ are called the longitudinal and transverse relaxation rates, respectively. The total Magnetic Field of a Current Element Magnetic Resonance is the vector sum of a Static Field Bₒ^{→}ₙ₌₀ along [symbol] and a field B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: τₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ=i(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ rotating above the x-y plane, B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′=(Bₙ cos(ωt) Bₙ sin(ωt) B₀). Inserting B^{→} into the Bloch equations yields d/d t (u v w)=(Ω_{R} cos(ωt) Ω_{R} cos(ωt) ω₀)×(u, v, w)−( [symbol] ₂ u [symbol] ₂V [symbol] ₁(w−w_{eq})), where ω₀= [symbol] |Bₒ^{→}ₙ₌₀| is the free Larmor precession frequency around Bₒ^{→}ₙ₌₀: and Ω_{R}= [symbol] |B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀ aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ {−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′| is our Rabi frequency, which characterizes the magnitude of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: τₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′, the strength of the interaction of the rotating field with the magnetization. Our set ω₀=(n=2); after generalizing the notion of integration, the logarithm can be viewed either as the inverse function of the exponential, or as the integral log z=integral sign ∫1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. More generally, Laurent series (using positive and negative powers) take care of isolated points where functions become infinite and lead to the powerful ‘theory of residues’ for the calculation of complex integrals. Returning to geometric ideas, complex analysis proves invaluable in two-dimensional potential theory. Finally the geometric ideas of Riemann can be viewed in terms of modern topology to give a global insight into ‘many-valued’ functions (the logarithm can be viewed either as the inverse function of the exponential, or as the integral log z=integral sign ∫1/z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. As the theory of complex analysis unfolds, the reader will see the immense importance of this definition. Complex functions f will be restricted to those of the form f: D→C where D is a domain. The fact that D is open will allow us to deal neatly with limits, continuity, and differentiability because z₀∈D implies the existence of a positive ε such that N_{ε}(z₀)⊆D and so f(z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S⊆C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some t∈R} is path connected. Sometimes it is more convenient to use a simpler type of path. Definition. A step path in S is a path y:[a, b]→S together with a subdivision a=t₀<t₁<t₂<∧<tₙ=b of [a, b] such that in each subinterval [tⱼ₋₁, tⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S⊆C which is path connected but is not step connected. Theorem. Every open disc N_{ε}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁˜z₂ iff there exists a path y in S from z₁ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in ethen all the connected components of S are open in C. One interesting way to generate open sets in C is to consider the complement of a path. Definition. Let y:[a, b]→C be a path. The complement of y is defined to be C\y([a, b]).; so all frequencies and relaxation rates are expressed in units of ω₀. The time unit is therefore 2π/ω₀ and the total time is equivalent to the number of Larmor cycles. Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series nondegenerate 2-form structure finite-dimensional n=2 flat, hyperbola, the distance between the foci is 2c. C²=a²+b². Every hyperbola has two asymptotes. A hyperbola with a horizontal transverse axis and center at (h, k) has one asymptote with equation y=k+(x−h) and the other with equation y=k−(x−h). The set of Din the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n EN even, let pₙ=pₙ(d) denote the number of length n self-avoiding polygons in Z^{d} up to translation. The polygon cardinality grows exponentially, and the growth rate lim_{n∈2N} p¹ₙ^{/n}∈(0,∞) is called the connective constant and denoted by μ. Madras [J. Statist. Rhys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if θ′=aθ+b/cθ+d where ax+b/cx+d∈SL₂(Z), then A_{θ},A_{θ}0 are Morita equivalent (cf. D. Ruelle and D. Sullivan. Currents, flows and diffeomorphisms. Topology 14). A module is called a uniform module if every two nonzero submodules have nonzero intersection circle group are also injective Z-modules A module isomorphic to an injective module solid domain surfaces U|_{N} has an integrated form σ^{N} giving a representation of C*(n) on H along the line of an unique trace x, nearby level surfaces (x+1)⁻ⁿ, “ideal radial”, “slant”, “V”, “straight”, “inline”, “horizontally opposed”, “linear actuated”¹, or “stationary object”¹ (are our special cases of the one-manifold¹) base of the natural plane constant are the first convex set eigenfunctions form a complete set subspace which is a linear resolution we incorporate the periodic set c equal to e the base of the natural plane logarithm two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] Sᵢ, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0,1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations G^{x}, x=r( [symbol] ) constants determined by the initial conditions, K. Sugahara, On the poles of Riemannian manifolds of nonnegative curvature, Progress in Differential Geometry, Adv. Stud. Pure Math. 22,(1993), 321-332. Larmor the zero module {0} is injective. M^{→}| is maximized when the rotational frequency ω is equal to the Larmor free precession frequency ω₀> [symbol] |Bₒ^{→}ₙ₌₀| (Our detuning ω−ω₀≈0). Free Larmor precession, which occurs for |B^{→}ₑ. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i√ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Incipient p-wave RF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.” Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Let (aₙ)^{∞}ₙ₌₀ be a sequence of real numbers and c∈R real-valued power series. (We refer to) “Cohomology Operations Lectures By N. E. Steenrod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p,1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{p})→(π×π, Zₚ,K^{P}×L^{P}). We have the commutative diagram of maps of geometric triples where d is induced by the diagonal on K×L, d₁ by the diagonal on n and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W×W×K×L;Zp)=H*(W/π×W/π×K×L;Zp). It is easy to see that under this isomorphism we have by 3.2 (d′)*(Pu×Pv)=Σ_{j,l} (−1)^{l(pr-j)} wⱼ×wₗ×Dⱼu×Dₗv. Applying (d₁)* to each side of this equation, and using the commutative diagram, we obtain d*∧*(Pu×Pv)=Σ_{j,l} (−1)^{l(pr-j)} wⱼ wₗ×DⱼU×Dₗv. Also d* P(U×v)=Σₖwₖ×Dₖ (U×v). The lemma follows from 2.6 and V 5.2”. The power series centered at c with coefficients aₙ is the series ^{∞}Σₙ₌₀ aₙ(x−c)ⁿ. Power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . . We apply Markov Chain basic probability, and conditional probability the conditional probability of event A given event B is defined as P(A/B)≡P(AB)/P(B) where AB≡A∩B (intersection). Events A and B are independent if P(AB)=P(A)P(B) or, equivalently, if P(A|B)=P(A). For events Bᵢ, 1≤i≤k, such that BᵢBⱼ=Ø for all i≠j, and an event A, we can apply Bayes formula to calculate P(Bᵢ|A) if we are given P(Bᵢ) and P(A|Bᵢ), 1≤i≤k: P(Bᵢ\A)=P(A\Bᵢ)/P(A)=P(Bᵢ)P(A\Bᵢ)/P(Bⱼ)P(A\Bⱼ). Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-1=0}: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)} ≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Our two solutions to the system of X is far from being trivial, that it gives rise to the C*-algebra A, which is a simple C*-algebra, uniquely characterized as a C*-algebra (up to Morita equivalence) by the properties 1) weak extrapolation method ZhT,1,2=2Ef(X̅T h/2)−Ef(X̅T h) where X̅Th/2 and X̅Th are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e1(T)h+e2(T)h2+ [symbol] +em(T)hm+O(hm+1)): to |ZTh−Ef(XT)|≤O(hm+1) A is the inductive limit of finite-dimensional algebras; it is said to be approximately finite (or AF). 2) (K0(A), K0(A)+)=(Z2, {(a, b); 1+√5/2 a+b≥0}). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =%-2=0: projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)} ≡P(Xₙ+m=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d begin a subgroup H of elements of G which leave the representative 1 fixed topological spaces, i.e. topological spaces with distinguished points closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where Pᵢⱼ≡P(Xₙ₊₁=j|Xₙ=i). And the initial distribution, P(X₀=j), for all states j. The m-step transition probabilities are P_{i,j}^{(m)} ≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d can be resolved into a sum of two vectors, one parallel and one perpendicular to the axis L, that is, d=d_{L}+d_{⊥}, d_{L}=(d·S)S, d_{⊥}=d−d_{L}. In this case, the rigid motion takes the form D(x)=(A(x)+d_{⊥})+d_{L}. Now, the orientation preserving rigid motion D′*=A(x)+d_{⊥} transforms all the points of R³ so that they remain in planes perpendicular to L. For a rigid motion of this type there is a unique point c in the plane P perpendicular to L through 0, such that D*(C)=A(C)+d_{⊥}=C. The point C can be calculated as C=[I−A]⁻¹d_{⊥}, because dx does not have a component in the direction of the axis of A. A rigid motion D′* with a fixed point must be a rotation of around the axis L_{c} through the point c. Therefore, the rigid motion D(x)=D*(x)+d_{L}, consists of a rotation about the line L_{c} followed by a translation by the vector d_{L} in the direction of the line L_{c}. Conclusion: every rigid motion of R³ is the result of a rotation of R³ about a line L_{c} followed by a translation in the direction of the line. The combination of a rotation about a line and translation along the line is called a helical motion. Computing a point on the helical axis A point C on the helical axis satisfies the equation: D*(C)=A(C)+d_{⊥}=C. Solve this equation for C using Cayley's formula for a rotation matrix C [A]=[I−B]⁻¹ [I+B], where [B] is the skew-symmetric matrix constructed from Rodrigues' vector b=tan ϕ/2S, such that [B]y=b×y. Use this form of the rotation A to obtain C=[I−B]⁻¹ [I+B]C+d_{⊥}, [I−B]C=[I+B]C+[I−B]d_{⊥}, which becomes −2[B]C=[I−B]d_{⊥}. This equation can be solved for C on the helical axis P(x) to obtain, C=b×d−b×(b×d)/2b×b. The helical axis P(x)=C+xS of this spatial displacement has the Plücker coordinates S=(S, C·S) ‘Helical’ geometric, Plücker coordinates, assign six homogeneous coordinates to each line in projective 3-space: Let f:[0,1]→R_{0,1} strong V sufficiently a homology 3-dimensional a 3-sphere continuous function, P³ position ‘helical’ insertion closed-chain equivariant translation-banded (helical screw) topological Markov chains. 1. We suppose v is a positive linear functional with μ≥v≥0. Discrete-Time Markov Chains (DTMC's) the model a stochastic process {Xₙ: n≥0}is a Markov process if the conditional probability of each future event given the present state and past states depends only on the present state. The word chain is used if the states can be expressed as nonnegative+integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ+m=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0, or spherical d. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 approximations of functionals can be obtained with lower order weak schemes by extrapolation methods representations correspond to the little group integral submultiples of Lᵥ can be synthesized colimit 2.0 “Topology” our two solutions to the system of X is far from being trivial, that it gives rise to the C*-algebra A, which is a simple C*-algebra, uniquely characterized as a C*-algebra (up to Morita equivalence) by the properties 1) weak extrapolation method Z^{h}_{T,1,2}=2Ef(X̅_{T}^{h/2})−Ef(X̅_{T}^{h}) where X̅_{T}^{h/2} and X̅_{T}^{h} are the Euler approximation at time T for the step size h/2 and h respectively. Generally, if we consider ZTh=λ0Ef(X̅ Th)+λ1Ef(X̅ Th/2)+λ2Ef(X̅ Th/4)+ [symbol] +λmEf(X̅ Th/2m) for a sequence h>h/2>h/4> . . . >h/2m. Conclusion: we can then arrive from (Err(T,h)=e₁(T)h+e₂(T)h²+ [symbol] +eₘ(T)h^{m}+O(h^{m+1})): to |Z_{T}^{h}−Ef(X_{T})|≤O(h^{m+1}) A is the inductive limit of finite-dimensional algebras; it is said to be approximately finite (or AF). 2) (K₀(A), K₀(A)⁺)=(Z², {(a, b); 1+√5/2 a+b≥0}). We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio correspond to the little group integral submultiples of Lᵥ can be synthesized colimit 2.0 topology our two solutions to the system are exposed to the common action of a static Magnetic Field of a Current Element Magnetic Resonance side B^{→}=Bₒ^{→}ₙ₌₀: and B^{→}ₑ (n-Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series). B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ [|B^{→}ₑ D 4==• . . . =^{D}_{2N-2=0}: Let (an)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′|=Ω_{R}/ [symbol] ] that rotates with a frequency ω around Bₒ^{→}ₙ₌₀. The motion of M^{→} is governed by the Bloch equations. The effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , τₙ₌₀(n!)xⁿ=1+x+2x²+6x³+24x⁴+^{∞}Xₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ on M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , Σₙ₌₀ 1/n!xⁿ=1+x+½x²+⅙x³+ 1/24x⁴+ . . . , Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′=0, so that magnetization processes around B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+X³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ=i(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ at the Larmor frequency. The magnetization is Bin(n,p) binomial distribution f(k)=ₙCₖ p^{k}(1−p)^{n-k} pulsed rotations above the two dimensional x-y plane for [symbol] \hat{ } direction for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀ xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ rotates at the Larmor frequency (detuning=0) and for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀(−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ−(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ the magnetization is for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B→ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Zₙ₌₀aₙ(x−c)ⁿ. FI ere are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ rotates at the Larmor frequency (detuning=0) and for which B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}τₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′| Magnetic Field of a Current Element Magnetic Resonance with relaxation, for which the magnetization reaches a steady state. Our value of the frequency detuning ω−ω₀. If ω<<ω₀ or ω>>ω₀, the effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ is small and the steady state is close to the equilibrium magnetization along [symbol] . However, when ω≈ω₀, the effect of B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀Xⁿ=1+x+x²+x³+x⁴+ . . . , ^{∞}Σₙ₌₀1/n!xⁿ=1+x+½x²+⅙x³+ 1/24x⁴+ . . . , ^{∞}Σₙ₌₀(n!)xⁿ=1+X+2x²+6x³+24x⁴+ . . . , Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ is important and the steady state is reached far from the [symbol] axis. Adiabatic following occurs for ω<<ω₀, in which case the magnetization processes rapidly around the Magnetic Field of a Current Element Magnetic Resonance and therefore follows the direction of B^{→} adiabatically. The time evolution of the magnetization M^{→}=(u, v, w) of an ensemble of magnetic moments in a Magnetic Field of a Current Element Magnetic Resonance B^{→}=(Bₓ, B_{y}, B_{z}) is described by the Bloch equations, d/d t (u v w)= [symbol] (Bₓ, B_{y}, B [symbol] )×(u, v, w)−( [symbol] ₂ u [symbol] ₂ v [symbol] ₁(w−w_{eq})), where w_{eq} is the equilibrium [symbol] -component of M^{→}, when all fields are 0; [symbol] ₁ and [symbol] ₂ are called the longitudinal and transverse relaxation rates, respectively. The total Magnetic Field of a Current Element Magnetic Resonance is the vector sum of a Static Field Bₒ^{→}ₙ₌₀ along z and a field B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+X+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁(−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′ rotating above the x-y plane, B^{→}=Bₒ^{→}ₙ₌₀: and B^{→}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′=(Bₙ cos(u)t) Bₙ sin(ωt) B₀). Inserting B^{→} into the Bloch equations yields d/d t (u v w)=(Ω_{R} cos(ωt) Ω_{R} cos(ωt) ω₀)×(u, v, w)−( [symbol] ₂ u [symbol] ₂v [symbol] ₁(w−w_{eq})), where ω₀= [symbol] |Bₒ^{→}ₙ₌₀| is the free Larmor precession frequency around Bₒ^{→}ₙ₌₀: and Ω_{R}= [symbol] |B^{→}=Bₒ^{→}ₙ₌₀: and B→ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series Σₙ₌₀aₙ(x−c)ⁿ. Here are some power series centered at 0: ^{∞}Xₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀(n!)xⁿ=1+x+2x²+6x³+24x⁴+ . . . , ^{∞}Σₙ₌₀ (−1)ⁿx²ⁿ=x−x²+x⁴−x⁸+ . . . ; and here is a power series centered at 1: (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′| is our Rabi frequency, which characterizes the magnitude of B^{>}=Bₒ^{>}ₙ₌₀: and B^{>}ₑ semigroup, a semidirect product given a group G with identity element e, the substitution law holds for real power-associative algebras, and the multiplication of polynomials works. For f a real polynomial in x, and for any a in such an algebra define f(a) to be the element of the algebra resulting from the obvious substitution of a into f. B^{→}=Bₒ^{→}ₙ₌₀: and B^{→}ₑ semigroup, a semidirect product given a group G with identity element e, |B^{→}ₑ D 4==• . . . =^{D}_{2N-2=0}: Let (aₙ)^{∞}ₙ₌₀ be a sequence of real numbers and c∈R real-valued power series. The power series centered at c with coefficients aₙ is the series ^{∞}Σₙ₌₀aₙ(x−c)ⁿ. Here are some power series centered at 0: ^{∞}Σₙ₌₀xⁿ=1+x+x²+x³+x⁴+ . . . , τₙ₌₀ 1/n!xⁿ=1+x+½x²+⅙x³+ 1/24x⁴+ . . . , ^{∞}Σₙ₌₀(n!)xⁿ=1+x+2X²+6X³+24X⁴+ . . . , ^{∞}Σₙ₌₀ (−1)ⁿx²ⁿ=x−x²+x⁴−x⁸+ . . . ; and here is a power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . 2.0 homogeneous polynomials F2k, k=2, . . . , n−2, of degree k such that 1−12k=H2F2k_2 equivalent translation periodic D′, the strength of the interaction of the rotating field with the magnetization. Our set ω₀=(n=2); after generalizing the notion of integration, the logarithm can be viewed either as the inverse function of the exponential, or as the integral log z=integral sign ∫1/z dz, is interpreted. This interpretation yields intimate links between geometric intuition and formal analysis. At this stage Cauchy's Theorem is presented in various guises and the use of integration arguments leads to a proof that every differentiable function can be expressed as a power series. More generally, Laurent series (using positive and negative powers) take care of isolated points where functions become infinite and lead to the powerful ‘theory of residues’ for the calculation of complex integrals. Returning to geometric ideas, complex analysis proves invaluable in two-dimensional potential theory. Finally the geometric ideas of Riemann can be viewed in terms of modern topology to give a global insight into ‘many-valued’ functions (the logarithm can be viewed either as the inverse function of the exponential, or as the integral log z=integral sign ∫1/z dz) and open up our new areas of progress here. Definition. A domain is a non-empty, path connected, open set in the complex plane. According to Theorem 2.66, a domain is also step connected. This means we can refer to a domain as being “connected,” meaning either path or step connected as appropriate. As the theory of complex analysis unfolds, the reader will see the immense importance of this definition. Complex functions f will be restricted to those of the form f: D→C where D is a domain. The fact that D is open will allow us to deal neatly with limits, continuity, and differentiability because z₀∈D implies the existence of a positive e such that N_{ε}(z₀)⊆D and so f(z) is defined for all z near z₀. The connectedness of D guarantees a (step) path between any two points in D and this in turn will allow us to define the integral from one point to another along such a path. In example, if two differentiable complex functions are defined on the same domain D and they happen to be equal in a small disc in D, then they are equal throughout D. Connectedness definition a subset S⊆C is said to be path connected if for all z₁, z₂∈S there exists a path y in S from z₁ to z₂. Theorem. Every open disc N_{ε}(z₀) in C is path connected. We can prove, by constructing an appropriate path given by an explicit function, that S={z∈C|z=t+it² for some t∈R} is path connected. Sometimes it is more convenient to use a simpler type of path. Definition. A step path in S is a path y:[a, b]→S together with a subdivision a=t₀<t₁<τ₂<∧<τₙ=b of [a, b] such that in each subinterval [tⱼ₋₁, tⱼ] either re(y) or im(y) is constant. This means that the image of y consists of a finite number of straight line segments, each parallel to the real or imaginary axis. We can (a) Draw a complicated step path from [symbol] to i; and we can (b) draw a simple step path from [symbol] to i. Definition. A subset S⊆C is said to be step connected if for all z₁, z₂∈S there exists a step path y in S from z₁ to z₂. Apparently every step connected set is also path connected. The converse, however, is not true. We can give an example of a subset S⊆C which is path connected but is not step connected. Theorem. Every open disc N_{ε}(z₀) in C is step connected. Theorem. Let S be an open subset of C. If S is path connected, then S is step connected. An arbitrary subset S⊆C may not be path connected. However, for any S⊆C we may define the “is-connected-to” relation on S as follows: z₁˜z₂ iff there exists a path y in S from z₁ to z₂. Theorem. Let S⊆C. The “is-connected-to” relation on S (defined above) is an equivalence relation on S. Moreover, each equivalence class is path connected. Definition. The equivalence classes of the “is-connected-to” relation on S⊆C are called the connected components of S. We can find the connected components of S={z∈C: |z|≠1 and |z|≠2}. Theorem. If S is open in ethen all the connected components of S are open in C. One interesting way to generate open sets in C is to consider the complement of a path. Definition. Let y:[a, b]→C be a path. The complement of y is defined to be C\y([a, b]).; so all frequencies and relaxation rates are expressed in units of ω₀. The time unit is therefore 2π/ω′₀ band the total time is equivalent to the number of Larmor cycles. Let x, y be two solutions to the system, does prove that any point [symbol] =λx+λx+(1−λy) with λ∈|0, 1| also is A solution to the system, or having exponents the exponential function e^{x}, and the sum of the first n+1 terms of its Taylor series nondegenerate 2-form structure finite-dimensional n=2 flat, hyperbola, the distance between the foci is 2c. C²=a²+b². Every hyperbola has two asymptotes. A hyperbola with a horizontal transverse axis and center at (h, k) has one asymptote with equation y=k+(x−h) and the other with equation y=k−(x−h). The set of Din the intersection of n half-spaces of the hyperplane Σⁿᵢ₌₁ xᵢ=a with the hyperrectangle R defined by 0≤xᵢ≤Mᵢ, i=1, . . . , n, or we denote by N the set of non-negative integers for d≥2 and n∈N even, let pₙ=pₙ(d) denote the number of length n self-avoiding polygons in Z^{d} up to translation. The polygon cardinality grows exponentially, and the growth rate lim_{n∈2N} p¹n^{/n}∈(0,∞) is called the connective constant and denoted by μ. Madras [J. Statist. Phys. 78 (1995) no. 3-4, 681-699] has shown that pₙμ⁻ⁿ≤Cn^{-1/2} in dimension d=2. Here we establish that pₙμ⁻ⁿ≤n^{-3/2+o(1)} for a set of even n of full density when d=2 we have that if θ′=aθ+b/cθ+d where ax+b/cx+d∈SL₂(Z), then A_{θ},A_{θ}0 are Morita equivalent (cf. D. Ruelle and D. Sullivan. Currents, flows and diffeomorphisms. Topology 14). A module is called a uniform module if every two nonzero submodules have nonzero intersection circle group are also injective Z-modules A module isomorphic to an injective module solid domain surfaces U|_{N} has an integrated form σ^{N} giving a representation of C*(n) on H along the line of an unique trace τ, nearby level surfaces (x+1)⁻ⁿ, “ideal radial”, “slant”, “V”, “straight”, “inline”, “horizontally opposed”, “linear actuated”¹, or “stationary object”¹ (are our special cases of the one-manifold¹) base of the natural plane constant are the first convex set eigenfunctions form a complete set subspace which is a linear resolution we incorporate the periodic set c equal to e the base of the natural plane logarithm two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] Sᵢ, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along S₁ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀iX₁ of 1.3, B*B representations G^{x}, x=r( [symbol] ) constants determined by the initial conditions, K. Sugahara, On the poles of Riemannian manifolds of nonnegative curvature, Progress in Differential Geometry, Adv. Stud. Pure Math. 22,(1993), 321-332. Larmor the zero module {0} is injective. M^{→}| is maximized when the rotational frequency ω is equal to the Larmor free precession frequency ω₀= [symbol] |Bₒ^{→}ₙ₌₀| (Our detuning ω−ω₀≈0). Free Larmor precession, which occurs for |B^{→}ₑ. The Space X of Quasiperiodic the little group integral submultiples of Lᵥ can be synthesized colimit 2.0 “Topology” our two solutions to the system of X is far from being trivial, method of two simple planes a and b having a sequence (zₙ)_{n=0, 1, 2, . . .} of 0's and 1's that satisfies the following coherence rule: zₙ=1⇒zₙ₊₁ (neighborhood of 0). Whereas the continuous dimension of Murray and von Neumann can take on all the positive real values for the projections of R (or of the matrix rings Mₙ(R)) since dim(e)=τ(e), for the projections that belong to i∞ [symbol] A this dimension can only take values in the subgroup [symbol] +1+5/2 Z. Semidirect products let G be a semidirect product of the normal subgroup N and the subgroup H semigroup which are poles of the function. The rank of H(a) is equal to the number of poles of the rational function Pa (calculated up to multiplicity). More generally, Laurent series (using positive and negative powers) take care of isolated points where functions become infinite and lead to the powerful ‘theory of residues’ for the calculation of complex integrals the canonical form of an absorbing DTMC can be expressed as P=(I R 0 Q), where I is an identity matrix (1's on the diagonal and 0's elsewhere) and 0 (zero) is a matrix of zeros, which accounts for the role of these numbers in measuring the densities of the planes, of finite-dimensions as densities in the neighborhood of 0, and continued of the continuous dimensions as the densities of the planes. Discrete-Time Markov Chains (DTMC's) the model a stochastic process {Xₙ: n≥0} is a Markov process if the conditional probability of each future event given the present state and past states depends only on the present state. The word chain is used if the states can be expressed as nonnegative + integers, and our equivalent of such − negative integers. A DTMC is characterized by the transition probabilities P(Xₙ₊₁=j|Xₙ=i), which we assume are independent of n. Thus the model is specified by the transition matrix P≡(P_{i,j}), where P_{i,j}≡P(Xₙ₊₁=j|Xₙ=i). And the initial distribution, P(X₀=j), for all states j. The m-step transition probabilities are P_{i,j}^{(m)}≡P(Xₙ₊ₘ=j|Xₙ=i)=(P^{m})_{i,j}=P_{i,k}^{m-1} P_{k,j} (matrix multiplication). Communication and canonical form state j is accessible from state i if P^{(m)}_{i,j}>0 for some m>0. States i and j communicate if each is accessible from the other. The communication relation partitions the set of states into (communication) classes. Every state is in one and only one class. If there is only one class, the chain is irreducible; otherwise it is reducible. A communication class is closed if the DTMC cannot leave it; otherwise it is open. All states j in open classes are transient; then P_{i,j}ⁿ→0 as n→∞. A DTMC can be put into canonical form by rearranging the states, putting the closed classes first. Sampled functions leads to a sampling theorem for finite sequences of the sample paths and gives us a simple derivation in block matrix form with 2 closed classes and 1 open class: P=(P₁ 0 R₁ 0 P₂ R₂ 0 0 Q) (The entries are themselves matrices.) Positive recurrent DTMC's an irreducible DTMC (or a closed communication class) is recurrent if the probability of returning to each state is 1. A recurrent DTMC is positive recurrent if the expected time to return is finite. A finite-state irreducible DTMC is always positive recurrent. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖ(j)ₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)}(U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. Let (aₙ)^{∞}ₙ₌₀ be a sequence of real numbers and c∈R real-valued power series. (We refer to) “Cohomology Operations Lectures By N. E. Steen rod Written And Revised By D. B. A. Epstein”. “The lemma follows by comparing coefficients of wₖ”. “4.7. Lemma. Let u∈H^{r}(K;Zₚ) and v∈H^{S}(L;Zₚ). If p>2 then D₂ₖ(U×v)=(−1)^{p}(^{p-1})^{rs/2} Σ^{k}ⱼ₌₀ D₂ⱼ U×D_{2k-2J} v. If p=2, Dₖ(U×v)=Σ^{k}ⱼ₌₀ DⱼU×D_{k-J}v. Construction of Powers Proof. The map of geometric triples ∧, used in 2.6, takes the form ∧: (π, Zₚ, (K×L)^{P})→(π×π, Zₚ,K^{P}×L^{P}). We have the commutative diagram of maps of geometric triples where d is induced by the diagonal on K×L, d₁ by the diagonal on π and d′ by combining the diagonals on k and L. Let W be a π-free acyclic complex. Then W×W is a (π×π)-free acyclic complex. From the above diagram and V 3.3 we have a commutative diagram. According to V 4.2, Pu×Pv is an element in the group on the upper right of the diagram. We have H* _{π×π}(W×W×K×L;Zp)≈H*(W/π×W/π×K×L;Zp). It is easy to see that under this isomorphism we have by 3.2 (d′)*(Pu×Pv)=Σ_{j,l} (−1)^{l(pr-j)}wⱼ×wₗ×Dⱼu×Dₗv. Applying (d₁)* to each side of this equation, and using the commutative diagram, we obtain d*∧*(Pu×Pv)=Σ_{j,l}(−1)^{l(pr-j)} wⱼ wₗ×DⱼU×Dₗv. Also d* P(U×v)=Σₖwₖ×Dₖ (U×v). The lemma follows from 2.6 and V 5.2”. The power series centered at c with coefficients aₙ is the series τₙ₌₀aₙ(x−c)ⁿ. Power series centered at 0: ^{∞}τₙ₌₀xⁿ=1+x+x²+x³+x⁴+ . . . , ^{∞}Σₙ₌₀ 1/n!xⁿ=1+x+½x²+⅙x³+ 1/24x⁴+ . . . , ^{∞}Σₙ₌₀ (n 1)xⁿ=1+x+2x²+6x³+24x⁴+ . . . , ^{∞}Σₙ₌₀ (−1)ⁿx²ⁿ=x−x²+x⁴−x⁸+ . . . ; and power series centered at 1: ^{∞}Σₙ₌₁ (−1)ⁿ⁺¹/n(x−1)ⁿ=(x−1)−½(x−1)²+⅓(x−1)³−¼(x−1)⁴+ . . . closed-chain equivariant translation-banded A class of C*-algebras and topological Markov chains. Incipient p-wave PF power transmission superconducter the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }(j)ₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖcₖϕₖ. It's then easy to prove that the previous relation PF\hat{ }G\hat{ }f=G\hat{ }PF\hat{ }f is valid for any function f [n-mosfet generated by symbols {A₁, . . . , Aₛ}] power series expansion (n) sides metal-oxide-semiconductor field-effect transistor (mosfet) PF transmission. Proposition. We use Rohlin's Theorem to select to select F⁻ such that F⁻, T F⁻, T² F⁻, . . . , T^{m-1} F⁻ is a disjoint sequence, and μ(∪^{m-1}ᵢ₌₀ Tⁱ F⁻)≥1−ε/2. NOW express each set A∈V^{m-1}₀ T⁻ⁱP/F⁻ as A₁∪A₂, A₁∩A₂=ϕ, μ(A₁)=μ(A₂), and put (m/2)−1 (m/2)−1 FA=[T2iA1∪[T2i−1A2 i=0 i=l. Clearly, F_{A} and TF_{A} are disjoint. We now let F be the union of the sets F_{A}, A∈V^{m-1}₀T⁻ⁱ P/F⁻. It follows that F∩TF=ϕ, and that F∪TF is all of ∪^{m-1}ᵢ₌₀ Tⁱ F⁻, TⁱF⁻, 0≤i≤m−1. Thus if m is large enough, μ(F∪TF) will be at least 1−ε. This establishes that d(P/F)=d(P/F∪TF). Shifts and partitions of a Bernoulli shift we begin with π=(p₁, p₂, . . . , pₖ), with pᵢ>0 and Σpᵢ=1. Let X be the set of all 2-form infinite sequences of the symbols 1, 2, . . . , k; that is, the set of all functions from the integers Z into {1, 2, . . . , k}. A measure is defined on X as follows: A cylinder set is a subset of X determined by a finite number of values, such as (2.1) C={x|xᵢ=tᵢ,−m≤i≤n} where tᵢ, −m≤i≤n, is some fixed finite sequence in {1, 2, . . . , k}. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. Theorem I. There exists a functor Mag:=Mag_{R,G}: Cob_{G}→Lagr_{R} which is defined as follows. At the level of objects, Mag assigns to any pair F_{g}, ϕ:π₁(F_{g},★)∈) the skew-Hermitian R-module (H^{ϕ}₁(F_{g},★), [symbol] ∩,⋅ [symbol] ₛ) where ★∈∂F_{g} and [symbol] ⋅,⋅ [symbol] ₛ: H^{ϕ}₁(F_{g},∈)×H^{ϕ}₁(F_{g},∈)→R is a version of the equivariant intersection form with coefficients in R twisted by ϕ. At the level of morphisms, Mag assigns to any cobordism (M,ϕ) between (F_{g-},ϕ₋) and (F_{g+},ϕ₊) the (closure of) the kernel of the R-linear map (−m₋)⊗m₊: H^{ϕ}₁⁻F_{g-},★)⊗H^{ϕ}₁⁺ (F_{g+},★)→H^{ϕ}₁(M,★) induced by the inclusions m_{±}:F_{g±}→∂M⊂M. (We refer to) “A functorial extension of the Magnus representation to the category of three-dimensional cobordisms” Vincent Florens, Gwenael Massuyeau, and Juan Serrano de Rodrigo 23 Apr. 2016 to Sep. 10, 2018. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge.³ (We refer to). Mag category 4.3. Definition of Mag. Theorem 4.3. [12] There is a functor Mag:=MagR,G: Cob_{G}→pLagrR defined by Mag(g, ϕ):=empirical distributions. “Let R be an integral domain and G be a subgroup of its group of units. We consider the category Cob_{G} of 3-dimensional cobordisms between oriented surfaces with connected boundary, equipped with a representation of their fundamental group in G. Under some mild conditions on R, we construct a monoidal functor from Cob_{G} to the category plag_{R} consisting of “pointed Lagrangian relations” between skew-Hermitian R-modules. We call it the “Magnus functor” since it contains the Magnus representation of mapping class groups as a special case. Our construction as a G-equivariant version of a TQFT-like functor”, . . . “a TQFT-like extension of the Magnus representations under some homological assumptions on the cobordisms, this “TQFT” is also equivalent to a construction of Frohman and Nicas [FN91] which involves moduli spaces of flat U(1)-connections. When G is a free Abelian group and R=Z[G] is the group ring of G, we relate the Magnus functor to the “Alexander functor”, and we deduce a factorization formula for the latter”. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987], Larmor frequency fundamental group in a fixed group G kinematic variables³ three-sphere has the exact sequence flat δ-cover in case F is a flat module¹; or semi-precious mineral plate¹; ridge²; and wedge.³ Mag category 4.3. Definition of Mag. Theorem 4.3. [12] There is a functor Mag:=MagR,G: Cob_{G}→pLagrR defined by Mag(g, ϕ):=empirical distributions that are applied to resonance transition, and the construction of orbits with prescribed itineraries of the cylinder sets. Empirical distributions begin with invariant sesquilinear three-manifold¹⁻²⁻³ cohomology of the triple complex (12) [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Larmor frequency fundamental group in a fixed group G kinematic variables³ three-sphere has the exact sequence flat δ-cover in case F is a flat module¹; or semi-precious mineral plate¹; ridge²; and wedge³ structures are relevant for transport between the interior and exterior Hill's regions, and other resonant phenomena. In quantum field theory (and in quantum mechanics) that scattering amplitudes are analytic functions of their kinematic variables.³ Thus, quantum field theory continue Cauchy, with regard to all momenta in the scattering amplitude calculation to verify that this goes through even if p^{μ} are complex, so that λ and λ^{˜} are no longer yoked to each other is modeled as x=A*s where the ‘mixing matrix’ for all x∈s where the constants C and λj have to be determined so that the integral of p(x) over s is 1 and the above conditions for the expected values are satisfied. The same map Indₐ arises naturally from a geometric construction, that of the tangent groupoid of the manifold M. This groupoid encodes the deformation of T*M to a single point, using the equivalence relation on M×[0, 1] which identifies any pairs (x,ε) and (y,ε) provided ε>0. 5.β The Ruelle-Sullivan cycle and the Euler number of a measured foliation. By a measured foliation we mean a foliation (V,F) equipped with a transverse measure ∧. We assume that F is oriented and we let C be the current defining ∧ in the point of view b). As C is closed, dC=0, it defines a cycle [C]∈Hₖ(V,R), by looking at its de Rham homology class. The distinction here between cycles and cocycles is only a question of orientability. If one assumes that F is transversally oriented then the current becomes even and it defines a cohomology class (cf. D. Ruelle and D. Sullivan. Currents, flows and diffeomorphisms. Topology 14). Now let e(F)∈H^{k}(V,R) be the Euler class of the oriented bundle F on V (cf. J. Milnor and D. Stasheff. Characteristic classes. Ann. of Math. Stud.). Implicitly the notion of groupoid. Which we will call X an equilibrium point more explicitly, the factor in our affine geometric construction. We note that the C*-algebra A is exactly the one that appears in the construction by Vaughan Jones [V. F. R. Jones. Index for subfactors. Invent. Math. 72 (1983)] of subfactors of index less than 4, for index equal to the golden ratio. The measure space (X,Σ,μ), where Σ is the completion of E with respect to μ, will be called the product space with product measure μ determined by the distribution π. The transformation T defined by (Tx)ₙ=xₙ₊₁, n∈Z, is clearly an invertible μ-measure-preserving transformation. The transformation T defined by (Tx)ₙ=xₙ₊₁, n∈Z, is clearly an invertible μ-measure-preserving transformation. The Bernoulli shift with distribution π and denoted by T_{π}. There are many ways of determining the space (X,Σ,μ); are many isomorphisms, of a given Bernoulli shift. We begin simple geometric representation for the case when π=a/b fraction from 0 to 1 in steps of 0.01 (δ=0), and continued by the rational function Bin(n,p) binomial distribution f(k)=ₙCₖ p^{k}(1−p)^{n-k} electromagnetic pulses. (We refer to) “Up to a shift of parity, the geometric group K*,_{τ}(BG) is the K-theory group K*⁺¹(V). The projection p:V→V/F is naturally K-oriented and the following maps from K*(V) to K(C*(V,F)) coincide: 1) p! (cf. Theorem) which, up to the Thom isomorphism, K*(F)˜K*⁺¹(V) is equal by Lemma 7 to Indₐ=Indₜ. 2) The Thom isomorphism (Appendix C) ϕ:K*(V)=K(C(V))→K(C(V)oR)=K(C*(V,F)) where we used an arbitrary flow defining the foliation. In particular, by Appendix C, ϕ is an isomorphism and so are the map pi and the index Indₐ:K*(F)→K(C′(V,F)). Taking for instance the horocycle foliation of V=SL(2,R)/Γ, where Γ is a discrete cocompact subgroup of SL(2,R), by the left action of the subgroup of lower triangular matrices of the form [1 0 t 1], τ∈R, one sees that the analytic index gives a (degree −1) isomorphism of K*(V) onto K(C*(V,F)), while for the only transverse measure ∧ for (V,F) (the horocycle flow being strongly ergodic), the composition of the above analytic index with dim_{∧}:preserving K*(C*(V,F))→R is equal to 0, so in particular dim∧ is identically 0, submitting K(C*(V,F))→R is equal to 0, so in particular dim∧ is identically 0, so * is removed considering (K-theoretic formulation of the index theorem (Theorem 6). “The Longitudinal Index Theorem for Foliations A. Connes* and G. Skandalis** 1983)”. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)}>,b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )=∫ [symbol] _{1∘} [symbol] ₂₌ [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Γϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where S, are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪Sᵢ W′ is S₀ [symbol] S₂. Since g and g′ agree on Sᵢ, they induce a map g∪g′:W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and Xi G^{x}, x=r( [symbol] ), infinite connected manifolds the Θ^{j}(K) commute pairwise (S₀, g₀) and (S₁, g₁), where S, are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations X₀ G^{x}, x=r( [symbol] ) and Xi G^{x}, x=r( [symbol] ), infinite connected manifolds the Θ^{j}(K) commute pairwise, the Θ^{j}(K) generate the von Neumann algebra R_{0,1}. This property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)∘(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an HNN group whose base is a tree product of vertices cKc⁻¹∩H where c ranges over a double coset representative system for G mod (H, K). (We refer to). An Improved Subgroup Theorem For HNN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path y:[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. The mathematical structure preserving map function the group homomorphism A, B equipped the well order relation of variety* the injective of 1-1 structure of the Dual Algebra itineraries of oriented poles of normalized equipotential well order relation of variety* injective 1-1 correspond the structure of the Dual Algebra dimorphism (n) numbers are the natural order of variety* (itineraries). We solve for the solution of the equation base of the natural logarithm function of maximum entropy rotation circular moment expansion at the base of the natural logarithm exponential e^{x}, and complex variable z complex analysis, a complex logarithm function an inverse of the complex function e^{x} a logarithm of a complex number [symbol] a complex number w such that e^{w}= [symbol] , the notation for such a w is log [symbol] , is an exponential function e^{x}, continued in the Taylor series of n-sums of the first n+1 terms of a n-series at 0, when n:=a=0, the Maclaurin series for log(1−x), where log denotes the natural logarithm: −x−½x2−⅓x3−¼x4− . . . , or (x−0)n in the numerator and n! in the denominator for each term in the infinite sum we consider by two routes with the n-ball. The fitting method utilizes an iterative Einstein theory energy, and matter relativistic sub-plasma 150-200 nm circuit. (We refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R;” nondegenerate 2-form structure in potential theory complex analysis proves invaluable mathematical physics expressions an infinite potential finite-dimensional photon optically paired cables; “let c be a cocycle of total degree 2q in the bicomplex of simplicial currents on the nerve of G and [symbol] (c) the associated cyclic cohomology class in the (b,B) bicomplex of A=C_{c}^{∞}(G⊗R);” “Theorem 12 reduces to Theorem 4.7 in the case of discrete groups G=Γ. Let c be a group cocycle, c∈Z^{2q}(Γ,C). Then by Section 2 [symbol] ) one has (3.36) [symbol] (c)=τ_{c}. But the cyclic cocycle τ_{c} of Theorem 4.7 is here viewed as a cocycle in the (b,B) bicomplex. The point then is that the formula (3) for the pairing of (b,B) cocycles with K-theory accounts for the strange numerical factor 1/(2q)! of Theorem 4.7 (cf. [129] for a discussion of this numerical factor);” in the context of foliations, we construct “a left inverse λ of the map [symbol] _{*} ([114]) (3.38) λ:H*(A)→H*_{τ}(BG). In fact, we shall only describe the composition of this map with the pull-back H*_{τ}(BG)→H*_{τ}(V). When one varies V without varying V/F one gets the desired information. The idea of the construction of (3.39) λᵥ:H*(A)→H*_{τ}(V) is to exploit the local triviality of the foliation as follows: For each open set U⊂V one lets A(U) be the algebra associated by the functor C_{c}^{∞}(⋅, Ω^{1/2}) to the restriction of the foliation to U. If U₁⊂U₂ one has an obvious inclusion (3.40) A(U₁)⊂A(U₂). Thus, one obtains for each n a presheaf Γⁿ on V by setting (3.41) Γⁿ(U)=C^{m} (A(U)^{˜}, A(U)^{˜}*), the space of continuous (n+1)-linear forms on A(U)^{˜}, the algebra obtained by adjoining a unit to A(U). Because the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12)”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. We endow the linear space C_{c}^{∞}(G, Ω^{1/2}) of smooth compactly supported sections of Ω^{1/2} with the convolution product (a*b)( [symbol] )= [symbol] a( [symbol] ₁)b( [symbol] ₂) ∀a, b∈C_{c}^{∞}(G, Ω^{1/2}) where the integral on the right-hand side makes sense since it is the integral of a 1-density, namely a( [symbol] ₁)b( [symbol] ₁⁻¹ [symbol] ), we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, as the group of all isometries, ISO(n), where the group Γ is chosen discrete and cocompact in such a way that V is a homology 3-sphere is our Euclidean centered group for calibration and control R³ subspace, the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving Hermitian operators are often needed, so they are listed here: If A is Hermitian: [symbol] g|Af [symbol] = [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16, S to sets of a vector space, set of all vectors S a vector space of R³, all of S is contained in R³, that is any vector in S can also be found in R³, therefore, S is a subspace of R³ rotating in the x-y plane closed under addition and scalar multiplication continued by rotational mathematics and symmetry the dynamics in our process magnetization (magnetic resonance) in which the macroscopic magnetization subspace is a set of all vectors S a vector space of R³ such transforms constitute a group called the orthogonal group O(n), and it's elements Q are exactly solutions of a matrix equation where Q^{T} is the transpose of Q and I is the identity matrix M^{→}. Two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′, g′) between (S₁, g₁) and (S₂, g₂), where W, W′ and all Sᵢ are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on Sᵢ, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a O-vector space. This indicates the role of Z/2 in the notation of homology groups;” two manifolds X₀ G^{x}, x=( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and X₁ in a Hermitian solution X X₀ iX₁ of 1.3, B*B representations X₀ G^{x}, x=r( [symbol] ) and X₁G^{x}, x=r( [symbol] ), infinite connected manifolds the Θ^{j}(K) commute pairwise, the Θ^{j}(K) generate the von Neumann algebra R_{0,1}. This property remains true whenever Θ is multiplied by an automorphism eigenvalue of modulus 1. Where H is an HNN group whose base is a tree product of vertices cKc⁻¹∩H where c ranges over a double coset representative system for G mod (H, K). (We refer to). An Improved Subgroup Theorem For FINN Groups ‘With Some Applications’ by A. Karrass, A. Pietrowski, And D. Solitar. Hamiltonian is assumed to be in Birkhoff's normal form up to terms of degree 2n continuum a lift a normal k-smoothing isometries where [symbol] ₙ are the approximations to [symbol] to that our system of equations orders in the number of terms Gamma's definition [symbol] =lim_{n→∞}(Hₙ−1n n). The Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, G^{x}, x=r( [symbol] ), as two easy examples of this construction one can take, α) The groupoid G=M×M where M is a compact manifold, r and s are the two projections G→M=G⁽⁰⁾={(x,x);x∈M} and the composition is (x,y)=(y,z)=(x,z) ∀x,y,z∈M. The convolution algebra is then the algebra of smoothing kernels on the manifold M. β) A Lie group G is, in a trivial way, a groupoid with G⁽⁰⁾={e}. One then gets the convolution algebra C_{c}^{∞}(G, Ω^{1/2}) of smooth 1-densities on G, −1n n), with [symbol] we have [symbol] =0+½(1+⅓(0+¼(1+⅕(4+⅙(1+ 1/7(4+⅛(1+ 1/9(3+ 1/10(0+) . . . )))))))) or in the shorthand notation [0; 0, 1, 0, 1, 4, 1, 4, 1, 3, 0, . . . ] the minimal carrier of τ consists of simplexes all of which have Xᵢ as a vertex of load, or signal by the rule (χ*(n mod m), gcd(n,m)=1, χ(n)=0. Where H is an FINN group whose base is a tree product of vertices cKc⁻¹∩H where c ranges over a double coset representative system for G mod (H, K). (We refer to). An Improved Subgroup Theorem For FINN Groups ‘With Some Applications’ by A. Karrass, A. Pietrowski, And D. Solitar. The Hamiltonian is assumed to be in Birkhoff's normal form up to terms of degree 2n χ for the function of transport properties generating a series interval A step path in S is a path [symbol] :[A, b]→S together with a subdivision a=τ₀<τ₁<τ₂<∧<τₙ=b of [A, b] such that in each subinterval [τⱼ₋₁, τⱼ] either re(y) or im(y) is constant τ₀<τ₁<τ₂<∧<τₙ=b of let y:uniform on [A, b]→C be a path we find the natural base of the plane points an optimal value of (P) and (D) calculated in the shape object plane with Hilbert-Huang transform HHT. We now decompose a step algorithm that converges to a local optimum, then we have the following familiar result (so-called weak duality). For a smooth point p on S, we continue mapping of the complex Hilbert transform z with envelope |z|. Mapping Hilbert-Huang transform (HHT). We now decompose our load, or signal into so-called intrinsic mode functions (IMF) along with a trend, and then we obtain the instantaneous frequency for nonstationary and nonlinear data equivalent translation power series expansion. Let (aₙ)^{∞}ₙ₌₀ be a sequence of real numbers and c∈R real-valued power series. The generating function thus F(x). Let F:R→R be the function defined by setting F(x):=f(x) for x∈[0,1] and F(x):=0 for x∉[0,1]. We find the familiar geometric series from calculus, alternately, this function has an infinite expansion. The coordinate system mapping the coordinate [symbol] -plane tangent to S at P and we then define the second fundamental form in the same way. Nearby twisted by ϕ are the molecular semi-direct products 1-1 structure filtration. The set Pn can be filtered by FkPn:=∪i≤kPn,i, cf. 1.5. Since, an element; or in the product of two elements stationary; and independent increments elements of 1-1 structure, the number of marked variables is equal or less than the sum of the numbers of the components, the image of FkPn×FlPm is in Fk+lPn+m. The family of standard simplices. Let Δn={(x0, . . . , xn)∈Rn+1|x0+ [symbol] +xn=1,0≤xi≤1} be the standard n-simplex. As usual we label its vertices by the integers 0 to n, and mapped by the complex Hilbert transform z with envelope |z|. This example shows that even when the foliation (V,F) does have a non-trivial transverse measure, the K-theoretic formulation of the index theorem (Theorem 6) gives much more information than the index theorem for the measured foliation (F,∧). As a corollary of the above we get: Corollary 8. Let (V,F) (1) be one-dimensional as above, and let ∧ be a transverse measure for (V,F). Then the image dim_{∧}(K(C*(V,F))) is equal to {hCh(E),[C]i;[E]∈K*(V)}. Here Ch is the usual Chern character, mapping K*(V) to H*(V,Q), and [C] is the Ruelle-Sullivan cycle. Corollary. Let V be a compact smooth manifold, and let ϕ be a minimal diffeomorphism of V. Assume that the first cohomology group H¹(V,Z) is equal to 0. Then the crossed product A=C(V)o_{ϕ}Z is a simple unital C*-algebra without any non-trivial idempotents. As a very nice example where this corollary applies one can take the diffeomorphism ϕ given by left translation by [1 0 1 1]∈SL(2, R) of the manifold V=SL(2,R)/Γ, where the group Γ is chosen discrete and cocompact in such a way that V is a homology 3-sphere”. (The Longitudinal Index Theorem for Foliations A. Connes* and G. Skandalis** 1983). Let 1. The Acyclicity of the Koszul complex and Rohlin's Theorem (strong form). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈ InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. Corollary 15. The group OutR is a simple group with a denumerable number of conjugacy classes. In fact, a result more general than the above theorem shows exactly the role played by the equalities InnR=AutR and CtR=InnR. One first shows, for every factor M with separable predual M_{*}, the following equivalence: InnM/InnM is nonAbelian⇔M is isomorphic to M⊗R. In this case, let Θ∈InnM. In order that 0 be outer conjugate to the automorphism 1⊗S^{y}ₚ of M⊗R for suitable p and [symbol] , it is necessary and sufficient that p₀(Θ)=pₐ(Θ). Moreover, for Θ∈AutM to be outer conjugate to Θ⊗s¹_{q}∈Aut(M⊗R), it is necessary and sufficient that q divide the asymptotic period pₐ(Θ). In particular, every automorphism Θ of M is outer conjugate to Θ⊗1. These results demonstrate the interest of the invariant i− [symbol] χ(M)=Inn M∩Ct M/Inn M, which made it possible ([87]) to show the existence of a factor of type II₁ not antiisomorphic to itself”. [A. Connes. Cyclic cohomology and noncommutative differential geometry. Proceedings of the International Congress of Math. (ICM Berkeley, Calif., 1986) Vol. 2, Amer. Math. Soc., Providence, R.I., 1987]. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σk iₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P); and Let 2. The Acyclicity of the Koszul complex Rohlin's Theorem (strong form). Semiprime rings. Two rings R,S are Morita equivalent if their categories of left modules are equivalent. R and Mₙ(R) are known to be Morita equivalent. In some C*algebraic sense, B₀(Ft) is Morita equivalent to C. Theorem (Morita) Let F:R-Mod→S-Mod be an equivalence of categories. Lemma 1. Let R be a strongly semiprime ring. Then for every q∈Q(R) there exist elements i₁, . . . , iₙ∈R and ψ₁, . . . , ψₙ∈F, such that qiₖ, iₖq∈R, and Σₖiₖψₖ=1. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. The Acyclicity of the Koszul complex and Rohlin's Theorem (strong form). If T is ergodic, n a positive integer, ε a positive number, and P a partition, then there is a set F such that F, TF, . . . , Tⁿ⁻¹F is a disjoint sequence, μ(∪ⁿ⁻¹ᵢ₌₀ Tⁱ F)≥1−ε and d(P/F)=d(P). Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Rohlin's Theorem (strong form). Let (X,B,μ) be a standard Borel probability space and let T be a Borel transformation of (X,B) that preserves μ. Then there exists an essentially unique partition of X, X=U^{∞}ᵢ₌₁ Xᵢ, where each Xᵢ is invariant under T, and where: 1) For every i>0, the restriction of T to Xᵢ is periodic of period i and card{T^{j}x}=i ∀x∈Xᵢ. 2) For i=0, the restriction of T to X₀ is aperiodic, i.e. card{T^{j}x}=∞ ∀x∈X₀. We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heterodinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heterodinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I^{˜}). There is a map K₀(I^{˜})→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. {1} Let the Bernoulli shift with distribution π and denoted by Tₙ for convenience we shall use the indexing {0,1}, rather than {1,2}; that is, X will be the set of all 2-form infinite sequences of zeros and ones. Given x∈X, we construct the point (s(x),t(x)) in the unit square (using binary digits) s(x)=.x₀x₁x₂ . . . and t(x)=.x₋₁x₋₂x₋₃ . . . . The mapping x→(s(x),t(x)) is easily seen to be 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto (after removing a set from X of μ-measure zero). We consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and Xi in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Furthermore, this mapping carries the class I onto the class of Lebesgue sets and μ into Lebesgue measure on the unit square. Also, s(Tx)=.x₁x₂ . . . and τ(Tx)=.x0x−1x−2 . . . so that T is carried onto the Baker's transformation {1} Two columns of equal width {the Bernoulli shifts the Acyclicity of the Koszul complex two Bernoulli shifts}; and {2} Two columns of equal width {the Bernoulli shifts the Acyclicity of the Koszul complex two Bernoulli shifts}:=four {4×4 columns} the Acyclicity of the Koszul complex Rohlin's Theorem (strong form). The Acyclicity of the Koszul complex Rohlin's Theorem (strong form) pseudoprime base number theory. A semiprime is a natural number that is a product of two prime numbers. The same entropy can be isomorphic on sequence spaces Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. Proof. Bernoulli shifts with distribution π and denoted by T_{π} up to a shift of parity. The Acyclicity of the Koszul complex Rohlin's Theorem (strong form) pseudoprime base number theory, a semiprime is a natural number that is a product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We characterize those rings whose classical ring of left quotients is semisimple. We digress briefly to discuss the notion of a prime ideal in a non-commutative setting. And in turn, leads to a generalization of the prime radical from commutative algebra. Total order ordering relation where all elements can be compared, equality means identity, binary relation on some set, which is antisymmetric, transitive, and total well-order (on a set S) total order on S with the property that every non-empty subset of S has a least element in this ordering. The set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation. Left quotients are semisimple we consider two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs from the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs under the Larmor frequency), or the common action of a static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs equal to the Larmor frequency comprising electromagnetic pulses) both expressions listed above involve a “static” value plus one half the square of the velocity *-dynamical system finite-dimensional *-representations are completely reducible (semisimple) continuum a lift a normal k-smoothing isometries quantum mechanics on a complex, finite dimensional let A be a *-Banach algebra with identity and let μ be a positive linear functional on A which has an asymptotically stable, hyperbolic static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point monotone approximation by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs, where the group Γ is chosen discrete and cocompact in such a way that V is a homology 3-sphere (The Longitudinal Index Theorem for Foliations A. Connes* and G. Skandalis** 1983). For instance, one can take in the Poincaré disk a regular triangle T with its three angles equal to π/4 and as Γ the group formed by products of an even number of hyperbolic reflections along the sides of T. In order to exploit the results on vanishing or homotopy invariance of the analytic index Indₐ:K*(F)→K(C*(V,F)) we shall construct higher-dimensional generalizations of the above maps dim∧: K(C*(V,F))→R associated to higher-dimensional “currents” on the space of leaves V/F, whose differential geometry, i.e. the transverse geometry of the foliation, will then be fully used. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I). There is a map K₀(I)→K₀(k)≅Z. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is under the Larmor frequency. The static-field normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1 zₙ₊₁=0 order of harmonic notation nP whose initial and final points coincide in a fixed-point p known as the base point monotone approximation of distributions least upper bound property, and mapped by the complex Hilbert transform [symbol] with envelope | [symbol] |. A heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the following theorem shows us that, in the lift zonoid order, every probability distribution least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs can be approximated from below by empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs and from above by absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. Theorem 5.8. Given F 2 F₀, there exists a sequence fFₙg of empirical distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs. And a sequence fF ⁿg of absolutely continuous distributions least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs such that both converge weakly to F and Fn dLZ F dLZ F n: the proof is complete; see Phelps (1966, ch. 13); and see Goodey and Weil (1993, p. 1321). We have here non-trivially whereby the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs is equal to the Larmor frequency monotone approximation by empirical distributions. The classical cases listed above establish two routes least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs the set S together with the well-order relation is then called a well-ordered set we provide is the least upper bound property a heteroclinic connection between pairs of equal energy periodic orbits around two of the libration points commute specific base cohomology properties. We obtain an upper bound on the possible number of linearly independent vector fields on a sphere, then we establish an upper bound on k(n) which is a step toward the complete result and which gives the least upper bound for n<16 (N. E. Steenrod). Then least upper bound base the objects are pairs well-order relation continued in number theorem and the prime radical from commutative algebra problems. Completeness of Fourier modes the purpose of this note is to show completeness of the Fourier modes . . . , e^{-3ix}/√2π, e^{-2ix}/√2π, e^{-ix}/√2π, 1/√2π, e^{ix}/√2n, e^{2ix}/√2n, e^{3ix}/√2π . . . , for describing functions that are periodic of period 2π. It is to be shown that all these functions is written as combinations of the Fourier modes above. Assume that f(x) is any reasonable smooth function that repeats itself after a distance 2π, so that f(x+2π)=f(x). Then you can always write it in the form f(x)= . . . +c₋₂e^{-2ix}/√2π, +c₋₁e^{-2ix}/√2π, +c₋₁e^{-ix}/√2π, +c₀1/√2π, +c₁e^{ix}/√2π, +c₂e^{2ix}/√2π, +c₃e^{3ix}/√2π . . . +. or f(x)=^{∞}Σ_{k=-∞}cₖe^{kix}/2π for short. Such a representation of a periodic function is called a “Fourier series”. The coefficients cₖ are called “Fourier coefficients”. The factors 1/√2π can be absorbed in the definition of the Fourier coefficients, if you want. Because of the Euler formula, the set of exponential Fourier modes above is completely equivalent to the set of real Fourier modes 1/√2π, cos(x)/√π, sin(x)/√π, cos(2x)/√π, sin(2x)/√π, cos(3x)/√π, sin(3x)/√π, . . . so that 2π-periodic functions are written as f(x)=a₀1/√2π+^{∞}Σₖ₌₁ak cos(kx)/√π+^{∞}Σₖ₌₁bk sin(kx)/√π. The extension to functions that are periodic of some other period than 2π is a trivial matter of rescaling x. For a period 2I, with I any half period, the exponential Fourier modes take the more general form . . . , e^{-k2ix}/√2l, +e^{-k1ix}/√2l, +1/√2l, +e^{k1ix}/√2l, +e^{k2ix}/√2l, . . . k₁=1π/l, k₂=2π/l, k₃=3π/l, . . . and similarly the real version of them becomes 1/√2l, cos(k₁x)/√l, sin(k₁x)/√l, cos(k₂x)/√l, sin(k₂x)/√l, cos(k₃x)/√l, sin(k₃x)/√l, . . . , Often, the functions of interest are not periodic, but are required to be zero at the ends of the interval on which they are defined. Those functions can be handled too, by extending them to a periodic function. For example, if the functions f(x) relevant to a problem are defined only for 0 [symbol] x [symbol] l and must satisfy f(0) f(x) f(l) 0, then extend them to the range −l [symbol] x [symbol] 0 by setting f(x)=−f(−x) and take the range −l [symbol] x [symbol] l to be the period of a 2l-periodic function. It may be noted that for such a function, the cosines disappear in the real Fourier series representation, leaving only the sines. Similar extensions can be used for functions that satisfy symmetry or zero-derivative boundary conditions at the ends of the interval on which they are defined. If the half period I becomes infinite, the spacing between the discrete k values becomes zero and the sum over discrete k values turns into an integral over continuous k values. This is exactly what happens in quantum mechanics for the eigenfunctions of linear momentum. The representation is now no longer called a Fourier series, but a “Fourier integral”. And the Fourier coefficients cₖ are now called the “Fourier transform” F(k). The completeness of the eigenfunctions is now called Fourier's integral theorem or inversion theorem. The basic completeness proof is a long mathematical derivation. The Fourier modes are orthogonal and normalized. Any arbitrary periodic function f of period 2n that has continuous first and second order derivatives is written as f(x)=^{k=∞}Σ_{k=-∞}cₖe^{kix}/√2π, in other words, as a combination of the set of Fourier modes. First an expression for the values of the Fourier coefficients cₖ is needed. It can be obtained from taking the inner product [symbol] e^{lix}/√2π|f(x) [symbol] between a generic eigenfunction e^{lix}/√2π and the representation for function f(x) above. Noting that all the inner products with the exponentials representing f(x) will be zero except the one for which k=I, if the Fourier representation is indeed correct, the coefficients need to have the values cₖ∫^{2π}ₓ₌₀e^{-lix}/√2πf(x)dx, a requirement that was already noted by Fourier. Note that I and x are just names for the eigenfunction number and the integration variable that you can change at will. Therefore, to avoid name conflicts, the expression will be renotated as cₖ∫^{2π}ₓ₌₀e^{-kix}^{^{−}}/√2πf(x⁻)dx⁻. Now the question is: suppose you compute the Fourier coefficients cₖ from this expression, and use them to sum many terms of the infinite sum for f(x), say from some very large negative value −K for k to the corresponding large positive value K; in that case, is the result you get, call it fK(x)≡√1+2(2+t)_{-K}cₖe^{kix}/√2π, a valid approximation to the true function f(x)? More specifically, if you sum more and more terms (make K bigger and bigger), does f_{K}(x) reproduce the true value of f(x) to any arbitrary accuracy that you may want? If it does, then the eigenfunctions are capable of reproducing f(x). If the eigenfunctions are not complete, a definite difference between f_{K}(x) and f(x) will persist however large you make K. In mathematical terms, the question is whether lim_{K→∞}f_{K}(x)=f(x). To find out, the trick is to substitute the integral for the coefficients cₖ into the sum and then reverse the order of integration and summation to get: f_{K}(x)=½π∫^{2π}ₓ_{^{−}}₌₀f(x⁻)[√1+2(2+t)_{-K}e^{ki(x-x}^{^{−}}⁾] dx⁻. The sum in the square brackets can be evaluated, because it is a geometric series with starting value e^{-i(x-x}^{^{−}}⁾ and ratio of terms e^{i(x-x}^{^{−}}⁾. Using a formula, multiplying top and bottom with e^{-i(x-x}^{^{−}}^{)/2}, and cleaning up with, the Euler formula, the sum is found to equal sin ((K+½)(x−x⁻))/sin(½(x−x⁻)). This expression is called the Dirichlet kernel. You now have f_{K}(x)=∫^{2π}ₓ_{^{−}}₌₀f(x⁻)sin((K+½)(x−x⁻))/2π sin (½(x−x⁻)) dx⁻. The second trick is to split the function f(x⁻) being integrated into the two parts f(x) and f(x⁻)−f(x). The sum of the parts is obviously still f(x⁻), but the first part has the advantage that it is constant during the integration over (x⁻) and can be taken out, and the second part has the advantage that it becomes zero at (x⁻)=x. You get f_{K}(x)=f(x)∫^{2π}ₓ_{^{−}}₌₀ sin((K+½)(x−x⁻))/2π sin(½(x−x⁻)) dx⁻+∫^{2π}ₓ_{^{−}}₌₀(f(x⁻)−f(x))sin((K+½)(x−x⁻))/2π sin(½(x−x⁻)) dx⁻. Now if you backtrack what happens in the trivial case that f(x) is just a constant, you find that f_{K}(x) is exactly equal to f(x) in that case, while the second integral above is zero. That makes the first integral above equal to one. Returning to the case of general f(x), since the first integral above is still one, it makes the first term in the right hand side equal to the desired f(x), and the second integral is then the error in f_{K}(x). To manipulate this error and show that it is indeed small for large K, it is convenient to rename the K-independent part of the integrand to g(x⁻)=f(x⁻)−f(x))/2π sin(½(x−x⁻)). Using l'Hôpital's rule twice, it is seen that since by assumption f has a continuous second derivative, g has a continuous first derivative. So you can use one integration by parts to get f_{K}(x)=f(x)+l/K+½ ∫^{2π}ₓ_{^{−}}₌₀ g′(x⁻) cos ((K+½)(x−x⁻))dx⁻. And since the integrand of the final integral is continuous, it is bounded. That makes the error inversely proportional to K+½, implying that it does indeed become arbitrarily small for large K. Completeness has been proved. It may be noted that under the stated conditions, the convergence is uniform; there is a guaranteed minimum rate of convergence regardless of the value of x. This can be verified from Taylor series with remainder. Also, the more continuous derivatives the 2π-periodic function f(x) has, the faster the rate of convergence, and the smaller the number 2K+1 of terms that you need to sum to get good accuracy is likely to be. For example, if f(x) has three continuous derivatives, you can do another integration by parts to show that the convergence is proportional to 1/(K+½)² rather than just 1/(K+½). But watch the end points: if a derivative has different values at the start and end of the period, then that derivative is not continuous, it has a jump at the ends. (Such jumps can be incorporated in the analysis, however, and have less effect than it may seem. You get a better practical estimate of the convergence rate by directly looking at the integral for the Fourier coefficients). By the rule (χ*(n mod m), gcd(n,m)=1, χ(n)=0, χ is also referred to as a Dirichlet character, χ for the function of transport properties of Euclidean space transformations that preserve the Euclidean metric isometries are the sum of the dimensions of its factors two pairs (S₀, g₀) and (S₁, g₁), where Sᵢ are compact, m-dimensional Z/2-oriented, regular stratifolds and gᵢ:Sᵢ→X are continuous maps; (we refer to) Differential Algebraic Topology From Stratifolds to Exotic Spheres by Matthias Kreck “[Z/2-homology. We call a c-stratifold T compact if the underlying space T is compact. Since ∂T is a closed subset of T, the boundary of a compact regular stratifold is compact. Definition: Two pairs (S₀, g₀) and (S₁, g₁), where Sᵢ are compact, m-dimensional Z/2-oriented, regular stratifolds and gᵢ:Sᵢ→X are continuous maps, are called bordant if there is a compact (m+1)-dimensional Z/2-oriented regular c-stratifold T, and a continuous map g:T→X such that (∂T, g)=(S₀, g₀)+(S₁, g₁). The pair (T, g) is called a bordism between (S₀, g₀) and (S₁, g₁)]; simply connected closed n-dimensional manifolds proposition 4.4. Let X be a topological space. Bordism defines an equivalence relation on the set of isomorphism classes of compact, m-dimensional, Z/2-oriented, regular stratifolds with a map to X. Moreover, the topological sum (S₀, g₀)+(S₁, g₁):=(S₀ [symbol] S₁, g₀ [symbol] g₁) induces the structure of an abelian group on the set of such equivalence classes. This group is denoted by SHₘ(X; Z/2), the m-th stratifold homology group with Z/2-coefficients or for short m-th Z/2-homology. We denote the equivalence class represented by (S, g) by [S, g]. Singular homology groups. Proof: (S, g) is bordant to (S, g) via the bordism (S×[0, 1], h), where h(x, t)=g(x). We call this bordism the cylinder over (S, g). We observe that if S is Z/2-oriented and regular, then S×[0, 1] is Z/2-oriented and regular. Thus the relation is reflexive. The relation is obviously symmetric. To show transitivity we consider a bordism (W, g) between (S₀, g₀) and (S₁, g₁) and a bordism (W′; g′) between (S₁, g₁) and (S₂, g₂), where W, W′ and all S, are regular Z/2-oriented stratifolds. We glue W and W′ along Sᵢ as explained in Proposition 3.1. The result is regular and Z/2-oriented. The boundary of W∪S₁ W′ is S₀ [symbol] S₂. Since g and g′ agree on S₁, they induce a map g∪g′ : W∪S₁ W′→X, whose restriction to S₀ is g₀ and to S₂ is g₂. Thus (S₀, g₀) and (S₂, g₂) are bordant, and the relation is transitive. Next, we check that the equivalence classes form an abelian group with respect to the topological sum. We first note that if (S₁, g₁) and (S₂, g₂) are isomorphic, then they are bordant. A bordism is given by gluing the cylinders (S₁×[0, 1], h) and (S₂×[0, 1], h) via the isomorphism considered as a map from ({1}×S₁) to (S₂×{0}) (as explained after Proposition 3.1). Since the isomorphism classes of pairs (S, g) are a set and isomorphic pairs are bordant, the bordism classes are a quotient set of the isomorphism classes, and thus are a set. The operation on SHₘ(X; Z/2) defined by the topological sum satisfies all the axioms of an abelian group. The topological sum is associative and commutative. An element (S, g) represents the zero element if an only if there is a bordism (T, h) with ∂(T, h)=(S, g). The inverse of [S, g] is given by [S, g] again, since [S, g]+[S, g] is the boundary of (S×[0, 1], h), the cylinder over (S, g). Remark: By the last argument, each element [S, g] in SHₘ(X; Z/2) is 2-torsion, i.e., 2[S, g]=0. In other words, SHₘ(X; Z/2) is a vector space over the field Z/2. Here we abbreviate the quotient group Z/2Z, which is a field, as Z/2. Later we will define SHₘ(X; Q), which will be a Q-vector space. This indicates the role of Z/2 in the notation of homology groups;” two manifolds X₀G^{x}, x=r( [symbol] ) and X₁ G^{x}, x=r( [symbol] ), infinite connected manifolds the Θ^{j}(K) commute pairwise (S₀, g₀) and (S₁, g₁), where Sᵢ are compact, m-dimensional Z/2-oriented, regular stratifolds and gᵢ:Sᵢ→X are continuous maps we consider Tian 13 gave the maximal and minimal ranks of two real matrices X₀ and X₁ in solution X X₀ iX₁ to AXB C over C with its applications, and Liu et al. 9 derived the maximal and minimal ranks of the two real matrices X₀ and X₁ in a Hermitian solution X X₀iX₁ of 1.3, B*B representations M₀ and N₁, infinite connected manifolds the Θ^{j}(K) commute pairwise, the Θ^{j}(K) generate the von Neumann algebra R_{0,1}, and this property remains true whenever Θ is multiplied by an automorphism eigenvalue of modulus 1 A differentiable map f:M₀→N₁ is called A diffeomorphism if it is A bijection and its inverse f−1: N₁→M₀ is differentiable as well, if these functions are r times continuously differentiable, f is called A Cr-diffeomorphism. M₀ and N₁ formally, are diffeomorphic symbol usually being ≃ if there is A diffeomorphism f from M₀ to Ni, they are Cr diffeomorphic if there is an r times continuously differentiable bijective map between them whose inverse is also r times continuously differentiable. Diffeomorphism if it is A bijection and its inverse f−1: N₁→M₀ having exponents b^{m+n}=b^{m}×bⁿ; (b^{m})ⁿ=b^{m×n}; and (b×c)ⁿ=bⁿ×cⁿ mean value constraint as applications, we establish necessary and sufficient conditions over H to have The Real and Complex Hermitian Solutions to a System of Quaternion Matrix Equations with Applications by Shao-Wen Yu (we refer to). Diffeomorphism A mapping that is isomorphic, 1-1 structure of the Dual Algebra the monomials ε^{I} in a′ correspond in a one-to-one way with sequences of non-negative integers (i₁, i₂, • • • , iₙ, 0, • • • ) we now find the diagonal in a* and onto, differentiable, with an inverse map having the same characteristics as the original smooth map f:S1→S2f:S1→S2, which are bijective and whose inverse map f−1:S2→S1f−1:S2→S1, which are bijective and whose inverse map f−1:S2→S1f−1:S2→S1 is smooth onto, vector additive the dot product of one of the vectors (with respect to coordinate-wise addition) with the cross product of the other two, 1-1 structure of the Dual Algebra the monomials s′ in a′ correspond in a one-to-one way with sequences of non-negative integers (i₁, i₂, • • • , iₙ, 0, • • • ) we now find the diagonal in a* we define on the base of the natural plane constant are the first convex set eigenfunctions form a complete set subspace which is a linear resolution eigenvalue of modulus 1 normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 order of harmonic notation nP whose initial and final points coincide in a fixed point p known as the base point rotation A module is called a uniform module if every two nonzero submodules have nonzero intersection at the initial phase of the motion 1n+1, phase factor for any complex number written in polar form (such as re^{iΘ}), the phase factor is the complex exponential factor (e^{iΘ}) the motion is uniform circular motion we incorporate the periodic set c equal to e so they are too fortuitously the base of the natural logarithm plane. The normalization function of a different action the motion of our system of equations eigenfunctions the principal of eigenvalues of arithmetic progression. Homomorphism of groups, the homomorphism of the ring structure I^{˜}. Commutes with all cohomology operations negative [symbol] -axis y:[A, b]→S together with a subdivision a=τ₀<τ₁<τ₂<∧<τₙ=b of [A, b] let G be a connected Lie group and let A be a strongly continuous action of G on B contain 1. We show that it is sufficient to treat the case V=K. Compact operators. Let H be a Hilbert space and let Bf(H) be the set of finite rank operators in B(H). This is a two-sided ideal in B(H). If I is any proper 2-sided ideal, then Bf(H)⊆I. Let the exact sequence K₀(I)→K₀(R)→K₀(R/I) where K₀(I) is defined as follows: adjoined unit by ring structure I^{˜}, which has some K-theory K₀(I). There is a map K₀(I^{˜})→K₀(k)≅Z. Let the exact sequence K₀(I)→K₀(R)→K₀(R/I) where K₀(I) is defined as follows: adjoined unit by ring structure I^{˜}, which has some K-theory K₀(I^{˜}). It may be noted that under the stated conditions, the convergence is uniform; there is a guaranteed minimum rate of convergence regardless of the value of x. This can be verified from Taylor series with remainder. Also, the more continuous derivatives the 2π-periodic function f(x) has, the faster the rate of convergence, and the smaller the number 2K+1 of terms that you need to sum to get good accuracy is likely to be. For example, if f(x) has three continuous derivatives, you can do another integration by parts to show that the convergence is proportional to 1/(K+½)² rather than just 1/(K+½). But watch the end points: if a derivative has different values at the start and end of the period, then that derivative is not continuous, it has a jump at the ends. (Such jumps can be incorporated in the analysis, however, and have less effect than it may seem. You get a better practical estimate of the convergence rate by directly looking at the integral for the Fourier coefficients). Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, Leibniz's rule for differentiation under the integral sign ∫, for an integral of the form ₐ₍ₓ₎∫^{b(x)} f(x,t) dt, where −∞<a(x), b(x)<∞ the derivative of this integral is expressible as d/dx(ₐ₍ₓ₎∫_{b(x)} f(x,t) dt)=f(x, b(x))·d/dx b(x)−f(x, a(x))·d/dx a(x)+a(x)∫b(x) ∂/∂x f(x, t) dt, where the partial derivative indicates that inside the integral, only the variation of f(x, t) with x is considered in taking the derivative. Notice that if a(x) and b(x) are constants rather than functions of x, we have a special case of Leibniz's rule: d/dx (a∫b f(x, t) dt)=ₐ∫^{b} ∂/∂x f(x, t) dt. Thus under certain conditions, one may interchange the integral and partial differential operators. This important result is particularly useful in the differentiation of integral transforms. A moment generating function in probability theory, a variation of the Laplace transform, which can be differentiated to generate the moments of a random variable. Whether Leibniz's integral rule applies is essentially a question about the interchange of limits. Theorem. Let f(x, t) be a function such that both f(x, t) and its partial derivative fₓ(x, t) are continuous in t and x in some region of the (x, t)-plane, including a(x)≤t≤b(x), x₀≤x≤x₁. Also suppose that the functions a(x) and b(x) are both continuous and both have continuous derivatives for x₀≤x≤x₁. Then, for x₀≤x≤x₁, d/dx(a(x)∫b(x) f(x,t) dt)=f(x, b(x))·d/dx b(x)−f(x, a(x))·d/dx a(x)+a(x)∫b(x) ∂/∂x f(x, t) dt. This formula is the general form of the Leibniz integral rule and can be derived using the fundamental theorem of calculus. The (first) fundamental theorem of calculus is just the particular case of the above formula where a(x)=a, a constant, b(x)=x, and f(x, t)=f(t). If both upper, and lower limits are taken as constants, then the formula takes the shape of an operator equation: It∂x=∂xIt where ∂x is the partial derivative with respect to x and It is the integral operator with respect to t over a fixed interval. That is, it is related to the symmetry of second derivatives, but involving integrals as well as derivatives. This case is also known as the Leibniz integral rule. The following three basic theorems on the interchange of limits are essentially equivalent: the interchange of a derivative and an integral (differentiation under the integral sign ∫; i.e., Leibniz integral rule); the change of order of partial derivatives; the change of order of integration (integration under the integral sign ∫; i.e., Fubini's theorem). Continuity of equation orientated equivalence ±poles of the function, are continued as a continuous equivalence ±poles of the function in a Hilbert space is a vector space H with an inner product [symbol] f, g [symbol] such that the norm defined by |f|=√ [symbol] f, f [symbol] turns H into a complete metric space. If the metric defined by the norm is not complete, then H is instead known as an inner product space. Sampled functions leads to a sampling theorem for finite sequences of the sample paths in Hilbert spaces include 1. The real numbers Rⁿ with [symbol] v, u [symbol] the vector dot product of v and u. 2. The complex numbers Cⁿ with [symbol] v, u [symbol] the vector dot product of v and the complex conjugate of u. Sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =^{-∞}∫^{∞}f (x) g (x) d x, and nondegenerate 2-form structure in potential theory complex analysis proves invaluable mathematical physics expressions an infinite potential one {1×1 column} quadrupole, or equivalence their incidence of the Euclidean space are shared with an affine geometry, the complete metric space property, and the number in base point k-face element plane the fundamental group we consider the category of pointed topological spaces, i.e. topological spaces with distinguished points. Equilateral pole equivalent translation symmetrical bisection measure of change two poles, or equivalently is written period module the sum of the first n+1 terms of a series at 0; Euler's identity is the equality e^{iπ}+1=0 the Euler scheme is our simplest strong Taylor approximation, containing only the time and Wiener integrals of multiplicity one from the Itô-Taylor expansion, and usually attains the order of strong convergence [symbol] =0.5. Magnetic Field of a Current Element Magnetic Resonance trapping function period module terms Euler poles has sides of the trapping function bisection measure of change two poles, or equivalently is written period module the sum of the first n+1 terms of a series at 0; Euler's identity is the equality e^{iπ}+1=0; we find the quadrupole distributed increment of the ith component of the m-dimensional standard Wiener process W on [τₙ,τₙ₊₁] for an ideal H of R the following are equivalent: (a) H is semiprime; (b) I²⊆H implies I⊆H for all left (right/two-sided) ideals I; (c) aRa⊆H implies that a e H. Permuting the coordinates (±1, 0, 0, . . . , 0) homogeneous Leibniz two terminal poles, and equivalent terminal poles continuity in equation polar terminus equivalence A×B Cartesian Product (set of ordered pairs from A and B) {1,2}×{3,4}={(1,3), (1,4), (2,3), (2,4)} calculus to calculate the ±poles of the function, sampled functions leads to a sampling theorem for finite sequences of the sample paths and gives us a simple derivation of an infinite-dimensional Hilbert space is L², the set of all functions f: R→R such that the integral of f² over the whole real line is finite. In this case, the inner product is [symbol] f, g [symbol] =_{-∞}∫^{∞}f (x) g (x) d x, nondegenerate 2-form structure in potential theory complex analysis proves invaluable mathematical physics expressions an infinite potential one {1×1 column) quadrupole, or equivalence capillary feeder and collector of exhaled carbon dioxide CO₂, equipotential byproduct carbon dioxide CO₂; or synthesized organigenic gases the numerical solution X⁽ⁿ⁾ converges strongly to X with order [symbol] >0 if there exists a constant c>0 such that E|X_{T}−X⁽ⁿ⁾_{T}|≤cmesh(τn) [symbol] , ∀n≥1. X₍ₙ₎ is a strong numerical solution of the SDE if E|X_{T}−X⁽ⁿ⁾_{T}|→0, as mesh(τn)→0. One could use E sup_{0≤t≤T}|Xₜ−X⁽ⁿ⁾ₜ| as a more appropriate criteria to describe the pathwise closeness of X and X⁽ⁿ⁾. But this quantity is more difficult to deal with theoretically. The Euler Approximation The equidistant Euler approximation converges strongly with order 0.5 of Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Higher aggregation atoms sinterization (oxygen, gases, and elements) (1.0) atoms and intramolecular hybridization molecules the scalar triple product written in terms of the permutation symbol ^{∈i j k} as A·(B×C)=_{∈i j k} Aⁱ B^{j} C^{k}, where Einstein summation noted to sum over repeated indices q=∥μ∥ a second scalar field at program temperature fluid triple product written in terms of the permutation symbol ^{∈i j k} as A·(B×C)=_{∈i j k} Aⁱ B^{j} C^{k}, where Einstein summation is used to sum over repeated indices we also use here in the shorthand notation [0; 0, 1, 0, 1, 4, 1, 4, 1, 3, 0, . . . ]. The Acyclicity of the Koszul complex and Rohlin's Theorem (strong form). (We refer to). “Whose period is the smallest possible compatible with these conditions. In particular, all the outer symmetries Θ∈AutR of R, Θ²=1, Θ/∈ InnR, are pairwise conjugate. The simplest realization of the symmetry s¹₂ consists in taking the automorphism of R⊗R that transforms x⊗y into y⊗x for all x,y∈R. For p₀=0, there exists, up to outer conjugacy, a unique aperiodic automorphism Θ∈AutR (i.e. with p₀(Θ)=0). In particular, all the Bernoulli shifts the Acyclicity of the Koszul complex Rohlin's Theorem (strong form), although pairwise distinguished up to conjugacy by the entropy, are outer conjugate. All the Bernoulli shifts the Acyclicity of the Koszul complex Rohlin's Theorem (strong form) pseudoprime base number theory. A semiprime natural number the product of two prime numbers. A strong pseudoprime base prime number >arithmetic mean nearest prime above and below. And in algebra, the number theoretic sense given a prime number pₙ, semiprime is the index in the ordered set of prime numbers, pₙ>pₙ₋₁+p_{n+1/2}. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. We use Lissajous figures to compute the input, and output quadrature of the function over the domain [−1,1]×[−1,1] of a set of Padua points for our rotations concerns heteroclinic connections and resonance transitions in the planar circular restricted 3-body problem. A cylinder set is a subset of X determined by a finite number of values, such as (2.1) C={x|xᵢ=tᵢ,−m≤i≤n} where tᵢ, −m≤i≤n, is some fixed finite sequence in [1, 2, . . . , k]. Let E denote the σ-algebra generated by the cylinder sets. There is then a unique measure μ defined on E such that, if C has the form (2.1), then μ(C)=πⁿᵢ₌₋ₘ Ptᵢ with applications to the dynamics transfers. The existence of a heteroclinic connection between pairs of equal energy periodic orbits around two of the libration points is tabulated numerically. We consider higher-dimensional analogues of Steiner's problem by two n strong pseudoprimes dimorphism (n) for some k satisfying 0≤k<d, and for some k satisfying 0≤k<d if a composite number n satisfies these two equations, we call n a strong pseudoprime dimorphism (n) to base two (spsp(a) for short), this is the basic of Rabin-Miller test (3) a chemistry the property exist in two distinct crystalline forms refinement of the crystal lattice structure variety conforming to subspace groups (T])* property base of the natural plane we refer to survey of numerical solution of stochastic differential equations of P. E. Kloeden and E. Platen. High-order methods for strong sample path approximations and for weak functional approximations with k-sides are variations fundamental the magnitudes signals (sources) strong topology. Transcendental Functions analytic function ƒ(z) of one real or complex variable z independent variable extended to functions of several variables mathematics through quadrature of the rectangular hyperbola xy=1, functions are transcendental: f₁(x)=x^{π}, f₂(x)=c^{x}, f₃(x)=x^{x}, f₄(x)=x^{1/x}, f₅₍ₓ₎=log_{c}(x), f₆(x)=sin x in particular, for ƒ₂ if we set c equal to e the base of the natural logarithm, then we get that e^{x} is a transcendental function similarly, if we set c equal to e in ƒ₅, then we get that f₅₍ₓ₎=logₑ x=1n x that is, the natural logarithm is a transcendental function and Differentiation of Transcendental Functions trigonometric derivatives (rate of change, engineering, equation of normal) of sin, cos, and tan functions, derivatives of esc, sec, and cot functions, and derivatives of inverse trigonometric functions differentiating logarithmic, and exponential functions derivative of the logarithmic function, and derivatives of transcendental functions formulas for taking derivatives of exponential, logarithm, trigonometric, and inverse trigonometric functions then any function made by composing these with polynomials, or with each other can be differentiated by using the chain rule, product rule, or mathematic the first two are the essentials for exponential, and logarithms: the next three are essential for trig functions: and the next three are essential for inverse trig functions curves as the cycloid of mathematics a periodic curve. The matrix W whose columns form a period basis of the Abelian function f(z) has dimension p×2p and is known as the period matrix of the Abelian function f(z). A necessary and sufficient condition for a given matrix W of dimension p×2p to be the period matrix of some non-degenerate Abelian function f(z) exist an anti-symmetric non-degenerate square matrix M with integer elements, of order 2p, and Hermitian inner product has 1 real part symmetric positive definite, and its imaginary part symplectic by properties on a complex vector space V is a complex-valued bilinear form on V which is antilinear in the second slot, and is positive definite, following properties, where z* means the complex conjugate of z. Conditions are expressed as equations and inequalities respectively, a system of p(p−1)/2R Riemann equations and p(p−1)/2R Riemann inequalities is obtained. The number p is called the genus of the matrix W and of the corresponding Abelian function f(z). The columns wᵥ=Re wᵥ+i Im wᵥ of W, regarded as vectors in the real Euclidean space R^{2p}, define the period parallelotope of f(z). All Abelian functions corresponding to the same period matrix W form an Abelian function field ^{K}W. If the field ^{K}W contains a non-degenerate Abelian function, its degree of transcendence over the field C is p. The torus Cp/Γ is then an Abelian variety, and ^{K}W turns out to be its field of rational functions. If, on the other hand, all Abelian functions of ^{K}W are degenerate, then ^{K}W is isomorphic to the field of rational functions on an Abelian variety of dimension lower than p. The Abelian function AI(z) may be represented as AI(z)=AI(^{z}1, . . . , ^{zp})=R[^{x}1(^{z}1, . . . , ^{z}p), . . . , ^{x}p (^{Z}1, . . . , ^{z}p)]. A generalization of the concept of an elliptic function of the real part of one complex variable s=σ+i τ in analytic number theory to the case of several complex variables, a function f(z) in the variables ^{Z}1, . . . , ^{z}p, z=(^{z}1, . . . , ^{z}p), mathematical field of complex analysis meromorphic does function on an open subset D of the complex plane is a function that is holomorphic on all of D except for a set of isolated points, in the complex space C^{p}, p≥1, p coordinates of the upper limits ^{x}1, . . . , ^{x}p, and system of sums lower integration limits ^{c}1, . . . , ^{c}p which are poles of the function in the complex space C^{p}, f(z)f(z), in the complex space, function f(z) in the variables ^{Z}1, . . . , ^{z}p, ^{z=z}1, . . . , ^{z}p, is called an Abelian function if there exist ²p row vectors in C^{p}, wᵥ=(w1ᵥ, . . . , wₚᵥ), v=1, . . . , 2p, which are linearly independent over the field of real numbers and are such that f(z+wᵥ)=f(z) for all z∈C^{p}, v=1, . . . , 2p. The vectors wᵥ of all periods, or the system of periods of the Abelian function f(z) form an Abelian group Γ under addition, the period group, or the period module, a basis of this group is a system of periods of the Abelian function, or also as a system of basic periods, an Abelian function f(z) is degenerate if there exists a linear transformation of the variables ^{z}1, . . . , ^{z}p which converts f(z) into a function of fewer variables, otherwise f(z) is said to be a non-degenerate Abelian function, degenerate Abelian functions are distinguished by having infinitely small periods, such as for any number ∈>0 it is possible to find a period wᵥ, if p=1, the non-degenerate Abelian functions are elliptic functions of one complex variable, each Abelian function with period group Γ is naturally identified with a meromorphic function on the complex torus C^{p}/Γ, such as the quotient space C^{p}/Γ, is called a quasi-Abelian function if it has, linearly independent periods. The formula: 2^{x-1}+4^{y}(1^{x+y}) is the real Euclidean space R^{2p} for all positive integer values of x and y formula for all composite numbers every even number paired with this formula subtracted by a given magnitude Q/2 would be a prime denoting Q as a given magnitude as a given magnitude Q/2+(2^{x-1}+4^{y}(1^{x+y}) is the real Euclidean space R^{2p}) fitted for the magnitude Q=Π(X_{0,1}). All Abelian functions corresponding to the same period matrix W form an Abelian function field ^{K}W, If the field ^{K}W contains a non-degenerate Abelian function its degree of transcendence over the field C is p. The torus Cp/Γ is then an Abelian variety, and ^{K}W turns out to be its field of rational functions if, on the other hand all Abelian functions of ^{K}W are degenerate, then ^{K}W is isomorphic to the field of rational functions on an Abelian variety of dimension lower than p. There is a universal C*-algebra whose representations correspond to covariant representations of a given C*-dynamical system we simplify a thermodynamic analysis we operate using intensive variables on the poles of Riemannian manifolds of nonnegative curvature s-Cobordism Theorem. Chapter 7. Pages 55, 56, and 57. The Statement and Consequences of the s-Cobordism Theorem (2005). (We refer to). “The following result, Theorem 7.1 “(s-Cobordism Theorem). Let M₀ be a closed connected oriented manifold of dimension n≥5 with fundamental group π=π₁(M₀). (1) Let (W; M₀, f₀, M₁, f₁) be an h-cobordism over M₀. Then W is trivial over M₀ if and only if its Whitehead torsion τ (W, M₀)∈Wh(π) vanishes. (2) For any x∈Wh(π) there is an h-cobordism (W; M₀, f₀, M₁, f₁) over M₀ with τ (W,M₀)=x∈Wh(π). (3) The function assigning to an h-cobordism (W; M₀, f₀, M₁, f₁) over M₀ its Whitehead torsion yields a bijection from the diffeomorphism classes relative M₀ of h-cobordisms over M₀ to the Whitehead group Wh(π). Here are some explanations. An n-dimensional cobordism (sometimes also called just bordism) (W; M₀, f₀, M₁, f₁) consists of a compact oriented n-dimensional manifold W, closed (n−1)-dimensional manifolds M₀ and M₁, a disjoint decomposition ∂W=∂₀W [symbol] ∂₁W of the boundary ∂W of W and orientation preserving diffeomorphisms f₀:M₀→∂W₀ and f₁:M⁻₁∂W₁. Here and in the sequel we denote by M⁻₁ the manifold M₁ with the reversed orientation and we use on ∂W the orientation with respect to the decomposition TₓW=Tₓ∂W⊕R coming from an inward normal field for the boundary. If we equip D² with the standard orientation coming from the standard orientation on R², the induced orientation on Sᵢ=∂D² corresponds to the anti-clockwise orientation on S₁. If we want to specify M₀, we say that W is a cobordism over M₀. If ∂₀W=M₀, ∂₁W=M⁻₁ and f₀ and f₁ are given by the identity or if f₀ and f₁ are obvious from the context, we briefly write (W; ∂₀W, ∂₁W). Two cobordisms (W, M₀, f₀, M₁, f₁) and (W′,M₀, f′₀,M′₁, f′₁) over M₀ are diffeomorphic relative M₀ if there is an orientation preserving diffeomorphism F:W→W′ with F∘f₀=f′₀. We call an h-cobordism over M₀ trivial, if it is diffeomorphic relative M₀ to the trivial h-cobordism (M₀×[0, 1]; M₀×{0}, (M₀×{1})⁻). Notice that the choice of the diffeomorphisms fᵢ does play a role although they are often suppressed in the notation. We call a cobordism (W; M₀, f₀, M₁, f₁) an h-cobordism, if the inclusions ∂ᵢW→W for i=0, 1 are homotopy equivalences. The Whitehead torsion of an h-cobordism (W; M₀, f₀, M₁, f₁) over M₀, τ (W, M₀)∈Wh(π₁(M₀)), (7.2) is defined to be the preimage of the Whitehead torsion (see Definition 6.12) τ M₀^{f0}→∂₀Wⁱ⁰→W)∈Wh(π₄(W)) under the isomorphism (i₀∘f₀)*: Wh(π₄(M₀))^{≅}→Wh(π₁(W)), where i₀:∂₀W→W is the inclusion. Here we use the fact that each closed manifold has a CW-structure, which comes for instance from a triangulation, and that the choice of CW-structure does not matter by the topological invariance of the Whitehead torsion (see Theorem 6.13 (5)). The s-Cobordism Theorem 7.1 is due to Barden, Mazur, Stallings. Its topological version was proved by Kirby and Siebenmann [130, Essay II], More information about the s-cobordism theorem can be found for instance in [128], [153, Chapter 1], [167] [211, pages 87-90]. The s-cobordism theorem is known to be false (smoothly) for n=dim(M₀)=4 in general, by the work of Donaldson [70], but it is true for n=dim(M₀)=4 for so-called “good” fundamental groups in the topological category by results of Freedman [94], [95]. The trivial group is an example of a “good” fundamental group. Counterexamples in the case n=dim(M₀)=3 are constructed by Cappell and Shaneson [45], The Poincaré Conjecture (see Theorem 7.4) is at the time of writing known in all dimensions except dimension 3. We already know that the Whitehead group of the trivial group vanishes. Thus the s-Cobordism Theorem 7.1 implies Theorem 7.3 (h-Cobordism Theorem). Each h-cobordism (W; M₀, f₀, M₁, f₁) over a simply connected closed n-dimensional manifold M₀ with dim(W)≥6 is trivial. Theorem 7.4 (Poincaré Conjecture). The Poincaré Conjecture is true for a closed n-dimensional manifold M with dim(M)>5, namely, if M is simply connected and its homology Hₚ(M) is isomorphic to Hₚ(Sⁿ) for all p∈Z, then M is homeomorphic to Sⁿ. Proof. We only give the proof for dim(M)≥6. Since M is simply connected and H*(M)≅H*(Sⁿ), one can conclude from the Hurewicz Theorem and Whitehead Theorem [255, Theorem IV.7.13 on page 181 and Theorem IV.7.17 on page 182] that there is a homotopy equivalence f:M→Sⁿ. Let Dⁿᵢ⊆M for i =0, 1 be two embedded disjoint disks. Put W=M−(int(Dⁿ₀) [symbol] int(Dⁿ₁)). Then W turns out to be a simply connected h-cobordism. Hence we can find a diffeomorphism F:(∂Dⁿ₀×[0, 1], ∂Dⁿ₀×[0], Dⁿ₀×{1})→(W, (∂Dⁿ₀, ∂Dⁿ₁) which is the identity on ∂Dⁿ₀=∂Dⁿ₀×{0} and induces some (unknown) diffeomorphism f₁:∂Dⁿ₀×{1}→∂Dⁿ₁. By the Alexander trick one can extend f₁:∂Dⁿ₀=∂Dⁿ₀×{1}→∂Dⁿ₁ to a homeomorphism f₁⁻:Dⁿ₀→Dⁿ₁. Namely, any homeomorphism f:Sⁿ⁻¹→Sⁿ⁻¹ extends to a homeomorphism f⁻:Dⁿ→Dⁿ by sending t·x for t∈[0, 1] and x∈Sⁿ⁻¹ to t·f(x). Now define a homeomorphism h:Dⁿ₀×{0}Uᵢₒ ∂Dⁿ₀×[0, 1] Uᵢ₁ Dⁿ₀×{1}→M for the canonical inclusions ik:∂Dⁿ₀×{k}→∂Dⁿ₀×[0, 1] for k=0, 1 by h|_{Dn0×{0}}=id, h|_{∂Dn0×[0, 1]}=f₁⁻. Since the source of h is obviously homeomorphic to Sⁿ, Theorem 7.4 follows. In the case dim(M)=5 one uses the fact that M is the boundary of a contractible 6-dimensional manifold W and applies the s-cobordism theorem to W with an embedded disc removed. Remark 7.5 (Exotic spheres). Notice that the proof of the Poincaré Conjecture in Theorem 7.4 works only in the topological category but not in the smooth category. In other words, we cannot conclude the existence of a diffeomorphism h:Sⁿ→M. The proof in the smooth case breaks down when we apply the Alexander trick. The construction of f⁻ given by coning f yields only a homeomorphism f⁻ and not a diffeomorphism even if we start with a diffeomorphism f. The map f⁻ is smooth outside the origin of Dⁿ but not necessarily at the origin. We will see that not every diffeomorphism f:Sⁿ⁻¹→Sⁿ⁻¹ can be extended to a diffeomorphism Dⁿ→Dⁿ and that there exist so-called exotic spheres, i.e., closed manifolds which are homeomorphic to Sⁿ but not diffeomorphic to Sⁿ. The classification of these exotic spheres is one of the early very important achievements of surgery theory and one motivation for its further development. For more information about exotic spheres we refer for instance to [129], [144], [149] and [153, Chapter 6], Remark 7.6 (The surgery program). In some sense the s-Cobordism Theorem 7.1 is one of the first theorems, where diffeomorphism classes of certain manifolds are determined by an algebraic invariant, namely the Whitehead torsion. Moreover, the Whitehead group Wh(π) depends only on the fundamental group π=π₁(M₀), whereas the diffeomorphism classes of h-cobordisms over M₀ a priori depend on M₀ itself. The s-Cobordism Theorem 7.1 is one step in a program to decide whether two closed manifolds M and N are diffeomorphic, which is in general a very hard question. The idea is to construct an h-cobordism (W;M,f,N,g) with vanishing Whitehead torsion. Then W is diffeomorphic to the trivial h-cobordism over M which implies that M and N are diffeomorphic. So the surgery program would be: (1) Construct a homotopy equivalence f:M→N. (2) Construct a cobordism (W;M,N) and a map (F,f,id):(W;M,N)→(N×[0,1],N×{0},N×{1}). (3) Modify W and F relative boundary by so-called surgery such that F becomes a homotopy equivalence and thus W becomes an h-cobordism. During these processes one should make certain that the Whitehead torsion of the resulting h-cobordism is trivial. The advantage of this approach will be that it can be reduced to problems in homotopy theory and algebra, which can sometimes be handled by well-known techniques. In particular one will sometimes get computable obstructions for two homotopy equivalent manifolds to be diffeomorphic. Often surgery theory has proved to be very useful, when one wants to distinguish two closed manifolds, which have very similar properties. The classification of homotopy spheres is one example. Moreover, surgery techniques also can be applied to problems which are of different nature than of diffeomorphism or homeomorphism classifications”. In mathematics, a binary relation R over a set X is reflexive if every element of X is related to itself. Formally, this may be written ∀x∈X:x R x we consider Tian 13 gave the maximal and minimal ranks of two real matrices X₀ and X₁ in solution X X₀iX₁ to AXB C over C with its applications, and Liu et al. 9 derived the maximal and minimal ranks of the two real matrices X₀ and Xi in a Hermitian solution X X₀ iX₁ of 1.3, B*B representations. We continue with The Real and Complex Hermitian Solutions to a System of Quaternion Matrix Equations with Applications by Shao-Wen Yu (we refer to) B*B representations. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. This defines a vector bundle. More generally, for any unital ring R, all finitely-generated projective R-modules are direct summands of free modules, so can be obtained as the image of projections in Mₙ(R). The following properties of inner products involving, Hermitian operators are often needed, so they are listed here: If A is Hermitian: [symbol] g|Af [symbol] = [symbol] f|Ag [symbol] *, [symbol] f|Af [symbol] is real. Semiprime rings. Two rings R,S are Morita equivalent if their categories of left modules are equivalent. R and Mₙ(R) are known to be Morita equivalent. In some C*algebraic sense, B₀(H) is Morita equivalent to C. Theorem (Morita) Let F:R-Mod→S-Mod be an equivalence of categories. An example of a reflexive relation is the relation “is equal to” on the set of real numbers, since every real number is equal to itself. A reflexive relation is said to have the reflexive property or is said to possess reflexivity. Along with symmetry and transitivity, reflexivity is one of three properties defining equivalence relations. Related terms. A relation that is irreflexive, or anti-reflexive, is a binary relation on a set semiprime element is related to itself. An example is the “greater than” relation (x >y) on the real numbers. Note that not every relation which is not reflexive is irreflexive; it is possible to define relations where some elements are related to themselves but others are not (i.e., neither all nor none are). For example, the binary relation “the product of x and y is even” is reflexive on the set of even numbers, irreflexive on the set of odd numbers, and neither reflexive nor irreflexive on the set of natural numbers. A relation on a set S is called quasi-reflexive if every element that is related to some element is also related to itself, formally: ∀x, y∈S:x^{˜}y⇒(x^{˜}x ∧ y^{˜}y). An example is the relation “has the same limit as” on the set of sequences of real numbers: not every sequence has a limit, and thus the relation is not reflexive, but if a sequence has the same limit as some sequence, then it has the same limit as itself. The reflexive closure ≃ of a binary relation ˜ on a set S is the smallest reflexive relation on S that is a superset of ˜. equivalently, it is the union of ˜ and the identity relation on S, formally: (≃)=(˜)∪(=). For example, the reflexive closure of x<y is x≤y. The reflexive reduction, or irreflexive kernel, of a binary relation ˜ on a set S is the smallest relation \tilde{≠} such that \tilde{≠} shares the same reflexive closure as ˜. It can be seen in a way as the opposite of the reflexive closure. It is equivalent to the complement of the identity relation on S with regard to ˜, formally: (\tilde{≠})=(˜)\(=). That is, it is equivalent to ˜ except for where x˜x is true. For example, the reflexive reduction of x≤y is x<y. Theorem 7.6. (Gärding) For any f∈(G) and any b∈B, we have α_{f}(b)=B^{∞}. As a corollary, B^{∞} is dense in B. Proof. We have Dₓ(α_{f}b))=lim_{τ→0}αₑₓₚ(_{τ}x)(α_{f}(b)−(α_{f}(b)/τ=lim_{τ→0} αₑₓₚ(_{τ}x)∫G f(x)αₓ(b)dx−∫G f(x)αₓ(b)dx/τ=lim_{τ→0}1/τ(∫f(x)αₑₓₚ(τX)x(b)−∫f(x)αₓ(b)dx)=lim_{τ→0}∫(αₑₓₚ(τX)f)(x)−f(x)/τ αₓ(b)dx=J(Dₓf)(x)αₓ(b)dx where we use the fact that (α_{y}f)(x)=f(y⁻¹x). Is it true that every b∈B^{∞} has the form α_{f}(c) for some f∈C_{c}^{∞}(G) and c∈B? Dixmier-Malliavin showed that the answer is no, but that b is always a finite sum of terms of this form (so B^{∞} is the Gärding domain). The construction b→α_{f}(b) normal k-smoothing isometries is often called smoothing, or mollifying. Our quantum mechanics application Dirichlet series d along a line parallel to the imaginary axis with real part σ the representation of a function in terms of a power series here is a mathematical tool employed with our Dirichlet series d(s)≡Σ^{∞}ₙ₌₁ dn/n^{s} which are central to number theory and with Dirichlet series are intimately connected to quantum mechanics through the Schröedinger map, and by joint measurements. This development allows us to construct a quantum wavenumber data sequences whose dynamics provides us with a single Dirichlet series, a combination of two Dirichlet series, or equivalence condition TₓM can have equivalence on the transitivity (or transitiveness) which is a key property of both partial order relations and equivalence relations. Formal definition. In terms of set theory, the transitive relation can be defined as: ∀ a,b,c∈X:(aRb∧bRc)→aRc. This is the analytical continuation of a Dirichlet series of the complete complex plane when the coefficients dn are too fortuitously real including the dot product or scalar product of algebraic operation takes two equal-length sequences of numbers coordinated with a return of a single number Vparallelpiped longitude, or transverse combination while for the only transverse measure λ for (v,f) (the horocycle flow being strongly ergodic), the composition of the above analytic index with dimλ:K*(C*(v,f)) over a Noetherian ring, every injective module is uniquely a direct sum of indecomposable modules, and their structure is well understood. An injective module over one ring, may not be injective over another, but there are well-understood methods of changing rings which handle special cases. Rings which are themselves injective modules have a number of interesting properties and include rings such as group rings of finite groups over fields. Injective modules include divisible groups and are generalized by the notion of injective objects in category theory. Equivariant cohomology. Group actions. Let G be a discrete group. Suppose we are given an action α:G→Aut(A) where A is a C*-algebra. We may think of this as a generalized dynamical system; in the special case that A=C₀(X) we take actions α:G→Homeo(X). The environmental control unit ECU applied action α:G→Homeo(X) sub-plasma. Froda's Theorem provide f:X→Y is a morphism of pointed spaces, a rigid continuous map f(x+0):=limh [symbol] 0f(x+h) f(x+0):=limh [symbol] 0f(x+h), and f(x−0):=limh [symbol] 0f(x−h) f(x−A):=limh [symbol] 0f(x−h) the Space X of Quasiperiodic the little group integral submultiples of Lᵥ can be synthesized colimit the lemma follows intrinsic amount the colimits coefficients of wₖ concordant correspondence in the affine S to sets direction of the planes a summation such a directed partition fundamental section width provide f:X→Y is a morphism of pointed spaces, the mathematical structure preserving map function the group homomorphism on the continuous function, the smallest of all the semiprime ideals, N(R)=∩{P:P is a prime ideal of R} is the prime radical of R smooth 1-densities on G the object functor category, G^{x}, x=r( [symbol] ), conservation and matter relation constraint subspace the generating function on the lower bound bases and on the upper bound for finite additive 2-bases let n(2,k) denote the largest integer n for which there exists a set A of k nonnegative integers such that the sumset 2A contains {0,1,2, . . . , n−1} a classical problem in additive number theory is to find an upper bound for n(2,k) upper bound additive 2-bases let n be a positive integer, and let A be a set of nonnegative integers such that A=[0,n]∩Z the set A is called a basis of order h for n if every integer m 6 [0,n] the system of constraint provide f:X→Y is a morphism of pointed spaces, a rigid continuous map thus F(x). Let F:H→H be the function defined by setting F(x):=f(x) for x∈[0,1] and F(x):=0 for x∉[0,1]. Work power energy of a system E_{sys} conservation, and matter relation subspace constraint qᵢⱼ(xᵢ,xⱼ)∈{0,1} isotopic class [A] power series two linearly independent solutions a minimum type thermodynamic characteristic range set lower bound of these maxima over all sets an isotopy class is said to be closed if it contains the topological limit of any sequence of sets in it. Given a space X such a family (Dₓ)_{x∈X} of elliptic operators parametrized by X is given by a longitudinal elliptic operator D an element of the K-group of the parameter space groupoid longitude, or transverse combination. Continuous of the homomorphism [symbol] :Y→Q. such that [symbol] f=g, the following diagram commutes: [symbol] *0→X^{g}↑_{Q}^{f} [symbol] Y the lemma follows cohomology of group operations. A regular cell complex K is a cell complex with the property that the closure of each cell is a finite subcomplex homeomorphic to a closed ball. The equivariant cohomology of a chain complex with a group action the cohomology group is left fixed by inner automorphisms of the group (1) let (V,F) (1) be one-dimensional as previously described. Let ∧ be a transverse measure for (V,F), the category whose objects are pairs (p,A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left, and let R be a ring (commutative, with unity). An R-module is an Abelian group (M, +) together with an action of R, a map R×M→M (r, m)→r*m=: rm∈M satisfying the following conditions: (we refer to) Chapter 3 Modules 3.1. “Some generalities about modules” “M1 Distributivity: r(m +n)=rm+rn for all r∈R, m, n∈M. M2 Distributivity: (r+s)m=rm+sm for all r, s∈R, m∈M. M3 Pseudoassociativity: (rs)m=r(sm) for all r, s∈R, m∈M. M4 Modularity: for all m∈M one has 1m=m, if this is the case, we will also say that M is a module over R, when we want to emphasize the R-module structure of M, we will write it as _{R}M” has the exact limit of the contravariant functor Hom(−,Q). Where A is a C*-algebra we find the familiar geometric series from calculus, alternately, this function has an infinite expansion. There is a universal C*-algebra whose representations correspond to covariant representations of a given C*-dynamical system. If f∈C_{c}(G,A) is a function on G with finite support and values in A and (H,π,U) is a covariant representation. (We refer to). Cohomology Operations Lectures By N. E. Steenrod Written And Revised By D. B. A. Epstein. “§ 4. Indecomposable Elements. 4. 1. Lemma. In a graded connected algebra over a field, any set B of generators of A, contains a subset B₁, whose image in Q(A) forms a vector space basis. Any such B₁ is minimal and generates A. Proof. Any set of generators of A spans Q(A). Let B₁, be any subset of B whose image in Q(A) is a basis. Let g∈A be the element of smallest degree, which is not in the algebra A′ generated by {1, B₁}. There is an element g′∈A′ such that g−g′ is decomposable. So g−g′∈ϕ(A⊗A) and g−g′=Σaᵢ′/aᵢ″, where aᵢ′, aᵢ″∈A. But aᵢ′ and aᵢ″ are in A′. Therefore g′∈A′, which is a contradiction” the colimits coefficients of wₖ concordant correspondence the affine S to sets direction of the planes a summation such a directed partition fundamental section width provide f:X→Y is a morphism of pointed spaces, the mathematical structure preserving map function the group homomorphism on the continuous function the smallest of all the semiprime ideals, N(R)=∩{P:P is a prime ideal of R} is the prime radical of R smooth 1-densities on G the object functor category, ∪ is well-defined and unitary, or in category of sheaves of O_{X}-modules over some ringed space (X,O_{X}) a right Noetherian. (We refer to) Chapter 3 Modules 3.1. “Some generalities about modules” we utilize Modules 3.1 defined in 3.1.2: let F be a field, then and F-module is precisely a vector space over F, let (M, +) be an Abelian group, define the map Z×M→M (r, m)→rm:={m+m+^{(r)} . . . +m if r>0, {(−m)+(−m)+^{(-r)} . . . +(−m) if r<0, {0 if r=0, from the group axioms it can be easily deduced that the previous map defines a Z-action on M, in other words, every Abelian group is a Z-module, the converse is also true, if (M, +) is a Z-module the for any r >0 in Z one has r=1+1+^{(r)} . . . +1, and thus rm=(1+ [symbol] +1)m=1m+ [symbol] +1m=m+^{(r)} . . . +m, and for r<0 one has r=(−1)+thus Z-modules are precisely Abelian groups, let R be a ring, define an action of R on (R, +) by r*s:=rs, by the ring laws this action makes R into an R-module, this action is called the (left) regular action of R on itself. When we want to refer to R as a module over itself rather than as a ring we will write it as _{R}R, let R, S be rings, ϕ:R→S a ring homomorphism, _{S}M an S-module. Consider the map R×M→M (r, m)→r*m:=ϕ(r)m, the ring morphism axioms, together with the fact that M is an S-module, ensure that this action provides an R-module structure on M. This is called the R-module structure induced by ϕ, in particular, if R≤S subring, then every S-module is automatically an R-module with the action given by restriction of scalars, let V be a vector space over a field F, and α:V→V a linear map. Define the map F[x]×V→V (x, v)→x*v:=a(v) extending to xⁿ*v:=αⁿ(v)=α(α(⁽ⁿ⁾ . . . α(v))) and (Σaᵢxⁱ)*v:=Σαᵢxⁱ(v). It is an easy exercise to check that under this action V becomes an F[x]-module. Conversely, if V is a module over the polynomial ring F[x], since F≤F[x], by the previous example V is automatically an F-module, thus a vector space over F. Now, define α:V→S V by α(v):=x*v, by the module axioms, a is an F-linear map, and thus there is a one to one correspondence between F[x]-modules and vector spaces V over F endowed with a linear map α:V→V. Let R be any commutative ring, the set Mₙ(R) of all n×n matrices with coefficients in R is an R-module under the action r*(aᵢⱼ):=(rαᵢⱼ). Remark, this is a particular case of let V be a vector space over a field F, and α:V→V a linear map, with M=S=Mₙ(R) and ϕ:R→S given by α(r):=r·Id. Or Definition 3.1.3 let _{R}M be an R-module, a subset p⊆M is said to be a submodule of M if: P is a subgroup of (M, +), i.e. P≠Ø, for all α, b∈P one has α+b in P and −α∈P, for all r∈R, and for all m∈P one has rm∈P. If P is a submodule of M we will denote that by P≤M. In this case, P is also an R-module in its own right. Remark 3.1.4, P is a submodule of M if and only if for all m, n∈P and for all r, s∈R one has rm+sn∈P. The category of sheaves of O_{X}-modules over some ringed space (X,O_{X}) a right Noetherian, right self-injective ring (important module theoretic property quasi-Frobenius the projective modules are exactly the injective modules), two-sided Artinian and two-sided injective, (Lam 1999, Th. 15.1). From the category of left R-modules to the category of Abelian groups is exact. The product topology on K×L defines a space which is homotopy equivalent to the CW complex K×L. Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K. (We refer to). Cohomology Operations Lectures By N. E. Steenrod Written And Revised By D. B. A. Epstein. “§ 2. 1-1 Structure of the Dual Algebra the monomials ε^{I} in a′ thus correspond in a one-to-one way with sequences of non-negative integers (i₁, i₂, • • • , iₙ, 0, • • • ). The admissible monomials Sq^{I′}∈a correspond to sequences of integers (i′₁, i′₂, • • • , i′n, 0, • • • ) where i′ₖ≥2i′ₖ₊₁ and i′ₙ≥1. It remains only to set up a one-to-one correspondence between sequences of non-negative integers I and admissible sequences I′ such that ε^{I} and Sq^{I′} have the same degree. Let Iₖ be the sequence which is zero everywhere except for a 1 in the k^{th} place. Let, I′ₖ=(2^{k-1}, 2^{k-2}, . . . 2, 1, 0, 0, • • • ). We construct a map from the set of sequences I to the set of sequences I′ by insisting that Iₖ be sent to I′ₖ and that the map be additive (with respect to coordinate-wise addition). Then if I=(i₁, • • • , iₙ, 0, • • • )→I¹=(i′₁, • • • , i′ₙ, 0, • • • ) ε^{I} and Sq^{I′} have the same degree and we have i′ₖ=iₖ+2iₖ₊₁+ • • • +2^{n-k} iₙ. Solving for iₖ in terms of i′ₖ, we obtain iₖ=i′ₖ+2i′ₖ₊₁. Therefore, every admissible sequence I′ is the image of a unique sequence I of non-negative integers. Thus the correspondence is one-to-one. This completes the proof of the theorem. We now find the diagonal in a*”, (we refer to). Cohomology Operations Lectures By N. E. Steenrod Written And Revised By D. B. A. Epstein. “§ 1. Chain Complexes with a Group Action. 1.1. Definitions. The category of pairs is the category whose objects are pairs (p, A), where p is a group and A is a left p-module. A map f: (p, A)→(π, B) consists of homomorphisms f₁: p→π and f₂: B→A such that f₂(f₁(α)b)=α f₂(b) for all α∈p, b∈B. The category of algebraic triples is the category whose objects are triples (p,A,K) where p and A are as above and K is a chain complex on which p acts from the left. A map f: (p,A,K)→(π,B,L) consists of a map (p,A)→(π,B) in the category of pairs and a chain map f_{#}:K→L such that f_{#}(αk)=f₁(α)f_{#}(k) for all α∈p and k∈K. We say that f_{#}, and f₂ are equivariant (i.e., commute with the group action). Let C*ₚ (K;A)=Homₚ (K,A) be the complex of equivariant cochains on K with values in A. A map f: (p,A,K)→(π,B,L) induces a map f^{#}:C*_{π}(L;B)→C*ₚ (K;A) via the composition K^{f #}→L→B^{f2}→A. Let H*_{P}(K;A) be the homology of the complex C*_{P}(K;A) and H*_{P}(K;A) are contravariant functors from the category of algebraic triples. 1.3 Definition. An automorphism of an algebraic triple (p,A,K) is a map (p,A,K)→(p,A,K) with an inverse. The inner automorphism of (p,A,K) determined by y∈p is defined by f₁(α)=yαy⁻¹, f₂(a)=y⁻¹a, f_{#}(k)=yk. If π is a normal subgroup of p, then an inner automorphism of (p,A,K) induces an automorphism of (π,A,K). We repeat all the definitions in 1.3 in the case of a pair (p,A), by suppressing all mention of K. An automorphism of (p,A,K) induces an automorphism of H*_{P}(K;A) by 1.2. 1.4. Lemma. An inner automorphism of the algebraic triple (p,A,K) induces the identity map on H*_{P}(K;A). Proof. The induced map is the identity on the cochain level. 1.5. Lemma. Let (p,A,K) be an algebraic triple. Let n be a normal subgroup of p and let y→p. Let g:(π,A,K)→(π,A,K) be the automorphism determined by y. Then the image H*_{P}(K;A)→H*_{π}(K;A) is pointwise invariant under the automorphism g.* Proof, let f: (p,A,K)→(p,A,K) be the inner automorphism determined by y. Then by 1.2, the following diagram is commutative H*_{P}(K;A)^{f}*→H*_{P}(K;A) H*_{π}(K;A); and H*ₚ(K;A)→H*_{π}(K;A)^{g*}→H*_{π}(K;A). Further, 1.4 shows that f*=1. (We refer to). Cohomology Operations Lectures By N. E. Steenrod Written And Revised By D. B. A. Epstein. “§ 2. Cohomology of Groups. A regular cell complex K Is a cell complex with the property that the closure of each cell is a finite subcomplex homeomorphic to a closed ball. If K is Infinite, we give It the weak topolology—that is, a set is open if and only if its intersection with every finite subcomplex is open, (i.e. K is a CW complex). Let K and L be cell complexes. A carrier from K to L is a function C which assigns to each cell τ∈K a subcomplex C(τ) of L such that a face of τ is sent to a subcomplex of C(τ). An acyclic carrier is one such that C(τ) is acyclic for each τ∈K. Let p and π be groups which act on K and L respectively (consistently with their cell structures), and let h: p→π be a homomorphism. An equivariant carrier is one such that C(ατ)=h(α) C(τ) for all α∈p and τ∈K. Let ϕ:K→L be a chain map: we say ϕ is carried by C If ϕ(τ) is a chain in C(τ) for all τ∈K. 2.1. Remark. Let K and L be CW complexes. We give K×L the product cell structure and the CW topology. The chain complex of K×L is the tensor product of the chain complex of K and the chain complex of L. If K and L are both regular complexes, then K×L is a regular complex. (According to Dowker [1], the product topology on K×L defines a space which is homotopy equivalent to the CW complex K×L.) Let K′ be a p-subcomplex of a p-free cell complex and suppose we have an equivariant chain map K′→L. Suppose we have an equivariant acyclic carrier from K to L which carries ϕ|K′. 2.2. Lemma. We can extend ϕ to an equivariant chain map ϕ:K→L carried by C. If ϕ₀ and ϕ₁ are any two such extensions carried by C, then there is equivariant homotopy I⊗K→L between ϕ₀ and ϕ₁. (p acts on I⊗K by leaving I fixed and acting as before on K.) Proof. We arrange a p-basis for the cells of K−K¹ in order of increasing dimension. We must define ϕ so that ∂ϕ=∂ϕ. Since C(τ) is acyclic for each τ, we can do this inductively. The second part of the lemma follows from the first, since I×K is a p-free complex (see 2.1), and we can define a carrier from I×K to L by first projecting onto K end then applying C. 2.3. Lemma. Given a group n, we can always construct a π-free acyclic simplicial complex W. Proof. We give π the discrete topology and form the infinite repeated join W=π*π*π . . . . This repeated join is a simplicial complex. Taking the join of a complex with a point gives us a contractible space. Any cycle in W must lie in a finite repeated join W′. Such a cycle is homologous to zero in W′*π. Therefore, W is acyclic. We make n act on W as follows:π acts by left multiplication on each factor π of the join and we extend the action linearly. This action is obvious free and the lemma is proved. Suppose we have a homomorphism π→p and W is an acyclic π-free complex and V an acyclic p-free complex. Then we have an equivariant acyclic carrier from W to V: for each cell T∈W, we define C(τ)=V. By 2.2 we can find an equivariant chain map W→V, and all such chain maps are equivariantly homotopic. Therefore a map of pairs f:(π, A)→(π, B) as in 1.1 leads to a of algebraic triples (π, A, W)→(p, B, V) which is determined up to equivariant homotopy of the chain map W→V. By 1.2 we obtain a well-defined induced homomorphism f*:H*ₚ(V;B)→H*_{π}(W;A). In the class of π-free acyclic complexes, any two complexes are equivariantly homotopy equivalent, and any two equivariant chain maps going from one such complex to another are equivariantly homotopic. Therefore the groups H*_{π}(W;A), as W varies over the class, are all isomorphic to each other and the isomorphisms are unique and transitive. We can therefore identify all these cohomology groups and write H*(π;A), instead of H*_{π}(W;A). 2.4. Lemma. H*(π;A), is a contravariant functor from the category of pairs (see 1.1)”. An element of the K-group of the parameter space groupoid of the manifold M through the associated C*-algebra C*ᵣ(G): random dilution of random matrices H_{N}=U_{N} F_{N} U^{†}_{N}, where U_{N} are uniformly distributed over the group of N×N unitary matrices and F_{N} are non-random Hermitian matrices. The main tools of the analysis are energy and Strichartz estimates, as well as two anisotropic Sobolev inequalities. A concentration of mass on the ground state of the harmonic effect of the polar coordinates, and the lower-dimensional modulation wave function again satisfies a nonlinear Schrödinger equation. Dilute synthesis extraction is solved with dimension reduction of the three-dimensional Gross-Pitaevskii equation, which models the dynamics of Bose-Einstein condensates equations for a dilute atomic gas, modeled by polynomial growth spiral in contrast to a strong numerical solution, a weak numerical solution aims at the approximation of the moments of the solution X. Let f be chosen from a class of smooth functions, e.g., certain polynomials or functions with a specific polynomial growth. The numerical solution X⁽ⁿ⁾ converges weakly to X with order [symbol] >0 if there exists a constant c>0 such that c mesh(τₙ) [symbol] , ∀n≥1. X⁽ⁿ⁾ is a weak numerical solution of the SDE if, as mesh(τₙ)→0. Higher aggregation order utilizes in contrast to the first order approximation, the Milstein approximation exploits a so-called Taylor-Itô expansion that incorporates high order approximation. Heuristics: Apply the Itô lemma to the integrands μ(Xₛ) and σ(Xₛ) at each point tᵢ₋₁ of discretization, and then estimate the higher order terms using the fact that (dBₛ)²=ds. Taylor-Itô expansions involve multiple stochastic integrals. Their rigorous treatment requires a more advanced theory of the stochastic calculus. We refer to survey of numerical solution of stochastic differential equations of P. E. Kloeden and E. Platen. The Milstein approximation define recursively for 1≤i≤n, xₜᵢ⁽ⁿ⁾=xₜᵢ⁽ⁿ⁾₋₁+μ(xₜᵢ⁽ⁿ⁾₋₁)Δi+σ(xₜᵢ⁽ⁿ⁾₋₁ ΔiB+½σ(xₜᵢ⁽ⁿ⁾₋₁)σ⁰(xₜᵢ⁽ⁿ⁾₋₁)[(ΔiB)²−Δᵢ], with x₀⁽ⁿ⁾=x₀ the equidistant Milstein approximation converges strongly with order 1.0 and modeled by an anisotropic harmonic potential with second row period-2 element molecular highly-pure beryllium N order of harmonic notation nP ratio of harmonic to fundamental inductance (L) system of equations circuit an inductor to resist changes in current and which also relates current, i with its magnetic flux linkage, N [symbol] as a constant of proportionality is called inductance which is given the symbol (L) with units of Henry, (H) semiprime is any integer value of normal the coherence rule central to proposition number (N) theorem of a matrix system The Real and Complex Hermitian Solutions to a System of Quaternion Matrix Equations with Applications by Shao-Wen Yu the number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0 is the phase factor derivative, dI/dU, on the electric current, I. Incipient p-wave PF power transmission superconductor the operator PF\hat{ }, that obeys the following rules: PF\hat{ }ϕₖ=Pϕₖ, for k=1, 2, 3 PF\hat{ }ϕ₄=Fϕ₄ where P and F are real number. When the operators G\hat{ } and PF\hat{ } commute, we have the mathematical expression. Since the two operators share common eigenfunctions, they commute. More precisely: since the two observable on subvector ample line O(1) share common eigenfunctions, we can write PF\hat{ }G\hat{ }ϕₖ=gₖPF\hat{ }ϕₖ=gₖ(PF)ₖϕₖ (where (PF)ₖ=P for k=1, 2, 3 and =F for k=4. We also have G\hat{ }PF\hat{ }ϕₖ=G\hat{ }(PF)ₖϕₖ=(PF)ₖG\hat{ }ϕₖ=(PF)ₖgₖϕₖ. Thus we proved that for the 4 eigenfunctions: [PF\hat{ }, G\hat{ }]ϕₖ=0. Now, to state that [PF\hat{ }, G\hat{ }]=0, we need to prove that [PF\hat{ }, G\hat{ }]f=0 for any function f. However, the eigenfunctions form a basis, so that any other function in the subvector ample line O(1) space can be written as a linear combination of ϕₖ's: f=Σₖ cₖϕₖ. It's then easy to prove that the previous relation PF\hat{ }G\hat{ }f=G\hat{ }PF\hat{ }f is valid for any function f Lemma 3.8.16. Let f:[0,1]→R_{0,1} strong V sufficiently a homology 3-dimensional a 3-sphere continuous function when mod Θ=λ, there exists a λ×λ matrix algebra K in R_{0,1} such that: 1) the Θ^{j}(K) commute pairwise; 2) the Θ^{j}(K) generate the von Neumann algebra R_{0,1}, and this property remains true whenever Θ is multiplied by an automorphism eigenvalue of modulus 1 which equals 0 on the boundary of [0,1], i.e., f(0)=f(1)=0; (we refer to) “the construction of the (b,B) bicomplex is functorial it yields a presheaf of bicomplexes: (Γ^{(n,m)},b,B). Choosing a covering U=(U_{α}) of V sufficiently fine so that the multiple intersections are domains of foliation charts, we get a triple complex M (3.42) (Γ^{n,m,p}=Γ^{(n,m)} (U₀∩U₁∩ . . . ∩Uₚ), b,B,δ) Uᵢ∈U where δ is the Cech coboundary.\check{ } Moreover, there is an obvious forgetful map ϕ from the periodic cyclic cohomology H*(A), A=A(V), to the cohomology of the triple complex (12);” “affine geometry, (vector field on the generic leaf of a foliation) Hₖ(V,R), we get a scalar χ(F,∧)=he(F),[C]i∈R”. Let F:R→R be the function defined by setting F(x):=f(x) for x∈[0,1] and F(x):=0 for x∉[0,1]. Then F is also continuous [n-mosfet generated by symbols {A₁, . . . , Aₛ}] power series expansion. We begin simple geometric representation for the case when π=a/b fraction from 0 to 1 in steps of 0.01 (δ=0). Continued by the rational function Bin(n,p) binomial distribution f(k)=ₙCₖ p^{k}(1−p)^{n k} electromagnetic pulses continued as phase factor for any complex number written in polar form (such as re^{iΘ}), the phase factor is the complex exponential factor (e^{iΘ}). Group G in is a finite extension of a torsion free non-cyclic indecomposable subgroup G₁ of the form G₁= [symbol] a₁, b₁, • • • , a_{g}, b_{g}; Π[aᵢ/bᵢ] [symbol] , g≥0 of this group has, as a Lie group, the same dimension n(n−1)/2 and is the identity component of O(n). The instantaneous helical axis, or instantaneous helicoidal axis, is the axis of the helicoidal field generated by the velocities of every point in a moving body are Euclidean motions (for n≥3), or the instantaneous center of rotation, also called an instant center. The term ‘centro’ is also used for a velocity pole, and the locus of these points for a planar movement is called a centrode. Groups SO(n) are well-studied for n≤4. There are no non-trivial rotations in 0- and 1-spaces. Rotations of a Euclidean plane (n=2) are parametrized by the angle (modulo 1 turn, or the sum of the first n+1 modulo terms). Constant (L), a semiprime is any integer normalized function of temperature; and pressure correction value of number n is continued as phase factor for any complex number written in polar form (such as re^{iΘ}), the phase factor is the complex exponential factor (e^{iΘ}). The value of number n is continued a permutation cycle a coherence length: let dᵣ (n, k) be the number of permutations of n having exactly k cycles all of which are of length ≥r. Permutation cycles we use the number d₁ (n, k) of k-cycles in a permutation group of order n a permutation cycle is a subset of a permutation whose elements trade places with one another. Permutations cycles are called “orbits” by Comtet (1974, p. 256). For example, in the permutation group {4, 2, 1, 3), (143) is a 3-cycle and (2) is a 1-cycle. Here, the notation (143) means that starting from the original ordering {1, 2, 3, 4}, the first element is replaced by the fourth, the fourth by the third, and the third by the first, i.e., 1 →4 →3 →1. There is a great deal of freedom in picking the representation of a cyclic decomposition since (1) the cycles are disjoint and can therefore be specified in any order, and (2) any rotation of a given cycle specifies the same cycle (Skiena 1990, p. 20). Therefore, (431)(2), (314)(2), (143)(2), (2)(431), (2)(314), and (2)(143) all describe the same permutation. The following table gives the set of representations for each element of the symmetric group on three elements, S₃, sorted in lowest canonical order (first by cycle length, and then by lowest initial order of elements). Permutation of {1, 2, 3} notation {1, 2, 3} (1)(2)(3); {1, 3, 2} (1)(23); {2, 1, 3} (3)(12); {2, 3, 1} (123); {3, 1, 2} (132); {3, 2, 1} (2)(13). The cyclic decomposition of a permutation can be computed in the Wolfram Language with the function PermutationCycles[p] and the permutation corresponding to a cyclic decomposition can be computed with PermutationList[c]. Here, the individual cycles are represented using the function Cycles. Every permutation group on n symbols can be uniquely expressed as a product of disjoint cycles (Skiena 1990, p. 20). A cycle decomposition of a permutation can be viewed as a class of a permutation group. The number d₁ (n, k) of k-cycles in a permutation group of order n is given by d₁ (n, k)=(−1)^{n-k}=|S₁(n, k)|, where S₁(n, m) are the Stirling numbers of the first kind. More generally, let dᵣ (n, k) be the number of permutations of n having exactly k cycles all of which are of length ≥r. d₂ (n, k) are sometimes called the associated Stirling numbers of the first kind (Comtet 1974, p. 256). The quantities d₃ (n, k) appear in a closed-form expression for the coefficients of in Stirling's series (Comtet 1974, p. 257 and 267). The following table gives the triangles for dᵣ (n, k). r Sloane dᵣ (n, k). 1 A008275 1; 1, 1; 2, 3, 1; 6, 11, 6, 1; 24, 50, 35, 10, 1; . . . . 2 A008306 1; 2; 6, 3; 24, 20; 120, 130, 15; 720, 924, 210; . . . . 3 A050211 2; 6; 24; 120, 40; 720, 420; 5040, 3948; 40320 4 A050212 6; 24; 120; 720; 5040, 1260; 40320, 18144; . . . . 5 A050213 24; 120; 720; 5040; 40320; 362880, 72576; . . . . The functions dᵣ (n, k) are given by the recurrence relation dᵣ (n, k)=(n−1) dᵣ(n−1, k)+(n−1)ᵣ₋₁ dᵣ (n−r, k−1), where (n)k is the falling factorial, combined with the initial conditions dᵣ (n, k)=0 for n≤k r−1 (3) dᵣ (n, 1)=(n−1)! (4). (Riordan 1958, p. 85; Comtet 1974, p. 257). Referenced on Wolfram|Alpha: Permutation Cycle we refer to: Weisstein, Eric W. “Permutation Cycle”. From MathWorld—A Wolfram Web Resource. http://mathworld.wolfram.com/PermutationCycle.html. The number of permutations of n having exactly k cycles all of which are of length, and we have a sequence (zₙ)_{n=0, 1, 2, . . .} of 0's and 1's that satisfies the following coherence rule: zₙ=1⇒zₙ₊₁=0.
